(19) United States
(12) Patent Application Publication
(10) Pub. No.: US 2026/0004531 A1
(43) Pub. Date: Jan. 1, 2026

(54) METHODS OF FACILITATING REAL-TIME COMMUNICATION SESSIONS FOR CO-LOCATED USERS

(71) Applicant: Apple Inc., Cupertino, CA (US)

(72) Inventors: Shih-Sang CHIU, San Francisco, CA (US); Connor A. SMITH, San Jose, CA (US); Jacob A. PICCOLO, San Mateo, CA (US); Joseph P. CERRA, San Francisco, CA (US); Patrick PIEMONTE, San Francisco, CA (US)

(21) Appl. No.: 19/207,267

(22) Filed: May 13, 2025

Related U.S. Application Data
(60) Provisional application No. 63/646,549, filed on May 13, 2024.
(60) Provisional application No. 63/764,142, filed on Feb. 27, 2025.

(51) Int. Cl. G06T 19/00; G06F 3/01

(52) U.S. Cl. CPC G06T 19/006; G06F 3/013

(57) ABSTRACT

A computer facilitates display of content, and when criteria are satisfied, displays an option for initiating a process to display the content at a location by a second computer, facilitates initiation of a spatial real-time communication session with user(s) in a 3D environment, shares content with a second computer in response to selection of an element, in response to different inputs directed to a user of the second computer and to the content, and/or in response to movement of the content to an element, displays a sharing user interface for selecting content to share with a user in response to selection of an element displayed when the user is in a viewport of the computer, initiates a process to present a visual indication on a second computer in response to criteria being satisfied, and/or adds a user to a communication session in response to input directed at a user interface.

### CROSS REFERENCE TO RELATED APPLICATIONS

This application claims the benefit of U.S. Provisional Application No. 63/646,549, filed May 13, 2024, U.S. Provisional Application No. 63/764,142, filed Feb. 27, 2025, U.S. Provisional Application No. 63/805,051, filed May 13, 2025, and U.S. Provisional Application No. 63/805,056, filed May 13, 2025, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates sharing of virtual content with one or more users in a three-dimensional environment. In some embodiments, a computer system facilitates initiation of a spatial real-time communication session with one or more users in a three-dimensional environment. In some embodiments, a first computer system shares a user interface (UI) with a second computer system in response to selection of a first user interface element for sharing the user interface with the second computer system. In some embodiments, a first computer system shares a user interface with a second computer system in response to detecting different user inputs directed to a user of the second computer system and to the user interface. In some embodiments, a first computer system shares a user interface with a second computer system in response to detecting movement of the user interface to a user interface element for sharing the user interface with the second computer system.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-1-7M illustrate examples of a computer system facilitating sharing of virtual content with one or more users in a three-dimensional environment in accordance with some embodiments.

FIG. 8 is a flowchart illustrating an exemplary method of facilitating sharing of virtual content with one or more users in a three-dimensional environment in accordance with some embodiments.

FIGS. 9A-9O illustrate examples of a computer system facilitating initiation of a spatial real-time communication session with one or more users in a three-dimensional environment in accordance with some embodiments.

FIG. 10 is a flowchart illustrating an exemplary method of facilitating initiation of a spatial real-time communication session with one or more users in a three-dimensional environment in accordance with some embodiments.

FIGS. 11A-1-11F generally illustrate examples of a first computer system sharing a user interface with a second computer system in response to selection of a first user interface element for sharing the user interface with the second computer system in accordance with some embodiments.

FIG. 12 is a flowchart illustrating an exemplary method for sharing a user interface with a second computer system in response to selection of a first user interface element for sharing the user interface with the second computer system in accordance with some embodiments.

FIGS. 13A-13J generally illustrate examples of a first computer system sharing a user interface with a second computer system in response to detecting different user inputs directed to a user of the second computer system and to the user interface, where the first computer system and the second computer system are collocated in a physical environment in accordance with some embodiments.

FIG. 14 is a flowchart illustrating an exemplary method for sharing a user interface with a second computer system in response to detecting different user inputs directed to a user of the second computer system and to the user interface in accordance with some embodiments.

FIGS. 15A-15Y generally illustrate examples of a first computer system sharing a user interface with a second computer system in response to detecting movement of the user interface to a user interface element for sharing the user interface with the second computer system, where the first computer system and the second computer system are collocated in a physical environment in accordance with some embodiments.

FIG. 16 is a flowchart illustrating an exemplary method for sharing a user interface with a second computer system in response to detecting movement of the user interface to a user interface element for sharing the user interface with the second computer system in accordance with some embodiments.

FIGS. 17A-1-17Z generally illustrate examples of a first computer system displaying a sharing user interface for selecting content to share with a second user of a second computer system in response to selection of a first user interface element that is displayed when the second user is detected in a viewport of the first computer system, where the first computer system and the second computer system are collocated in a physical environment in accordance with some embodiments.

FIG. 18 is a flowchart illustrating an exemplary method for displaying a sharing user interface for selecting content to share with a second user of a second computer system in response to selection of a first user interface element that is displayed when the second user is detected in a viewport of the first computer system in accordance with some embodiments.

FIGS. 19A-19O generally illustrate examples of a first computer system initiating a process to present a visual indication on a portion of a second computer system in response to detecting that certain criteria are satisfied, where the first computer system and the second computer system are collocated in a physical environment in accordance with some embodiments.

FIG. 20 is a flowchart illustrating an exemplary method for initiating a process to present a visual indication on a portion of a second computer system in response to detecting that certain criteria are satisfied in accordance with some embodiments.

FIGS. 21A-21U generally illustrate examples of a first computer system adding a user to an existing communication session that is between a first user of the first computer system and a second user of a second computer system in response to user input from the first user being directed at a communication session user interface for adding the user, where the first computer system and second computer systems are collocated in a physical environment, in accordance with some embodiments.

FIG. 22 is a flowchart illustrating an exemplary method for adding a user to an existing communication session that is between a first user of the first computer system and a second user of a second computer system in response to user input from the first user being directed at a communication session user interface for adding the user in accordance with some embodiments.

FIGS. 23A-23AU generally illustrate examples of a first computer system displaying a user interface and detecting and responding to input directed to a first control element that is concurrently displayed with the user interface, where the first control element is selectable to display a sharing user interface for the user interface, and/or displaying a user interface and detecting and responding to input corresponding to a request to initiate sharing of the user interface, in accordance with some embodiments.

FIG. 24 is a flowchart illustrating an exemplary method for displaying a sharing user interface for a user interface in response to detecting an input directed to a first control element for the user interface, in accordance with some embodiments.

FIG. 25 is a flowchart illustrating an exemplary method for displaying a sharing user interface for a user interface in response to detecting an input corresponding to a request to initiate sharing of the user interface in a communication session, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates sharing of virtual content with one or more users in a three-dimensional environment. In some embodiments, sharing virtual content displayed at a location within a first three-dimensional environment of a first computer system includes causing display of the virtual content that is not displayed by the second computer system at a respective location within a second three-dimensional environment of the second computer system that corresponds to the location of the virtual content within the first three-dimensional environment. In some embodiments, the sharing is performed independently of a real-time communication session. In some embodiments, a first computer system sharing the virtual content detects a second computer system is within physical proximity to the first computer system, and displays a selectable option to initiate sharing of the virtual content not displayed within a three-dimensional environment of the second computer system. In some embodiments, the proximity is sensed based on signal strength, a range of a network, a ranging distance between the devices, detecting of a shared physical environment, detecting of a sound within the environment, detecting of an interaction between users of computer systems, detecting that another user is within a viewport of a computer system, and/or some combination thereof. In some embodiments, the first computer system displays a selectable option indicating that virtual content is not yet shared with the second computer system. In some embodiments, the selectable option is displayed proximate to the virtual content and/or to a representation of the user of the second computer system. In some embodiments, the selectable option is displayed in accordance with a determination that the second user corresponds to an account associated with the second computer system and known to the first computer system, in accordance with a determination that the second computer system indicated approval of sharing the virtual content, and/or that the second computer system previously received content shared by the first computer system. In some embodiments, the virtual content is displayed at a location corresponding to a physical object. In some embodiments, the first computer system and/or the second computer system changes the location of the virtual content relative to their respective three-dimensional environments.

In some embodiments, a computer system facilitates initiation of a spatial real-time communication session with one or more users in a three-dimensional environment. In some embodiments, while an environment is visible via the display generation component, a first computer system detects a first indication of a request to initiate non-spatial communication with a second user, different from a first user of the first computer system, of a second computer system, different from the first computer system. In some embodiments, in response to detecting the first indication, the first computer system enters a non-spatial real-time communication session with the second user, including displaying, via the display generation component, a first object corresponding to a non-spatial representation of the second user in the environment. In some embodiments, while displaying the first object in the environment, the first computer system detects a second indication of a request to transition the non-spatial real-time communication session to a spatial real-time communication session. In some embodiments, in response to detecting the second indication, the first computer system enters a spatial real-time communication session with the second user, including, in accordance with a determination that one or more criteria are not satisfied, ceasing display of the first object in the environment and displaying, via the display generation component, a first spatial visual representation of the second user in the environment. In some embodiments, in accordance with a determination that the one or more criteria are satisfied, the first computer system ceases display of the first object in the environment without displaying the first spatial visual representation of the second user in the environment.

In some embodiments, a first computer system shares a user interface with a second computer system in response to selection of a first user interface element for sharing the user interface with the second computer system. In some embodiments, the first computer system and the second computer system are collocated in a physical environment.

In some embodiments, a first computer system shares a user interface with a second computer system in response to detecting different user inputs directed to a user of the second computer system and to the user interface. In some embodiments, the first computer system and the second computer system are collocated in a physical environment.

In some embodiments, a first computer system shares a user interface with a second computer system in response to detecting movement of the user interface to a user interface element for sharing the user interface with the second computer system. In some embodiments, the first computer system and the second computer system are collocated in a physical environment.

In some embodiments, a first computer system displays a sharing user interface for selecting content to share with a second user of a second computer system in response to a first user of the first computer system selecting a first user interface element that is displayed when the second user is detected in a viewport of the first computer system. In some embodiments, the first computer system and the second computer system are collocated in a physical environment.

In some embodiments, a first computer system initiates a process to present a visual indication on a portion of a second computer system in response to detecting that certain criteria are satisfied. In some embodiments, the first computer system and the second computer system are collocated in a physical environment.

In some embodiments, a first computer system adds a user to an existing communication session that is between a first user of the first computer system and a second user of a second computer system in response to user input from the first user being directed at a communication session user interface for adding the user. In some embodiments, the first computer system and second computer systems are collocated in a physical environment.

In some embodiments, a first computer system displays a sharing user interface that includes a first option that is selectable to initiate a process for sharing the user interface in a first type of communication session between a first user of the first computer system and a second user of a second computer system and includes a second option that is selectable to initiate a process for sharing the user interface in a second type of communication session that is different from the first type of communication session, in accordance with some embodiments. In some embodiments, the first computer system and second computer systems are collocated in the physical environment.

In some embodiments, a first computer system displays a sharing user interface that includes a first set of one or more options that corresponds to one or more users who are collocated in a physical environment with a first user of the first computer system and who satisfy one or more criteria and that are selectable to initiate a process for sharing the user interface in a first type of communication session between the first user of the first computer system and the one or more users of computer systems who are collocated in the physical environment with the first user of the first computer system and satisfy the one or more criteria. In some embodiments, the sharing user interface also includes a second option that is selectable to initiate a process for sharing the user interface in the first type of communication session between the first user of the first computer system and one or more users of computer systems who are collocated in the physical environment with the first user of the first computer system and do not satisfy the one or more criteria.

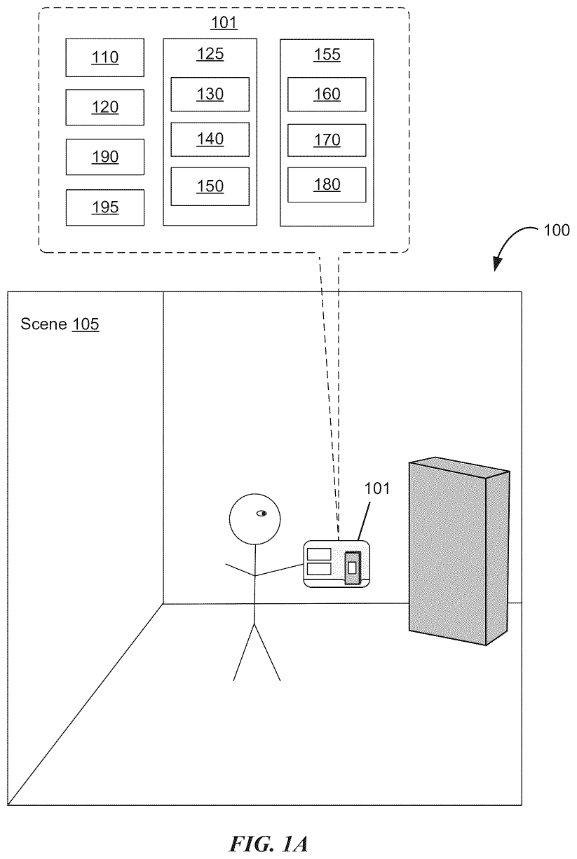

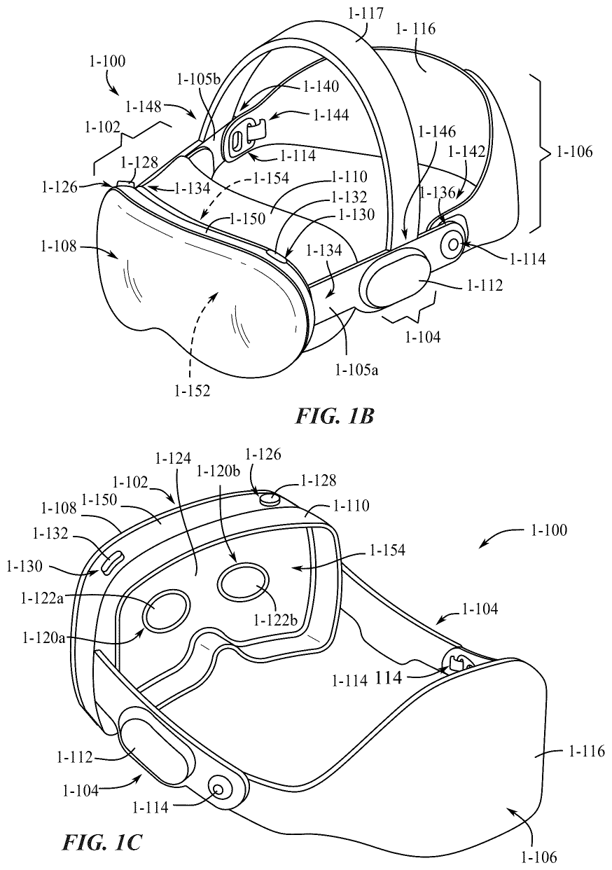

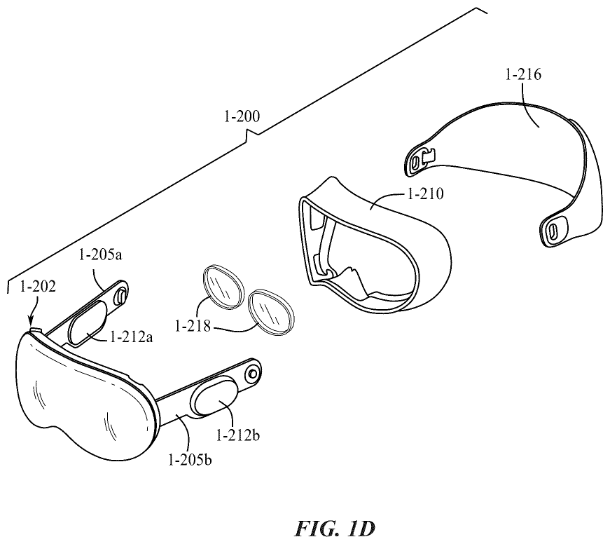

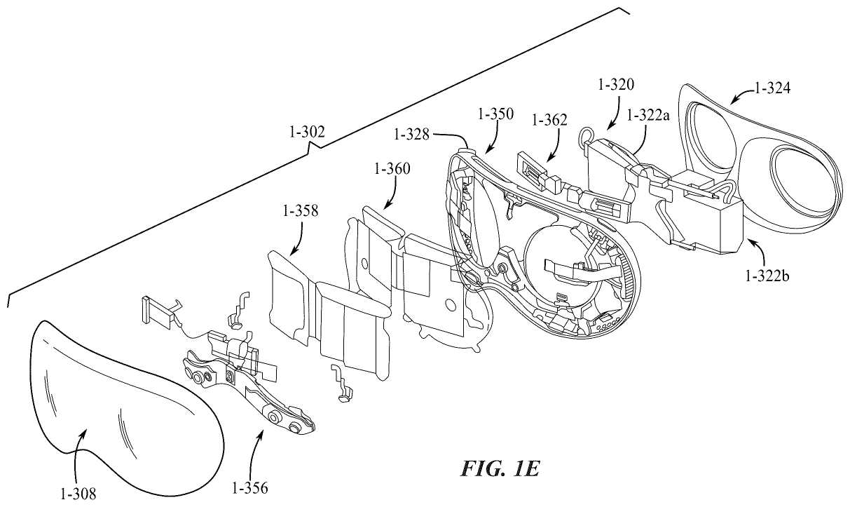

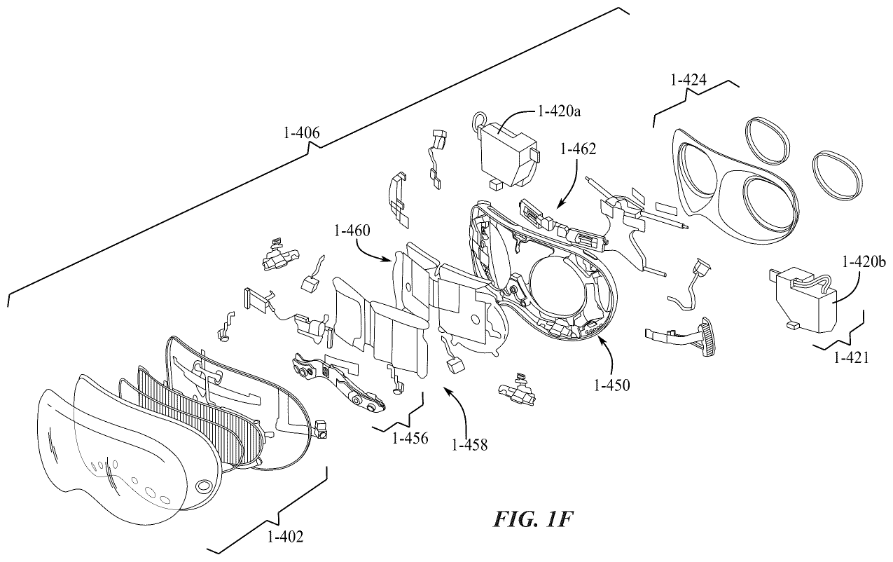

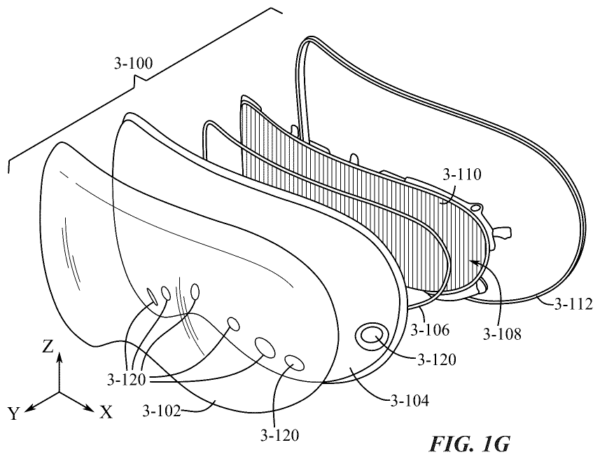

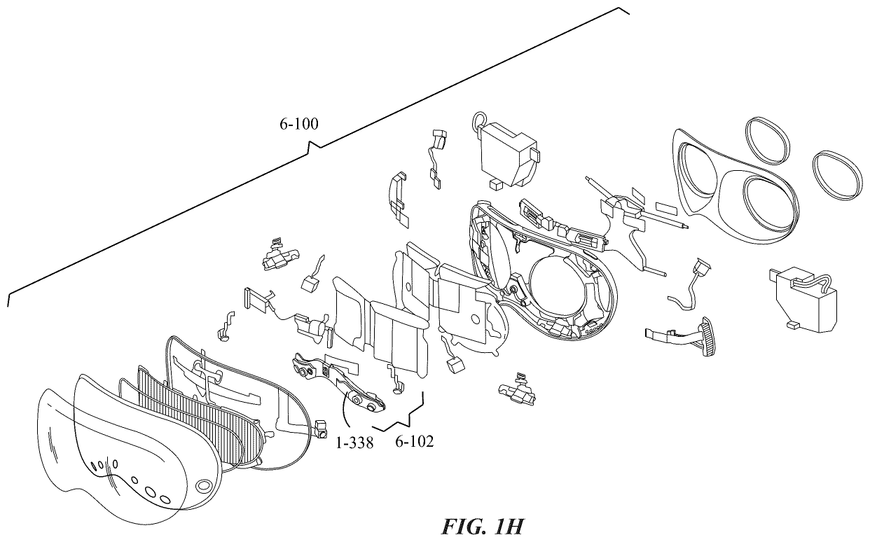

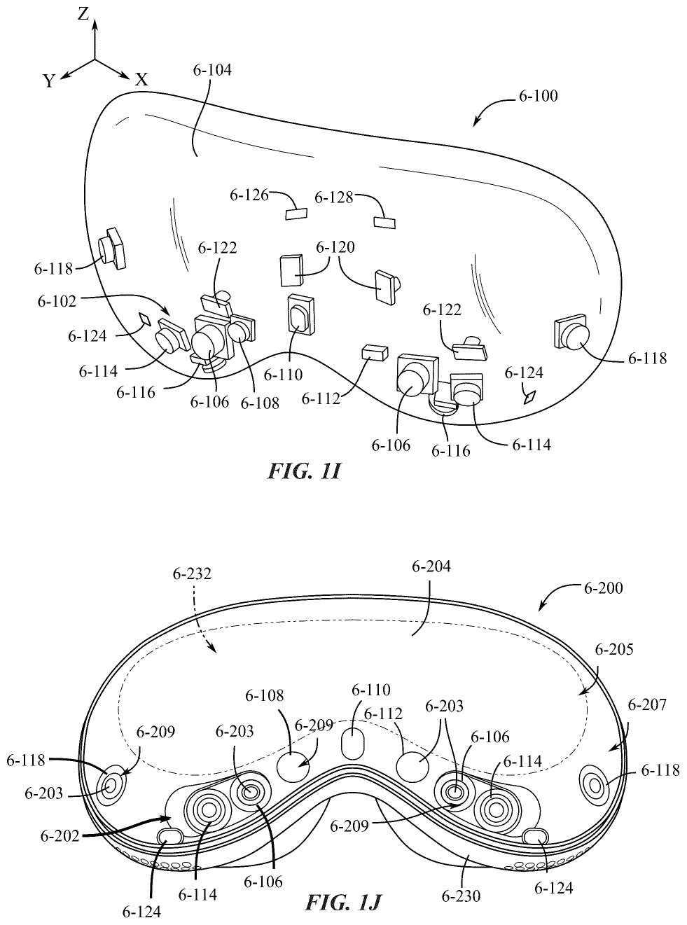

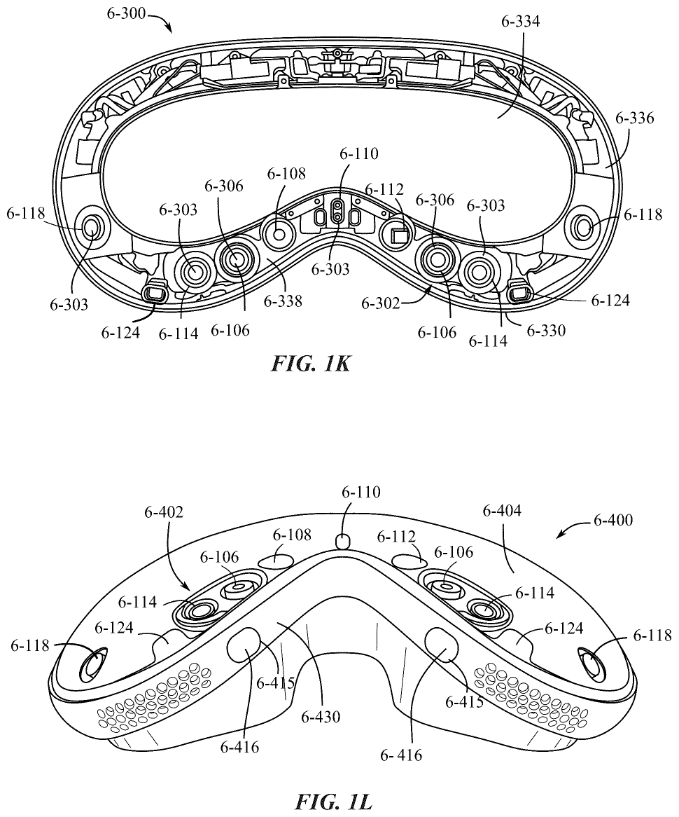

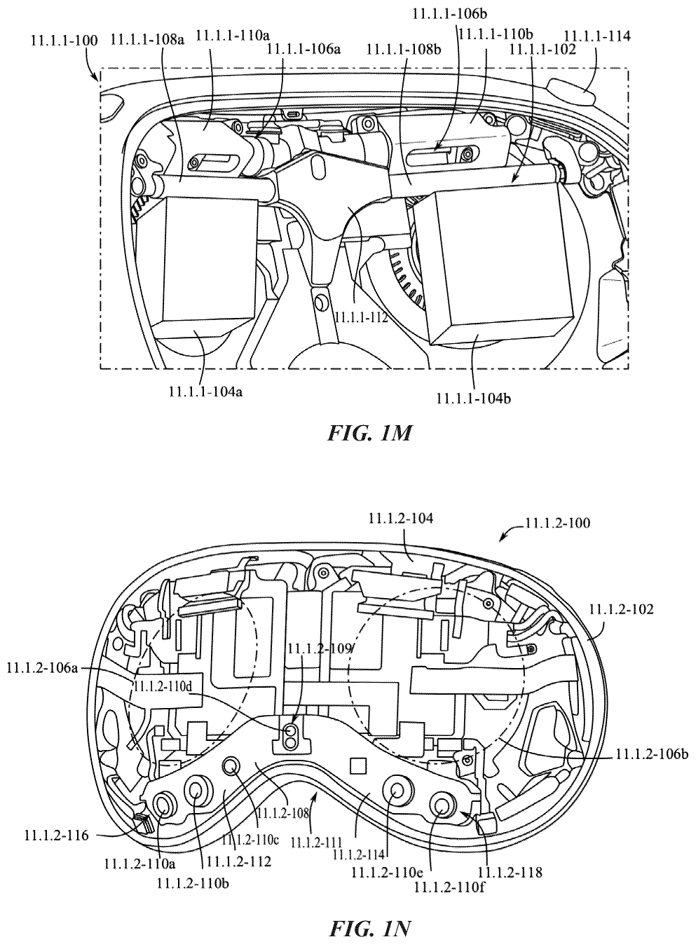

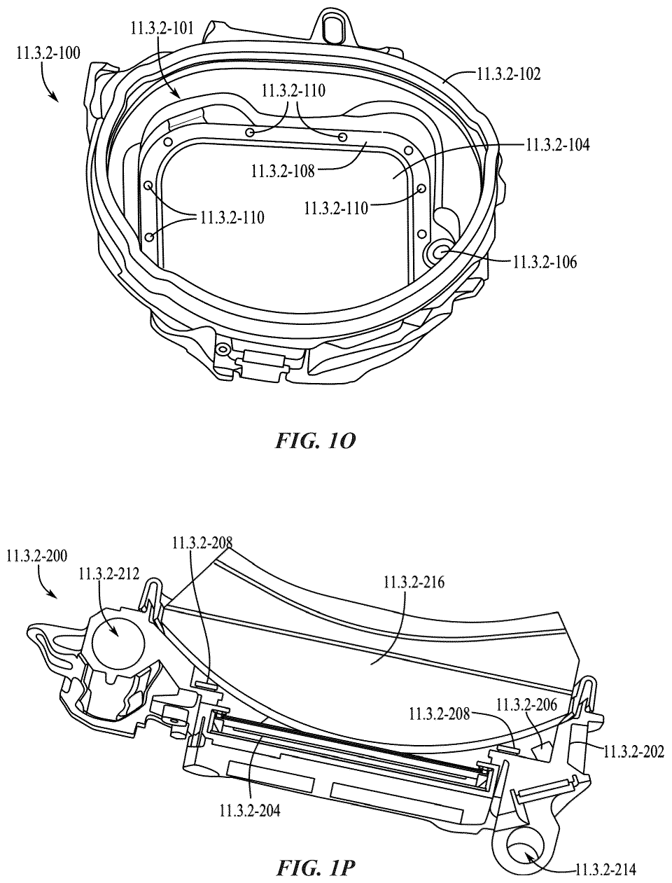

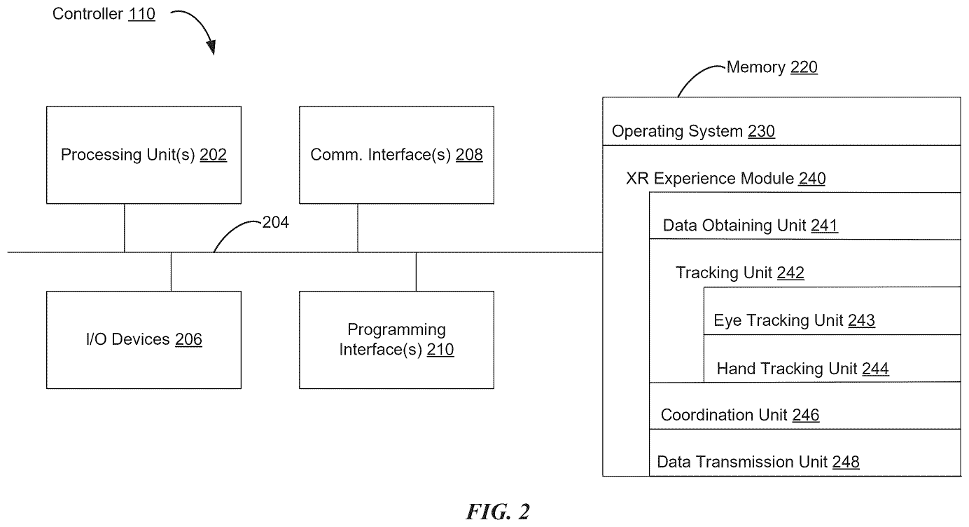

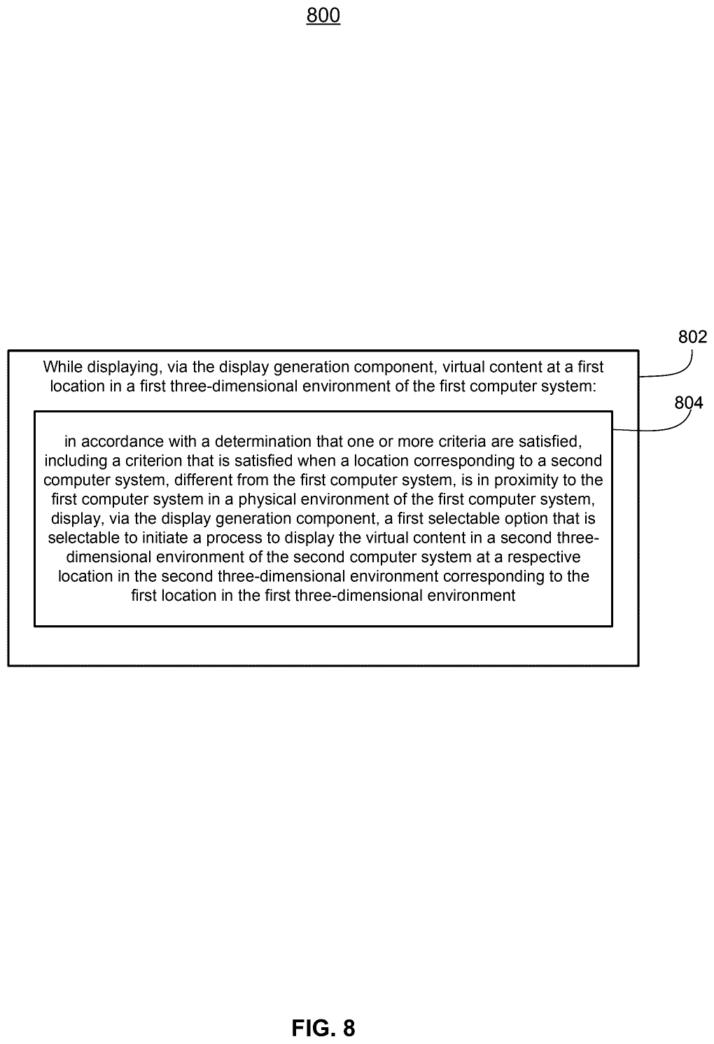

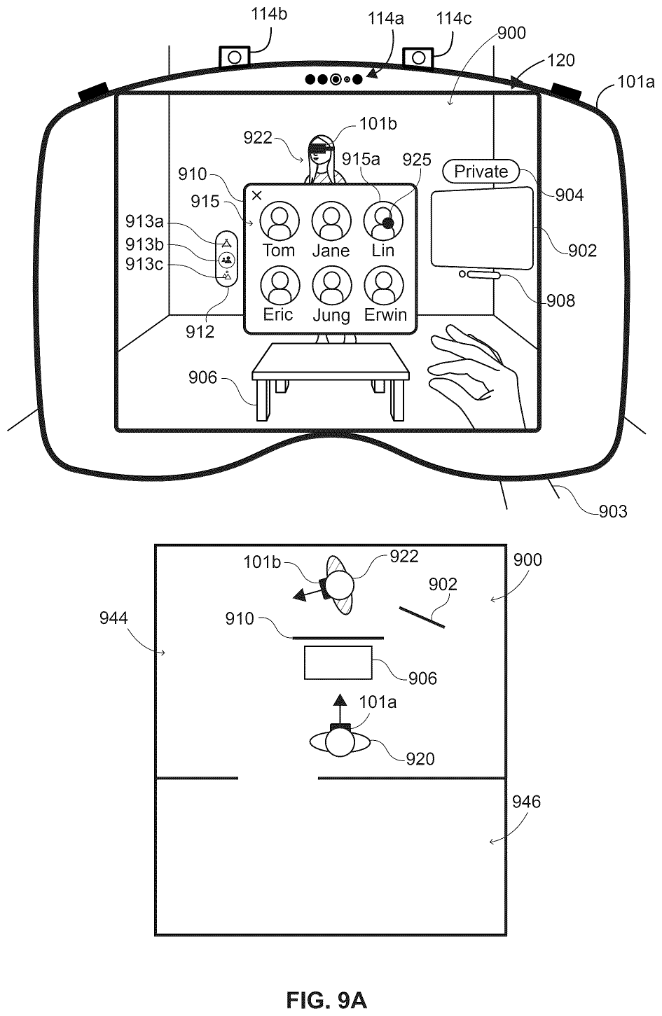

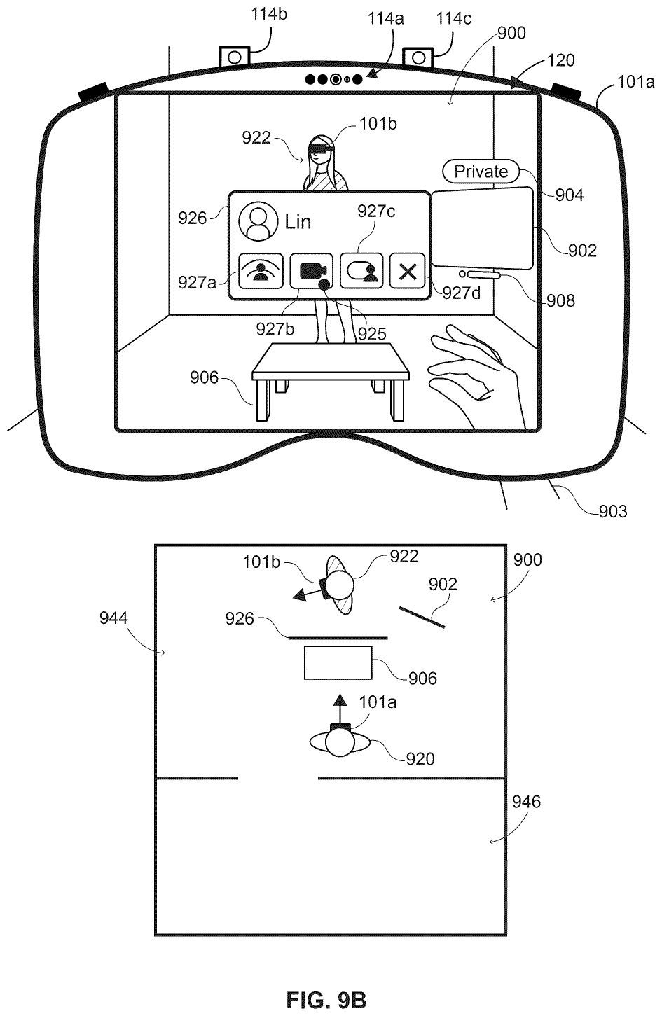

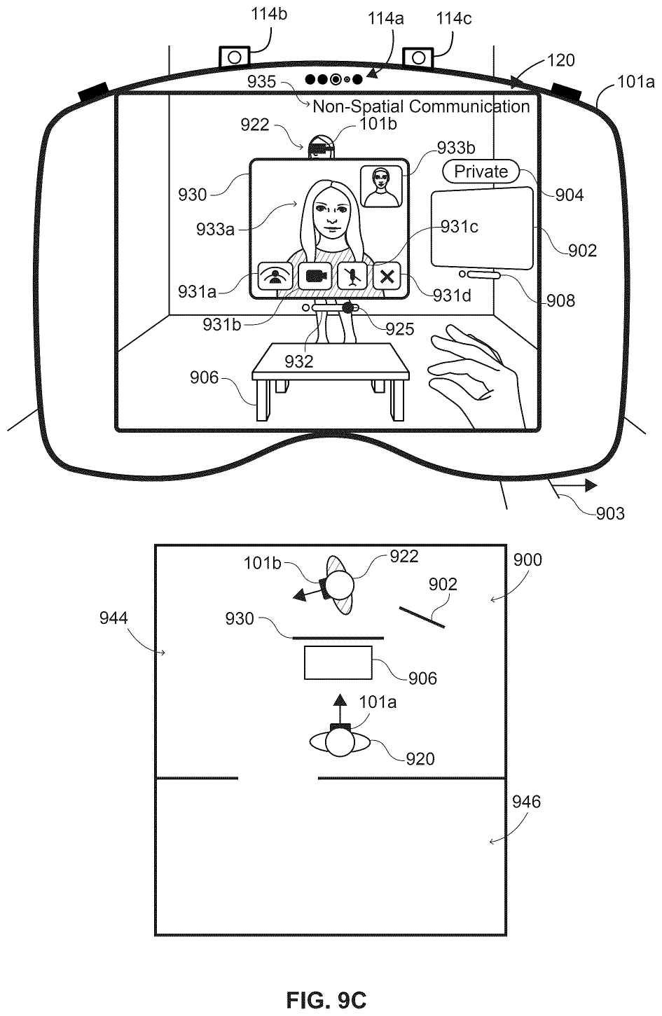

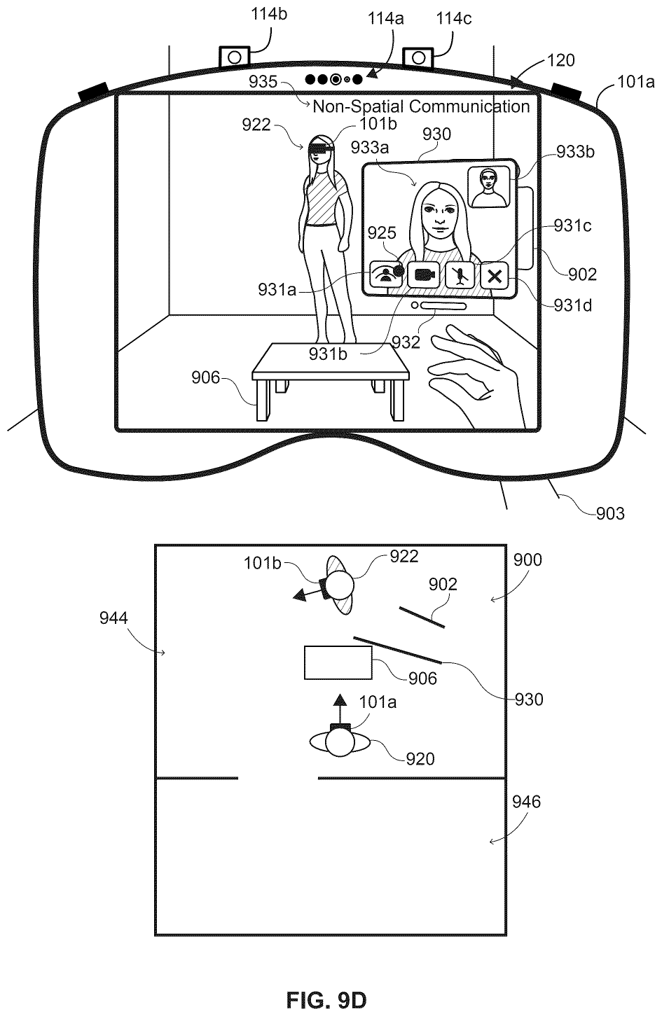

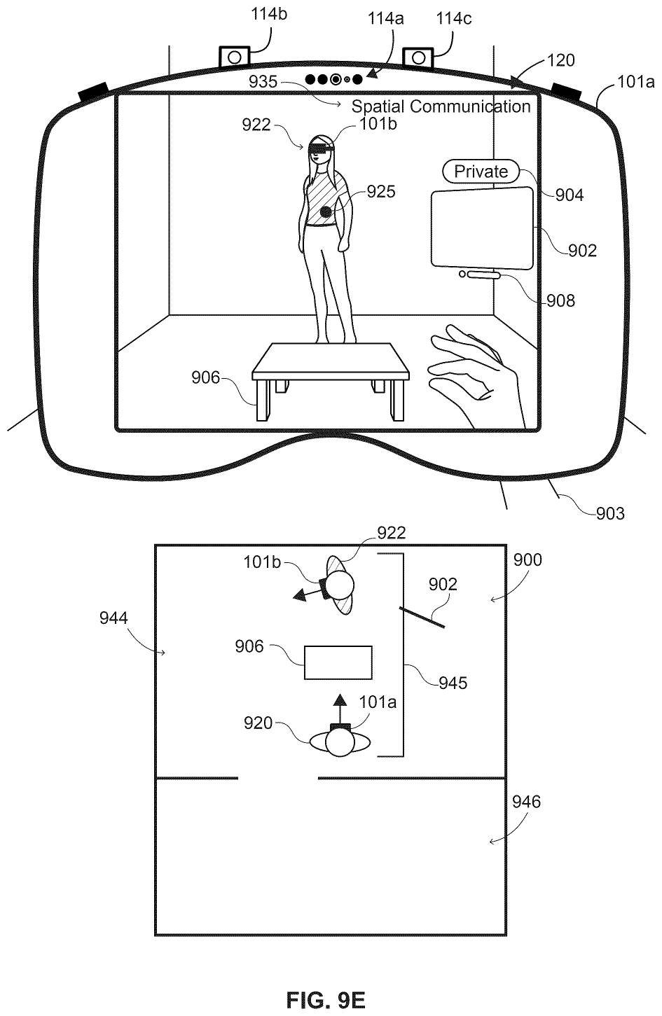

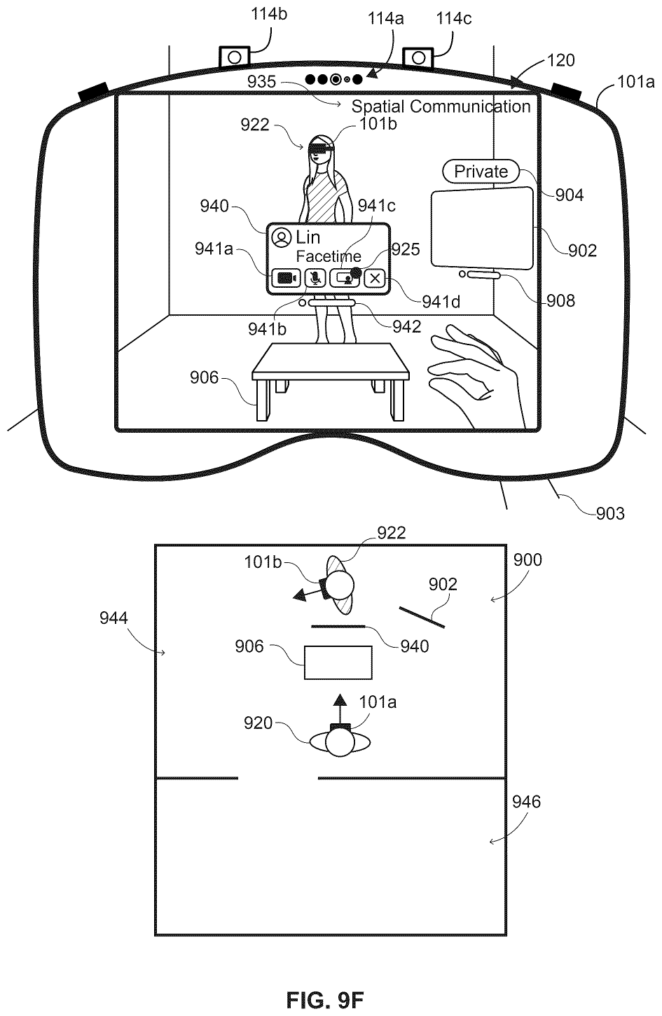

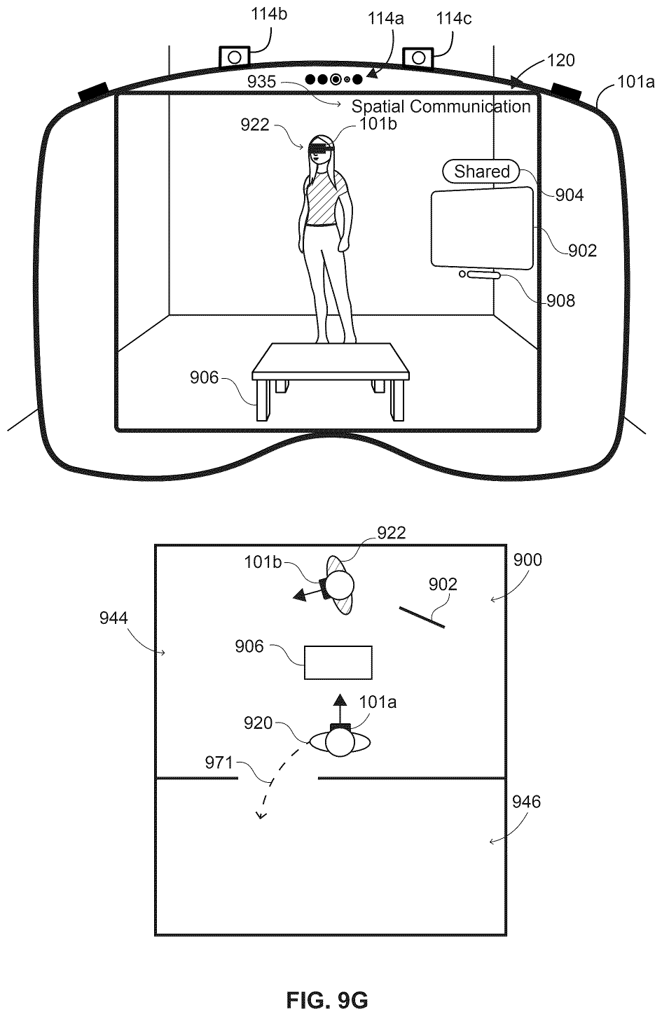

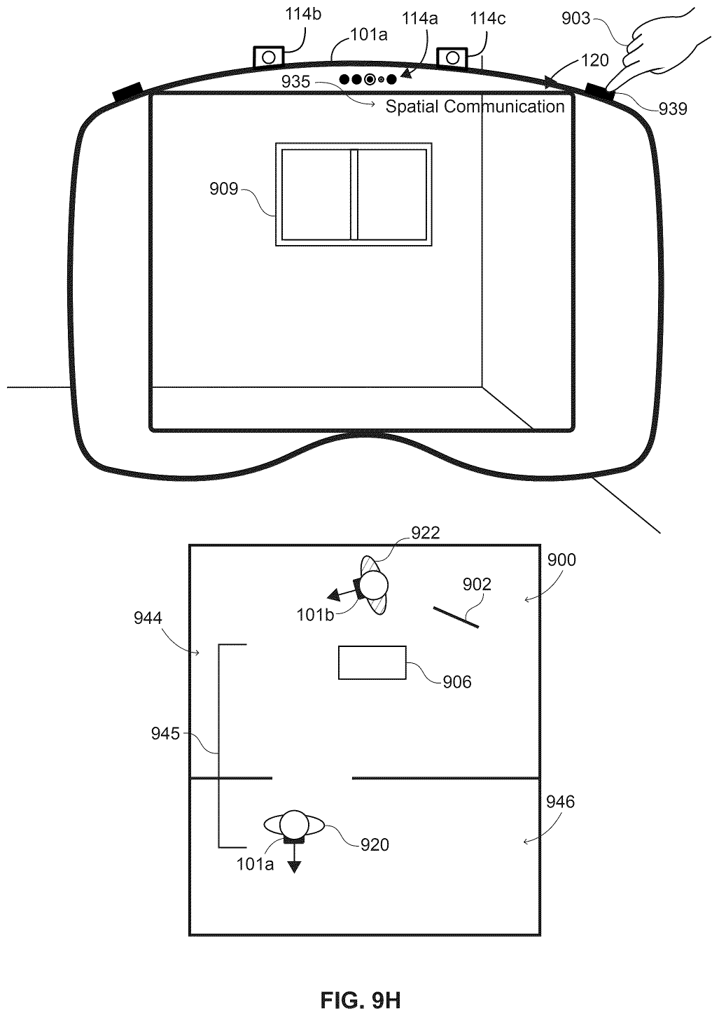

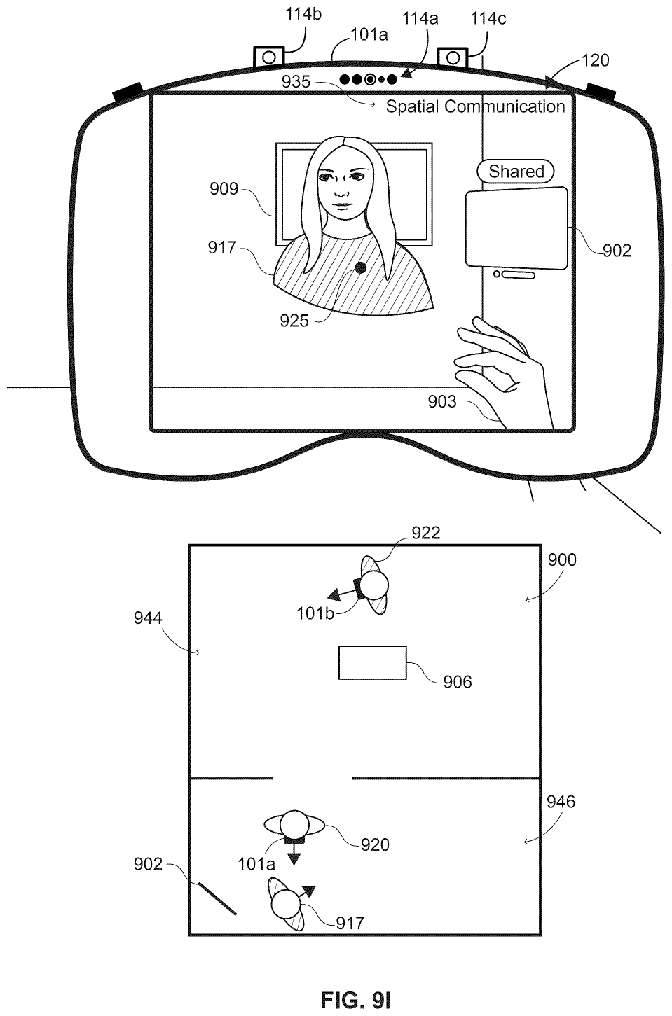

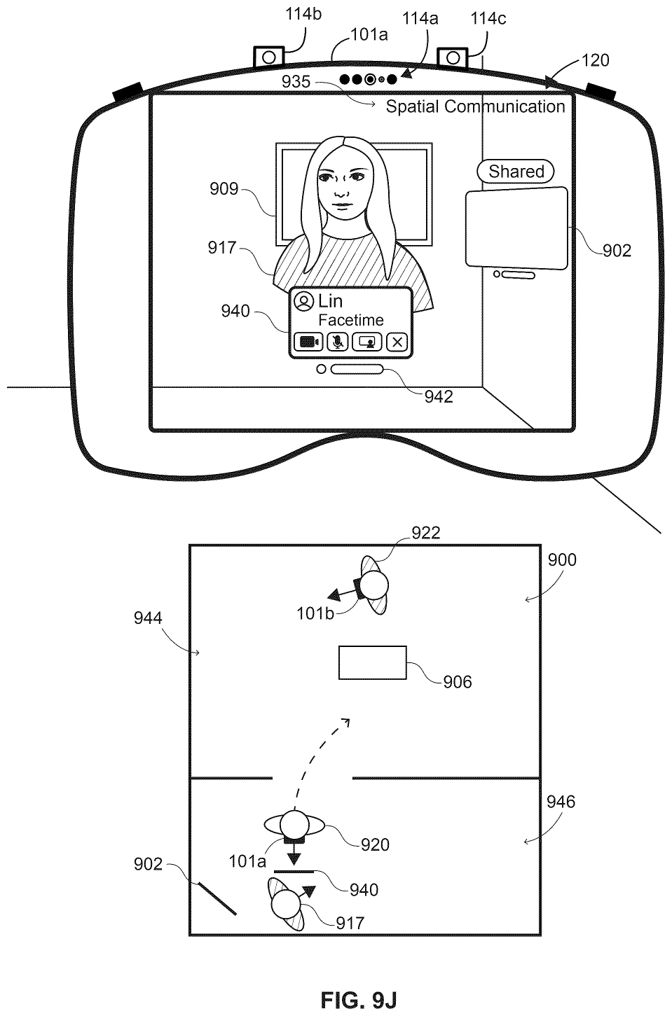

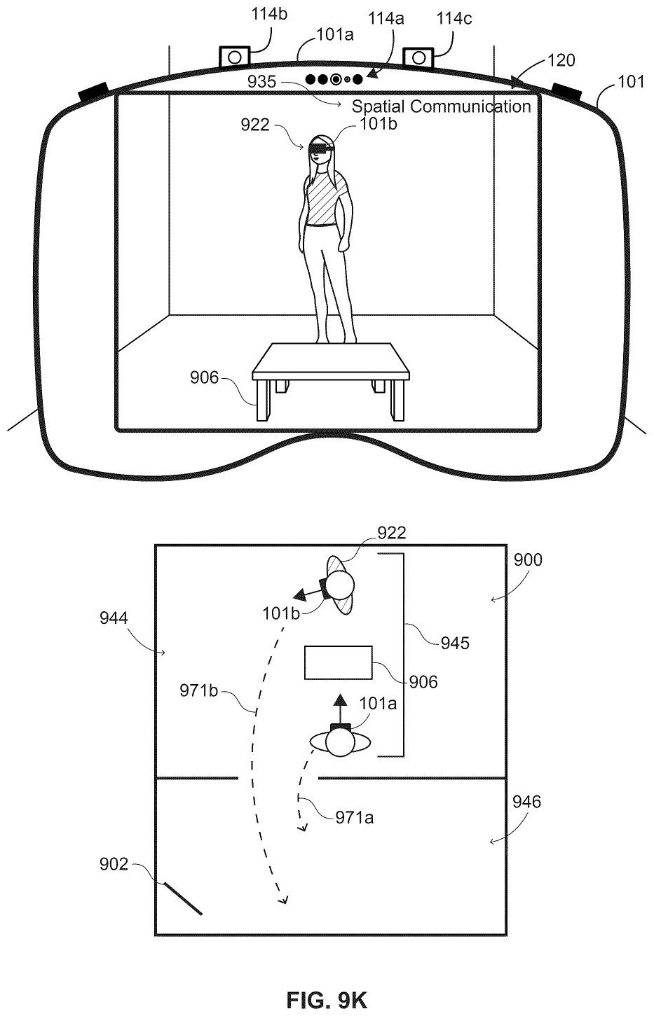

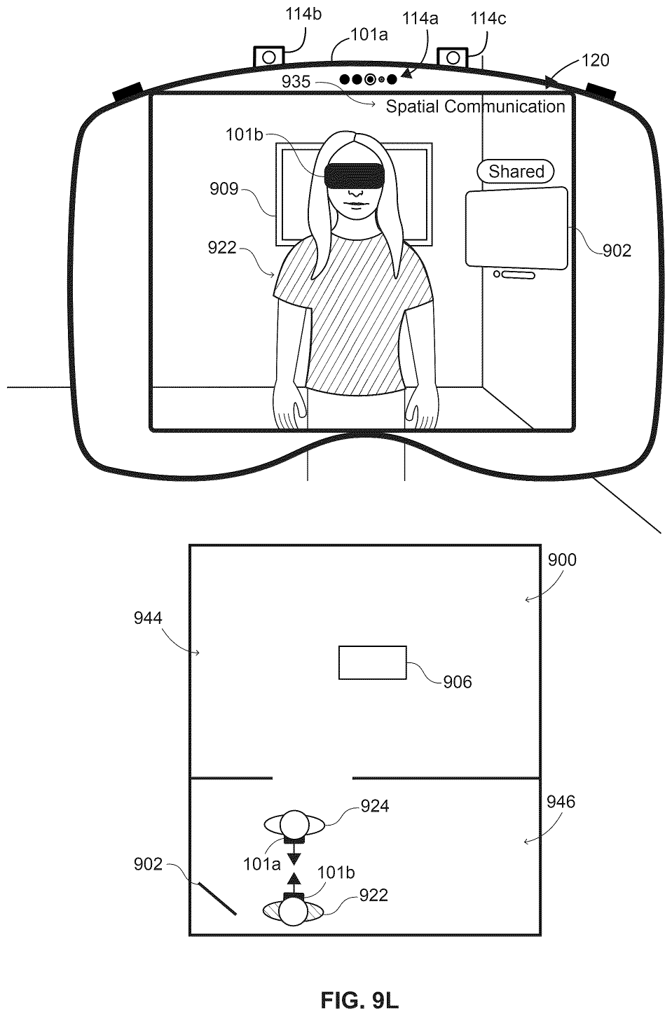

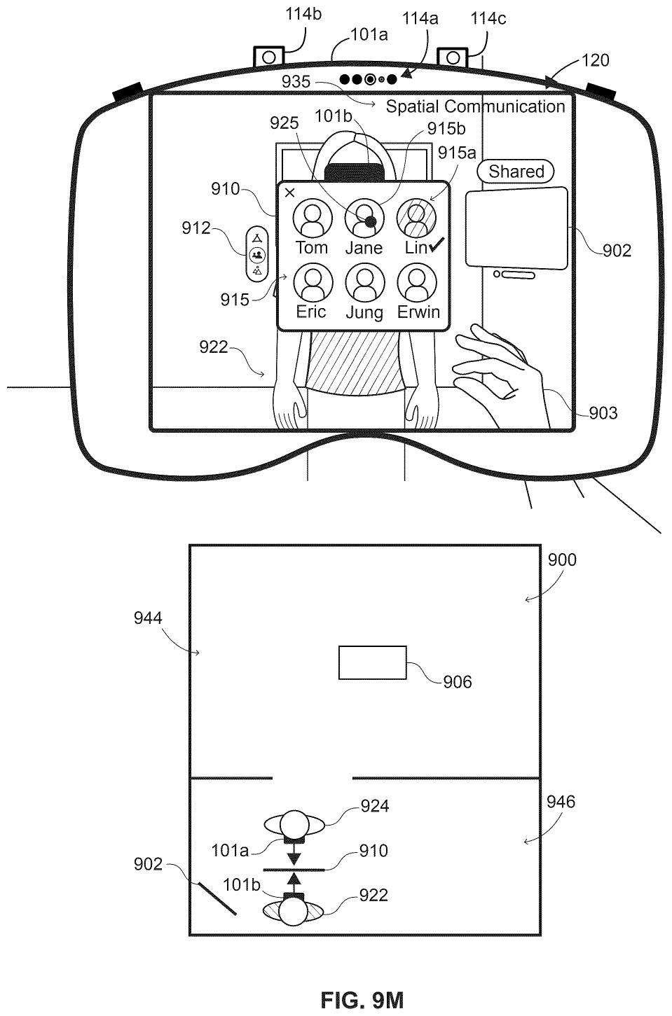

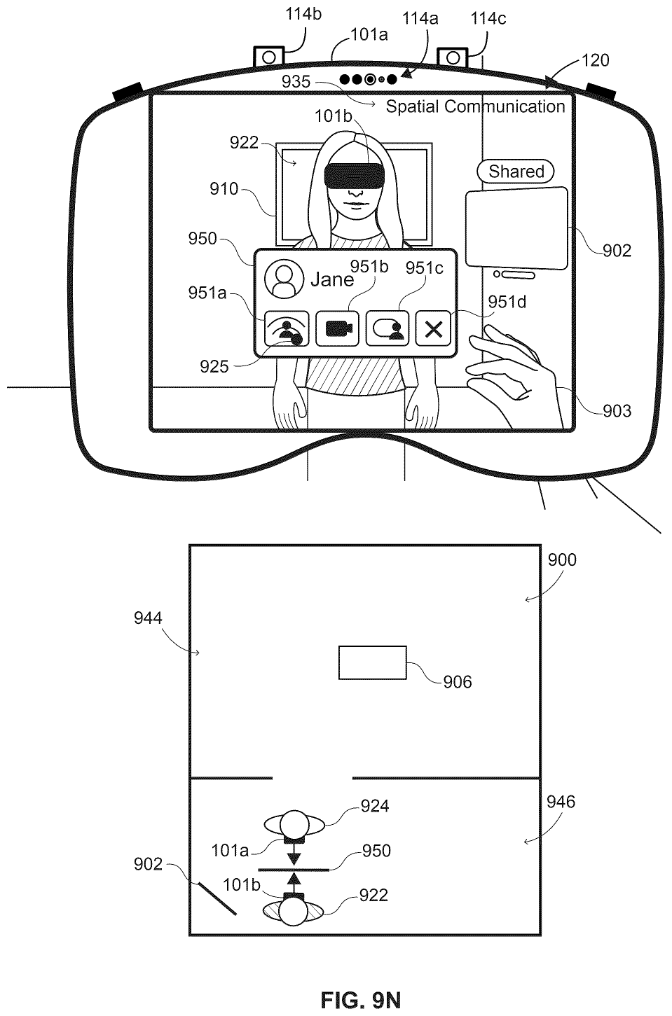

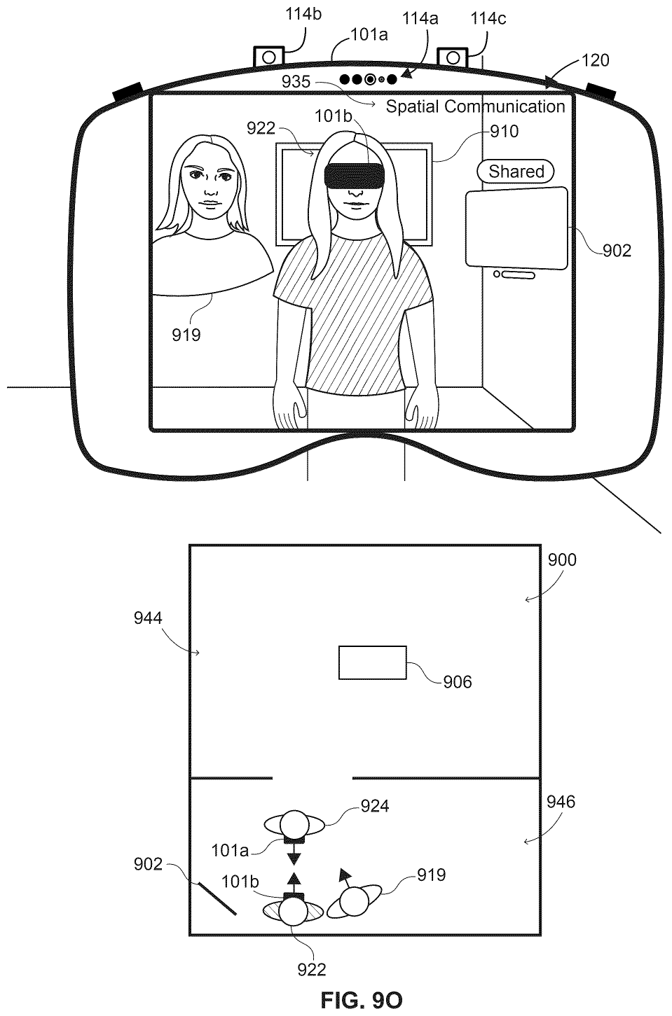

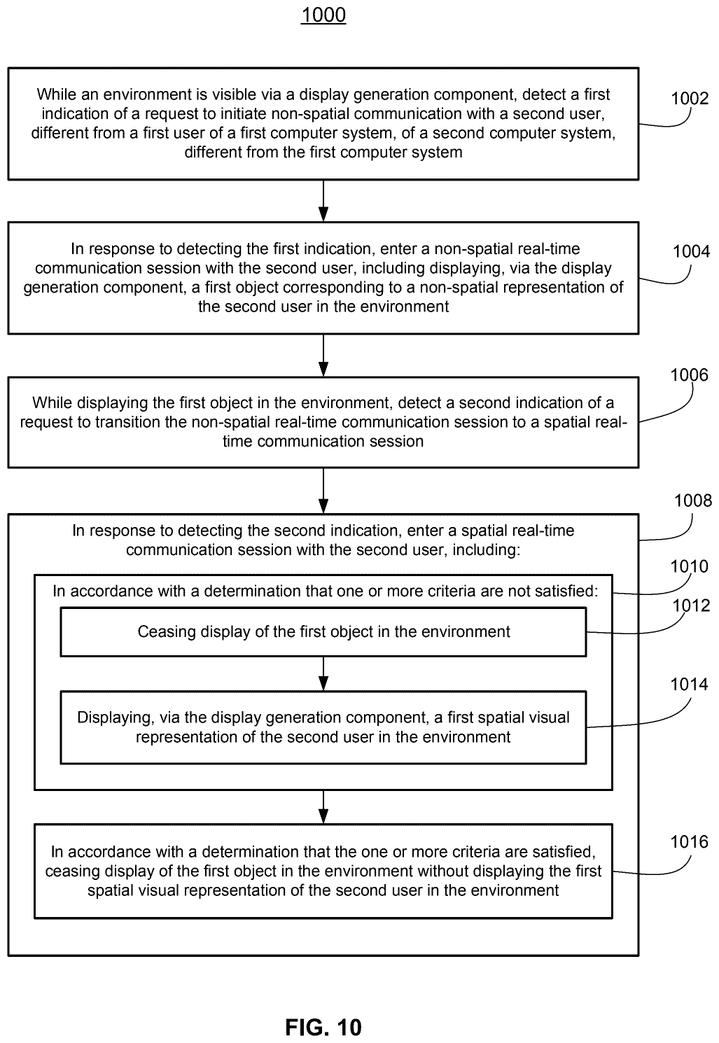

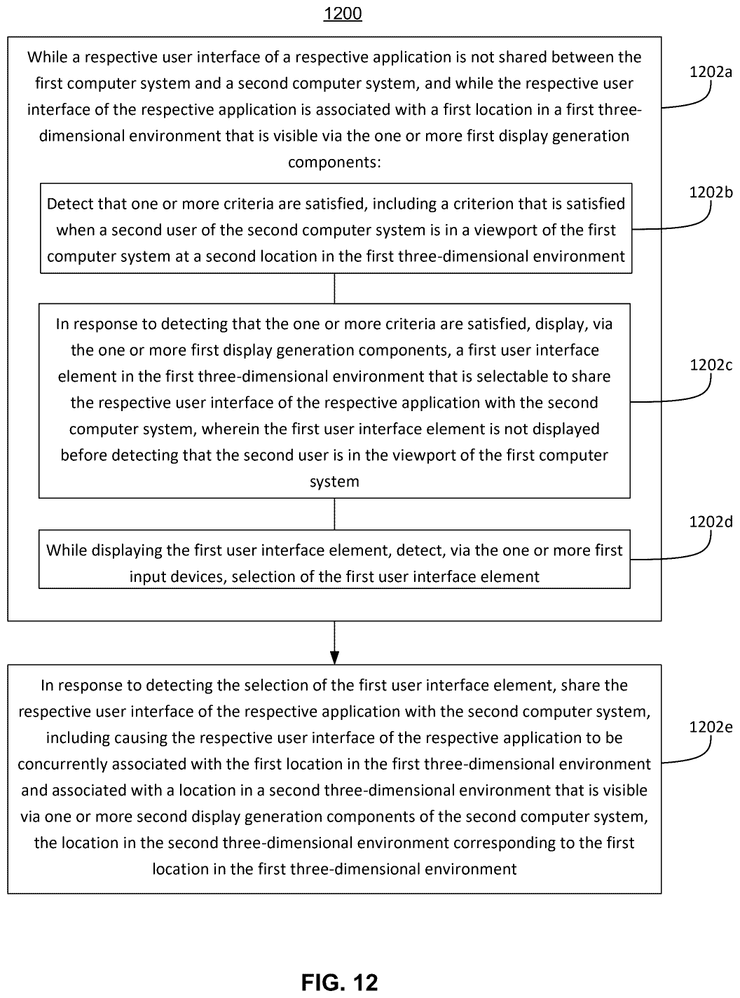

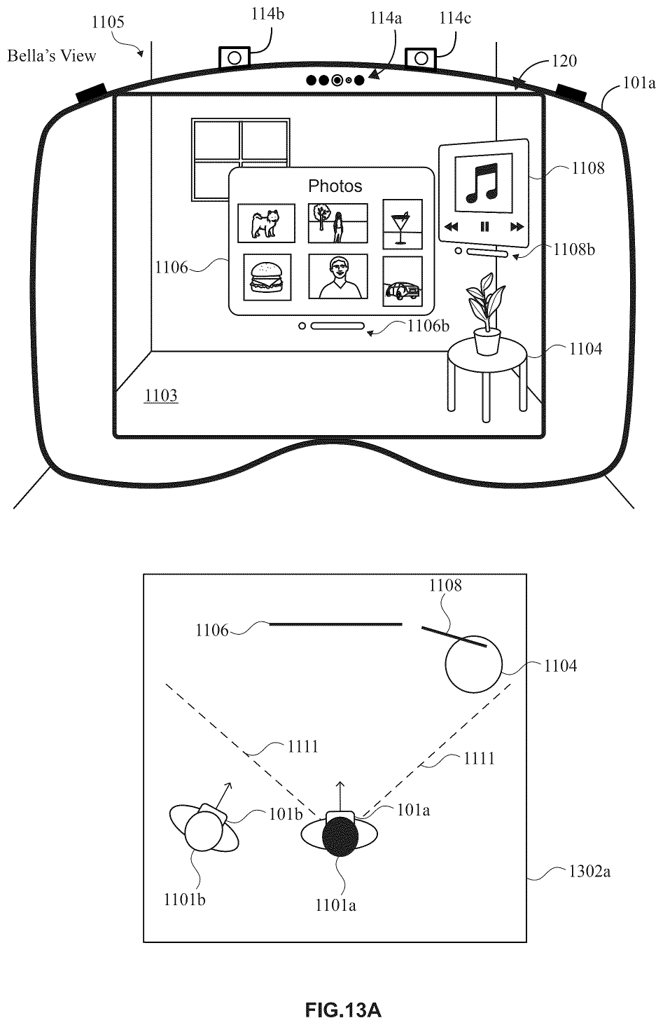

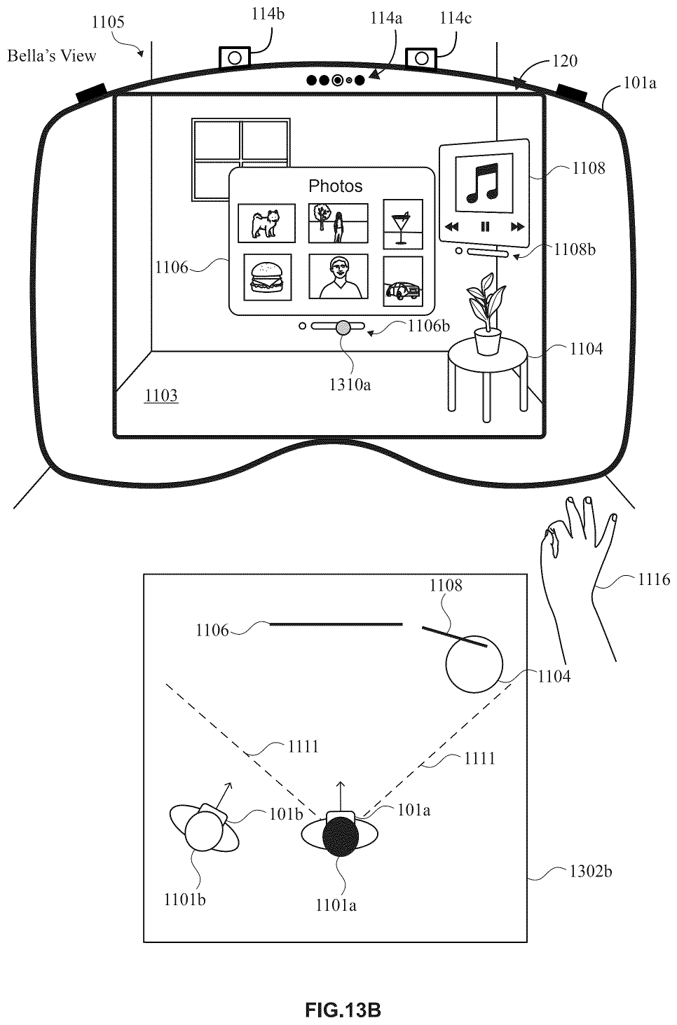

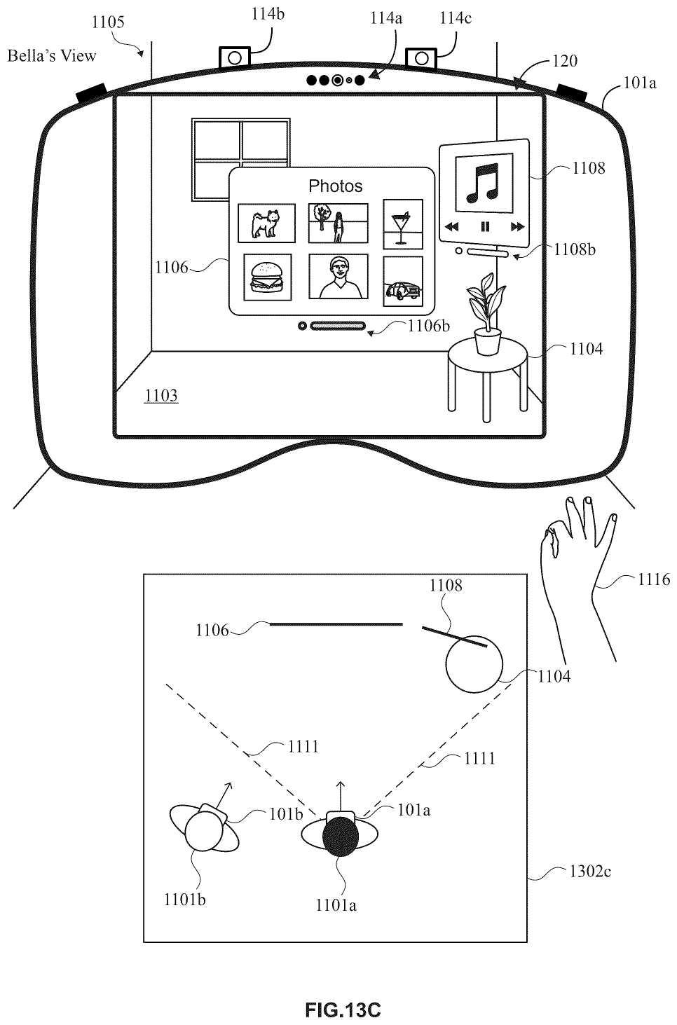

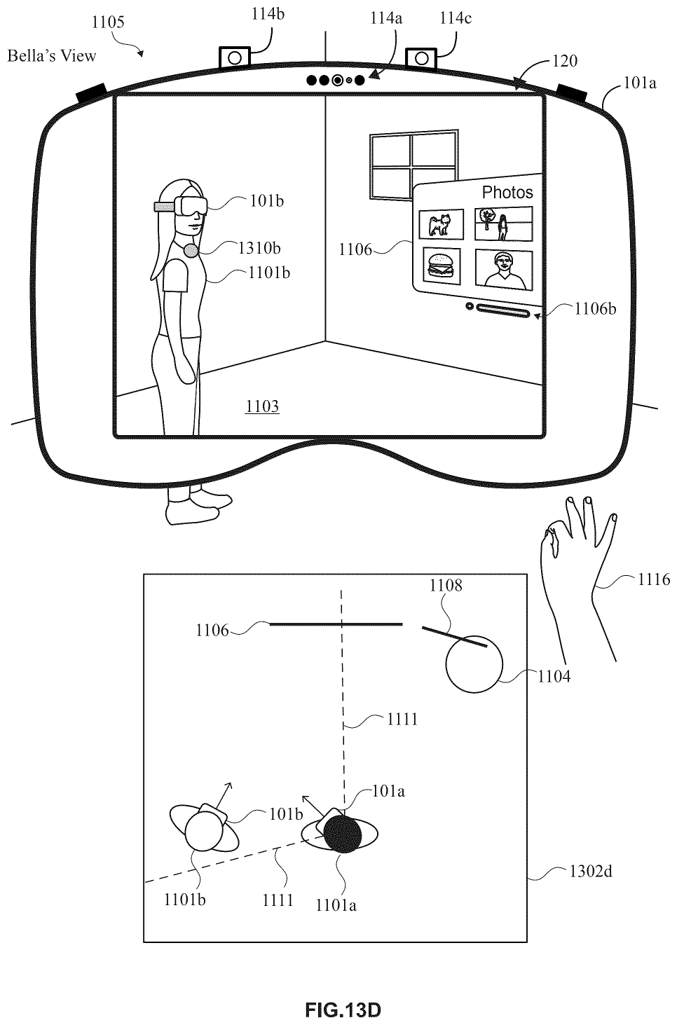

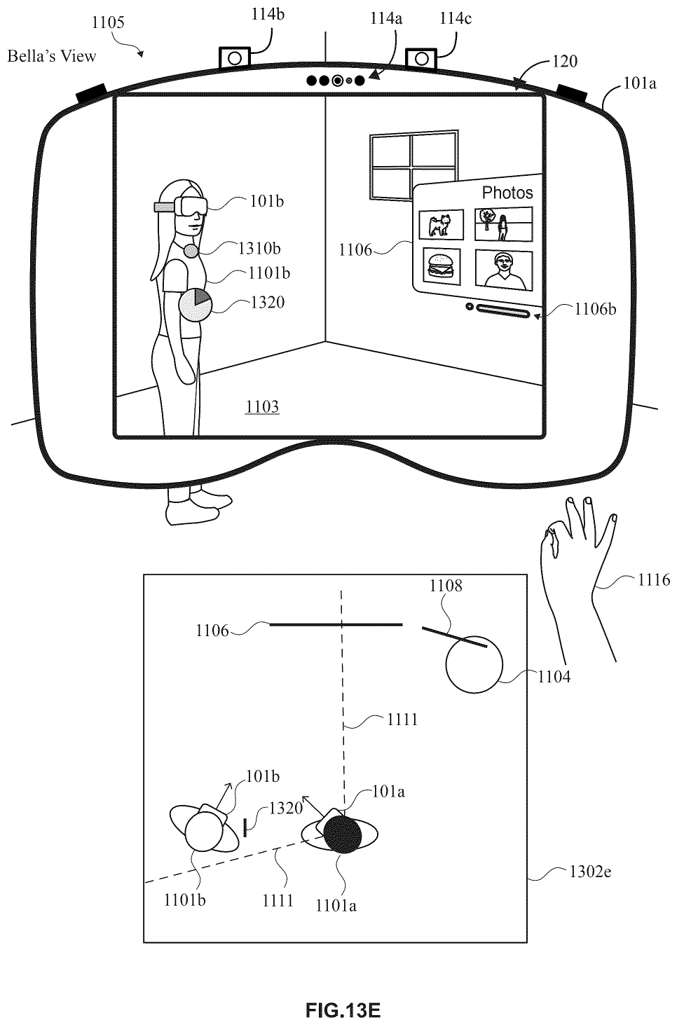

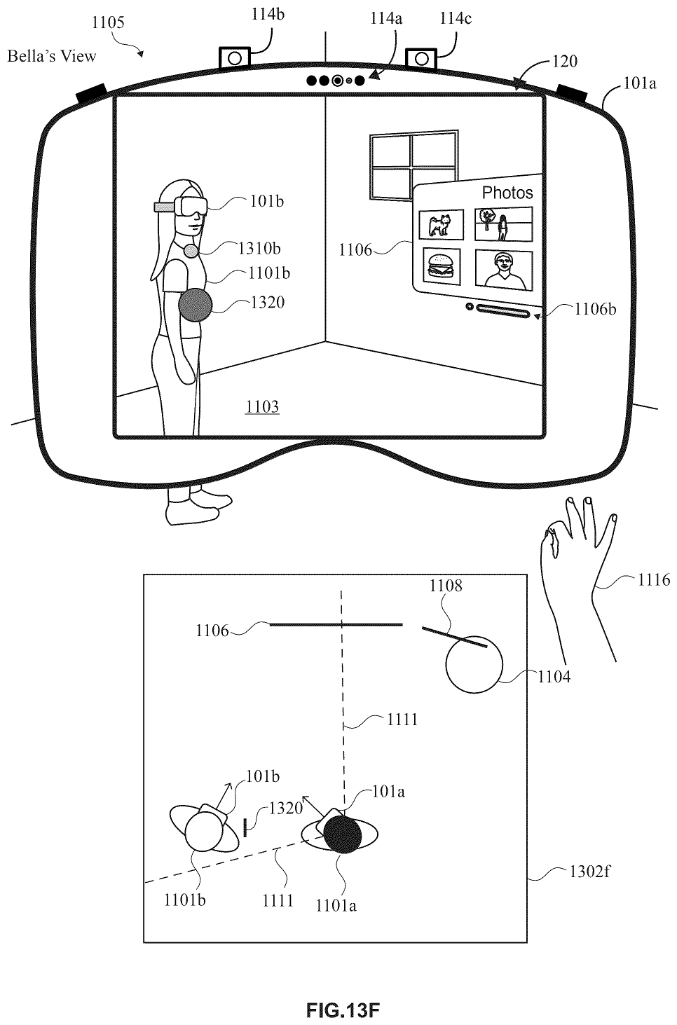

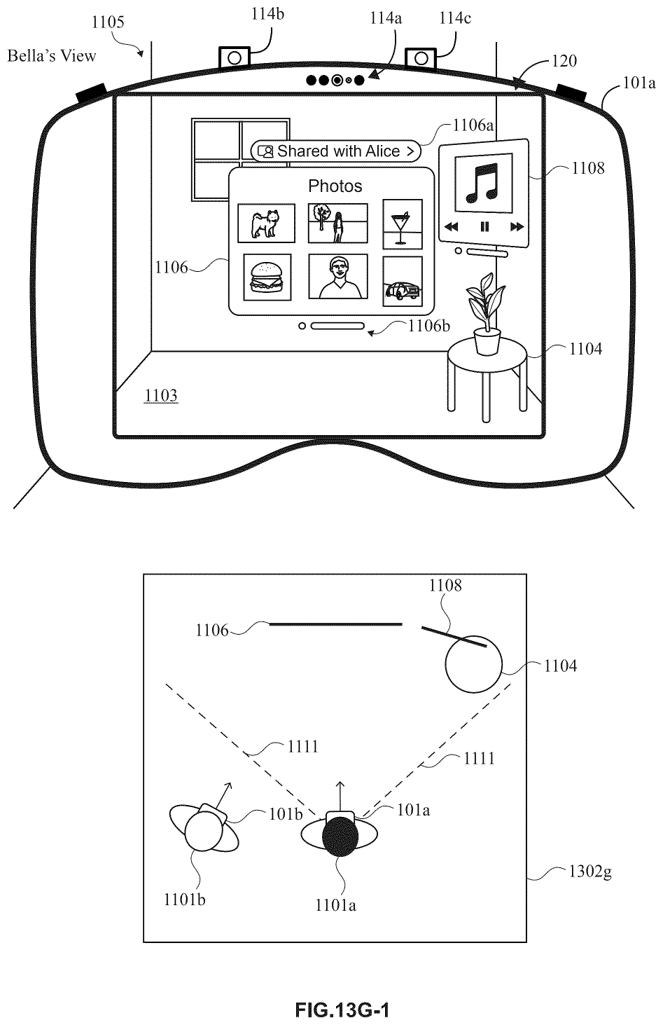

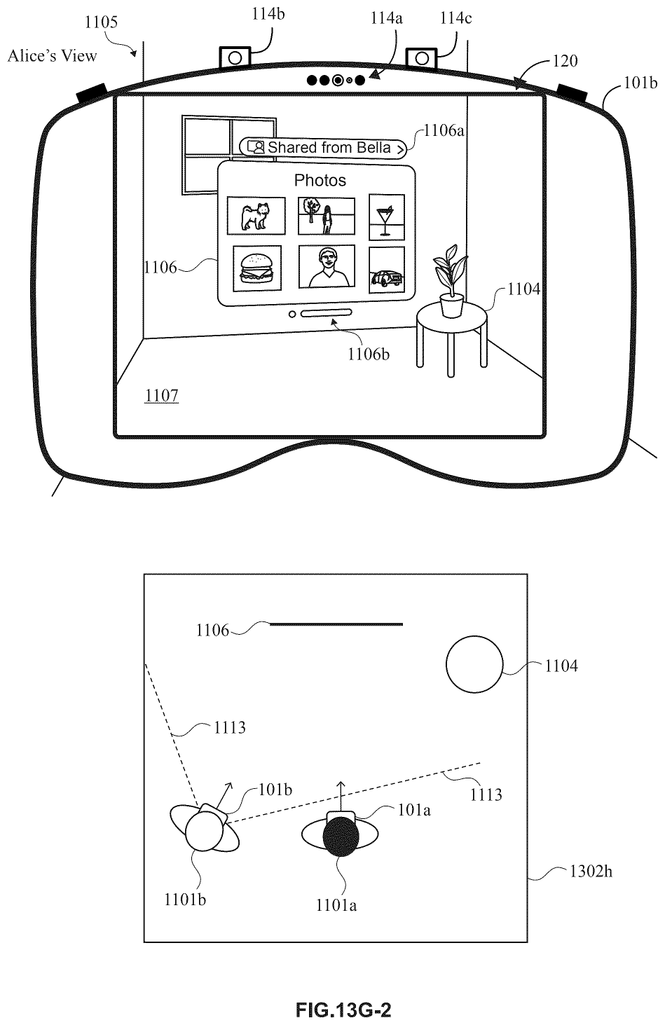

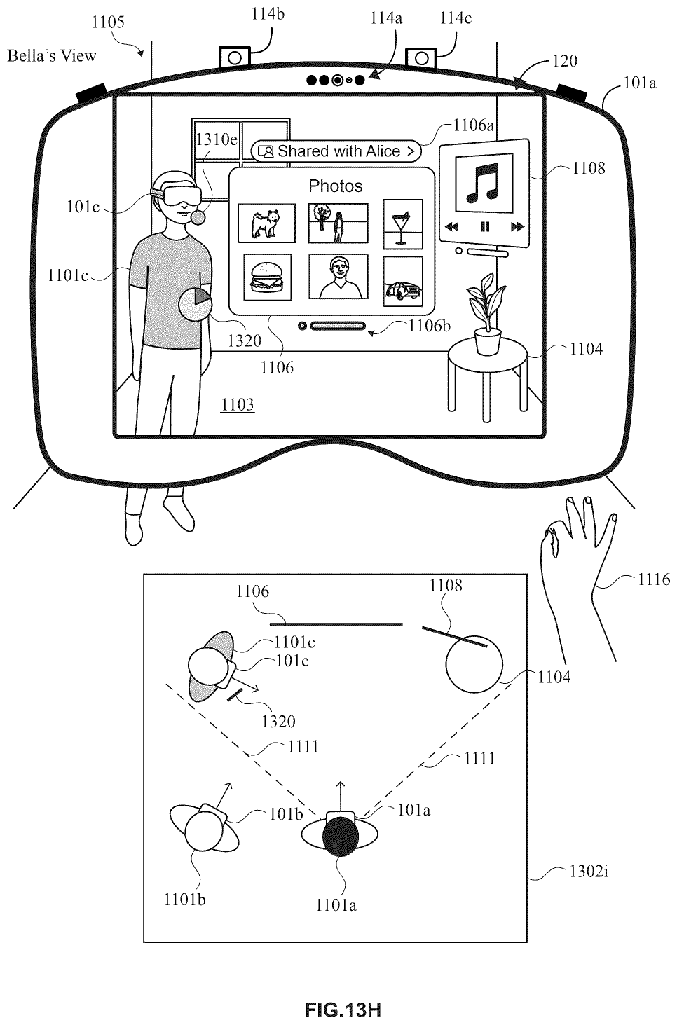

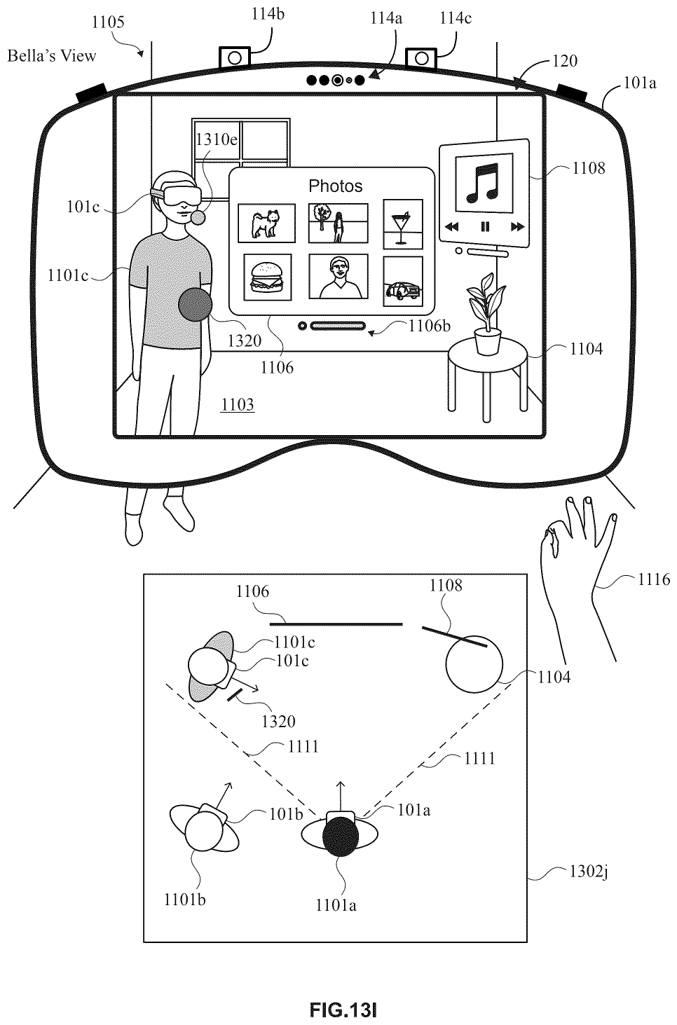

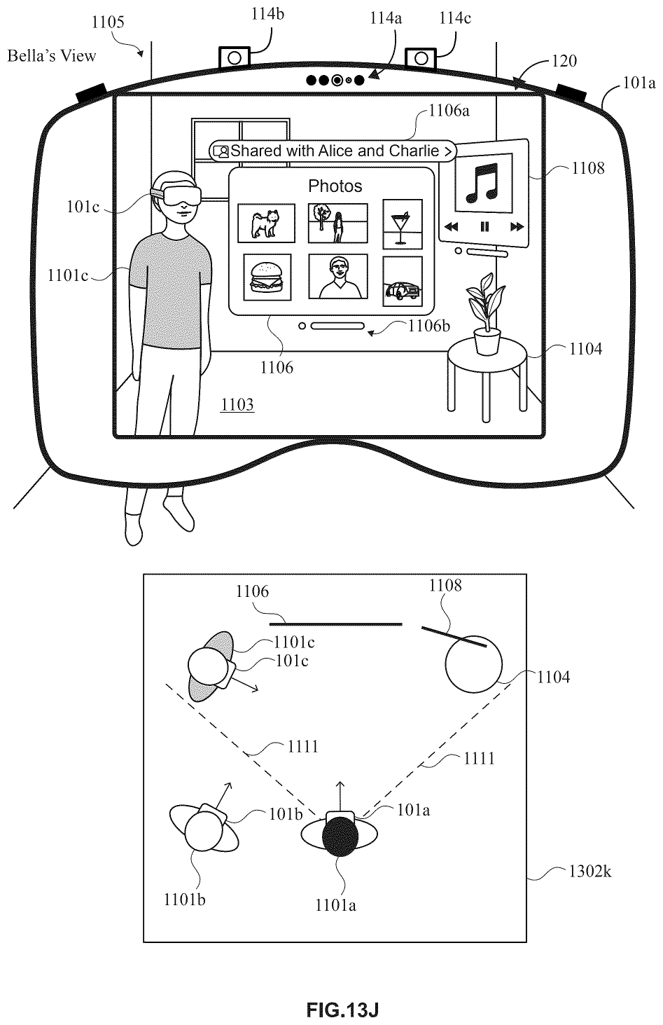

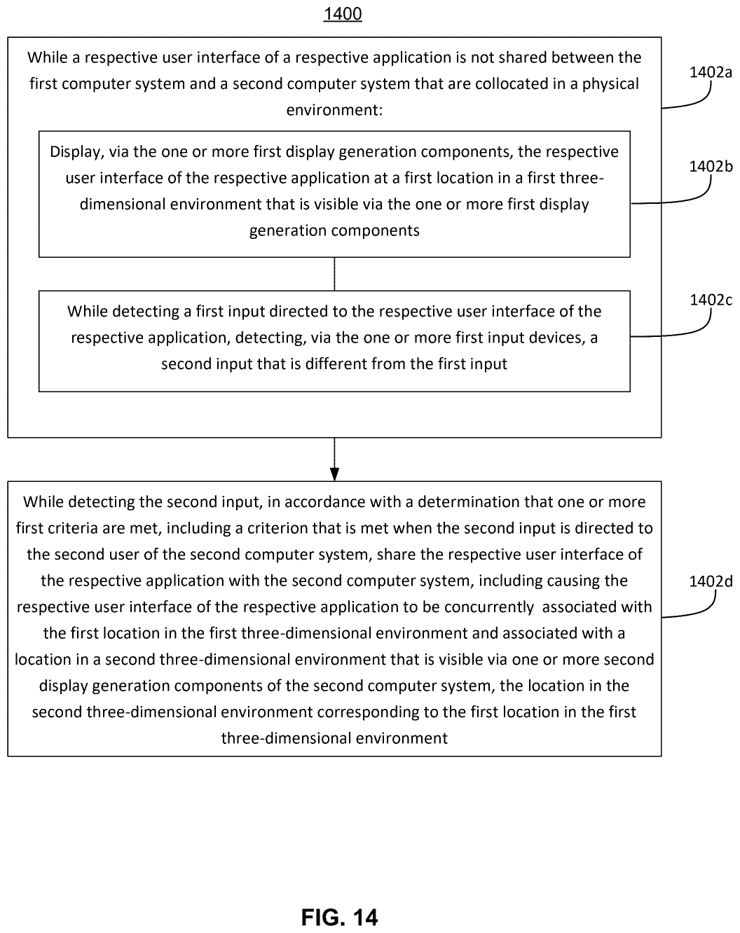

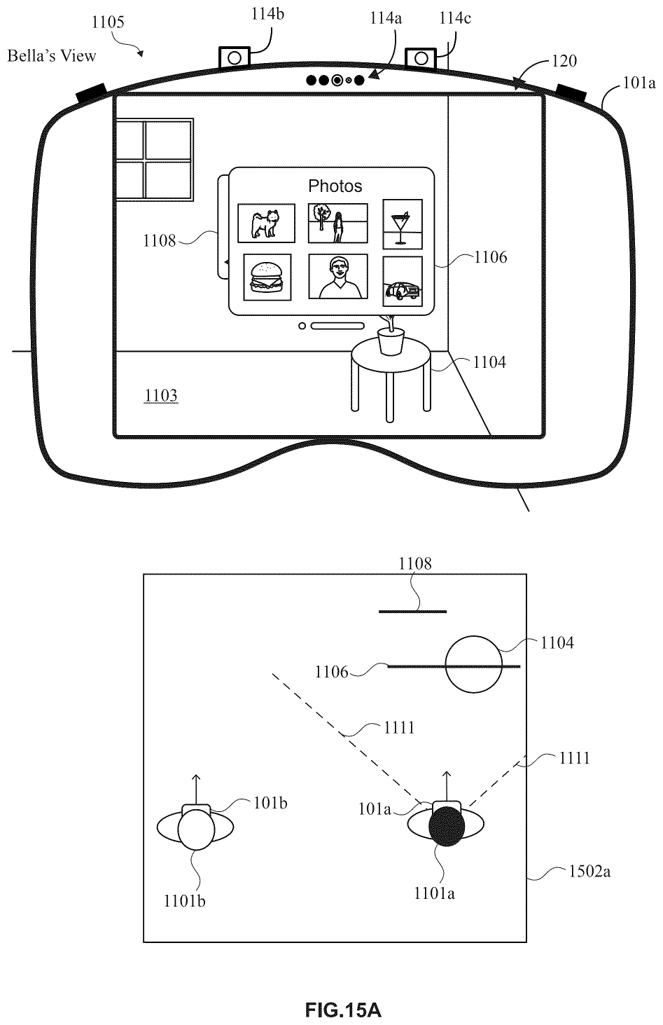

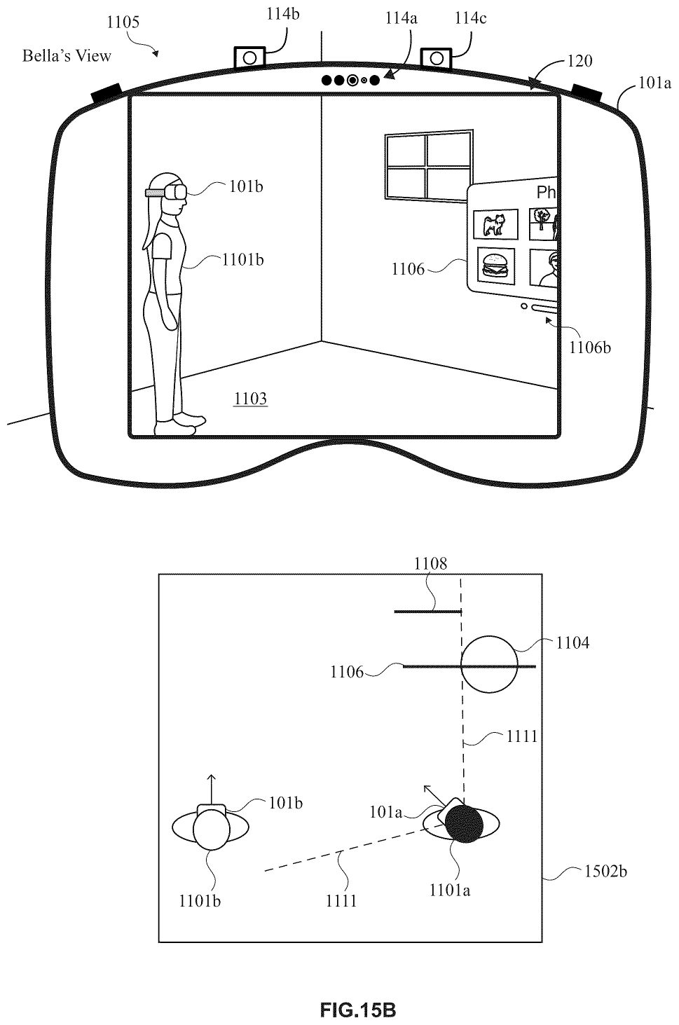

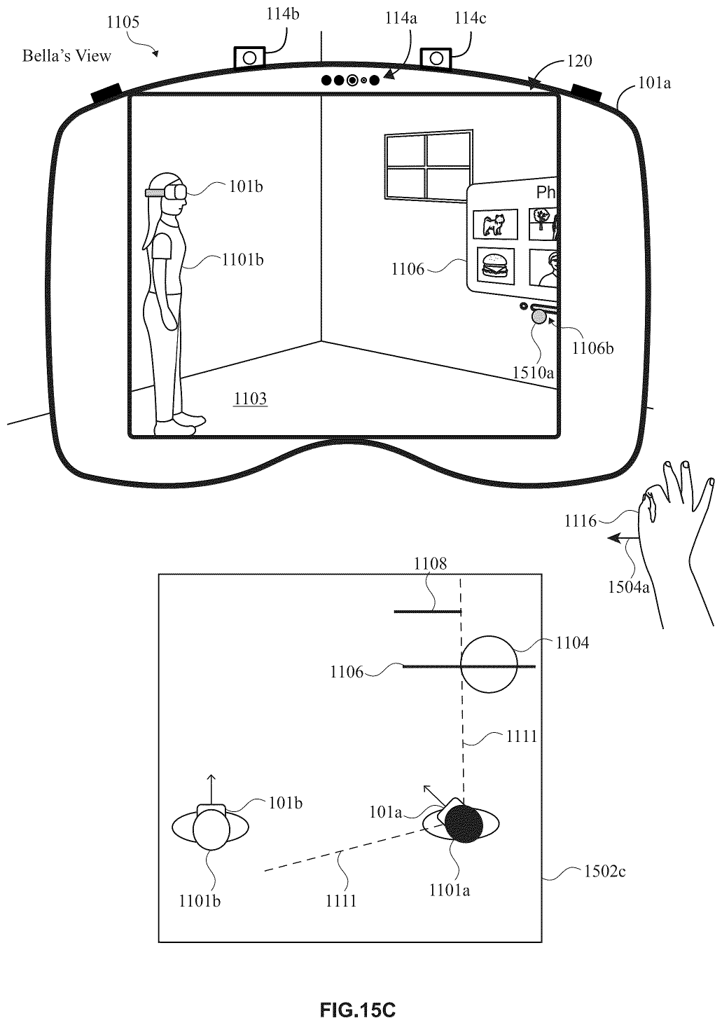

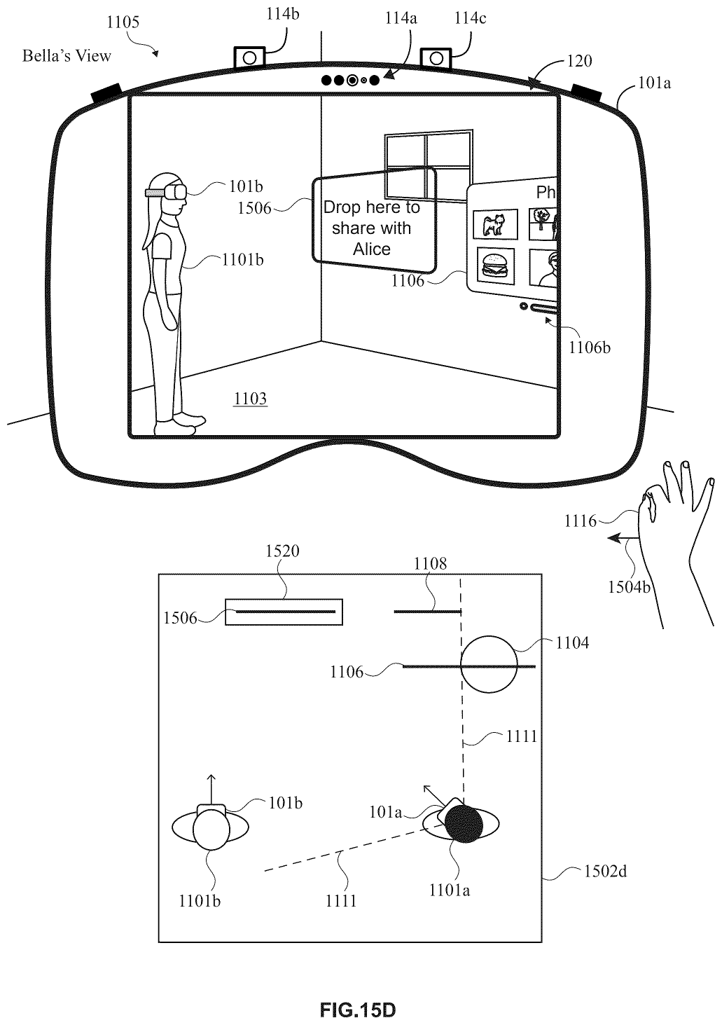

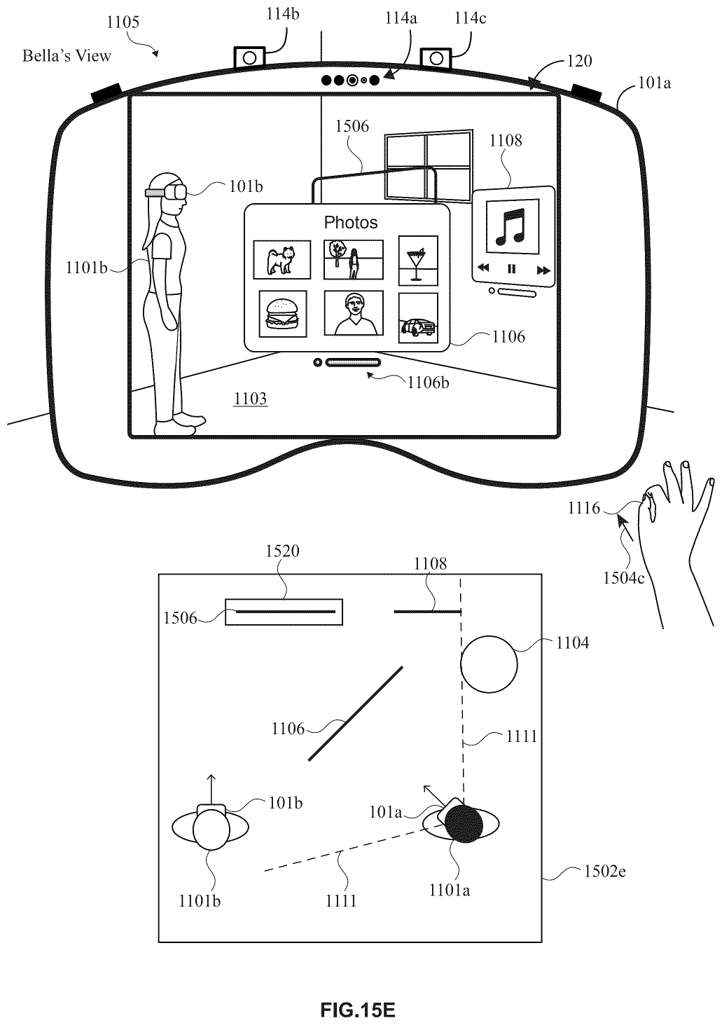

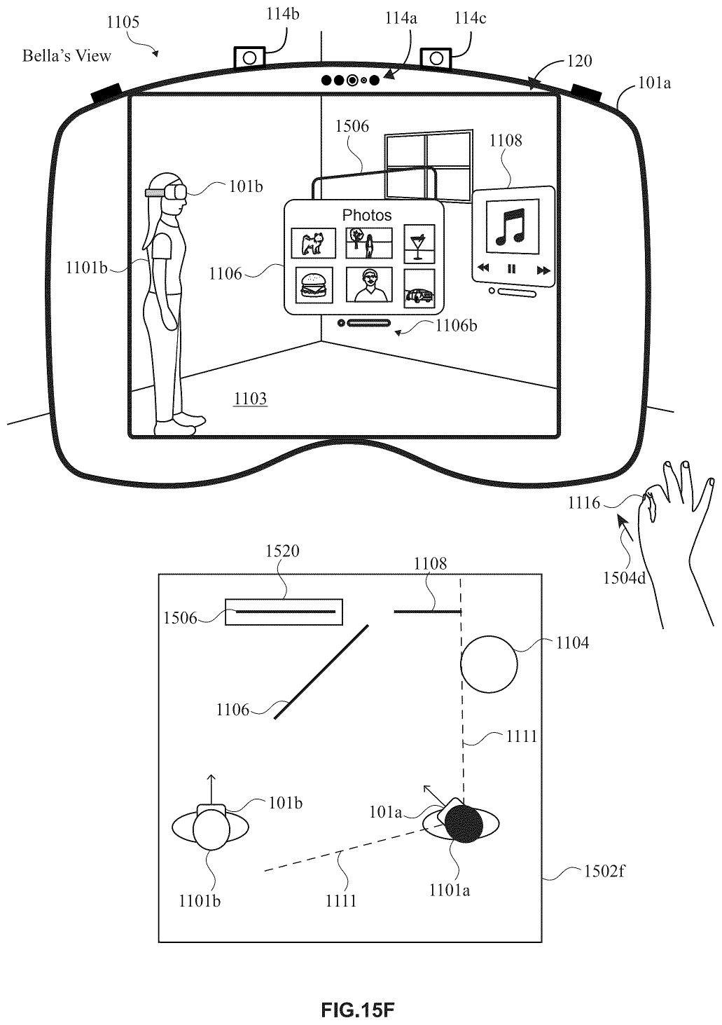

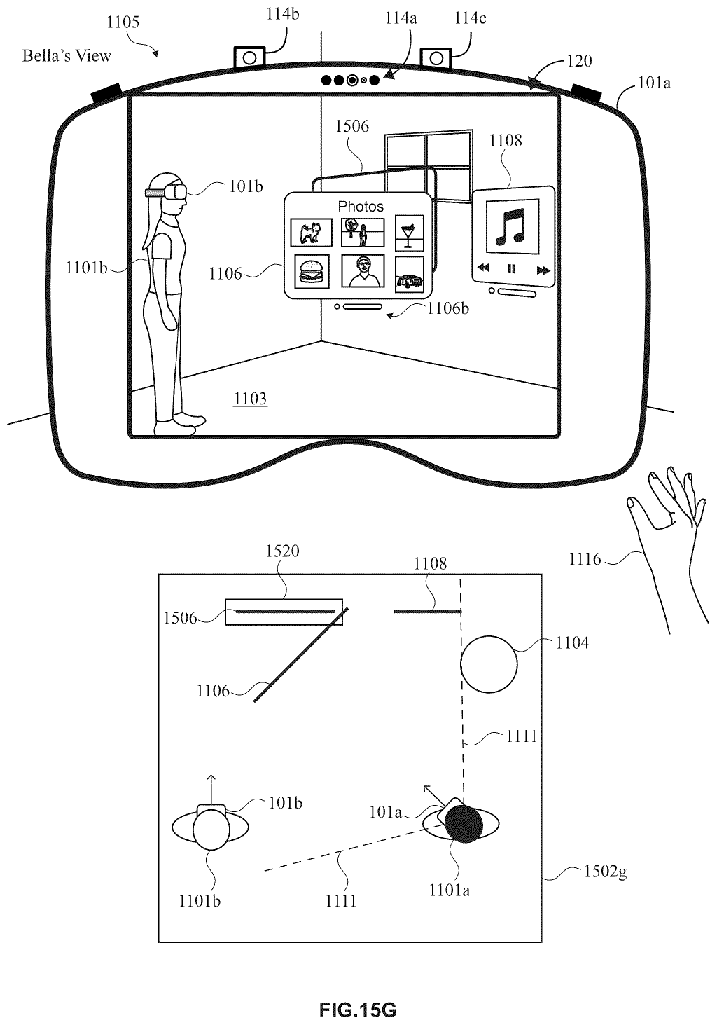

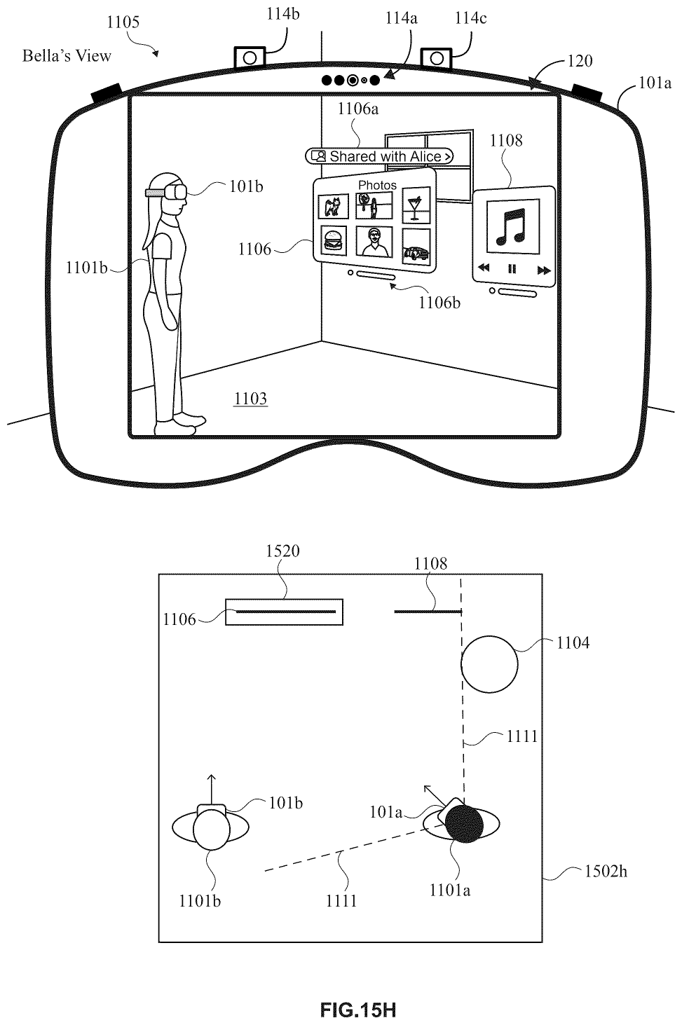

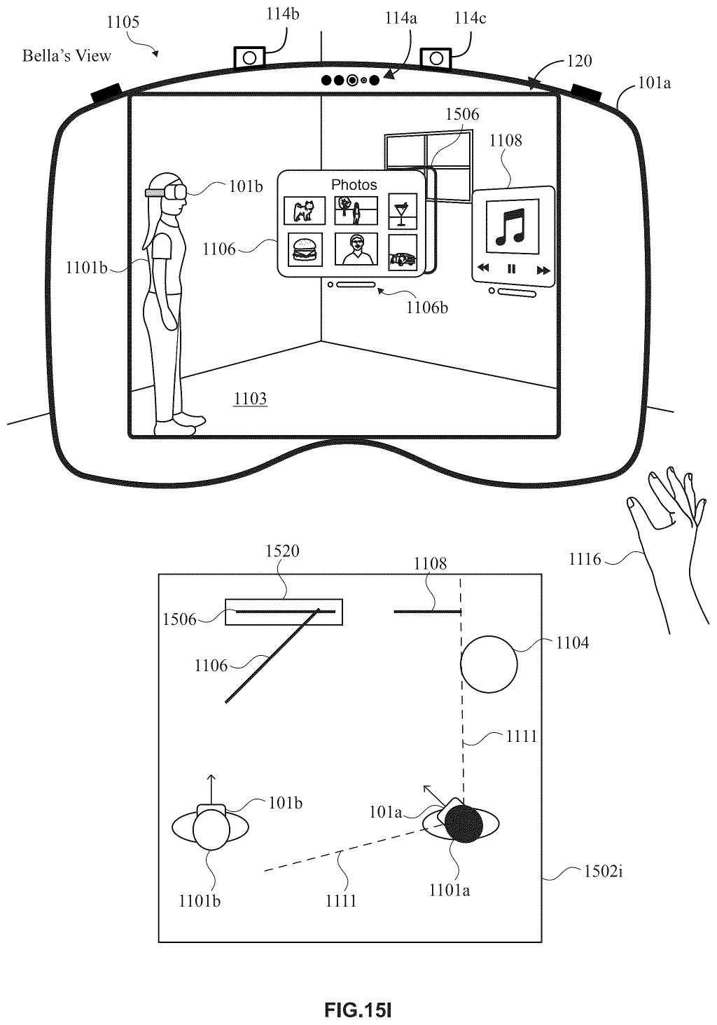

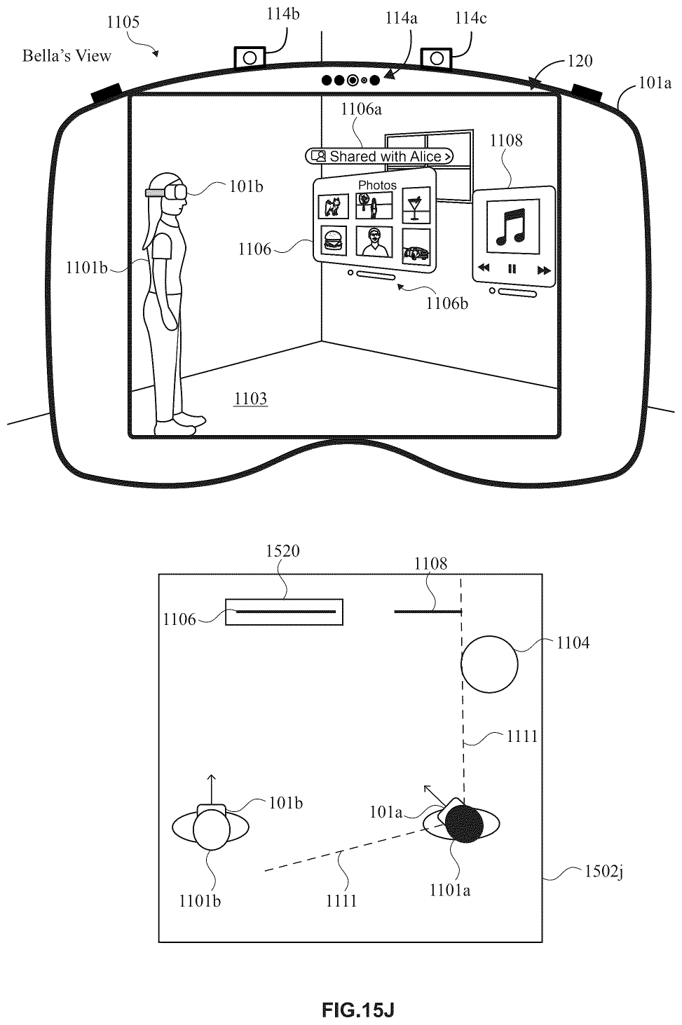

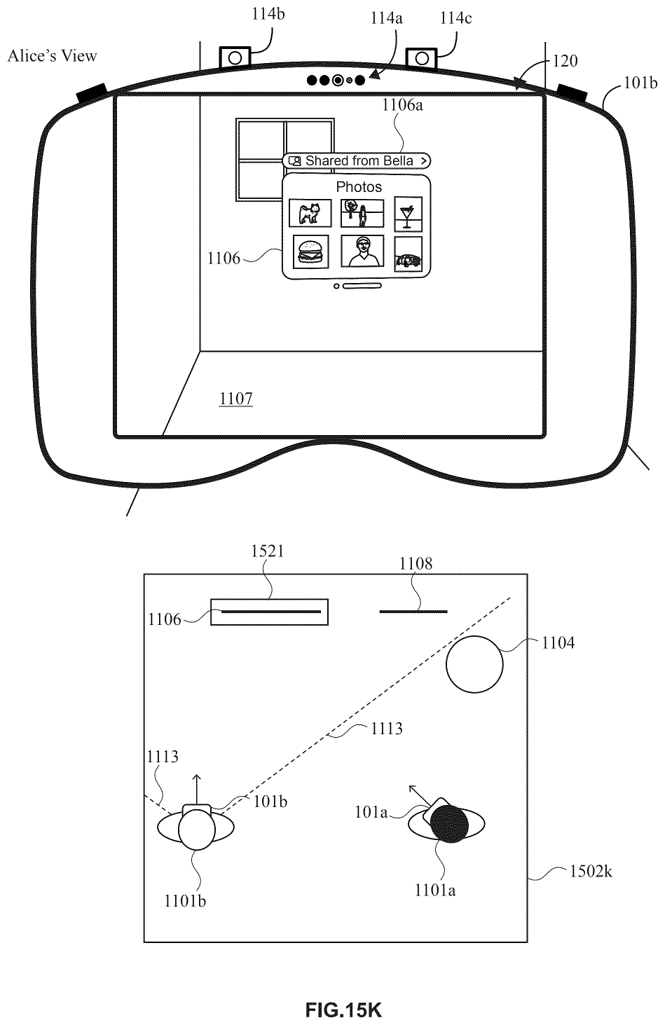

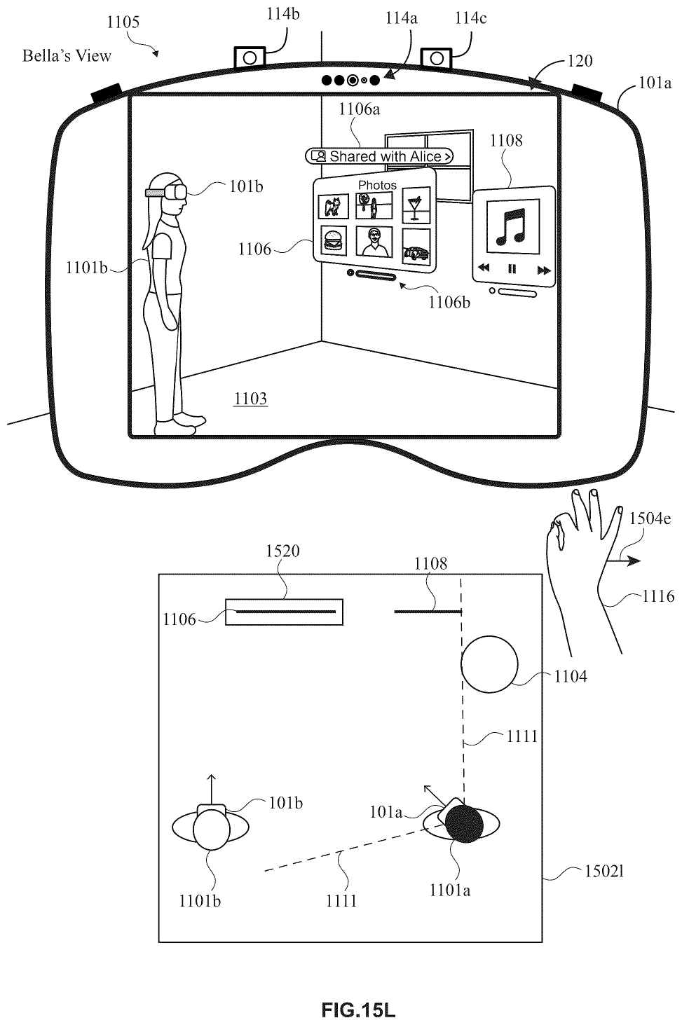

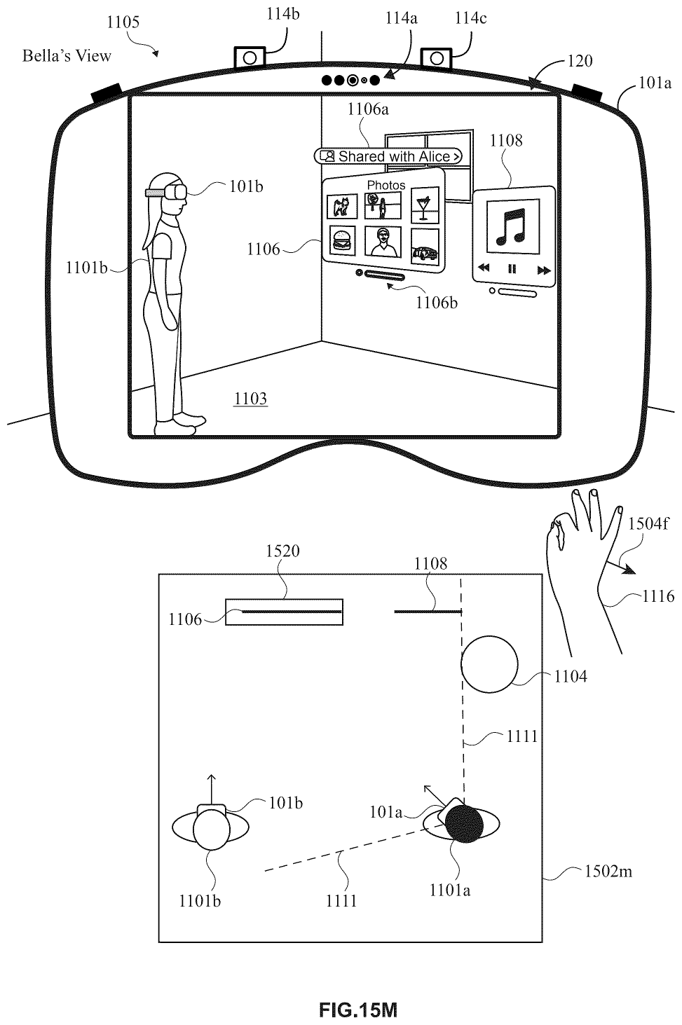

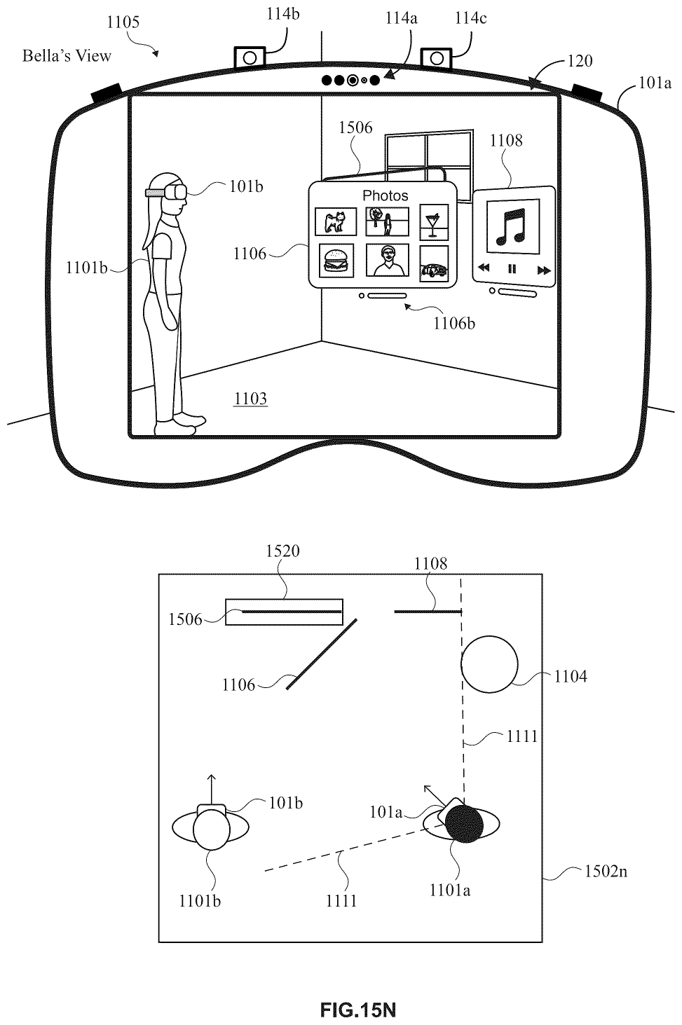

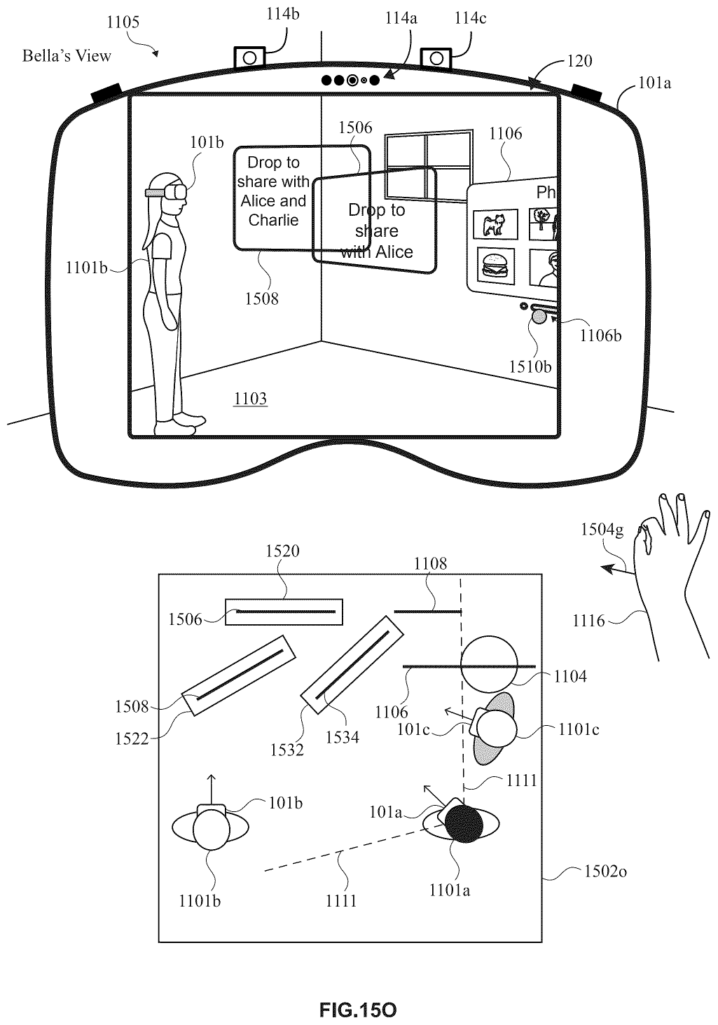

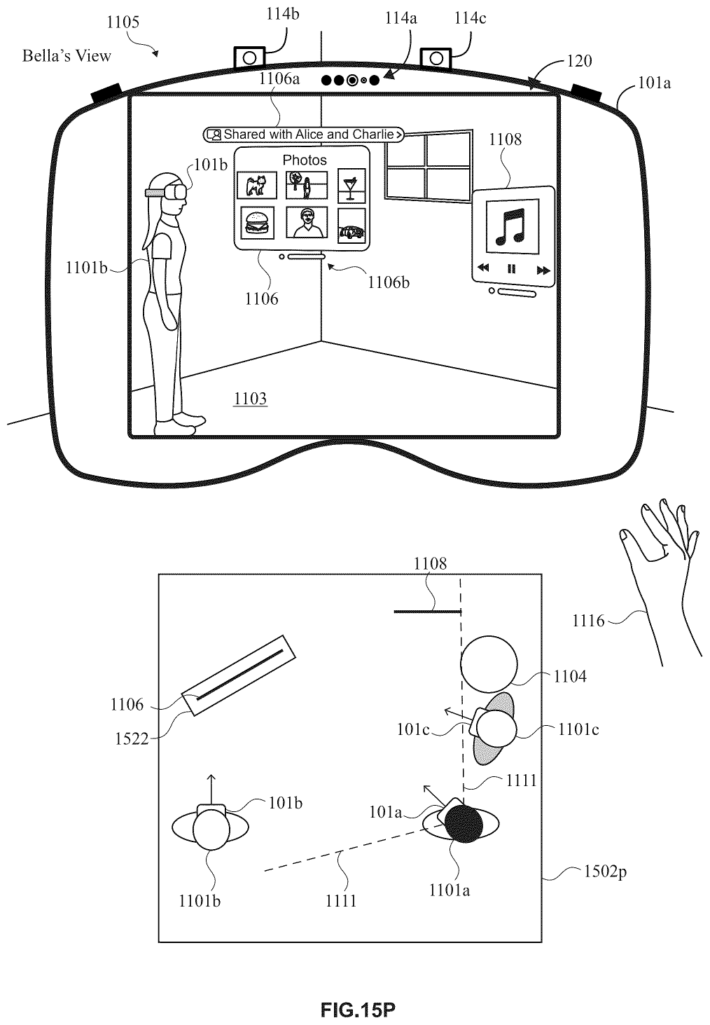

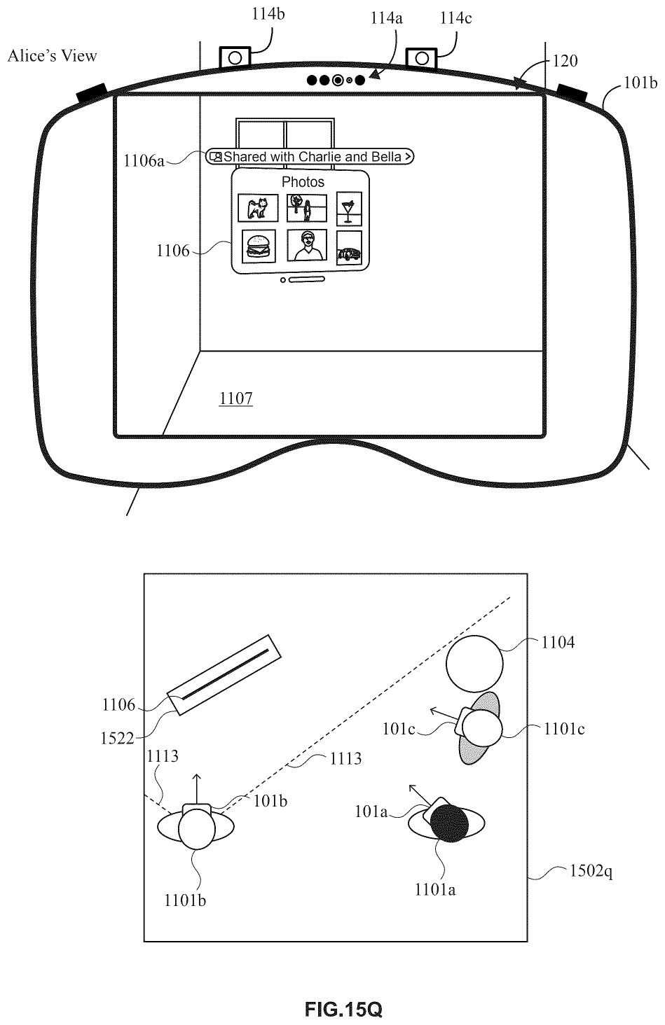

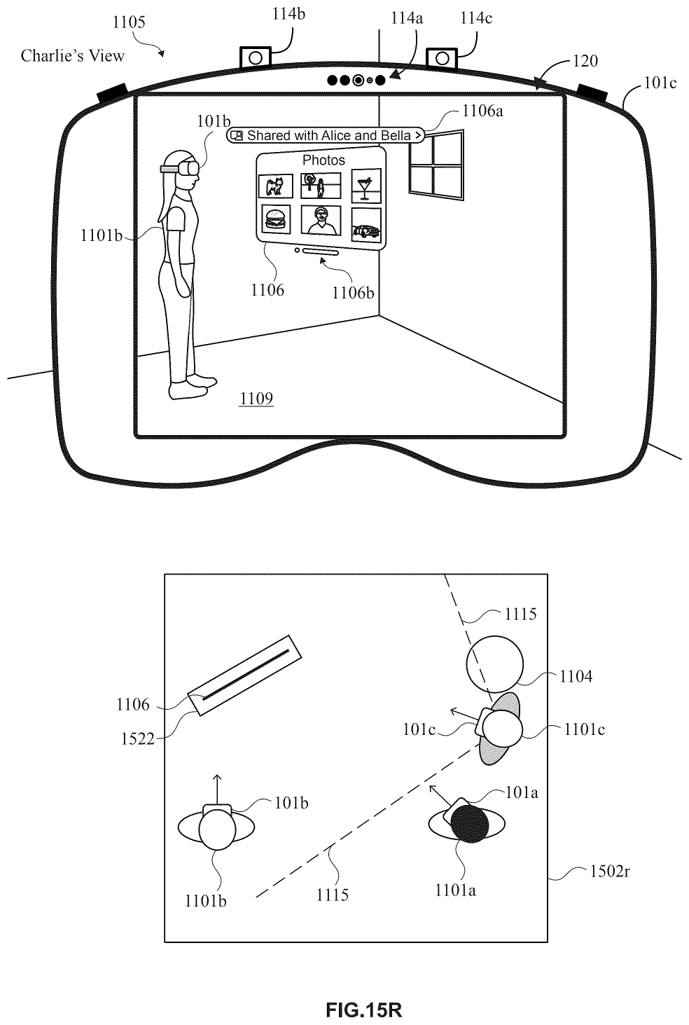

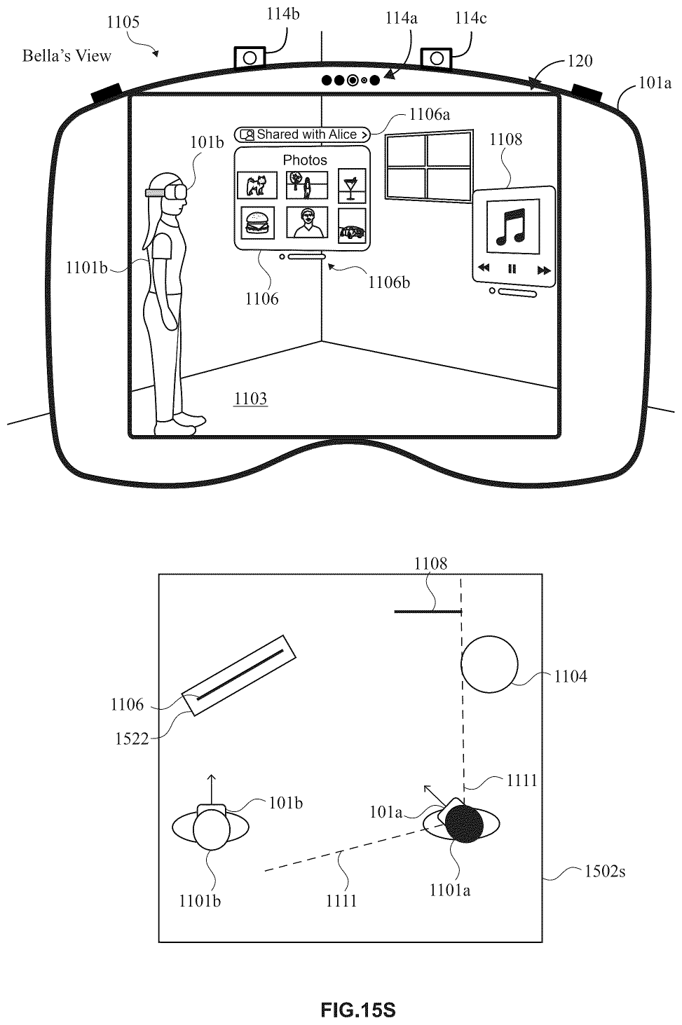

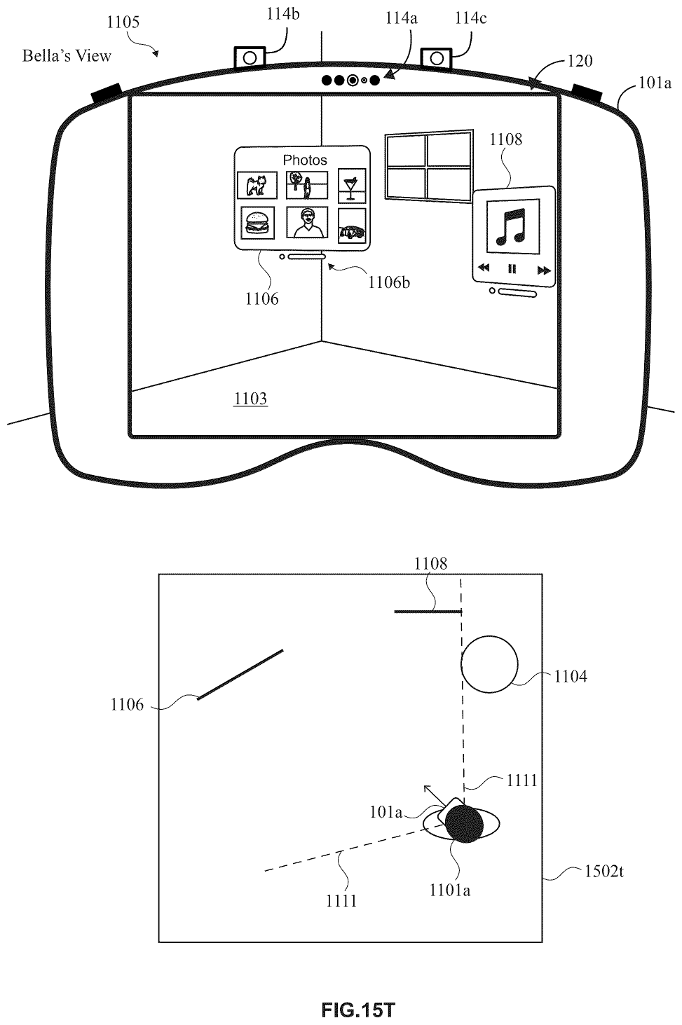

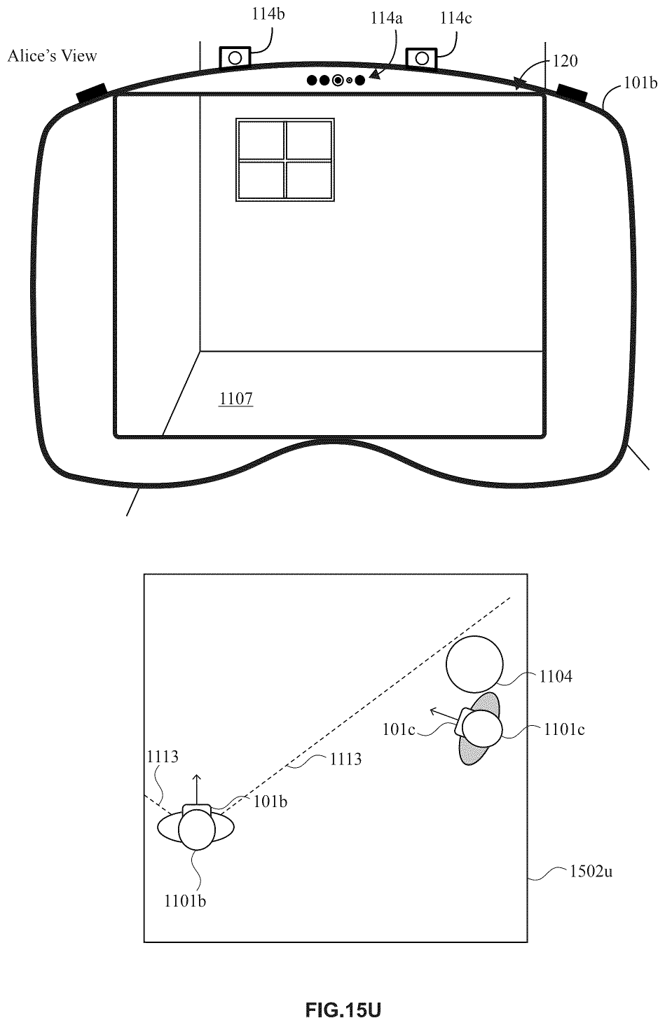

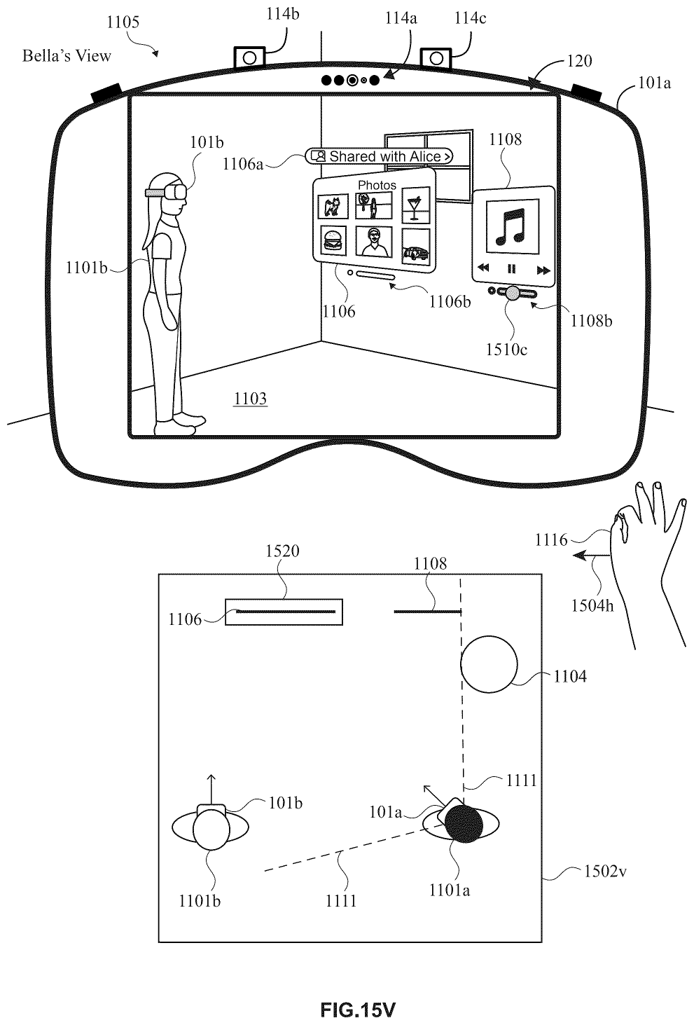

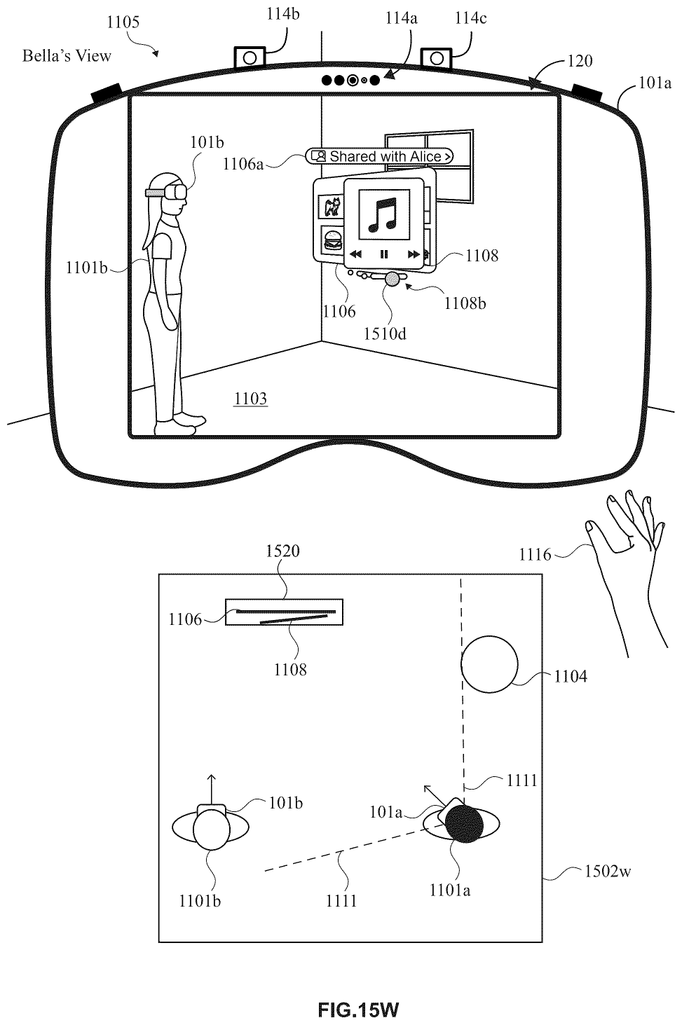

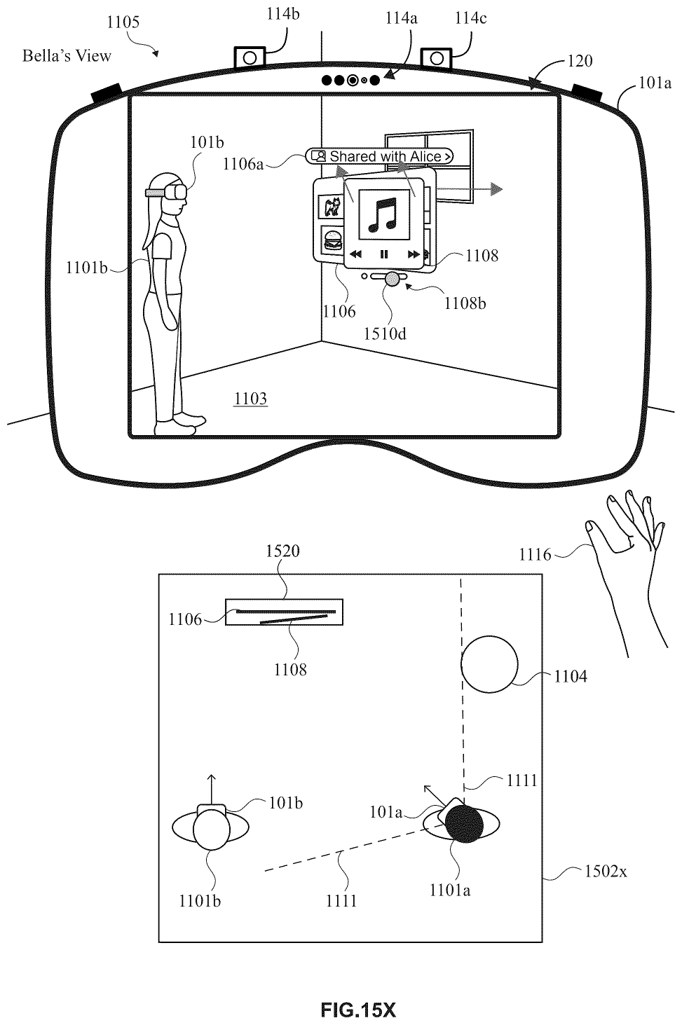

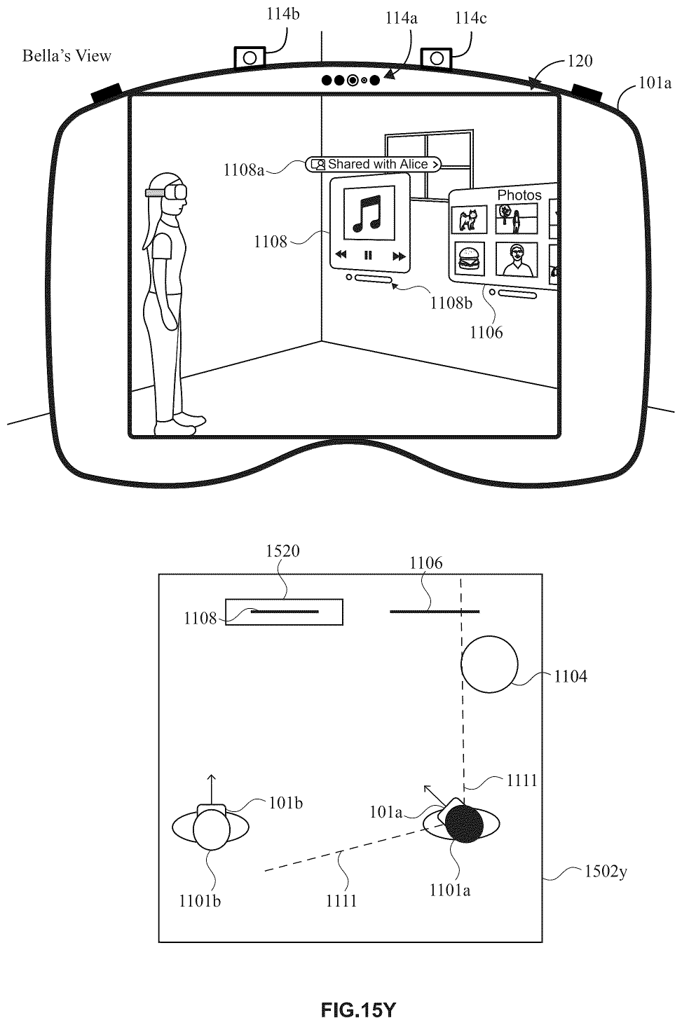

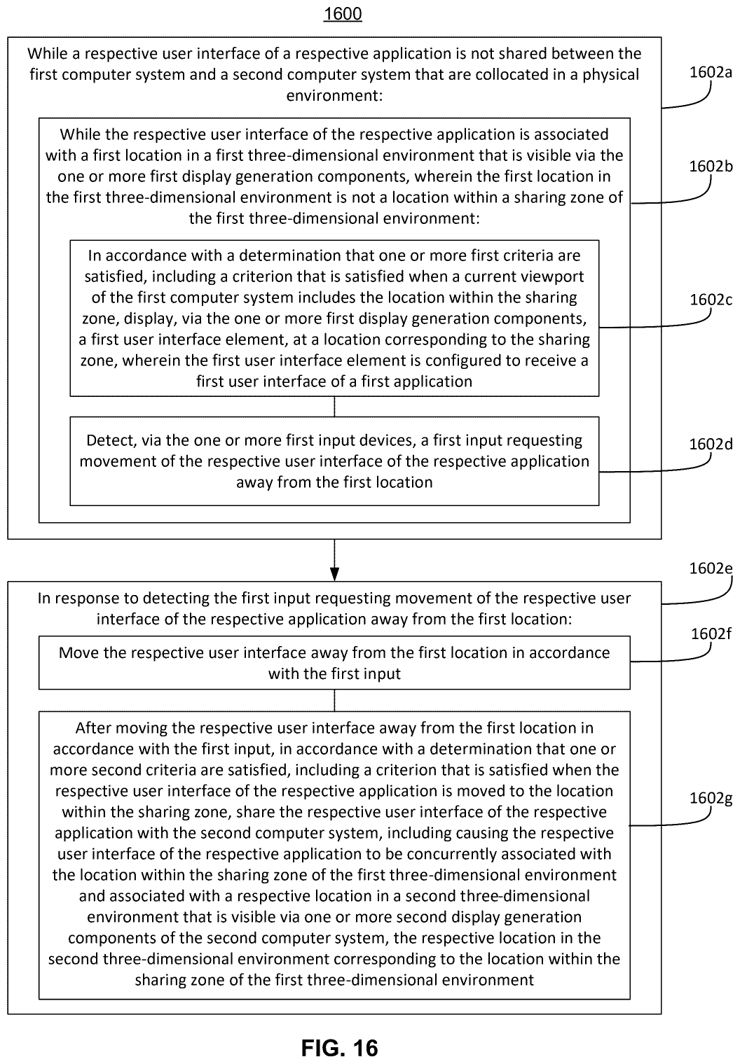

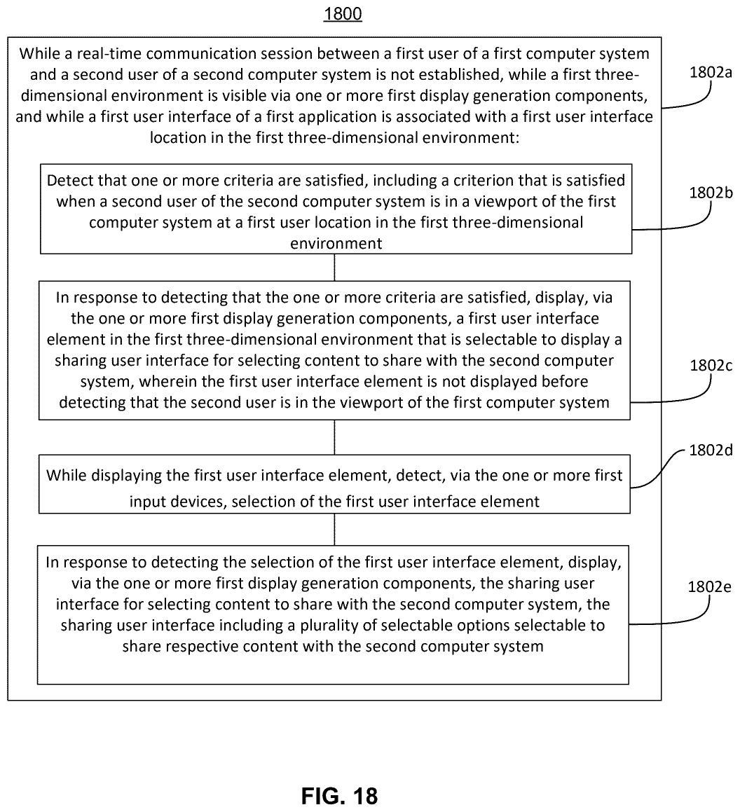

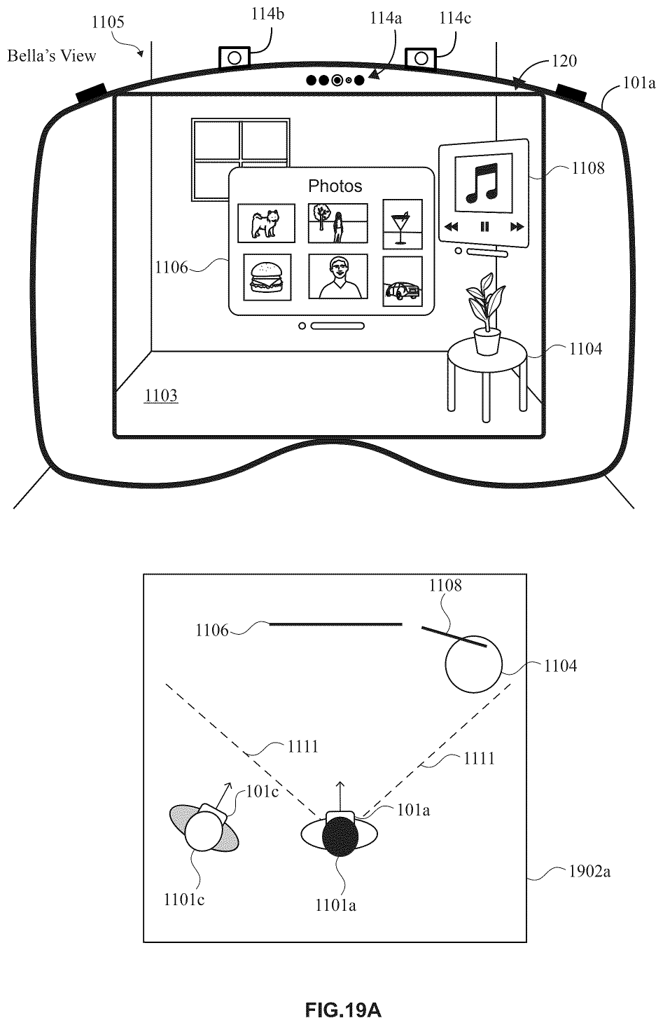

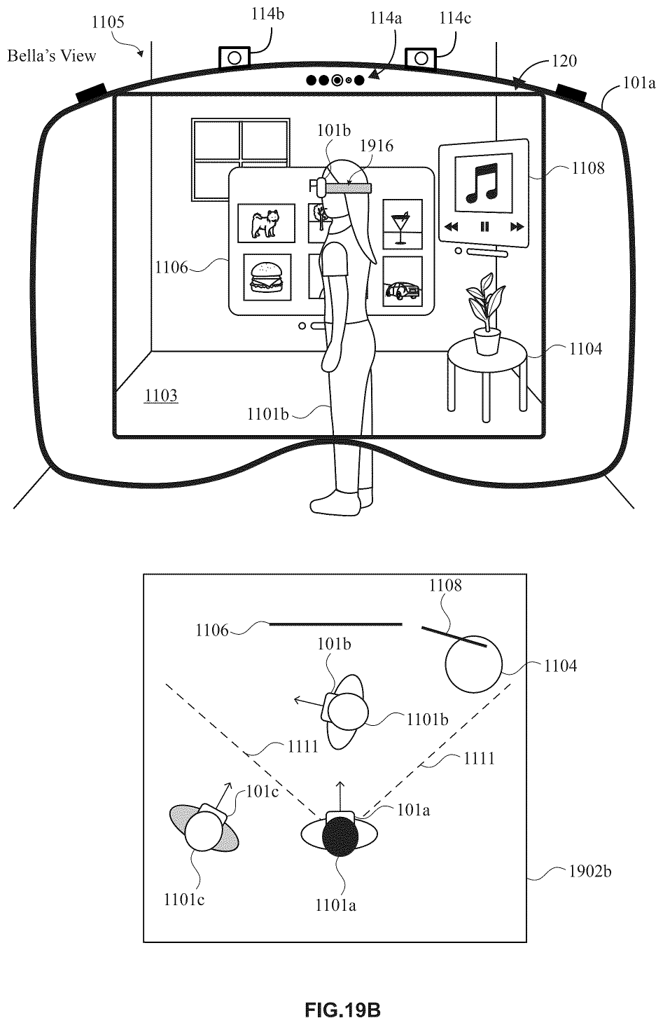

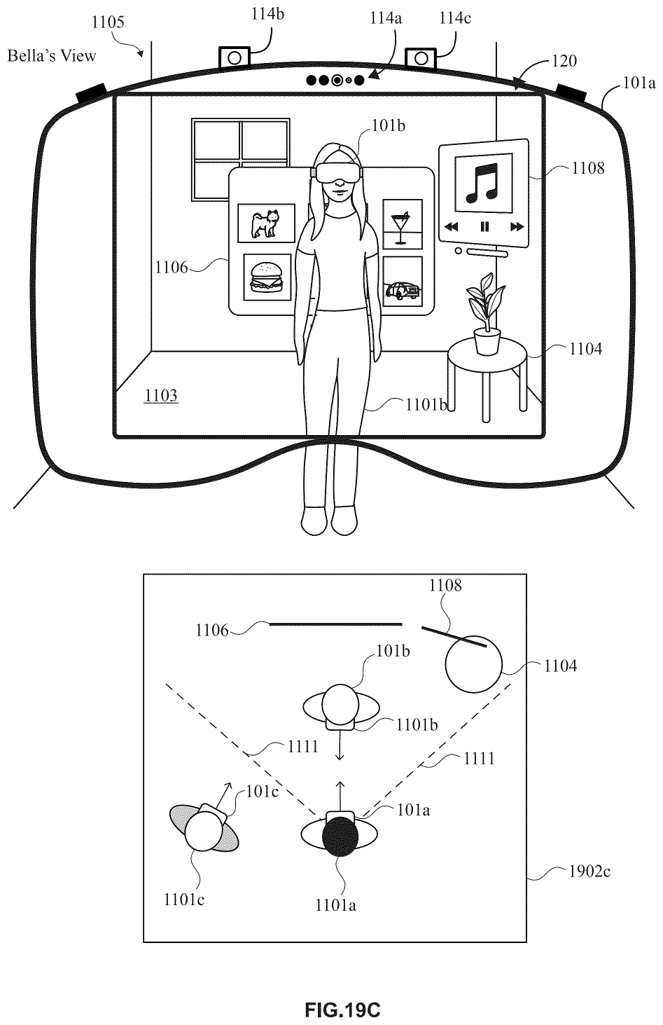

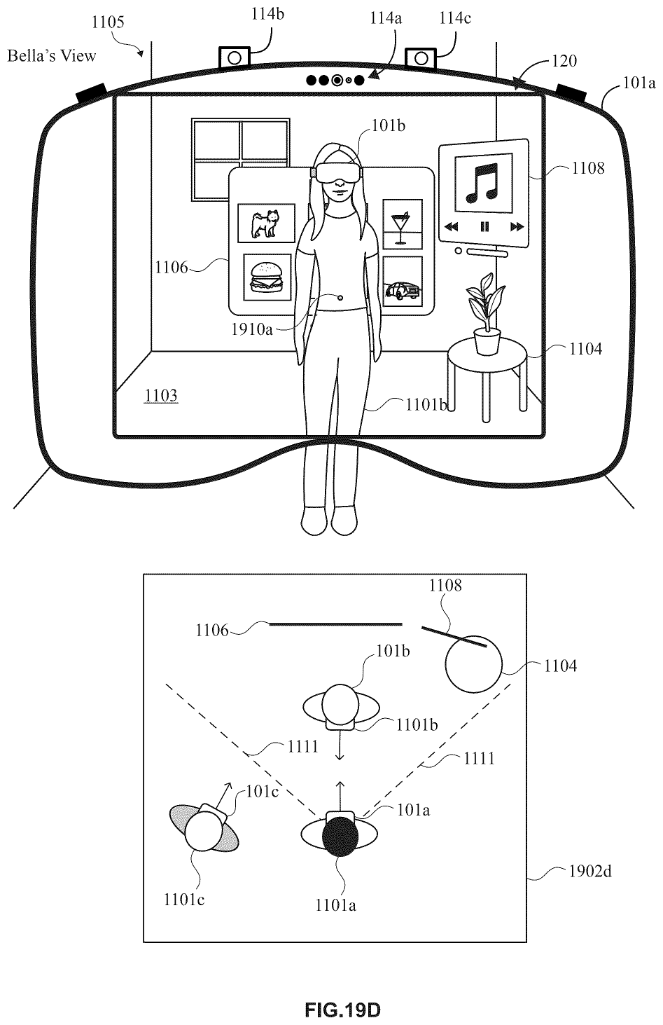

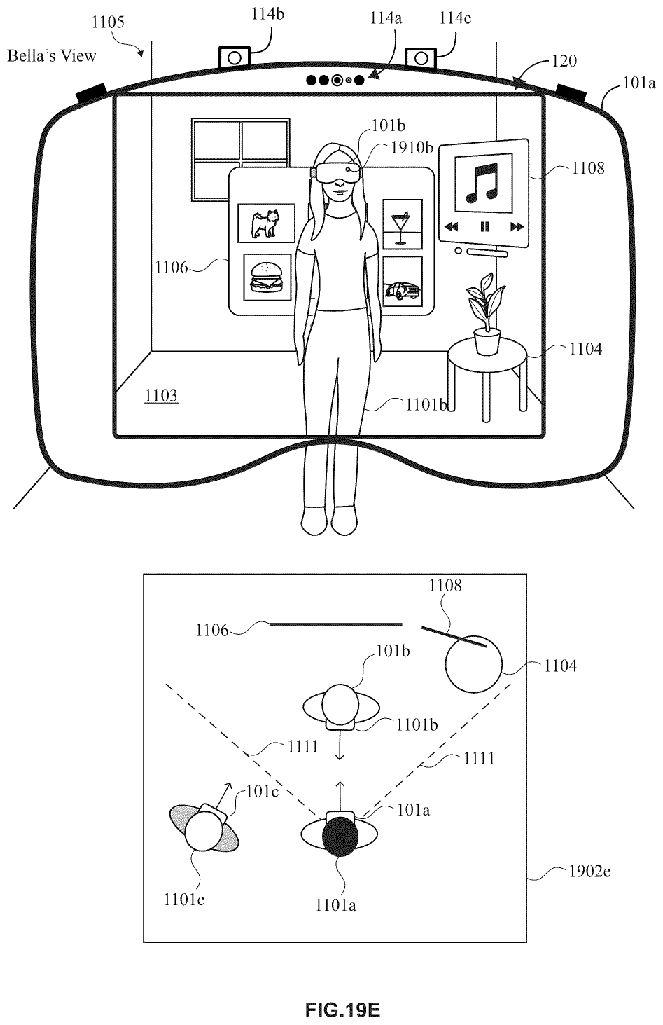

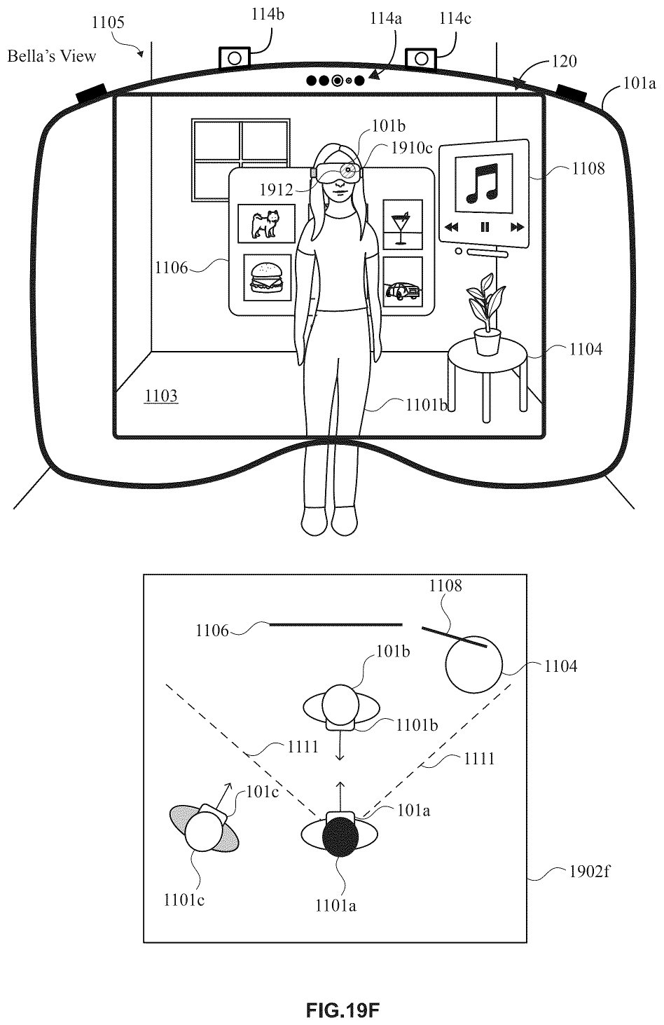

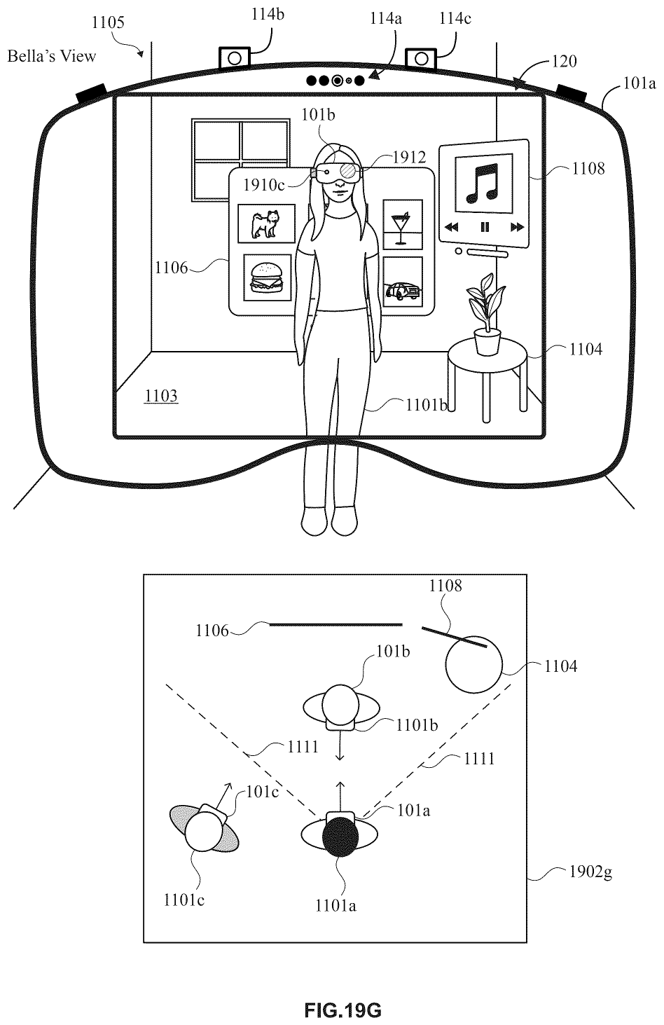

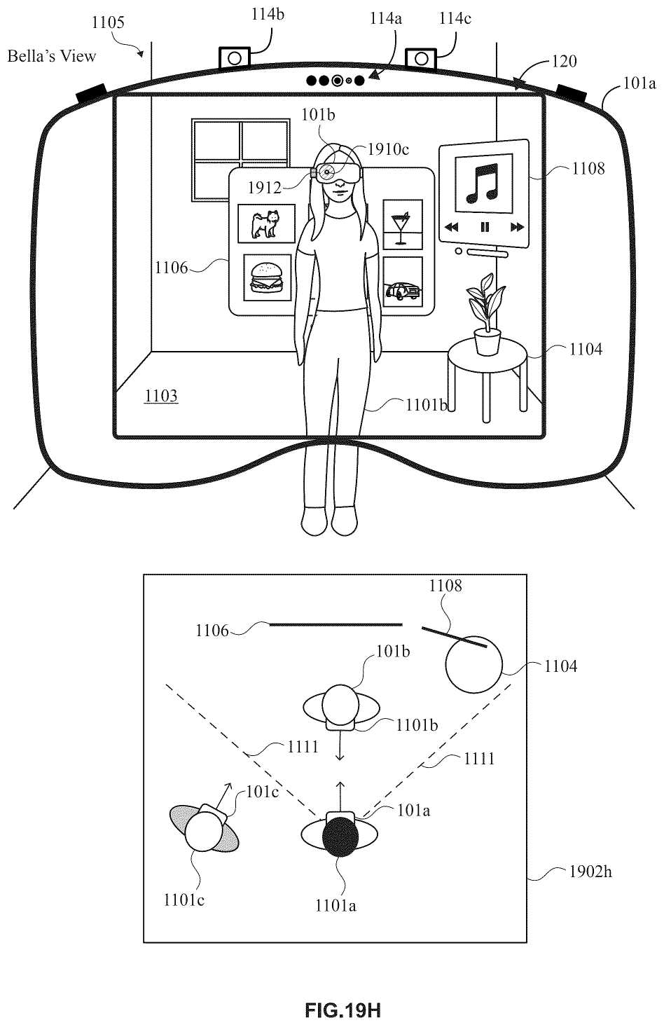

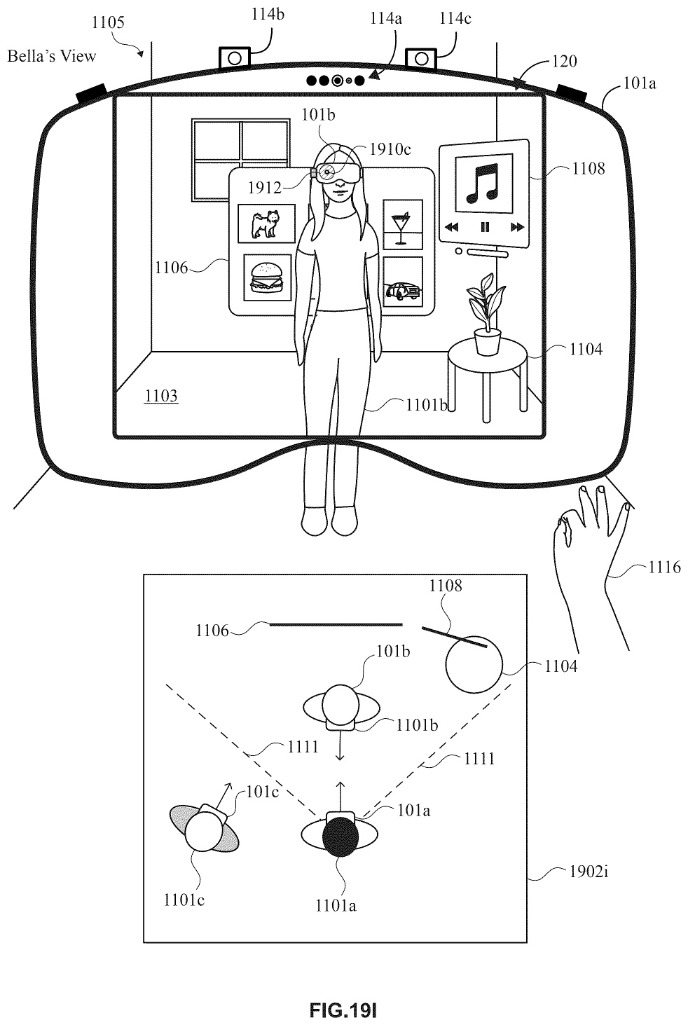

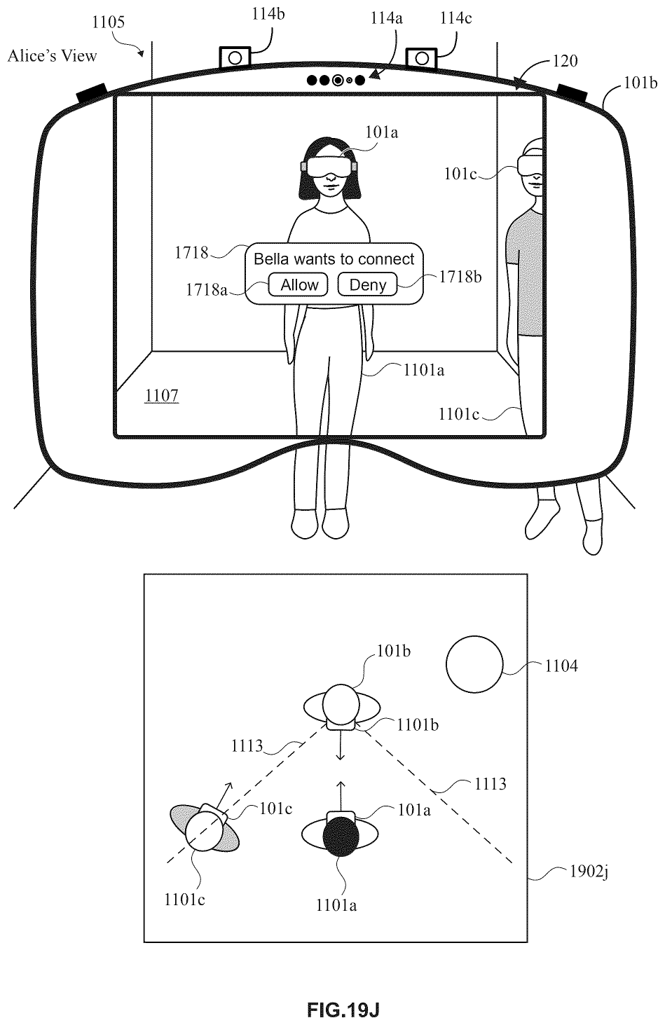

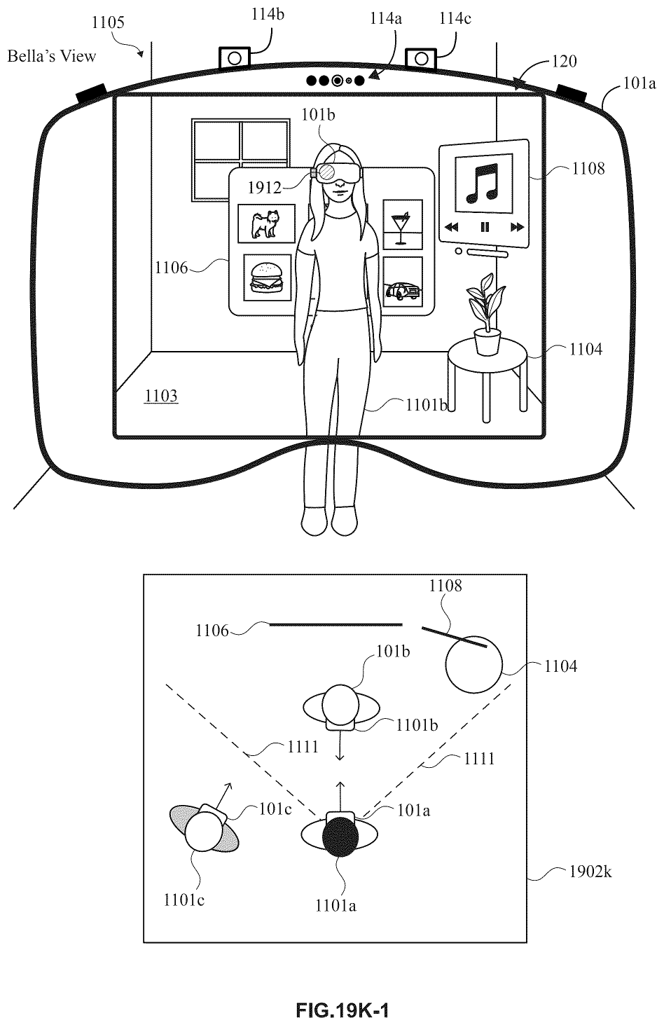

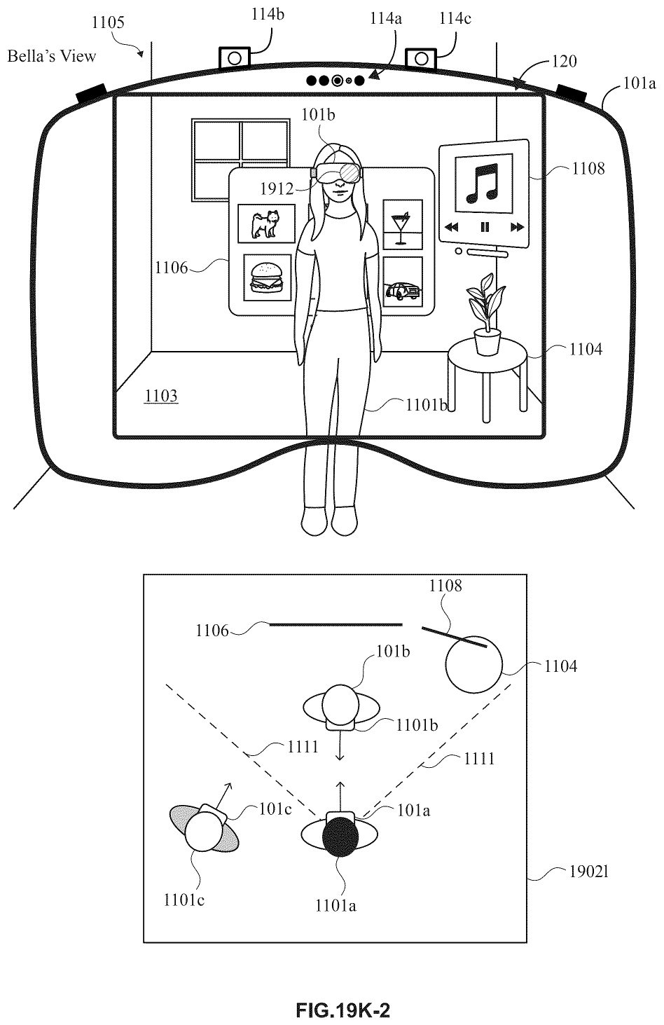

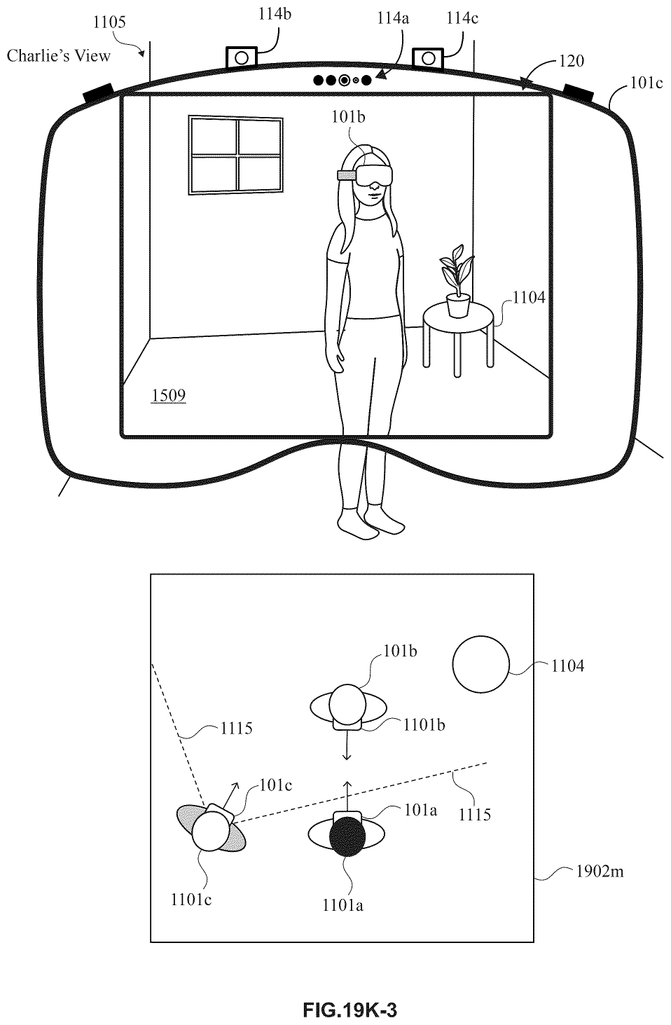

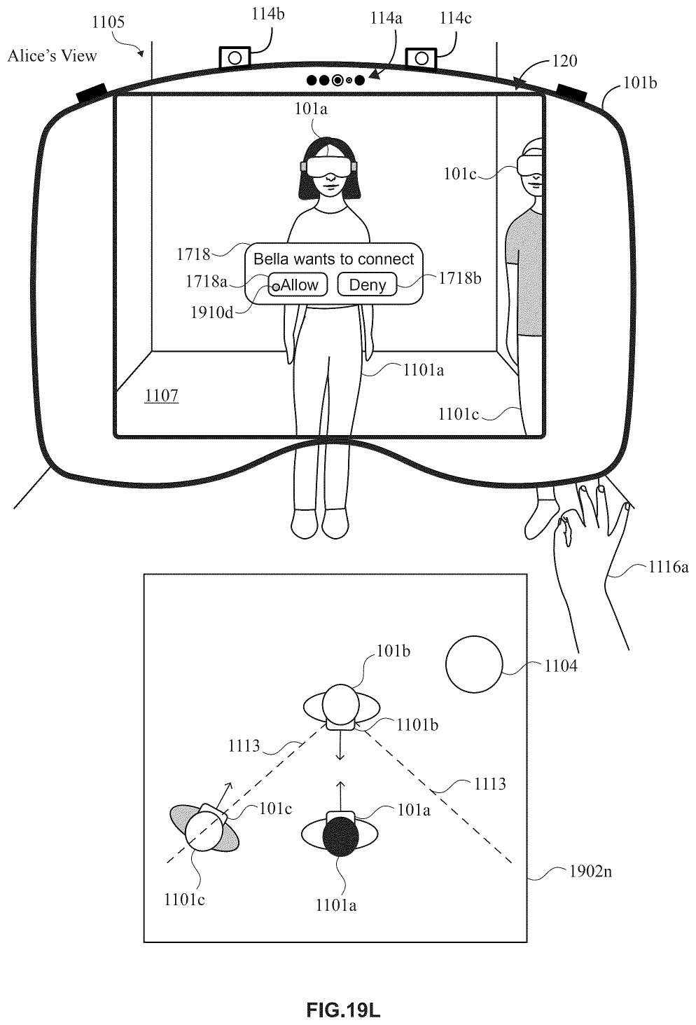

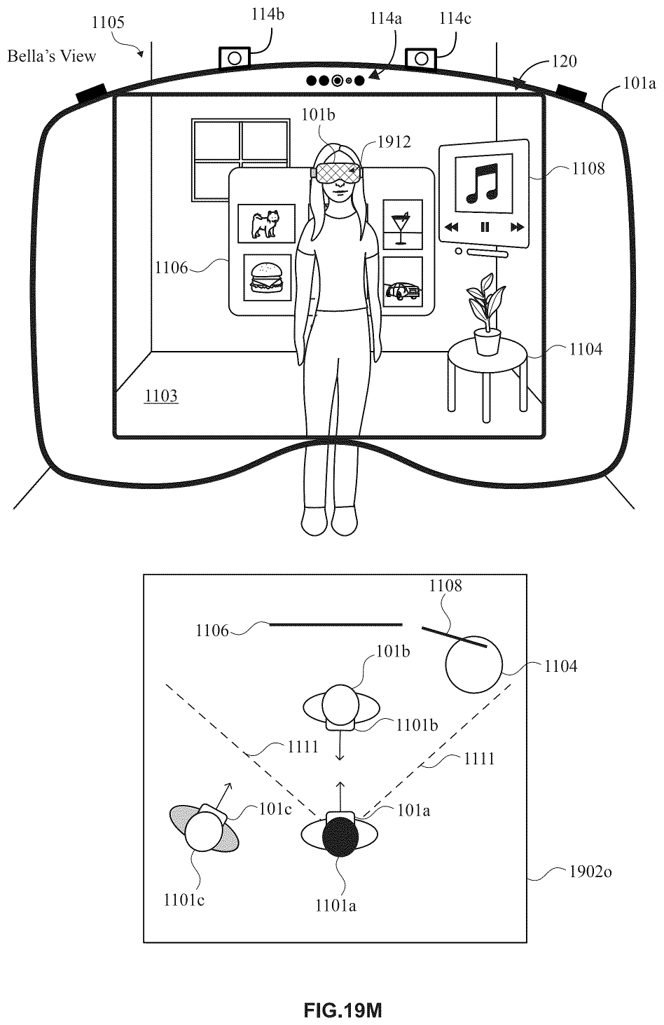

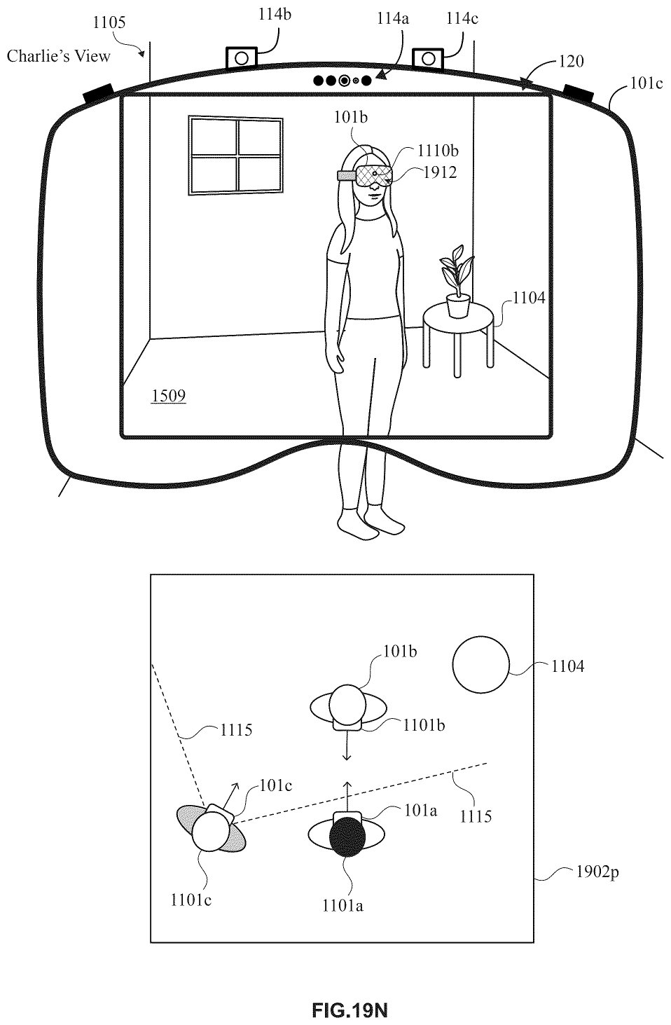

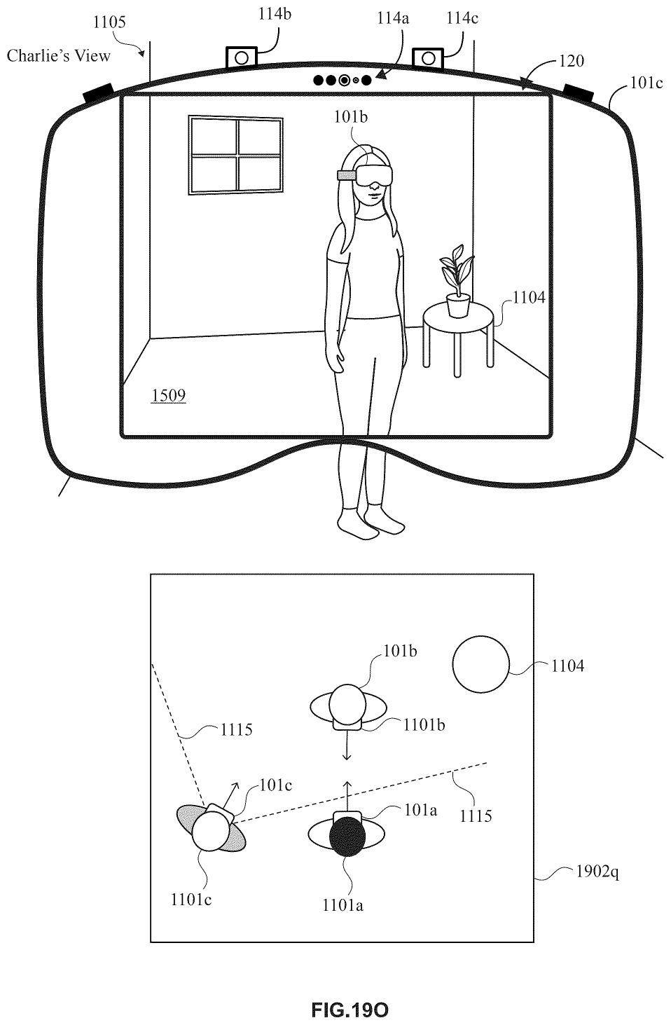

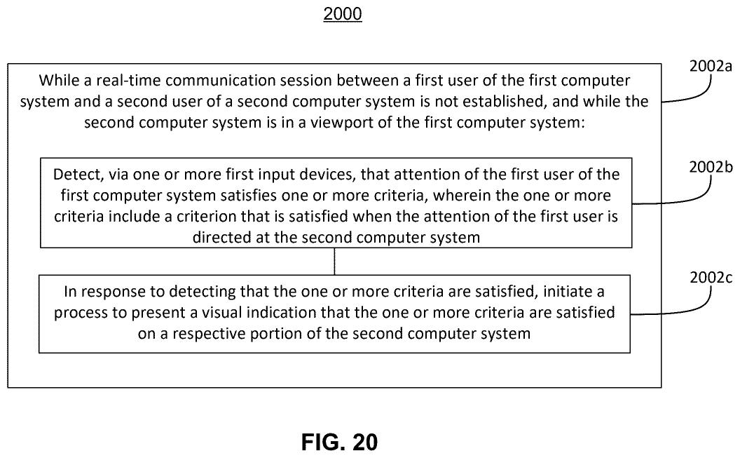

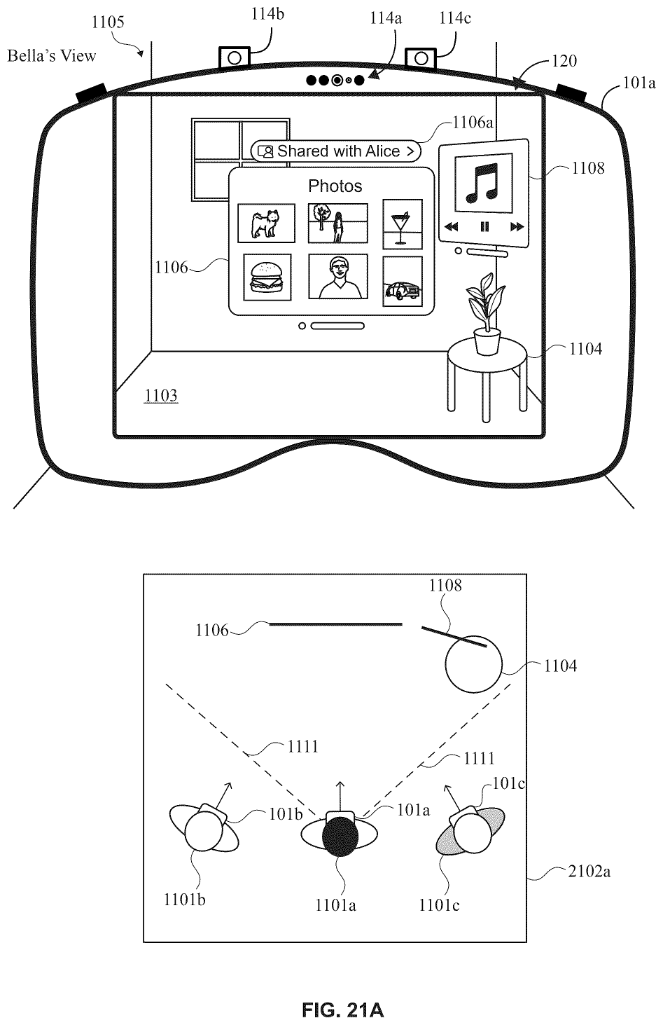

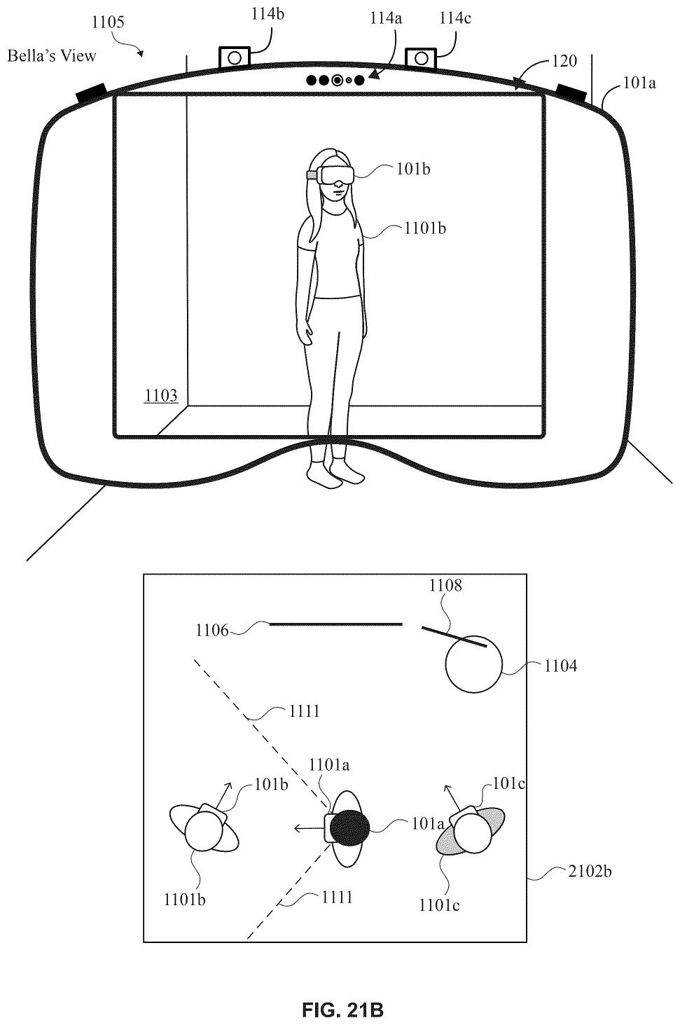

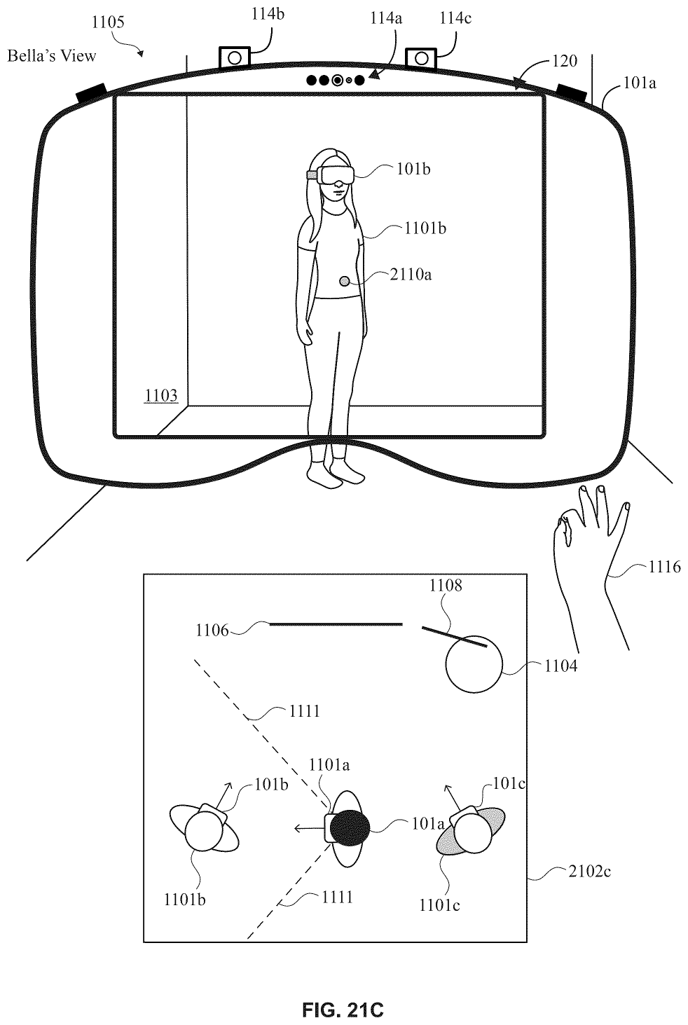

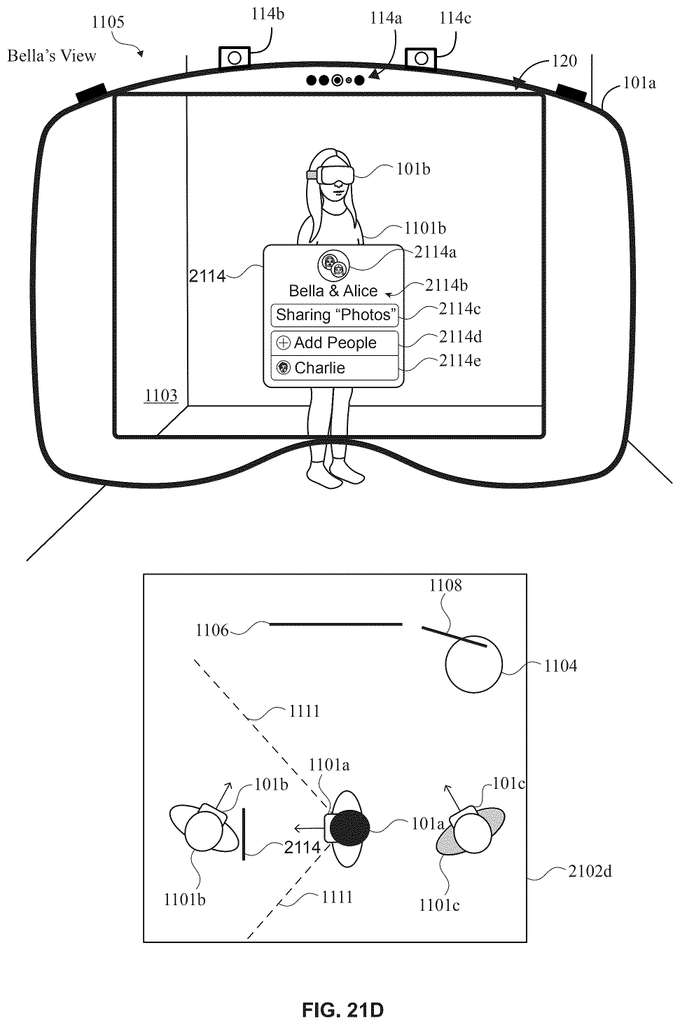

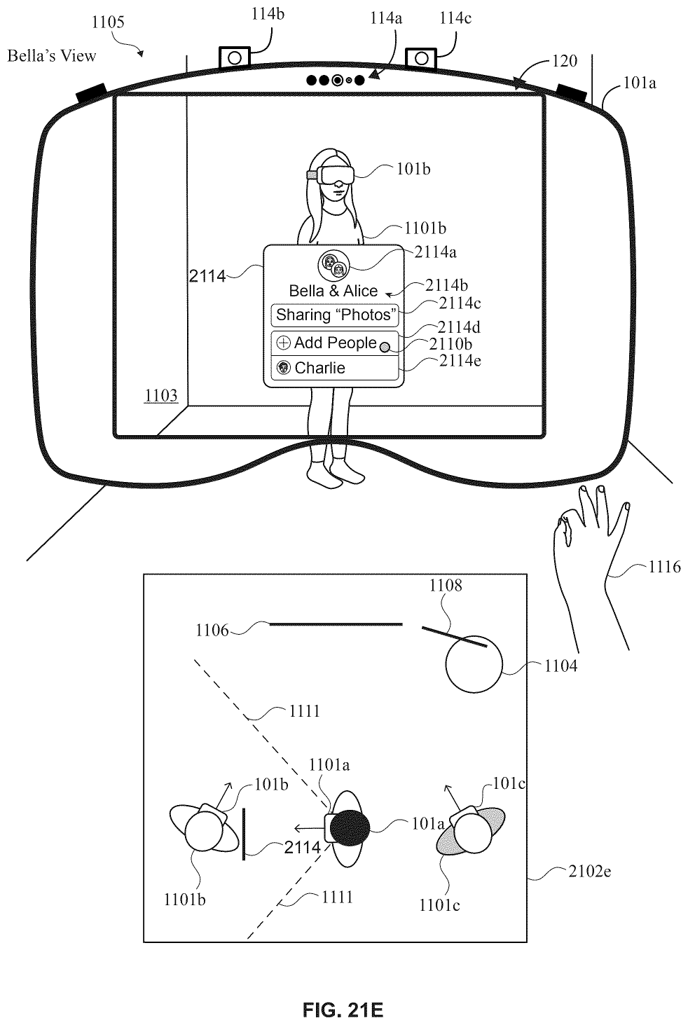

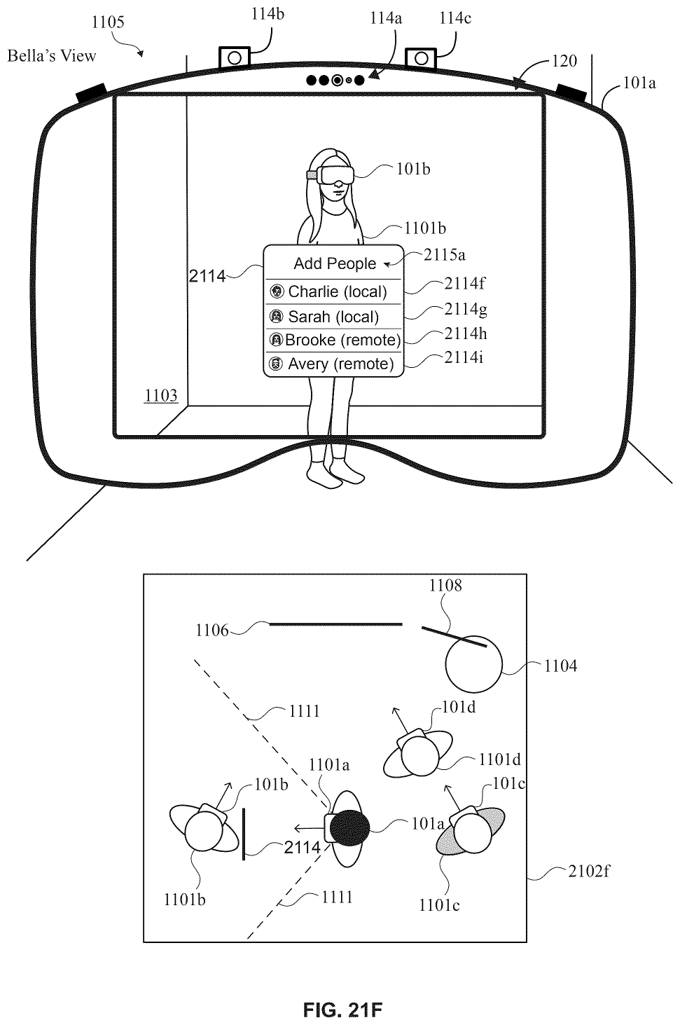

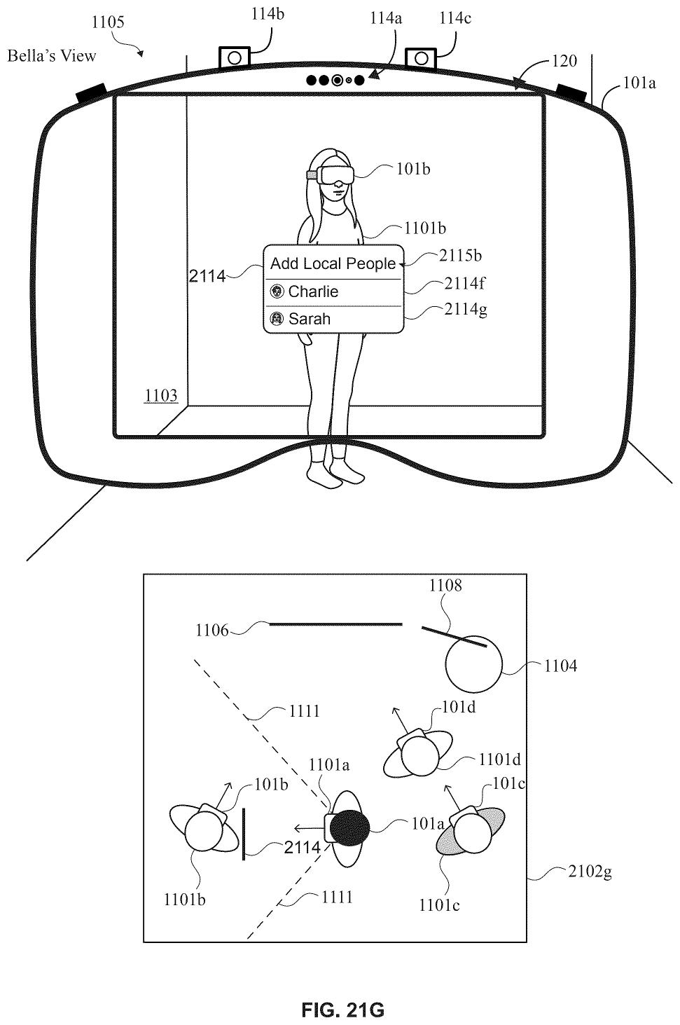

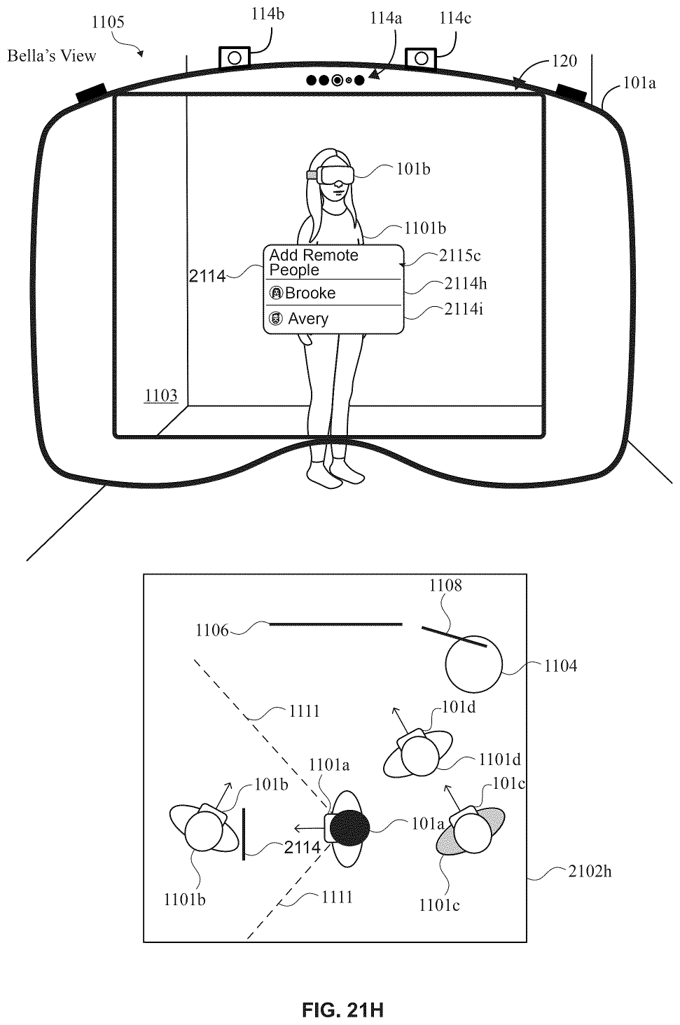

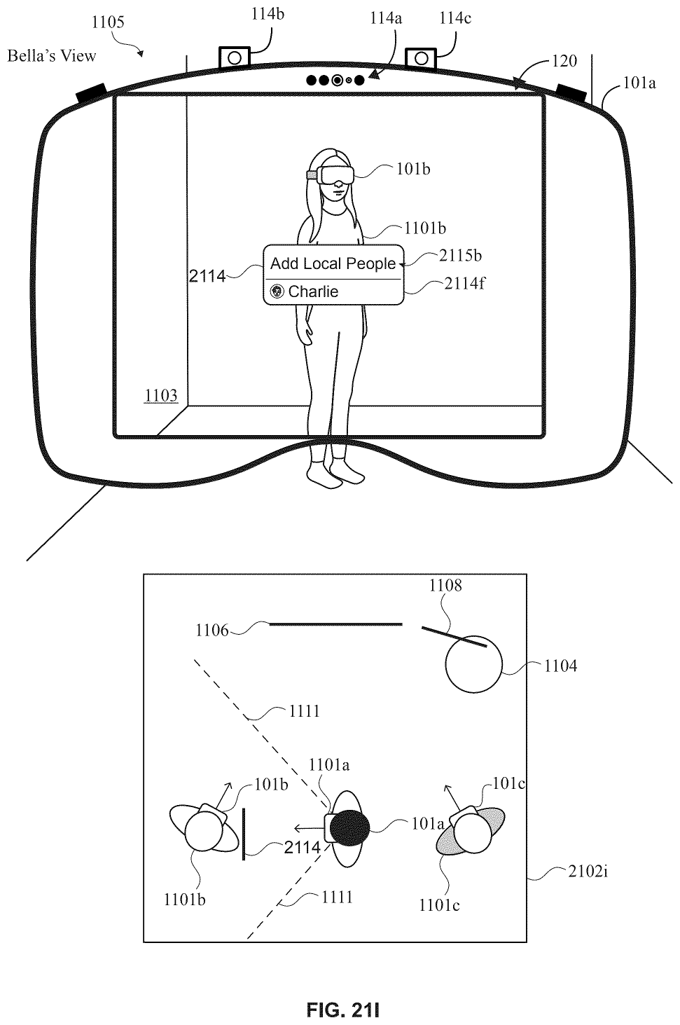

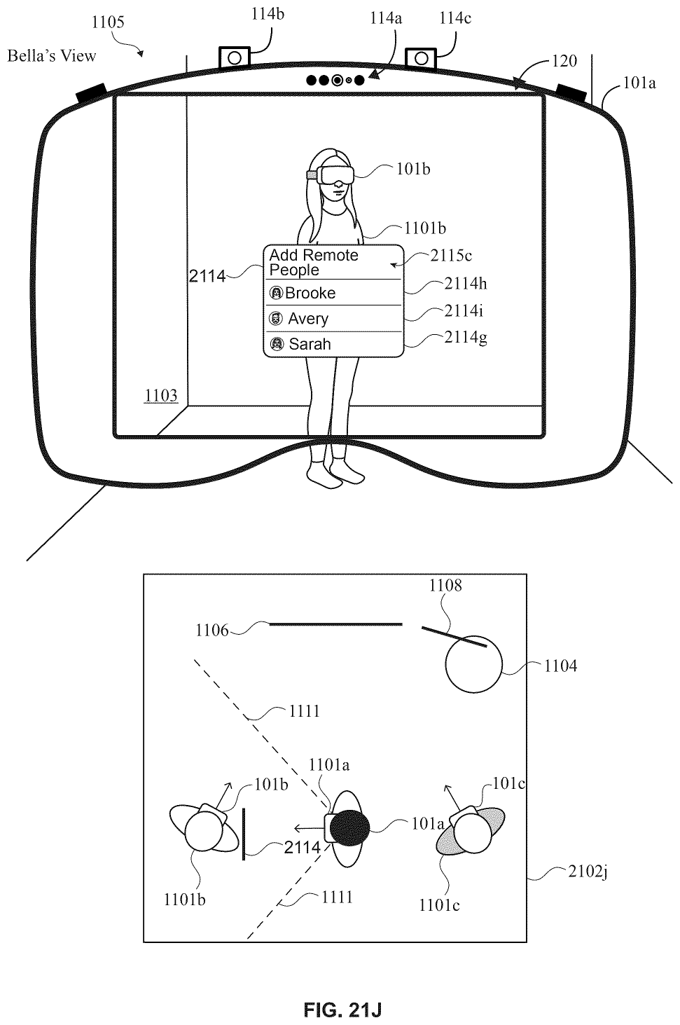

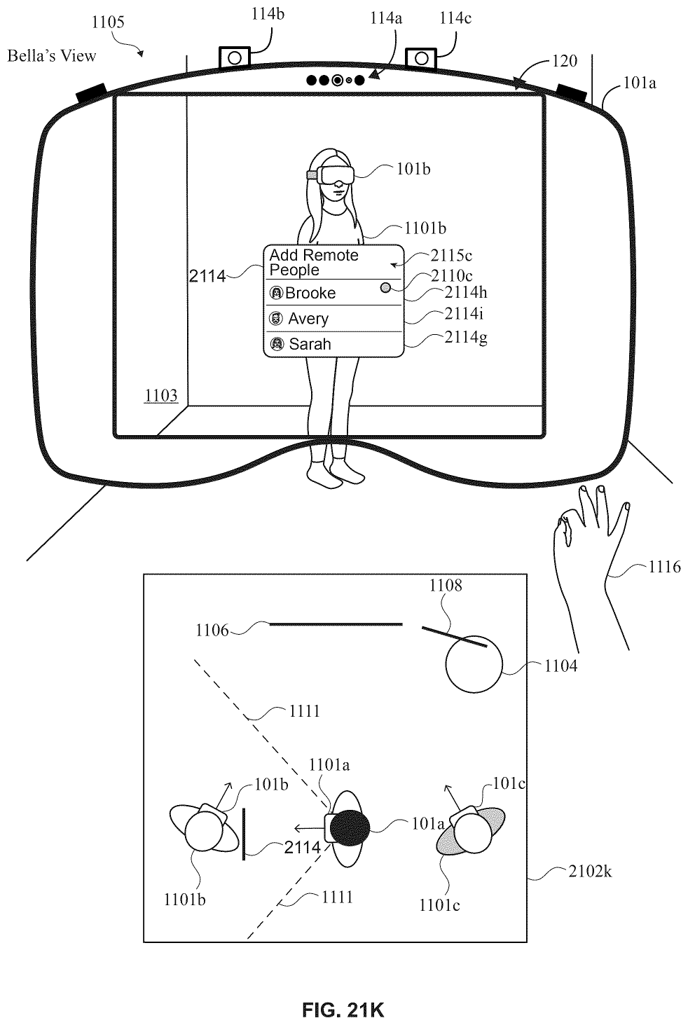

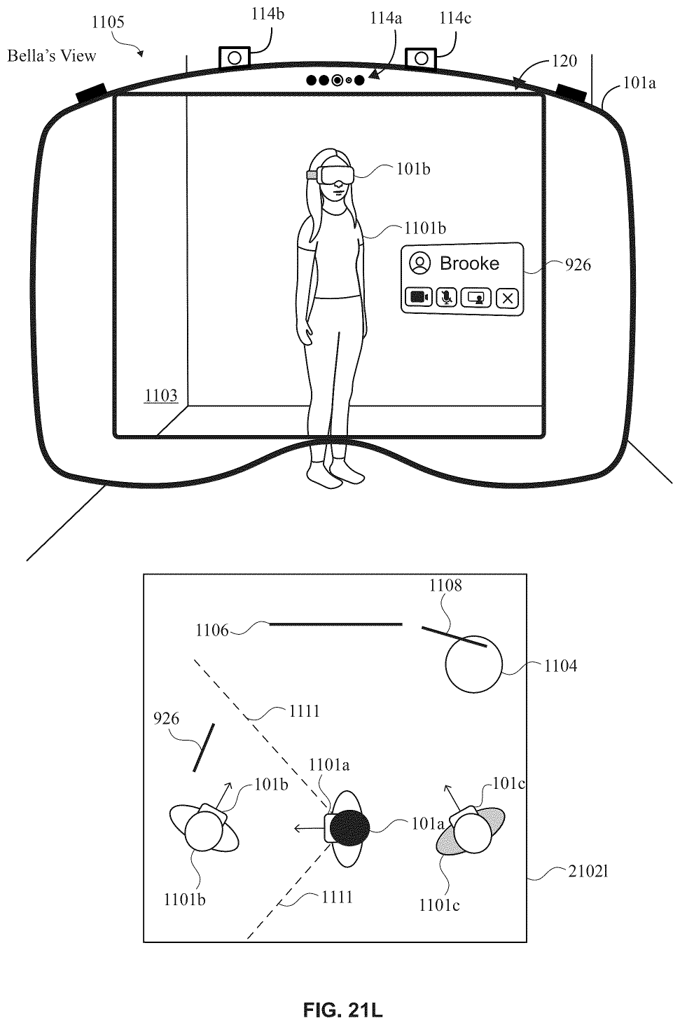

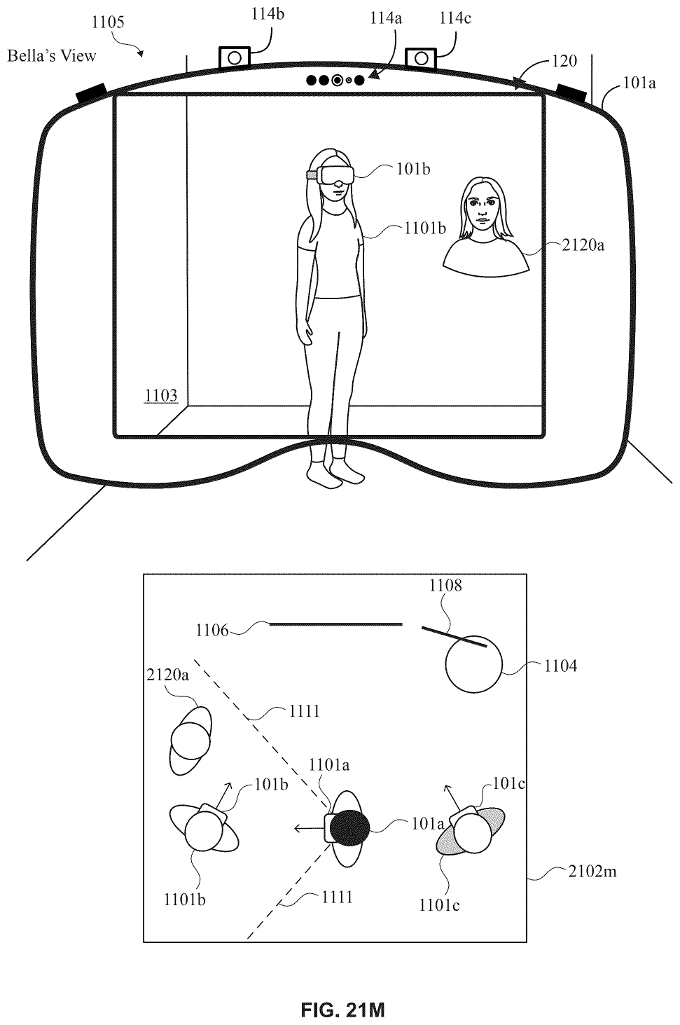

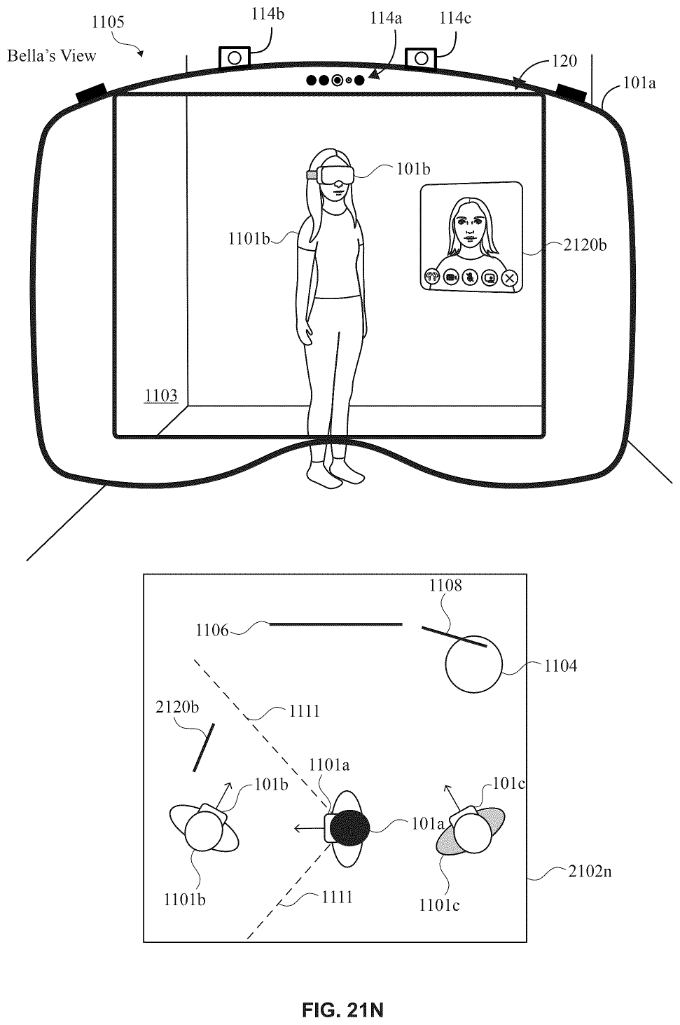

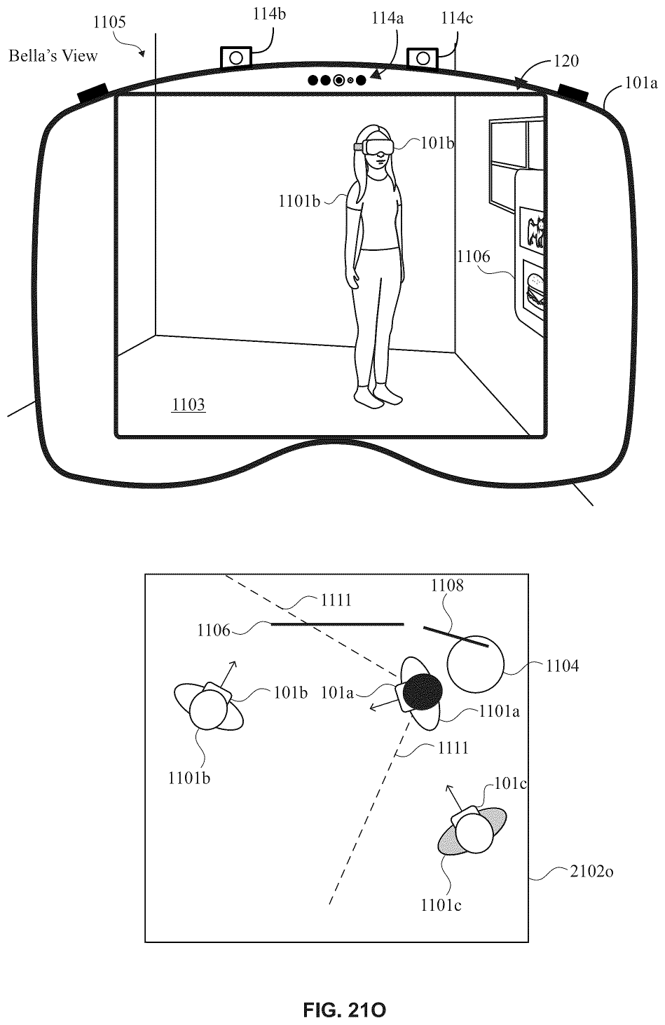

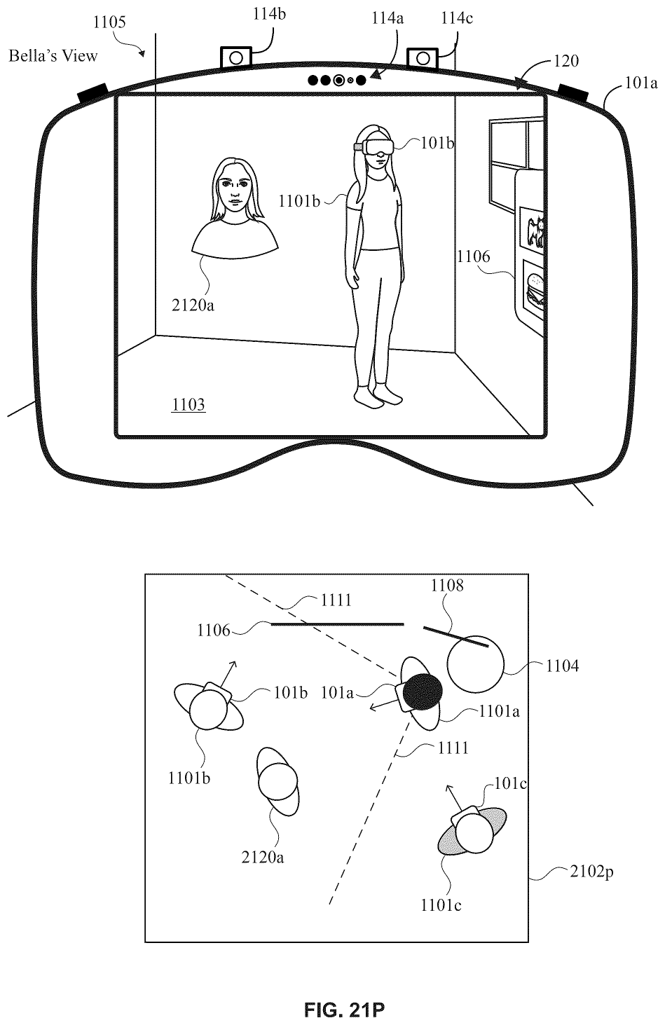

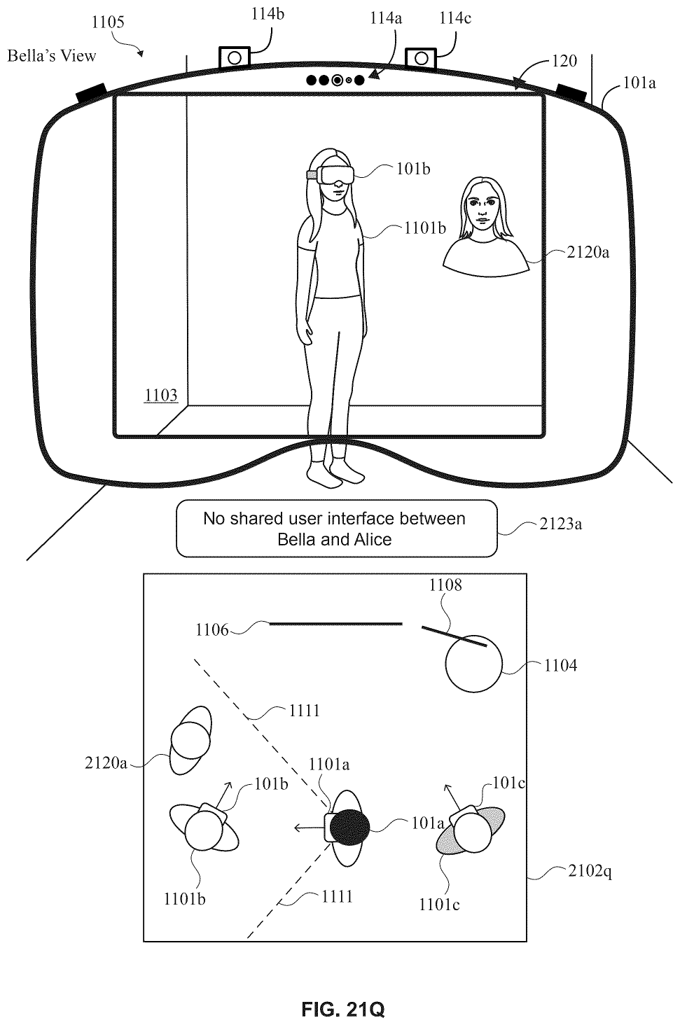

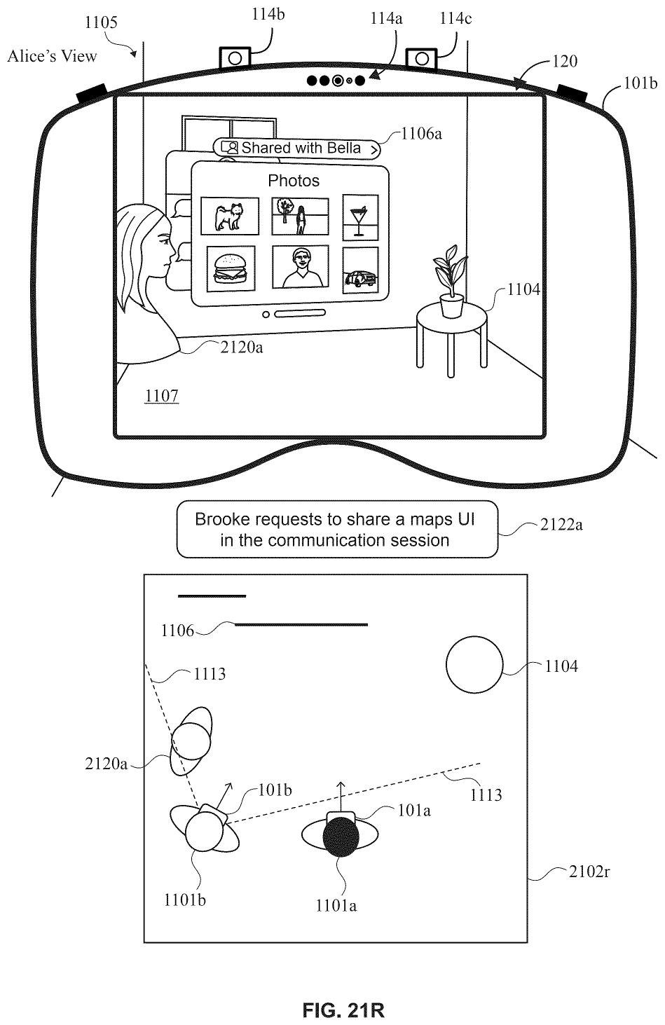

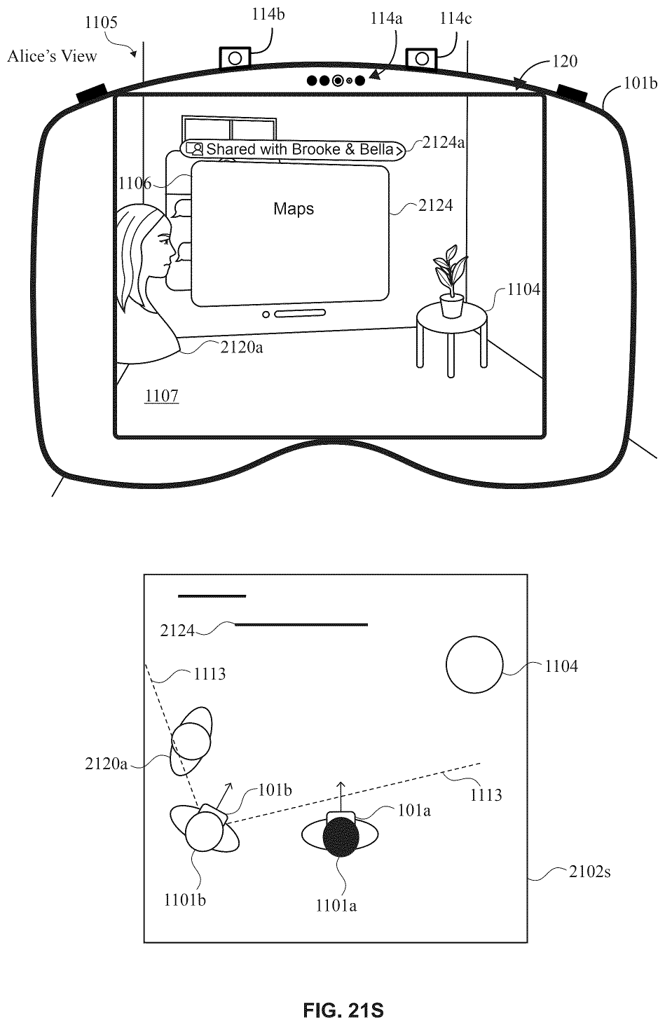

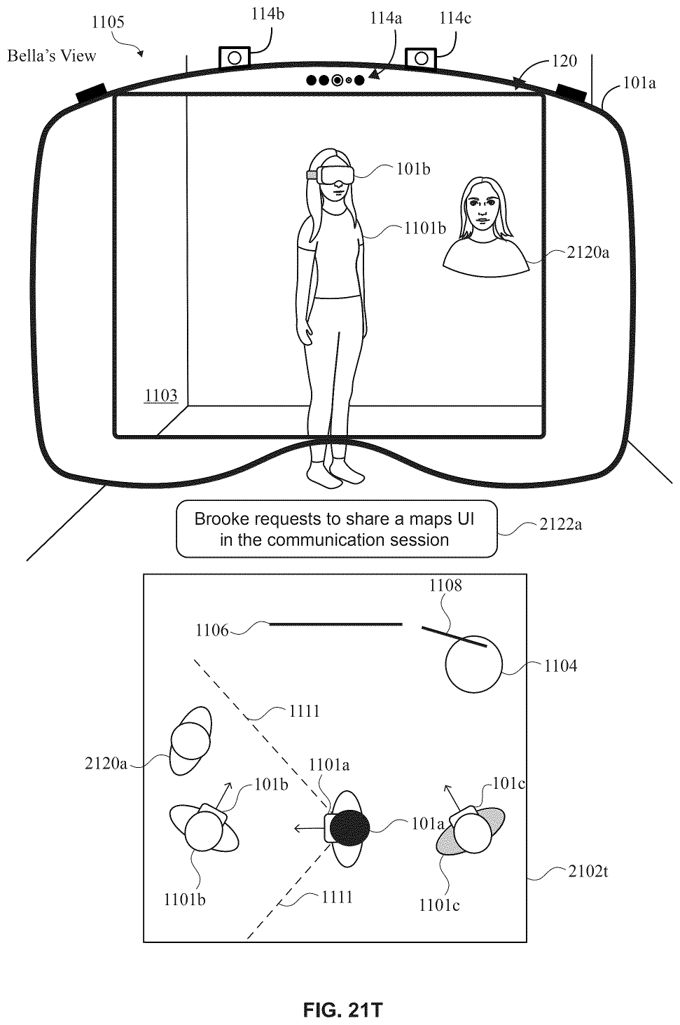

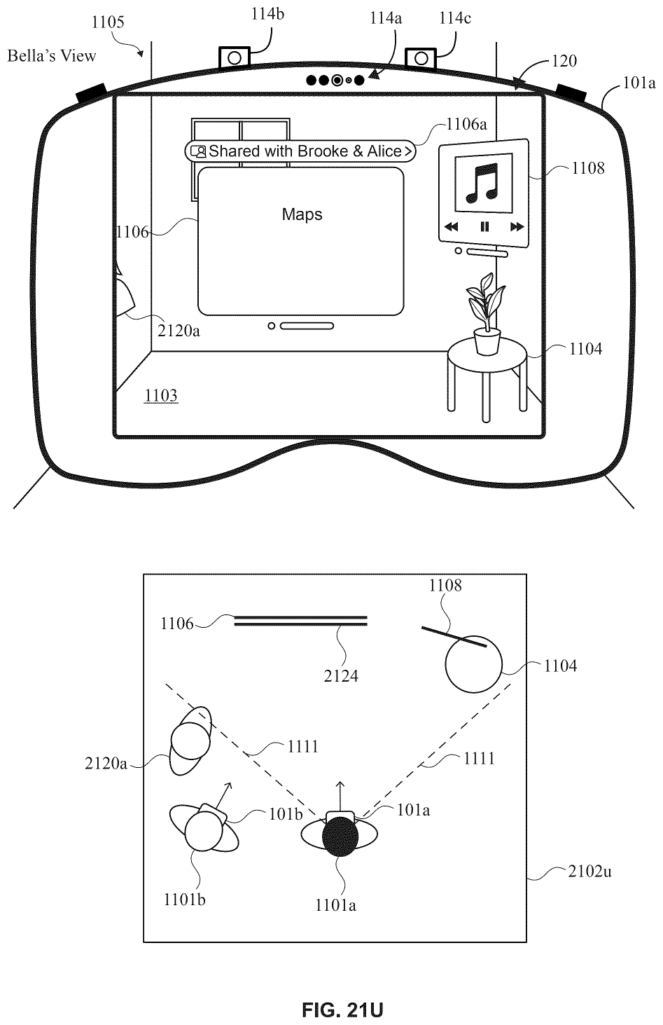

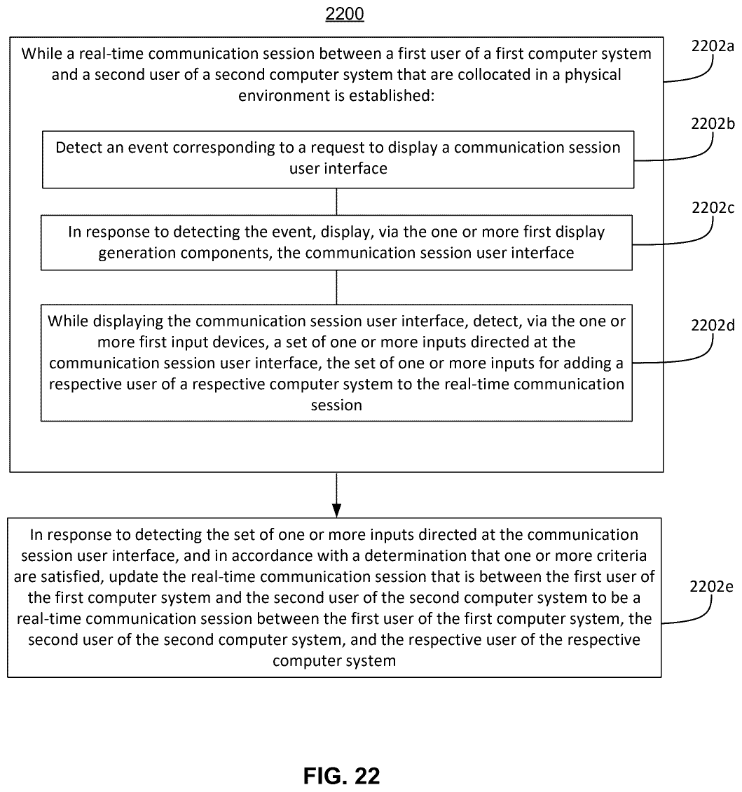

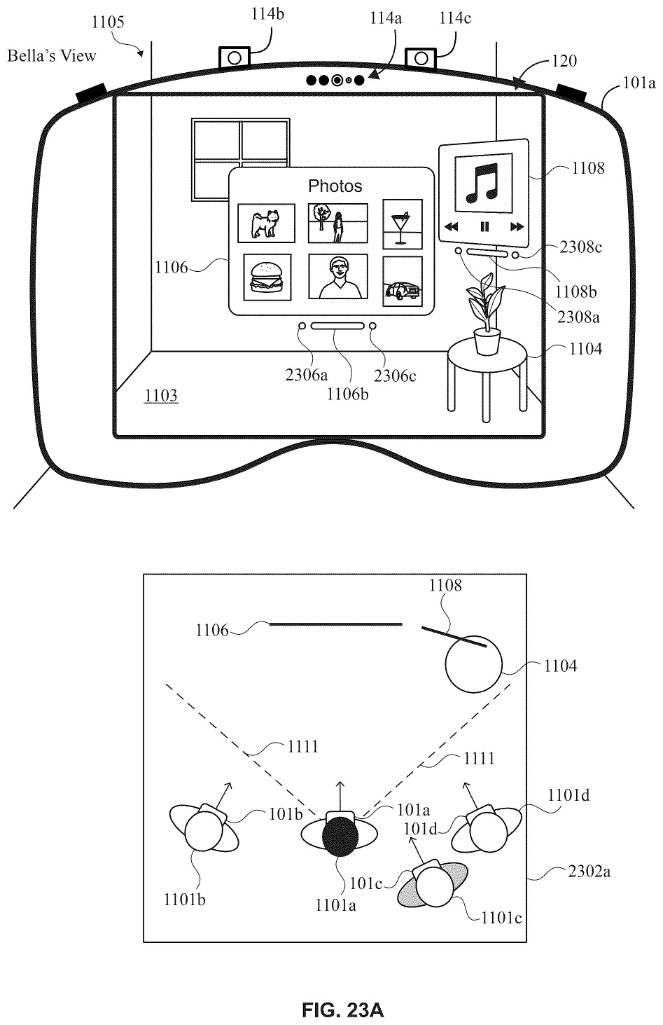

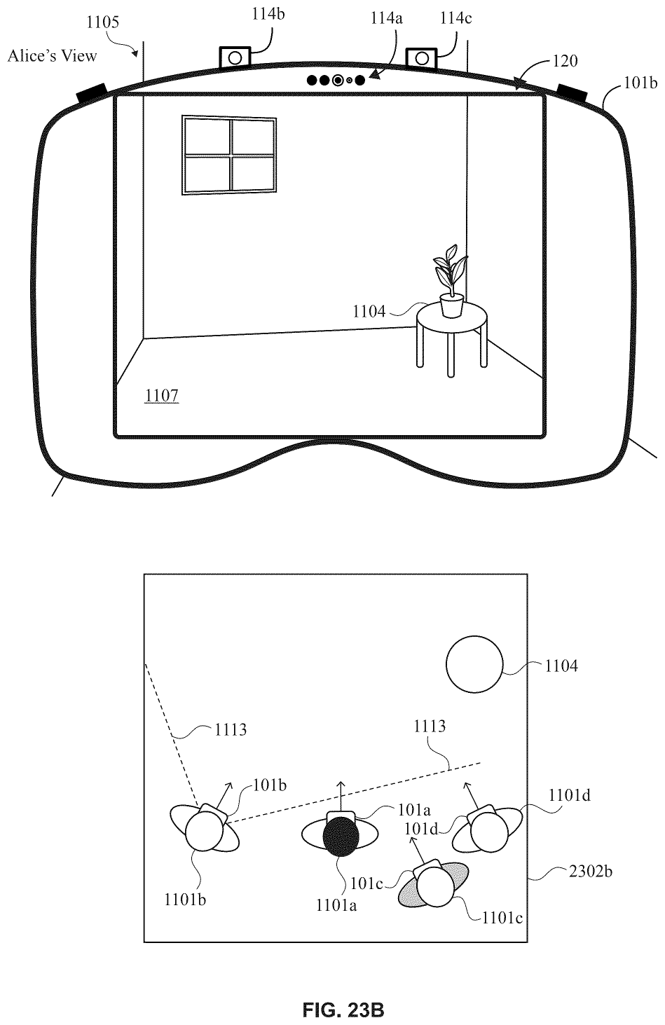

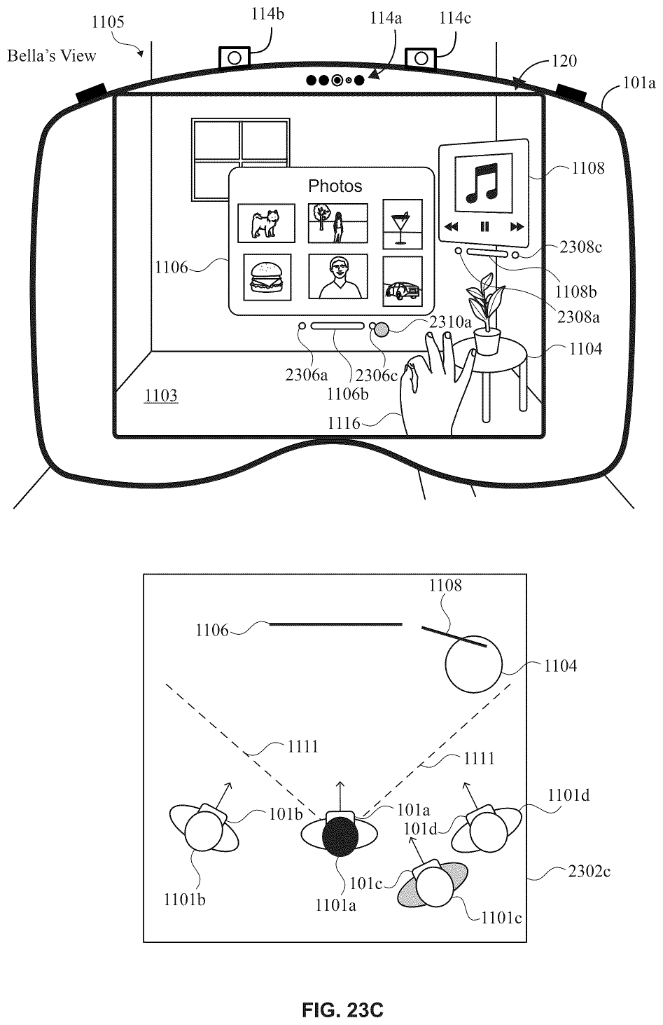

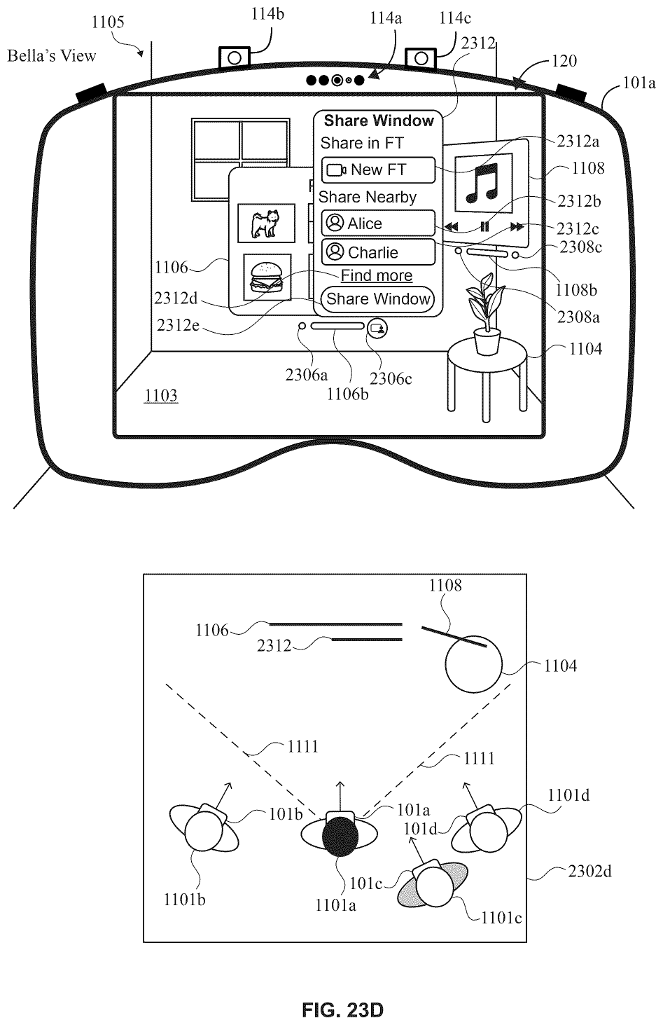

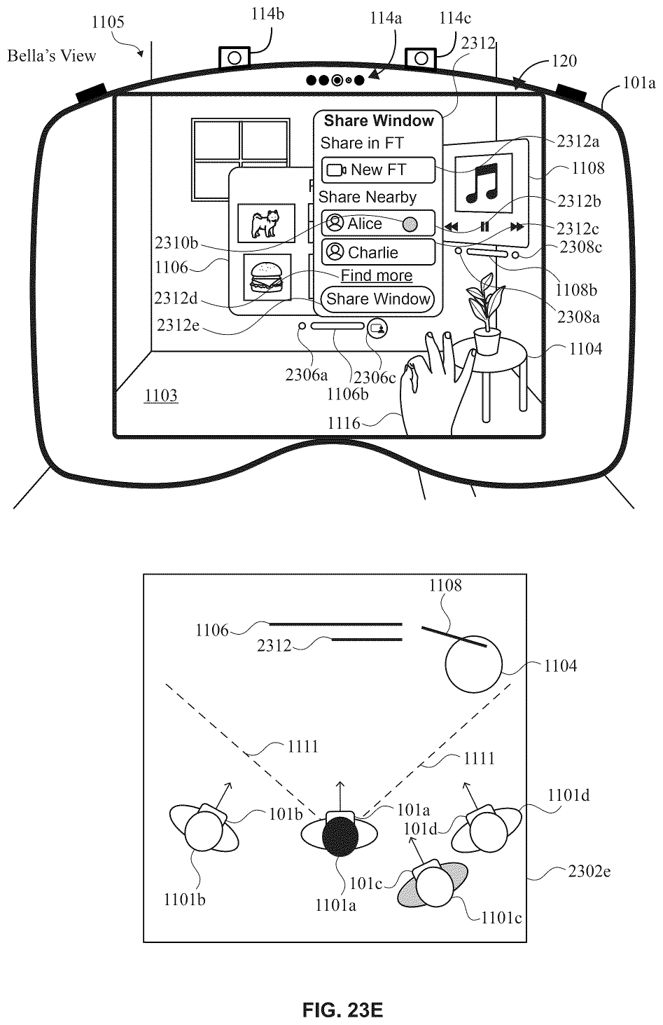

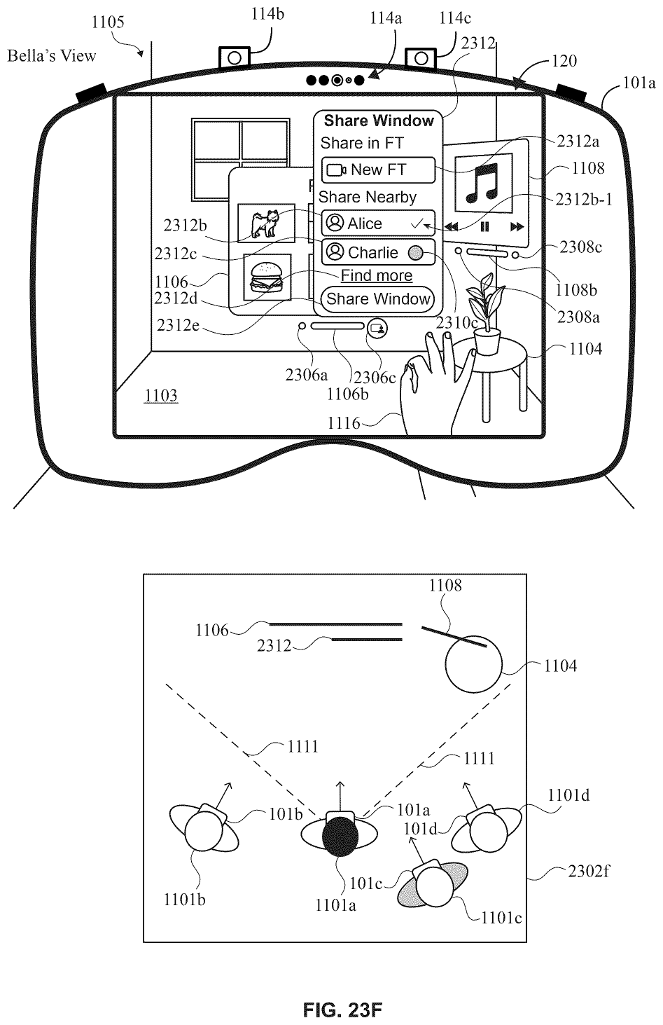

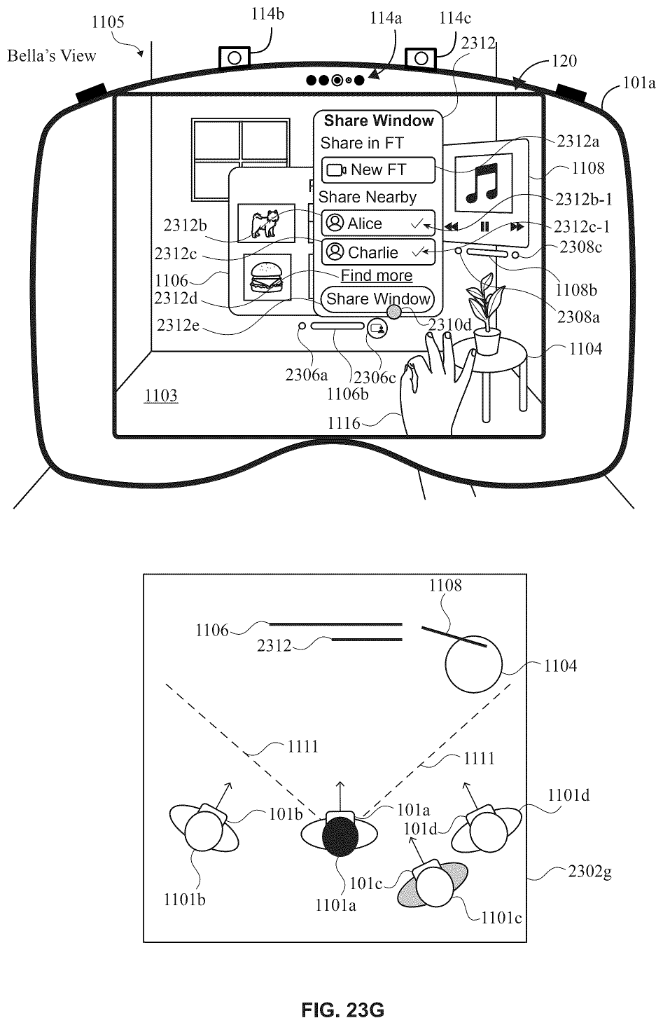

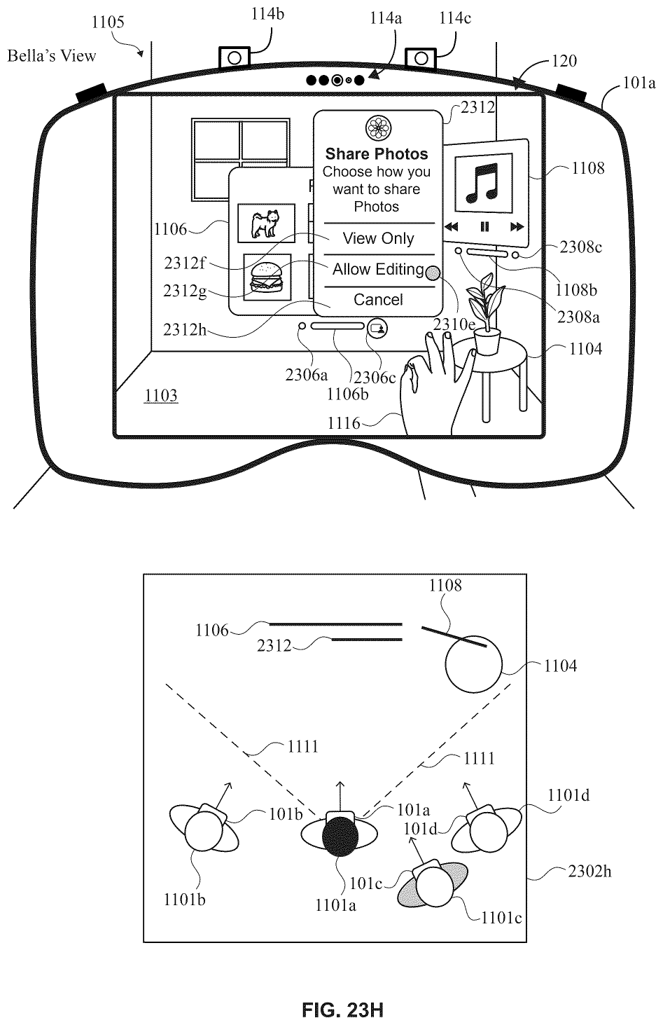

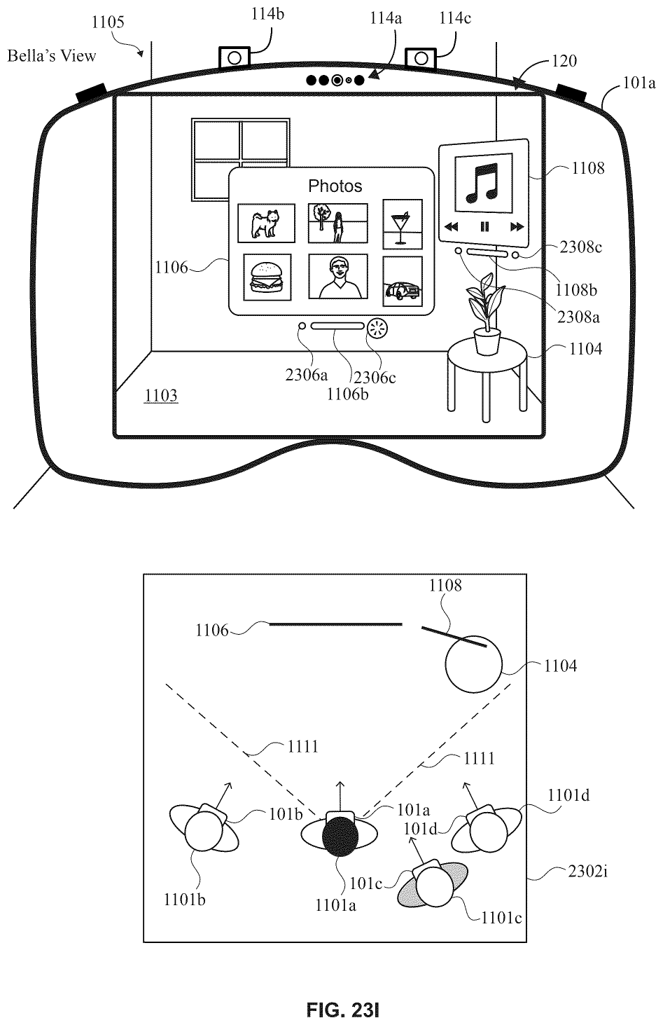

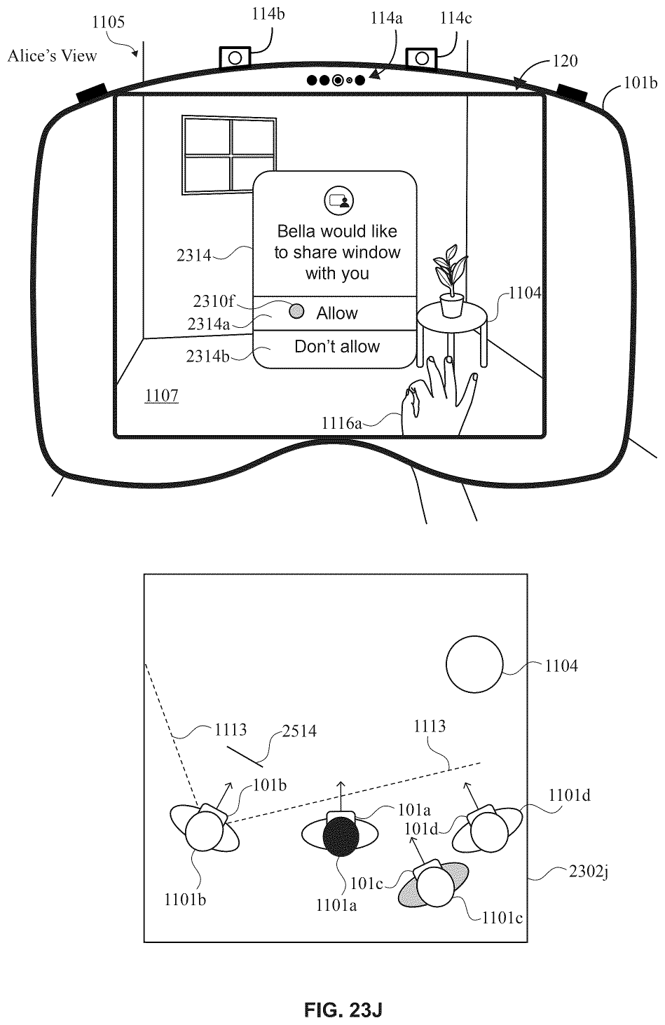

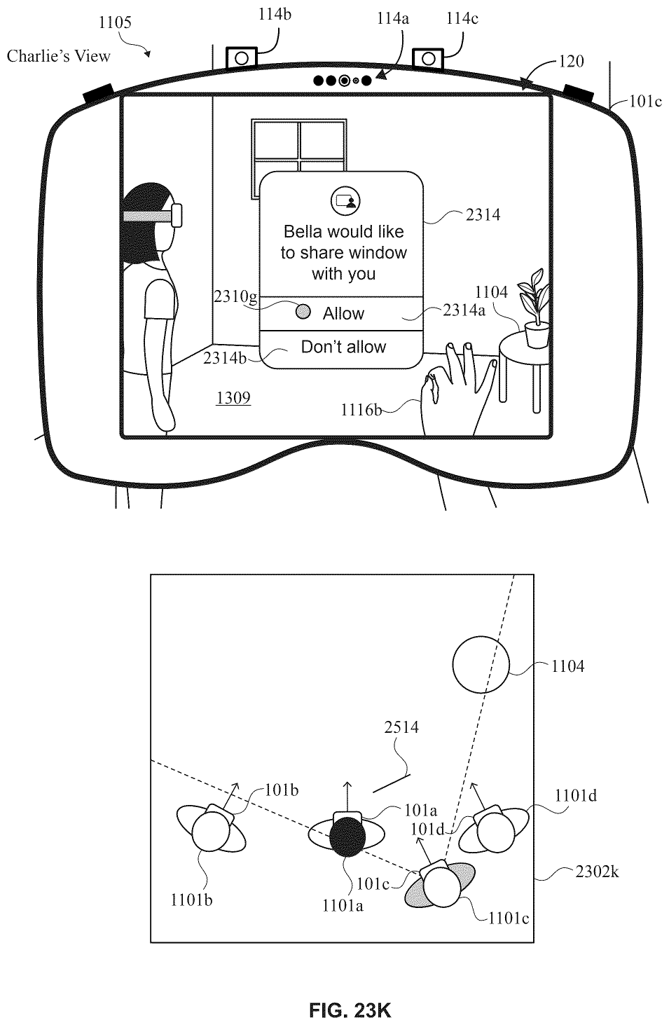

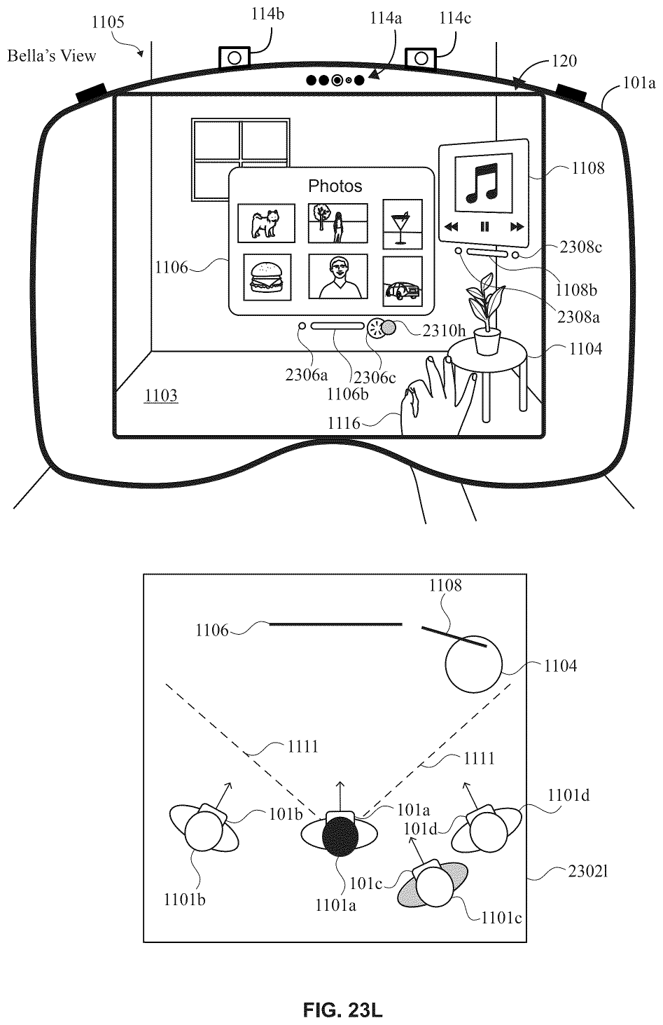

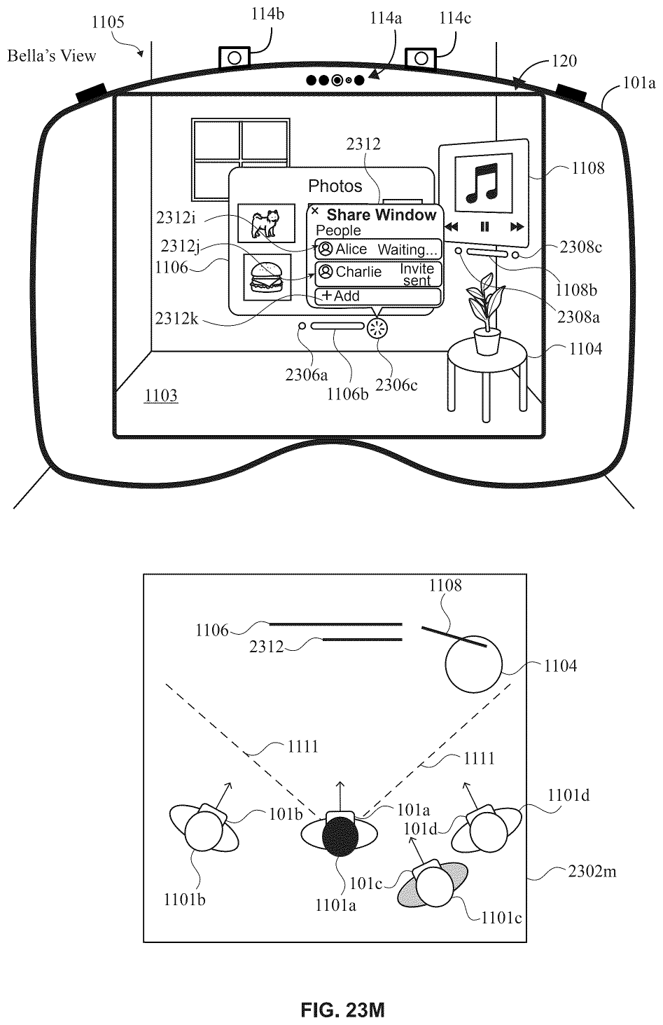

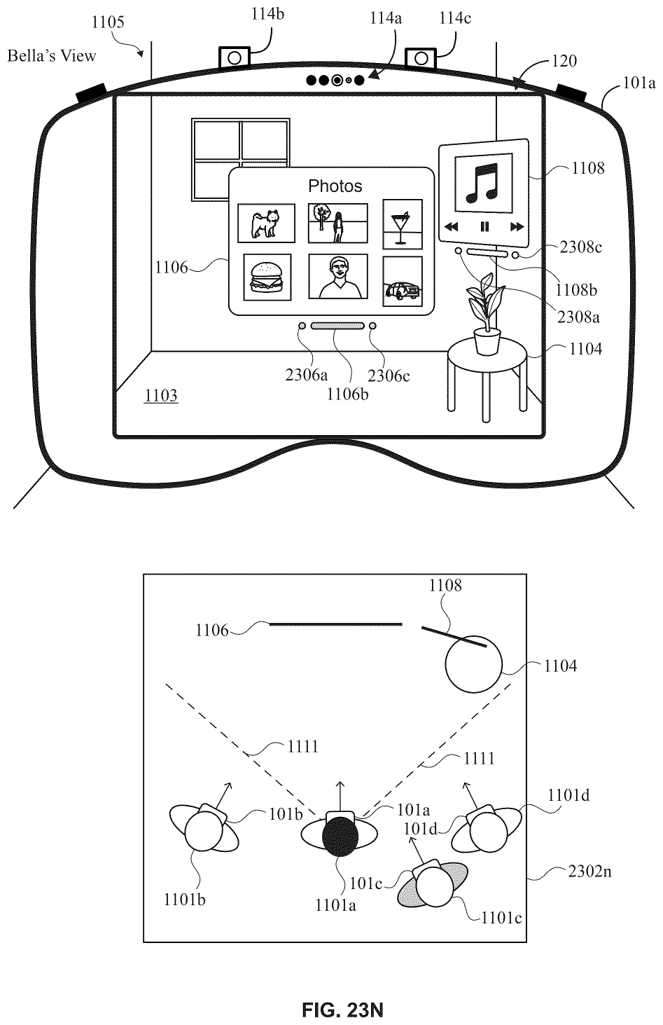

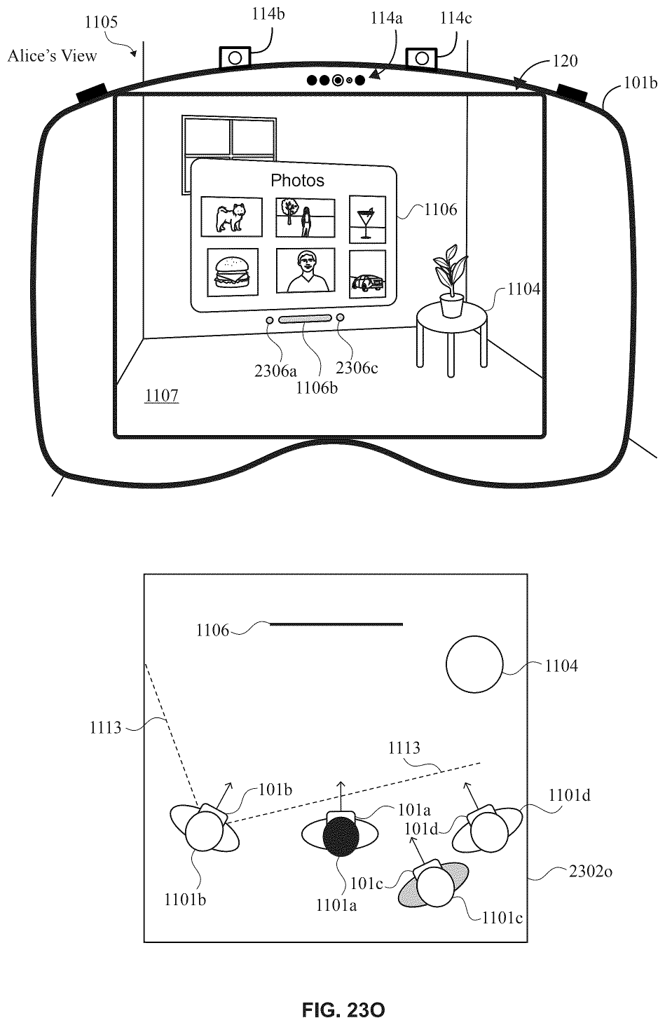

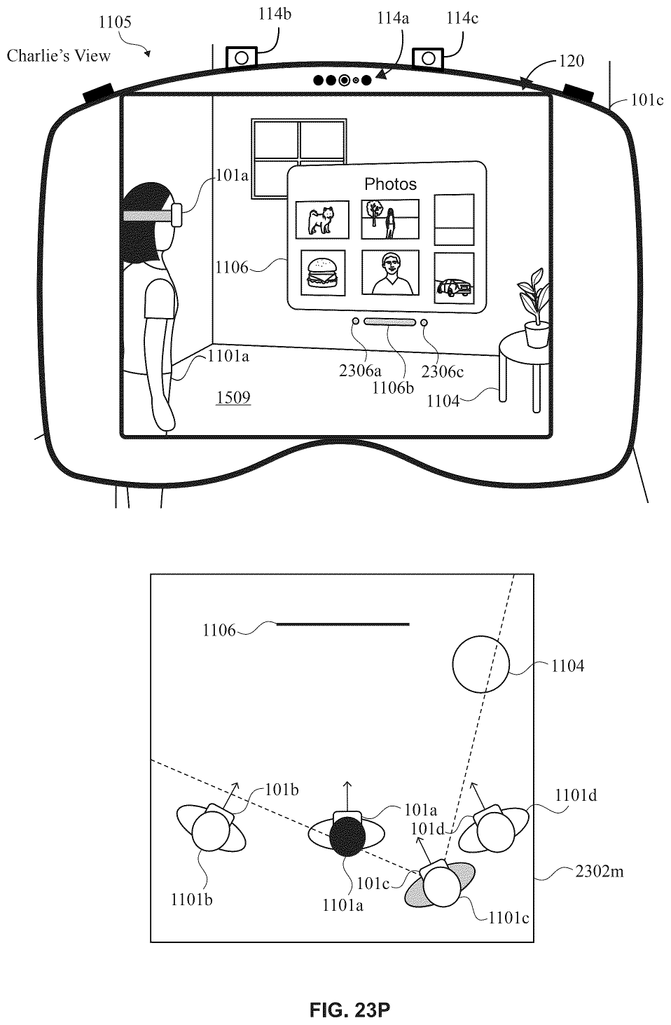

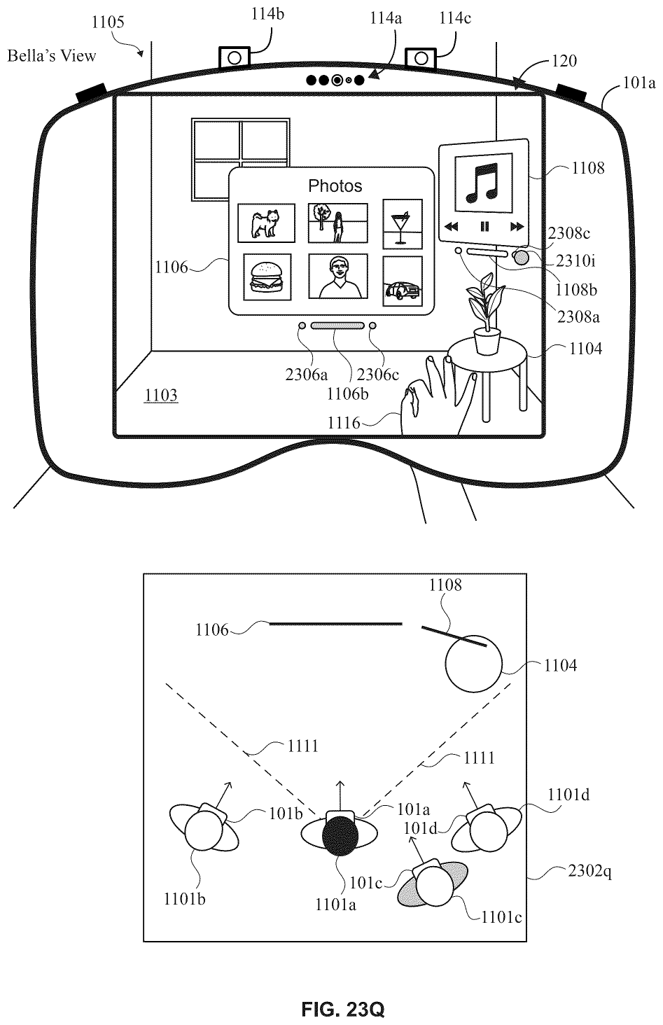

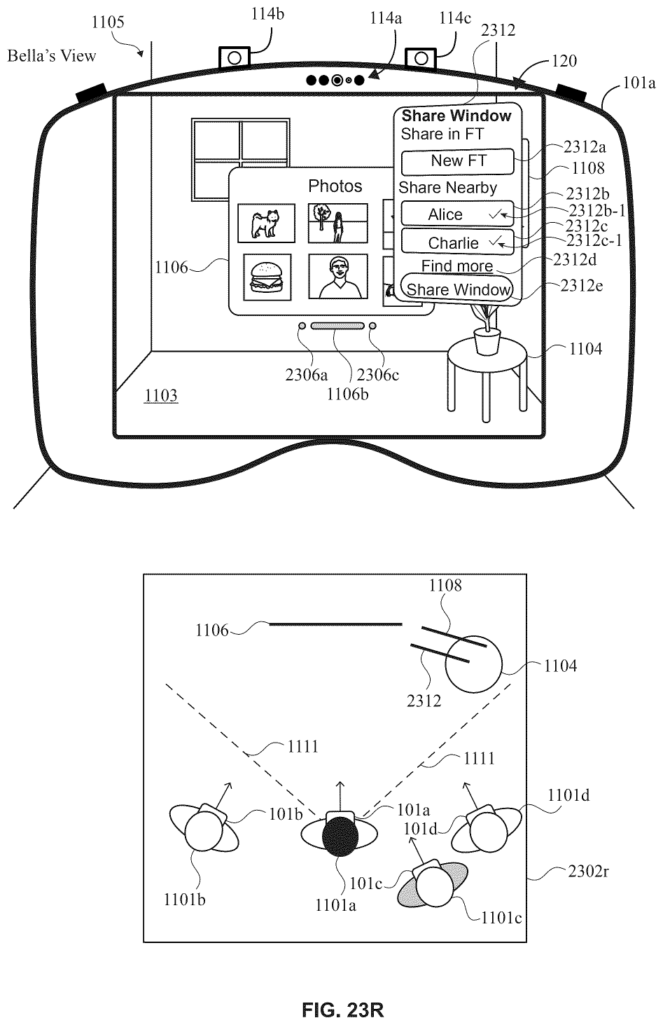

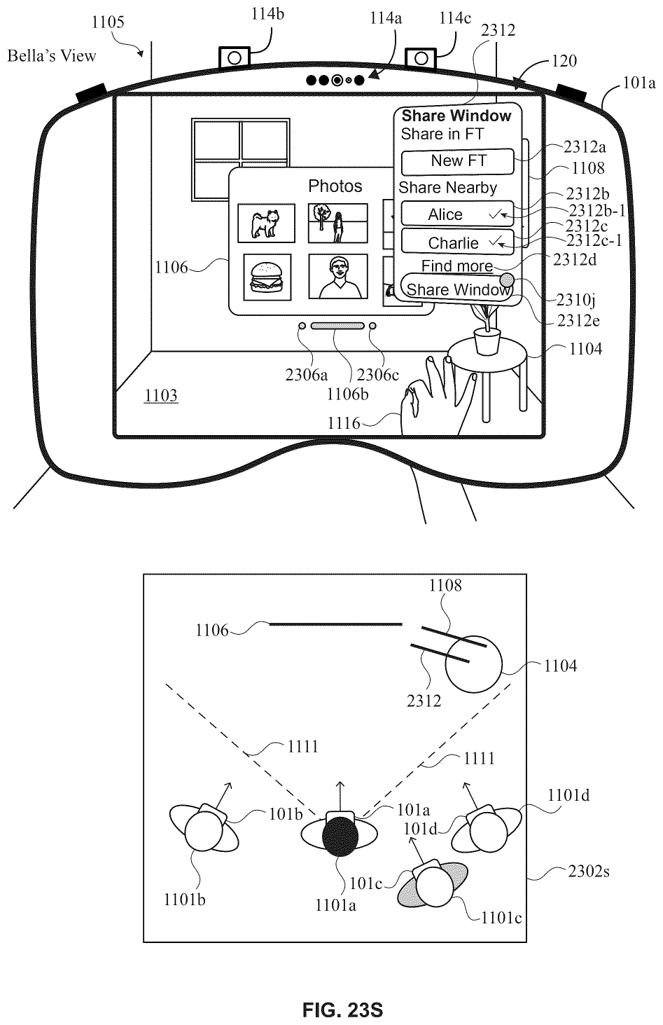

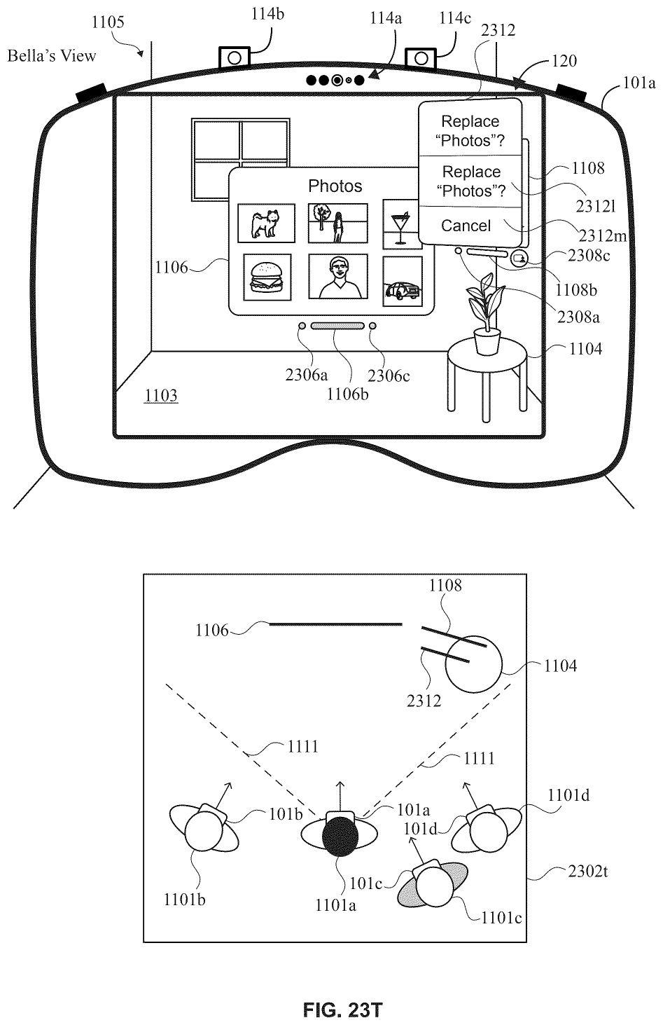

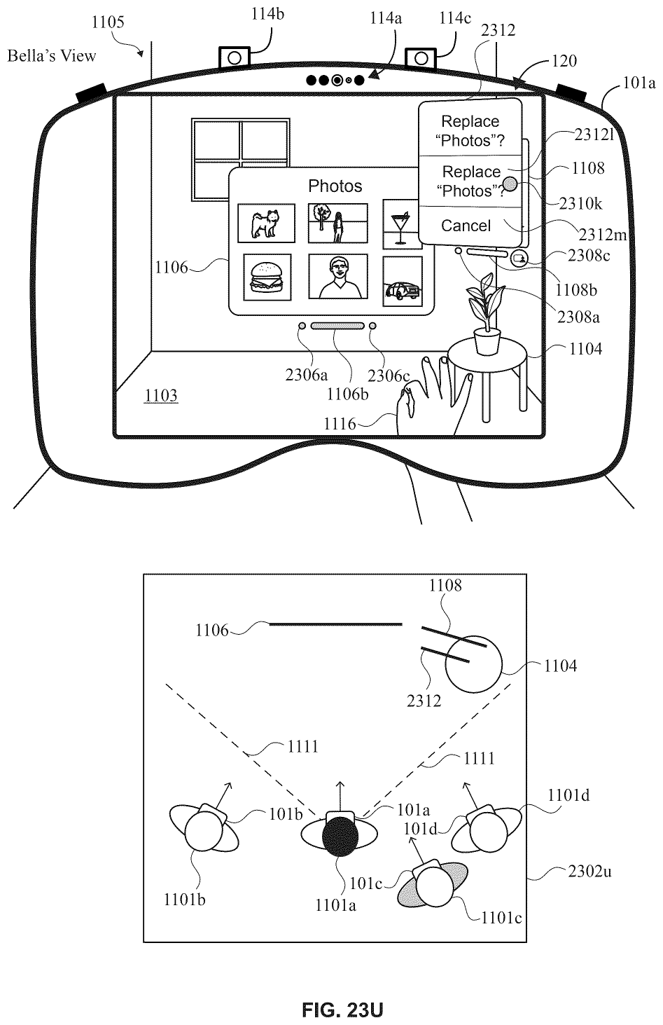

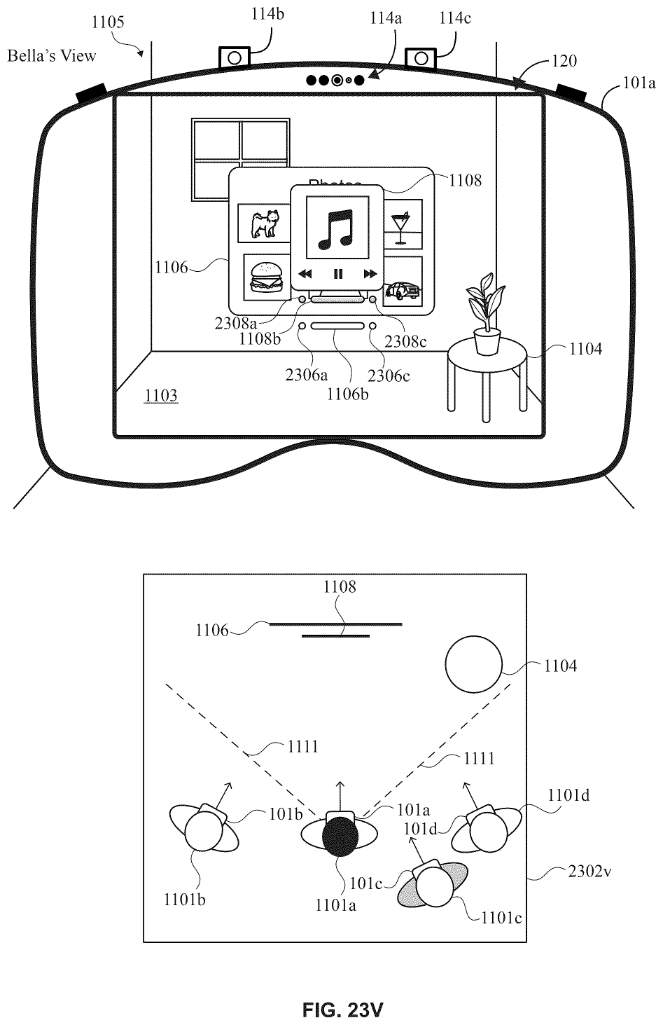

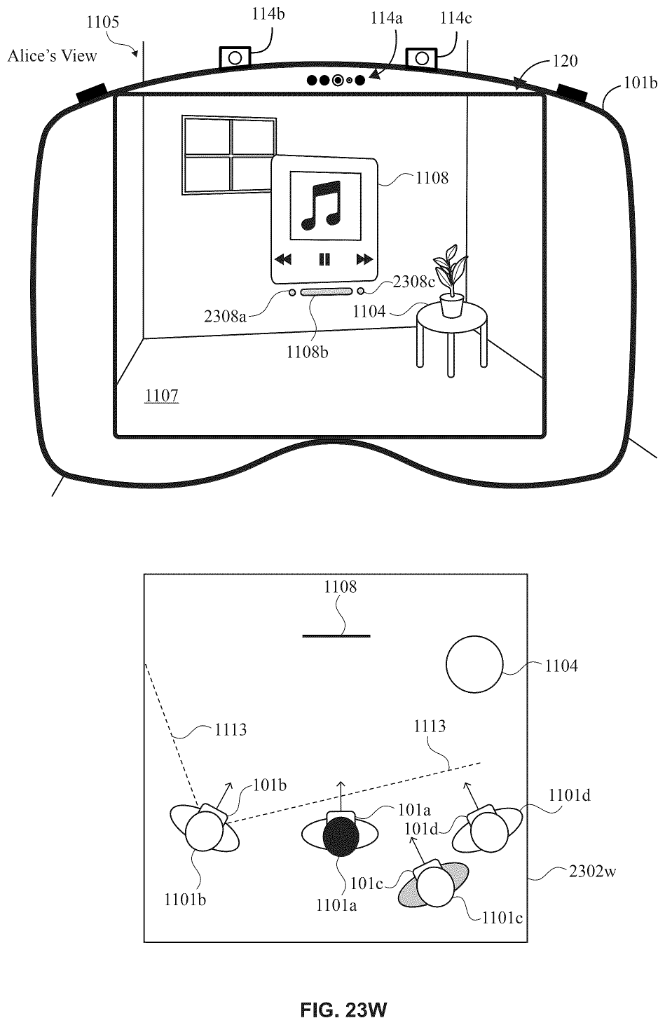

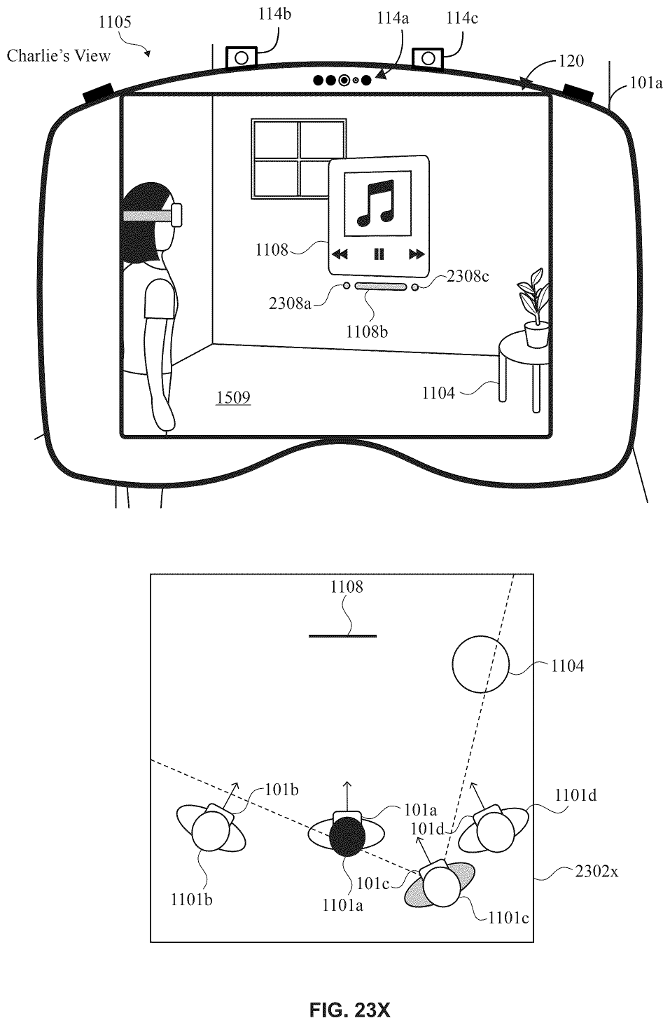

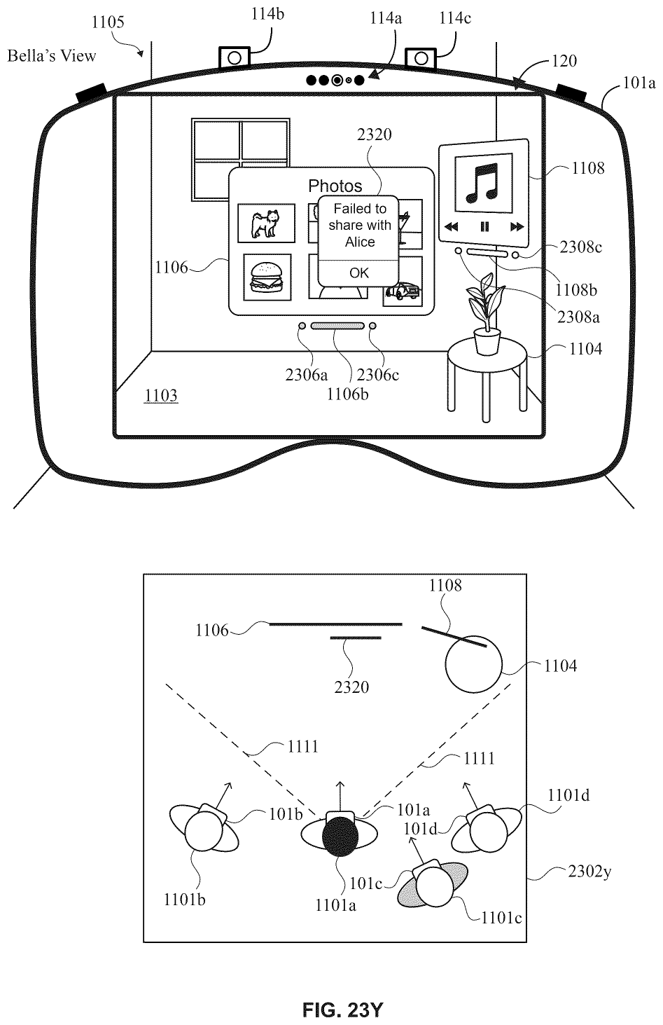

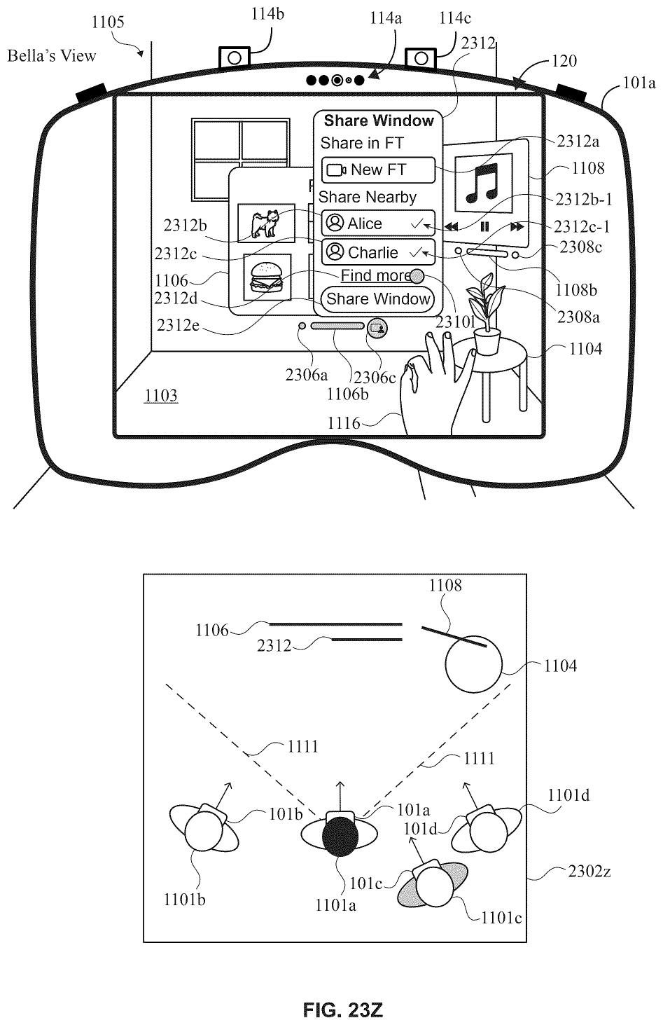

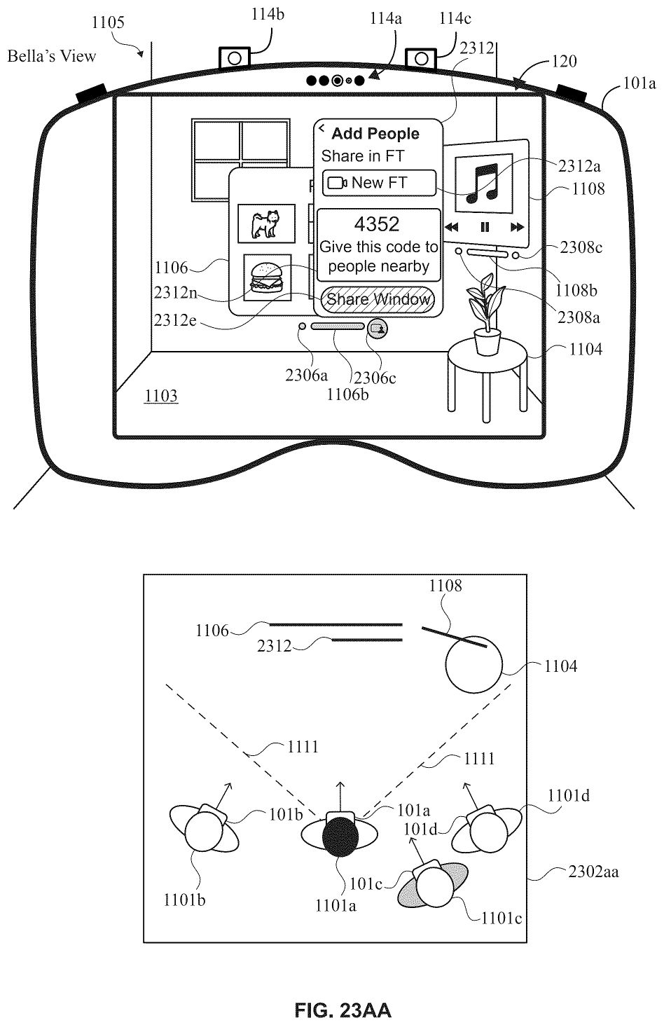

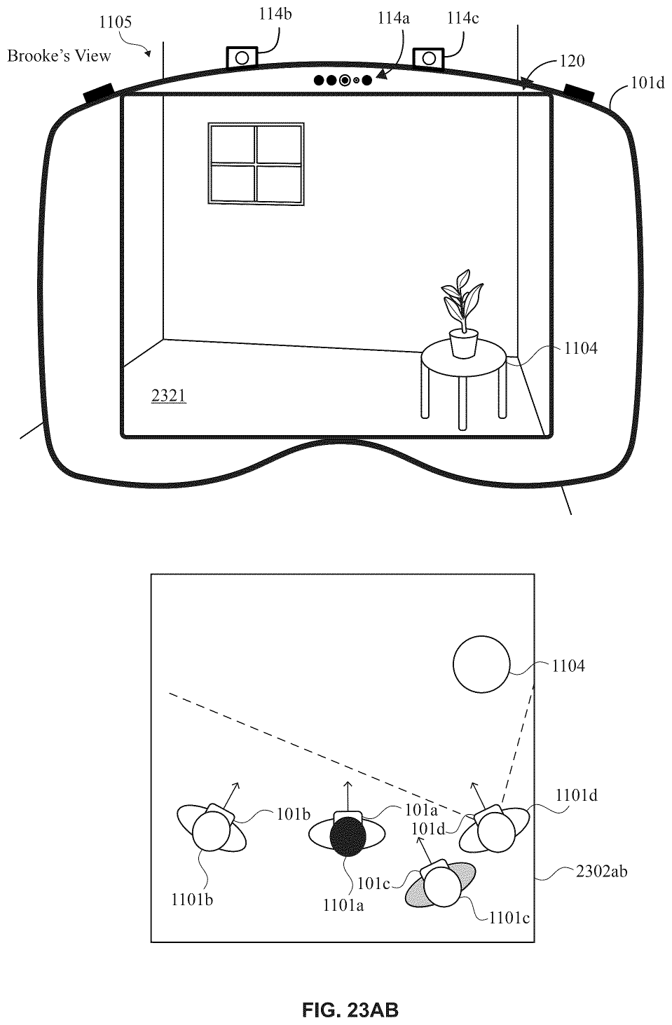

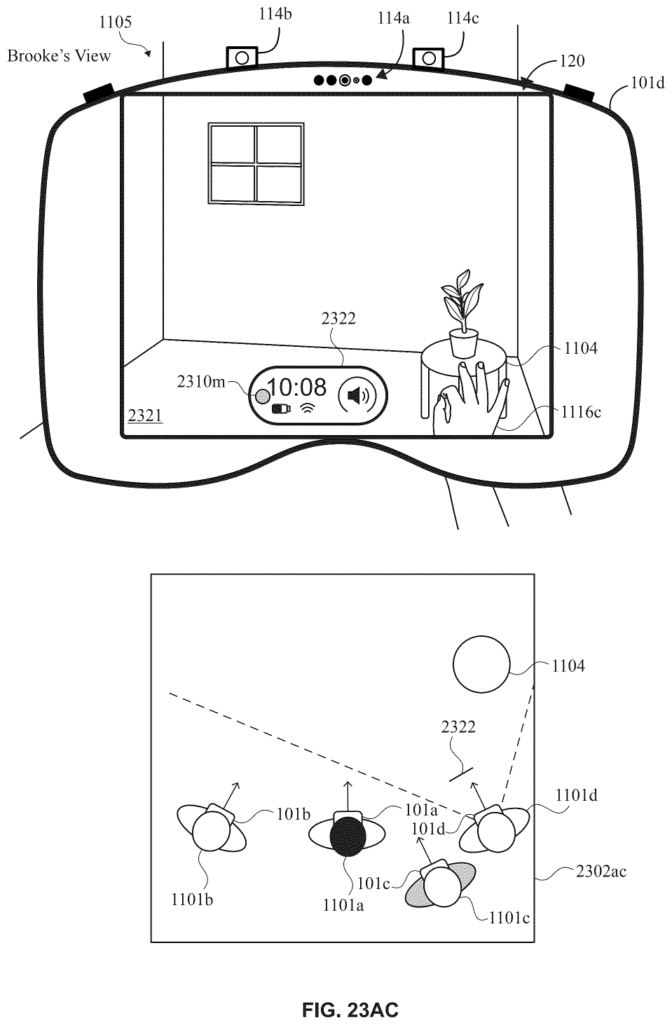

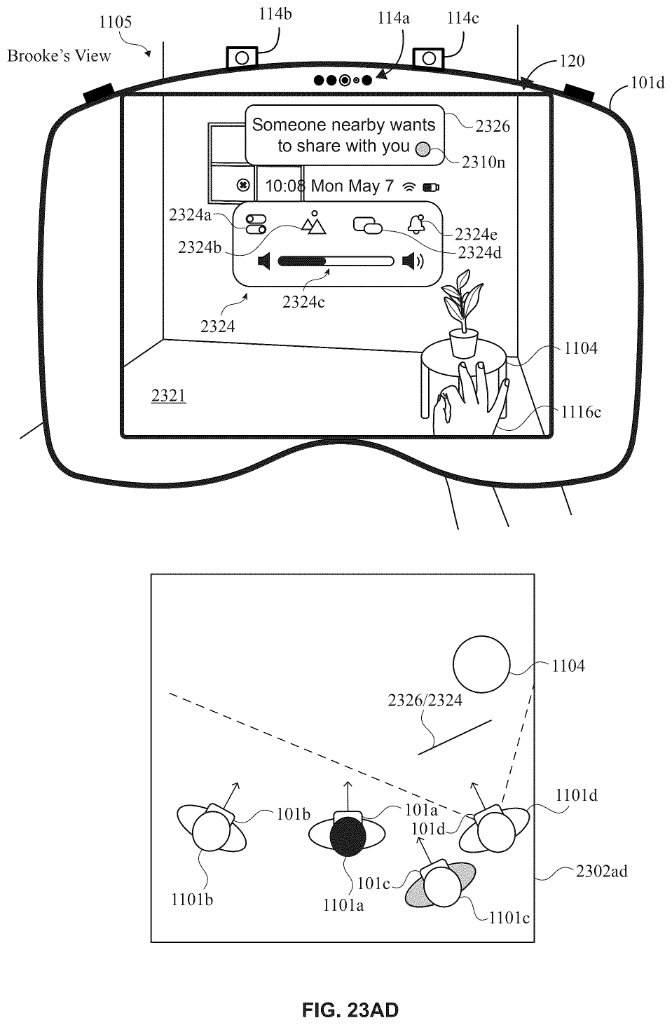

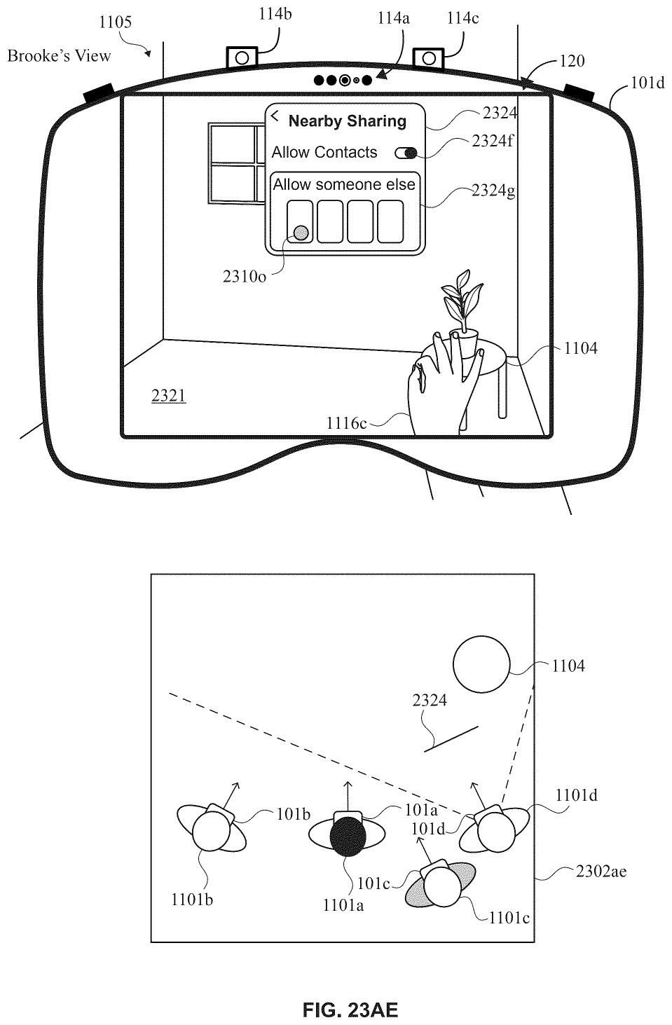

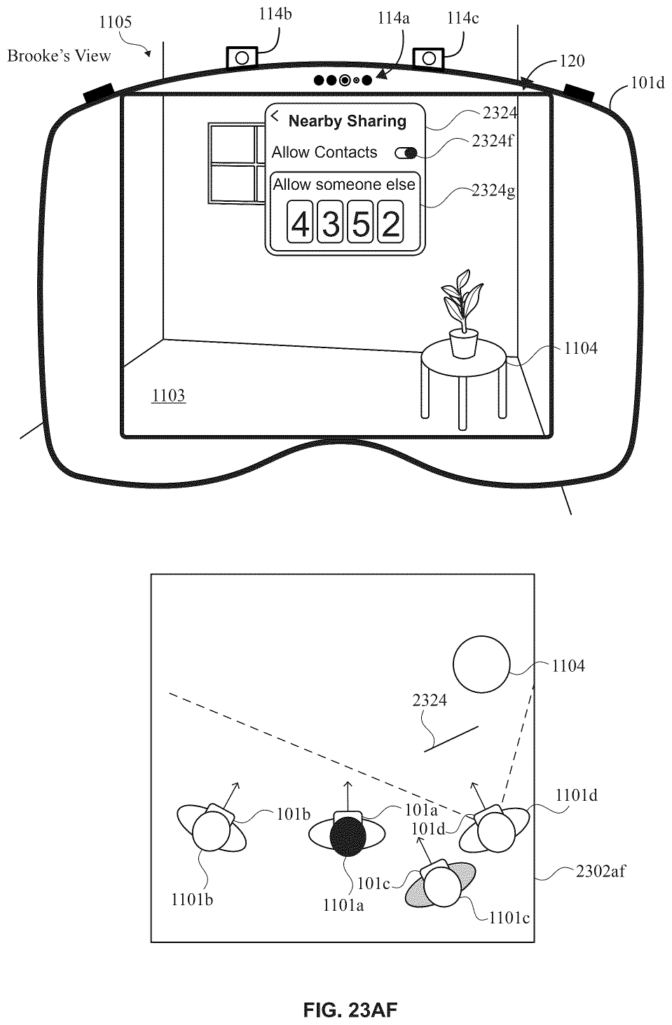

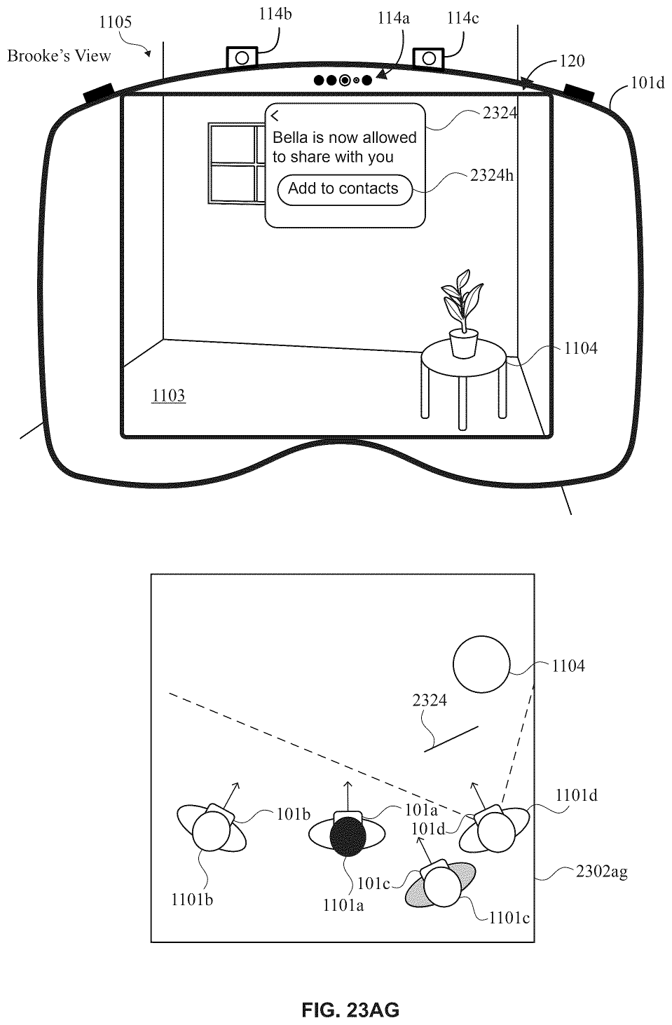

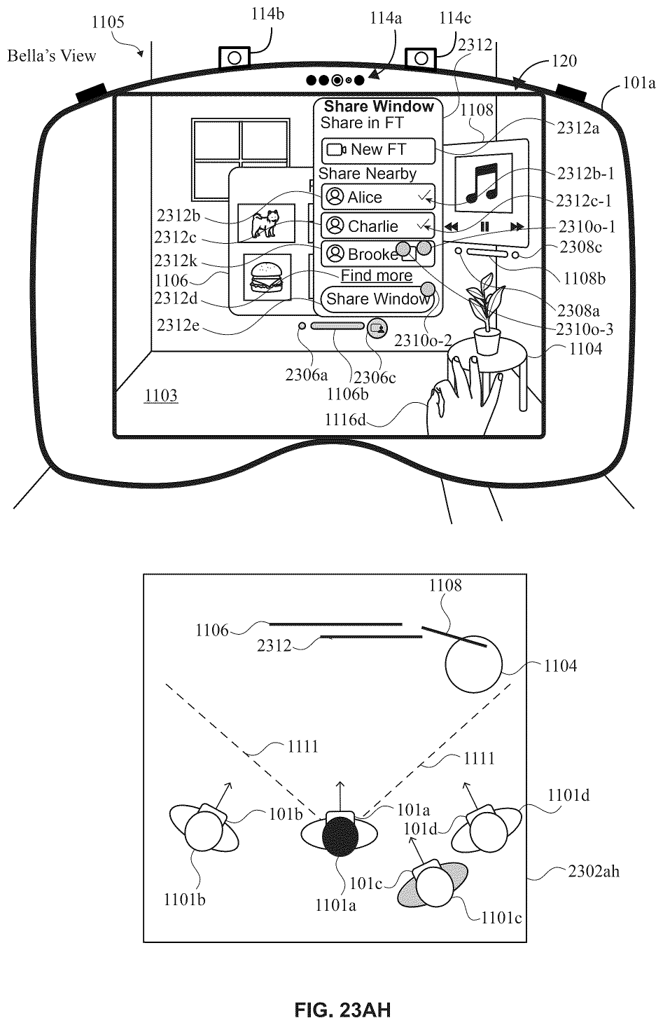

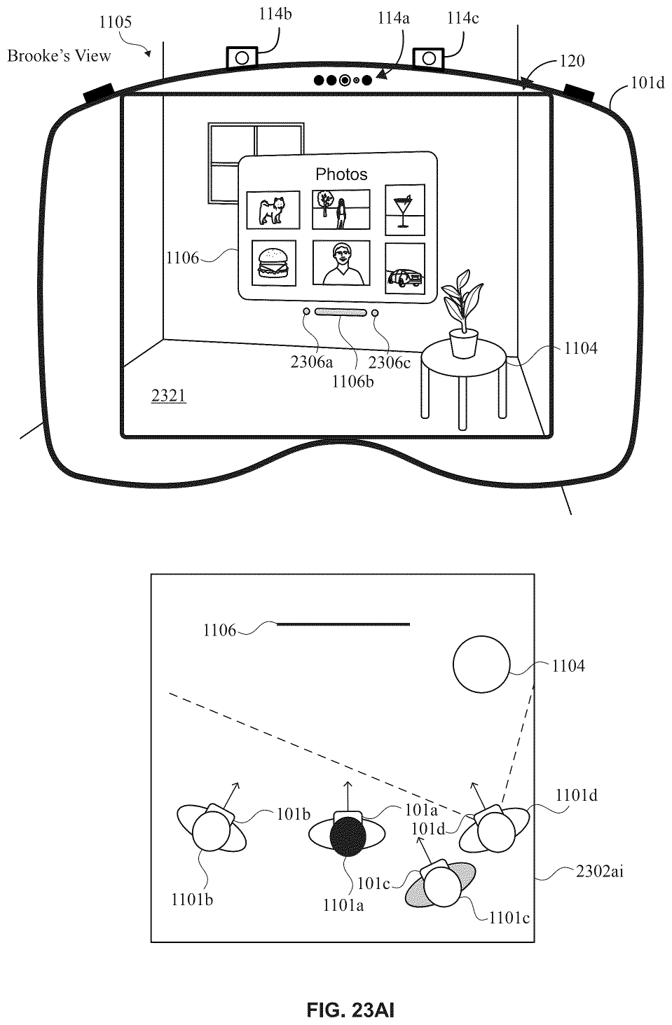

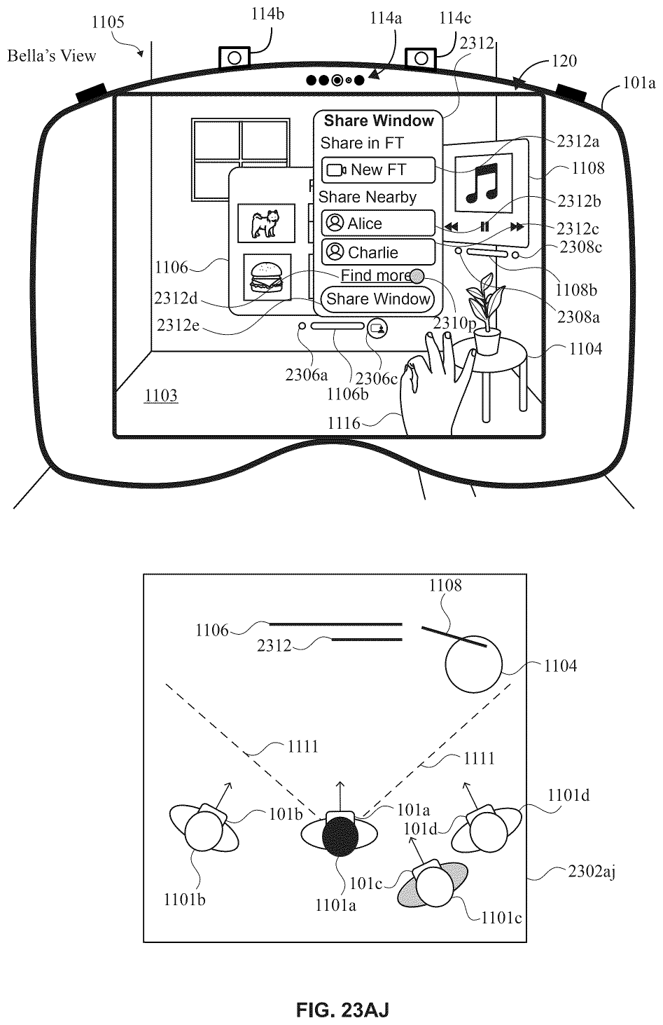

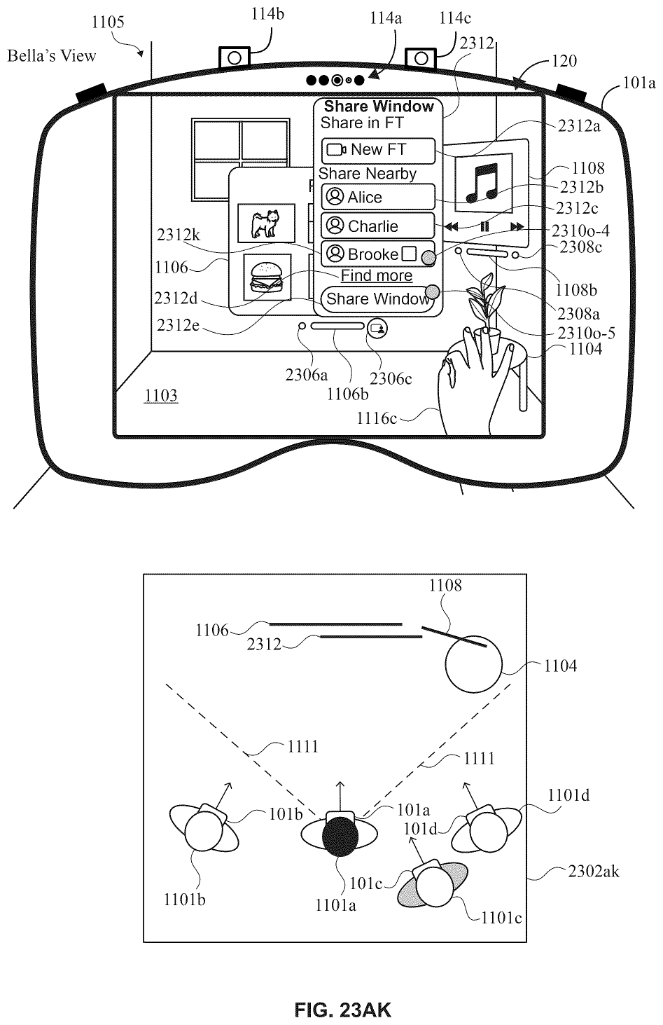

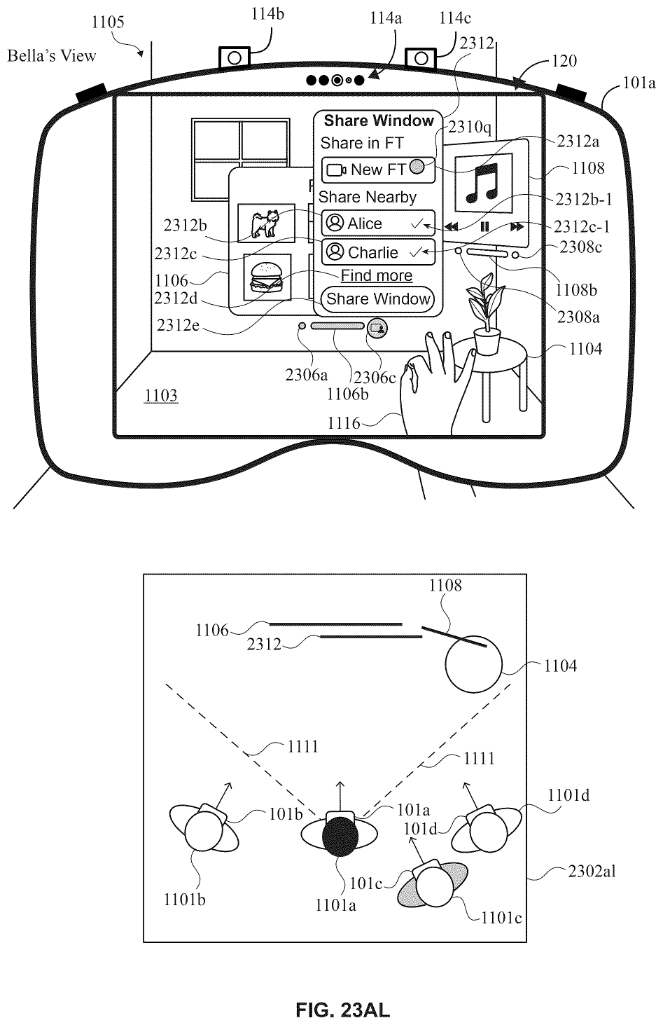

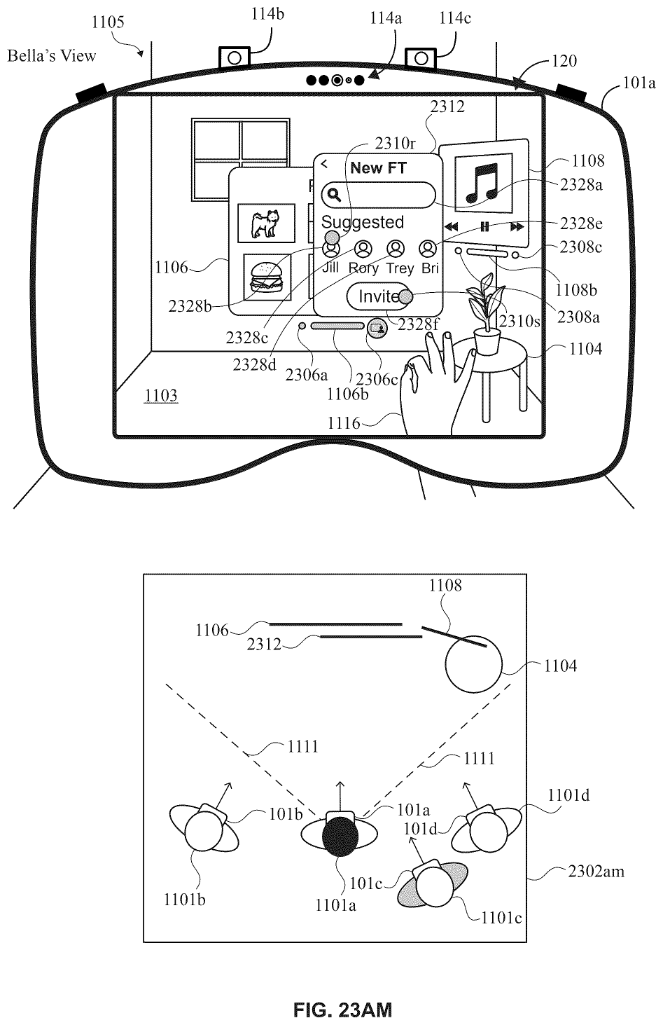

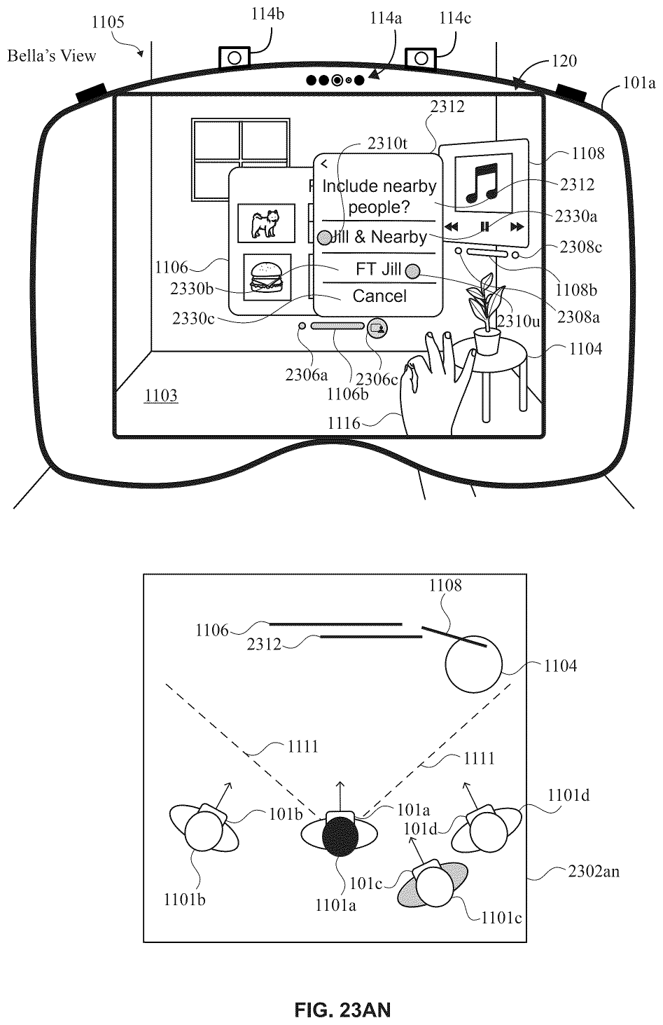

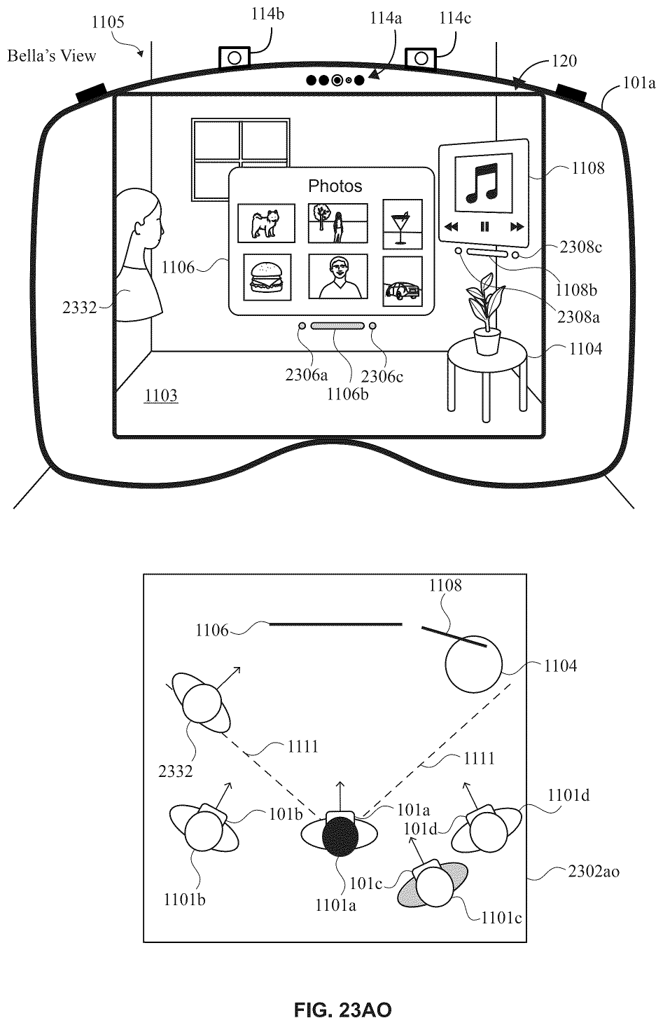

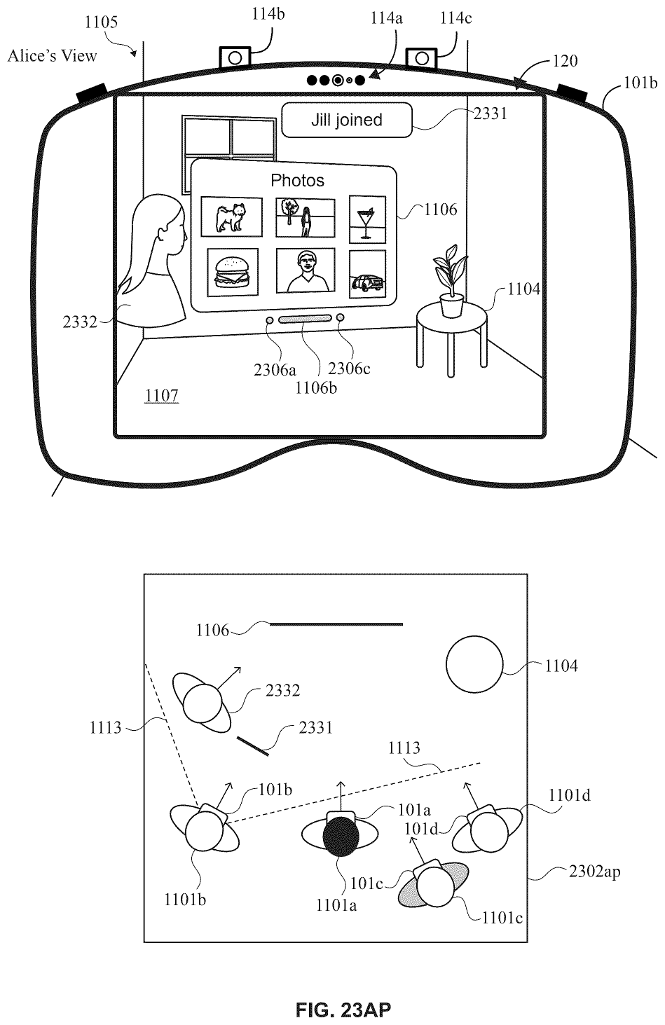

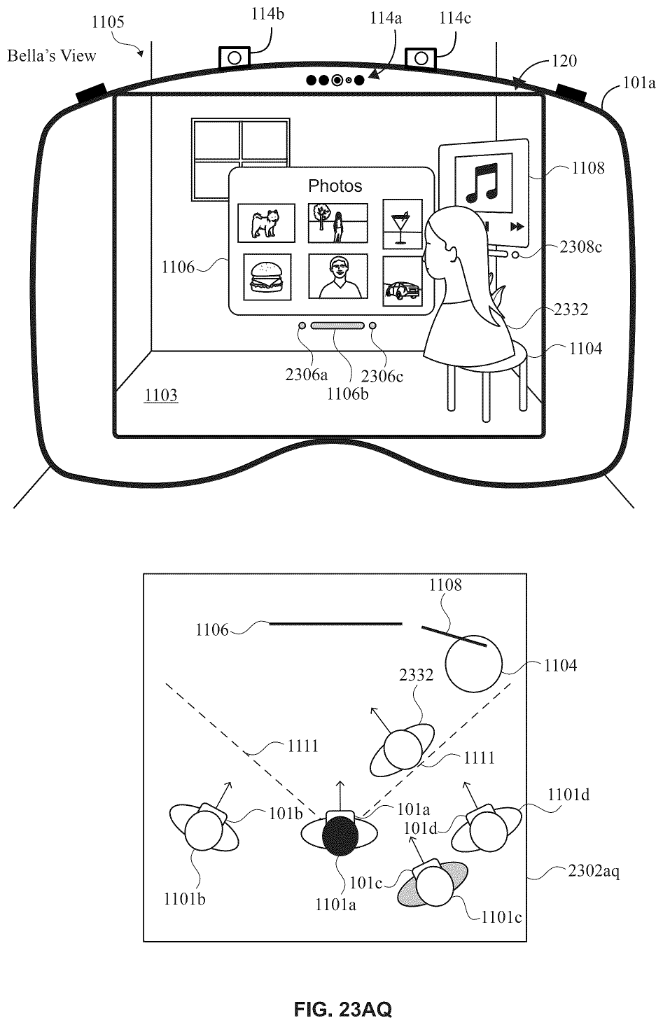

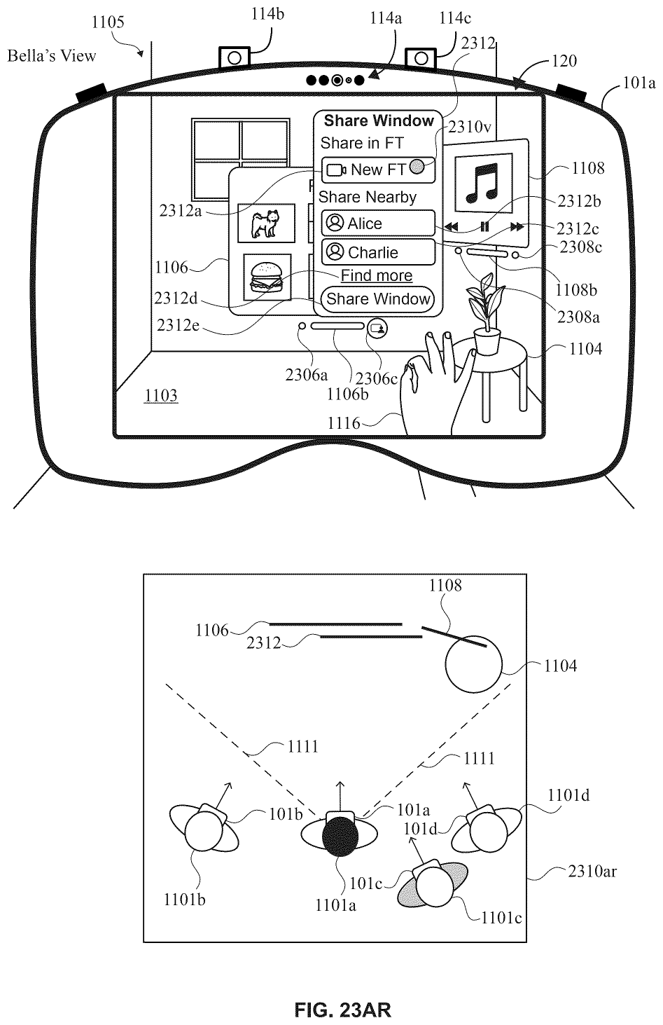

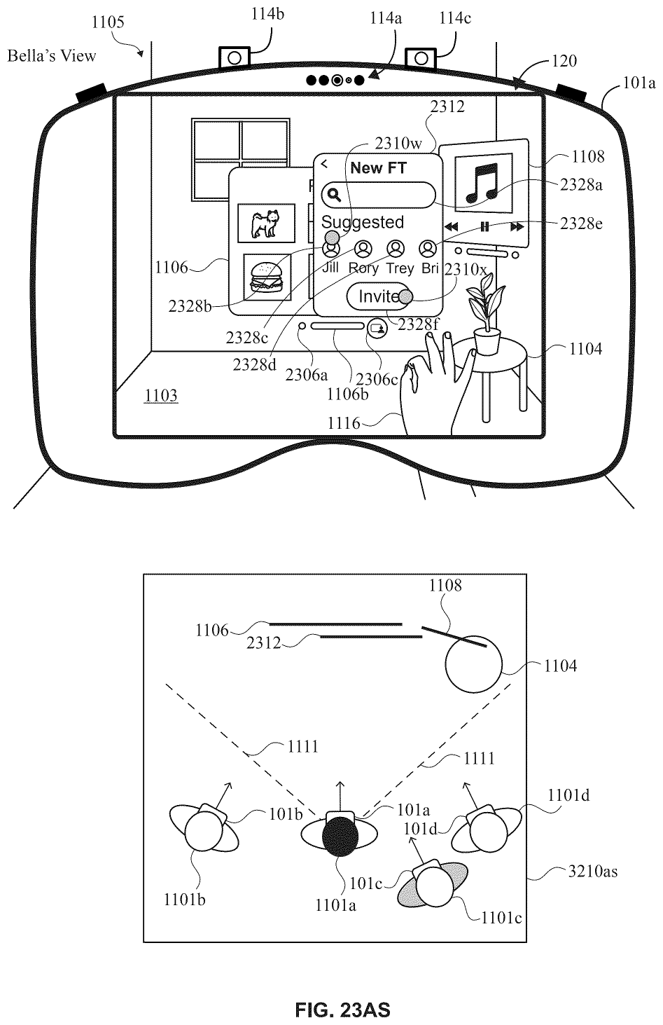

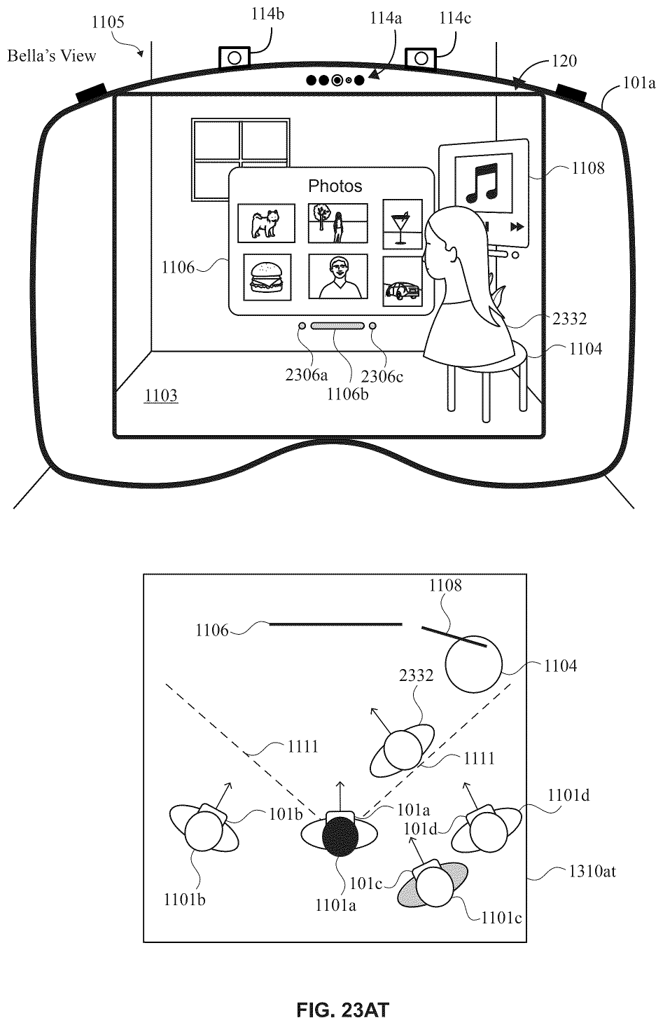

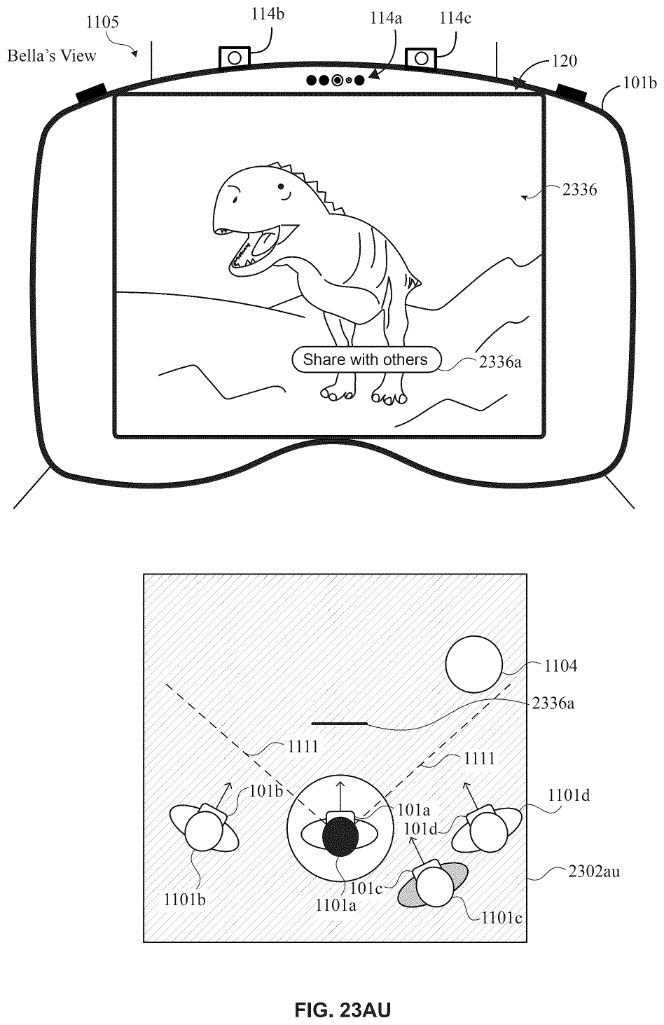

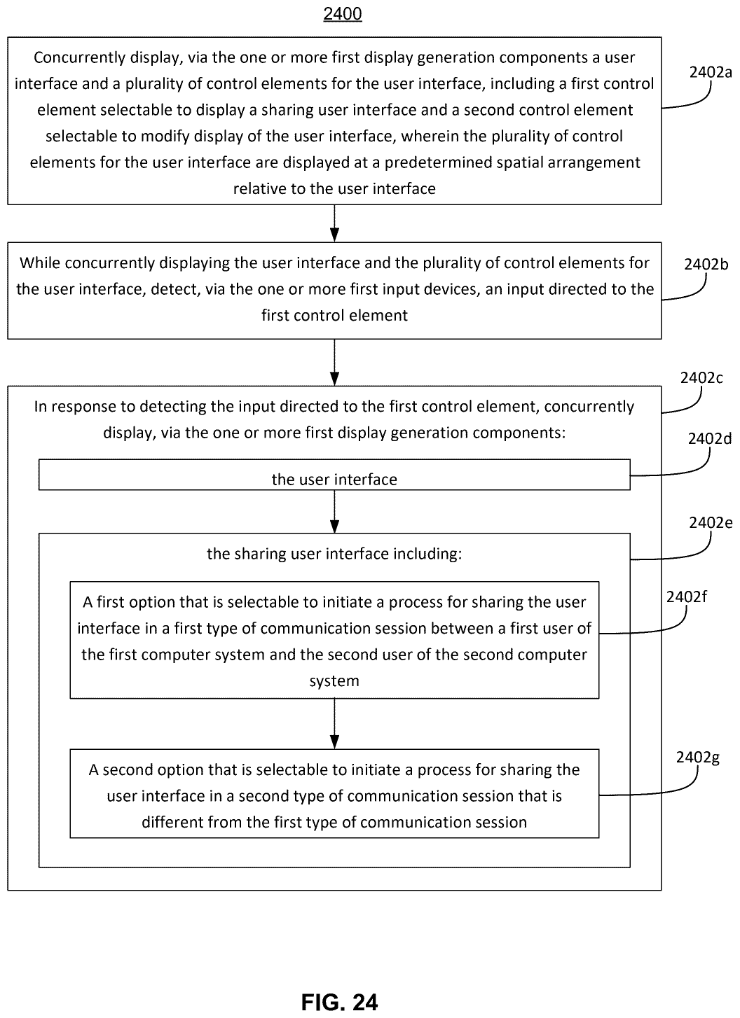

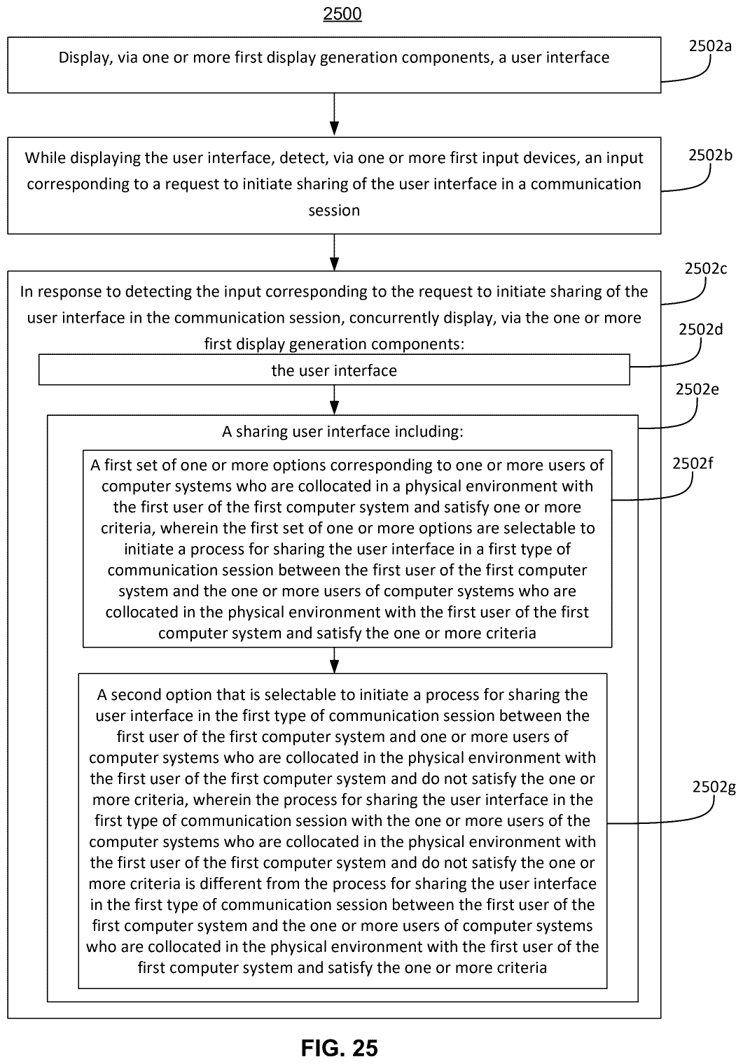

FIGS. 1A-6 provide a description of example computer systems for providing XR experiences to users (such as described below with respect to methods 800, 1000, 1200, 1400, 1600, 1800, 2000, 2200, 2400, and/or 2500). FIGS. 7A-1-7M illustrate examples of a computer system facilitating sharing of virtual content with one or more users in a three-dimensional environment in accordance with some embodiments. FIG. 8 is a flowchart illustrating an exemplary method of facilitating sharing of virtual content with one or more users in a three-dimensional environment in accordance with some embodiments. The user interfaces in FIGS. 7A-1-7M are used to illustrate the processes in FIG. 8. FIGS. 9A-9O illustrate example techniques for facilitating initiation of a spatial real-time communication session with one or more users in a three-dimensional environment in accordance with some embodiments. FIG. 10 is a flowchart of methods of facilitating initiation of a spatial real-time communication session with one or more users in a three-dimensional environment in accordance with some embodiments. The user interfaces in FIGS. 9A-9O are used to illustrate the processes in FIG. 10. FIGS. 11A-1 through 11F generally illustrate examples of a first computer system sharing a user interface with a second computer system in response to selection of a first user interface element for sharing the user interface with the second computer system in accordance with some embodiments. FIG. 12 is a flowchart illustrating an exemplary method for sharing a user interface with a second computer system in response to selection of a first user interface element for sharing the user interface with the second computer system in accordance with some embodiments. The user interfaces in FIGS. 11A-1 through 11F are generally used to illustrate the processes in FIG. 12. FIGS. 13A through 13J generally illustrate examples of a first computer system sharing a user interface with a second computer system in response to detecting different user inputs directed to a user of the second computer system and to the user interface, where the first computer system and the second computer system are collocated in a physical environment in accordance with some embodiments. FIG. 14 is a flowchart illustrating an exemplary method for sharing a user interface with a second computer system in response to detecting different user inputs directed to a user of the second computer system and to the user interface in accordance with some embodiments. The user interfaces in FIGS. 13A through 13J are generally used to illustrate the processes in FIG. 14. FIGS. 15A through 15Y generally illustrate examples of a first computer system sharing a user interface with a second computer system in response to detecting movement of the user interface to a user interface element for sharing the user interface with the second computer system, where the first computer system and the second computer system are collocated in a physical environment in accordance with some embodiments. FIG. 16 is a flowchart illustrating an exemplary method for sharing a user interface with a second computer system in response to detecting movement of the user interface to a user interface element for sharing the user interface with the second computer system in accordance with some embodiments. The user interfaces in FIGS. 15A through 15Y are generally used to illustrate the processes in FIG. 16. FIGS. 17A-1 through 17Z generally illustrate examples of a first computer system displaying a sharing user interface for selecting content to share with a second user of a second computer system in response to selection of a first user interface element that is displayed when the second user is detected in a viewport of the first computer system, where the first computer system and the second computer system are collocated in a physical environment in accordance with some embodiments. FIG. 18 is a flowchart illustrating an exemplary method for displaying a sharing user interface for selecting content to share with a second user of a second computer system in response to selection of a first user interface element that is displayed when the second user is detected in a viewport of the first computer system in accordance with some embodiments. The user interfaces in FIGS. 17A-1 through 17Z are generally used to illustrate the processes in FIG. 18. FIGS. 19A through 19O generally illustrate examples of a first computer system initiating a process to present a visual indication on a portion of a second computer system in response to detecting that certain criteria are satisfied, where the first computer system and the second computer system are collocated in a physical environment in accordance with some embodiments. FIG. 20 is a flowchart illustrating an exemplary method for initiating a process to present a visual indication on a portion of a second computer system in response to detecting that certain criteria are satisfied in accordance with some embodiments. The user interfaces in FIGS. 19A through 19O are generally used to illustrate the processes in FIG. 20. FIGS. 21A through 21U generally illustrate examples of a first computer system adding a user to an existing communication session that is between a first user of the first computer system and a second user of a second computer system in response to user input from the first user being directed at a communication session user interface for adding the user, where the first computer system and second computer systems are collocated in a physical environment, in accordance with some embodiments. FIG. 22 is a flowchart illustrating an exemplary method for adding a user to an existing communication session that is between a first user of the first computer system and a second user of a second computer system in response to user input from the first user being directed at a communication session user interface for adding the user in accordance with some embodiments. The user interfaces in FIGS. 21A through 21U are generally used to illustrate the processes in FIG. 22. FIGS. 23A through 23AU generally illustrate examples of a first computer system displaying a user interface and detecting and responding to input directed to a first control element that is concurrently displayed with the user interface, where the first control element is selectable to display a sharing user interface for the user interface, and/or displaying a user interface and detecting and responding to input corresponding to a request to initiate sharing of the user interface, in accordance with some embodiments. FIG. 24 is a flowchart illustrating an exemplary method for displaying a sharing user interface for a user interface in response to detecting an input directed to a first control element for the user interface, in accordance with some embodiments. FIG. 25 is a flowchart illustrating an exemplary method for displaying a sharing user interface for a user interface in response to detecting an input corresponding to a request to initiate sharing of the user interface in a communication session, in accordance with some embodiments. The user interfaces in FIGS. 23A through 23AU are generally used to illustrate the respective processes in FIGS. 24 and 25.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

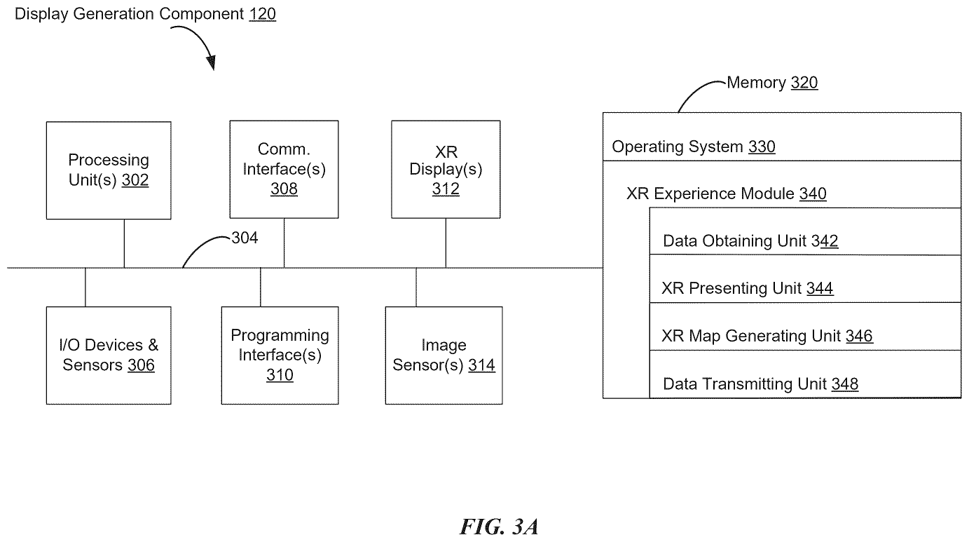

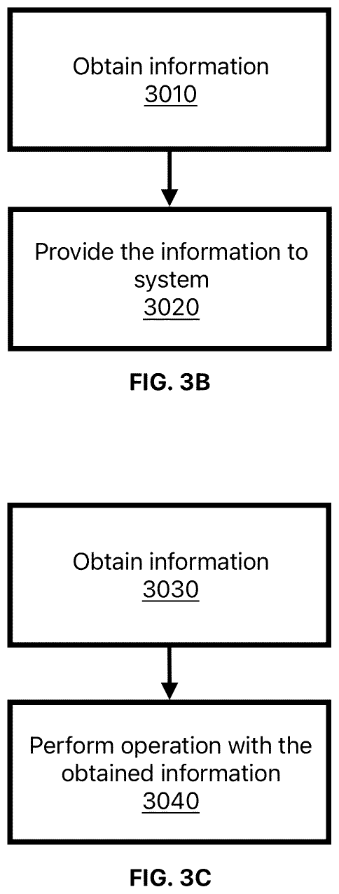

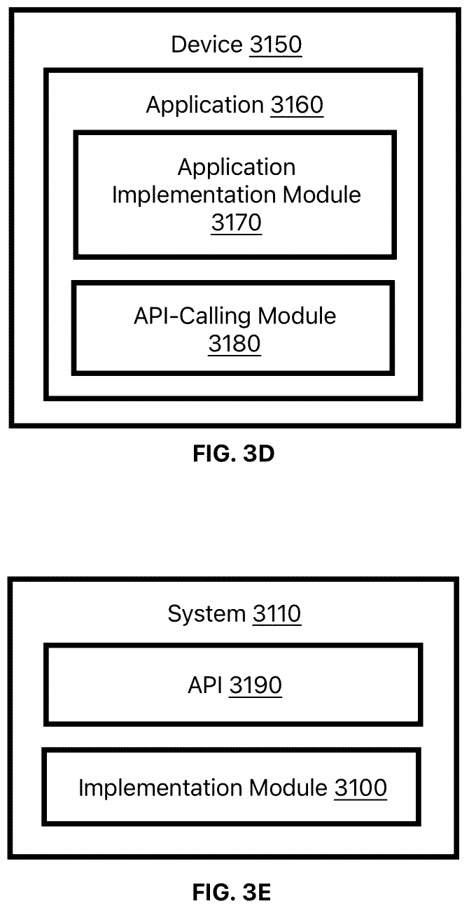

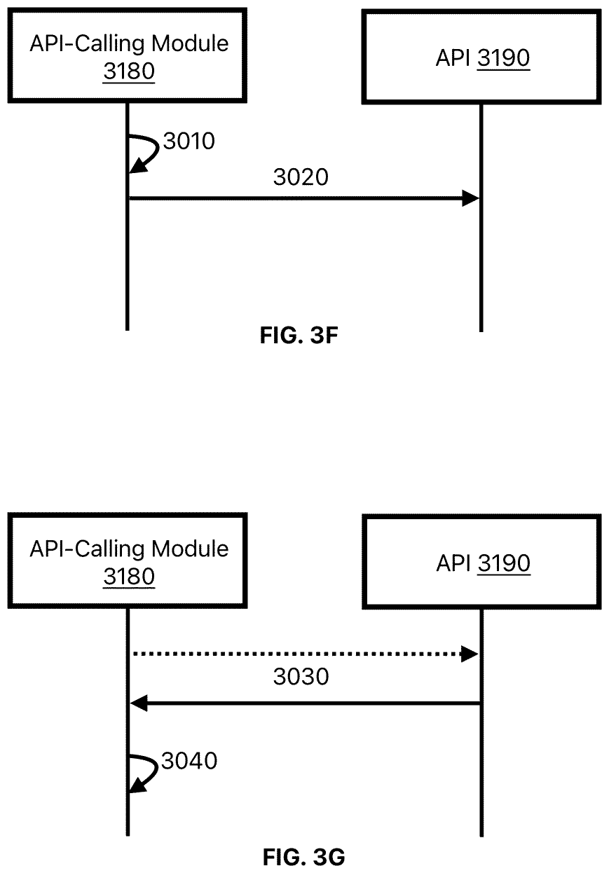

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

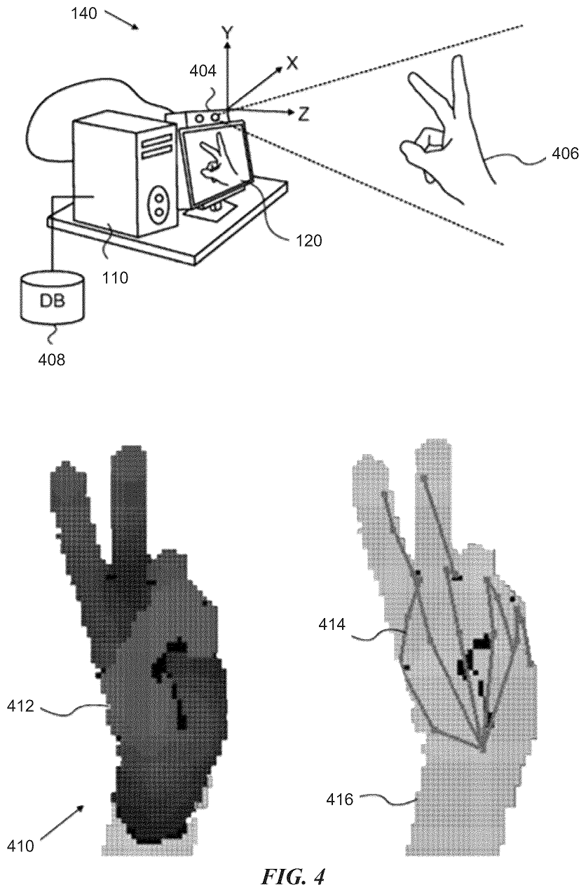

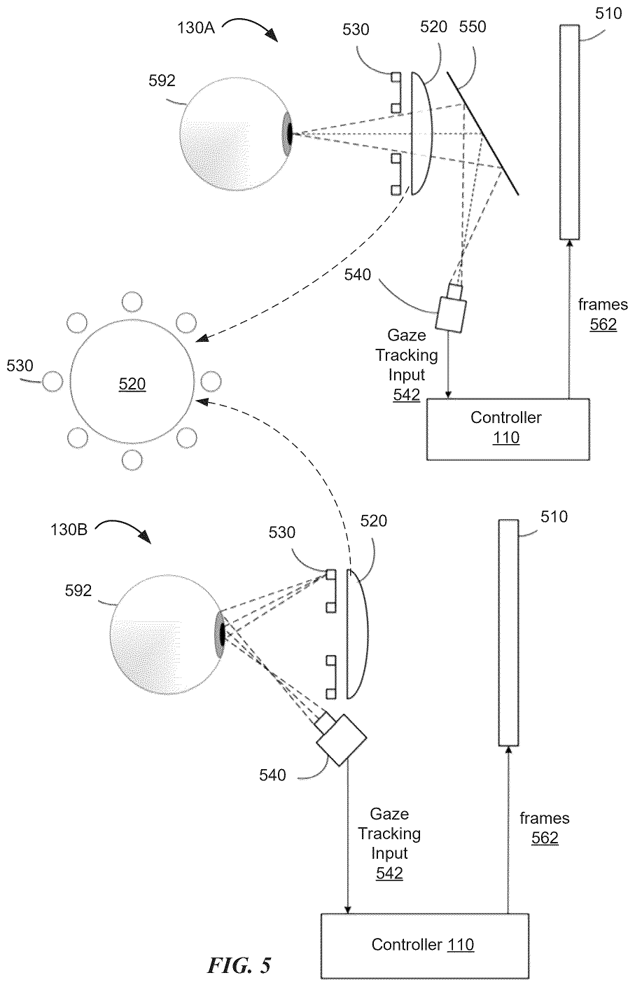

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the method 800 (FIG. 8), the method 1000 (FIG. 10), the method 1200 (FIG. 12), the method 1400 (FIG. 14), the method 1600 (FIG. 16), the method 1800 (FIG. 18), the method 2000 (FIG. 20), the method 2200 (FIG. 22), the method 2400 (FIG. 24), and/or the method 2500 (FIG. 25) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

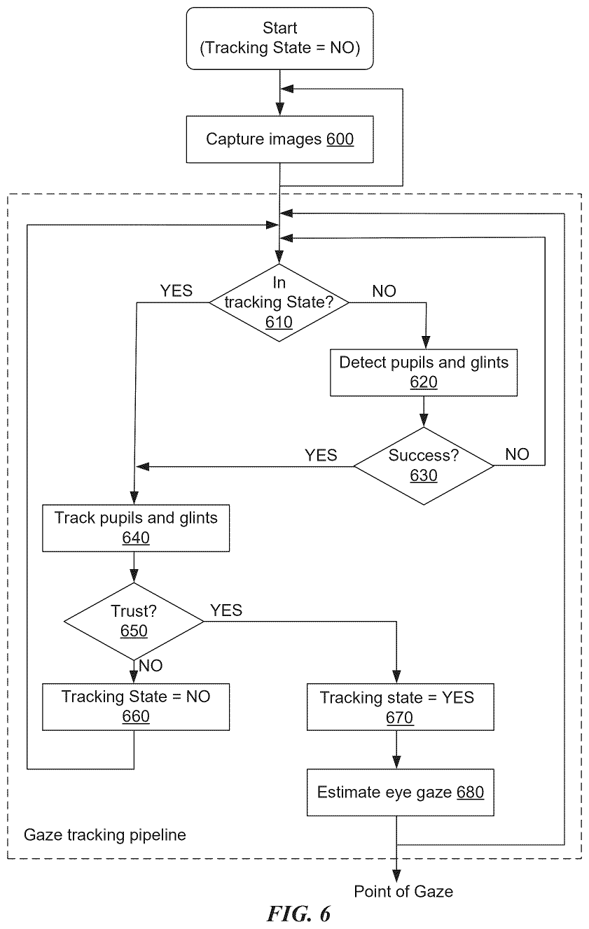

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or more cameras.

FIGS. 7A-1-7M illustrate examples of a computer system facilitating sharing of virtual content with one or more users in a three-dimensional environment according to some embodiments of the disclosure.

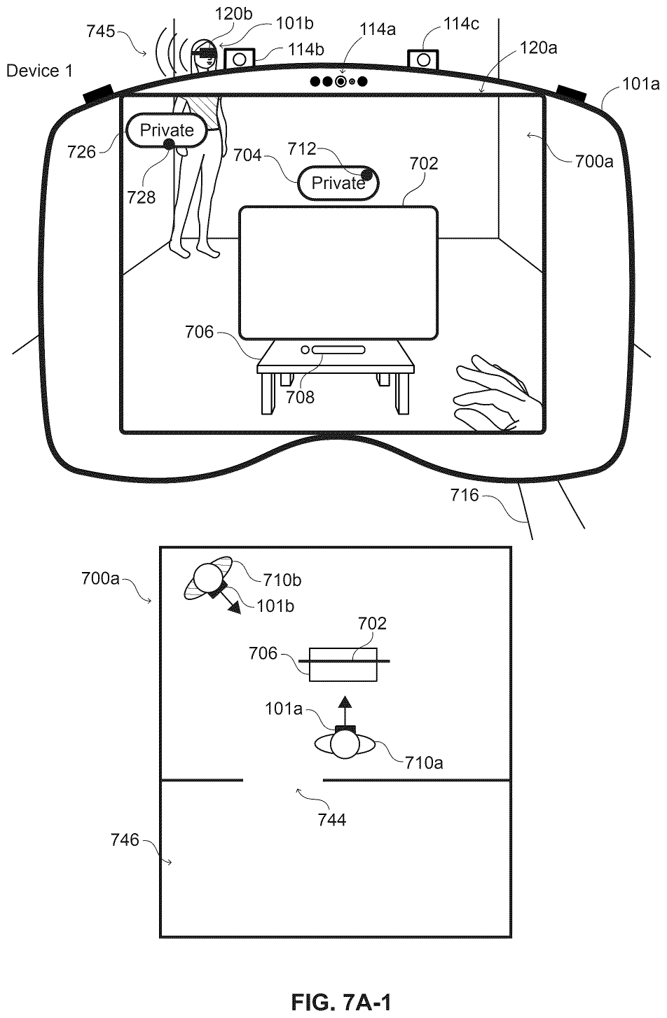

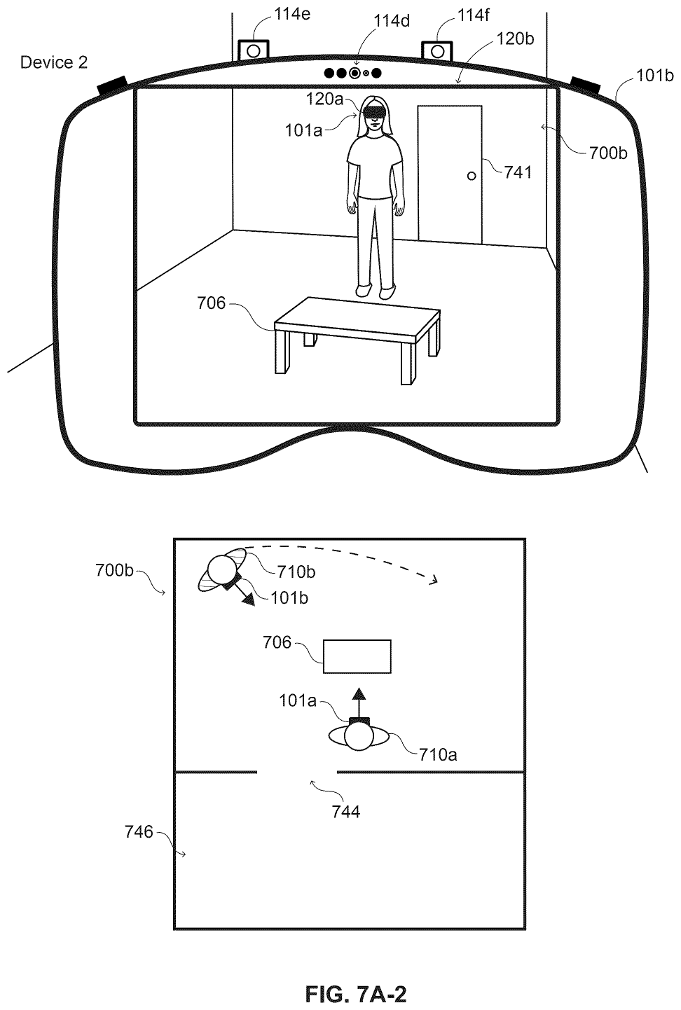

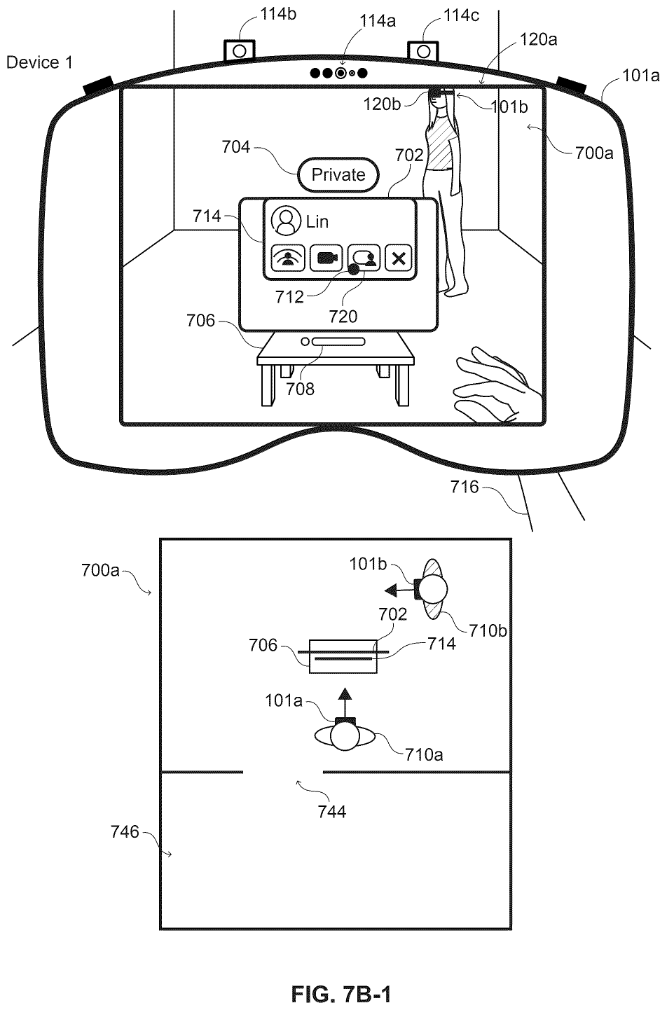

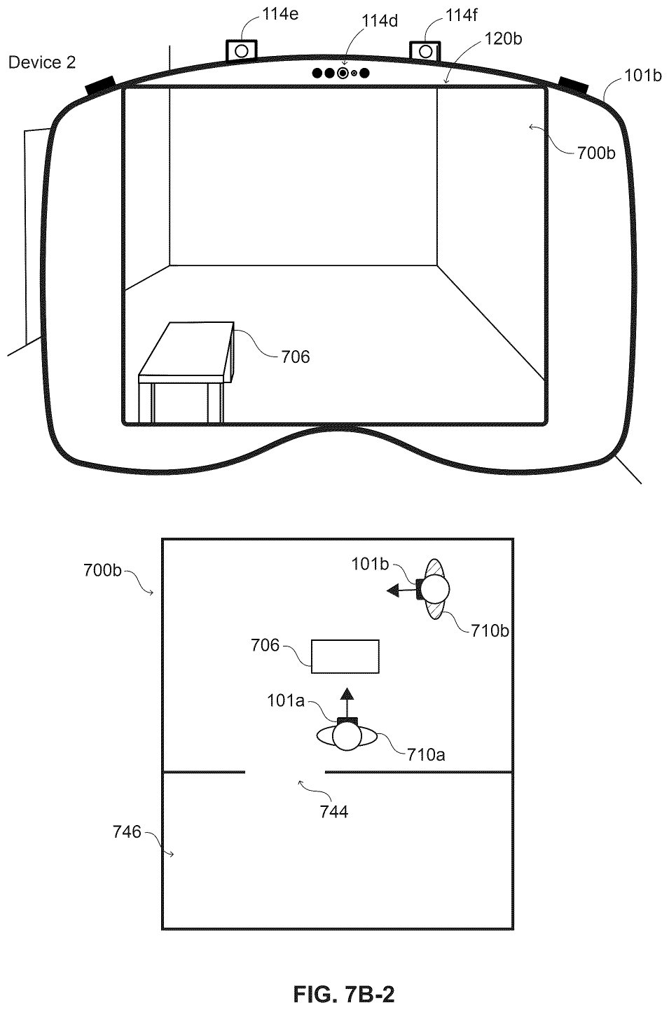

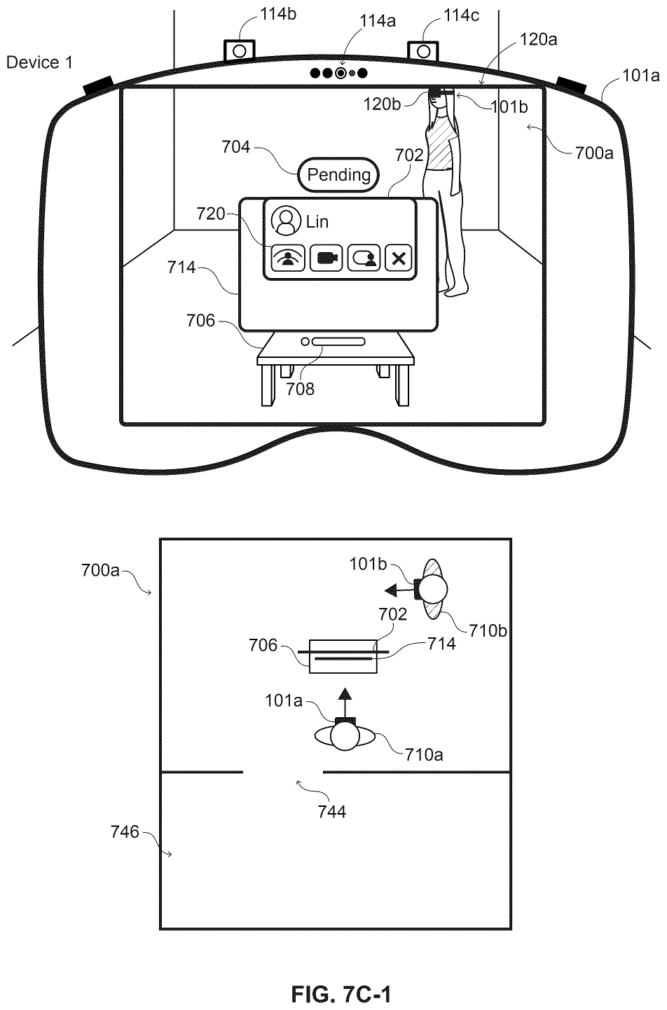

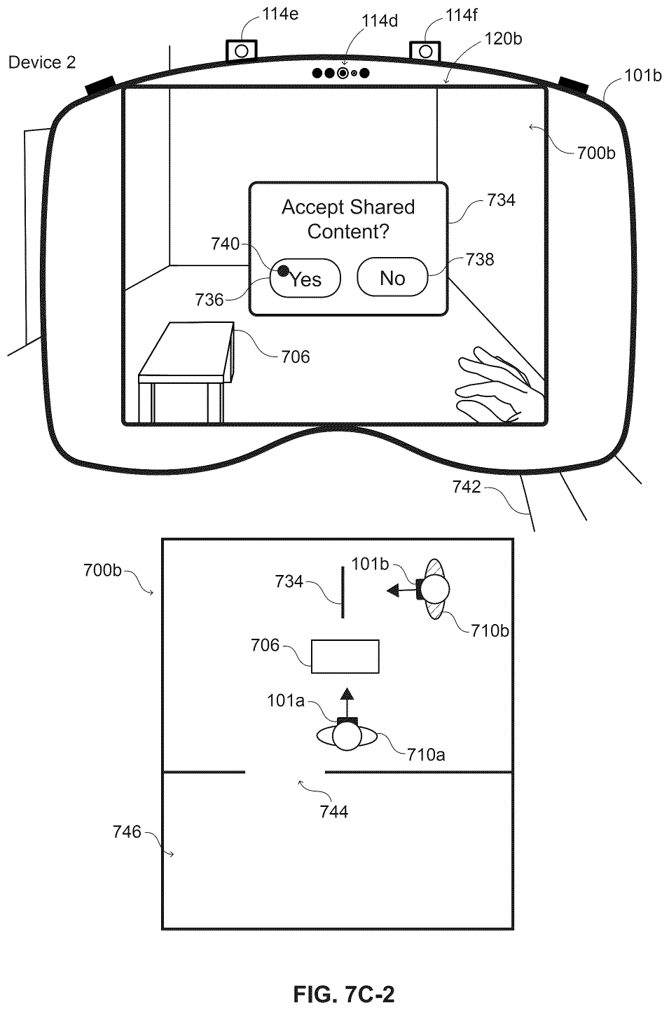

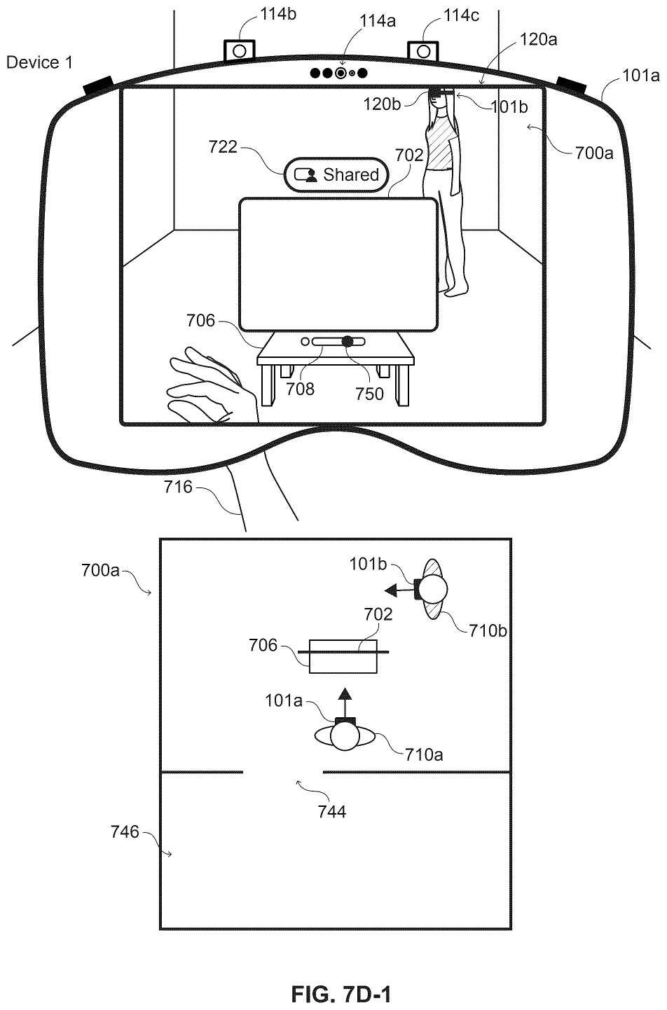

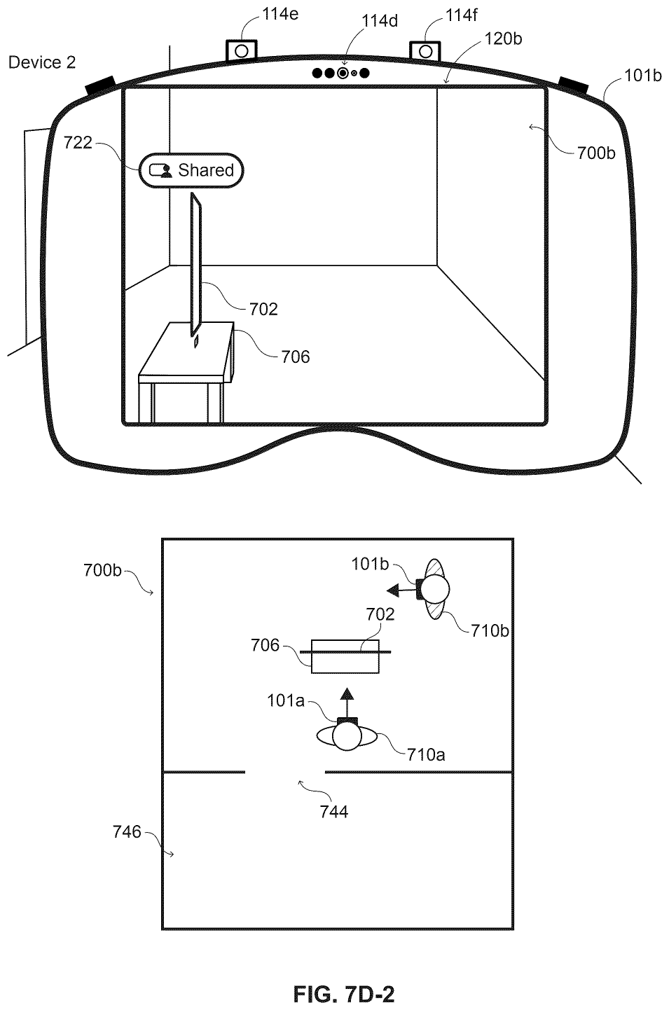

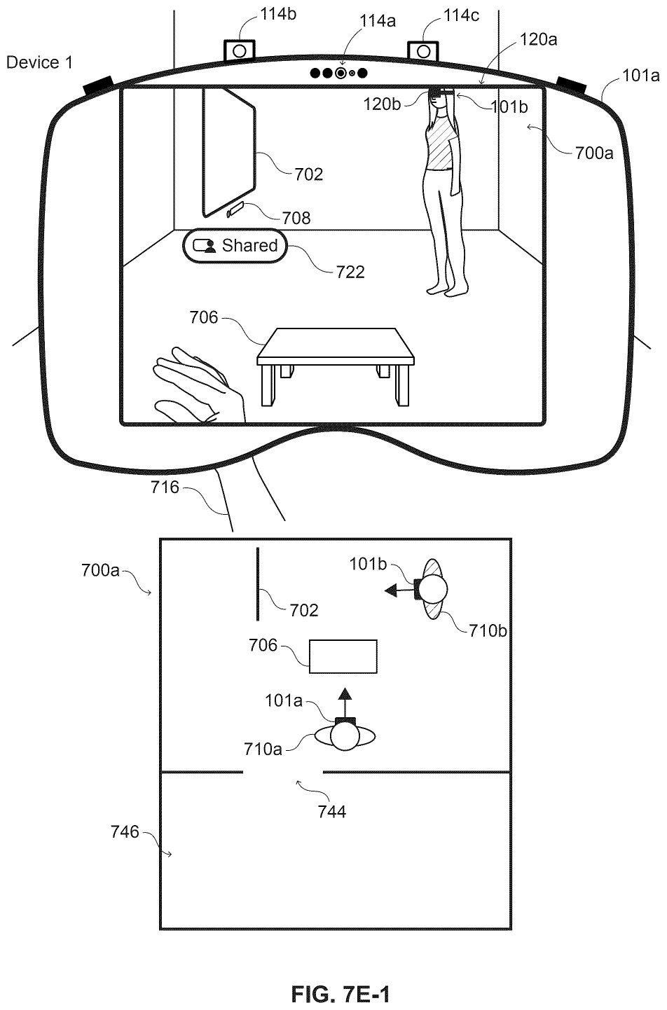

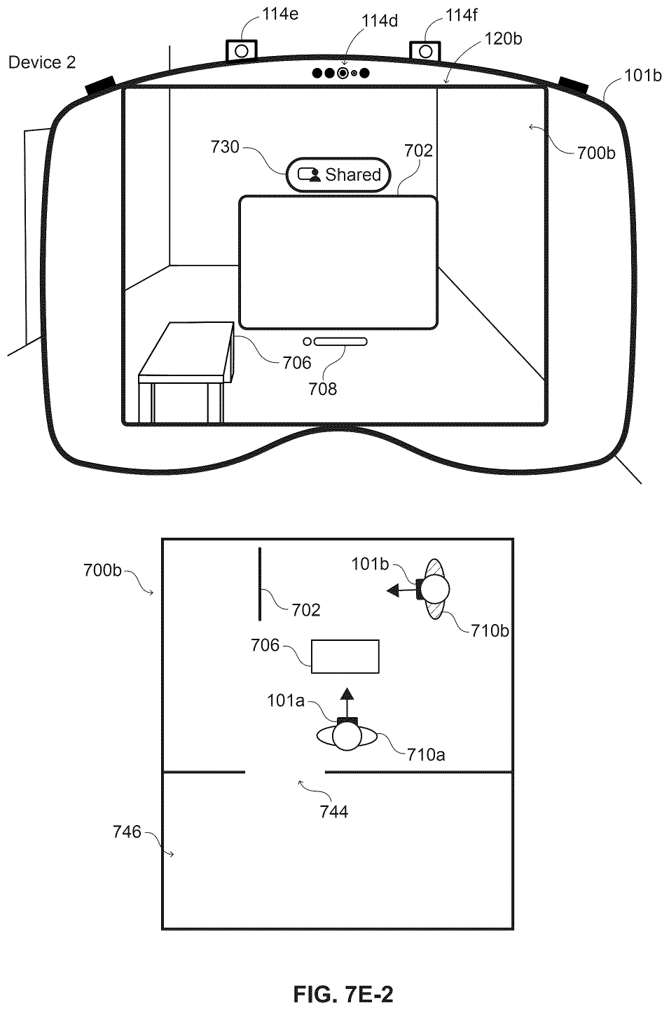

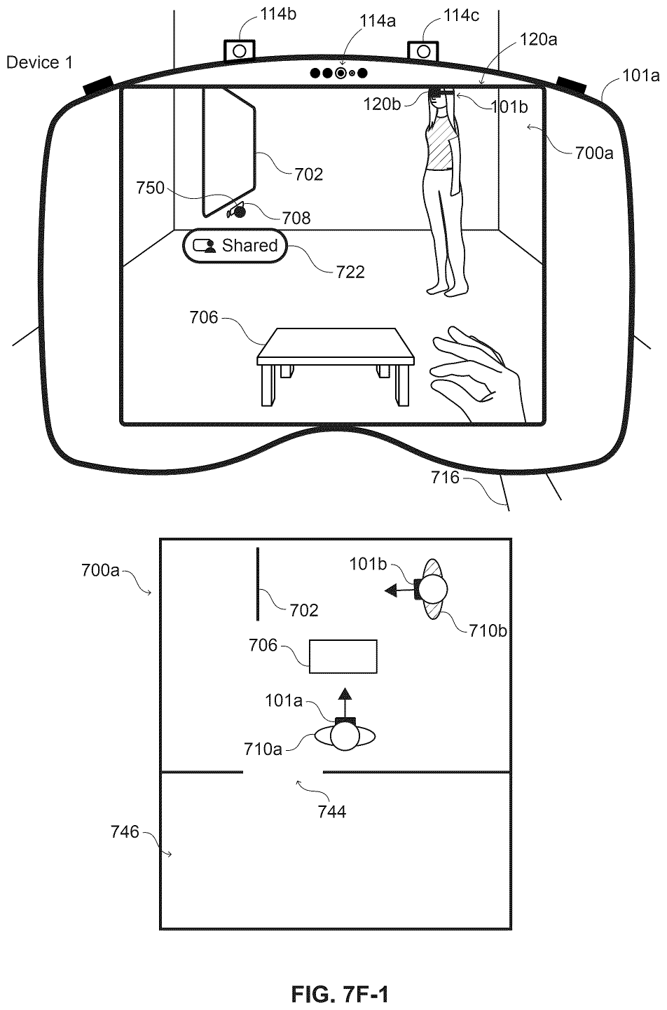

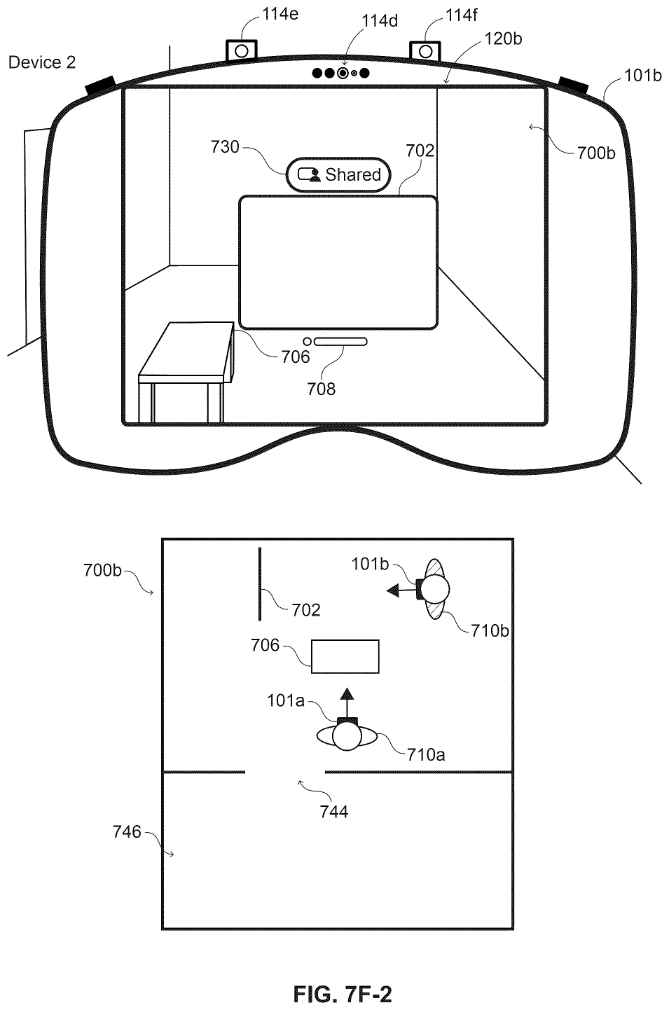

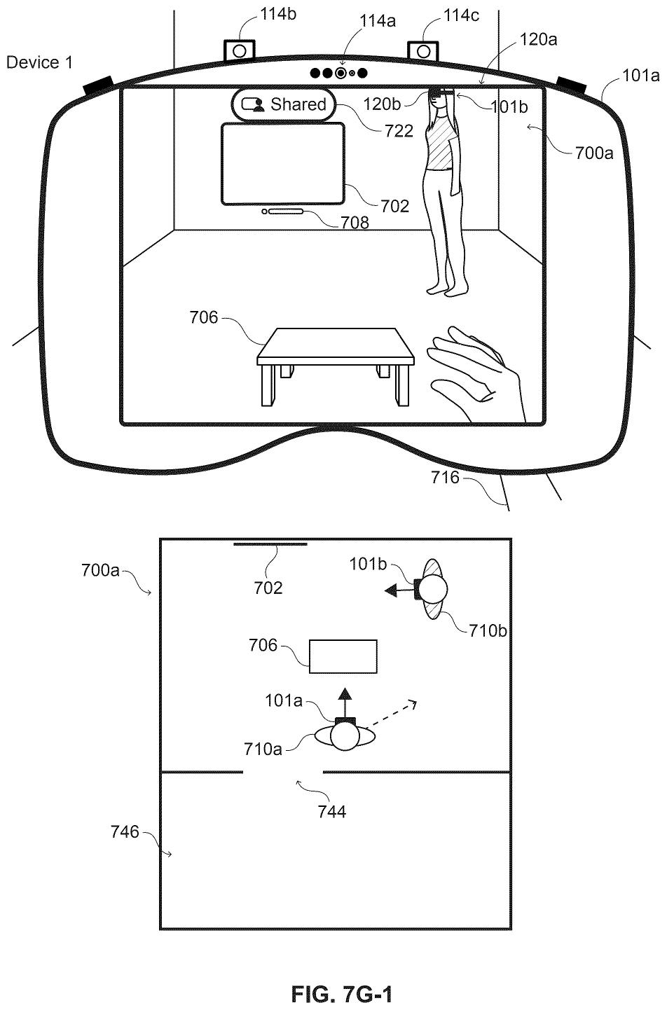

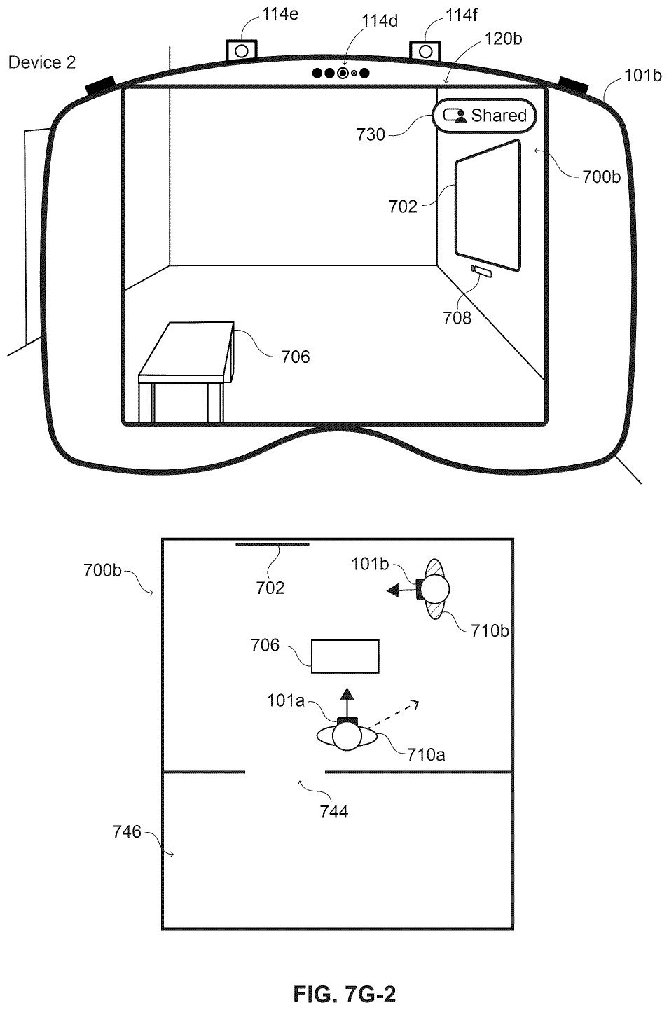

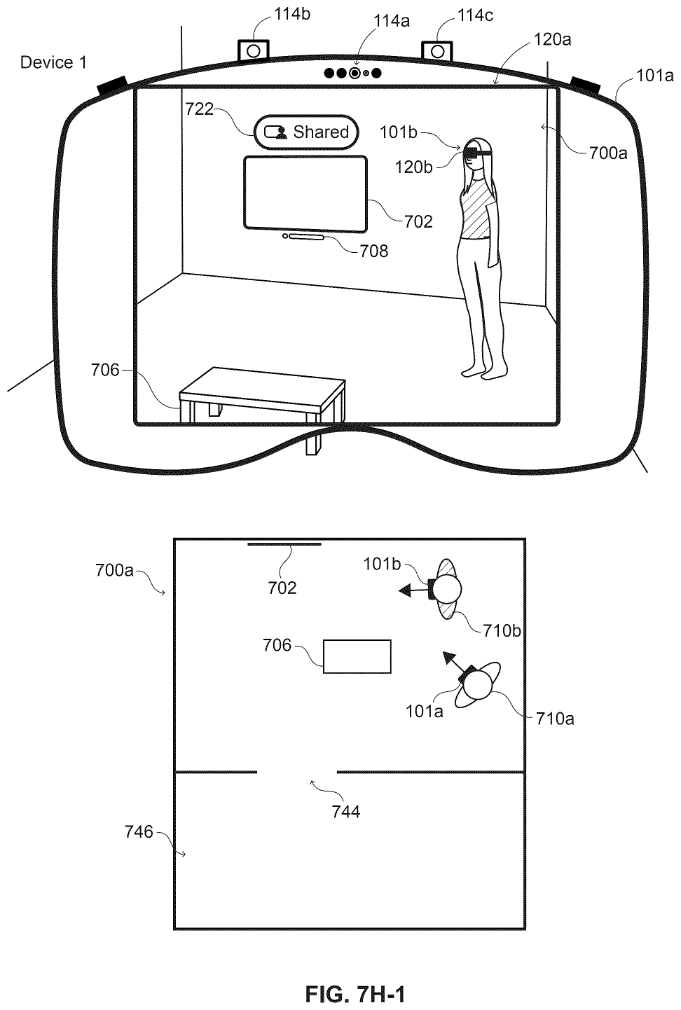

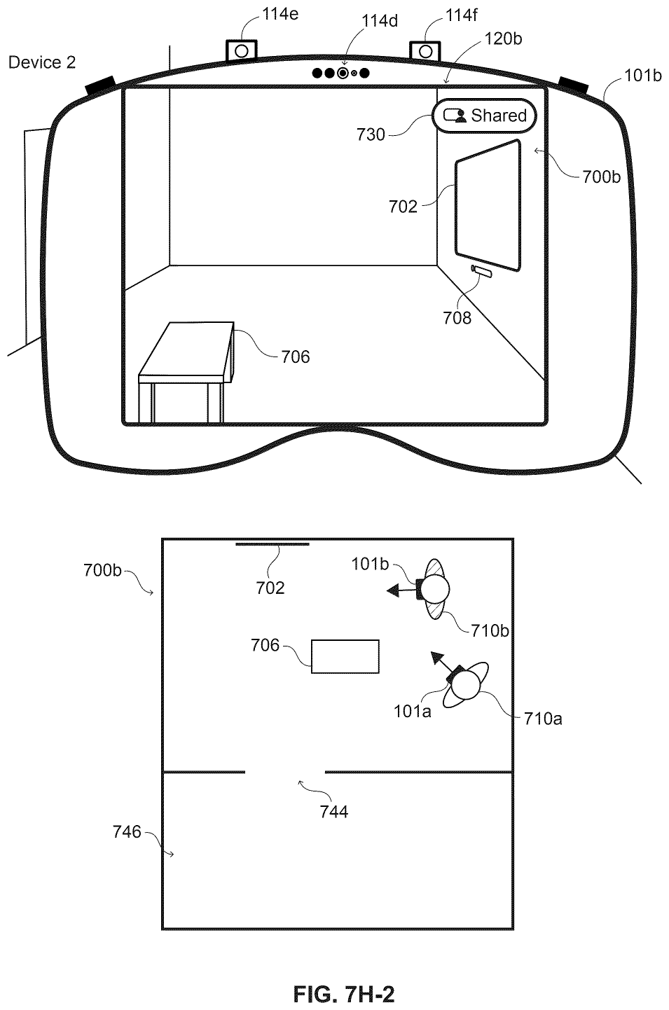

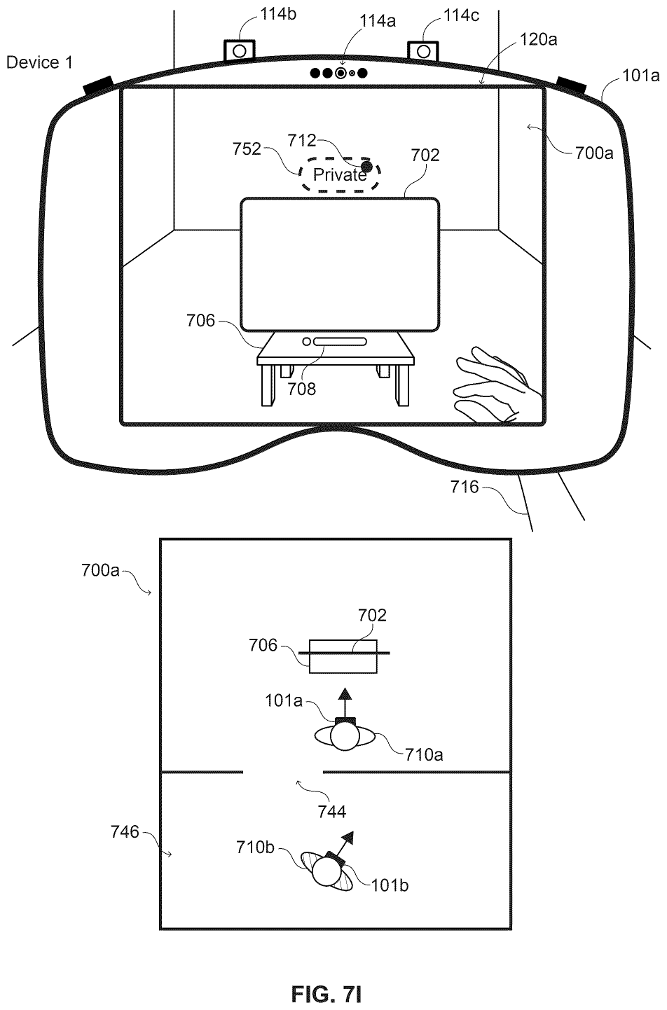

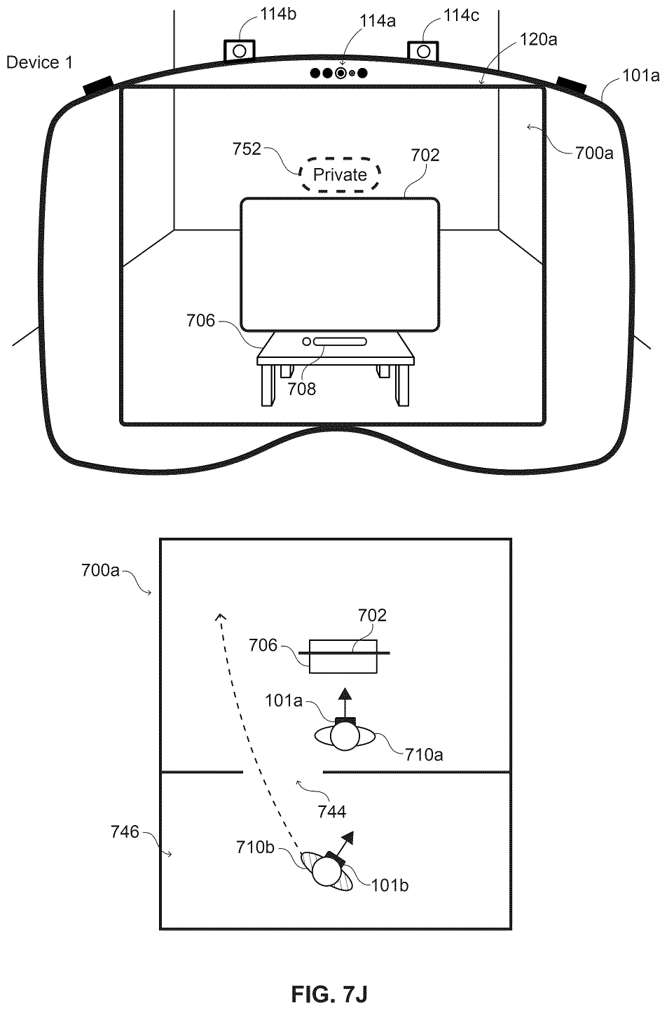

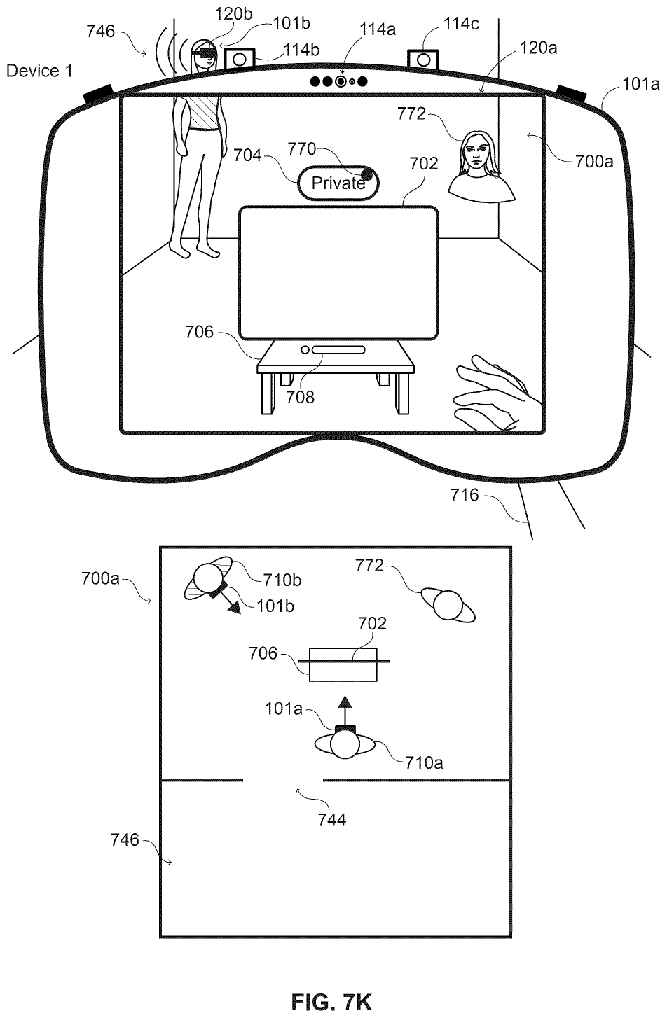

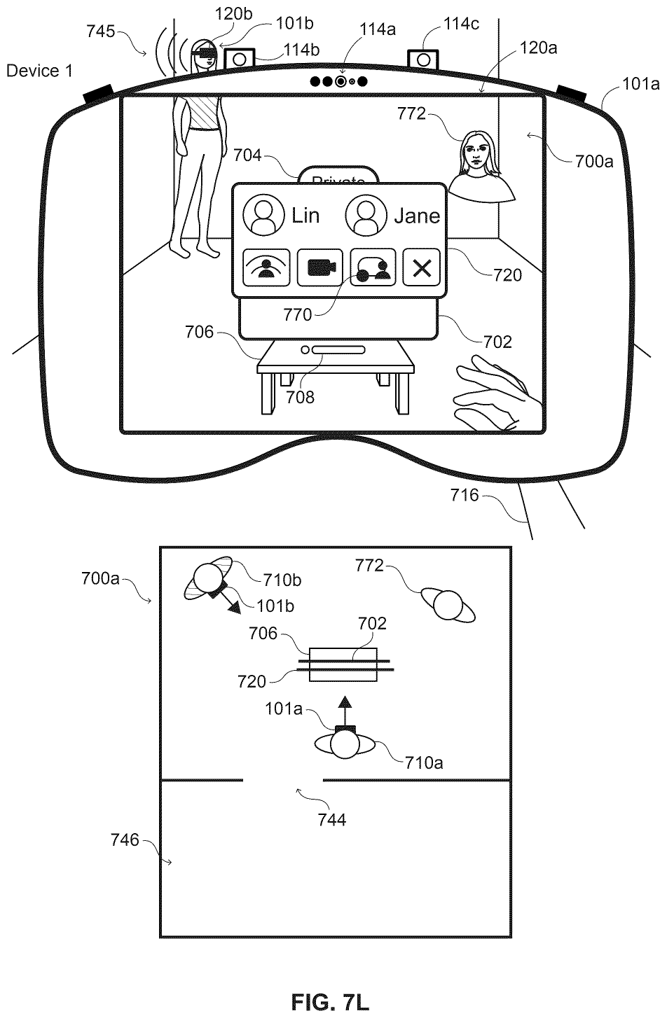

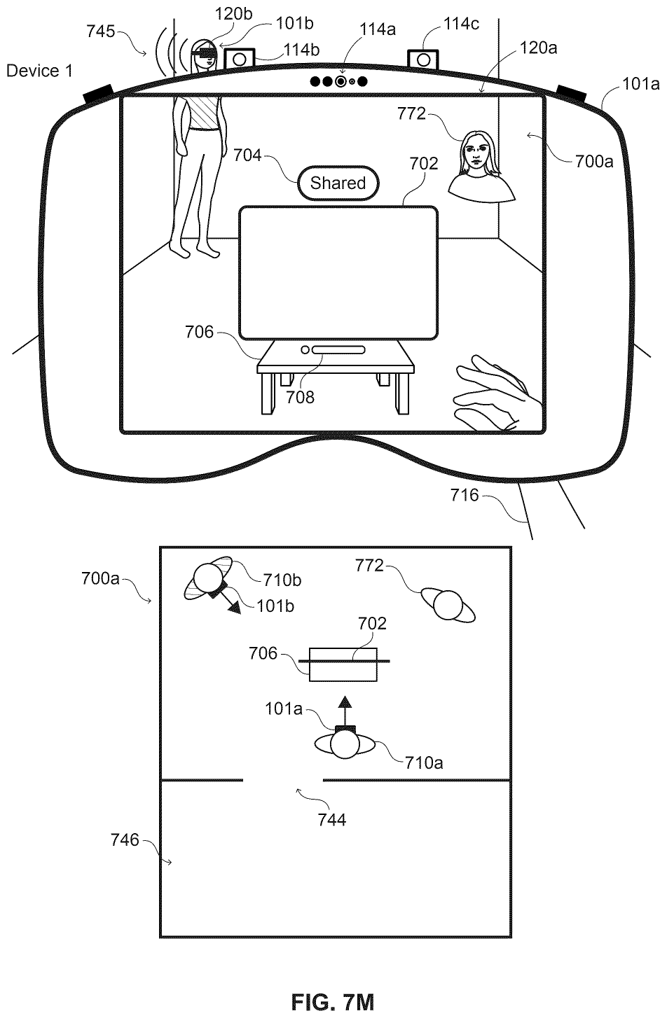

FIG. 7A-1 illustrates a first computer system 101a (e.g., an electronic device) displaying, via a display generation component 120a (e.g., display generation components 1-122a and 1-122b of FIG. 1), a three-dimensional environment 700a from a viewpoint of a first user (e.g., first user 710a in overhead view of the three-dimensional environment 700a) of the first computer system 101a (e.g., facing the back wall of the physical environment in which the first computer system 101a is located). It is understood that a three-dimensional environment of a computer system optionally includes a mapping of a physical and/or virtual space that is determined by the computer system and/or is obtained from another computer system (e.g., a server, a network, another similarly capable computer system, and/or some combination thereof). In some embodiments, mapping includes the locations of virtual content and/or the locations corresponding to physical objects within the three-dimensional environment. Thus, the three-dimensional environment of computer system 101a is optionally different from the three-dimensional environment of computer system 101b, as described further herein. In some embodiments, the three-dimensional environments of different computer systems are co-located (e.g., share a portion of a physical environment). For example, computer system 101a and computer system 101b in FIG. 7A-1 are co-located by virtue of their presence in a same physical room or area. It is understood that references herein to “collocate” and/or “collocated” optionally refer to entities that are co-located sharing a physical space, and that such references optionally differ from the conventional meaning of collocate (e.g., is optionally different from placing objects side by side with a particular spatial relation). Additionally, references herein to any neologisms such as “colocate” and/or “colocated” are understood to similarly refer to entities that are co-located and share a physical space.

FIG. 7A-2 illustrates a second computer system 101b (e.g., an electronic device) displaying, via a display generation component 120b (e.g., display generation components 1-122a and 1-122b of FIG. 1), a three-dimensional environment 700b from a viewpoint of a second user (e.g., second user 710b in overhead view of the three-dimensional environment 700b) of the second computer system 101b (e.g., facing the back wall of the physical environment in which the second computer system 101b is located).

In some embodiments, the first computer system 101a includes a display generation component 120a. In FIG. 7A-1, the display generation component 120a includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120a to enable eye tracking of the user's left and right eyes. Display generation component 120a also includes external image sensors 114b and 114c facing outwards from the user to detect and/or capture the physical environment and/or movements of the user's hands.

As shown in FIG. 7A-1, the first computer system 101a captures one or more images of the physical environment around the first computer system, including one or more objects and/or users in the physical environment around the first computer system 101a. In some embodiments, the first computer system 101a displays representations of the physical environment in three-dimensional environment 700a. For example, three-dimensional environment 700a includes representations of the rear and side walls of the room in which the first computer system 101a is located and a representation of table 706, corresponding to a physical table that is physically co-located with first computer system 101a in a same physical room. Additionally, in some embodiments, as shown in FIG. 7A-1, the three-dimensional environment 700a includes a representation of a second user 710b. Second user 710b is located in the same physical room as first computer system 101a in FIG. 7A-1, and in the overhead view of three-dimensional environment 700a.

In some embodiments, as shown in FIG. 7A-2, the second user 710b is associated with second computer system 101b (e.g., worn on a head of the second user 710b). In some embodiments, as described herein, the representations of the physical environment, including the representations of the second user 710b and the second computer system 101b, are visible in the field of view of the first user 710a using optical passthrough. Additionally, in some embodiments, as indicated in the overhead view of the three-dimensional environment 700b, the physical environment in which the first computer system 101a (e.g., and the first user 710a) and the second computer system 101b (e.g., and the second user 710b) are located includes two physical areas 744 and 746 (e.g., separate rooms or corridors).

In FIG. 7A-1, the first computer system 101a (e.g., and the first user 710a) and the second computer system 101b (e.g., and the second user 710b) are optionally both located in the first area 744 of the physical environment, as indicated in the overhead view of the three-dimensional environment 700a. In some embodiments, such as in FIG. 7A-1 and FIG. 7A-2, computer systems 101a and 101b are not yet engaged in a real-time communication session with one another, but are able to initiate and perform processes to share virtual content (e.g., without initiating the real-time communication session). A real-time communication session optionally includes a communication session configured to facilitate transmission and reception of data, including voice, video, pictures, and/or other data or information, as described with reference to method 1000. In some embodiments, the computer systems 101a and 101b are engaged in a first communication session to facilitate communication in order to determine that the computer systems share a portion of their physical environment. In some embodiments, the first communication session is different from (e.g., is not) a real-time communication session. Accordingly, some functions and/or operations available to the computer sessions when they are later engaged in a real-time communication session are optionally not performed and/or not available during the first communication session. In some embodiments, during the first communication session, computer system 101a and computer system 101b communicate information to share virtual content, as described further herein.

In some embodiments, the second computer system 101b includes a display generation component 120b. In FIG. 7A-2, the display generation component 120b includes one or more internal image sensors 114d oriented towards the face of the user (e.g., eye tracking cameras 540 described with reference to FIG. 5). In some embodiments, internal image sensors 114d are used for eye tracking (e.g., detecting a gaze of the user). Internal image sensors 114d are optionally arranged on the left and right portions of display generation component 120b to enable eye tracking of the user's left and right eyes. Display generation component 120b also optionally includes external image sensors 114e and 114f facing outwards from the user to detect and/or capture the physical environment and/or movements of the user's hands.

In FIG. 7A-2, computer system 101b presents a view of the physical room shared with the user 710a. For example, computer system 101b presents a view of a representation of table 706, and of user 710a within a second three-dimensional environment 700b of the computer system 101b. Additionally, three-dimensional environment 700b includes a representation of a physical door 741, which physically separates the areas 744 and 746 included in the three-dimensional environment 700b.

Turning back to FIG. 7A-1, computer system 101a displays virtual content 702 within three-dimensional environment 700a. In some embodiments, content 702 includes virtual content, which optionally includes one or more virtual objects, text, media, one or more user interfaces, selectable options, and/or some combination thereof. One example includes a user interface of a media playback software application, including media that is presented to (e.g., visible and/or audible to) user 710a. In some embodiments, content 702 is shareable content. For example, computer system 101a optionally initiates one or more operations to cause display of content 702—or virtual content that is similar to content 702—at a respective location in the second three-dimensional environment 700b of the second computer system 101b. In FIG. 7A-1, indicator 704 indicates that the content 702 is currently “Private,” and is not currently “shared” with computer system 101b. Therefore, as shown in FIG. 7A-2, computer system 101b is not presenting the content 702, as illustrated by the absence of content 702 in the overhead view and via the display generation component 120b. In FIG. 7A-1, computer system 101a additionally or alternatively displays another indicator 726 within three-dimensional environment 700a.

In some embodiments, the virtual content 702 is optionally a user interface of an application containing content. For example, in FIG. 7A-1, the virtual content 702 optionally includes a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. Additionally, in some embodiments, as shown in FIG. 7A-1, the virtual content 702 is displayed with an exit option and a grabber 708. In some embodiments, the grabber 708 is selectable to initiate a process to move the virtual content 702 within the three-dimensional environment 700a.

In some embodiments, the position and/or orientation of status indicators are dependent upon a location corresponding to virtual content and/or corresponding to another user. For example, in FIG. 7A-1, computer system 101a displays indicator 704 above content 702, and relatively centered (e.g., in a perceived lateral direction) with the content 702. Thus, indicator 704 is optionally visible at a location corresponding to the location and/or orientation of content 702. Similarly, indicator 726 is displayed at a location corresponding to a representation of user 710b. For example, indicator 726 is displayed relatively closer to the viewpoint of user 710b in a depth direction in FIG. 7A-1, as compared to the location of the representation of user 710b. In some embodiments, indicator 726 is displayed above a representation of a head of user 710b, overlapping and/or centered with a portion of a representation of a torso of user 710b, and/or otherwise adjacent or near the representation of user 710b in first three-dimensional environment 700a.

In some embodiments, one or more status indicators corresponding to content are displayed in accordance with a determination one or more criteria are satisfied. For example, in FIG. 7A-1, computer system 101a determines and/or obtains an indication that the computer system 101b and the user 710b share at least a portion of a physical environment. Thus, because three-dimensional environment 700a and three-dimensional environment 700b share a physical area including area 744 in FIG. 7A-1 and in FIG. 7A-2, the corresponding computer systems 101a and 101b determine and/or obtain indications that the computer systems 101a and/or 101b satisfy one or more criteria. Accordingly, computer system 101a displays the indicator 704 and the indicator 726 in FIG. 7A-1. Additionally or alternative, the one or more criteria are satisfied when physical features and/or physical phenomena are shared between computer system 101a and computer system 101b. For example, in FIG. 7A-1, computer system 101a detects audio 745 spoken by user 710b, and the speech is also detected by computer system 101b. The shared detection of audio optionally indicates that the users 710a and 710b are physically within earshot (or are within a detection range of microphones of the computer systems). It is understood that audio 745 is merely representative of audio present in the physical environments of computer system 101a and computer system 101b, which optionally is emitted by a user or by another entity (e.g., a physical object, a device, and/or some combination thereof).

In some embodiments, in accordance with a determination the one or more criteria are not satisfied, computer system(s) forgo display of the status indicator, or display the status indicator to indicate that another user of another computer system is not physically co-located. For example, in FIG. 7I, computer system 101a determines and/or obtains an indication from another computer system such as a server that user 710b and/or computer system 101b are not within the physical environment. For example, user 710b is in an area 746, while user 710a is in area 744, separated by one or more physical features and/or objects such as door(s) and/or wall(s) in FIG. 7I. Accordingly, in FIG. 7I, indicator 752 is optionally not displayed as indicated by the dashed outline circumscribing indicator 752. Alternatively, computer system 101a optionally changes a visual appearance of indicator 752, as described with reference to method 800, to convey the lack of co-location with another computer system. For example, computer system 101a displays indicator 752 in FIG. 7I with text, color, saturation, a simulated lightning effect, including (or without) one or more selectable option(s), with one or more graphics, and/or some combination thereof that are different from analogous content included indicator 704 in FIG. 7A-1. As an example, the indicator 752 optionally is displayed with a different color, and/or optionally is not displayed with an arrow or graphic indicating that selection of indicator 752 optionally results in a launching of a sharing user interface (described further herein).

In some embodiments, a first computer system detects one or more inputs initiating a process to display virtual content at a respective location within a second three-dimensional environment of a second computer system. For example, in FIG. 7A-1, computer system 101a detects attention 712 of the user (e.g., corresponding to a recent or current target of the user's gaze) directed to indicator 704. Alternatively, computer system 101a detects attention 728 directed to indicator 726. In some embodiments, in response to detecting one or more inputs, the first computer system initiates the processes described above. For example, computer system 101a in FIG. 7A-1 detects an air pinch gesture performed by hand 716, including a discrete and/or continuous contacting of one or more fingers of the fingers of hand 716. As described with reference to method 800, the computer system 101a optionally initiates the process to share the content 702 in response to the detection of the one or more inputs.

In FIG. 7B-1, computer system 101a performs one or more operations including display of a sharing user interface associated with virtual content. For example, from FIG. 7A-1 to FIG. 7B-1, computer system 101a detects the air pinch gesture, and in response to the detecting displays user interface 714. User interface 714 optionally is displayed closer in a depth dimension to the viewpoint of user 710a compared to content 702, and optionally includes one or more selectable options in FIG. 7B-1. In some embodiments, the user interface 714 includes one or more indicators of one or more co-located users. For example, user interface 714 includes an image depicting the likeness of a user associated with the computer system 101b, such as an owner of an account logged into computer system 101b (e.g., “Lin”) in FIG. 7B-1. In some embodiments, in addition to one or more indicators of co-located users, the user interface 714 includes one or more indicators of one or more users that are engaged in a real-time communication session with the computer system 101a, as described further herein and with reference to methods 800 and/or 1000.

In some embodiments, user interface 714 includes one or more selectable options. For example, selectable option 720 is displayed, and is selectable to continue the process to display the virtual content 702 at a respective location within three-dimensional environment 700b (a second three-dimensional environment) in FIG. 7B-1. In some embodiments, the user interface 714 has one or more characteristics similar to or the same as user interface(s) configured to initiate a real-time communication session as described with reference to method 1000. In FIG. 7B-1, computer system 101a detects a selection input including an air gesture, different from the air gesture illustrated in FIG. 7A-1. In response to detecting the air gesture in FIG. 7B-1, the computer system 101a optionally prompts computer system 101b to approve sharing and/or display of virtual content 702.

In FIG. 7B-2, computer system 101b updates the viewpoint of user 710b relative to three-dimensional environment 700b. For example, from FIG. 7A-2 to FIG. 7B-2, computer system 101b optionally detects movement of the user's body relative to the three-dimensional environment. In FIG. 7B-2, a representation of user 710a is physically obscured by a housing of computer system 101b, but it is understood that the representation of user 710a optionally is displayed when the field of view (associated with a viewport) of computer system 101b is different than as illustrated, or the representation of user 710a corresponds to a different location within three-dimensional environment 700b. Due to modified viewpoint of user 710b, computer system 101b updates the perspective of table 706 in FIG. 7B-2. In FIG. 7B-2, the virtual content displayed by computer system 101a is absent from three-dimensional environment 700b because the request to approve sharing of virtual content is not yet obtained and/or represented by computer system 101b.

In FIG. 7C-1, computer system 101a updates display of indicator 704—including the word “pending” and forgoing display of the word “private”- to indicate that a request to share the virtual content 702 was communicated to computer system 101b. In FIG. 7C-2, computer system 101b displays a prompt user interface 734, including selectable option 736—selectable to approve the display of the shared content—and including selectable option 738—selectable to reject the display of the shared content. In some embodiments, in response to detecting selection of the selectable option 738, computer system 101b forgoes display of the shared content and/or of the prompt user interface 734. In some embodiments, in response to detecting selection of the selectable option 736, as indicated by the attention 740 and air pinch performed by hand 742 in FIG. 7C-2, computer system 101b initiates display of the virtual content shared by computer system 101a.

In FIG. 7D-1, computer system 101a ceases display of the sharing user interface described previously, and maintains the display of virtual content 702 in response to obtaining an indication that computer system 101b approved the sharing request. Accordingly, computer system 101a in FIG. 7D-1 initiates display of the indicator 722 (e.g., “Shared”), indicating that the virtual content 702 is displayed within three-dimensional environment 700b of the second computer system 101b. Similarly, in FIG. 7D-2, computer system 101b initiates display of the content 702 within three-dimensional environment 700b in response to the input approving the sharing request detected in FIG. 7C-2. Additionally, computer system 101b in FIG. 7D-2 initiates display of the indicator 722, conveying that the virtual content 702 is shared. In some embodiments, the indicator 722 displayed by computer system 101b indicates the source of the shared content, such as a name associated with computer system 101a.

In some embodiments, the locations at which virtual content 702 is displayed within the first three-dimensional environment 700a and at which virtual content is displayed within the second three-dimensional environment 700b correspond to one another. For example, the computer system 101a and/or 101b optionally determine a mapping between coordinates included in the respective three-dimensional environment of the respective computer systems. Using the mapping, the respective computer systems 101a and/or 101b optionally determine a same location and/or series of locations that correspond to the virtual content 702. For example, in FIG. 7D-2, the location of the content 702 relative to three-dimensional environment 700b is similar to or the same as the location of the content 702 relative to three-dimensional environment 700a, including the physical portions of the respective three-dimensional environments. Described in a qualitative way, the virtual content 702 is displayed with a position and orientation that is above the table 706 relative to the floors of three-dimensional environments 700a and 700b. In some embodiments, the computer systems map the dimensions of the physical environments, such as distance between physical features (e.g., walls, doors, slopes, objects, and/or some combination thereof), and cross-reference a coordinate grid of the physical environments to determine a shared set of locations that correspond to the virtual content 702. Additional description of such cross-referencing and/or mapping is presented when describing method 800.

In some embodiments, a computer system detects one or more inputs requesting movement of the virtual content relative to a corresponding three-dimensional environment. For example, in FIG. 7D-1, computer system 101a detects attention 750 directed to grabber 708 while an air pinch gesture is performed (and/or maintained) by hand 716. It is understood that when computer system 101b detects a similar input, the computer system 101b optionally performs one or more operations similar to or the same as described with reference to computer system 101a. For example, from FIG. 7D-1 to FIG. 7E-1, computer system 101a detects movement of the hand 716 relative to three-dimensional environment 700a (e.g., included in one or more “movement” inputs), and moves the virtual content 702 to an updated position and/or orientation in accordance with the hand movement. For example, computer system 101a optionally detects movement in one or more directions, and magnitudes of movement along the one or more directions. In response to detecting the movement, computer system 101a optionally moves the virtual content 702 in one or more directions similar to, or the same as the direction(s) of movement of hand 716. Additionally or alternatively, the virtual content 702 is optionally moved by one or more magnitudes relative to three-dimensional environment 700b similar to, the same as, inversely proportional, or otherwise based upon the one or more magnitudes of movement of hand 716 to the location depicted in FIG. 7E-1.

In some embodiments, the computer system 101b displays the movement of the virtual content in accordance with indications of the inputs detected by computer system 101a (and/or in accordance with indications of the direction(s) and/or magnitude(s) of virtual content movement). For example, the location of virtual content in FIG. 7E-2 is different from FIG. 7D-2, and is similar to or the same as the location of virtual content in FIG. 7E-1. Thus, when facilitating movement of the virtual content relative to three-dimensional environment 700a, the virtual content 702 is optionally moved by a similar or same amount relative to three-dimensional environments 700a and 700b, simulating the effect of a physical object moving within a shared physical environment of computer systems 101a and 101b.

In some embodiments, in response to detecting ceasing of an air gesture or pose, a computer system ceases a movement of virtual content. For example, in FIG. 7E-1, computer system 101a detects a separation of the fingers included in hand 716 that made contact during performance of an air pinch. Accordingly, in response to detecting movement of hand 716 while the contact of fingers is ceased, computer system 101a optionally forgoes movement of virtual content 702, irrespective of the target of the attention of user 710a.

FIGS. 7F-1-7H-2 illustrate additional or alternative movement of shared virtual content relative to three-dimensional environments of respective computer systems. It is understood that the inputs, operations, and/or communication between the computer system 101a and computer system 101b are optionally similar to, the same as, or otherwise based upon the operation(s) described with reference to FIGS. 7A-1-7E-2.

In FIG. 7F-1, computer system 101a detects an air pinch gesture performed by hand 716 while attention 750 is directed to grabber 708. In response to detecting the concurrent air pinch and attention 750, computer system 101a optionally initiates movement of the shared content 702. In FIG. 7G-1, in response to detecting movement of hand 716 while hand 716 maintains the air pinch gesture detected in FIG. 7F-1, the computer system 101a moves the virtual content 702 in accordance with the movement of the hand 716. In some embodiments, the virtual content is “pinned” and/or “snaps” to representation of physical features in the three-dimensional environment of a computer system when one or more criteria are satisfied.

In some embodiments, the “pinned” and/or “snapped” location of the content 702 differs from an expressly requested location designated by one or more inputs moving the content 702. For example, from FIG. 7F-1 to FIG. 7G-1, computer system 101a detects one or more inputs including movement of hand 716 that would typically result in moving the content 702 a first distance away from a back-wall of the three-dimensional environment 700a. In FIG. 7G-1, however, computer system 101a optionally moves the virtual content to coincide with (e.g., be flush with, overlaying, and/or within a threshold distance (e.g., 0, 0.001, 0.005, 0.01, 0.025, 0.05, 0.075, 0.1, or 0.25 m)) the back wall. Consequentially, in response to the movement of hand 716 in FIG. 7F-1, computer system 101a moves the content 702 a second distance—different from the first distance—away from the back wall. Thus, when the one or more inputs satisfy one or more criteria and/or when the location of content 702 satisfies one or more criteria, such as a criterion satisfied when a portion of content 702 (e.g., a corner, a center, a border, and/or some combination thereof) is within the threshold distance of a physical object and/or feature.

In some embodiments, the orientation of the virtual content is different from an expressly requested orientation corresponding to one or more movement inputs. For example, a viewing surface of the content 702 optionally rotates during movement of content 702, such that a vector extending from a viewing surface intersects with the user's viewpoint. As referred to herein, a viewing surface optionally includes a surface of a virtual object and/or virtual content that the user is likely to view and/or interact with, such as the surface visible to user 710b in FIG. 7G-1. Accordingly, during movement of the content 702, the vector extending from the rectangular surface of content 702 facing the viewpoint of user 710a extends through the user's viewpoint in three-dimensional environment 700a. In some embodiments, in response to termination of one or more movement inputs, computer system 101a displays content 702 with an orientation that is the same as the orientation of content 702 prior to the termination of the one or more inputs. In some embodiments, when the one or more criteria are satisfied, computer system 101a determines and/or is made aware that content 702 corresponds to a physical feature and/or surface. Consequentially, computer system 101a optionally changes the orientation of content 702 to differ from its orientation immediately prior to the termination of the one or more inputs. For example, in FIGS. 7G-1 and 7G-2, computer systems 101a and 101b display content 702 parallel to the surface of the back wall in the physical environment. If the back wall were beyond the threshold distance (e.g., not shown) when the one or more movement inputs were terminated, but content 702 was moved to the same position as illustrated in FIG. 7G-1 and FIG. 7G-2, computer systems 101a and/or 101b would display content 702 such that the viewing surface were optionally not parallel to the surface of the back wall.

As shown in FIG. 7G-1 and FIG. 7G-2, indicator 722 and indicator 730 optionally are displayed with orientations that differ from the orientation of content 702. For example, the status indicators in FIG. 7G-1 and FIG. 7G-2 optionally rotate such that a vector extending from a viewing surface including text (e.g., “Shared”) intersects with the viewpoint of the user (and/or are parallel to a vector extending tangent to a plane of the user's head), even when the vector extending from the viewing surface of content 702 does not intersect with the viewpoint of the user, as shown in FIG. 7G-2.

In some embodiments, the position and/or orientation of shared virtual content is independent of movement of users within their respective three-dimensional environment. For example, from FIG. 7G-1 to FIG. 7H-1, computer system 101a detect movement of the viewpoint of user 710a relative to three-dimensional environment 700a. In response to detecting the movement, the computer system 101a forgoes movement (e.g., changing of orientation and/or position) of content 702, as additionally reflected from the perspective of user 710b in FIG. 7H-2.

In some embodiments, when one or more criteria are not satisfied, computer system(s) forgo display of a selectable option that is selectable to initiate a process to display virtual content at a respective location in a three-dimensional environment of another computer system. For example, FIGS. 7I-7M illustrate computer system 101a displaying, not displaying, and/or modifying display of a selectable option corresponding to indicator 752 and/or indicator 704 in accordance with a determination that user 710b is not or is indeed co-located with user 710a. Additionally, FIGS. 7K-7M illustrate computer system 101a engaged with a third computer system (e.g., different from computer system 101b), and contemplate embodiments in which a content sharing user interface differs from the content sharing user interface(s) described with reference to FIG. 7C-1.

In FIG. 7I, as described additionally herein, computer system 101a concurrently displays content 702 and indicator 752. As described additionally herein, it is understood that the dashed-line pattern is optionally not displayed, and that the dashed-line pattern optionally indicates that indicator 752 is not displayed in accordance with a determination that user 710b is not in a same physical room and/or region (e.g., is in area 746) as user 710a. Alternatively, indicator 752 is optionally displayed with a visual appearance that differs from a visual appearance of indicator 704 described with reference to other figures herein. In FIG. 7I, computer system 101a detects an air gesture such as an air pinch while attention 712 is directed to indicator 752 (or a region of three-dimensional environment 700a where indicator 752 would be, were user 710b situated within area 744).

In FIG. 7J, because the one or more criteria are not satisfied, computer system 101a forgoes initiating the process(es) to display content 702 in three-dimensional environment 700b of user 710b in response to the input detected in FIG. 7I. Described an additional way, computer system 101a optionally forgoes initiating sharing and/or display of a sharing user interface in response to the air gesture illustrated in FIG. 7I, because user 710b is not co-located when the air gesture is detected. As illustrated in the overhead view of FIG. 7J, user 710b moves from area 746 to area 744; thus, after the movement in FIG. 7J, the one or more criteria are satisfied.

FIG. 7K illustrates an embodiment in which computer system 101a is engaged in a real-time communication session with a computer system corresponding to a representation 772 of a user of the computer system, and is not engaged in a real-time communication session with computer system 101b. Aspects of FIG. 7K are similar to aspects of FIG. 7A, and it is understood that where appropriate, description of FIG. 7A applies to FIG. 7K. In FIG. 7K, computer system 101a detects an air pinch gesture performed by hand 716 while attention 770 is directed to indicator 704. In some embodiments, in response to detecting the input in FIG. 7K, computer system 101a displays user interface 724, such as in FIG. 7L. In FIG. 7L, user interface 724 is a sharing user interface including selectable options (e.g., similar to user interface 714 in FIG. 7C-1). It is understood that description of the user interface 714 applies to user interface 724, where appropriate. In FIG. 7L, however, user interface 724 includes an indication of the user corresponding to representation 772 (e.g., “Jane”) including an image, graphic, and/or media, and the name of the user and/or of a name assigned to an account associated with representation 772.

In FIG. 7L, computer system 101a detects an input including hand 716 performing an air pinch while attention 770 is directed to a sharing selectable option. In FIG. 7M, in response to the input in FIG. 7L, computer system 101a continues the process to display content 702 in the three-dimensional environment of computer system 101b, and the process to display content 702 within the three-dimensional environment of the computer system that a user corresponding to representation 772. It is understood that similar to as described with reference to the prior figures, that virtual content 702 is optionally not displayed within the three-dimensional environment of the user corresponding to representation 772 until user 710b. For example, the virtual content is optionally not displayed until the user corresponding to representation 772 accepts a request to share the virtual content 702. It is further understood that the relative position and/or location of the virtual content 702 displayed in the three-dimensional environment of the user corresponding to representation 772 is optionally based upon a virtual mapping between three-dimensional environment 700a and/or the three-dimensional environment of the user corresponding to representation 772. For example, from the perspective of the user corresponding to representation 772, virtual content 702 is displayed at a respective location within their three-dimensional environment such that the viewing surface is not visible (due to its orientation toward the user 710a) in response to approving the sharing of the virtual content. Thus, the computer system corresponding to representation 772 optionally generates and/or determines a three-dimensional environment that includes a location assigned to user 710a, and a location assigned to the virtual content 702, optionally simulating an effect of a shared physical environment including the virtual content 702.

FIG. 8 is a flowchart illustrating an exemplary method 800 sharing of virtual content with one or more users in a three-dimensional environment in accordance with some embodiments. In some embodiments, the method 800 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, a method 800 is performed at a first computer system, such as computer system 101a as shown in FIG. 7A-1, in communication with one or more input devices, such as input devices 314a-c as shown in FIG. 7A-1, and a display generation component, such as display generation component 120a as shown in FIG. 7A-1. In some embodiments, the first computer system is or includes an electronic device, such as a mobile device (e.g., a tablet, a smartphone, a media player, or a wearable device), or a computer. In some embodiments, the display generation component is a display integrated with the first computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller. In some embodiments, the first computer system has one or more characteristics similar to or the same as described with reference to method 1000.

In some embodiments, while displaying, via the display generation component, virtual content at a first location in a first three-dimensional environment of the first computer system (802), such as virtual content 702 as shown in FIG. 7A-1, in accordance with a determination that one or more criteria are satisfied, including a criterion that is satisfied when a location corresponding to a second computer system, different from the first computer system, such as computer system 101b as shown in FIG. 7A-2, is in proximity to the first computer system in a (e.g., first) physical environment of the first computer system, such as the physical environment included in three-dimensional environment 700a as shown in FIG. 7A-1, the computer system displays (802), via the display generation component, a first selectable option that is selectable to initiate a process to display the virtual content in a second three-dimensional environment of the second computer system at a respective location in the second three-dimensional environment corresponding to the first location in the first three-dimensional environment, such as indicator 704 as shown in FIG. 7A-1, which is selectable to cause display of virtual content at a location within three-dimensional environment 700b, as shown in FIG. 7D-2. In some embodiments, the virtual content includes one or more virtual objects. In some embodiments, the virtual objects include and/or correspond to one or more user interfaces of software applications included in and/or in communication with the computer system, such as media playback, text editing, web browsing, and/or operating system control panel user interface(s). For example, the first virtual content is optionally a first virtual window including a user interface of a media browsing application to stream and/or view media content, and/or optionally includes a second virtual window including a user interface of a web browsing application. In some embodiments, the first virtual content is a two-dimensional, or nearly two-dimensional object (e.g., a flat, or nearly flat virtual window), and in some embodiments, the first virtual content is a three-dimensional object (e.g., a virtual model of a car, a nearly flat object including some degree of curvature, and/or a virtual geometric shape such as a virtual rectangular prism). In some embodiments, the content is virtual content that includes visual and/or audio content associated with an application, such as media content (e.g., still images or audio and/or video content that changes over time during playback), a slide deck, a spreadsheet, a text message conversation, social media content, a game, or a map. In some embodiments, the virtual content is displayed at a first location and/or orientation relative to a three-dimensional environment of the first computer system (e.g., a location of a user of the first computer system). In some embodiments, the first location and/or orientation has a spatial arrangement relative to a viewpoint of a user of the first computer system. For example, the viewpoint of the user optionally includes a position and/or orientation of the user relative to the three-dimensional environment (e.g., what is visible via a viewport of the first computer system), and the first virtual content is displayed having a first spatial arrangement with the viewpoint of the user of the first computer system.

In some embodiments, the first three-dimensional environment is generated, displayed, or otherwise caused to be viewable by the first computer system. For example, the first three-dimensional environment is an extended reality (XR) environment, such as a virtual reality (VR) environment, a mixed reality (MR) environment, or an augmented reality (AR) environment. In some embodiments, the first three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In some embodiments, the first three-dimensional environment includes one or more virtual objects and/or representations of objects in a physical environment of a user of the computer system. In some embodiments, the first three-dimensional environment includes one or more characteristics of three-dimensional and/or virtual environments described with reference to method 1000. It is understood that description of the first three-dimensional environment optionally applies to other three-dimensional environments described herein, and that description of other three-dimensional environments (e.g., a second three-dimensional environment described with reference to the present method and/or method 1000) optionally applies to the first three-dimensional environment.

In some embodiments, the first selectable option is displayed by the computer system when the location corresponding to the second computer system (e.g., the location of the user of the second computer system and/or the location of the second computer system itself), such as the location of computer system 101b as shown in FIG. 7A-1, is in proximity in the physical environment of the first computer system, such as in a same physical room, building, along a same physical roadway, and the like, as shown in FIG. 7A-1. In some embodiments, the first computer system displays a virtual object that includes the first selectable option, such as a virtual button that is selectable to initiate one or more operations (e.g., included in the process to display the virtual content in the second three-dimensional environment). For example, the first computer system optionally displays a virtual button, a virtual icon corresponding to a software application, an image corresponding to a user and/or an account associated with the second computer system, and/or a representation of the second computer system. In some embodiments, in accordance with a determination that the one or more criteria are not satisfied, the first computer system optionally forgoes display of the first selectable option. For example, the first one or more criteria optionally correspond to proximity and/or signal communication related criteria, and optionally include a criterion that is satisfied when the first computer system is within a threshold distance from the second computer system (e.g., 0.05, 0.1, 0.25, 0.5, 1, 1.5, 3, 5, 10, or 15 m), a criterion that is satisfied when one or more signals communicated to, from, and/or between the first and second computer systems indicate a sufficient signal strength, a criterion that is satisfied that the first and second computer systems share a physical room, a criterion that is satisfied when the first and the second computer systems share one or more hardware and/or software characteristics (e.g., pertaining to the ability of the computer system to display data format(s), such as spatial data simulating immersion of the users into virtual three-dimensional environments), and/or a criterion that is satisfied when the second computer system and/or a user of the second computer system is within a viewport of the first computer system. When the first and second computer systems share a physical environment and/or are relatively proximate to each other, the first computer system optionally initiates display of the first selectable option. When the first and second computer systems do not share a physical environment and/or are not relatively proximate to each other, the first computer system optionally forgoes display of the first selectable option.

In some embodiments, the selectable option, such as indicator 704 as shown in FIG. 7A-1, is displayed at a respective location within the first three-dimensional environment that corresponds to a location of the second computer system, as shown in FIG. 7A-1. For example, the first selectable option is optionally displayed above, below, and/or otherwise nearby a representation of the user of the second computer system. In some embodiments, the displayed position of the first selectable option corresponds to a position, posture, and/or orientation of the user of the second computer system, and/or a current viewpoint of the user of the computer system. For example, the first computer system optionally displays the first selectable option below a representation of the other user's head, and/or optionally overlaying the other user's torso. In response to detecting a change in the user's position relative to the physical environment, the first computer system optionally moves the first selectable option in a direction and/or by a distance in accordance with movement of the user of the second computer system (e.g., in a same and/or similar distance and/or direction). Additionally or alternatively, in response to detecting attention (e.g., gaze) of the user targeting the first selectable option and/or a representation of the user of the second computer system, the first computer system optionally displays a virtual effect such as a simulated glow, a virtual scaling of the first selectable option, and/or an increasing of opacity of the first selectable option. In some embodiments, the first selectable option is displayed at a position corresponding to the virtual content (e.g., as opposed to being positioned relative to the other user). For example, the first selectable option is optionally displayed above, below, or adjacent to the virtual content relative to the three-dimensional environment and/or relative to a user's current viewpoint. As an example, the first selectable option is optionally displayed above the virtual content relative to a floor of the three-dimensional environment, with a center corresponding to and/or aligned with a center of the virtual content.

In some embodiments, the second computer system has one or more characteristics similar to or the same as one or more characteristics of the first computer system. In some embodiments, the second three-dimensional environment has one or more characteristics similar to or the same as the first three-dimensional environment. For example, the first and the second three-dimensional environments optionally share a physical environment, and optionally respectively include virtual object(s) that is not shared with the other computer system. In some embodiments, however, the first and second three-dimensional environment share the virtual content (e.g., in response to detecting an input optionally including selection of a selectable option to initiate the sharing, described further below with reference to the second selectable option). Sharing the virtual content optionally includes displaying the virtual content within a respective position and/or orientation within a respective three-dimensional environment, which optionally perceptually occupies and/or is associated with a same physical location within the respective three-dimensional environment. It is understood that the second computer system optionally displays a similar selectable option via the display generation component it is in communication with, corresponding to a location of the user of the first computer system, and in accordance with the determination that the one or more criteria are satisfied relative to the three-dimensional environment of the second computer system. In some embodiments, the virtual content is not displayed by the second computer system prior to initiation of the process to display the virtual content in the second three-dimensional environment (e.g., independently of a viewpoint of a user of the second computer system relative to the second three-dimensional environment). For example, the second computer system optionally forgoes display of the virtual content when a location that corresponds to the virtual content (e.g., the location at which the virtual content is displayed by the first computer system) is within the viewport of the second computer system. It is understood that additional or alternative selectable options are optionally displayed in accordance with the determination that the one or more criteria are satisfied relative to additional or alternative computer systems (e.g., a third, fourth, and/or fifth computer system), and that the respective, alternative computer system optionally are capable of performing the operations described with reference to the first computer system. Displaying a selectable option selectable to initiate sharing of content, and that corresponds to the second computer system when the second computer system is proximate to the first computer system provides a content sharing process and/or user interface that is suited to displayed shared virtual content in a same physical environment, reducing processing required to display the selectable option when the first and second computer systems do not share a same physical environment.

In some embodiments, while displaying the first selectable option, the computer system detects, via the one or more input devices, a first user input including a selection of the first selectable option, such as input provided by hand 716 as shown in FIG. 7A-1. For example, the first computer system optionally detects an input from the first user requesting to share the content, such as by detecting a selection of an affordance associated with the content and/or with an application associated with the content. In some embodiments, detecting the selection of the affordance includes detecting an input from a hand of the user, such as a touch input on a touch screen, an input on a mouse or trackpad, and/or an air gesture (e.g., an air pinch or hand raise detected by a camera and/or hand-tracking sensors). In some embodiments, detecting the selection of the affordance includes detecting a gaze of the user directed towards the affordance (e.g., via eye-tracking sensors or other sensors). In some embodiments, the selection input includes a voice request, and/or another audible noise made by a user of the first computer system. It is understood that the embodiments herein describe initiating sharing of virtual content and/or displaying virtual objects and/or selectable options to share the virtual content performed by the first computer system, but that in some embodiments the second computer system or another computer system optionally performs similar or the same operations. In such embodiments, the first computer system optionally performs one or more operations to approve and display the shared virtual content, similar to or the same as described with reference to the second computer system herein.

In some embodiments, in response to detecting the first user input, the computer system displays, via the display generation component, a second selectable option, different from the first selectable option, such as selectable option 720 as shown in FIG. 7B-1, wherein the second selectable option corresponds to a user account associated with the second computer system, such as a user account associated with computer system 101b as shown in FIG. 7B-2. For example, as described further herein, the second selectable option optionally includes a representation of the user account including text describing an address such as an e-mail related to the account, an image representing a user owning the account, a name of the user, and/or some combination thereof. In some embodiments, the second selectable option is displayed adjacent to and/or otherwise near the virtual content.

In some embodiments, while displaying the second selectable option, the computer system detects, via the one or more input devices, a second user input including a selection of the second selectable option, such as input provided by hand 716 directed to selectable option 720 as shown in FIG. 7B-1. For example, the second user input and/or the selection includes one or more inputs described with reference to inputs such as selection input(s) herein.

In some embodiments, in response to detecting the second user input, the computer system initiates a process to share the virtual content with the second computer system in the second three-dimensional environment, such as a process including causing display of user interface 734 as shown in FIG. 7C-2 and/or causing display of virtual content 702 as shown in FIG. 7D-2 at computer system 101b, wherein the process to share the virtual content is included in the process to display the virtual content in the second three-dimensional environment of the second computer system at the respective location (e.g., by downloading, launching, and/or playing the first content and/or downloading, launching, activating, or maintaining activation of an application associated with the first content). In some embodiments, the first computer system communicates information including data, metadata, a request, and/or other indication(s) to the second computer system. In response to obtaining the data, metadata, request, indication(s), and/or respective information indicative of such information, the second computer system optionally initiates display of the virtual content and/or respective virtual content that corresponds to the virtual content within a second three-dimensional environment. For example, the first and the computer systems both optionally display a virtual object including a user interface of a web browser, a user interface of a media player, a virtual game, one or more virtual objects, media including one or more images, and/or a virtual affordance. In some embodiments, the first and second computer systems display the virtual content at respective locations within their respective three-dimensional environments to simulate a sharing of a physical object in their shared physical environment. For example, the first computer system optionally maintains display of the virtual content in response to sharing the virtual content, and the second computer system optionally initiates display of the virtual content at a location in the second three-dimensional environment, similar to or the same as the location of the first virtual object in the first three-dimensional environment, such as placed upon a table, hovering above a floor of the three-dimensional environment, centered on a viewpoint of the user of the first computer system, and/or at a default viewing position suitable for sharing the virtual content such as a predetermined distance and/or orientation relative to the viewpoints of the users of the computer systems. Thus, it is understood that description of “sharing” virtual content herein optionally is included in the process to cause display of the virtual content in the second three-dimensional environment as described with reference to method 800. Additionally or alternatively, sharing the virtual content includes communicating information that causes display of the virtual content and/or corresponding virtual content at the second computer system. Sharing the virtual content in response to the second user input allows the user of the first computer system to visually present information to the user of the second computer system without requiring additional inputs, communication, and/or projection of images, thereby reducing energy consumption of the first computer system.

In some embodiments, the process to share the virtual content with the second computer system is performed irrespective of whether the first computer system and the second computer system are engaged in a real-time communication session, such as a communication between computer system 101a and computer system 101b performed capable of being initiated via user interface 714, the user interface 714 as shown in FIG. 7B-1. For example, the virtual content is optionally shared before a real-time communication session is initiated with the second computer system that optionally has one or more characteristics similar to or the same as those described with reference to method 1000. Thus, the first computer system optionally shares the virtual content before a spatial or non-spatial real time communication session is initiated or after a spatial or non-spatial real-time communication session is concluded. It is understood that the sharing of the virtual content optionally includes communication between the first and second computer systems (e.g., prior to the sharing, and/or when the second input is detected), which can be separate and different from the spatial or non-spatial real-time communication session. For example, the first computer system optionally transmits and receives requests, indications of approval of requests, data, and the like in response to the second input initiating sharing of the virtual content. The immediately aforementioned procedures optionally are separate from a spatial real-time communication session—at times referred to herein as a “spatial call”—thus allowing a user of the first computer system to share virtual content without spatially or non-spatially calling the second computer system. That said, it is understood that the virtual content is optionally shared while a real-time communication session is ongoing, such as while the first computer system is engaged in a spatial call with the second computer system. Sharing the virtual content independently of whether the first and second computer systems are engaged in a real-time communication session reduces the processing and power consumption required to initiate and sustain the real-time communication session.

In some embodiments, while displaying, via the display generation component, the virtual content at the first location in the first three-dimensional environment of the first computer system in accordance with a determination that the one or more criteria are not satisfied, the computer system displays, via the display generation component, a first virtual object, different from the first selectable option, wherein a visual appearance of the first virtual object is different from a visual appearance of the first selectable option, such as indicator 752 as shown in FIG. 7I. For example, as described with reference to method 800.

For example, the first virtual object is optionally a selectable option including a button, graphic, text, media, and/or some combination thereof. In some embodiments, the first virtual object is a two or three-dimensional shape, such as a circle, ellipse, rectangle, asymmetric polygon, cube, sphere, and the like. In some embodiments, the first virtual object is displayed overlapping with, adjacent to, and/or otherwise near the virtual content. In some embodiments, the first virtual object is displayed at location that is the same as the location of the first selectable option. In some embodiments, the first virtual object includes information and/or is displayed with a visual appearance to indicate a sharing state of the virtual content. For example, the first virtual object optionally includes information such as text indicating that the virtual content is “private” and is not displayed or otherwise accessible to the second computer system. Thus, the virtual content is optionally in a private state, and is optionally not shared with the second computer system. The private state is optionally indicated by displaying an icon, text (e.g., “private”), shading the first virtual object with one or more first colors, and/or displaying the first virtual object with a particular scale and/or shape relative to the three-dimensional environment; thus, the first virtual object is optionally displayed with a visual appearance that is different from the visual appearance of the virtual content. Additionally or alternatively, the display of the first virtual object optionally conveys that the virtual content cannot be shared (e.g., until the second or another computer system satisfies the one or more criteria). Thus, when the one or more criteria are satisfied, the first computer system displays the first virtual object.

In some embodiments, the computer system changes a visual appearance of the first selectable option described with reference to method 800 when the one or more criteria are not satisfied, such as indicator 752 as shown in FIG. 7I. For example, when the first computer system is not physically proximate to the second computer system, the computer system changes a visual appearance of the first selectable option to be similar to or the same as described with reference to the first virtual object. In this example, the computer system maintains display of the first selectable option when the one or more criteria are not satisfied to indicate a private state of the virtual content, and/or that the virtual content optionally cannot be shared. In response to detecting an event that causes display of the first selectable option, the computer system optionally displays the first selectable option with the visual appearance described with reference to the first virtual object. Additionally or alternatively, when the one or more criteria are initially not satisfied and the first computer system detects and/or obtains an indication that the one or more criteria become satisfied (e.g., when the first computer system detects that the second computer system is physically proximate), the first computer system optionally changes the visual appearance from indicating that the virtual content is private and/or cannot be shared to the visual appearance indicating that the virtual content is not private and/or is able to be shared to the second computer system.

In some embodiments, in response to detecting selection of the first virtual object, the first computer system forgoes display of a sharing user interface, such as the forgoing of displaying of a user interface as shown in FIG. 7J. For example, because the virtual content is private and the one or more criteria are not satisfied, the first computer system does not detect a suitable recipient of the sharing of the virtual content within the physical environment. In some embodiments, the selection includes a selection input including one or more of an air pinches while attention is directed to the first virtual object, a touching of a surface such as a trackpad or a monitored non-touch sensitive surface, a voice command, and/or a selection of a physical or virtual button. Displaying the first virtual object indicates that the virtual content is not yet shared with another computer system and/or sharing of the virtual content is not presently possible, thus reducing erroneous user input and thereby power consumption required to detect and perform operations related to requesting content sharing.

In some embodiments, the visual appearance of the first virtual object includes a visual indication indicating that the virtual content is not visible via the second computer system, such as text included in indicator 752 as shown in FIG. 7I. For example, unless the computer system is sharing and/or initiated a process to share the virtual content, the first virtual object optionally indicates that the virtual content is not shared with the second computer system. For example, the visual indication optionally includes the “private” text and/or visual appearance described previously. In some embodiments, if the one or more criteria are no longer satisfied (e.g., after initially being satisfied), the computer system displays the visual indication conveying a sharing state of the virtual content. For example, the computer system optionally displays text indicating that the virtual content is “not shared” or “private” after the first computer system ceases sharing of the virtual content. In some embodiments, the first computer system additionally or alternatively displays the virtual content with a particular visual appearance indicating the sharing state of the virtual content. For example, the first computer system optionally displays a border around the virtual content, a simulated lighting effect mimicking the visual appearance of one or more physical light sources directed toward the virtual content, and/or text included in the virtual content. Displaying the visual indication indicates that the virtual content is not yet shared with another computer system and/or sharing of the virtual content is not presently possible, thus reducing erroneous user input and thereby power consumption required to detect and perform operations related to requesting content sharing.

In some embodiments, the determination that the one or more criteria are satisfied is based on sensing performed by the first computer system, such as sensing performed by computer system 101a as shown in FIG. 7A-1. For example, the first computer system optionally includes circuitry and/or is configured to detect whether the second computer system is sufficiently physically proximate—as described with reference to method 800—to share the virtual content (e.g., separately from a real-time communication session). As described further herein, the first computer system optionally detects a power of signal received from the second computer system, and/or detects an indication of power transmitted from the first computer system and received by the second computer system. It is understood that additional or alternative metrics optionally are determined and/or obtained by the first computer system to determine that the first and second computer systems are within a wireless range of one another, share a subset of physical environment, is visible to the first computer system, that sounds are mutually audible to the computer systems, and/or otherwise are physically co-located. Additional description of the logic and/or mechanics of the sensing performed by the first computer system follows. It is understood that when the logic and/or mechanics described herein do not implicate that the one or more criteria are satisfied (e.g., the first and second computer systems are not physically co-located), that the first computer system optionally forgoes display of the first selectable option (e.g. does not display an affordance to initiate sharing of the virtual content). It is further understood that aspects of certain embodiments optionally are combined with aspects of other embodiments, and/or that different sensing modalities, operations, and implications of co-location optionally are combined to improve and/or conclude that the computer systems are co-located. Sensing proximity of the second computer system reduces the likelihood that the first selectable option is displayed when the virtual content cannot yet be shared, thus reducing power consumption of the first computer system.

In some embodiments, the satisfaction of the one or more criteria is determined based upon a strength of a signal communicated between the first computer system and the second computer system, such as a signal capable of being transmitted by computer system 101a shown in FIG. 7A-1. For example, the first and/or second computer systems optionally detect a received signal power, signal-to-noise ratio, signal quality, signal energy, and/or another suitable signal metric(s) of one or more signals transmitted by the other computer system. In accordance with a determination that such metrics are above, below, within, or outside a suitable threshold window or value, the first and/or second computer systems (optionally independently) determine that the other computer system is physically co-located, and therefore that the one or more criteria area satisfied. For example, the first computer system optionally determines that a received signal strength indication (RSSI) associated with a transmission from the second computer system or a transmission to the second computer system is greater than a threshold value (e.g., −180, −150, −125, −110, −100, −90, −80, −70, −50, or −40 dBm), indicating that the second computer system is co-located with the first computer system. In some embodiments, the strength of one or more signals communicated between the first and the second computer system that satisfy the one or more criteria are included and/or associated with procedures facilitating a communication link using Wireless Fidelity (Wi-Fi), BlueTooth®, and/or cellular communication. Accordingly, the first computer system optionally displays the first selectable option as described with reference to method 800. It is understood that additional modalities of circuitry, such as acoustic, electromagnetic, and/or optical signals are optionally transmitted from the first toward the second computer system to determine a numerical metric associated with proximity of the two devices, and that any embodiments described herein are merely exemplary. Determining co-location of the second computer system based upon a signal communicated between the first and second computer systems provides a characterization of point-to-point communication, thus indicating potential co-location of the second computer system and reducing the likelihood that content sharing is requested when the computer systems are not co-located, thereby reducing power consumption of the respective computer systems.

In some embodiments, the satisfaction of the one or more criteria is determined based upon the first computer system and the second computer system being within range of a same wireless network, such as a wireless network communicatively coupled to computer system 101a as shown in FIG. 7A-1 and computer system 101b as shown in FIG. 7A-2. In some embodiments, the computer determines that the first and second computer systems are connected to a same wireless network, and that the one or more criteria are thereby satisfied. For example, the first computer system optionally obtains an indication from a wireless network that the second computer system is connected to the same wireless network, and/or that one or more signals exchanged between the second computer system and the network is above a threshold value and/or is within a threshold window (e.g., similar to as described with reference to signals transmitted from the first to the second computer system, directly). The metrics associated with each computer system optionally indicate the effective “range” of the corresponding network. Additionally or alternatively, one or more network modules optionally determines a relative position of the first and second computer systems relative to the physical environment, and/or a relative distance between the first and second computer systems, and optionally transmits an indication of such position and/or distances to the first and second computer systems. In accordance with a determination that the computer systems are within a threshold distance (e.g., 0.01, 0.05, 0.1, 0.25, 0.5, 0.75, 1, 1.25, 1.5, 3, 5, 10, or 20 m) of each other, the first and second computer systems optionally and respectively determine that the systems are co-located, and that the one or more criteria are satisfied. Accordingly, the first computer system optionally displays the first selectable option to facilitate sharing of the virtual content. Determining co-location based upon a network range reduces power consumption required by the first computer system that otherwise is consumed when assessing the proximity between the first and second computer systems.

In some embodiments, the satisfaction of the one or more criteria is determined based upon a ranging distance between the first computer system and the second computer system, such as a ranging distance between computer system 101a and computer system 101b as shown in FIG. 7A-1. For example, the first and second computer system optionally receive a signal indicating time-of-flight between the computer systems. In accordance with a determination that the time-of-flight is less than threshold time (e.g., 0.1 ps, 1 ps, 10 ps, 100 ps, 1 ns, 10 ns, 100 ns, 250 ns, or 500 ns), the one or more criteria are optionally satisfied. In some embodiments, the ranging distance is additionally or alternatively based upon a power, energy, signal-to-noise ratio, and/or some combination thereof. Determining that the computer systems are co-located based upon a ranging distance reduces the need for a shared wireless network, thus reducing power consumption required to connect and communicate with the network.

In some embodiments, the satisfaction of the one or more criteria is determined based upon sensing, by the first computer system, that the first computer system and the second computer system occupy a same physical room, such as the physical room shared between computer system 101a and computer system 101b as shown in FIG. 7A-1. For example, the first computer system optionally detects that spatial data indicates that the first computer system and the second computer system occupy a same physical room (e.g., sensed optically, acoustically, electromagnetically, and/or some combination thereof). As an example, the first computer system optionally obtains a mapping of the physical environment included in the first three-dimensional environment of the first computer system, and cross-references that spatial understanding of the physical environment of the first computer system with a mapping of the physical environment included in the second three-dimensional environment of the second computer system. In some embodiments, in accordance with a determination that physical objects and/or features are shared between the first and second three-dimensional environments, the first and/or second computer systems respectively determine that the computer systems share a same physical room. For example, in accordance with a determination that both environments include a table, chair, walls, floors, and/or that the spatial arrangement (e.g., position and/or orientation) between such physical objects and features are similar or the same, the computer systems are determined be physically co-located (e.g., by the first, second, or another computer system in communication with both computer systems). In some embodiments, the presence, position, and/or orientation of physical objects and/or whether the computer systems are in the same room are determined optically by the first and/or second computer systems, such as using light detecting and ranging (LiDAR), radar, image processing (e.g., using images obtained from one or more cameras), and/or some combination thereof. In some embodiments, in accordance with a determination that the physical environment included in the first three-dimensional environment and the physical environment included in the second three-dimensional environment are at least partially different, and therefore that the one or more criteria are not satisfied. For example, the first computer system optionally receives an indication of the dimensions and/or objects within the physical environment of the second computer system. In accordance with a determination that the spatial arrangement between such objects and/or that different objects are included in the physical environment of the second computer system (e.g., that a chair detected by the second computer system is not detected by the first computer system), the first computer system optionally determines the one or more criteria are not satisfied, and that the computer systems are not co-located. Additionally or alternatively, the computer systems respectively determine that the dimensions and arrangement of walls and/or a ceiling included in respective physical environments differ, and therefore determine that the first and second computer systems are not co-located. Displaying the first selectable option in accordance with a determination that the computer systems share a physical room reduces the likelihood that the virtual content is displayed at a position within the second three-dimensional environment of the second computer system that disorients a user of the second computer system.

In some embodiments, the satisfaction of the one or more criteria is determined based upon a determination that the first computer system and the second computer system detect a same sound in the physical environment, such as indicated by audio 745 as shown in FIG. 7A-1. For example, the first computer system optionally determines that a sound generated by the first computer system is audible to second computer system in response to obtaining an indication of that sound from the second computer system. Accordingly, the first and second computer systems optionally determine the one or more criteria are satisfied. In some embodiments, the first computer system detects one or more sounds in its physical environment, and in response to receiving an indication that the second computer system also detects the one or more sounds, the one or more criteria are satisfied. For example, speech of the user of the first computer system is optionally detected by microphones of the second computer system, which optionally indicates that the computer systems are co-located. The sounds optionally include ambient sounds that exist in the physical environment of the computer systems (e.g., not generated by the first and/or second computer systems, and emitted by something else (e.g., another device, another entity, etc. in the same physical environment of the two computer systems)), and/or sounds that are intentionally generated (e.g., by user's speaking, clicking, snapping, and/or some combination thereof). In some embodiments, in accordance with a determination that the same sound is not detected, the one or more criteria are not satisfied, and the first computer system forgoes display of information and/or the first selectable option to initiate processes to share the virtual content described with reference to method 800. Displaying the first selectable option when a same sound is present in the physical environments of the computer systems indicates that the first and second computer systems are likely within a same physical environment.

In some embodiments, the satisfaction of the one or more criteria is determined based upon a sensed physical interaction between the user of the first computer system and a user of the second computer system, such as a shaking of hands between user 710a and user 710b as performed in a shared physical environment similar to or the same as shown in FIG. 7A-1. For example, the first computer system optionally senses a handshake, speech, an air gesture, and/or some combination thereof (e.g., the sensed physical interaction) directed to a user of the second computer system and/or performed by the user of the second computer system. Thus, the users of the respective computer systems optionally are physically interacting, and are therefore physically co-located. In some embodiments, if the first computer system does not detect speech, a noise, a gesture, and/or a movement of the user of the second computer system relative to the first three-dimensional environment, the one or more criteria are not satisfied. Physical interaction with the user of the second computer system necessarily indicates co-location of the first and second computer systems, thus reducing the likelihood that the virtual content is shared with a non-co-located user.

In some embodiments, the satisfaction of the one or more criteria is determined based upon a determination that at least a portion of a user of the second computer system is included within a viewport of the first computer system, such as the representation of user 710b visible in the viewport of computer system 101a as shown in FIG. 7A-1. For example, the first computer system optionally detects that one or more image sensors indicate a portion of the body of the user of the second computer system is visible, and optionally determines that the user of the second computer system is co-located. Additionally or alternatively, the first computer system performs one or more image processing operations to detect one or more portions of the body of the second user system. In some embodiments, in accordance with a determination that the user is not at least partially visible via the one or more image sensors (e.g., that the user is not within the viewport of the first computer system), the first computer system forgoes display of the first selectable option because the one or more criteria are not satisfied. Satisfaction of the one or more criteria when the user is within the viewport of the first computer system improves the likelihood that the virtual content is shared at a location that is visible and/or spatially relevant to the second computer system, thus reducing the need for inputs moving the virtual content to such a location, thereby reducing power consumption of the first computer system.

In some embodiments, while displaying the first selectable option, the computer system detects, via the one or more input devices, a first user input including a selection of the first selectable option, such as the air pinch performed by hand 716a as shown in FIG. 7A-1. For example, similar to or the same as described with reference to selection inputs herein.

In some embodiments, in response to detecting the first user input, the computer system displays, via the display generation component, one or more representations of one or more users of respective computer systems sharing the physical environment with the first computer system, wherein the one or more representations of one or more users includes a representation of a user of the second computer system, such as a representation of user 710b (e.g., “Lin”) as shown in FIG. 7B-1. For example, the first computer system optionally displays a media, text, graphics, and/or some combination thereof depicting, identifying, and/or otherwise representing the user of the second computer system in response to detecting the selection of the first selectable option. For example, the first computer system optionally displays a name tied to an account registered with the second computer system such as the name of the user of the second computer system, and/or an electronic address or other identifier registered with the account. Additionally or alternatively, the one or more representations optionally include a picture, a digital avatar, an animated avatar, and/or some combination thereof. In some embodiments, the first computer system displays a plurality of representations concurrently. In some embodiments, the first computer system displays text indicating the virtual content will be shared with the displayed representations of users of co-located computer systems (e.g., the second, and a third computer system) in response to detecting a second selectable option. For example, the first computer system optionally displays the second selectable option (e.g., “Share”) in response to detecting the first user input. In some embodiments, the first computer system shares the virtual content with a subset of users corresponding to the one or more representation of users. For example, the first computer system detects one or more selection inputs directed to some of the one or more representation (e.g., a series of an air pinches while gaze is directed to respective representations), and optionally displays a visual indication that the corresponding representation are selected for prospective content sharing (or that the selected users will be omitted from the content sharing). In response to detecting the selection of the second selectable option, the first computer system optionally shares the virtual content with the selected (or the non-omitted) computer systems. In some embodiments, the first computer system ceases display of a representation of a user of another computer system that no longer satisfies the one or more criteria, and accordingly forgoes sharing of the virtual content if the second selectable option is shared. In some embodiments, the first computer system shares the virtual content in response to selection of a respective representation of a user directly, without requiring selection of the second selectable option and/or without displaying the second selectable option. Displaying representations of users that are co-located with the first computer system allows the user of the first computer system to view, and decide which recipient system(s) will receive the virtual content.

In some embodiments, in accordance with the determination that the one or more criteria are satisfied, the first selectable option is displayed at a second location within the first three-dimensional environment, corresponding to (e.g., at a respective (optionally fixed) spatial arrangement (e.g., position and/or orientation) relative to) the first location at which the virtual content is displayed, such as the location of selectable option 720 as shown in FIG. 7A-1. For example, the first computer system optionally displays the first selectable option above, below, lateral to, and/or in another location within the first three-dimensional environment that is near the first location. The first selectable option, for example, is optionally a pill-shaped two-dimensional virtual object displayed in a plane that is parallel to the virtual content. In some embodiments, the pill-shaped selectable option is centered with laterally centered with the first content, and is displayed above the first virtual content relative to a floor of the first three-dimensional environment. Additionally or alternatively, the first selectable option is optionally displayed laterally adjacent to the virtual content, below and centered with the virtual content, displayed extruded away from the first virtual object, and/or near a corner of the virtual content. In some embodiments, in response to detecting one or more inputs changing the position and/or orientation of the virtual content relative to the first three-dimensional environment, the first computer system moves the first selectable option by a similar or same magnitude and/or in a similar and/or same direction as the movement of the virtual content. In some embodiments, in response to detecting movement of the viewpoint of the user of the first computer system relative to the first three-dimensional environment, the computer system forgoes changing (e.g., maintains) the position of the virtual content and/or the first selectable optional relative to the first three-dimensional environment. Thus, the first computer system optionally maintains a spatial relationship between the virtual content and the first selectable option in response to detecting inputs requesting movement and/or while moving the virtual content relative to the first three-dimensional environment, and optionally changes a spatial relationship between the first selectable option and the viewpoint of the user in response to detecting changes in the user's viewpoint. In some embodiments, the first selectable option position and/or orientation changes in response to viewpoint movement. For example, a viewing surface of the first selectable option optionally rotates relative to the first three-dimensional environment such that an angular relationship between a vector extending from the front surface (e.g., normal to the front surface) and a vector extending from the viewpoint of the user (e.g., parallel to the floor, centered with the user's viewpoint) is optionally maintained. Described an additional way, the first selectable option optionally rotates such that the viewing surface remains visible and/or oriented toward the user's viewpoint in response to detecting changes in the viewpoint. Displaying the first selectable option near the virtual content reduces user input required to locate the first selectable option while the user's focus is directed to the virtual content, thereby reducing superfluous power consumption of the first computer system.

In some embodiments, in accordance with the determination that the one or more criteria are satisfied, the first selectable option is displayed at a second location within the first three-dimensional environment, corresponding to (e.g., at a respective (optionally fixed) spatial arrangement (e.g., position and/or orientation) relative to) a third location in the first three-dimensional environment associated with the second computer system, such as the location of indicator 726 as shown in FIG. 7A-1. For example, the second location is optionally configured such that the first selectable option is displayed near or overlapping with a representation of the user of the second computer system. In some embodiments, similar to as described with reference to the virtual content and the first selectable option, the first computer system maintains a spatial relationship between the first selectable option and the representation of the user of the second computer system. For example, in response to obtaining an indication that the representation of the user of the second computer system is to move and/or is moving relative to the first three-dimensional environment, the first computer system optionally changes a position and/or orientation of the first selectable option. In some embodiments, the magnitude(s) and/or direction(s) of movement of the first selectable option are similar to and/or the same as the magnitude(s) and/or direction(s) of movement of the representation of the user of the second computer system. For example, the first selectable option is optionally displayed above a displayed or visible view of a head of the user of the second computer system. In such an example, the first computer system optionally maintains a spatial relationship and/or a positional relationship between the representation of the second user and the first selectable option as the representation moves, remaining hovering above the head. For example, the first computer system optionally displays the first selectable option above a head of the user of the second computer system relative to the floor of the first three-dimensional environment, centered with a torso of the user, or laterally (relative to the user's viewpoint) adjacent to a shoulder of the user. It is understood that the first selectable option is also associated with an orientation relative to the first three-dimensional environment, such parallel to a plane intersecting the users head, passing through the user's ears or eyes, and/or perpendicular to the floor. In some embodiments, the first computer system additionally displays a second selectable option—similar to the first selectable option—selectable to initiate sharing of the virtual content at a third location corresponding to a user of a third computer system that also satisfies the one or more criteria. Displaying the first selectable option near the second computer system reduces user input required to locate the first selectable option while the user's focus is directed to the second computer system, thereby reducing superfluous power consumption of the first computer system.

In some embodiments, the one or more criteria include a criterion that is satisfied when a first user account associated with the first computer system is associated with a second user account associated with the second computer system, such as a user account registered with computer system 101a that is associated with a user account registered with computer system 101b as shown in FIG. 7A-1. For example, the first computer system optionally forgoes display of the first selectable option whether the second computer system is physically co-located or is not co-located in accordance with a determination that the second user does not correspond to a registered contact known to the first computer system. For example, the first computer system is optionally registered with a first user account, and/or maintains a first list of user accounts and/or contacts. If the first user account and/or the first list does not include a second user account that is registered to the second computer system, the first computer system optionally does not default to surfacing the first selectable option, and therefore forgoes display of a convenient mechanism to share the virtual content because the second user account is not associated with the first user account and/or the first list. Forgoing display of the first selectable option in accordance with a determination that the first and second accounts are not associated reduces the likelihood that virtual content is erroneously shared with a device and/or user that is not yet trusted, or known to the first computer system.

In some embodiments, the one or more criteria include a criterion that is satisfied when the first computer system has previously shared virtual content with the second computer system prior to displaying the first selectable option, such as after displaying virtual content 702 as shown in FIG. 7D-2 (e.g., repeating the steps illustrated in FIGS. 7A-1 through 7D-1). For example, the first computer system optionally displays the first selectable option in accordance with a determination that the first computer system—at a previous time—shared virtual content (e.g., the same or different from the virtual content described with reference to method 800) with the second computer system. As an example, the first computer system optionally detects a request to share respective virtual content (e.g., from a user interface included in the respective virtual content, a request from the second computer system, and/or a request received during a real-time communication session), and optionally approves the sharing of the respective virtual content. At a later time, the first computer system optionally displays the virtual content described with reference to method 800, and optionally displays the first selectable option because the first computer system has formed an association of trust with the second computer system by virtue of the sharing of the respective virtual content. In an alternative example, if the user of the first computer system optionally rejects the sharing of the respective virtual content, the first computer system optionally forgoes display of the first selectable option when displaying the virtual content at the first location because the trust association between the computer systems has not yet been established. It is understood, however, that the virtual content is optionally shared using other options, such as using a messaging user interface, upon entry into a real-time communication session, and/or upon entry into a shared MR, XR, or VR environment. Displaying the first selectable option in accordance with a determination that the first and second computer systems have previously shared virtual content reduces the likelihood that virtual content is shared with an untrusted or unknown computer system, thus improving the data privacy of the first computer system.

In some embodiments, the one or more criteria include a criterion that is satisfied when a first user account associated with the first computer system is included in a group of user accounts that includes a second user account associated with the second computer system, such as a group of user accounts including a user account registered with computer system 101a and a user account registered with computer system 101b as shown in FIG. 7A-1. For example, as described further herein, the computer systems are optionally associated with respective user accounts. In some embodiments, the user accounts are included in a group of user accounts, such as a friends or family sharing group. For example, the first and second user accounts optionally are registered with an external server, and designated as members that share a portion of data and access to applications. In some embodiments, the family sharing group includes sharing access to a pool of purchased and/or subscribed software and/or includes exchanging information concerning respective computer systems. For example, the family sharing optionally includes shared mobile applications, media storage, news subscriptions, video games, and/or facilitates opt-in access to device location sharing, and/or some combination thereof. Accordingly, the first and second user accounts are associated with one another, and more likely to be trusted when sharing virtual content. Thus, when the first computer system displays virtual content and the second computer system is co-located, the first computer system optionally displays the first selectable option. In some embodiments, in accordance with a determination that the second user account is not registered and/or included in the group of user accounts, the first computer system forgoes display of the first selectable option. Displaying the first selectable option in accordance with a determination that the first and second computer systems are included in a group of user accounts reduces the likelihood that virtual content is shared with an untrusted or unknown computer system, thus improving the data privacy of the first computer system.

In some embodiments, the process to display the virtual content in the second three-dimensional environment of the second computer system at the respective location is completed in response to a determination that the second computer system indicates an approval of the display of the virtual content in the second three-dimensional environment, such as an indication of the input provided by hand 742 as shown in FIG. 7C-2. For example, in response to detecting a selection input directed toward the first selectable option and/or directed toward a representation of a user of the second computer system (as described further herein), the first computer system optionally transmits a request to share the virtual content. In response to receiving the request, the second computer system optionally displays a prompt and/or audibly prompts the user of the second computer system to approve or reject the virtual content sharing. In response to detecting user input approving the content sharing (e.g., biometric sensing, a selection of an approval button, a voice command, and/or some combination thereof), the second computer system optionally transmits the approval to the first computer system, which optionally proceeds to share the virtual content. Thereafter, the second computer system optionally displays the virtual content obtained from the first computer system and/or indicated by the first computer system within the second three-dimensional environment, and the process to initiate the sharing of the virtual content is optionally complete. In some embodiments, in accordance with a determination that the content sharing is rejected at the second computer system, the first computer system forgoes the sharing of the virtual content, and the second computer system forgoes display of the shared virtual content. Sharing the virtual content contingent upon approval of the content sharing reduces the likelihood that the first computer system requires processing and power consumption attempting to share virtual content that is not wanted by the user of the second computer system.

In some embodiments, while displaying, via the display generation component, the virtual content at the first location and the first selectable option in the first three-dimensional environment, the computer system detects, via the one or more input devices, one or more inputs including selection of the first selectable option, such as input provided by hand 716 as shown in FIG. 7A-1 and/or 7B-1. For example, as described with reference to method 800 and further herein with respect to selection input(s).

In some embodiments, in response to detecting the one or more inputs, the computer system maintains display of the virtual content at the first location within the first three-dimensional environment while the virtual content is displayed in the second three-dimensional environment, such as the location of content 702 shown from FIG. 7B-1 to FIG. 7C-1. For example, sharing the virtual content by the first computer system optionally includes maintaining a position and/or orientation of the virtual content and first selectable option relative to the first three-dimensional environment. Accordingly, from the perspective of the first and second computer systems, the virtual content is optionally displayed at a position and/or orientation similar to a physical object that was previously only visible via the first computer system, and is now visible to both users of the computer systems. In some embodiments, the process to display the virtual content in the second three-dimensional environment of the second computer system at the respective location in the second three-dimensional environment includes maintaining display of the virtual content at the first location in the first three-dimensional environment. Maintaining the location of the first selectable option and virtual content relative to the three-dimensional environment when sharing the virtual content reduces the likelihood that the user of the first computer system directs erroneous input toward the virtual content, thus reducing power consumption of the first computer system.

In some embodiments, after initiating the process to display the virtual content at the respective location in the second three-dimensional environment of the second computer system, and while displaying the virtual content at the first location in the first three-dimensional environment, the computer system detects, one or more events including movement of viewpoint of a user of the first computer system relative to the first three-dimensional environment, such as movement of the viewpoint of user 710a to as shown in FIG. 7G-1. For example, while the virtual content is being shared and displayed at the first location, the first computer system detects one or more events, such as including one or more inputs requesting movement of the user's viewpoint relative to the first three-dimensional environment. The one or more inputs optionally include movement of one or more portions of the user's body, such as walking and/or turning relative to the first three-dimensional environment. Additionally or alternatively, the one or more inputs optionally include one or more directional inputs detected via a joystick, a touchpad, a voice command, and/or some combination thereof requesting the movement of the viewpoint. In some embodiments, the one or more events include an indication that a viewpoint of the user of the second computer system moves relative to the second three-dimensional environment. In some embodiments, the one or more events include movement of the viewpoint of the user of the first computer system relative to the first three-dimensional environment while maintaining the virtual content at the first location, and further includes selection of a button detected after the movement while the virtual content is still at the first location. In some embodiments, the movement results in a modification of spatial relationship between the viewpoint of the user and the virtual content as compared to a spatial relationship prior to the movement.

In some embodiments, in response to detecting the one or more events, the computer system moves the virtual content relative to the first three-dimensional environment in accordance with the movement of the viewpoint, such as moving virtual content 702 in accordance with the movement in response to the movement shown in FIG. 7G-1. For example, the position and/or orientation of the virtual content changes in a direction and/or by a magnitude based upon a magnitude and/or direction of the movement of the viewpoint. As an example, in accordance with a determination that the one or more events includes a first movement, including a first distance of movement and/or a first degree of rotation relative to the first three-dimensional environment, the first computer system optionally moves the virtual content by a second distance and/or second degree of rotation relative to the first three-dimensional environment. In some embodiments, the first and second distances and/or degrees of rotation are similar, the same, or otherwise based upon the viewpoint movement. In some embodiments, in accordance with a determination that the one or more events includes a third movement, including a third distance and/or a third degree of rotation relative to the first three-dimensional environment, the first computer system moves the virtual content by a fourth distance and/or fourth degree of rotation relative to the first three-dimensional environment, different from the first, second, and/or third distances and/or degrees of rotation. For example, the first computer system optionally moves the virtual content rightward in response to detecting the user's viewpoint rotate toward the user's right side, and optionally moves the virtual content leftward in response to detecting the user's viewpoint rotate toward the user's left side. Additionally or alternatively, the virtual content is moved one meter along an axis parallel to the user's viewpoint in response to detecting one meter of viewpoint movement along the axis. Moving the virtual content in accordance with viewpoint movement improves the likelihood that the virtual content is visible and/or is interactable while sharing the virtual content, and reduces input and thereby processing required to separately request movement using other input(s).

In some embodiments, after initiating the process to display the virtual content at the respective location in the second three-dimensional environment of the second computer system, and while displaying the virtual content at the first location in the first three-dimensional environment, the computer system detects, via the one or more input devices, one or more inputs including a request to move the virtual content to a second location in the first three-dimensional environment, corresponding to a location of the second computer system, such as input directed to grabber 708 as shown in FIG. 7F-1. In some embodiments, the one or more inputs include a first input that includes an air pinch gesture performed by a hand of the user of the computer system—such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system while attention (e.g., including gaze) of the user is directed toward the virtual object. In some embodiments, the computer system detects the first input irrespective of the location of the attention of the user in the three-dimensional environment. In some embodiments, the computer system detects the air pinch gesture directed toward a selection element (e.g., a grabber or handlebar virtual object) associated with the virtual content that is selectable to initiate movement of the virtual content in the three-dimensional environment. In some embodiments, after detecting the air pinch gesture, the computer system detects movement of a portion of the user. For example, the computer system detects movement of the hand of the user in space, such as a movement while the hand is maintaining the pinch hand shape (e.g., the tips of the thumb and index finger remain touching) such as an air drag gesture. In some embodiments, the movement of the hand of the user is lateral (e.g., in a horizontal direction relative to the viewpoint of the user, parallel to the floor of the three-dimensional environment) in space toward the second location in the three-dimensional environment. In some embodiments, the first computer system moves the virtual content in a direction, and by a magnitude that corresponds to a direction and/or magnitude of movement of the air pinch gesture. For example, the first computer system optionally moves the virtual content leftward by a first distance relative to the user's viewpoint in response to detecting movement of the air pinch leftward by a second distance. In some embodiments, the second distance is similar to, proportional to, inversely proportional to, or otherwise based upon the value of the first distance. Further, the first computer system optionally moves the virtual content rightward by a third distance relative to the user's viewpoint in response to detecting movement of the air pinch rightward by a fourth distance. In some embodiments, the fourth distance is similar to, proportional to, inversely proportional to, or otherwise based upon the value of the third distance. It is understood that the virtual content is optionally moved along one, two, or three axes relative to the first three-dimensional environment.

In some embodiments, the computer system detects the first input via a hardware input device (e.g., a controller operable with six degrees of freedom of movement, or a touchpad or mouse) in communication with the computer system. For example, the computer system detects a selection input (e.g., a tap, touch, or click) via the input device provided by one or more fingers of the hand of the user. In some such embodiments, after detecting the selection input, the computer system detects movement via the hardware input device, such as movement of the controller in space, movement of a mouse across a surface (e.g., a tabletop), or movement of a finger of the hand of the user across the touchpad. In some embodiments, the lateral movement of the object relative to the three-dimensional environment is relative to gravity (e.g., a vertical vector that is parallel to the force of gravity and/or perpendicular to the physical floor of the physical environment of the user). For example, the lateral movement is horizontal relative to, and therefore normal to (e.g., or within 0.5, 1, 3, 5, 8, 10, 15, 20, 25, or 30 degrees of being normal to), the vertical vector that is parallel to the force of gravity. In some embodiments, the first input need not include exclusively lateral movement of the object. For example, the first input includes movement of the object that is vertical (or has a vertical component, such as diagonal movement) relative to gravity, followed by the lateral movement described above, or vice versa, or a combination of vertical and lateral movement occurring concurrently.

In some embodiments, in response to detecting the one or more inputs, the computer system moves the virtual content to the second location in the first three-dimensional environment, wherein the second location in the first three-dimensional environment corresponds to a respective second location in the second three-dimensional environment, such as the location of virtual content 702 as shown in FIG. 7G-2. In some embodiments, the second location corresponds to a position that is expressly requested by the one or more inputs, such as the movement of an air pinch gesture. In some embodiments, the second location corresponds to a viewpoint of the user of the second computer system. In some embodiments, the second location and/or an orientation of the virtual content is centered with the viewpoint of the user of the second computer system. For example, the first computer system optionally rotates the virtual content until a surface of a virtual object including the virtual content is facing the user of the second computer system. In some embodiments, the rotation is performed in response to detecting the user of the first computer system terminate an air gesture, and in accordance with a determination that the second location is within a threshold distance (e.g., 0.25, 0.5, 0.75, 1, 1.25, 1.5, 2, 3, 5, 7.5, or 10 m) of the viewpoint of the second user. From the perspective of the user of the second computer system, the virtual content is moved and/or rotated to face the user (e.g., such that a plane of virtual object including the virtual content is parallel to the eyes and/or shoulders of the user of the second computer system). Thus, the first computer system optionally moves and/or rotates the virtual content to correspond to a respective second location in the second three-dimensional environment. Moving the virtual content to within the first three-dimensional environment and causing movement of the virtual content relative to the second three-dimensional environment to correspond to a location associated with the user of the second computer system facilitates visibility of the virtual content using the second computer system, thus reducing user input and/or communication otherwise required to convey information that can be more readily viewed via the shared virtual content.

In some embodiments, after initiating the process to display the virtual content at the respective location in the second three-dimensional environment of the second computer system, and while the virtual content is displayed at the first location in the first three-dimensional environment, the computer system detects, via the one or more input devices, one or more events including an indication of movement of a user of the second computer system relative to the second three-dimensional environment, such as movement of user 710b as shown from FIG. 7A-2 to FIG. 7B-2. For example, similar to as described with reference to moving the virtual content based upon movement of the viewpoint of the user of the first computer system relative to the first three-dimensional environment, the first computer system optionally moves the virtual content in accordance with information indicating movement of the user of the second computer system relative to the second three-dimensional environment. As an example, the indication of movement optionally indicates a first movement in one or more directions, by first one or more distances along the one or more directions. The first computer system optionally determines, and/or detects a mapping between the first and second three-dimensional environment, and optionally translates the movement of the second user relative to the second three-dimensional environment to movement of the second user relative to the first three-dimensional environment. Thus, the first computer system optionally detects and/or determines an equivalent of the user of the second user moving within the first three-dimensional environment, and optionally moves the virtual content based upon the equivalent. In some embodiments, the one or more events include movement of the viewpoint of the user of the second computer system, and a subsequent input such as a pressing of a button after the movement detected by the second computer system, and/or indications of such events that are transmitted to the first computer system. For example, the second computer system maintains display of the virtual content at the respective location and the first location computer system maintains display of the virtual content at the first location in response to detecting viewpoint movement and/or an indication of such movement of the user of the second computer system. In response to detecting the movement and/or the indication, the respective computer system optionally maintain the position and/or orientation of the virtual content in the respective three-dimensional environments. In response to detecting a pressing of a button after the viewpoint movement and/or an indication of the pressing, and when the viewpoint of the user of the second computer system is different from when the movement was initially detected, the respective computer system optionally move the virtual content relative to the respective three-dimensional environments.

In some embodiments, in response to detecting one or more events including the indication movement of the user of the second computer system, the computer system moves the virtual content from the first location to a second location in the first three-dimensional environment in accordance with the indication of movement of the user of the second computer system, such as movement of the virtual content 702 were it shared with computer system 101b in FIG. 7B-2. For example, the second computer system optionally detects event(s) including movement of the viewpoint of the user of the second computer system relative to the second three-dimensional environment (e.g., similar to or the same as described with reference to the first computer system detecting one or more events including movement of the viewpoint of the user of the first computer system). In some embodiments, the one or more events are detected while the virtual content is displayed at the respective position described with reference to method 800. In some embodiments, the second computer system moves the virtual content to an updated position and/or orientation relative to the second three-dimensional environment. Concurrently, and/or at a similar time, the second computer system optionally transmits an indication of such movement of the virtual content to the first computer system directly, or through one or more intermediate computer systems). In some embodiments, the first computer system detects the indication of the movement of the viewpoint of the user of the second computer system and/or the movement of the virtual content, and/or moves the virtual content in accordance with the indication. For example, the virtual content is optionally moved to a position and/or orientation relative to the first three-dimensional environment that is similar to, the same as, or otherwise is based upon the updated position of the virtual content relative to the second three-dimensional environment. Thus, the virtual content is optionally moved to a same position and/or orientation similar to as though the virtual content were a physical object that moves within a shared physical space of the first and second computer system. For example, in accordance with a determination that the one or more events indicate that the virtual content is to be moved to a first position and/or orientation relative to the first three-dimensional environment (e.g., including a first distance and/or rotation), the first computer system optionally moves the virtual content to the first position and/or orientation (e.g., by the first distance and/or the first degree of rotation). In accordance with a determination the one or more events indicate that the virtual content is to be moved to a second position and/or orientation, different from the first position and/or orientation, the first computer system moves the virtual content to the second position and/or orientation (e.g., and forgoes moving of the virtual content to the first position and/or orientation) relative to the first three-dimensional environment. Moving the virtual content based upon event(s) indicating movement of the user of the second computer system provides feedback indicating the user's position and/or orientation relative to the virtual content, thus reducing the likelihood that a user of the first computer system provides input or instructions directed to the virtual content while the virtual content is not visible and/or interactable to the user of the second computer system, thereby reducing processing required for such erroneous input.

In some embodiments, while displaying, via the display generation component, the virtual content at the first location in the first three-dimensional environment of the first computer system the computer system detects, via the one or more input devices, one or more inputs requesting movement of the first virtual object to a second location within the first three-dimensional environment, such as input provided by hand 716 as shown in FIG. 7F-1. For example, as described with reference to method 800.

For example, the first computer system optionally detects one or more inputs requesting movement of the virtual content. The one or more inputs optionally include a voice command, an air gesture (e.g., an air pinch, an air swiping of one or more fingers, an air fist, and/or other gestures described herein) while user attention is directed to the virtual content and/or a related virtual object associated with moving the virtual content, one or more trackpad inputs, and/or some combination thereof. For example, the first computer system optionally detects an air pinch while gaze is directed to a “grabber” virtual object displayed adjacent to the virtual content. In some embodiments, the grabber virtual object—at times, referred to herein as a grabber—is an oblong and/or elliptical virtual object that serves to move related virtual content. In some embodiments, the grabber is selected in response to the combination of the air gesture and/or user attention. In some embodiments, while the air gesture and/or an air pose is maintained (e.g., while contact between fingers forming an air pinch is maintained), the first computer system moves the virtual object in accordance with the movement of the hand(s) performing the air gesture.

In some embodiments, in response to detecting the one or more inputs requesting movement to the second location, in accordance with a determination that the second location corresponds to a physical object in the first three-dimensional environment, the computer system moves the virtual content to a third location in the first three-dimensional environment, different from the second location, such as the moving of virtual content as shown in FIG. 7G-1. For example, the first computer system optionally moves the virtual content to a third location that is different from an expressly requested location in accordance with a determination that the virtual content is to be moved near and/or intersecting with a location corresponding to a physical object. In some embodiment, the first computer system affixes the virtual content to a location corresponding to a physical wall, a surface, and/or an object in the first three-dimensional environment. For example, the first computer system optionally detects one or more inputs requesting movement of the virtual content (e.g., described further herein) to an updated location and/or orientation that is within a threshold distance (e.g., 0.001, 0.005, 0.01, 0.05, 0.075, 0.1, 0.125, 0.15, 0.2, 0.3, or 0.5 m) of a physical wall. In some embodiments, the first computer system forgoes movement to the requested, updated location, and moves the virtual content to correspond to the physical wall. For example, the virtual content is optionally displayed having a simulated contact with and/or overlaying the physical wall in response to detecting user input requesting movement of the virtual content within the threshold distance of the wall. Additionally or alternatively, the first computer system optionally changes the orientation of the virtual content. For example, the virtual content is optionally rotated to correspond to the surface (e.g., tangent to a tabletop, parallel with a wall, and/or hovering within the threshold distance of the surface). Thus, when the second location corresponds to the physical object, the first computer system moves the virtual content to the third location as though pinning and/or “snapping” the window to the third location, the movement including a different magnitude and/or direction of movement in one or more directions than that expressly requested by the one or more inputs.

In some embodiments, in response to detecting the one or more inputs requesting movement to the second location in accordance with a determination that the second location does not correspond to the physical object, the computer system moves the virtual content to the second location in the first three-dimensional environment, such as a location a distance away from a physical wall shown in FIG. 7G-1. In some embodiments, when the requested destination location corresponding to the requested movement of the virtual content does not correspond to a physical object, the first computer system moves the virtual content to the requested location in the first three-dimensional environment (e.g., forgoes the moving to correspond to the physical object). For example, in response to detecting the user move a first hand maintaining an air pinch by a first distance in a first direction, the first computer system optionally moves the virtual content by a second distance in a second direction to the second location. The second distance and/or second direction optionally are similar to, the same as, or otherwise based upon the first distance and/or the first direction. In some embodiments, when the first hand maintains the air pinch is moved a third distance and in a third direction, the first computer system moves the virtual content by a fourth distance in a fourth direction. The fourth distance and the fourth direction optionally are respectively similar to, the same as, or otherwise based upon the third distance and/or the third direction. In some embodiments, the virtual content is moved in a combination of directions, and by respective distances. Thus, when the requested location of movement of the virtual content does not correspond to a physical object, the first computer system optionally does not pin and/or snap the virtual content “to” a physical object, and the virtual content is optionally moved to the second location by first one or more magnitudes and first one or more directions included in the input corresponding to the express request to move the virtual content. Moving the virtual object to a third location corresponding to a physical object reduces user input to align the virtual content with the user's three-dimensional environment, reducing user input and improving content visibility, thereby conserving processing and power consumption of the first computer system.

In some embodiments, in accordance with a determination that the first computer system is engaged in a real-time communication session with a third computer system, different from the first computer system and different from the second computer system, while the first selectable option is displayed, the first selectable option is selectable to initiate a process to display the virtual content in a third three-dimensional environment, different from the first three-dimensional environment and different from the second three-dimensional environment, of the third computer system at a respective second location in the third three-dimensional environment corresponding to the first location in the first three-dimensional environment, such as the indicator 704 as shown in FIG. 7K and/or such as the target of input provided by hand 716 as shown in FIG. 7L. For example, as described with reference to method 1000, the first computer system optionally communicates with one or more computer systems other than the second computer system. In some embodiments, the communication is facilitated by a real-time communication session in which the first and the other computer system(s) are physically located in different physical environments (e.g., dwellings, rooms, regions of the earth, and/or some combination thereof). In some embodiments, in response to detecting selection of the first selectable option, the first computer system shares the virtual content with the other computer system(s). In some embodiments, the other computer system(s) performs one or more operations similar to as described with reference to the second computer system (e.g., accepting the sharing), and initiates display of the virtual content at a respective location within a respective three-dimensional environment of the other computer system(s). In some embodiments, the one or more other computer systems than the second computer system are not located in the physical environment of the first computer system, and therefore do not satisfy the one or more criteria described with reference to method 800.

In some embodiments, in accordance with a determination that the first computer system is not engaged in the real-time communication session with the third computer system while the first selectable option is displayed, the first selectable option is not selectable to initiate the process to display the virtual content in the third three-dimensional environment, such as if the user corresponding to representation 772 were not engaged in a real-time communication session with computer system 101a, similar to as shown in FIG. 7L. For example, in accordance with a determination that the first computer system is not engaged in a spatial “call” with other computer system(s) that do not share a portion of the physical environment of the first computer system, the first computer system optionally forgoes one or more operations to share the virtual content with the other computer system(s). In such an example, the second computer system is optionally co-located (e.g., shares a physical room and/or dwelling with the first computer system), and the first computer system optionally initiates one or more operations to share the virtual content with the second computer system and not the third computer system. In some embodiments, when the first and the third computer system (and/or other computer system) are engaged in a real-time communication session when the first input is detected, the first computer system initiates the process to share the virtual content with the second computer system as described herein with reference to method 800 and/or with reference to “sharing” the virtual content, and concurrently initiates a process to share the virtual content with the one or more other computer systems. Thus, the first computer system optionally shares the virtual content with physically co-located computer system(s) such as the second computer system, and optionally shares the virtual content with physically non-co-located computer system(s) that are engaged in a real-time communication session with the first computer system, such as the third computer system Initiating sharing of the virtual content with other computer system(s) in accordance with a determination that the first computer system is engaged in a real-time communication session with the other computer system(s) reduces execution of instructions attempting to rectify spatial discrepancies between the first computer system and the other computer system(s), thereby reducing processing and power consumption required by the first computer system.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9O illustrate examples of a computer system facilitating initiation of a spatial real-time communication session with one or more users in a three-dimensional environment according to some embodiments of the disclosure.

FIG. 9A illustrates a first computer system 101a (e.g., an electronic device) displaying, via a display generation component 120 (e.g., display generation components 1-122a and 1-122b of FIG. 1), a three-dimensional environment 900 from a viewpoint of a first user (e.g., first user 920 in overhead view of the three-dimensional environment 900) of the first computer system 101a (e.g., facing the back wall of the physical environment in which the first computer system 101a is located).

In some embodiments, the first computer system 101a includes a display generation component 120. In FIG. 9A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 9A, the first computer system 101a captures one or more images of the physical environment around the first computer system 101a (e.g., operating environment 100), including one or more objects and/or users in the physical environment around the first computer system 101a. In some embodiments, the first computer system 101a displays representations of the physical environment in three-dimensional environment 900. For example, three-dimensional environment 900 includes representations of the rear and side walls of the room in which the first computer system 101a is located and a representation of table 906 located in the room in which the first computer system 101a is located. Additionally, in some embodiments, as shown in FIG. 9A, the three-dimensional environment 900 includes a representation of a second user 922 who is located in the room in which the first computer system 101a is located. In some embodiments, as shown in FIG. 9A, the second user 922 is associated with second computer system 101b (e.g., worn on a head of the second user 922). In some embodiments, as similarly discussed herein, the representations of the physical environment, including the representations of the second user 922 and the second computer system 101b, are visible in the field of view of the first user 920 as passthrough. Additionally, in some embodiments, as indicated in the overhead view of the three-dimensional environment 900, the physical environment in which the first computer system 101a (e.g., and the first user 920) and the second computer system 101b (e.g., and the second user 922) are located includes two individual areas 944 and 946 (e.g., separate rooms or corridors). In FIG. 9A, the first computer system 101a (e.g., and the first user 920) and the second computer system 101b (e.g., and the second user 922) are optionally both located in the first area 944 of the physical environment, as indicated in the overhead view of the three-dimensional environment 900.

As discussed in more detail below, in FIG. 9A, display generation component 120 is illustrated as displaying content in the three-dimensional environment 900. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 9A-9O.

Display generation component 120 has a field of view (e.g., a field of view captured by external image sensors 114b and 114c and/or visible to the user via display generation component 120) that corresponds to the content shown in FIG. 9A. Because display generation component 120 is optionally a head-mounted device, the field of view of display generation component 120 is optionally the same as or similar to the field of view of the user. For example, the view of three-dimensional environment 900 depicts what is visible to the first user 920 (via display generation component 120) when the viewpoint of the first user 920 is located as shown in the overhead view of the three-dimensional environment 900 and the first computer system 101a is oriented in the direction indicated by the direction arrow emanating from the first computer system 101a in the overhead view of the three-dimensional environment 900. Similarly, in some embodiments, the second computer system 101b (e.g., associated with the second user 922) is oriented in the direction indicated by the direction arrow emanating from the second computer system 101b in the overhead view of the three-dimensional environment 900 in FIG. 9A.

As discussed herein, the first user 920 performs one or more air pinch gestures (e.g., with hand 903) to provide one or more inputs to the first computer system 101a to provide one or more user inputs directed to virtual objects displayed by the first computer system 101a. Such depiction is intended to be exemplary rather than limiting; the first user optionally provides user inputs using different air gestures and/or using other forms of input.

In the example of FIG. 9A, because the first user's hand 903 is within the field of view of display generation component 120, it is visible within the three-dimensional environment 900. That is, the first user can optionally see, in the three-dimensional environment 900, any portion of their own body that is within the field of view of display generation component 120.

As mentioned above, the first computer system 101a is configured to display content in the three-dimensional environment 900 using the display generation component 120. In FIG. 9A, three-dimensional environment 900 also includes a plurality of virtual objects. For example, as shown in FIG. 9A, the three-dimensional environment 900 includes virtual object 902 and people picker user interface 910, discussed below.

In some embodiments, the virtual object 902 is optionally a user interface of an application containing content. For example, in FIG. 9A, the virtual object 902 is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. Additionally, in some embodiments, as shown in FIG. 9A, the virtual object 902 is displayed with an exit option and a grabber bar 908. In some embodiments, the grabber bar 908 is selectable to initiate a process to move the virtual object 902 within the three-dimensional environment 900. In some embodiments, the virtual object 902 corresponds to an object that is private to the first user 920 (e.g., the virtual object 902 corresponds to a private application window) in the three-dimensional environment. In some embodiments, as described in more detail with reference to method 800, because the virtual object 902 is private to the first user 920, the virtual object 902 is not displayed in the three-dimensional environment of the second computer system 101b (e.g., and is therefore not visible to and/or interactive to the second user 922). In some embodiments, as illustrated in FIG. 9A, the virtual object 902 is displayed with pill 904 that indicates a status of the virtual object 902 (e.g., indicates that the virtual object 902 is private to the first user 920). Additional details regarding the pill 904 are provided with reference to method 800.

In some embodiments, as shown in FIG. 9A, the people picker user interface 910 includes a plurality of representations 915 of a plurality of users that is selectable to initiate a process to establish a (e.g., spatial or non-spatial) real-time communication session with a user corresponding to the selected representation. In some embodiments, the people picker user interface 910 is displayed in the three-dimensional environment 900 via interaction with home toolbar 912 in FIG. 9A. For example, in FIG. 9A, while the home toolbar 912 is displayed in the three-dimensional environment 900 (e.g., in response to detecting a press of a hardware control of the first computer system 101a), the first computer system 101a detects a selection of option 913b in the home toolbar 912 that causes the first computer system 101a to display the people picker user interface 910 in the three-dimensional environment 900. As shown in FIG. 9A, the home toolbar 912 also optionally includes option 913a that is selectable to display a plurality of icons corresponding to applications launchable at the first computer system 101a and option 913c that is selectable to display a plurality of virtual environments configured to be displayed in the three-dimensional environment 900. In some embodiments, the plurality of representations 915 of the plurality of users is displayed (e.g., included) in the people picker user interface 910 based on data provided by a contacts or phone application running on the first computer system 101a. In some embodiments, the plurality of representations 915 of the plurality of users is displayed in the people picker user interface 910 based on one or more user settings/preferences and/or activity (e.g., the plurality of users corresponds to favorited contacts, contacts recently and/or commonly interacted with, contacts of work colleagues, and the like). In some embodiments, the plurality of representations 915 of the plurality of users is displayed in the people picker user interface 910 based on proximity of the first computer system 101a to other computer systems associated with the plurality of users (e.g., a respective user of the plurality of users is within a threshold distance (e.g., 0.5, 0.75, 1, 2, 3, 5, 10, 15, 20, 40, and/or 100 meters) of the first user 920 and/or the first computer system 101a).

It should be understood that the content discussed above is exemplary and that, in some embodiments, additional and/or alternative content and/or user interfaces are provided in the three-dimensional environment 900, such as three-dimensional objects (e.g., virtual clocks, virtual balls, virtual cars, etc.) or any other element displayed by the first computer system 101a that is not included in the physical environment of display generation component 120.

In some embodiments, virtual object 902 is displayed in three-dimensional environment 900 with a respective orientation relative to a viewpoint of the first user 920 (e.g., prior to receiving input interacting with the virtual object, which will be described later, in three-dimensional environment 900). As shown in FIG. 9A, for example, the virtual object 902 has a first orientation in the three-dimensional environment 900 (e.g., the front-facing surface of the virtual object 902 is angled rightward relative to the viewpoint of the first user 920). It should be understood that the orientation of the virtual object 902 in FIG. 9A is merely exemplary and that other orientations are possible.

In some embodiments, the virtual object 902 is displayed in three-dimensional environment 900 at a respective location relative to the viewpoint of the first user 920 (e.g., prior to receiving input interacting with the virtual objects, which will be described later, in three-dimensional environment 900). As shown in FIG. 9A, for example, the virtual object 902 is optionally displayed at a first location in the three-dimensional environment 900 (e.g., at a location to the right of and farther than the people picker user interface 910 relative to the viewpoint of the first user 920, as indicated in the overhead view of the three-dimensional environment 900 in FIG. 9A). It should be understood that the initial location of the virtual object 902 in FIG. 9A is merely exemplary and that other locations are possible (e.g., based on object type, prior input directed to the virtual object 902 provided by the first user 920, and/or the application with which the virtual object 902 is associated).

In some embodiments, the first computer system 101a facilitates initiation of a real-time communication session with one or more other users in the three-dimensional environment 900. For example, as discussed in more detail below, the first computer system 101a is configured to establish a spatial or a non-spatial real-time communication session with one or more users, including collocated and non-collocated users, via the three-dimensional environment 900 (e.g., via virtual elements (e.g., user interfaces and/or avatars) displayed in the three-dimensional environment 900 when the real-time communication session is established). Additionally, in some embodiments, while the first user 920 is in a real-time communication session with a collocated user, the first computer system 101a selectively displays a spatial visual representation (e.g., an avatar) of the collocated user in the three-dimensional environment 900 based on the satisfaction of one or more criteria. Additional details of the above and below with respect to selectively displaying a spatial visual representation of a collocated user in the three-dimensional environment 900 while in a spatial real-time communication session are provided with reference to method 1000.

In FIG. 9A, the first computer system 101a detects an input corresponding to a request to initiate communication with a second user in the three-dimensional environment 900. Particularly, in FIG. 9A, the first computer system 101a detects an input corresponding to a request to initiate communication with “Lin” who corresponds to the second user 922 discussed above. For example, as shown in FIG. 9A, the first computer system 101a detects hand 903 of the first user 920 provide an air gesture, such as an air pinch gesture in which an index finger and thumb of the hand 903 of the first user 920 come together to make contact, while a gaze 925 of the first user 920 is directed to a first representation 915a of the plurality of representations 915 corresponding to Lin (e.g., the second user 922). In some embodiments, as shown in FIG. 9A, the first computer system 101a detects the hand 903 provide the air pinch gesture without detecting movement of the hand 903 in space.

In some embodiments, as shown in FIG. 9B, in response to detecting the input provided by hand 903 corresponding to the selection of the first representation 915a, the first computer system 101a displays contact user interface 926 for the second user 922 (e.g., Lin) in the three-dimensional environment 900. For example, as shown in FIG. 9B, the first computer system 101a replaces display of the people picker user interface 910 with the contact user interface 926 for the second user 922 in the three-dimensional environment 900. In some embodiments, as shown in FIG. 9B, the contact user interface 926 includes a plurality of interactive elements 927a-d for initiating communication between the first user 920 and the second user 922. For example, in FIG. 9B, the contact user interface 926 includes interactive element 927a that is selectable to initiate a spatial real-time communication session with the second user 922 (e.g., Lin), as discussed in more detail below. In some embodiments, the contact user interface 926 includes interactive element 927b that is selectable to initiate a non-spatial real-time communication session (e.g., by way of a video-conferencing user interface in the three-dimensional environment 900). In some embodiments, the contact user interface 926 includes interactive element 927c that is selectable to initiate a process to share content, such as the content of virtual object 902, with the second user 922 at the second computer system 101b. In some embodiments, the contact user interface 926 includes interactive element 927d that is selectable to cease display of the contact user interface 926 in the three-dimensional environment 900.

In FIG. 9B, while displaying the contact user interface 926 in the three-dimensional environment 900, the first computer system 101a detects a selection input directed to the interactive element 927b in the three-dimensional environment 900. For example, as shown in FIG. 9B, the first computer system 101a detects the hand 903 of the first user 920 perform an air pinch gesture, optionally while the gaze 925 of the first user 920 is directed to the interactive element 927b in the contact user interface 926.

In some embodiments, as shown in FIG. 9C, in response to detecting the selection of the interactive element 927b in the contact user interface 926, the first computer system 101a initiates communication with the second computer system 101b. Particularly, in FIG. 9C, the first computer system 101a sends an indication of a request to the second computer system 101b to enter a non-spatial real-time communication session with the first computer system 101a. In some embodiments, as shown in FIG. 9C, in accordance with a determination that the request is accepted by the second computer system 101b (e.g., via user input provided by the second user 922), the first computer system 101a and the second computer system 101b enter a non-spatial real-time communication session, as indicated by indication 935. It should be understood that the indication 935 is optionally not a displayed element in the three-dimensional environment 900 and is provided in the figures to provide a clear indication of the type of real-time communication session (e.g., spatial or non-spatial) the first computer system 101a (e.g., and the first user 920) is participating in.

In some embodiments, as shown in FIG. 9C, entering the non-spatial real-time communication session with the second computer system 101b includes displaying video conferencing user interface 930 in the three-dimensional environment 900. In some embodiments, as shown in FIG. 9C, the video conferencing user interface includes and/or corresponds to a non-spatial visual representation of the second user 922 (e.g., Lin). For example, as shown in FIG. 9C, the video conferencing user interface 930 is displayed as a virtual object in the three-dimensional environment 900 and includes and/or is displayed with a grabber bar 932, indicating that the video conferencing user interface 930 is movable (e.g., via the grabber bar 932) in the three-dimensional environment 900. In some embodiments, as shown in FIG. 9C, the video conferencing user interface 930 includes video 933a of the second user 922 (e.g., captured via internal image sensors of the second computer system 101b) and video 933b of the first user 920 (e.g., captured via internal image sensors 114a of the first computer system 101a)). Additionally, in some embodiments, the video conferencing user interface 930 includes a plurality of controls for controlling a plurality of functions associated with the non-spatial real-time communication session. For example, as shown in FIG. 9C, the video conferencing user interface 930 includes control 931a that is selectable to transition (e.g., upgrade) the non-spatial real-time communication session to a spatial real-time communication session, as discussed in more detail below. In some embodiments, the video conferencing user interface 930 includes control 931b that is selectable to toggle off/on the video 933b of the first user 920 (e.g., deactivate/activate the internal image sensors 114a), as shown in FIG. 9C. In some embodiments, as shown in FIG. 9C, the video conferencing user interface 930 includes control 931c that is selectable to toggle off/on audio of the first user 920 (e.g., verbal input) captured by the first computer system 101a (e.g., deactivate/activate one or more microphones of the first computer system 101a). Additionally, in some embodiments, as shown in FIG. 9C, the video conferencing user interface 930 includes control 931d that is selectable to cease display of the video conferencing user interface 930 and end the non-spatial real-time communication session between the first user 920 and the second user 922.

In FIG. 9C, while the video conferencing user interface 930 is displayed in the three-dimensional environment 900, the first computer system 101a detects an input corresponding to a request to move the video conferencing user interface 930 in the three-dimensional environment 900. For example, as shown in FIG. 9C, the first computer system 101a detects an air pinch gesture provided by the hand 903 of the first user 920, optionally while the gaze 925 of the first user 920 is directed to the grabber bar 932 of the video conferencing user interface 930 in the three-dimensional environment 900. Additionally, as shown in FIG. 9C, the first computer system 101a detects movement of the hand 903 of the first user 920 in space relative to the viewpoint of the first user 920. For example, as shown in FIG. 9C, the first computer system 101a detects the hand 903 move rightward relative to the viewpoint of the first user 920 while maintaining the pinch hand shape.

In some embodiments, as shown in FIG. 9D, in response to detecting the movement input directed to the video conferencing user interface 930, the first computer system 101a moves the video conferencing user interface 930 in accordance with the movement input. For example, as shown in FIG. 9D, the first computer system 101a moves the video conferencing user interface 930 rightward in the three-dimensional environment 900 relative to the viewpoint of the first user 920 in accordance with the rightward movement of the hand 903 in FIG. 9C. Additionally, as shown in FIG. 9D, the first computer system 101a optionally updates an orientation of the video conferencing user interface 930 (e.g., angles the front-facing surface of the video conferencing user interface 930) based on the updated location of the video conferencing user interface 930 in the three-dimensional environment 900 relative to the viewpoint of the first user 920. For example, the video conferencing user interface 930 is angled leftward relative to the viewpoint of the first user 920, such that the front-facing surface of the video conferencing user interface 930 continues to face toward the viewpoint of the first user 920 in the three-dimensional environment 900.

In FIG. 9D, the first computer system 101a detects an input corresponding to a request to transition the non-spatial real-time communication session between the first user 920 and the second user 922 to a spatial real-time communication session. For example, as shown in FIG. 9D, the first computer system 101a detects a selection input directed to the control 931a in the video conferencing user interface 930, such as an air pinch gesture provided by the hand 903, optionally while the gaze 925 of the first user 920 is directed to the control 931a in the three-dimensional environment 900.

In some embodiments, as shown in FIG. 9E, in response to detecting the selection of the control 931a in the video conferencing user interface 930, the first computer system 101a transitions (e.g., and/or initiates a process to transition) the non-spatial real-time communication session to a spatial real-time communication session. Particularly, in FIG. 9E, the first computer system 101a sends an indication of a request to the second computer system 101b to enter a spatial real-time communication session with the first computer system 101a. In some embodiments, as shown in FIG. 9E, in accordance with a determination that the request is accepted by the second computer system 101b (e.g., via user input provided by the second user 922), the first computer system 101a and the second computer system 101b enter a spatial real-time communication session, as indicated by indication 935.

In some embodiments, as shown in FIG. 9E, entering the spatial real-time communication session with the second user 922 includes ceasing display of the video conferencing user interface 930 in the three-dimensional environment 900. In some embodiments, after ceasing display of the video conferencing user interface 930, the first computer system 101a determines whether to display a spatial visual representation of the second user 922 in the three-dimensional environment 900. In some embodiments, the first computer system 101a displays a spatial visual representation of the second user 922 in the three-dimensional environment 900 in accordance with a determination that one or more criteria are satisfied. In some embodiments, the one or more criteria include a criterion that is not satisfied when the second user 922 (e.g., and the second computer system 101b) is located within the field of view of the first computer system 101a. In some embodiments, the one or more criteria include a criterion that is not satisfied when the second user 922 (e.g., and the first computer system 101a) is collocated with the first user 920 (e.g., and the first computer system 101a) in the physical environment, such as being within a threshold distance (e.g., 1, 2, 3, 5, 10, 15, 20, 30, or 40 meters) of each other. Additional examples and/or details of the one or more criteria are provided with reference to method 1000.

In FIG. 9E, the first computer system 101a determines that the one or more criteria are not satisfied. For example, as shown in FIG. 9E, the second user 922 is located within and is visible in the field of view of the first user 920 in the three-dimensional environment 900. Additionally, as another example, in the overhead view of the three-dimensional environment 900 in FIG. 9E, the second user 922 (e.g., and the second computer system 101b) is within threshold distance 945 of the first user 920 (e.g., and the first computer system 101a), such that the first user 920 and the second user 922 are collocated in the physical environment. Accordingly, because the one or more criteria are not satisfied, the first computer system 101a optionally forgoes displaying a spatial visual representation (e.g., an avatar) of the second user 922 in the three-dimensional environment 900, as shown in FIG. 9E.

In some embodiments, while the two users are participating in the spatial real-time communication session, the first user 920 and the second user 922 in the overhead view of the three-dimensional environment 900 correspond to positions (e.g., location and/or orientation) of the current viewpoints of the first user 920 and the second user 922 relative to the three-dimensional environment 900. In the example of FIG. 9E, the participants in the spatial real-time communication session are optionally not arranged according to a template (e.g., they are not arranged by the first computer system 101a), and are instead at respective locations within the three-dimensional environment that have been chosen by the respective participants, such as by the participants moving within the physical environment (e.g., as detected by their respective computer systems).

In some embodiments, while the first user 920 and the second user 922 are in the spatial real-time communication session, virtual elements in the three-dimensional environment 900 have a spatial arrangement that is based on positions of the virtual elements relative to the three-dimensional environment 900. For example, as illustrated by their corresponding positions in the overhead view of the three-dimensional environment 900 in FIG. 9E, the viewpoint of the first user 920, the viewpoint of the second user 922, and the virtual object 902 have a first spatial arrangement in the three-dimensional environment 900.

In FIG. 9E, the first computer system 101a detects an input provided by hand 903 corresponding to a selection of the second user 922 in the three-dimensional environment 900. For example, as shown in FIG. 9E, the first computer system 101a detects hand 903 provide an air pinch gesture while the gaze 925 of the first user 920 is directed to the second user 922 in the three-dimensional environment 900.

In some embodiments, as shown in FIG. 9F, in response to detecting the input provided by hand 903 corresponding to the selection of the second user 922, the first computer system 101a displays communication session user interface 940 in the three-dimensional environment 900. In some embodiments, the communication session user interface 940 includes a plurality of interactive elements 941a-d for controlling one or more functionalities of the spatial real-time communication session between the users. In some embodiments, interactive element 941a is an option that, when selected, initializes a video conferencing user interface in the three-dimensional environment 900 (e.g., similar to video conferencing user interface 930 discussed above, thereby returning the real-time communication session to a non-spatial real-time communication session as discussed above). In some embodiments, interactive element 941b is an option that, when selected, mutes the audio of the first user 920, as similarly discussed above. In some embodiments, interactive element 941c is an option that, when selected, initiates the sharing of content within the real-time communication session, as discussed below. In some embodiments, interactive element 941d is an option that, when selected, ends the communication session with the second user 922.

Additionally, in FIG. 9E, the communication session user interface 940 is associated with (e.g., is displayed with) a movement element 942. In this embodiment, movement element 942 corresponds to and/or is similar to a grabber bar as similarly discussed above with reference to the virtual object 902 and the video conferencing user interface 930. In this example, movement element 942 (e.g., the grabber bar) is displayed beneath the communication session user interface 940 from the viewpoint of the first user 920. In some embodiments, the movement element 942 is configured to be selectable to initiate the update of the spatial arrangement of virtual elements that are shared within the real-time communication session.

In some embodiments, while in the spatial real-time communication session, a participant of the spatial real-time communication session (e.g., first user 920) is able to share content with other participants in the spatial real-time communication session. For example, as previously discussed above, in FIG. 9F, the virtual object 902 corresponds to an object that is private to the first user 920 in the spatial real-time communication session. In some embodiments, because the virtual object 902 is private to the first user 920 in the spatial real-time communication session, the virtual object 902 is not displayed in the three-dimensional environment of the second computer system 101b (e.g., and is therefore not visible to and/or interactive to the second user 922).

In FIG. 9F, the first computer system 101a detects an input corresponding to a request to share the virtual object 902 with the second user 922 in the spatial real-time communication session. For example, as shown in FIG. 9F, while the communication session user interface 940 is displayed in the three-dimensional environment 900, the first computer system 101a detects an air pinch gesture provided by the hand 903, while the gaze 925 of the first user 920 is directed to the interactive element 941c in the three-dimensional environment 900.

In some embodiments, as shown in FIG. 9G, in response to detecting the selection of the interactive element 941c, the first computer system 101a shares the virtual object 902 with the second computer system 101b. In some embodiments, because the virtual object 902 now corresponds to a shared object in the real-time communication session, the second computer system 101b of the second user 922 displays the virtual object 902 in its respective three-dimensional environment. Accordingly, in some embodiments, the virtual object 902 is viewable by and/or interactive to the first user 920 and the second user 922 via their respective computer systems (e.g., including the first computer system 101a). Additionally, as shown in FIG. 9G, the first computer system 101a optionally updates the pill 904 of the virtual object 902 to indicate that the virtual object 902 has been shared with other participants (e.g., the second user 922) in the spatial real-time communication session.

In FIG. 9G, the first computer system 101a detects movement of the viewpoint of the first user 920 relative to the three-dimensional environment 900. For example, as shown in the overhead view of the three-dimensional environment 900, the first user 920 moves within the physical environment from the first area 944 to the second area 946, which causes the location of the first computer system 101a to also be updated in accordance with the movement of the first user 920.

In some embodiments, as shown in FIG. 9H, after detecting the movement of the viewpoint of the first user 920, the field of view of the first user 920 of the three-dimensional environment 900 is updated based on the updated viewpoint of the first user 920. For example, as shown in FIG. 9H, when the first user 920 moves to be positioned in the second area 946 of the physical environment, the three-dimensional environment 900 is updated to include representation of window 909 that is visible in the field of view of the first user from the updated viewpoint of the first user. In some embodiments, as shown in FIG. 9H, after the first user 920 moves to be positioned in the second area 946 of the physical environment, the second user 922 is no longer visible in the three-dimensional environment 900 from the current viewpoint of the first user 920. Additionally, as shown in the overhead view of the three-dimensional environment 900 in FIG. 9H, the first user 920 (e.g., and the first computer system 101a) is optionally located more than the threshold distance 945 from the second user 922 (e.g., and the second computer system 101b) when the first user 920 moves to the second area 946 in the physical environment.

In FIG. 9H, while the first user 920 is located in the second area 946 of the physical environment, the first computer system 101a detects an input corresponding to a request to reset (e.g., update) the spatial arrangement of the virtual elements of the spatial real-time communication session. For example, as shown in FIG. 9H, the first computer system 101a detects a press and/or click of button 939 of the first computer system 101a (e.g., provided by hand 903 of the first user 920).

In some embodiments, as shown in FIG. 9I, in response to detecting the press of the button 939 (e.g., the input corresponding to the request to reset the spatial arrangement of the virtual elements), the first computer system 101a resets the spatial arrangement of the virtual elements of the spatial real-time communication session relative to the updated viewpoint of the first user 920. For example, as shown in FIG. 9I, the first computer system 101a moves/redisplays the virtual object 902 in the three-dimensional environment 900 based on (e.g., relative to) the updated viewpoint of the first user 920 in the three-dimensional environment 900. Accordingly, as shown in the overhead view of the three-dimensional environment 900 in FIG. 9I, in response to detecting the press of the button 939 in FIG. 9H, the first computer system 101a moves/redisplays the virtual object 902 in the three-dimensional environment 900 corresponding to second area 946 in which the first user (e.g., and the first computer system 101a) is located. In some embodiments, when the virtual object 902 is redisplayed in the three-dimensional environment 900 relative to the updated viewpoint of the first computer system 101a, the virtual object 902 is displayed at a location and with an orientation corresponding to the previous location and orientation of the virtual object 902 prior to the first computer system 101a detecting the movement of the viewpoint of the first user 920. For example, in the overhead view of the three-dimensional environment 900 in FIG. 9I, the virtual object 902 is displayed at a location and with an orientation relative to the viewpoint of the first user 920 that correspond to the location and the orientation of the virtual object 902 relative to the viewpoint of the first user 920 in the overhead view of the three-dimensional environment 900 in FIG. 9G.

In some embodiments, while the first user 920 and the second user 922 are in the spatial real-time communication session, the input corresponding to the request to reset the spatial arrangement of the virtual elements (e.g., the press of the button 939) discussed above causes the first computer system 101a to display a visual representation of the second user 922 in accordance with the determination that the one or more criteria discussed previously above are satisfied. For example, as discussed previously above, when the first user 920 moves to the second area 946 of the physical environment, which causes the viewpoint of the first user 920 to be updated accordingly, the second user 922 is no longer in the field of view of the first user 920 in the three-dimensional environment 900 and/or the second user 922 (e.g., and the second computer system 101b) is more than the threshold distance 945 from the first user 920 (e.g., and the first computer system 101a), in FIG. 9H. Accordingly, when the first computer system 101a detects the press of the button 939 in FIG. 9I, the first computer system 101a determines that the one or more criteria are satisfied. Thus, as shown in FIG. 9I, when the first computer system 101a updates the spatial arrangement of the virtual object 902 relative to the updated viewpoint of the first user 920 in the three-dimensional environment 900, the first computer system 101a displays visual representation 917 (e.g., a spatial avatar) of the second user 922 in the three-dimensional environment 900.

In some embodiments, the first computer system 101a displays the visual representation 917 at a location and with an orientation in the three-dimensional environment 900 that is based on the location and the orientation of the second user 922 (e.g., and the second computer system 101b) in the physical environment. Additionally, as shown in the overhead view of the three-dimensional environment 900 in FIG. 9I, a spatial distribution of the visual representation 917 and the virtual object 902 (e.g., a relative distance between and/or order of the visual representation 917 and the virtual object 902) relative to the viewpoint of the first user 920 corresponds to the spatial distribution of the second user 922 and the virtual object 902 (e.g., a relative distance between and/or order of the second user 922 and the virtual object 902) relative to the viewpoint of the first user 920 in the overhead view of the three-dimensional environment 900 in FIG. 9G.

It should be noted that, in some embodiments, the first computer system 101a automatically displays the visual representation 917 in the three-dimensional environment 900 relative to the updated viewpoint of the first user 920 after detecting the movement of the viewpoint of the first user 920 discussed above. For example, as discussed above, the movement of the viewpoint of the first user 920 causes the one or more criteria to be satisfied, and accordingly, the first computer system 101a automatically displays the visual representation 917 in the three-dimensional environment 900 (e.g., without requiring the first user 920 to press the button 939 as discussed above).

In FIG. 9I, while displaying the visual representation 917 in the three-dimensional environment 900, the first computer system 101a detects an input corresponding to a selection of the visual representation 917. For example, as shown in FIG. 9I, the first computer system 101a detects an air pinch gesture provided by the hand 903 of the first user 920, while the gaze 925 is directed to the visual representation 917 in the three-dimensional environment 900.

In some embodiments, as shown in FIG. 9J, in response to detecting the selection of the visual representation 917, the first computer system 101a displays the communication session user interface 940 and the movement element 942 discussed previously above in the three-dimensional environment 900. In some embodiments, as similarly discussed above with reference to the display of the communication session user interface 940 and the movement element 942 in FIG. 9F, the communication session user interface 940 and the movement element 942 are displayed relative to the visual representation 917 in the three-dimensional environment 900 from the viewpoint of the first user 920. For example, as shown in the overhead view of the three-dimensional environment 900 in FIG. 9J, the communication session user interface 940 (e.g., and the movement element 942) are displayed in front of (e.g., and/or overlaid on) the visual representation 917 from the viewpoint of the first user 920.

In FIG. 9J, the first computer system 101a detects movement of the viewpoint of the first user 920 relative to the three-dimensional environment 900. For example, as shown in the overhead view of the three-dimensional environment 900, the first user 920 moves within the physical environment from the second area 946 to the first area 944, which causes the location of the first computer system 101a to also be updated in accordance with the movement of the first user 920.

In some embodiments, as shown in FIG. 9K, after detecting the movement of the viewpoint of the first user 920, the field of view of the first user 920 of the three-dimensional environment 900 is updated based on the updated viewpoint of the first user 920. For example, as shown in FIG. 9K, when the first user 920 moves to be positioned back in the first area 944 of the physical environment, the three-dimensional environment 900 is updated to once again include representations of the table 906 and the second user 922 that are visible in the field of view of the first user 920 from the updated viewpoint of the first user 920. In some embodiments, as shown in FIG. 9K, after the first user 920 moves to be positioned in the first area 944 of the physical environment, the second user 922 is once again visible in the three-dimensional environment 900 from the current viewpoint of the first user 920. Additionally, as shown in the overhead view of the three-dimensional environment 900 in FIG. 9K, the first user 920 (e.g., and the first computer system 101a) is optionally located within the threshold distance 945 of the second user 922 (e.g., and the second computer system 101b) when the first user 920 returns to the first area 944 in the physical environment.

In some embodiments, as similarly discussed above, when the first user 920 returns to the first area 944 of the physical environment, the one or more criteria discussed above cease to be satisfied (e.g., because the second user 922 is located in the field of view of the first user and/or the first user 920 and the second user 922 are within the threshold distance 945 of each other). Accordingly, as indicated in the overhead view of the three-dimensional environment 900 in FIG. 9K, the first computer system 101a ceases display of the visual representation 917 of the second user 922. For example, as shown in FIG. 9K, the first computer system 101a is no longer displaying (e.g., and does not move) the visual representation 917 in the three-dimensional environment 900 from the updated viewpoint of the first user 920 because the one or more criteria are no longer satisfied.

In FIG. 9K, the first computer system 101a detects movement of the viewpoint of the first user 920 relative to the three-dimensional environment 900. For example, as shown in the overhead view of the three-dimensional environment 900, the first user 920 moves within the physical environment from the first area 944 to the second area 946, which causes the location of the first computer system 101a to also be updated in accordance with the movement of the first user 920. Additionally, as shown in FIG. 9K, the second computer system 101b detects movement of the viewpoint of the second user 922 relative to the three-dimensional environment 900. For example, as shown in the overhead view of the three-dimensional environment 900, the second user 922 moves within the physical environment from the first area 944 to the second area 946, which causes the location of the second computer system 101b to also be updated in accordance with the movement of the second user 922.

In some embodiments, as shown in FIG. 9L, after detecting the movement of the viewpoint of the first user 920, the field of view of the first user 920 of the three-dimensional environment 900 is updated based on the updated viewpoint of the first user 920. For example, as shown in FIG. 9L, when the first user 920 moves to be positioned in the second area 946 of the physical environment, the three-dimensional environment 900 is updated to include representation of window 909 that is visible in the field of view of the first user 920 from the updated viewpoint of the first user 920 and the virtual object 902 that is visible in the field of view of the first user 920 from the updated viewpoint of the first user 920. Additionally, in some embodiments, as shown in FIG. 9L, after the first user 920 moves to be positioned in the second area 946 of the physical environment, because the second user 922 has also moved to be positioned in the second area 946 of the physical environment, the second user 922 remains visible in the three-dimensional environment 900 from the current viewpoint of the first user 920. Additionally, as shown in the overhead view of the three-dimensional environment 900 in FIG. 9H, the first user 920 (e.g., and the first computer system 101a) optionally remains within the threshold distance (e.g., not shown for brevity) of the second user 922 (e.g., and the second computer system 101b) when the first user 920 and the second user 922 move to the second area 946 in the physical environment. Accordingly, as similarly discussed above, the one or more criteria remain unsatisfied following the movement of the viewpoint of the first computer system 101a, which optionally causes the first computer system 101a to forgo displaying the visual representation 917 of the second user 922 discussed previously above in the three-dimensional environment 900.

From FIGS. 9L to 9M, the first computer system 101a detects a sequence of one or more inputs corresponding to a request to display the people picker user interface 910 discussed previously above with reference to FIG. 9A. For example, the first computer system 101a detects a press on the button 939 of the first computer system 101a discussed above, which causes the first computer system 101a to display home toolbar 912 in three-dimensional environment 900, optionally followed by a selection (e.g., via an air gesture) of the option 913b in the home toolbar 912, which causes the first computer system 101a to display the people picker user interface 910 as shown in FIG. 9M. As previously discussed above, the people picker user interface 910 optionally includes a plurality of representations 915 of a plurality of users that is selectable to initiate communication with a respective user corresponding to the selected representation. In some embodiments, as shown in FIG. 9M, because the first user 920 is in the spatial real-time communication session with the second user 922, the first representation 915a (e.g., corresponding to the second user 922) is displayed with a visual indication that indicates the second user 922 is in the spatial real-time communication session with the first user 920. For example, as shown in FIG. 9M, the first representation 915a is displayed with a checkmark affordance and/or is displayed with highlighting or other visual effect that indicates the second user 922 (e.g., Lin) is in the spatial real-time communication session with the first user 920.

In FIG. 9M, the first computer system 101a detects an input corresponding to a request to initiate communication with a third user. For example, as shown in FIG. 9M, while displaying the people picker user interface 910 in the three-dimensional environment 900, the first computer system 101a detects a selection of second representation 915b of the plurality of representations 915, such as via an air pinch gesture provided by the hand 903 while the gaze 925 is directed to the second representation 915b. In some embodiments, the selection of the second representation 915b corresponds to a request to initiate communication with Jane.

In some embodiments, as shown in FIG. 9N, in response to detecting the selection of the second representation 915b in the people picker user interface 910, the first computer system 101a displays contact user interface 950 for the third user (e.g., Jane) in the three-dimensional environment 900. For example, the first computer system 101a replaces display of the people picker user interface 910 with the contact user interface 950 in the three-dimensional environment 900. In some embodiments, the contact user interface 950 for the third user has one or more characteristics of the contact user interface 926 for the second user (e.g., Lin) discussed above with reference to FIG. 9B. For example, the contact user interface 950 includes a plurality of interactive elements 951a-d for initiating communication between the first user 920 and the third user (e.g., Jane) that corresponds to the plurality of interactive elements 927a-d discussed above with reference to FIG. 9B.

In FIG. 9N, while displaying the contact user interface 950 for the third user (e.g., Jane), the first computer system 101a detects a selection of interactive element 951a in the contact user interface 950. For example, as shown in FIG. 9N, the first computer system 101a detects an air pinch gesture provided by the hand 903 of the first user 920, while the gaze 925 is directed to the interactive element 951a in the three-dimensional environment 900. In some embodiments, as similarly discussed above with reference to FIG. 9B, the interactive element 951a is selectable to initiate spatial communication with the third user (e.g., Jane) in the three-dimensional environment 900.

In some embodiments, as shown in FIG. 9O, in response to detecting the selection of the interactive element 951a, the first computer system 101a enters a spatial real-time communication session with a third computer system that is associated with the third user (e.g., Jane). Particularly, in FIG. 9O, the first computer system 101a sends an indication of a request to the third computer system to add third user (e.g., Jane) to the spatial real-time communication session that includes the first user 920 and the second user 922. In some embodiments, as shown in FIG. 9O, in accordance with a determination that the request is accepted by the third computer system (e.g., via user input provided by the third user), the third computer system joins the spatial real-time communication session with the first computer system 101a and the second computer system 101b, as indicated by the indication 935.

In some embodiments, when the third user joins the spatial real-time communication session with the first user 920 and the second user 922, the first computer system 101a determines whether to display a spatial visual representation of the third user (e.g., Jane) in the three-dimensional environment 900. In some embodiments, as previously discussed herein, the first computer system 101a displays a spatial visual representation of the third user in the three-dimensional environment 900 in accordance with a determination that one or more second criteria are satisfied. In some embodiments, the one or more second criteria include a criterion that is not satisfied when the third user (e.g., and the third computer system) is located within the field of view of the first computer system 101a. In some embodiments, the one or more second criteria include a criterion that is not satisfied when the third user (e.g., and the third computer system) is collocated with the first user 920 (e.g., and the first computer system 101a) in the physical environment, such as being within a threshold distance (e.g., 1, 2, 3, 5, 10, 15, 20, 30, or 40 meters) of each other. Additional examples and/or details of the one or more criteria are provided with reference to method 1000.

In FIG. 9O, the first computer system 101a determines that the one or more second criteria are satisfied. For example, as shown in FIG. 9O, the third user is not located within and is not visible in the field of view of the first user 920 in the three-dimensional environment 900. Additionally, as another example, in the overhead view of the three-dimensional environment 900 in FIG. 9O, the third user (e.g., and the third computer system) is outside the threshold distance of the first user 920 (e.g., and the first computer system 101a), such that the first user 920 and the third user are non-collocated in the physical environment. Accordingly, because the one or more second criteria are satisfied, the first computer system 101a optionally displays a spatial visual representation 919 (e.g., an avatar) of the third user (e.g., Jane) in the three-dimensional environment 900, as shown in FIG. 9O. As shown in FIG. 9O, in some embodiments, the visual representation 919 of the third user is displayed in the three-dimensional environment 900 while the second user 922 (e.g., and the second computer system 101b) is visible in the field of view of the first user 920 in the three-dimensional environment 900 relative to the viewpoint of the first user 920.

FIG. 10 is a flowchart illustrating an exemplary method 1000 of facilitating initiation of a spatial real-time communication session with one or more users in a three-dimensional environment according to some embodiments of the disclosure. In some embodiments, the method 1000 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a first computer system (e.g., 101a in FIG. 9A) in communication with a display generation component (e.g., 120 in FIG. 9A) and one or more input devices (e.g., image sensors 114a-114c in FIG. 9A). For example, the first computer system is or includes an electronic device, such as a mobile device (e.g., a tablet, a smartphone, a media player, or a wearable device), or a computer. In some embodiments, the first computer system has one or more characteristics of the computer systems in method 800. In some embodiments, the display generation component has one or more characteristics of the display generation component in method 800. In some embodiments, the one or more input devices have one or more characteristics of the one or more input devices in method 800.

In some embodiments, while an environment (e.g., a three-dimensional environment) is visible via the display generation component, such as three-dimensional environment 900 in FIG. 9A, the first computer system detects (1002) a first indication of a request to initiate non-spatial communication with a second user, different from a first user of the first computer system, of a second computer system, different from the first computer system, such as selection of first representation 915a in FIG. 9A, followed by selection of interactive element 927b in FIG. 9B. In some embodiments, the environment is an extended reality (XR) environment, such as a virtual reality (VR) environment, a mixed reality (MR) environment, or an augmented reality (AR) environment. In some embodiments, the three-dimensional environment has one or more characteristics of the environment(s) in method 800. In some embodiments, the first computer system initiates and/or receives a request to join a non-spatial communication session with the second computer system. In some embodiments, the second computer system is within a threshold distance (e.g., 0.1, 0.5, 0.75, 1, 2, 3, 5, 10, 12, 15, 20, 25, 30, or 50 m) of the first computer system when the first indication is detected. In some embodiments, when the first indication is detected, the second computer system is located in a same physical environment of the first computer system. For example, the second user is in a same or nearby room or space as the first user. In some embodiments, when the first indication is detected, the second user is in a field of view of the first user in the environment (e.g., and/or vice versa). In some embodiments, the second computer system is outside of the threshold distance of the first computer system when the first indication is detected. In some embodiments, the first indication of the request to initiate non-spatial communication with the second user corresponds to a request to initiate a phone call with the second user. For example, the first computer system or the second computer system detects an input (e.g., provided by the first user or the second user) directed to a user interface of a phone calling application (e.g., a contact card of the second user or the first user) corresponding to a request to call the second user or the first user (e.g., selection of a call button in the user interface). In some embodiments, the first indication of the request to initiate non-spatial communication with the second user corresponds to a request to initiate a video call with the second user. For example, the first computer system or the second computer system detects an input (e.g., provide by the first user or the second user) directed to a user interface of a video conferencing application (e.g., a contact card of the second user or the first user) corresponding to a request to initiate a video conference with the second user or the first user (e.g., selection of a video call button in the user interface). In some embodiments, the first indication includes input directed to a suggested users user interface displayed at the first computer system (or the second computer system). For example, the suggested users user interface includes visual indications (e.g., images, icons, and/or other representations) of users and/or computer systems who are proximate to the first computer system, such as the second user if the second user is within the threshold distance of the first user (e.g., and therefore the first computer system). In some embodiments, the suggested users user interface is displayed in the three-dimensional environment in response to detecting a respective input corresponding to a request to display the suggested users user interface. For example, prior to detecting the first indication, the first computer system detects an input provided by the first user corresponding to a selection of a respective option or physical button that is selectable to display the suggested users user interface. In some embodiments, in response to detecting the input provided by the first user, the first computer system displays the suggested users user interface that includes the visual indications of users overlaid on the physical environment that is visible in the three-dimensional environment. In some embodiments, the first indication includes a selection of a visual indication of the second user within the suggested users user interface (e.g., if the second user is proximate to the first user).

In some embodiments, as discussed in more detail below, non-spatial communication includes communication in which the first user and other participants (e.g., the second user) do not share a common virtual space, such as three-dimensional environment 900 being uncommon to second user 922 in FIG. 9C. For example, the participants are not represented by virtual avatars (or similar representations) in the three-dimensional environment, wherein the virtual avatars provide the first user of the first computer system with visual indications of the locations and/or orientations of the participants within the virtual space shared among the participants. In some embodiments, as mentioned above, the first indication includes input provided by the first user or the second user. For example, the first indication corresponds to a selection of a virtual button displayed in a user interface in the environment, such as via an air pinch gesture (e.g., in which the index finger and thumb of the user come together to form a pinch hand shape in space), an air tap gesture, a voice command, and/or selection of a physical button on a hardware input device (e.g., a controller, touchpad, mouse, and/or keyboard). In some embodiments, the input includes attention (e.g., including gaze) of the first user or the second user directed toward a respective element in the environment for initiating the non-spatial communication with the second user. In other embodiments, when the real-time communication session is initiated, the first user (or the second user) selects an option to conduct the communication session as a non-spatial communication session as opposed to a spatial communication session. In some embodiments, the input corresponding to the first indication has one or more characteristics of inputs discussed with reference to method 800.

In some embodiments, in response to detecting the first indication, the first computer system enters (1004) a non-spatial real-time communication session with the second user, as indicated by indication 935 in FIG. 9C, including displaying, via the display generation component, a first object corresponding to a non-spatial representation of the second user in the environment (e.g., video conferencing user interface 930 that includes video 933a of the second user 922 in FIG. 9C). In some embodiments, the non-spatial communication session is a real-time (e.g., or nearly real-time) communication session that includes audio (e.g., real-time voice audio from the first user and/or the second user) and/or video (e.g., real-time video of the environment of the first user and/or second user). For example, the first computer system displays the first object via which to visually and/or audibly communicate with the second user in the three-dimensional environment in response to detecting the first indication. In some embodiments, the first object is displayed as a virtual object (e.g., a non-spatial window) that includes a two-dimensional rendering of the second user based on image data captured by sensors in an environment of the second user, such as one or more cameras of the second computer system. For example, the two-dimensional rendering of the second user corresponds to a photograph, cartoon, sketch, or other still image selected by the second user or corresponds to a (e.g., live) video feed of the second user. In some embodiments, the two-dimensional rendering of the second object corresponds to a two-dimensional animated representation of the second user (e.g., a two-dimensional avatar rather than a three-dimensional avatar as discussed above). Additionally, in some embodiments, the first object is or includes a non-spatial communication interface (e.g., a virtual video panel that includes a two-dimensional rendering of the second user) via which to communicate with the second user (e.g., in lieu of a virtual avatar, as discussed in more detail below). Accordingly, in some embodiments, the first object (e.g., the non-spatial communication interface) serves as a visual indication that the first user and the second user are engaging in a non-spatial communication session. In some embodiments, as discussed in more detail below, the first object includes one or more selectable options for controlling the non-spatial communication with the second user. For example, the non-spatial communication interface included in the first object includes one or more options for ending the non-spatial communication with the second user, adding another participant (e.g., a third user) to the non-spatial real-time communication session, initiating spatial communication with the second user (e.g., transitioning the non-spatial real-time communication session to a spatial real-time communication session), and/or muting verbal input provided by the first user (e.g., deactivating the microphone of the first computer system). In some embodiments, the first object is configured to be movable and/or repositioned in the environment as other virtual objects are, such as application windows including other user interfaces and/or content, three-dimensional models or shapes, images, and/or other content displayed in the environment. In some embodiments, the first object is displayed at a predetermined location in the environment (e.g., selected automatically by the first computer system), optionally independent of a location of the second user in the environment. For example, the first object is displayed at a predetermined distance from a viewpoint of the first user and/or with a predetermined orientation (e.g., facing toward the viewpoint of the first user), rather than based on the location of the second user relative to the viewpoint of the first user.

In some embodiments, while displaying the first object in the environment, the first computer system detects (1006) a second indication of a request to transition the non-spatial real-time communication session to a spatial real-time communication session, such as selection of control 931a in the video conferencing user interface 930 as shown in FIG. 9D. For example, the first computer system initiates and/or receives a request to transition the non-spatial communication session with the second computer system to a spatial communication session. In some embodiments, the second indication corresponds to user input detected by the first computer system. In some embodiments, the first computer system detects input provided by the first user that is directed to the first object discussed above. For example, as mentioned above, the first object is or includes a non-spatial communication interface that includes a two-dimensional representation of the second user and one or more controls for controlling the non-spatial communication with the second user. In some embodiments, the one or more controls includes a respective option that is selectable to initiate a process to transition the non-spatial communication session with the second user to a spatial communication session. Accordingly, in some embodiments, detecting the second indication includes detecting a selection of the respective option in the first object. Alternatively, in some embodiments, the second indication includes input directed to a different user interface in the environment, such as a settings user interface of the first computer system or the suggested users user interface discussed above.

In some embodiments, in response to detecting the second indication, the first computer system enters (1008) a spatial real-time communication session with the second user, as indicated by indication 935 in FIG. 9E. In some embodiments, the communication session is a real-time (e.g., or nearly real-time) communication session that includes audio (e.g., real-time voice audio from the first user and/or the second user, and/or audio content from media shared between the first user and the second user), video (e.g., real-time video of the environment of the first user and/or second user, and/or video content from media shared between the first user and the second user) and/or other shared content (e.g., images, applications, and/or interactive media (e.g., video game media)). In some embodiments, in response to initiating and/or receiving the request to join the spatial communication session, the first and/or second computer systems initiate display of a shared three-dimensional environment to facilitate communication between the first user of the first computer system and the second user of the second computer system. In some embodiments, entering the spatial real-time communication session includes establishing a shared virtual space (e.g., in the form of a shared three-dimensional environment) in which media and other content is able to be shared between the first user and the second user. For example, content that is shared between the first user and the second user corresponds to content that is viewable to and/or interactive to the first user and the second user via their respective computer systems in the shared three-dimensional environment. In some embodiments, while the first user and the second user are in the spatial real-time communication session, the first user and the second user have unique viewpoints in the shared three-dimensional environment determined based on the locations of the first computer system and the second computer system, respectively, relative to the three-dimensional environment. In some embodiments, the spatial real-time communication session has one or more characteristics of the real-time communication session discussed with reference to method 800.

In some embodiments, in accordance with a determination that one or more criteria are not satisfied, the first computer system ceases (1010) display of the first object in the environment, such as ceasing display of the video conferencing user interface 930 in FIG. 9E, and displays (1014), via the display generation component, a first spatial visual representation of the second user in the environment (e.g., visual representation 917 of the second user 922 in FIG. 9I). For example, the first computer system replaces display of the non-spatial communication interface with the first spatial visual representation of the second user in the three-dimensional environment. In some embodiments, the one or more criteria include a criterion that is satisfied if, when the second indication is detected, the second computer system is within (e.g., still within) the threshold distance of the first computer system. For example, if the second computer system was not within the threshold distance of the first computer system when the first indication is detected, but is moved to within the threshold distance of the first computer system (e.g., by the second user) when the second indication is detected, the one or more criteria are satisfied. In some embodiments, the one or more criteria include a criterion that is satisfied if, when the second indication is detected, the second user is within the field of view of the first user in the environment (e.g., the second user is visible to the first user from the viewpoint of the first user, optionally independent of whether the second computer system is within the threshold distance of the first computer system). Accordingly, the one or more criteria are optionally not satisfied in accordance with a determination that the second computer system is more than the threshold distance of the first computer system and/or the second user is outside of the field of view of the first user (e.g., the second user and the second computer system are located in and/or have moved to a different room or physical space) when the second indication is detected. In some embodiments, the first spatial visual representation of the second user corresponds to a virtual avatar. In some embodiments, the first spatial visual representation visually provides the first user of the first computer system with an indication of a location and/or orientation of the second user in the virtual space within the spatial communication session relative to the viewpoint of the first user, whereas the first object (e.g., the non-spatial representation of the second user) does not visually provide the first user of the first computer system with an indication of a location and/or orientation of the second user in the virtual space relative to the viewpoint of the first user. Additionally, as opposed to the first object, the first spatial visual representation of the second user is, in certain instances, not able to be movable and/or repositioned in the environment as other virtual objects are. For example, movement input directed to the first spatial visual representation of the second user does not cause the first computer system to move the first spatial visual representation of the second user relative to other virtual objects (e.g., virtual windows, as previously discussed above) that are shared and displayed in the virtual space within the spatial communication session. In some embodiments, the first spatial visual representation has one or more characteristics of the visual representations in method 800.

In some embodiments, in accordance with a determination that the one or more criteria are satisfied, the first computer system ceases (1016) display of the first object in the environment, such as ceasing display of the video conferencing user interface 930 in FIG. 9E, without displaying the first spatial visual representation of the second user in the environment, such as the visual representation 917 not being displayed as shown in FIG. 9E. For example, the one or more criteria are satisfied in accordance with a determination that the second computer system is within (e.g., remains within) the threshold distance of the first computer system and/or the second user is within (e.g., still within) the field of view of the first user (e.g., the second user and the second computer system are still located in or have moved to the same room or physical space as the first computer system) when the second indication is detected. In some embodiments, because the second user is within the field of view of the first user and/or is otherwise proximate to the first user of the first computer system, the first computer system forgoes displaying a virtual avatar of the second user in the three-dimensional environment, which could provide a duplicate and/or conflicting indication of the location of the second user relative to the viewpoint of the first user. For example, the second user is visible from the viewpoint of the first user when entering the spatial communication session with the second user, negating the need to represent the second user spatially in the environment as a virtual avatar. Thus, in either of the above instances, ceasing display of the first object (e.g., the non-spatial communication interface) optionally serves as a visual indication that the first user and the second user are now engaging in a spatial real-time communication session. Displaying a spatial visual representation of a second user in the three-dimensional environment when a first user enters a spatial communication session with the second user based on whether one or more criteria are not satisfied helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, detecting the first indication of the request to initiate non-spatial communication with the second user of the second computer system includes detecting, via the one or more input devices, a sequence of one or more inputs directed to a representation of the second user (e.g., an image of the second user, a photograph of the second user, a cartoon representation of the second user, or an icon or other sketch representing the second user), different from the first spatial visual representation of the second user, displayed among a plurality of representations of users other than the first user of the first computer system in the environment, such as the selection of the first representation 915a of plurality of representations 915 in people picker user interface 910 in FIG. 9A. For example, as similarly discussed above, the first computer system detects user input directed to a suggested users user interface displayed in the three-dimensional environment. In some embodiments, the suggested users user interface includes a plurality of representations of a plurality of users that are associated with a communication application (e.g., a messaging application, a phone application, and/or an email application) operating via the computer system, as described above. In some embodiments, the second user is a contact of the communication application. Additionally or alternatively, in some embodiments, the plurality of representations of users are included in the suggested users user interface in the three-dimensional environment based on proximity of the users (e.g., computer systems or other electronic devices associated with the users) to the first computer system. For example, the first computer system includes a representation of a respective user in the plurality of representations of the users in the three-dimensional environment in accordance with a determination that a respective computer system associated with the respective user is within a threshold distance (e.g., 0.1, 0.5, 0.75, 1, 2, 3, 5, 10, 12, 15, 20, 25, 30, or 50 m) of the first computer system when the suggested users user interface is displayed. In some embodiments, the plurality of representations of the users are included in the suggested users user interface in the three-dimensional environment in accordance with a determination that the users correspond to “favorite” or similar recommended contacts for the first user (e.g., recommended based on recency of communication, frequency of communication, and/or other user activity). In some embodiments, the sequence of one or more inputs includes a selection of the representation of the second user in the three-dimensional environment. For example, the first computer system detects an air pinch gesture (e.g., as similarly discussed above) while the gaze of the first user is directed to the representation of the second user in the three-dimensional environment. In some embodiments, in response to detecting the selection of the representation of the second user, the first computer system displays one or more user interface elements (e.g., selectable options and/or a visual indication of a name or other identifier associated with the second user) associated with initiating communication with the second user in the three-dimensional environment (e.g., in a contact card user interface in the three-dimensional environment). For example, the first computer system displays a selectable option for initiating non-spatial communication with the second user (e.g., a selectable option to initiate a phone call with the second user and/or a selectable option for initiating a video call with the second user), as well as a selectable option for initiating spatial communication with the second user in the three-dimensional environment (e.g., overlaid on the representation of the second user, displayed below or above the representation of the second user, or otherwise displayed adjacent to the representation of the second user from the viewpoint of the first user). In some embodiments, the sequence of the one or more inputs includes, while the one or more user interface elements discussed above are displayed, a second selection input that is directed toward the selectable option that is selectable to initiate the non-spatial communication with the second user, as similarly discussed above. In some embodiments, the first user of the first computer system is able to initiate communication with any of a plurality of users via their respective representations that are displayed in the three-dimensional environment in the manner discussed above. Displaying a spatial visual representation of a second user in the three-dimensional environment when a first user enters a spatial communication session with the second user via a suggested users user interface based on whether one or more criteria are not satisfied helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, the one or more criteria include a criterion that is satisfied when the second computer system is within a threshold distance (e.g., 0.1, 0.5, 0.75, 1, 2, 3, 5, 10, 12, 15, 20, 25, 30, or 50 m) of the first computer system (e.g., as similarly discussed above), such as threshold distance 945 in overhead view of the three-dimensional environment 900 in FIG. 9E, and the first computer system determines whether the second computer system is within the threshold distance of the first computer system based on data obtained via one or more sensors of the first computer system (e.g., via the one or more input devices, such as similarly discussed with reference to method 800), such as images captured via external image sensors 114b-114c in FIG. 9E. Displaying a spatial visual representation of a second user in the three-dimensional environment when a first user enters a spatial communication session with the second user based on whether the second user is within a threshold distance of the first user helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, while in the spatial real-time communication session and while displaying the first spatial visual representation of the second user in the environment in accordance with the determination that the one or more criteria are not satisfied (e.g., after detecting the second indication discussed above), the first computer system detects, via the one or more input devices, a selection input directed to the first spatial visual representation of the second user, such as the selection of the visual representation 917 of the second user 922 shown in FIG. 9I. For example, the first computer system detects an air gesture (e.g., an air pinch gesture, an air tap gesture, or other gesture) performed by a hand of the first user, optionally while the gaze of the first user is directed to the first spatial visual representation of the second user, as similarly discussed above. In some embodiments, the second computer system is more than the threshold distance (e.g., discussed above) from the first computer system and/or the second user is not in the field of view of the first user in the three-dimensional environment when the selection input is detected.

In some embodiments, in response to detecting the selection input, the first computer system displays, via the display generation component, a communication session user interface (e.g., communication session user interface 940 in FIG. 9J) relative to the first spatial visual representation of the second user in the environment from a viewpoint of the first user. For example, in response to detecting the selection input, the first computer system displays a communication session interface including a movement element concurrently with the first spatial visual representation of the second user in the three-dimensional environment from the viewpoint of the first user. In some embodiments, the communication session user interface includes one or more virtual buttons for controlling one or more aspects of the spatial communication session. In some embodiments, the one or more virtual buttons are not displayed in the three-dimensional environment before detecting the selection input. In some embodiments, the one or more standalone buttons include a video conferencing button, a mute button configured to mute the first user, an exit button, and a screenshare button configured to share media content from the first computer system at the second computer system (e.g., in the communication session). In some embodiments, the communication session user interface and/or the movement element are displayed overlaid on the first visual representation of the second user or otherwise in front of the first visual representation of the second user from the viewpoint of the first user, and/or in proximity to (e.g., arranged adjacent to a border of) any media content shared between the first user and the second user in the three-dimensional environment (e.g., in the communication session). In some embodiments, the communication session user interface is different from the suggested users user interface discussed previously above. In some embodiments, the movement element allows the first user to interact with the first spatial visual representation. For instance, the first spatial visual representation is associated with (e.g., via proximity) the movement element (e.g., a grabber bar), such that, when/if the movement element is selected by the first user (for instance by applying an air gesture such as an air pinch to the movement element while directing their gaze to the movement element), the movement causes the first computer system to move virtual objects (e.g., including the first spatial visual representation and any shared virtual content) to various locations within the three-dimensional environment. In certain embodiments, the movement element is displayed as a grabber bar positioned below the communication session user interface. Displaying a communication session user interface in response to detecting a selection of a visual representation of a second user in the three-dimensional environment reduces the number of inputs needed to control the spatial communication session and/or facilitates discovery that aspatial arrangement of the virtual elements in the real-time communication session are able to be manipulated in real-time, thereby improving the overall user experience during the real-time communication session, and helps avoid erroneous user input related to updating the spatial arrangement of the virtual elements.

In some embodiments, while in the spatial real-time communication session and while the second user is visible, via the display generation component, in the environment from a viewpoint of the first user in accordance with the determination that the one or more criteria are satisfied (e.g., after detecting the second indication discussed above), the first computer system detects, via the one or more input devices, a selection input directed to the second user, such as the selection of the second user 922 shown in FIG. 9E. For example, the first computer system detects an air gesture (e.g., an air pinch gesture, an air tap gesture, or other gesture) performed by a hand of the first user, optionally while the gaze of the first user is directed to the second user that is visible in passthrough in the three-dimensional environment, as similarly discussed above. In some embodiments, the second computer system is within the threshold distance (e.g., discussed above) from the first computer system and/or the second user is in the field of view of the first user in the three-dimensional environment when the selection input is detected. Additionally, in some embodiments, the first spatial visual representation of the second user is not displayed in the environment when the selection input is detected (e.g., because the one or more criteria are satisfied as discussed previously above).

In some embodiments, in response to detecting the selection input, the first computer system displays, via the display generation component, a communication session user interface (e.g., communication session user interface 940 shown in FIG. 9F) relative to the second user in the environment from the viewpoint of the first user (e.g., as similarly discussed above). In some embodiments, as similarly discussed above, the communication session user interface is displayed at a location in the three-dimensional environment that is based on the location of the second user in the three-dimensional environment. For example, the first computer system displays the communication session user interface overlaid on the second user or otherwise in front of the second user from the viewpoint of the first user, and/or in proximity to (e.g., arranged adjacent to a border of) any media content shared between the first user and the second user in the three-dimensional environment (e.g., in the communication session). In some embodiments, the communication session user interface is different from the suggested users user interface discussed previously above. Displaying a communication session user interface in response to detecting a selection of a second user in the three-dimensional environment reduces the number of inputs needed to control the spatial communication session and/or facilitates discovery that a spatial arrangement of the virtual elements in the real-time communication session are able to be manipulated in real-time, thereby improving the overall user experience during the real-time communication session, and helps avoid erroneous user input related to updating the spatial arrangement of the virtual elements.

In some embodiments, while in the spatial real-time communication session and while the second user is visible, via the display generation component, in the environment from a viewpoint of the first user in accordance with the determination that the one or more criteria are satisfied (e.g., after detecting the second indication discussed above), the first computer system detects, via the one or more input devices, a change in a location of the second user relative to the viewpoint of the first user in the environment, such as movement of the first user 920 as indicated by arrow 971 in the overhead view of the three-dimensional environment 900 in FIG. 9G. In some embodiments, the change in the location of the second user relative to the viewpoint of the first user in the environment is caused by movement of the second user in the physical environment. For example, the first computer system detects, via the one or more input devices, movement of the second user (e.g., the second computer system) that causes the second user to be located at a different location in the three-dimensional environment relative to the viewpoint of the first user. In some embodiments, the change in the location of the second user relative to the viewpoint of the first user in the environment is caused by movement of the viewpoint of the first user relative to the environment. For example, the first computer system detects, via the one or more input devices, movement of the first user in the physical environment, which causes the first computer system to also be moved in the physical environment, thereby changing the viewpoint of the first user relative to the three-dimensional environment and thus the location of the second user relative to the updated viewpoint of the first user. In some embodiments, the second computer system is within the threshold distance (e.g., discussed above) from the first computer system and/or the second user is in the field of view of the first user in the three-dimensional environment when the change in the location of the second user relative to the viewpoint of the first user is detected.

In some embodiments, in response to detecting the change in the location of the second user, in accordance with a determination that one or more second criteria are satisfied, including a criterion that is satisfied when the change in the location of the second user causes the one or more criteria to no longer be satisfied while in the real-time spatial communication session with the second computer system, such as the second user 922 no longer being in the field of view of the first user 920 as shown in FIG. 9H, the first computer system displays, via the display generation component, the first visual representation of the second user in the environment (e.g., the visual representation 917 in FIG. 9I). For example, as similarly discussed above, if the movement of the second user and/or the movement of the viewpoint of the first user causes the second user to no longer be visible in the first user's field of view and/or the first computer system to be more than the threshold distance above from the second computer system, the first computer system displays a virtual avatar of the second user in the three-dimensional environment. In some embodiments, in accordance with a determination that the change in the location of the second user does not cause the second user to no longer be visible in the environment form the viewpoint of the first user (e.g., the second user remains visible in passthrough from the viewpoint of the first user), the first computer system forgoes displaying the first visual representation of the second user in the environment. Displaying a spatial visual representation of a second user in the three-dimensional environment in response to detecting a change in a location of the second user relative to the viewpoint of a first user based on whether one or more criteria are not satisfied helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, the one or more second criteria include a criterion that is satisfied in accordance with a determination that, after detecting the change in the location of the second user relative to the viewpoint of the first user in the environment, an input corresponding to a request to update a spatial arrangement of one or more virtual objects relative to the viewpoint of the first user is detected, such as detecting selection of button 939 corresponding to a request to update a spatial arrangement of virtual object 902 relative to the viewpoint of the first user 920 as shown in FIG. 9H. In some embodiments, the input corresponds to a request to update a spatial arrangement of one or more virtual objects relative to the current viewpoint in accordance with a specified range of distances and/or a range of orientations of the one or more virtual objects relative to the current viewpoint of the user, such as a “recentering” input. In some embodiments, the input corresponding to the request to update the spatial arrangement of the one or more virtual objects relative to the viewpoint of the first user includes interaction with a hardware button (e.g., physical control or dial) of the first computer system for requesting the update of the spatial arrangement, such as a press, click, and/or rotation of the hardware button. In some embodiments, the input corresponding to the request to update the spatial arrangement of the one or more virtual objects relative to the viewpoint of the first user includes interaction with a virtual button displayed in the three-dimensional environment for requesting the update of the spatial arrangement. In some embodiments, the request to update the spatial arrangement of the one or more virtual objects relative to the viewpoint of the first user corresponds to a request to update a spatial arrangement of (e.g., to move) shared content (e.g., virtual objects that are shared between the first user and the second user in the communication session) that is displayed in the three-dimensional environment. In some embodiments, when the first computer system detects the input discussed above, the viewpoint of the user of the computer system has moved relative to the second user in the three-dimensional environment (e.g., such that the first user and the second user (e.g., and/or any shared content) have a respective spatial arrangement in the three-dimensional environment), which, in response to detecting the input, causes an updated spatial arrangement to be displayed relative to the updated viewpoint of the first user. In some embodiments, detecting the input corresponding to the request to update the spatial arrangement of the one or more virtual objects relative to the viewpoint of the first user fails to cause the one or more second criteria to be satisfied so long as the second user is not visible in the first user's field of view and/or the second computer system is more than the threshold distance from the viewpoint of the first user in the three-dimensional environment after detecting the movement of the second user and/or the movement of the viewpoint of the first user. Accordingly, if the first computer system detects the input corresponding to the request to update the spatial arrangement of the one or more virtual objects relative to the viewpoint of the first user while the second user is still in the field of view of the first user and/or the second computer system is still within the threshold distance of the first computer system after detecting the movement of the second user and/or the movement of the viewpoint of the first user, the first computer system forgoes displaying the first visual representation of the second user in the three-dimensional environment. In some embodiments, in response to detecting the input corresponding to the request to update the spatial arrangement of the one or more virtual objects relative to the viewpoint of the first user (e.g., independent of whether the second user is in the field of view of the first user and/or the second computer system is within the threshold distance of the first computer system), the first computer system updates an arrangement of the one or more virtual objects in the three-dimensional environment (optionally the spatial arrangement of the objects changes relative to the viewpoint of the user, but the spatial arrangement of the objects relative to each other does not change). For example, if the environment includes one or more virtual objects as discussed above, the first computer system optionally redefines respective position(s) and orientation(s) of the one or more virtual objects relative to the current viewpoint—corresponding to an updated spatial arrangement—in response to the input discussed above. In some embodiments, the updated spatial arrangement includes a modified arrangement (e.g., positions and/or orientations) of the one or more virtual objects relative to the current viewpoint compared to an initial spatial arrangement. In some embodiments, respective virtual objects are made visible (e.g., are displayed) when the one or more virtual objects are displayed with the updated spatial arrangement because such objects are moved in response to the recentering input. For example, the updated spatial arrangement optionally includes displaying and/or positioning the one or more virtual objects at one or more respective positions at least partially surrounding the current viewpoint, such that respective objects are optionally positioned at a fixed distance or a predetermined distance relative to the current viewpoint (e.g., based on and/or the same as the distance of the virtual objects relative to the current viewpoint while at the initial spatial arrangement). In some embodiments, if the environment does not include any virtual objects when the recentering input discussed above is detected, the first computer system selectively displays the first visual representation of the second user in the manner discussed above. Displaying a spatial visual representation of a second user in the three-dimensional environment in response to detecting an input corresponding to a request to update a spatial arrangement of the second user after detecting a change in a location of the second user relative to the viewpoint of a first user helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, the determination that the one or more second criteria are satisfied (e.g., the determination that the change in the location of the second user causes the one or more criteria to no longer be satisfied) while in the real-time spatial communication session with the second computer system is in accordance with a determination that the change in the location of the second user causes the first user (e.g., and/or the first computer system) and the second user (e.g., and/or the second computer system) to no longer be located in a same physical room in the environment, such as the second user 922 and the first user 920 being located in different areas 944 and 946 as indicated in the overhead view of the three-dimensional environment 900 in FIG. 9H. For example, the one or more criteria cease to be satisfied if the movement of the second user (e.g., and the second computer system) and/or the movement of the viewpoint of the first user causes the first computer system and the second computer system to be located in different physical rooms of the physical environment. In some embodiments, the determination that the first computer system and the second computer system are located in different rooms is in accordance with a determination that a physical wall, door, window, or other partition is physically dividing the first computer system and the second computer system. In some embodiments, the determination that the first user (e.g., and the first computer system) and the second user (e.g., and the second computer system) are located in different rooms is in accordance with a determination that the second user (e.g., and the second computer system) is no longer visible in the first user's field of view and/or that the second computer system is more than the threshold distance from the first computer system in the three-dimensional environment. Displaying a spatial visual representation of a second user in the three-dimensional environment in response to detecting a change in a location of the second user relative to the viewpoint of a first user based on whether the change in the location of the second user causes the first user and the second user to no longer be located in a same physical room helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, while displaying the first visual representation of the second user in the environment in accordance with the determination that the one or more second criteria are satisfied (e.g., because the change in the location of the second user causes the one or more criteria to no longer be satisfied) while in the real-time spatial communication session with the second computer system in response to detecting the change in the location of the second user, the first computer system detects, via the one or more input devices, a second change in the location of the second user relative to the viewpoint of the first user, such as the movement of the first user 920 from second area 946 back to first area 944 as shown in the overhead view of the three-dimensional environment 900 in FIG. 9J. For example, as similarly discussed above, after displaying the first visual representation of the second user in the three-dimensional environment the first computer system detects, via the one or more input devices, movement of the second user (e.g., the second computer system) that causes the second user to be located at a different location in the three-dimensional environment relative to the viewpoint of the first user and/or movement of the viewpoint of the first user relative to the three-dimensional environment that causes the second user to be located at a different location in the three-dimensional environment relative to the updated viewpoint of the first user.

In some embodiments, in response to detecting the second change in the location of the second user, in accordance with a determination that the second change in the location of the second user causes the one or more second criteria to no longer be satisfied because the one or more criteria become satisfied while in the real-time spatial communication session with the second computer system, such as the second user 922 being back in the field of view of the first user 920 in FIG. 9K, the first computer system ceases display of the first visual representation of the second user in the environment, such as ceasing display of the visual representation 917 as shown in FIG. 9K. For example, if the movement of the second user and/or the movement of the viewpoint of the first user cause the second user to become visible in the field of view of the first user and/or the first computer system to be within the threshold distance of the second computer system once again, the first computer system ceases display of the first visual representation of the second user in the three-dimensional environment. In some embodiments, the first computer system moves the first visual representation of the second user in the three-dimensional environment in accordance with the second change in the location of the second user relative to the viewpoint of the first user (e.g., in accordance with the movement of the second user) until the one or more criteria become satisfied (e.g., the second user becomes visible in the first user's field of view once again), which causes the first computer system to cease display of the first visual representation of the second user. Ceasing display of a spatial visual representation of a second user in the three-dimensional environment in response to detecting a change in a location of the second user relative to the viewpoint of a first user that causes one or more criteria to become satisfied helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, while displaying the first visual representation of the second user in the environment in accordance with the determination that the one or more second criteria are satisfied (e.g., because the change in the location of the second user causes the one or more criteria to no longer be satisfied) while in the real-time spatial communication session with the second computer system in response to detecting the change in the location of the second user, the first computer system detects, via the one or more input devices, a second change in the location of the second user relative to the viewpoint of the first user, such as the movement of the first user 920 from second area 946 back to first area 944 as shown in the overhead view of the three-dimensional environment 900 in FIG. 9J. For example, as similarly discussed above, after displaying the first visual representation of the second user in the three-dimensional environment the first computer system detects, via the one or more input devices, movement of the second user (e.g., the second computer system) that causes the second user to be located at a different location in the three-dimensional environment relative to the viewpoint of the first user and/or movement of the viewpoint of the first user relative to the three-dimensional environment that causes the second user to be located at a different location in the three-dimensional environment relative to the updated viewpoint of the first user.

In some embodiments, in response to detecting the second change in the location of the second user, in accordance with a determination that the second change in the location of the second user causes the first user (e.g., and/or the first computer system) and the second user (e.g., and/or the second computer system) to be located in a same physical room in the environment, such as the first user 920 and the second user 922 both being located in the first area 944 as shown in the overhead view of the three-dimensional environment 900 in FIG. 9K, the first computer system ceases display of the first visual representation of the second user in the environment, such as ceasing display of the visual representation 917 as shown in FIG. 9K. For example, if the movement of the second user and/or the movement of the viewpoint of the first user cause the second user (e.g., and the second computer system) to be located in the same physical room in the physical environment (e.g., but not necessarily to become visible in the field of view of the first user), the first computer system ceases display of the first visual representation of the second user in the three-dimensional environment. In some embodiments, the determination that the first computer system and the second computer system are located in the same physical room is based on proximity of the first computer system to the second computer system. In some embodiments, the determination that the first computer system and the second computer system are located in the same physical room is based on input data obtained via the one or more input devices (e.g., the second computer system is detectable via one or more cameras of the first computer system (and/or vice versa), though the second user is not necessarily visible in the first user's field of view). In some embodiments, the first computer system moves the first visual representation of the second user in the three-dimensional environment in accordance with the second change in the location of the second user relative to the viewpoint of the first user (e.g., in accordance with the movement of the second user) until the one or more criteria become satisfied (e.g., the second user becomes visible in the first user's field of view once again), which causes the first computer system to cease display of the first visual representation of the second user. Ceasing display of a spatial visual representation of a second user in the three-dimensional environment in response to detecting a change in a location of the second user relative to the viewpoint of a first user that causes the first user and the second user to become located in the same physical room helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, the change in the location of the second user relative to the viewpoint of the first user in the environment that causes the one or more criteria to no longer be satisfied (e.g., thereby satisfying the one or more second criteria) while in the real-time spatial communication session with the second computer system is detected while the first user (e.g., and/or the first computer system) and the second user (e.g., and/or the second computer system) are collocated in a first physical room in the environment, such as the first user 920 and the second user 922 both being located in the first area 944 of the physical environment as shown in the overhead view of the three-dimensional environment 900 in FIG. 9E. For example, the first computer system and the second computer system are both located in the first physical room when the movement of the second user (e.g., and the second computer system) and/or the movement of the viewpoint of the first user relative to the three-dimensional environment discussed above are detected. In some embodiments, the change in the location of the second user relative to the viewpoint of the first user in the environment causes the first computer system and the second computer system to be located in different physical rooms in the physical environment. For example, the movement of the second user and/or the movement of the viewpoint of the first user cause the one of the computer systems to remain located in the first physical room and the other computer system to be located in a second physical room, different from the first physical room, or the first computer system and the second computer system to be located in different rooms that are both different from the first physical room, such as a second physical room and a third physical room, in the physical environment.

In some embodiments, the second change in the location of the second user that causes the first user (e.g., and/or the first computer system) and the second user (e.g., and/or the second computer system) to be located in the same physical room causes the first user and the second user to be collocated in a second physical room, different from the first physical room, in the environment, such as the first user 920 and the second user 922 both being located in the second area 946 of the physical environment as shown in the overhead view of the three-dimensional environment 900 in FIG. 9L. For example, the subsequent movement of the second user (e.g., and the second computer system) and/or movement of the viewpoint of the first user relative to the three-dimensional environment causes the first computer system and the second computer system to both be located in the second physical room, which is a different room from the first physical room (e.g., the room in which the first computer system and the second computer system were located when the movement(s) were first detected above). Ceasing display of a spatial visual representation of a second user in the three-dimensional environment in response to detecting a change in a location of the second user relative to the viewpoint of a first user that causes the first user and the second user to become located in the same physical room helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, the change in the location of the second user relative to the viewpoint of the first user in the environment that causes the one or more criteria to no longer be satisfied (e.g., which satisfies the one or more second criteria) while in the real-time spatial communication session with the second computer system is detected while the first user (e.g., and/or the first computer system) and the second user (e.g., and/or the second computer system) are collocated in a first physical room in the environment, such as the first user 920 and the second user 922 both being located in the first area 944 of the physical environment as shown in the overhead view of the three-dimensional environment 900 in FIG. 9E. For example, the first computer system and the second computer system are both located in the first physical room when the movement of the second user (e.g., and the second computer system) and/or the movement of the viewpoint of the first user relative to the three-dimensional environment discussed above are detected. In some embodiments, the change in the location of the second user relative to the viewpoint of the first user in the environment causes the first computer system and the second computer system to be located in different physical rooms in the physical environment. For example, the movement of the second user and/or the movement of the viewpoint of the first user cause the one of the computer systems to remain located in the first physical room and the other computer system to be located in a second physical room, different from the first physical room, or the first computer system and the second computer system to be located in different rooms that are both different from the first physical room, such as a second physical room and a third physical room, in the physical environment.

In some embodiments, the second change in the location of the second user that causes the first computer system and the second computer system to be located in the same physical room causes the first user (e.g., and/or the first computer system) and the second user (e.g., and/or the second computer system) to be collocated in the first physical room in the environment, such as the first user 920 and the second user 922 both being located in the first area 944 of the physical environment as shown in the overhead view of the three-dimensional environment 900 in FIG. 9K. For example, the subsequent movement of the second user (e.g., and the second computer system) and/or movement of the viewpoint of the first user relative to the three-dimensional environment causes the first computer system and the second computer system to both be located in the first physical room (e.g., the room in which the first computer system and the second computer system were located when the movement(s) were first detected above). Ceasing display of a spatial visual representation of a second user in the three-dimensional environment in response to detecting a change in a location of the second user relative to the viewpoint of a first user that causes the first user and the second user to become located in the same physical room helps avoid duplicate and/or conflicting spatial representation of the second user in the spatial communication session relative to the viewpoint of the first user, thereby improving the overall user experience during the real-time communication session, and helps preserve computing resources that would otherwise be consumed to display the spatial visual representation.

In some embodiments, while displaying the first object in the environment (e.g., before detecting the second indication described above), the first computer system detects, via the one or more input devices, a movement input directed to the first object in the environment, such as movement of grabber bar 932 associated with the video conferencing user interface 930 in FIG. 9C. For example, as similarly discussed above, the first computer system detects an air gesture (e.g., an air pinch gesture, an air tap or touch gesture, or other gesture) performed by a hand of the first user, optionally while the gaze of the first user is directed toward the first object in the three-dimensional environment. In some embodiments, the movement input includes, after detecting the air gesture directed to the first object, movement of the hand of the first user (e.g., while maintaining the pinch hand shape). For example, the first computer system detects movement of the hand of the first user relative to the three-dimensional environment in a respective direction and/or with a respective magnitude (e.g., of speed and/or distance).

In some embodiments, in response to detecting the movement input, the first computer system moves the first object in the environment relative to a viewpoint of the first user in accordance with the movement input, such as the movement of the video conferencing user interface 930 in accordance with the movement of hand 903 in the three-dimensional environment 900 as shown in FIG. 9D. For example, the first computer system moves the first object corresponding to a non-spatial representation of the second user in the three-dimensional environment in accordance with the movement of the hand of the first user. In some embodiments, if the movement input includes movement of the hand of the first user in a first direction (e.g., forward or backward in space relative to a body of the first user) and with a first magnitude, the first computer system moves the first object in the three-dimensional environment in a first respective direction, based on the first direction, and with a first respective magnitude, based on the first magnitude, from the viewpoint of the first user. Alternatively, in some embodiments, if the movement input includes movement of the hand of the first user in a second direction (e.g., vertically or horizontally relative to a body of the first user), different from the second direction, and with a second magnitude (optionally different from the first magnitude), the first computer system moves the first object in the three-dimensional environment in a second respective direction, based on the second direction, and with a second respective magnitude, based on the second magnitude, from the viewpoint of the first user. Accordingly, as outlined above, the first computer system facilitates movement of the first object corresponding to the non-spatial representation of the second user in a similar manner as other virtual objects presented in the three-dimensional environment, such as application windows or other forms of content, including three-dimensional objects. However, the first spatial visual representation of the second user is, in certain instances, not able to be movable and/or repositioned in the environment as the first object is. For example, movement input directed to the first spatial visual representation of the second user does not cause the first computer system to move the first spatial visual representation of the second user relative to other virtual objects (e.g., virtual windows, as previously discussed above) that are shared and displayed in the virtual space within the spatial communication session. Moving a non-spatial representation of a second user in the three-dimensional environment while a first user and the second user are in a non-spatial communication session in response to detecting movement input directed to the non-spatial representation facilitates reduces the number of inputs needed to reposition the non-spatial representation relative to the viewpoint of the first user, thereby improving the overall user experience during the real-time communication session, and helps avoid erroneous user input related to moving the non-spatial representation in the three-dimensional environment.

In some embodiments, the first computer system detects a third indication of a request to initiate non-spatial communication with a third user, different from the first user and the second user, of a third computer system, different from the first computer system and the second computer system, such as selection of second representation 915b in the people picker user interface in FIG. 9M. In some embodiments, the third computer system is within the threshold distance (e.g., 0.1, 0.5, 0.75, 1, 2, 3, 5, 10, 12, 15, 20, 25, 30, or 50 m) of the first computer system when the third indication is detected. In some embodiments, when the third indication is detected, the third computer system is located in a same physical environment of the first computer system. In some embodiments, when the third indication is detected, the third user is in a field of view of the first user in the environment (e.g., and/or vice versa). In some embodiments, the third computer system is outside of the threshold distance of the first computer system when the third indication is detected. In some embodiments, the third indication of the request to initiate non-spatial communication with the third user corresponds to a request to initiate a phone call with the third user. In some embodiments, the third indication of the request to initiate non-spatial communication with the third user corresponds to a request to initiate a video call with the third user. In some embodiments, the third indication includes input directed to a suggested users user interface displayed at the first computer system (or the third computer system), as similarly discussed above. In some embodiments, detecting the third indication of the request to initiate non-spatial communication with the third user of the third computer system has one or more characteristics of the first indication discussed above. In some embodiments, the first computer system detects the third indication while the first user is in the non-spatial real-time communication session with the second user as discussed above. In some embodiments, the first computer system detects the third indication while the first user is in the spatial real-time communication session with the second user as discussed above. In some embodiments, the first computer system detects the third indication while the first user is not engaged in a real-time communication session (e.g., spatial or non-spatial), such as before detecting the first indication discussed above.

In some embodiments, in response to detecting the third indication, the first computer system enters a non-spatial real-time communication session with the third user, including displaying, via the display generation component, a second object corresponding to a non-spatial representation of the third user in the environment, such as contact user interface 950 for the third user in FIG. 9N. In some embodiments, as similarly discussed above, the non-spatial communication session is a real-time (e.g., or nearly real-time) communication session that includes audio (e.g., real-time voice audio from the first user and/or the third user and/or the second user) and/or video (e.g., real-time video of the environment of the first user and/or the third user and/or the second user). For example, the first computer system displays the second object via which to visually and/or audibly communicate with the third user in the three-dimensional environment in response to detecting the third indication. In some embodiments, the second object is displayed as a virtual object (e.g., a non-spatial window) that includes a two-dimensional rendering of the third user based on image data captured by sensors in an environment of the third user, such as one or more cameras of the third computer system. For example, the two-dimensional rendering of the third user corresponds to a photograph, cartoon, sketch, or other still image selected by the second user or corresponds to a (e.g., live) video feed of the second user. In some embodiments, the two-dimensional rendering of the second object corresponds to a two-dimensional animated representation of the third user (e.g., a two-dimensional avatar rather than a three-dimensional avatar as discussed above). Additionally, in some embodiments, the second object is or includes a non-spatial communication interface (e.g., a virtual video panel that includes a two-dimensional rendering of the third user) via which to communicate with the third user (e.g., in lieu of a virtual avatar, as discussed in more detail below). Accordingly, in some embodiments, the second object (e.g., the non-spatial communication interface) serves as a visual indication that the first user and the third user are engaging in a non-spatial communication session. In some embodiments, as similarly discussed above, the second object includes one or more selectable options for controlling the non-spatial communication with the third user. In some embodiments, the second object is configured to be movable and/or repositioned in the environment as other virtual objects are, as similarly discussed above. In some embodiments, the second object has one or more characteristics of the first object discussed above. In some embodiments, if the first user is in a non-spatial real-time communication session with the second user when the third indication is detected by the first computer system, the first computer system displays the second object concurrently with the first object discussed above in the three-dimensional environment. In some embodiments, if the first user in in a spatial real-time communication session with the second user when the third indication is detected by the first computer system, the first computer system displays the second object concurrently with the first spatial visual representation of the second user in the three-dimensional environment.

In some embodiments, while displaying the second object in the environment, the first computer system detects a fourth indication of a request to transition the non-spatial real-time communication session to a spatial real-time communication session, such as selection of interactive element 951a in the contact user interface 950 as shown in FIG. 9N. For example, the first computer system initiates and/or receives a request to transition the non-spatial communication session with the third computer system to a spatial communication session (e.g., independent/irrespective of whether the first computer system and the second computer system are in a spatial or non-spatial real-time communication session). In some embodiments, the fourth indication corresponds to user input detected by the first computer system. In some embodiments, the first computer system detects input provided by the first user that is directed to the second object, as similarly discussed above. In some embodiments, detecting the fourth indication of the request to transition the non-spatial real-time communication session to the spatial real-time communication session has one or more characteristics of the second indication discussed above.

In some embodiments, in response to detecting the fourth indication, the first computer system enters a spatial real-time communication session with the third user, as indicated by indication 935 in FIG. 9O. In some embodiments, in response to initiating and/or receiving the request to join the spatial communication session, the first and/or third (e.g., and/or second) computer systems initiate display of a shared three-dimensional environment to facilitate communication between the first user of the first computer system and the third user of the third computer system (e.g., and/or the second user of the second computer system). In some embodiments, as previously discussed above, entering the spatial real-time communication session includes establishing a shared virtual space (e.g., in the form of a shared three-dimensional environment) in which media and other content is able to be shared between the first user and the third user (e.g., and/or the second user). In some embodiments, while the first user and the third user (e.g., and/or the second user) are in the spatial real-time communication session, the first user and the third user (e.g., and/or the second user) have unique viewpoints in the shared three-dimensional environment determined based on the locations of the first computer system and the third computer system (e.g., and/or the second computer system), respectively, relative to the three-dimensional environment.

In some embodiments, in accordance with a determination that one or more second criteria are not satisfied, the first computer system ceases display of the second object in the environment and displays, via the display generation component, a second spatial visual representation of the third user in the environment, such as display of visual representation 919 of the third user as shown in FIG. 9O. For example, the first computer system replaces display of the non-spatial communication interface with the second spatial visual representation of the third user in the three-dimensional environment. In some embodiments, the one or more second criteria include a criterion that is satisfied if, when the fourth indication is detected, the third computer system is within (e.g., still within) the threshold distance of the first computer system. For example, if the third computer system was not within the threshold distance of the first computer system when the third indication is detected, but is moved to within the threshold distance of the first computer system (e.g., by the third user) when the fourth indication is detected, the one or more second criteria are satisfied. In some embodiments, the one or more second criteria include a criterion that is satisfied if, when the fourth indication is detected, the third user is within the field of view of the first user in the environment (e.g., the third user is visible to the first user from the viewpoint of the first user, optionally independent of whether the third computer system is within the threshold distance of the first computer system). Accordingly, the one or more second criteria are optionally not satisfied in accordance with a determination that the third computer system is more than the threshold distance of the first computer system and/or the third user is outside of the field of view of the first user (e.g., the third user and the third computer system are located in and/or have moved to a different room or physical space) when the fourth indication is detected. In some embodiments, the second spatial visual representation of the third user corresponds to a virtual avatar. In some embodiments, the second spatial visual representation visually provides the first user of the first computer system (e.g., and/or the second user of the second computer system) with an indication of a location and/or orientation of the third user in the virtual space within the spatial communication session relative to the viewpoint of the first user, whereas the second object (e.g., the non-spatial representation of the third user) does not visually provide the first user of the first computer system with an indication of a location and/or orientation of the third user in the virtual space relative to the viewpoint of the first user. Additionally, as opposed to the second object, the second spatial visual representation of the third user is, in certain instances, not able to be movable and/or repositioned in the environment as other virtual objects are. For example, movement input directed to the second spatial visual representation of the third user does not cause the first computer system to move the second spatial visual representation of the third user relative to other virtual objects (e.g., virtual windows, as previously discussed above) that are shared and displayed in the virtual space within the spatial communication session. In some embodiments, the second spatial visual representation has one or more characteristics of the first spatial visual representation discussed above. In some embodiments, if the first user is in a non-spatial real-time communication session with the second user when the fourth indication is detected by the first computer system and the one or more second criteria are satisfied, the first computer system displays the second spatial visual representation of the third user concurrently with the first object discussed above in the three-dimensional environment. In some embodiments, if the first user in in a spatial real-time communication session with the second user when the fourth indication is detected by the first computer system and the one or more second criteria are satisfied, the first computer system displays the second spatial visual representation of the third user concurrently with the first spatial visual representation of the second user in the three-dimensional environment.

In some embodiments, in accordance with a determination that the one or more second criteria are satisfied, the first computer system ceases display of the second object in the environment without displaying the second spatial visual representation of the third user in the environment, such as ceasing display of the video conferencing user interface 930 without displaying the visual representation 917 as shown in FIG. 9D. For example, the one or more second criteria are satisfied in accordance with a determination that the third computer system is within (e.g., remains within) the threshold distance of the first computer system and/or the third user is within (e.g., still within) the field of view of the first user (e.g., the third user and the third computer system are still located in or have moved to the same room or physical space as the first computer system) when the fourth indication is detected. In some embodiments, because the third user is within the field of view of the first user and/or is otherwise proximate to the first user of the first computer system, the first computer system forgoes displaying a virtual avatar of the third user in the three-dimensional environment, which could provide a duplicate and/or conflicting indication of the location of the third user relative to the viewpoint of the first user. For example, the third user is visible from the viewpoint of the first user when entering the spatial communication session with the third user, negating the need to represent the third user spatially in the environment as a virtual avatar. Thus, in either of the above instances, ceasing display of the second object (e.g., the non-spatial communication interface) optionally serves as a visual indication that the first user and the third user are now engaging in a spatial real-time communication session. Displaying a spatial visual representation of a third user in the three-dimensional environment when a first user enters a spatial communication session with the third user based on whether one or more criteria are not satisfied helps avoid duplicate and/or conflicting spatial representation of the third user in the spatial communication session relative to the viewpoint of the first user, thereby improving the overall user experience during the real-time communication session, and helps preserve computing resources that would otherwise be consumed to display the spatial visual representation.

In some embodiments, while in the non-spatial real-time communication session or the spatial real-time communication session with the second user, such as indicated by indication 935 in FIG. 9F, the first computer system displays, via the display generation component, a first option that is selectable to initiate a process to participate in a shared activity with the second user (and/or an option that is selectable to initiate a process to allow the computer system of the second user to display content that is displayed by the computer system of the first user), such as interactive element 941c in the communication session user interface 940 as shown in FIG. 9F. For example, while the first user is in a spatial or non-spatial real-time communication session with the second user (and/or other users), the first computer system displays a selectable option that is selectable to share content with the second user (and/or other users) in the three-dimensional environment within the real-time communication session. In some embodiments, before detecting an input selecting the first option, the content associated with the shared activity is not displayed by the second computer system associated with the second user. In some embodiments, the shared activity corresponds to a shared playback experience. For example, the first option is selectable to initiate a process to share a video (e.g., movie or television show episode), image, music, and/or other visual and/or audible media with the second user (and/or other users in the real-time communication session). As another example, the shared activity corresponds to a shared gaming experience. For example, the first option is selectable to initiate a process to initiate co-operational game play of a particular video, virtual board game, or other game. The shared activity optionally corresponds to other types of content that is configured to be shared within the real-time communication session, such as web pages, text documents, and/or three-dimensional models/shapes. In some embodiments, the shared activity is associated with a respective application running on the first computer system. In some embodiments, the first option is displayed in a predefined region of the display generation component and/or the three-dimensional environment, such as within a settings/controls user interface. In some embodiments, the first option is displayed with a respective user interface that is displayed in the three-dimensional environment and that is private to the first user (e.g., is only viewable by and/or interactive to the first user until the content of the respective user interface is shared with other users via the first option). In some embodiments, selection of the first option causes the first computer system to prompt the first user to designate participants for the shared activity, such as selecting particular users in the real-time communication session (e.g., such as the second user) and/or designating all users who are participating in the real-time communication session.

In some embodiments, the first option is not displayed in the environment while not in a real-time communication session with the second user (e.g., even though the first computer system is optionally displaying the virtual content discussed above), such as the interactive element 941c not being displayed in three-dimensional environment 900 in FIG. 9A while the first user 920 is not in a real-time communication session with the second user 922. For example, the first computer system forgoes displaying the first option in the three-dimensional environment in accordance with a determination that the first user is not in a non-spatial or spatial real-time communication session with another user, such as the second user. In some embodiments, the display of the first option is therefore independent of proximity of the first computer system to other computer systems, such as the second computer system. For example, if the second computer system (and/or other computer systems) is within the threshold distance discussed above of the first computer system in the physical environment, but the first user and the second user (and/or other users) are not in a real-time communication session, such as a phone call, video call, or spatial call, the first computer system forgoes displaying the first option in the three-dimensional environment. Similarly, the display of the first option is optionally independent of visibility of the second user (and/or other users) in the field of view of the first user. For example, if the second user (and/or other users) are visible in the first user's field of view of the three-dimensional environment, but the first user and the second user (and/or other users) are not in the real-time communication session, the first computer system forgoes displaying the first option in the three-dimensional environment. In some embodiments, once the first computer system enters a real-time communication session with the second user (and/or other users) in one or more of the manners discussed above, the first computer system optionally enables display of the first option in the three-dimensional environment as discussed above. Displaying a selectable option for sharing content with a second user in the three-dimensional environment based on whether a first user is in a real-time communication session with the second user facilitates discovery that the first user is in the real-time communication session with the second user and/or facilitates user input for entering a real-time communication session with the second user to enable the sharing of content with the second user, thereby improving user-device interaction.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-1 through 11F generally illustrate examples of a first computer system sharing a user interface with a second computer system in response to selection of a first user interface element for sharing the user interface with the second computer system, where the first computer system and the second computer system are collocated in a physical environment in accordance with some embodiments.

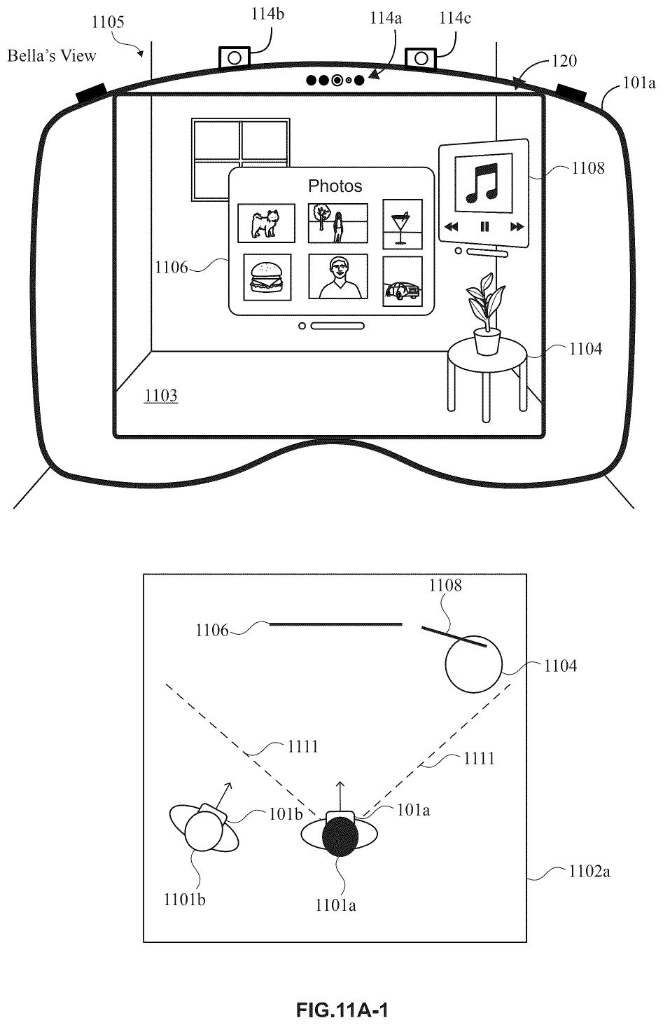

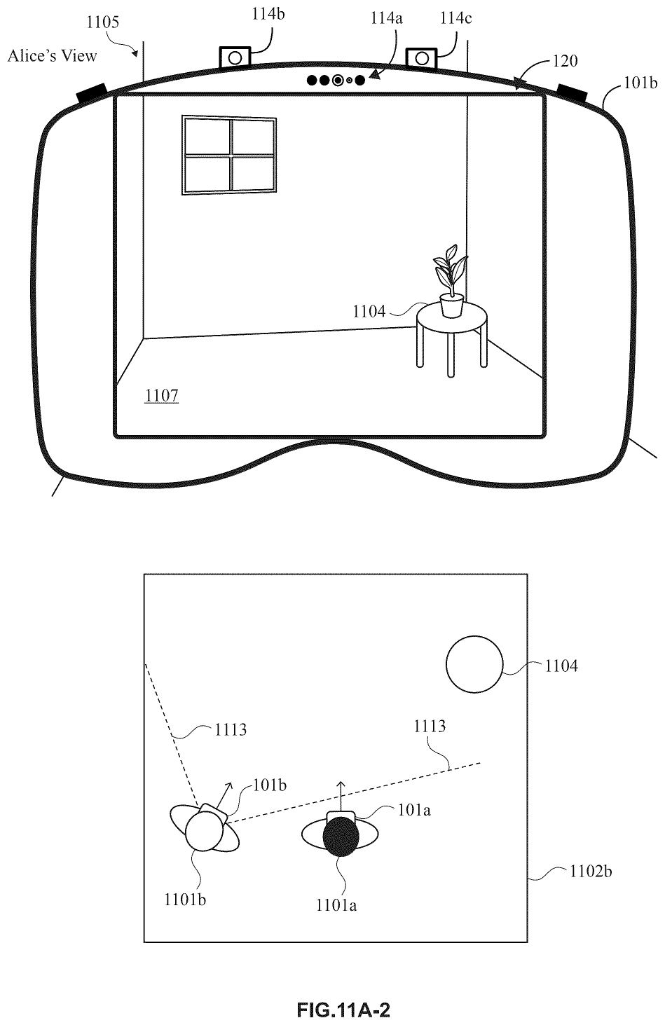

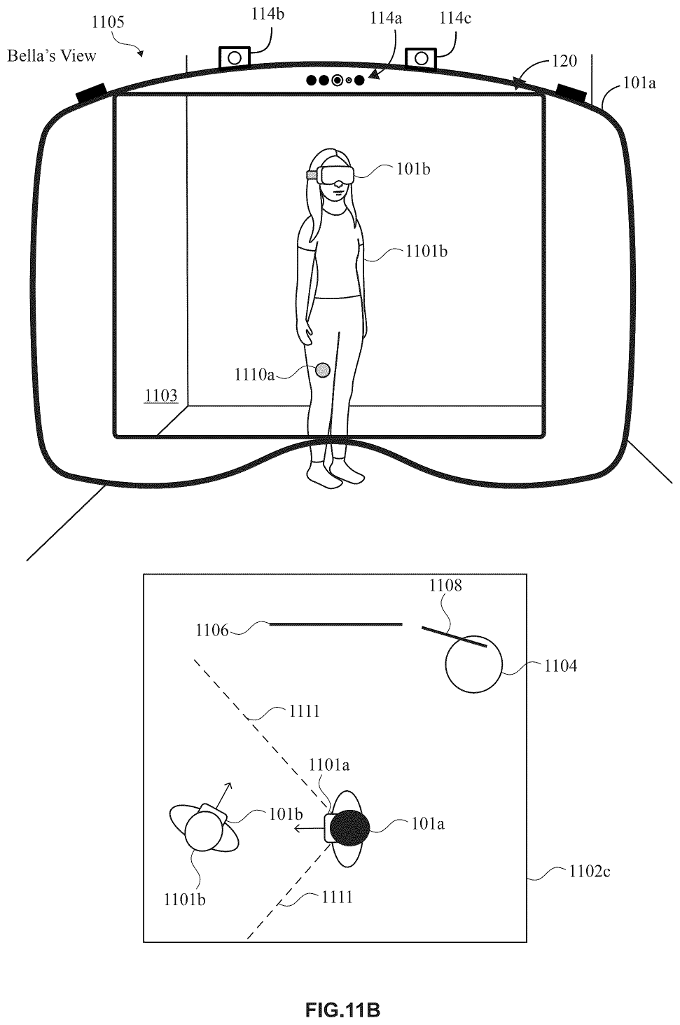

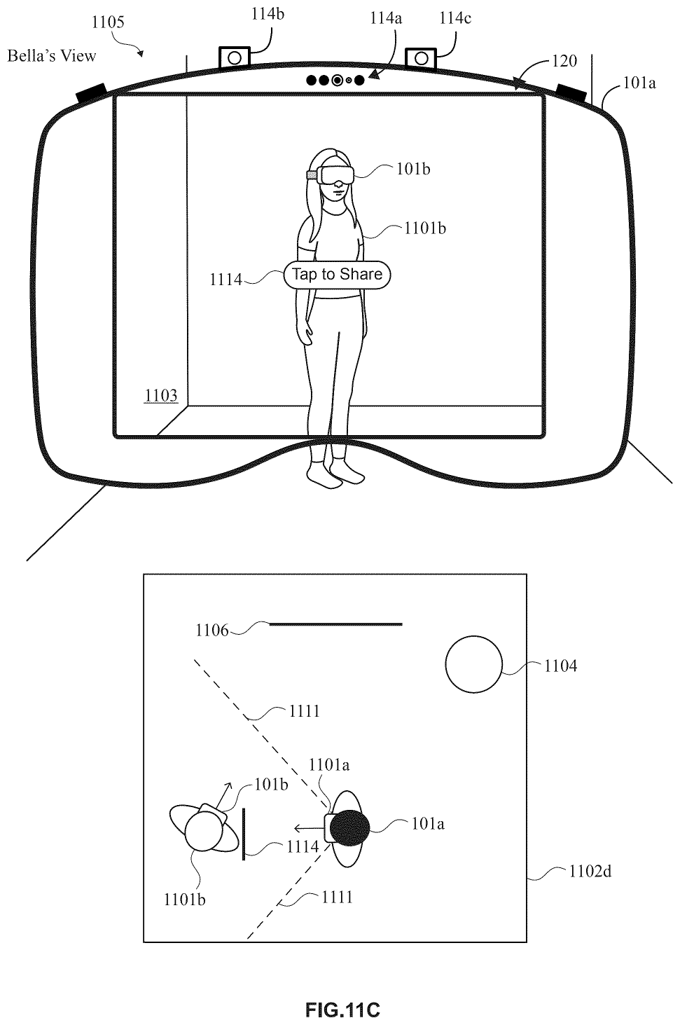

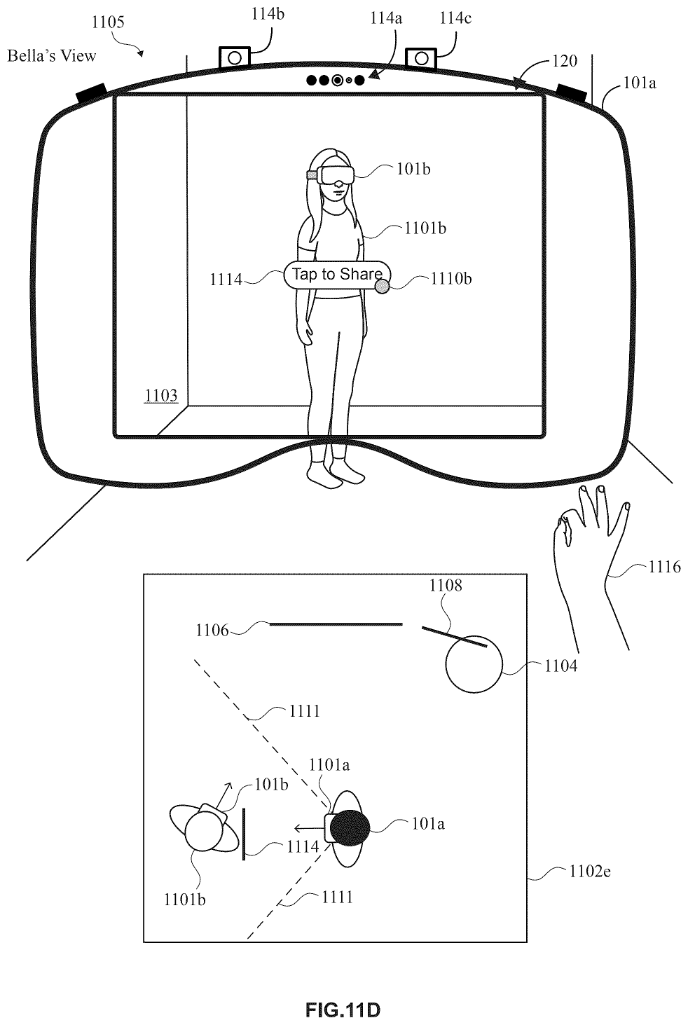

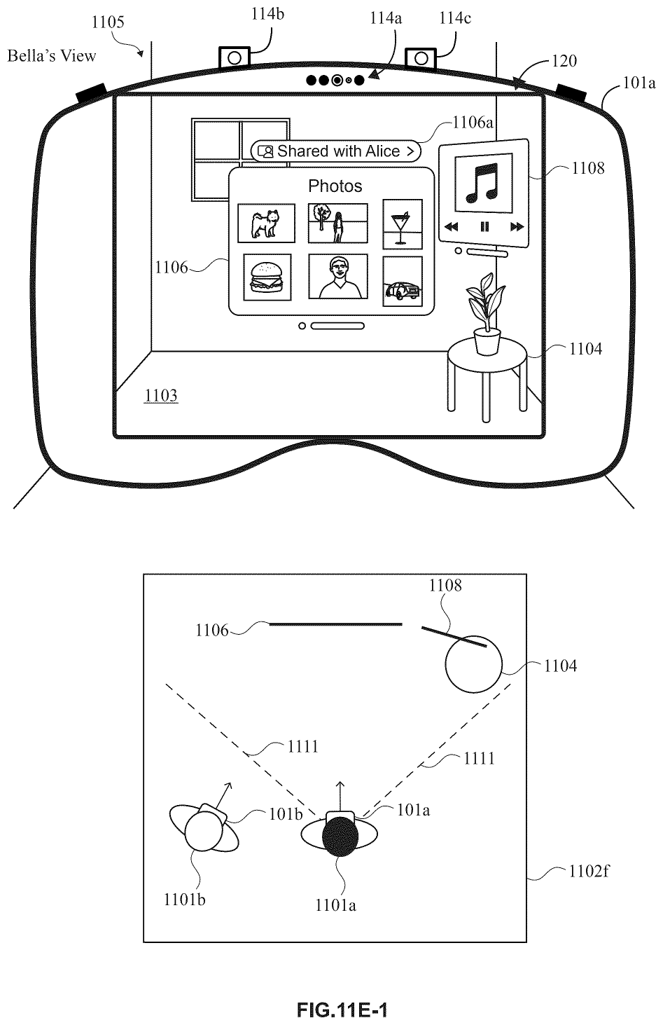

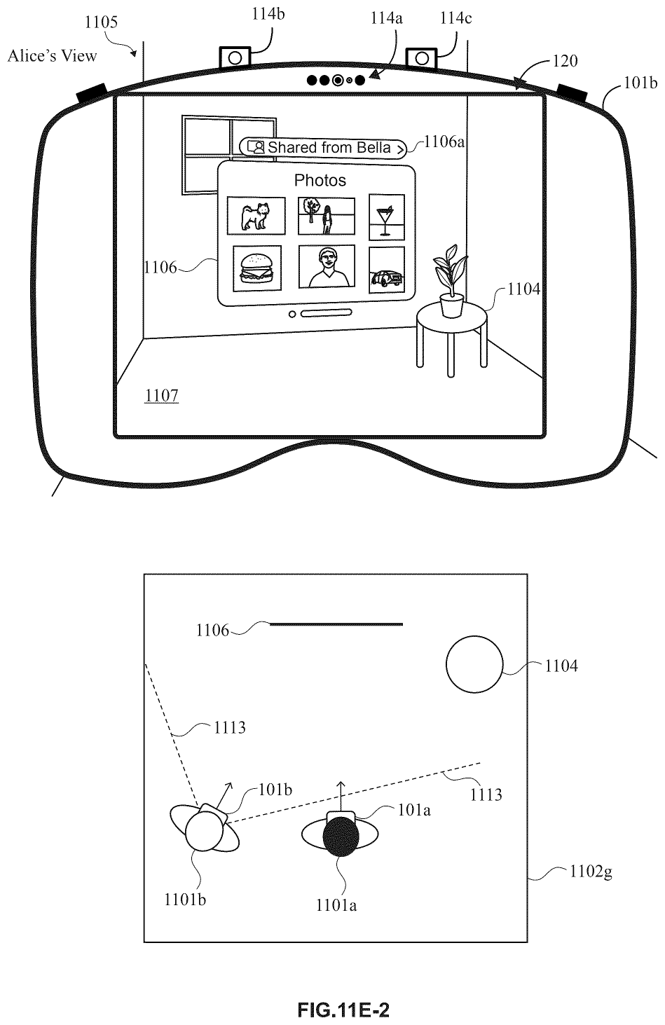

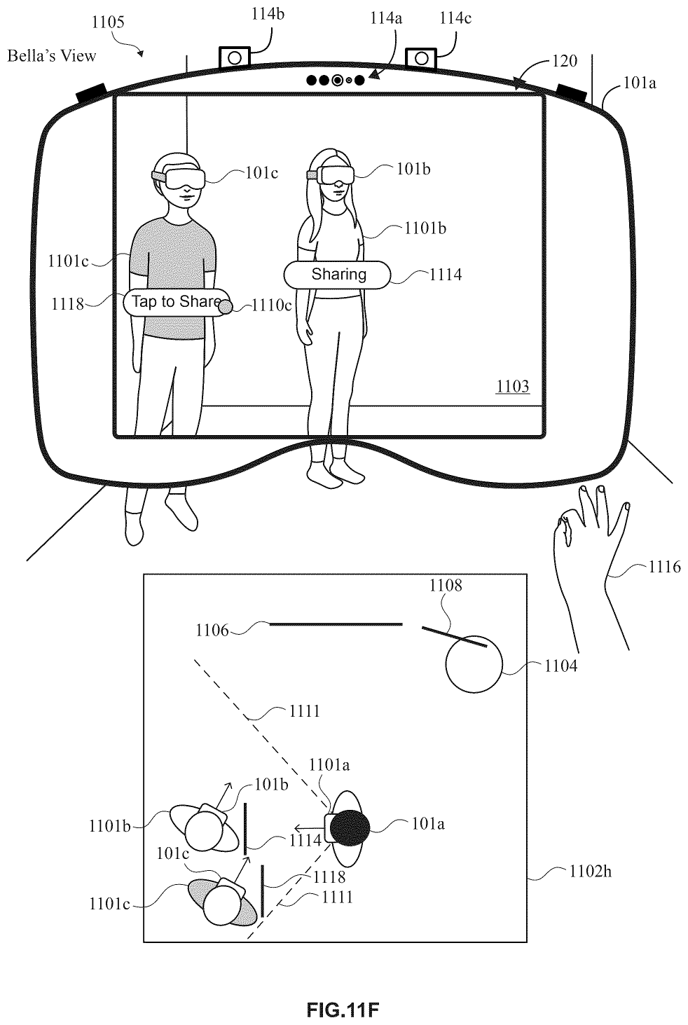

In FIG. 11A-1, a first computer system 101a (e.g., an electronic device) worn by a first user 1101a of the first computer system 101a is displaying, via a display generation components 120 (e.g., display generation components 1-122a and 1-122b of FIG. 1), a first three-dimensional environment 1103 from a viewpoint of the first user 1101a (e.g., first user 1101a in overhead view 1102a of the first three-dimensional environment 1103) of the first computer system 101a (e.g., facing the back wall of the physical environment 1105 in which the first computer system 101a is located). Overhead views 1102a through 1102h in FIGS. 11A-1 through 11F show relative positioning of objects in the three-dimensional environment in a horizontal dimension and a depth dimension in the respective figure. In FIG. 11A-1, the first computer system 101a is collocated with a second computer system 101b in the physical environment 1105.

In FIG. 11A-1, the display generation component 120 includes one or more internal image sensors 114a oriented towards the face of the user (e.g., eye tracking cameras 540 described with reference to FIG. 5). In some embodiments, the internal image sensors 114a are used for eye tracking (e.g., detecting a gaze of the user). The internal image sensors 114a are optionally arranged on the left and right portions of display generation component 120 to enable eye tracking of the user's left and right eyes. The display generation component 120 also includes external image sensors 114b and 114c facing outwards from the user to detect and/or capture the physical environment and/or movements of the user's hands.

In FIG. 11A-1, the first computer system 101a optionally captures one or more images of the physical environment 1105 around the first computer system 101a (e.g., operating environment 100), including one or more objects and/or users in the physical environment 1105 around the first computer system 101a. In some embodiments, the first computer system 101a displays representations of the physical environment 1105 in the first three-dimensional environment 1103. For example, the first three-dimensional environment 1103 optionally includes representations of the rear and side walls of the room (e.g., the physical environment 1105) in which the first computer system 101a is located and a representation of a table 1104 (e.g., a physical table on which a physical potted plant sits) located in the room in which the first computer system 101a is located.

As discussed in more detail below, in FIG. 11A-1, the display generation component 120 is illustrated as displaying content in the first three-dimensional environment 1103. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content through display generation component 120.

In FIG. 11A-1, the display generation component 120 has a field of view (e.g., a field of view captured by external image sensors 114b and 114c and/or visible to the user via display generation component 120) that corresponds to the content shown in FIG. 11A-1. For example, in FIG. 11A-1, the viewing boundaries of the first user 1101a via the first computer system 101a are given by the viewing boundaries 1111. Because the display generation component 120 is optionally a head-mounted device, the field of view of display generation component 120 is optionally the same as or similar to the field of view of the user. For example, the view of the first three-dimensional environment 1103 depicts what is visible to the first user 1101a (via display generation component 120) when the viewpoint of the first user 1101a is located as shown in the overhead view 1102a of the first three-dimensional environment 1103 and the first computer system 101a is optionally oriented in the direction indicated by the direction arrow emanating from the first computer system 101a in the overhead view 1102a. Similarly, the second computer system 101b (e.g., associated with the second user 1101b) is optionally oriented in the direction indicated by the direction arrow emanating from the second computer system 101b in the overhead view 1102a of the first three-dimensional environment 1103 in FIG. 11A-1.

As discussed herein, the first user 1101a may perform one or more air pinch gestures (e.g., with hand(s) of the first 1101a) to provide one or more inputs to the first computer system 101a to provide one or more user inputs directed to virtual objects displayed by the first computer system 101a. Such depiction is intended to be exemplary rather than limiting; the first user 1101a optionally provides user inputs using different air gestures and/or using other forms of input.

Note that in some embodiments, were a portion (e.g., a hand or another portion) of the first user 1101a to be within the field of view of display generation component 120, the portion may be visible within the first three-dimensional environment 1103. That is, the first user 1101a can optionally see, in the first three-dimensional environment 1103, any portion of their own body that is within the field of view of display generation component 120.

As mentioned above, the first computer system 101a is configured to display content in the first three-dimensional environment 1103 using the display generation component 120. In FIG. 11A-1, the first computer system 101a displays a first user interface 1106 and a second user interface 1108. The first user interface 1106 is a user interface of a photos application and the second user interface 1108 is a user interface of a music application. These user interfaces are representative and nonlimiting. Additionally, more or fewer user interfaces may be displayed in the first three-dimensional environment 1103.

In FIG. 11A-1, the first user interface 1106 and the second user interface 1108 are private to the first computer system 101a. That is, the first user interface 1106 and the second user interface 1108 are not being shared with the second computer system 101b. Thus, for example, in FIG. 11A-1, the first user interface 1106 and the second user interface 1108 are not displayed in the three-dimensional environment of the second computer system 101b (e.g., and is therefore not visible to and/or interactive to the second user 1101b); such features are further made clear in view of FIG. 11A-2, which shows a second three-dimensional environment 1107 that is visible via a display generation component 120 of the second computer system 101b (e.g., optionally at the same time as the first computer system 101a is displaying the first three-dimensional environment 1103 via the display generation component 120 in FIG. 11A-1).

As shown in overhead view 1102a in FIG. 11A-1, a second user 1101b is located in the room (e.g., in the physical environment 1105) in which the first computer system 101a is located. The first computer system 101a and the second computer system 101b are collocated in the physical environment 1105 (e.g., the first user 1101a and the second user 1101b are collocated with each other in the physical environment 1105), such as described herein with reference to collocation and/or proximity. Further, as shown in overhead view 1102a in FIG. 11A-1, the second user 1101b is associated with a second computer system 101b (e.g., that is being worn on a head of the second user 1101b). In some embodiments, the second computer system includes one or more features described with reference to the first computer system 101a (e.g., is optionally of the same type of computer system and/or includes one or more features that are similar to the first computer system 101a, such as including a display generation component 120 and/or other features).

FIG. 11A-2 illustrates the second computer system 101b of the second user 1101b displaying a second three-dimensional environment 1107 that is visible via a display generation component of the second computer system 101b from a viewpoint of the second user 1101b in accordance with some embodiments. The second user 1101b in FIG. 11A-2 is at the same location in the physical environment 1105 as illustrated in FIG. 11A-1 in overhead view 1102a. Note that the first computer system 101a and the second computer system 101b are located in the same physical environment 1105 (e.g., room). For example, in FIG. 11A-2, the viewing boundaries of the second user 1101b via the second computer system 101b are given by the viewing boundaries 1113. Though similar portions of the room are in the viewport of the second computer system 101b in FIG. 11A-2 as in the viewport of the first computer system 101a in FIG. 11A-1, such as shown with the representation of the table 1104 being shown in display generation component 120 of the second computer system 101b in FIG. 11A-2 just as it is shown via display generation component 120 of the first computer system 101a in FIG. 11A-1, the first user interface 1106 and the second user interface 1108 of FIG. 11A-1, are not being displayed by the second computer system 101b in FIG. 11A-2 because the first user interface 1106 and the second user interface 1108 are not being shared between the first computer system 101a and the second computer system 101b (e.g., are private to the first computer system 101a). Additionally, in the illustrated embodiment of FIG. 11A-2, the second computer system 101b is not displaying any user interface. Though, note that in some embodiments, the second computer system 101b in FIG. 11A-2 may display user interface(s) that may be private to the second computer system 101b.

FIGS. 11A-1, FIG. 11B, and FIG. 11C illustrate the first computer system 101a detecting and responding to certain criteria being satisfied for displaying a user interface element 1114 that is selectable to share a user interface with the second computer system 101b in accordance with some embodiments.

From FIG. 11A-1 to FIG. 11B, the first user 1101a turns (e.g., rotates) towards the second user 1101b, as shown from overhead view 1102a of FIG. 11A-1 to overhead view 1102c of FIG. 11B. In FIG. 11B, attention (e.g., gaze) of the first user 1101a is directed to the second user 1101b, as shown by gaze point 1110a in FIG. 11B being on a portion of the second user 1101b. In some embodiments, the criteria that should be satisfied in order for the first computer system 101a to display the user interface element 1114 includes attention (e.g., gaze) of the first user 1101a being directed to the second user 1101b. From FIG. 11B to FIG. 11C, the first computer system 101a displays the user interface element 1114 in response to detecting that attention (e.g., gaze) of the first user 1101a being directed to the second user 1101b.

As described above, the user interface element 1114 is selectable to share a user interface with the second computer system 101b which is in the same physical environment 1105 as the first computer system 101a. In some embodiments, the first computer system 101a displays the user interface element 1114 because the second computer system 101b is in the viewport of the first computer system 101a (e.g., a position corresponding to the second user 1101b and/or the second computer system 101b is in the field of view of the first computer system 101a, such as shown with the second user 1101b and/or the second computer system 101b being in the first three-dimensional environment 1103 of the first user 1101a in FIGS. 11B and 11C. Further details regarding criteria that may be satisfied in order for the first computer system 101a to display the user interface element 1114 are described with reference to method 1200. As shown in FIG. 11C, the first computer system 101a displays the user interface element 1114 in between a viewpoint of the first user 1101a and a position of the second user 1101b. Further details regarding a location of the display of the user interface element 1114 are provided with reference to method 1200.

As described above, the user interface element 1114 is selectable to share a user interface with the second computer system 101b which is in the same physical environment 1105 as the first computer system 101a. In some embodiments, the user interface that the user interface element 1114 is selectable to share is the user interface that the first user 1101a most recently used or the user interface with which the first user 1101a most recently interacted. As such, in some embodiments, when selection of the user interface element 1114 is detected, the first computer system 101a has predetermined which user interface is to be shared in response to selection of the user interface element 1114 and does not request further user input for determining which user interface to share. In some embodiments, the user interface element 1114 (e.g., the user interface element 1114 of FIG. 11C) visually indicates the specific user interface that the user interface element 1114 is selectable to share with the second computer system 101b before the user interface element 1114 is selected. In some embodiments, the user interface element 1114 visually indicates the second user 1101b. In some embodiments, the user interface element 1114 visually indicates an operation or gesture to be performed by the first user 1101a in order to share a user interface with the second user 1101b through the interaction with the user interface element 1114. In some embodiments, when selection of the user interface element 1114 is detected, the first computer system 101a displays one or more further user interface elements (e.g., displays a user interface picker user interface) from which the first user 1101a may provide user input selecting a specific user interface to share with the second computer system, which may or may not be different from the user interface that the first user 1101a most recently used or the user interface with which the first user 1101a most recently interacted. In some embodiments, when selection of the user interface element 1114 is detected, the first computer system 101a does not display one or more further user interface elements from which the first user 1101a may provide user input selecting a specific user interface to share with the second computer system 101b, and simply shares the user interface that the first user 1101a most recently used or the user interface with which the first user 1101a most recently interacted.

In FIG. 11D, the first computer system 101a detects selection of the user interface element 1114. For example, in FIG. 11D, the first computer system 101a optionally detects the hand 1116 of the first user 1101a performing an air pinch gesture directed to the user interface element (e.g., a tapping of the index finger with the thumb of the first user 1101a) while attention (e.g., gaze) of the first user 1101a is directed to the user interface element 1114, as shown with gaze point 1110b. In response, the first computer system 101a shares the first user interface 1106 with the second computer system 101b, as shown in FIGS. 11E-1 and 11E-2.

As shown in FIGS. 11E-1 and 11E-2, the first user interface 1106 is being displayed in both the first three-dimensional environment 1103 of the first user 1101a and the second three-dimensional environment 1107 of the second user 1101b. That is, the first computer system 101a is displaying the first user interface 1106 in the first three-dimensional environment 1103, as shown in FIG. 11E-1, and the second computer system 101b is now displaying the first user interface 1106 in the second three-dimensional environment 1107, as shown in FIG. 11E-2. Further, as shown in FIG. 11E-1, the first computer system 101a is now displaying a pill 1106a (e.g., a user interface element) that indicates that the first user interface 1106 is being shared. For example, when the first computer system 101a is not sharing the first user interface 1106, the first computer system 101a forgoes displaying a pill that indicates a shared status of the first user interface 1106, such as shown in FIG. 11A-1, and when the first computer system 101a is sharing the first user interface 1106, the first computer system 101a displays the pill 1106a which indicates that the first user interface 1106 is being shared, such as shown in FIG. 11E-1. In some embodiments, the pill 1106a further indicates that the first user interface 1106 is being shared with the second user 1101b, such as shown in FIG. 11E-1. As such, in some embodiments, the first computer system 101a does not display a pill that indicates a shared status of a user interface is when the user interface is not being shared and is displayed when the user interface is being shared. Additionally, as shown in FIG. 11E-2, the second computer system 101b displays the first user interface 1106 at a location in the second three-dimensional environment 1107 that corresponds to the location of display of the first user interface 1106 in the first three-dimensional environment 1103. For example, a corresponding location of the first user interface 1106 of the first three-dimensional environment 1103 in the physical environment 1105 is optionally the same as a corresponding location of the first user interface 1106 of the second three-dimensional environment 1107 in the physical environment 1105. Note that in some embodiments the location of display of the first user interface 1106 in the first three-dimensional environment 1103 of the first user 1101a does not change in response to selection of the user interface element 1114 or sharing of the first user interface 1106. As shown in FIG. 11E-2, the second computer system 101b displays a pill 1106a that indicates that the first user interface 1106 is being shared (e.g., and optionally specifically indicates that the first user interface 1106 is being shared specifically with (and/or from) the first computer system 101a).

Note that in some embodiments, the first computer system 101a displays pills that indicate a status of a user interface as shared or not shared. For example, in FIG. 11A-1, the first computer system 101a optionally displays a first pill that indicates that the first user interface 1106 is not being shared and a second pill that indicates that the second user interface 1108 is not being shared. Continuing with this example, were the first computer system 101a to share the first user interface 1106 with the second computer system 101b, the first computer system 101a would optionally update the first pill to indicate that the first user interface 1106 is being shared and maintain the second pill of the second user interface 1108 indicating that the second user interface 1108 is not being shared.

In some embodiments, the first computer system 101a shares the first user interface 1106 in response to the selection of the user interface element 1114 in FIG. 11D because the first user interface 1106 is the user interface that the first user 1101a most recently used or the user interface with which the first user 1101a most recently interacted. For example, were the second user interface 1108 the user interface that the first user 1101a most recently used or the user interface with which the first user 1101a most recently interacted (e.g., before selection of the user interface element 1114 and/or before the user interface element 1114 is displayed), the first computer system 101a would optionally share the second user interface 1108 in response to selection of the user interface element 1114 and not share the first user interface 1106.

In some embodiments, the first computer system 101a displays a separate user interface element that is selectable to share a user interface for each user that is collocated with the first user in the physical environment 1105. In some embodiments, the first computer system 101a can share a user interface with different users of computer systems by respectively selecting the respective user interface element that corresponds to the different users of the computer systems. For example, in FIG. 11F, the first computer system 101a concurrently displays the user interface element 1114 and a user interface element 1118 that is selectable to share a user interface with a third user 1101c of a third computer system 101c that is also collocated in the physical environment 1105 with the first computer system 101a. In some embodiments, the third computer system 101c includes one or more features described with reference to the first computer system 101a and/or the second computer system 101b (e.g., is optionally of the same type of computer system and/or includes one or more features that are similar to the first computer system 101a, such as including a display generation component 120 and/or other features).

Note that in the illustrated embodiment of FIG. 11F, user interface element 1114 indicates that the first user interface 1106 is already being shared with the second computer system 101b. In some embodiments, were the first user interface 1106 not already being shared between the first computer system 101a and the second computer system 101b (e.g., were no user interface being shared between the first computer system 101a and the second computer system 101b, the user interface element 1114 in FIG. 11F would indicate that the user interface element 1114 is selectable to share the user interface with the second computer system 101b. As shown in FIG. 11F, in some embodiments, were the first user interface 1106 already shared with the second computer system 101b, the first computer system 101a may display the user interface element 1114 indicating that the first computer system 101a is sharing the first user interface 1106 with the second computer system 101b instead of ceasing to display the user interface element 1114 on the second user 1101b when the first user interface 1106 is shared with the second computer system 101b. In some embodiments, were the first user interface 1106 already shared with the second computer system 101b when the user interface element 1118 is displayed, the first computer system 101a may forgo displaying the user interface element 1114.

The user interface element 1118 of FIG. 11F optionally includes the feature(s) described herein with reference to the user interface element 1114, but is relative to interaction between the first user 1101a and the third user 1101c instead of being relative to interaction between the first user 1101a and the second user 110b. For example, the user interface element 1118 is optionally selectable to share the first user interface 1106 (e.g., the user interface that the first user 1101a most recently used or the user interface with which the first user 1101a most recently interacted) specifically with the third computer system 101c just as the user interface element 1118 of FIG. 11D is selectable to share the first user interface 1106 with the second computer system 101b. In some embodiments, were the first user 1101a to select the user interface element 1118, and the first user interface to be the user interface that the first user most recently used or the user interface with which the first user 1101a most recently interacted, the first computer system 101a would share the first user interface 1106 with the third user 1101c (e.g., independent of whether the first user interface 1106 is already being shared between the first user 1101a and the second user 1101b). In some embodiments, were the first user interface 1106 already being shared between the first user 1101a and the second user 1101b (e.g., between the first computer system 101a and the second computer system 101b such as shown in FIGS. 11E-1 and 11E-2) when the first computer system 101a detects selection of the user interface element 1118 in FIG. 11F, such as when the first computer system 101a in FIG. 11F detects the hand 1116 of the first user 1101a performing an air pinch gesture directed to the user interface element (e.g., a tapping of the index finger with the thumb of the first user 1101a) while attention (e.g., gaze) of the first user 1101a is directed to the user interface element 1114, as shown with gaze point 1110c in FIG. 11F, the first computer system 101a would cause the first user interface 1106 to be shared between the first user 1101a, the second user 1101b, and the third user 1101c. Further details regarding the embodiments illustrated and described with reference to FIGS. 11A-1 through 11F are provided with reference to method 1200.

FIG. 12 is a flowchart illustrating an exemplary method 1200 for sharing a user interface with a second computer system in response to selection of a first user interface element for sharing the user interface with the second computer system in accordance with some embodiments. In some embodiments, the method 1200 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, the method 1200 (e.g., the method 1200 of FIG. 12) is performed at a first computer system in communication with one or more first display generation components and first one or more input devices. In some embodiments, the first computer system has one or more characteristics of the computer systems in methods 800 and/or 1000. In some embodiments, the one or more first display generation components have one or more characteristics of the one or more display generation components in methods 800 and/or 1000. In some embodiments, the one or more first input devices have one or more characteristics of the one or more input devices in methods 800 and/or 1000.

In some embodiments, (1202a) while a respective user interface of a respective application (e.g., a messages user interface, maps user interface, media user interface, web browsing user interface, a game user interface, or another user interface of an application, such as a user interface of an application described with reference to method 800 and/or 1000) is not shared between the first computer system and a second computer system (that are optionally collocated in a physical environment, such as a physical environment described with reference to method 800 and/or 1000), such as shown by the first user interface 1106 being in the first three-dimensional environment 1103 of the first computer system 101a in FIG. 11A-1 and not in the second three-dimensional environment 1107 of the second computer system 101b in FIG. 11A-2, and while the respective user interface of the respective application is associated with a first location in a first three-dimensional environment that is visible via the one or more first display generation components (e.g., the first location is visible when the part of the first three-dimensional environment that includes the first location is in the viewport of the first computer system and the first location is not visible when the part of the first three-dimensional environment that includes the first location is not within the viewport of the first computer system, and the respective user interface may be associated with (e.g., located at) the first location even when the first location is not in within the viewport), such as the illustrated location of the first user interface 1106 in the first three-dimensional environment 1103 in FIG. 11A-1, the first computer system detects (1202b) that one or more criteria are satisfied, including a criterion that is satisfied when a second user of the second computer system is in a viewport of the first computer system at a second location in the first three-dimensional environment (e.g., detecting that the second user and/or the second computer system is visible in physical form (e.g., not an avatar of the second user) in (e.g., through) the viewport of the first computer system at the second location in the first three-dimensional environment, because the second user is physically located at a location in the physical environment that corresponds to (e.g., is the same as) the second location in the first three-dimensional environment), such as the second user 1101b being visible in the view of the first three-dimensional environment 1103 in display generation component 120 in the FIG. 11B.

In some embodiments, (1202a) while the respective user interface of the respective application is not shared between the first computer system and the second computer system, and while the respective user interface of the respective application is associated with the first location in the first three-dimensional environment that is visible via the one or more first display generation components, in response to detecting that the one or more criteria are satisfied, the first computer system displays (1202c), via the one or more first display generation components, a first user interface element in the first three-dimensional environment that is selectable to share the respective user interface of the respective application with the second computer system, wherein the first user interface element is not displayed before detecting that the second user is in the viewport of the first computer system (e.g., before detecting that the one or more criteria are satisfied, such that the one or more criteria are optionally satisfied when the first computer system detects that the second user is in the viewport), such as the user interface element 1114 in FIG. 11C. In some embodiments, in response to detecting that the second user is no longer in the viewport of the first computer system, the computer system ceases display of the first user interface element. Note that optionally no user interface of an application (e.g., no user interface of any application), such as a user interface of an application described with reference to method 800 and/or 1000, is being shared between the first and second computer systems when the detection of the second user in the viewport and/or the display of the first user interface element occurs. Further, a communication session (e.g., a communication session described with reference to method 800 and/or 1000) is optionally not active between the first and second computer systems when the detection of the second user in the viewport and/or the display of the first user interface element occurs. The first three-dimensional environment is optionally as described with reference to the first three-dimensional environment of method 800. Further, in some embodiments, while the respective user interface of the respective application is associated with the first location in the first three-dimensional environment, the respective user interface of the respective application is not associated with a respective location in a second three-dimensional environment that is visible via the one or more second display generation components of the second computer system when the detection of the second user in the viewport and/or the display of the first user interface element occurs. As such, in some embodiments, the respective user interface is displayed in the first three-dimensional environment without being displayed in the second three-dimensional environment (e.g., by the second computer system) because the respective user interface is private to the first computer system when the detection of the second user in the viewport and/or the display of the first user interface element occurs.

In some embodiments, the first and second computer systems are collocated in the physical environment when one or more or all of the one or more criteria described with reference to method 800 and/or 1000 is satisfied. Additionally, in some embodiments, the first and second computer systems are collocated in the physical environment when the first user is in a contact list of the second computer system and/or when second user is in a contact list of the first computer system. Further, when the second user is in (e.g., is visible in) the viewport of the first computer system, the second user is visible via the one or more first display generation components and when the second user is not in the viewport of the first computer system, the second user is not visible via the one or more first display generation components. Note that in some embodiments, when the first computer system detects that the second user is in the viewport of the first computer system, the first computer system may or may not be visible in the viewport of the second computer system.

The first user interface element is specifically associated with the second user of the second computer system. For example, the first computer system may be collocated in the physical environment with the second computer system and a third computer system, but the first user interface element would be selectable to share the respective user interface with the second computer system, but not selectable to share the respective user interface with the third computer system.

In some embodiments, a location of display of the first user interface element in the first three-dimensional environment is based on the second location. For example, were the second location to be a first respective location in the first three-dimensional environment, the computer system would optionally display the first user interface element at a location that is based on the first respective location. Continuing with this example, were the second location to be a second respective location in the first three-dimensional environment that is different from the first respective location, the first computer system would optionally display the first user interface element at a location that is based on the second respective location (e.g., without being based on the first respective location). Further, the first computer system optionally displays the first user interface element having a predefined spatial relationship relative to a location of the second computer system, such as above, below, left, and/or right of the location of the second computer system, relative to a location of the first computer system. For example, the second computer system is optionally worn on a head of the second user, and the first computer system optionally displays the first user interface element having a vertical location that is below a vertical position of the second computer system. In some embodiments, the location of the first user interface element covers a portion of a torso of the second user of the second computer system.

In some embodiments, (1202a) while the respective user interface of the respective application is not shared between the first computer system and the second computer system, and while the respective user interface of the respective application is associated with the first location in the first three-dimensional environment that is visible via the one or more first display generation components, while displaying the first user interface element, the first computer system detects (1202d), via the one or more first input devices, selection of the first user interface element, such as the gaze point 1110b being directed to the user interface element 1114 while the hand 1116 of the first user 1101a is performing an air pinch gesture in FIG. 11D. For example, the first computer system optionally detects a gaze of the first user and/or an air gesture directed to the first user interface element. Additionally or alternatively, the first computer system optionally detects a voice input, an input via a mouse, touch screen or trackpad, or another type of input described herein that is directed to the first user interface element. Additionally or alternatively, in some embodiments, the selection of the first user interface element includes one or more characteristics described with reference to selections in methods 800 and/or 1000.

In some embodiments, in response to detecting the selection of the first user interface element, the first computer system shares (1202e) the respective user interface of the respective application with the second computer system (e.g., sharing of virtual content such as described with reference to method 800 and/or 1000), including causing the respective user interface of the respective application to be concurrently associated with the first location in the first three-dimensional environment and associated with a location in a second three-dimensional environment that is visible via one or more second display generation components of the second computer system, the location in the second three-dimensional environment corresponding to the first location in the first three-dimensional environment, such as shown by the first user interface 1106 being in the first three-dimensional environment 1103 in FIG. 11E-1 and the first user interface 1106 being in the second three-dimensional environment 1107 in FIG. 11E-2. For example, before the first computer system detects selection of the first user interface element, the respective user interface is optionally in the first three-dimensional environment of the first computer system, without being in the second three-dimensional environment of the second computer system. Continuing with this example, in response to detecting selection of the first user interface element, the respective user interface is optionally concurrently in the first three-dimensional environment and the second three-dimensional environment. The first computer system optionally does not change a location of the respective user interface in the first three-dimensional environment when the respective user interface becomes shared. Further, a corresponding physical location of the respective user interface (e.g., the location and/or orientation of the respective user interface relative to the same physical environment that is in the first three-dimensional environment and the second three-dimensional environment) is optionally the same between the first three-dimensional environment and the second three-dimensional environment. Note that the sharing of the respective user interface optionally initiates a communication session (e.g., a real-time communication session or another communication session) between the first and second computer systems, such as a communication session described with reference to method 800 and/or 1000. In some embodiments, when the respective user interface is displayed in the first three-dimensional environment and not shared with the second user, the respective user interface is responsive to input from the first user, and when the respective user interface is shared with the second user, the respective user interface is responsive to input from the first user and/or from the second user; as such, both users can interact with the respective user interface in their respective environments when the respective user interface is shared, and the respective user interface optionally updates in each environment in response to input detected from either the first or second user. In some embodiments, the first computer system moves the respective user interface to an ideal location in the first three-dimensional environment when the first computer system initiates sharing of the respective user interface, such as to a location in the first three-dimensional environment that, corresponding to a physical location in the physical environment, is in the current viewports (e.g., field of views) of the first and second computer systems when the sharing of the respective user interface is initiated. In some embodiments, the first computer system maintains the respective user interface at the same location in the first three-dimensional environment when it goes from not being shared with the second computer system to being shared with the second computer system. Sharing a user interface with a second user of a second computer system in response to selection of a first user interface element that is displayed in response to detection of the second user and that is dedicated to sharing the user interface with the second user specifically, reduces errors associated with sharing user interfaces with different users since the first user interface element is dedicated to sharing the user interface with the second user and makes sharing with collocated users more efficient since the first user interface element is dedicated to being selectable to sharing the user interface with a collocated user.

In some embodiments, while the respective user interface of the respective application is not shared between the first computer system and the second computer system, and while the respective user interface of the respective application is associated with the first location in the first three-dimensional environment, in accordance with a determination that the second user of the second computer system and the first location are in a current viewport of the first computer system (e.g., the first and second locations in the first three-dimensional environment are in the current viewport of the first computer system), the first computer system concurrently displays, via the one or more first display generation components the respective user interface of the respective application at the first location and the first user interface element. For example, were the location of first user interface 1106 and the location of the second user 1101b in the current viewport of the first computer system in FIG. 11C, the first computer system would optionally concurrently display the user interface element 1114 and the first user interface 1106 in FIG. 11C. As such, the first computer system optionally displays both the respective user interface and the first user interface element when their associated locations in the first three-dimensional environment are in the viewport (e.g., field of view) of the first computer system. Concurrently displaying the user interface and the user interface element when they are in the viewport maintains consistency of presentation of them at their respective locations in the first three-dimensional environment and reduces errors associated with misplacing the user interface and the user interface element in the first three-dimensional environment.

In some embodiments, while the respective user interface of the respective application is not shared between the first computer system and the second computer system, and while the respective user interface of the respective application is associated with the first location in the first three-dimensional environment, in accordance with a determination that the second user of the second computer system is in a current viewport of the first computer system and the first location is not in the current viewport of the first computer system (e.g., the first and second locations in the first three-dimensional environment are not in the current viewport of the first computer system), the first computer system displays, via the one or more first display generation components, the first user interface element, without displaying the respective user interface of the respective application, such as the user interface element 1114 being displayed without display of the first user interface 1106 in FIG. 11C. For example, the second user is associated with a second location in the first three-dimensional environment, such as described above, and if the second location is in the current viewport without the first location being in the current viewport, the first computer system would optionally display the first user interface element, without displaying the respective user interface. Continuing with this example, were the first location in the first three-dimensional environment to be in the current viewport without the second location being in the current viewport, the first computer system would optionally display the respective user interface, without displaying the first user interface element. As such, the first computer system optionally displays the first user interface element without displaying the respective user interface, or displays the respective user interface without displaying the first user interface element, when their associated locations in the first three-dimensional environment are not in the viewport (e.g., field of view) of the first computer system at the same time. Displaying the user interface element without display of the respective user interface when the associated location of the user interface element in the first three-dimensional environment is in the viewport of the first computer system and when the associated location of respective user interface in the first three-dimensional environment is not in the viewport of the first computer system reduces errors associated with misplacing the user interface and the user interface element in the first three-dimensional environment since they maintain association with their specific locations in the first three-dimensional environment.

In some embodiments, in accordance with a determination that a first user of the first computer system interacted with (e.g., by looking or gazing at (e.g., for at least a threshold period of time (e.g., 0.5 s, 1 s, 2 s, 5 s, 10 s, or another threshold period of time), and/or by performing an air gesture directed to) a first user interface of a first application (e.g., a messages user interface, maps user interface, media user interface, web browsing user interface, a game user interface, or another user interface of an application, such as a user interface of an application described with reference to method 800 and/or 1000) last before the first user interface element was selected, the respective user interface of the respective application that the first user interface element is selectable to share is the first user interface of the first application. For example, the first computer system optionally shares the first user interface 1106 in FIG. 11E-1 because the first user 1101a interacted with the first user interface 1106 last. In some embodiments, in accordance with a determination that the first user interacted with (e.g., by looking or gazing at, and/or by performing an air gesture directed to) a second user interface (e.g., a messages user interface, maps user interface, media user interface, web browsing user interface, a game user interface, or another user interface of an application, such as a user interface of an application described with reference to method 800 and/or 1000) that is different from the first user interface last before the first user interface element was selected, the respective user interface of the respective application that the first user interface element is selectable to share is the second user interface. For example, provided that the first user 1101a interacted last with the second user interface 1108 instead of the first user interface, the first computer system would optionally share the second user interface 1108 in FIG. 11E-1 instead of the first user interface 1106. In some embodiments, the second user interface is of the same application as the first user interface. In some embodiments, the second user interface is of an application that is different from the first application. As such, the first computer system optionally shares the user interface that the first user last used or with which the first user last interacted. For example, the first computer system optionally automatically shares the last-used user interface without further user input beyond the user input corresponding to selection of the first user interface element. In some embodiments, the first user interface element is selectable to display a menu from which the first user may select (e.g., provide an additional user input) for sharing a specific user interface. For example, in response to selection of the first user interface element, the first computer system optionally displays a menu of options corresponding to different user interfaces that are active on the first computer system. While displaying that menu, the first computer system optionally detects a user input (e.g., attention (e.g., gaze) of the first user and/or an air pinch gesture directed to a specific option in the menu) corresponding to a selection of one of the options that correspond to a user interface, and in response, the first computer system optionally shares the user interface that corresponds to that selected option. In some embodiments, the shared user interface is the user interface that the first user interacted with last before the first computer system displays the first user interface element. Sharing the user interface that the first user interacted with last reduces errors associated with unintended sharing of user interfaces and makes sharing user interfaces more efficient since the first computer system automatically shares the user interface that the first interacted with last without requesting additional user input beyond selection of the first user interface element.

In some embodiments, before detecting the selection of the first user interface element, the first computer system concurrently displays, via the one or more first display generation components, the respective user interface at the first location in the first three-dimensional environment and an indication that the respective user interface is not being shared with another user of a computer system. For example, in some embodiments, the first computer system concurrently displays the first user interface 1106 and a pill that indicates to the first user 1101a that the first user interface 1106 is not being shared (e.g., is private to the first user 1101a). In some embodiments, the indication that the respective user interface is not being shared is a separate user interface element that is displayed at a specific location (e.g., on top of, below, in front of, or another specific location) relative to a location of the respective user interface. In some embodiments, when the respective user interface is not being shared with another user of a computer system, the first computer system does not display the indication that the respective user interface is not being shared. For example, in some embodiments, when the respective user interface is not being shared with another user of a computer system, the first computer system may not display the indication that the respective user interface is not being shared (e.g., an indication that is dedicated to notifying that the respective user interface is not being shared). In some embodiments, in response to detecting the selection of the first user interface element, the first computer system concurrently displays, via the one or more first display generation components, the respective user interface at the first location in the first three-dimensional environment and an indication that the respective user interface is being shared with another user of the computer system, such as the first user interface 1106 and the pill 1106a in FIG. 11E-1. In some embodiments, the indication that the respective user interface is being shared is a separate user interface element that is displayed at the specific location (e.g., on top of, below, in front of, or another specific location) relative to the location of the respective user interface. In some embodiments, the indication that the respective user interface is being shared replaces the indication that the respective user interface is not being shared. In some embodiments, the indication that the respective user interface is being shared includes a portion that indicates with whom the respective user interface is being shared. For example, were the respective user interface to be shared with the second user of the second computer system, the indication that the respective user interface is being shared optionally includes content notifying that the respective user interface is shared specifically with the second user, such as including a name of the second user, an icon or photo representative of the second user, or another indicator that the respective user interface is being shared specifically with the second user. Displaying an indication that the respective user interface is not being shared before the first user interface element is selected and displaying an indication that the respective user interface is being shared in response to selection of the first user interface element notifies the first user of the shared status of the respective user interface, which distinguishes shared user interfaces from non-shared user interfaces in the first three-dimensional environment, and notifies the first user of the specific user with which the respective user interface is being shared.

In some embodiments, the one or more criteria include an additional criterion that is satisfied when attention (e.g., gaze) of a first user of the first computer system is directed to the second user, such as gaze point 1110b in FIG. 11D. For example, the first computer system optionally does not display the first user interface element until the first computer system detects that the first user is looking at the second user (e.g., independent of whether the second user is looking at the first user). As such, were the second user to be in the viewport of the first computer system (e.g., at a location in the first three-dimensional environment that is visible via the first display generation components of the first computer system) without the gaze of the first user directed to the second user being detected, the first computer system optionally does not display the first user interface element. In some embodiments, after detection that the gaze of the first user is directed to the second user, were the first user to direct their gaze away (e.g., look away) from the second user while the second user is still in the viewport of the first computer system, the first computer system would maintain display of the first user interface element. In some embodiments, the one or more criteria described above is not satisfied if the attention (e.g., gaze) of the first user is not directed to the second user. Displaying the first user interface element when at least the gaze of the first user is directed to the second user makes interpreting user intent to share a user interface more efficient since the displayed first user interface element is selectable to share with the second user specifically, who is the object of the first user's gaze, and reduces errors associated with sharing user interfaces with users with which the first user does not intend to share the respective user interface.

In some embodiments, the one or more criteria include another criterion that is satisfied when the attention (e.g., gaze) of the first user is directed to the second user for more than a threshold period of time (e.g., 0.5 s, 1 s, 4 s, 5 s, or another threshold period of time), such as gaze point 1110b in FIG. 11D being on the second user 1101b for more than the threshold period of time. For example, were the gaze of the first user to not be directed to the second user for more than the threshold period of time, the one or more criteria would optionally not be satisfied and the first user interface element would optionally not be displayed. Displaying the first user interface element when at least the gaze of the first user is directed to the second user for more than the threshold period of time makes interpreting user intent to share a user interface more efficient since the displayed first user interface element is selectable to share with the second user, who is the object of the first user's gaze for the threshold period of time, and reduces errors associated with sharing user interfaces with users with which the first user does not intend to share the respective user interface.

In some embodiments, displaying the first user interface element includes in accordance with a determination that the second location of the second user in the first three-dimensional environment is a first user position in the first three-dimensional environment, displaying the first user interface element at a first user interface element position in the first three-dimensional environment, such as the illustrated location of the user interface element 1114 in FIG. 11D, and in accordance with a determination that the second location of the second user in the first three-dimensional environment is a second user position, different from the first user position, in the first three-dimensional environment, displaying the first user interface element at a second user interface element position, different from the first user position, in the first three-dimensional environment. For example, were the location of the second user 1101b different from the illustrated location of the second user 1101b in FIG. 11D, the first computer system would optionally display the user interface element 1114 at a location that is different from the illustrated location of the user interface element 1114 in the first three-dimensional environment 1103 in FIG. 11D. As such, the first computer system optionally displays the first user interface element at different positions based on the position of the second user in the first three-dimensional environment. In some embodiments, a location of display of the first user interface element in the first three-dimensional environment is based on the second location of the second user, as described above with reference to step(s) 1202 of method 1200. In some embodiments, the position of the first user interface element is a position that is in between the position of the first user (e.g., the position of the viewpoint of the first user) and the position of the second user in the viewpoint of the first user of the first computer system. In some embodiments, were the position of the second user in the first three-dimensional environment to change, the first computer system updates the position of the first user interface element in the first three-dimensional environment. In some embodiments, the first computer system displays the first user interface element closer to the location of the first user than to the second location of the second user in the viewpoint of the first user of the first computer system. In some embodiments, the first computer system displays the first user interface element equidistance from the location of the first user and the second location of the second user in the viewpoint of the first user of the first computer system. Displaying the first user interface element at a position in the first three-dimensional environment that is based on a position of the second user in the first three-dimensional environment maintains a correspondence of the location of display of first user interface element in the first three-dimensional environment with the location of second user, which makes sharing the respective user interface more efficient, since the first user interface element is selectable to share the respective user interface specifically with the second user.

In some embodiments, while the respective user interface of the respective application is not shared between the first computer system and a third computer system (that are optionally collocated (e.g., the first user of the first computer system and the third user of the third computer system are collocated) in the physical environment, such as the physical environment described with reference to method 800 and/or 1000, such as described with reference to the respective user interface of the respective application not being shared between the first computer system and the second computer system), such as the third computer system 101c in FIG. 11F, and while the respective user interface of the respective application is associated with the first location in the first three-dimensional environment that is visible via the one or more first display generation components, the first computer system detects that one or more second criteria are satisfied, including a criterion that is satisfied when a third user of the third computer system is in the viewport of the first computer system at a third location in the first three-dimensional environment, such as described with reference to detecting that the one or more criteria are satisfied, including the criterion that is satisfied when the second user of the second computer system is in the viewport of the first computer system at the second location in the first three-dimensional environment in step(s) 1202 of method 1200, such as the third user 1101c being in the view of the first three-dimensional environment 1103 displayed via display generation component 120 in FIG. 11F. The one or more second criteria optionally includes one or more or all characteristics of the one or more criteria described with reference to method 1200, but associated with the first user and the third user instead of associated with the first user and the second user. In some embodiments, the third computer system includes one or more feature(s) of the first computer system and/or the second computer system, but is different from the first and second computer systems (e.g., the first computer system is optionally being worn by the first user, the second computer system is optionally being worn by the second user, and the third computer system is optionally being worn by the third user). In some embodiments, in response to detecting that the one or more second criteria are satisfied, the first computer system displays, via the one or more first display generation components, a second user interface element, different from the first user interface element, in the first three-dimensional environment that is selectable to share the respective user interface of the respective application with the third computer system (e.g., without being selectable to share the respective user interface with the second computer system), wherein the second user interface element is not displayed before detecting that the third user is in the viewport of the first computer system, such as described with reference to displaying the first user interface element in step(s) 1202 of method 1200, such as the user interface element 1118 in FIG. 11F. The second user interface element optionally includes one or more characteristics of the first user interface element described with reference to the first user interface element in step(s) 1202 of method 1200. Further, in some embodiments, the second user interface element is optionally specifically associated with the third user of the third computer system such that it is optionally specifically selectable to share the respective user interface with the third user, without being selectable to share the respective user interface with the second user described above.

In some embodiments, while displaying the second user interface element, the first computer system detects, via the one or more first input devices, selection of the second user interface element. For example, the first computer system optionally detects a gaze of the first user and/or an air gesture directed to the second user interface element. Additionally or alternatively, the first computer system optionally detects a voice input, an input via a mouse, touch screen or trackpad, or another type of input described herein that is directed to the second user interface element. Additionally or alternatively, in some embodiments, the selection of the second user interface element includes one or more characteristics described with reference to selections in methods 800, 1000, and/or 1200, such as with reference to the selection of the first user interface element in step(s) 1202 in method 1200.

In some embodiments, in response to detecting the selection of the second user interface element, the first computer system shares the respective user interface of the respective application with the third computer system (e.g., sharing of virtual content such as described with reference to method 800, 1000, and/or step(s) 1202 of method 1200), including causing the respective user interface of the respective application to be concurrently associated with the first location in the first three-dimensional environment and associated with a respective location in a third three-dimensional environment that is visible via one or more third display generation components of the third computer system, the respective location in the third three-dimensional environment corresponding to the first location in the first three-dimensional environment. For example, the first computer system would optionally share the respective user interface with the third computer system 101c provided that the first user 1101a selects the user interface element 1118 of FIG. 11F. As such, the first computer system optionally shares the respective user interface with additional or alternative users of computer systems using similar processes as described with reference to step(s) 1202 of method 1200. In some embodiments, when the first computer system (e.g., the first user of the first computer system) shares the respective user interface with the third computer system (e.g., the third user of the third computer system) in response to selection of the second user interface element, the respective user interface is not already shared with the second computer system (e.g., the first computer system has not earlier detected selection of the first user interface element described with reference to step(s) 1202 of method 1200). In some embodiments, when the first computer system (e.g., the first user of the first computer system) shares the respective user interface with the third computer system (e.g., the third user of the third computer system), the respective user interface is already shared with the second computer system (e.g., the first computer system earlier detected selection of the first user interface element described with reference to step(s) 1202 of method 1200). In some embodiments, when the respective user interface is shared between the first, second, and third computer systems, the respective user interface is associated with the first location in the first three-dimensional environment, the location in the second three-dimensional environment, and the respective location in the third three-dimensional environment. As such, the users of the computer system may interact with the respective user interface in their own environment. In some embodiments, the respective user interface is maintained at the same location in the first three-dimensional environment when it goes from not being shared with the third computer system to being shared with the third computer system, independent of whether or not it was already being shared between the first computer system and the second computer system. Additionally or alternatively, in some embodiments, were the respective user interface to already be shared with the second user when the first computer system detects selection of the second user interface element, the first computer system optionally moves the respective user interface to an ideal location in the respective environments of the first and second users when the first computer system initiates sharing of the respective user interface to include the third user, such as to a location (e.g., that is associated with a corresponding physical location) in the respective environments of the first and second users that is visible in the viewport (e.g., current field of view) of the first, second, and third computer systems when the sharing of the respective user interface with the third computer system is initiated. Sharing a user interface with a third user of a third computer system in response to selection of a second user interface element that is displayed in response to detection of the third user and that is dedicated to sharing the user interface with the third user specifically, reduces errors associated with sharing user interfaces with different users since the second user interface element is dedicated to sharing the user interface with the third user and makes sharing with collocated users more efficient since the second user interface element is dedicated to being selectable to sharing the user interface with a collocated user.

In some embodiments, in accordance with a determination that the one or more criteria are satisfied and that the one or more second criteria are satisfied (e.g., the second user and the third user are in the viewport of the first computer system at the same time), the first computer system concurrently displays, via the one or more first display generation components the first user interface element and the second user interface element, such as the concurrent display of the user interface element 1114 and the user interface element 1118 in FIG. 11F. As such, the first computer system optionally displays a respective user interface element for the respective person that the first user is collocated with in the physical environment. Thus, were the second user of the second computer system and the third user of the third computer system to be in the viewport of the first computer system (e.g., at locations in the first three-dimensional environment that are visible in the current viewport of the first computer system), the first computer system would optionally display the first user interface element that is selectable to share the respective user interface with the second user of the second computer system and the third user interface element that is selectable to share the respective user interface with the third user of the third computer system. Note that, were the first computer system to be collocated with more than two users of computers systems in the physical environment), the first computer system would optionally display a respective user interface element for each collocated user (e.g., each collocated user would optionally be associated with a separate user interface element that is selectable for sharing the respective user interface with the respective collocated user). Concurrently displaying the first user interface element that is selectable to share the respective user interface with the second user and the second user interface element that is selectable to share the respective user interface with the third user correspondence specific user interface elements to specific collocated users in the physical environment, and as such reduces errors associated with sharing with users with which the first user does not intend to share.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A through 13J generally illustrate examples of a first computer system sharing a user interface with a second computer system in response to detecting different user inputs directed to a user of the second computer system and to the user interface, where the first computer system and the second computer system are collocated in a physical environment in accordance with some embodiments.

In some embodiments, the first computer system 101a shares a user interface with the second computer system 101b in response to detecting that certain criteria are met. In some embodiments, the first computer system 101a detects a second user input while detecting a first user input directed to the user interface (e.g., while detecting a first user input directed to a grabber user interface element of the user interface such as described below), and if the second user input meets certain criteria, the first computer system 101a shares the user interface with the second computer system. The criteria optionally include a criterion that is satisfied when the second user input is directed to the second user 1101b.

In FIG. 13A, the first computer system 101a is displaying a first three-dimensional environment 1103 from a viewpoint of the first user 1101a (e.g., first user 1101a in overhead view 1302a of the first three-dimensional environment 1103) of the first computer system 101a (e.g., facing the back wall of the physical environment 1105 in which the first computer system 101a is located), such as described with reference to the first computer system 101a of FIG. 11A-1. The first three-dimensional environment 1103 of FIG. 13A is optionally the same as the first three-dimensional environment 1103 of FIG. 11A-1. Additionally, as described with reference to FIG. 11A-1, the first computer system 101a in FIG. 13A is collocated with a second computer system 101b in the physical environment 1105, as shown in overhead view 1302a in FIG. 13A. Overhead views 1302a through 1302k in FIGS. 13A through 13J show relative positioning of objects in the three-dimensional environment in a horizontal dimension and a depth dimension in the respective figure. The second computer system 101b in FIG. 13A is optionally displaying a second three-dimensional environment 1107 that is visible via a display generation component 120 of the second computer system 101b from a viewpoint of the second user 1101b, such as described with reference to FIG. 11A-2. Since the first user interface 1106 and the second user interface 1108 are not being shared between the first computer system 101a and the second computer system 101b, the second three-dimensional environment 1107 displayed by the second computer system 101b would not include the first user interface 1106 and the second user interface 1108 in FIG. 13A, such as described with reference to FIGS. 11A-1 and 11A-2.

In FIG. 13A, the first computer system 101a displays a grabber user interface element 1106b for the first user interface 1106 and a grabber user interface element 1108b for the second user interface 1108. The grabber user interface element 1106b is optionally selectable to move the first user interface 1106 in the first three-dimensional environment 1103 (e.g., in a direction and by a magnitude that corresponds to the input directed to the grabber user interface element 1106b) and the grabber user interface element 1108b is optionally selectable to move the second user interface 1108 in the first three-dimensional environment 1103 (e.g., in a direction and by a magnitude that corresponds to the input directed to the grabber user interface element 1108b). Further details regarding the grabber user interface elements are described with reference to method 1400.

In some embodiments, the first computer system 101a shares a user interface with a second computer system that is collocated in the physical environment with the first computer system in response to detecting that certain criteria are met. In some embodiments, the first computer system 101a detects a second user input while detecting a first user input directed to the user interface (e.g., while detecting a first user input directed to a grabber user interface element of the user interface such as described below), and if the second user input meets certain criteria, the first computer system 101a shares the user interface with the second computer system. The criteria optionally include a criterion that is satisfied when the second user input is directed to the second user 1101b.

In FIG. 13B, the first computer system 101a detects selection of the grabber user interface element 1106b of the first user interface 1106. For example, in FIG. 13B, the first computer system 101a optionally detects the hand 1116 of the first user 1101a performing an air pinch gesture directed to the grabber user interface element 1106b while attention (e.g., gaze) of the first user 1101a is directed to the grabber user interface element 1106b, as shown with gaze point 1310a. In response, the first computer system 101a visually confirms that the grabber user interface element 1106b is in a selected state (e.g., by changing a visual appearance of the grabber user interface element 1106b as shown from FIG. 13B to FIG. 13C), such as shown with the highlighting of the grabber user interface element 1106b of the first user interface 1106 from FIG. 13B to FIG. 13C.

From FIG. 13C to FIG. 13D, while the hand 1116 of the first user 1101a is still in the pinch pose of the air pinch gesture performed in FIG. 11B (e.g., while the tip of the index finger is still in contact with the tip of the thumb of the first user 1101a), the first user 1101a turns (e.g., rotates) towards the second user 1101b, as shown from overhead view 1302c of FIG. 13C to overhead view 1302d of FIG. 13D. Additionally, as shown in FIG. 13D, attention (e.g., gaze) of the first user 1101a is directed to the second user 1101b, as shown by gaze point 1310a in FIG. 13D being on a portion of the second user 1101b. For example, while the first computer system 101a is detecting that the hand of the first user 1101a is still in the air pinch pose from FIG. 13B, the first computer system 101a detects that attention (e.g., gaze) of the first user 1101a is directed to the second user 1101b, as shown with gaze point 1310b of the first user 1101a in FIG. 13D. In response, the first computer system 101a optionally shares the user interface that is associated with the grabber user interface element 1106b, which is the first user interface 1106.

In some embodiments, the first computer system 101a shares the first user interface 1106 in response to detecting that the attention (e.g., gaze) of the first user 1101a is directed to the second user 1101b for more than a threshold period of time, such as 0.5 s, 1 s, 4 s, 5 s, or another threshold period of time, such as shown in FIGS. 13E through 13G-2. In some embodiments, the threshold period of time of attention (e.g., gaze) of the first user 1101a being directed to the second user 1101b is to be met while the hand 1116 of the first user 1101a is still in the pinch pose of the air pinch gesture performed in FIG. 11B. In some embodiments, the first computer system 101a displays a progress user interface element 1320 indicative of an amount of progress until the threshold period of time has passed. In some embodiments, the first computer system 101a displays (e.g., initially displays) the progress user interface element 1320 in response to detecting that the attention (e.g., gaze) of the first user 1101a is directed to the second user 1101b (e.g., while the hand 1116 of the first user 1101a is still in the pinch pose of the air pinch gesture performed in FIG. 11B). For example, the first computer system 101a optionally goes from not displaying the progress user interface element 1320, as shown in FIG. 13D, to displaying the progress user interface element 1320, as shown in FIG. 13E, optionally because the first computer system 101a has detected that the attention (e.g., gaze) of the first user 1101a, as indicated by the gaze point 1310b in FIG. 13D, is directed to the second user 1101b. In some embodiments, the first computer system 101a updates the progress user interface element 1320 to indicate that the threshold period of time is being satisfied, such as shown from FIG. 13E to FIG. 13F, as shown with the change in appearance (e.g., the filling of the progress user interface element 1320 from FIG. 13D to FIG. 13E while the attention (e.g., gaze) of the first user 1101a is directed to the second user 1101b, as indicated by the gaze point 1310c in FIG. 13E. Note that the first computer system 101a optionally updates the progress user interface element 1320 independent of whether the input from the hand 1116 of the first user 1101a (e.g., from FIG. 13B to FIG. 13C to FIG. 13D to FIG. 13E to FIG. 13F, or, alternatively, from FIG. 13D to FIG. 13E to FIG. 13F) includes a movement component that requests movement of the first user interface 1106 while detecting the attention (e.g., gaze) of the first user 1101a is directed to the second user 1101b and while the hand 1116 of the first user 1101a is still in the pinch pose of the air pinch gesture performed in FIG. 11B. For example, even if the movement component is being detected and even if the first user interface 1106 is moving or has moved in response to the movement component, the first computer system 101a optionally continues to update the progress user interface element 1320 to indicate that progress to toward sharing of the first user interface 1106 is happening, optionally because the attention (e.g., gaze) of the first user 1101a is directed to the second user 1101b and/or the hand 1116 of the first user 1101a is still in the pinch pose of the air pinch gesture performed in FIG. 11B through the filling of the progress user interface element 1320. Additionally, note that were the first computer system 101a to move the first user interface 1106 in the first three-dimensional environment 1103 during the filling of the progress user interface element 1320, and the progress user interface element 1320 to be filled, the first computer system 101a would optionally share the first user interface 1106 from the location and/or orientation to which the first user interface 1106 was moved. Thus, the first computer system 101a optionally shares the first user interface 1106 from a location that is based on the movement of the first user interface 1106 (e.g., shares the first user interface 1106 from the position that the first user interface 1106 has when the progress user interface element 1320 is filled) were the first user interface 1106 to be moved.

In FIG. 13F, the progress user interface element 1320 indicates that the threshold amount of time has been reached, such as illustrated with the change in appearance of the progress user interface element 1320 from FIG. 13D to FIG. 13F. In response to reaching the threshold period of time of detecting that the attention (e.g., gaze) of the first user 1101a is directed to the second user 1101b for more than the threshold period of time (e.g., while the hand 1116 of the first user 1101a is still in the pinch pose of the air pinch gesture performed in FIG. 13B), the first computer system 101a shares the first user interface 1106 with the second computer system 101b, as shown in FIGS. 13G-1 and 13G-2.

As shown in FIGS. 13G-1 and 13G-2, the first user interface 1106 is being displayed in both the first three-dimensional environment 1103 of the first user 1101a and the second three-dimensional environment 1107 of the second user 1101b. That is, the first computer system 101a is displaying the first user interface 1106 in the first three-dimensional environment 1103, as shown in FIG. 13G-1, and the second computer system 101b is now displaying the first user interface 1106 in the second three-dimensional environment 1107, as shown in FIG. 13G-2. Note that the first three-dimensional environment 1103 of FIG. 13G-1 is optionally the same as the first three-dimensional environment 1103 of FIG. 13E-1 and the second three-dimensional environment 1107 of FIG. 13G-2 is optionally the same as the second three-dimensional environment 1107 of FIG. 11E-2.

Additionally, as shown in FIG. 13G-2, the second computer system 101b displays the first user interface 1106 at a location in the second three-dimensional environment that corresponds to the location of display of the first user interface 1106 in the first three-dimensional environment 1103. Note that in some embodiments, the location of display of the first user interface 1106 in the first three-dimensional environment 1103 of the first user 1101a does not change in response to sharing of the first user interface 1106.

FIGS. 13H through 13J illustrate the first computer system 101a detecting and responding to input for sharing the first user interface 1106 with the third user 1101c of the third computer system 101c while already sharing the first user interface 1106 with the second user 1101b of the second computer system 101b in accordance with some embodiments.

In FIG. 13H, the first user 1101a is collocated in the physical environment 1105 with the second user 1101b and the third user 1101c (e.g., the first computer system 101a has determined that the first computer system 101a is collocated with the second computer system 101b and the third computer system 101c in the room (e.g., the physical environment 1105). In FIG. 13H, the pill 1106a of the first user interface 1106 indicates that the first user interface 1106 is being shared with the second user 1101b of the second computer system 101b, as described with reference to FIG. 13G-1. Further, in FIG. 13H, the first computer system 101a detects selection of the grabber user interface element 1106b of the first user interface 1106, such as described with reference to the first computer system 101a detecting selection of the grabber user interface element 1106b of the first user interface 1106 in FIG. 13B. Additionally, in FIG. 13H, while detecting the selection of the grabber user interface element 1106b of the first user interface 1106, the first computer system 101a detects attention (e.g., gaze) of the first user 1101a directed to the second user 1101b, as indicated by the gaze point 1310d.

From FIG. 13H to 13I, the threshold period of time of input detection has passed (e.g., the attention (e.g., gaze) of the first user 1101a has been directed to the second user 1101b for the threshold period of time while the grabber user interface element 1106b of the first user interface 1106 is selected). In response, the first computer system 101a adds the third user 1101c to the set of computer systems between which the first user interface 1106 is being shared, such as shown from FIG. 13H to FIG. 13J. That is, while sharing the first user interface 1106 with the second computer system 101b, as shown in FIG. 13H, in response to the criteria for sharing with the third computer system 101c being met, including the threshold period of time of input detection, the first computer system 101a causes the first user interface 1106 to be shared with between the first computer system 101a, the second computer system 101b, and the third computer system 101c, as shown in FIG. 13J. In some embodiments, the first computer system 101a fades out the progress user interface element 1320 fades out (e.g., is reduced in visual prominence once the threshold period of time has been met, such that at some point in time it is no longer being displayed).

In FIG. 13J, the pill 1106a of the first user interface 1106 that is being displayed by the first computer system 101a indicates that the first user interface 1106 is being shared with the second user 1101b of the second computer system 101b and the third user 1101c of the third computer system 101c. In some embodiments, when the first user interface 1106 transitions from being shared between the first computer system 101a and the second computer system 101b to being shared between the first computer system 101a, the second computer system 101b, and the third computer system 101c, the pill 1106a of FIG. 13G-2 that is displayed by the second computer system 101b would indicate that the first user interface 1106 is shared with the first user 1101a and the third user 1101c. Furthermore, since the first user interface 1106 is shared with the third computer system 101c in FIG. 13J, the first user interface 1106 would be associated with a location in a third three-dimensional environment that corresponds to the location of display of the first user interface 1106 in the first three-dimensional environment 1103 of the first user 1101a. Further, since the first user interface 1106 is shared between the first user 1101a, the second user 1101b, and the third user 1101c, any of the first user 1101a, the second user 1101b, and the third user 1101c can interact with the first user interface 1106. Further details regarding the embodiments illustrated and described with reference to FIGS. 13A through 13J are provided with reference to method 1400.

FIG. 14 is a flowchart illustrating an exemplary method 1400 for sharing a user interface with a second computer system in response to detecting different user inputs directed to a user of the second computer system and to the user interface in accordance with some embodiments. In some embodiments, the method 1400 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, the method 1400 (e.g., the method 1400 of FIG. 14) is performed at a first computer system in communication with one or more first display generation components and one or more first input devices. In some embodiments, the first computer system has one or more characteristics of the computer systems in methods 800, 1000, and/or 1200. In some embodiments, the one or more first display generation components have one or more characteristics of the one or more display generation components in methods 800, 1000, and/or 1200. In some embodiments, the one or more first input devices have one or more characteristics of the one or more input devices in methods 800, 1000, and/or 1200.

In some embodiments, (1402a) while a respective user interface of a respective application (e.g., the respective user interface of the respective application described with reference to method 1200, or another user interface of an application, such as a user interface of an application described with reference to method 800 and/or 1000) is not shared between the first computer system and a second computer system that are collocated in a physical environment, such as the first user interface 1106 being private to the first three-dimensional environment 1103 of the first computer system 101a and not shared between the first computer system 101a and the second computer system 101b that are collocated in the physical environment 1105 in FIG. 13A, such as described with reference to no user interface of an application (e.g., no user interface of any application) being shared between the first computer system and the second computer system that are collocated (e.g., the first user of the first computer system and the second user of the second computer system are collocated) in the physical environment in method 1200, the first computer system displays (1402b), via the one or more first display generation components, the respective user interface of the respective application at a first location in a first three-dimensional environment that is visible via the one or more first display generation components, such as the first user interface 1106 in FIG. 13A, such as described with reference to the display of the respective user interface of the respective application at the first location when the first location of the first three-dimensional environment is in the viewport of the first computer system with reference to method 1200. In some embodiments, (1402a) while the respective user interface of the respective application is not shared between the first computer system and the second computer system that are collocated in the physical environment, and while detecting a first input directed to the respective user interface of the respective application, such as the index finger and thumb of the hand 1116 of the first user 1101a being in contact with each other in FIG. 13C as part of the air pinch gesture that started while the gaze point 1310a was directed to the grabber user interface element 1106b of the first user interface 1106 in FIG. 13B, the first computer system detects (1402c), via the one or more first input devices, a second input that is different from the first input, such as gaze point 1310b in FIG. 13D. In some embodiments, detecting the second input while detecting the first input includes detecting the second input when the first input is detected (e.g., the first and second inputs are detected at the same time). In some embodiments, detecting the second input while detecting the first input includes detecting the second input after a detecting a start of the first input and before detecting a completion (e.g., an ending) of the first input. In some embodiments, the first input is or includes a selection input directed to the respective user interface or directed to a user interface element that is associated with the respective user interface, such as the selection element described below, and in response to the first input (e.g., while the first input is being detected), the respective user interface or the user interface element is in a selected state. In some embodiments, while detecting the first input includes while the respective user interface is in the selected state (e.g., in response to the first input). In some embodiments, the respective user interface or the user interface element is in the selected state for as long as the first input is directed to the respective user interface or the user interface element, and the respective user interface or the user interface element is not in the selected state when the first input directed to the respective user interface or the user interface element has ceased being detected (e.g., the selection input of the first input has been released or has ended). For example, if the first input includes an air pinch gesture, the first input optionally starts when the air pinch gesture is detected, the first input continues while the air pinch hand shape is held, and the first input is terminated or ended when the air pinch gesture is released (e.g., the hand releases the air pinch hand shape). In some embodiments, while displaying the respective user interface at the first location in the first three-dimensional environment, the computer system detects, via the one or more first input devices, the first input. In some embodiments, while detecting the first input, the computer system detects the second input (e.g., concurrently with the first input). In some embodiments, the first computer system detects the first input via the one or more first input devices as well. In some embodiments, detecting the first and/or second inputs includes one or more characteristics described with reference to detecting inputs and/or selections in methods 800, 1000, and/or 1200. The first and second inputs are described in detail later below. A communication session (e.g., a communication session described with reference to method 800, 1000, and/or 1200) is optionally not active between the first and second computer systems when the first computer system displays the respective user interface and/or detects the second input.

In some embodiments, while detecting the second input (and optionally while detecting the first input), in accordance with a determination that one or more first criteria are met, including a criterion that is met when the second input is directed to a second user of the second computer system (e.g., the second user and/or the second computer system is optionally visible in physical form (e.g., not an avatar of the second user) in (e.g., through) the viewport of the first computer system at a location in the first three-dimensional environment, because the second user is physically located at the location in the physical environment that corresponds to (e.g., is the same as) the second location in the first three-dimensional environment and the second input directed to the second user optionally includes attention (e.g., gaze) of the first user being directed to the second user and/or another type of user input from the first user and directed to the second user, such as the first user using their hand to point at the second user with their index finger), such as gaze point 1310b being directed to the second user 1101b in FIG. 13D, the first computer system shares (1402d) the respective user interface of the respective application with the second computer system (e.g., such as described with reference to sharing of the respective user interface of the respective application in method 1200 and/or with reference to sharing of virtual content as described with reference to method 800 and/or 1000), including causing the respective user interface of the respective application to be concurrently associated with the first location in the first three-dimensional environment and associated with a location in a second three-dimensional environment that is visible via one or more second display generation components of the second computer system, the location in the second three-dimensional environment corresponding to the first location in the first three-dimensional environment, such as shown by the first user interface 1106 being in the first three-dimensional environment 1103 in FIG. 13G-1 and the first user interface 1106 being in the second three-dimensional environment 1107 in FIG. 13G-2. For example, while displaying the respective user interface at the first location in the first three-dimensional environment, the computer system optionally detects a user input directed to the respective user interface. Continuing with this example, while the user input directed to the respective user interface is being detected, the computer system optionally additionally detects another user input that is directed to the second user of the second computer system. In response, the computer system optionally shares the respective user interface with the second computer system, such as described with reference to the sharing of the respective user interface of the respective application in method 1200. A corresponding physical location of the respective user interface (e.g., the location and/or orientation of the respective user interface relative to the same physical environment that is in the first three-dimensional environment and the second three-dimensional environment) is optionally the same between the first three-dimensional environment and the second three-dimensional environment. Note that the sharing of the respective user interface optionally initiates a communication session (e.g., a real-time communication session or another communication session) between the first and second computer systems, such as a communication session described with reference to methods 800, 1000, and/or 1200. In some embodiments, the computer system detects the second input and while detecting the second input, if the first criteria are met, the computer system shares the respective user interface as described above. If the second input includes attention (e.g., gaze) of the first user directed to the second user (e.g., first user is looking at the second user and/or the second computer system), the second input optionally starts when the attention of the first user is initially detected as being directed to the second user, the second input continues while the attention of the first user is directed to the second user, and the second input is terminated or ended when the attention of the first user is no longer directed to the second user and/or after a threshold amount of time has been reached while the attention of the first user is directed to the second user. Additionally or alternatively, in some embodiments, the method includes while displaying the respective user interface of the respective application at the first location in the first three-dimensional environment, detecting, via the one or more first input devices, a first input that includes a selection input associated with selection of the respective user interface of the respective application, and in accordance with a determination that a second input, different from the first input, is also detected when the selection input is detected, and in accordance with a determination that the one or more first criteria are met, including a criterion that is met when the second input is directed to the second user of the second computer system, sharing the respective user interface as described above. In some embodiments, the first computer system moves the respective user interface to an ideal location in the first three-dimensional environment when the first computer system initiates sharing of the respective user interface, such as to a location in the first three-dimensional environment that, corresponding to a physical location in the physical environment, is in the current viewports (e.g., field of views) of the first and second computer systems when the sharing of the respective user interface is initiated. In some embodiments, the first computer system maintains the respective user interface at the same location in the first three-dimensional environment when it goes from not being shared with the second computer system to being shared with the second computer system. Sharing a user interface with a collocated user in response to detection of different user inputs directed to the collocated user and to the user interface reduces errors associated with sharing user interfaces with different users since the user interface is shared specifically with the collocated user to which the user input is directed and since the user interface to which the other user input is directed becomes the shared user interface, thus making sharing with collocated users more efficient.

In some embodiments, the first input directed to the respective user interface of the respective application is an input corresponding to a request to move the respective user interface of the respective application in the first three-dimensional environment, such as the first input directed to the grabber user interface element 1106b in FIG. 13C, which when selected, optionally causes the first user interface 1106 to move in the first three-dimensional environment 1103 in accordance with movement of the hand 1116 of the first user 1101a. For example, the first input is optionally directed to a user interface element for moving the respective user interface in the first three-dimensional environment, such as the selection element described below. The first computer system optionally displays the user interface element having a predetermined spatial relationship (e.g., a predetermined position and/or orientation) relative to the respective user interface. For example, the predetermined spatial relationship optionally includes the user interface element being displayed above the respective user interface, below the respective user interface, to the left of the respective user interface, to the right of the respective user interface, or another predetermined spatial relationship relative to the respective user interface (e.g., in the viewpoint of the first user of the first computer system). In some embodiments, were the first input to continue being detected after sharing of the respective user interface with the second computer system is initiated, were the first input to include the input that corresponds to the request to move the respective user interface in the first three-dimensional environment, and were the input that corresponds to the request to move the respective user interface in the first three-dimensional environment to include a first amount of requested movement, first computer system moves the respective user interface by the first amount of requested movement and may cause the respective user interface to be moved in the second three-dimensional environment of the second computer system by the first amount of requested movement as well. In some embodiments, though the first input may include the input corresponds to a request to move the respective user interface in the first three-dimensional environment, were the input to not request any movement, the first computer system would not move the respective user interface in the first three-dimensional environment. Including a first user input that corresponds to a request to move the respective user interface in the environment in the process for sharing a user interface reduces errors associated with unintended sharing of user interfaces since the shared user interface is the user interface that is subject to the movement input and makes sharing of user interfaces more efficient since the shared user interface is the user interface that is subject to the movement input.

In some embodiments, displaying the respective user interface of the respective application includes concurrently displaying, via the one or more first display generation components the respective user interface of the respective application and a user interface element for moving the respective user interface of the respective application in the first three-dimensional environment. In some embodiments, the user interface element is a selection element (e.g., a grabber or handlebar virtual object) associated with the respective user interface (e.g., virtual content) that is selectable to initiate movement of the respective user interface (e.g., virtual content) in the three-dimensional environment (e.g., the first three-dimensional environment) such as described with reference to method 800. In some embodiments, the first input is directed to the user interface element for moving the respective user interface of the respective application in the first three-dimensional environment such as the first input directed to the grabber user interface element 1106b of the first user interface 1106 in FIG. 13D. For example, the first input optionally includes an air pinch gesture performed by the hand of the first user of the first computer system (and directed to the user interface element), such as described below, while attention (e.g., gaze) of the first user is directed to the user interface element. In some embodiments, were the hand of the first user to move a first amount in the first three-dimensional environment while the air pinch pose of the hand is being held, the first computer system moves the respective user interface by a first respective amount in the first three-dimensional environment that corresponds to the first amount of hand movement. In some embodiments, were the hand of the first user to move a second amount, different from the first amount, in the first three-dimensional environment while the air pinch pose of the hand is being held, the first computer system moves the respective user interface by a second respective amount, different from the first respective amount, in the first three-dimensional environment. In some embodiments, were the hand of the first user to move in a first direction in the first three-dimensional environment while the air pinch pose of the hand is being held, the first computer system moves the respective user interface in a first corresponding direction (e.g., the first direction) in the first three-dimensional environment. In some embodiments, were the hand of the first user to move in a second direction, different from the first direction, in the first three-dimensional environment while the air pinch pose of the hand is being held, the first computer system moves the respective user interface in a second corresponding direction (e.g., the second direction) in the first three-dimensional environment that is different from the first corresponding direction in the first three-dimensional environment. Further, note that the first computer system optionally displays different user interface elements for moving different user interfaces in the first three-dimensional environment. As such, in some embodiments, the first computer system may display a separate user interface element for moving a user interface for each user interface that the first computer system displays. Including a first user input that is directed to a user interface element for moving a respective user interface in the process for sharing a user interface reduces errors associated with unintended sharing of user interfaces and makes sharing of user interfaces more efficient since the shared user interface is the user interface that is specifically associated with the user interface element for moving the respective user interface.

In some embodiments, detecting the first input includes detecting that a hand of a first user of the first computer system is in a pinch pose (and/or is performing an air pinch gesture), such as the index finger and thumb of the hand 1116 of the first user 1101a being in contact with each other in FIG. 13C as part of the air pinch gesture that started while the gaze point 1310a was directed to the grabber user interface element 1106b of the first user interface 1106 in FIG. 13B. For example, if the first input includes an air pinch gesture, the first input optionally starts when the air pinch gesture is detected (and optionally when attention (e.g., gaze) of the first user is detected when the air pinch gesture is detected), the first input optionally continues while the air pinch hand shape is held, and the first input optionally is terminated or ended when the air pinch gesture is released (e.g., the hand releases the air pinch hand shape). For example, the first input optionally includes an air pinch gesture performed by a hand of the user of the computer system, such as the thumb and index finger of the hand of the user starting more than a threshold distance (e.g., 0.1, 0.2, 0.5, 1, 2, or 5 cm) apart and coming together and touching at the tips, such as described with reference to method 800. For example, the first input is optionally directed to the selection element described above because the attention (e.g., gaze) of the first user is directed to the selection element when the air pinch gesture is performed (e.g., when the index finger and thumb of the user contact each other in the pinch pose). Were the attention (e.g., gaze) of the user directed elsewhere (e.g., to somewhere other than the selection element), the first input would optionally be directed to where that attention (e.g., gaze) of the first user is directed, which in this example is somewhere other than to the selection element. Including a first user input directed to a respective user interface that includes a hand of the first user being in a pinch pose in the process for sharing the user interface reduces errors associated with unintended sharing of user interfaces and makes sharing of user interfaces more efficient since the shared user interface is the user interface to which the hand of the first user in the pinch pose is directed.

In some embodiments, the second input includes attention (e.g., gaze) of a first user of the first computer system directed to the second user of the second computer system, such as the gaze point 1310b of the first user 1101a being directed to the second user 1101b in FIG. 13D. For example, while the respective user interface or the user interface element described with reference to step(s) 1402 is in the selected state, as described with reference to step(s) 1402, the first computer system optionally detects that the attention (e.g., gaze) of the first user is directed to the second user (e.g., directed to a portion of the second user). For example, the first input optionally includes the air pinch gesture performed by the hand of the first user, as described above, and while the hand is still in the pinched pose (e.g., is in the air pinch hand shape), the first computer system optionally detects that the attention (e.g., gaze) of the first user is directed to the second user. In some embodiments, the attention (e.g., gaze) of the first user is directed to the eye(s) of the second user of the second computer system. In some embodiments, the attention (e.g., gaze) of the first user would not be directed to the second user were the attention (e.g., gaze) of the first user not directed to the eye(s) of the second user. In some embodiments, were the attention (e.g., gaze) of the first user directed to someone other than the second user, the one or more first criteria described with reference to step(s) 1402 would not be met, so the first computer system would not share the user interface with the second user, but criteria for sharing with the other user to which the attention (e.g., gaze) of the first user might be met, so the first computer system might share the user interface with the other user in accordance with satisfaction of the criteria for sharing with the other user. Including a second user input that includes attention (e.g., gaze) of the first user of the first computer system directed to the second user of the second computer system in the process for sharing the user interface with the second user reduces errors associated with unintended sharing of user interfaces and makes sharing of user interfaces more efficient since the shared user interface is the user interface to which the attention (e.g., gaze) of the first user is directed.

In some embodiments, the one or more first criteria includes a criterion that is met when the attention (e.g., gaze) of the first user is directed to the second user for more than a threshold period of time (e.g., 0.5 s, 1 s, 4 s, 5 s, or another threshold period of time), such as the gaze point 1310b of the first user 1101a being directed to the second user 1101b for more than the threshold period of time in FIG. 13D. For example, were the attention (e.g., gaze) of the first user to not be directed to the second user for more than the threshold period of time, the one or more first criteria would optionally not be satisfied and the respective user interface would optionally not be shared. Including a second user input that includes attention (e.g., gaze) of the first user directed to the second user for at least a threshold period of time in the process for sharing the user interface with the second user reduces errors associated with unintended sharing of user interfaces and makes sharing of user interfaces more efficient since the shared user interface is the user interface to which the attention (e.g., gaze) of the first user is directed for at least the threshold period of time.

In some embodiments, while detecting the second input, the first computer system displays, via the one or more first display generation components, a user interface element (e.g., a progress element, progress bar that fills, a progress circle that fills clockwise or inside to outside, or progress indicator, or another user interface element) that indicates an amount of progress until the one or more first criteria are met, such as the progress user interface element 1320 in FIG. 13E. In some embodiments, the one or more first criteria include a criterion that is met when the amount of progress is a first amount of progress (e.g., full progress), such as the full progress that is indicated by the progress user interface element 1320 in FIG. 13F. For example, were the progress element that indicates the amount of progress to indicate a second amount of progress that is less than the first amount of progress, the one or more first criteria would optionally not be met. In some embodiments, the first computer system updates the progress element over time. For example, when the one or more first criteria include the criterion that is met when the gaze of the first user is directed to the second for more than the threshold period of time, such as described above, the first computer system optionally updates the progress element to indicate an amount of progress until the one or more first criteria. For example, were the threshold period of time to be four seconds, when one second is past, the progress element optionally has a first appearance (e.g., a first amount of fill, a first color, or another first appearance), when three seconds are past, the progress element has a second appearance (e.g., a second amount of fill, a second color, or another second appearance), and when four seconds are past, the user interface element has a third appearance (e.g., a third amount of fill, a third color, or another third appearance), where each appearance indicates how much progress has been reached until the one or more first criteria are met and/or how much progress is needed until the one or more first criteria are met. In some embodiments, the first computer system updates the progress element as long as the gaze of the first user is directed to the second user (e.g., while the hand of the first user is in the air pinch pose). In some embodiments, were the first user to look away from the first user while the first computer system is displaying the progress element and while the progress element indicates an amount of progress that is less than the one or more first criteria being met, the first computer system reduces in visual prominence (e.g., fades out or hides) the progress element and ceases continuing progress until the one or more first criteria are met. In some embodiments, the first computer system increases in visual prominence (e.g., fades in) the progress element when the first user looks again at the second user, at which the first computer system may begin updating the appearance of the progress element again (e.g., restart progressing from no progress or resume from where the progress was last left) in accordance with further progress being made toward the one or more first criteria being met. In some embodiments, the progress element indicates progress, as long as attention (e.g., gaze) of the first user is directed to the second user (e.g., while the hand of the first user is in the pinched pose of the air pinch pose). In some embodiments, the first computer system displays the progress element in between the viewpoint of the first user and the location of the user to which the progress element is associated (e.g., the second user were the progress element indicating progress until intent to share (or until sharing of) the respective user interface with the second user is confirmed or a third user indicating progress until intent to share (or until sharing of) the respective user interface with the third user such as described below). In some embodiments, the first computer system does not display the progress element until the start of the second input is detected. In some embodiments, were the first computer system to detect the second input without detection of the first input happening, the first computer system would not display the progress element. In some embodiments, were the second input directed to a third user (instead of being directed to the second user) while detection of the first input is happening, the first computer system would display the progress element for the third user instead of for the second user. Displaying a progress indicator for indicating to the first user an amount of progress until the one or more first criteria are met visually confirms to the first user whether progress is being made toward satisfaction of the one or more first criteria and visually confirms to the first user the amount of progress that has been made toward satisfaction of the one or more first criteria, which may reduce errors associated with operating the first computer system to share a user interface.

In some embodiments, while detecting the second input, in accordance with a determination that the first location in the first three-dimensional environment is not in (e.g., is not visible) a viewport of the first computer system while detecting the second input, the first computer system forgoes displaying, via the one or more first display generation components, the respective user interface of the respective application. For example, were the first location in the first three-dimensional environment 1103, which is the location of the first user interface 1106 in the first 1103, not in the view of the first three-dimensional environment 1103 in FIG. 13E, the first computer system would optionally forgo displaying the first user interface 1106 in FIG. 13E. As such, while detecting the second input, were the respective user interface to not be in the current viewport (e.g., field of view) of the first computer system, the first computer system optionally forgoes displaying the respective user interface while detecting the second input. In some embodiments, the first input includes a movement component (e.g., the first user moves their hand while the index finger and thumb of the first user is in contact with each other) that requests movement of the respective user interface. In some embodiments, when the first computer system detects the first input, the respective user interface is in the current viewport of the first computer system. In some embodiments, the first computer system has moved the respective user interface to a location in the first three-dimensional environment that is outside of the current viewport in accordance with the movement component of the first input. In some embodiments, when the first computer system detects the first input, the respective user interface is in the current viewport, and then the first user rotates their head, thus providing input to the first computer system requesting to change the orientation of the viewpoint to be toward the second user after grabbing the respective user interface (e.g., while grabbing the respective user interface), which causes the respective user interface to no longer be in the viewport of the first computer system. Forgoing display of the respective user interface while detecting the second input that is directed to the second user when the first location in the first three-dimensional environment is not in the viewport during detecting of the second input maintains consistency of presentation of the respective user interface at its respective location in the first three-dimensional environment since the respective user interface is not displayed when its respective location in the first three-dimensional environment is not in the viewport, and reduces errors associated with misplacing the respective user interface in the first three-dimensional environment.

In some embodiments, while detecting the second input, in accordance with a determination that the first location in the first three-dimensional environment is in (e.g., is visible) a viewport of the first computer system while detecting the second input, the first computer system displays, via the one or more first display generation components, the respective user interface of the respective application, such as shown with display of the first user interface 1106 in FIG. 13E. As such, while detecting the second input, were the respective user interface to be in the current viewport (e.g., field of view) of the first computer system, the first computer system optionally displays the respective user interface while detecting the second input. In some embodiments, the first input includes a movement component (e.g., the first user moves their hand) that requests movement of the respective user interface. In some embodiments, when the first computer system detects the first input, the respective user interface is in the current viewport of the first computer system. In some embodiments, the first computer system has moved the respective user interface to a location in the first three-dimensional environment that is still in the current viewport of the first computer system in accordance with the movement component of the first input. In some embodiments, when the first computer system detects the first input, the respective user interface is in the current viewport, and then the first user rotated their head, thus providing input to the first computer system requesting to change the orientation of the viewpoint to be toward the second user after the grabbing of the respective user interface via the selection element described above (e.g., while grabbing the respective user interface), but the respective user interface is still in the current viewport because the change in the orientation of the viewpoint was not a change that resulted in the location of the first three-dimensional environment at which the respective user interface is positioned being outside of the current viewport of the first computer system. Displaying the respective user interface while detecting the second input that is directed to the second user when the first location in the first three-dimensional environment is in the viewport of the first computer system maintains consistency of presentation of the respective user interface at its respective location in the first three-dimensional environment since the respective user interface is displayed when its respective location in the first three-dimensional environment is in the viewport, and reduces errors associated with misplacing the respective user interface in the first three-dimensional environment.

In some embodiments, the first computer system is also collocated with a third computer system in the physical environment (e.g., the first user of the first computer system is optionally collocated with the second user of the second computer system and the third user of the third computer system in the physical environment), such the third computer system 101c in FIG. 13H, which is being used by the third user 1101c. In some embodiments, while the respective user interface of the respective application is not shared between the first computer system and the third computer system, and while detecting a third input directed to the respective user interface of the respective application, the first computer system detects, via the one or more first input devices, a fourth input that is different from the third input, such the first computer system detecting gaze point 1310e in FIG. 13H while the index finger and thumb of the hand 1116 of the first user 1101a is in contact with each other in FIG. 13H as part of an air pinch gesture that was optionally started while the gaze of the first user 1101a was directed to the grabber user interface element 1106b of the first user interface 1106 in FIG. 13H. In some embodiments, the third input is the same as the first input (e.g., the third input is a continuation of the first input). For example, as described above, if the first input includes an air pinch gesture (e.g., directed to the respective user interface (e.g., to the selection element described above)), the first input optionally starts when the air pinch gesture is detected, the first input continues while the air pinch hand shape is held, and the first input is terminated or ended when the air pinch gesture is released (e.g., the hand releases the air pinch hand shape). Continuing with this example, the when the third input is detected, the first input is optionally still continuing, so the third input is optionally the same first input that has not been terminated or ended (e.g., the air pinch gesture of the first input optionally has not been released). In some embodiments, the third input is different from the first input. For example, the third input is optionally another air pinch gesture that is detected after the termination or ending of the air pinch gesture of the first input. In some embodiments, the third input includes one or more features of the first input described herein with reference to method 1400. For example, the third input is optionally directed to a user interface element for moving the respective user interface in the first three-dimensional environment, such as the selection element described above.

In some embodiments, while detecting the fourth input, in accordance with a determination that one or more second criteria are met, including a respective criterion that is met when the fourth input is directed to a third user of the third computer system, such as the gaze point 1310e being directed to the third user 1101c in FIG. 13H, the first computer system shares the respective user interface of the respective application with the third computer system (e.g., sharing of virtual content such as described with reference to method 800, 1000, 1200, and/or step(s) 1402), including causing the respective user interface of the respective application to be concurrently associated with the first location in the first three-dimensional environment and associated with a respective location in a third three-dimensional environment that is visible via one or more third display generation components of the third computer system, the respective location in the third three-dimensional environment corresponding to the first location in the first three-dimensional environment. For example, the first computer system 101a would optionally share the first user interface 1106 with the third computer system 101c as shown by pill 1106a in FIG. 13J, provided that the gaze point 1310e was directed to the third user 1101c while the index finger and thumb of the hand 1116 of the first user 1101a is in contact with each other from FIG. 13H to FIG. 131. As such, the first computer system optionally shares the respective user interface with additional or alternative users of computer systems using similar processes as described with reference to step(s) 1402 of method 1400. In some embodiments, the user with which the first computer system shares the respective user interface is the user to which the input (e.g., the second input, described with reference to step(s) 1402, or the fourth input described above) is directed. For example, the first computer system optionally shares the respective user interface with the third user, as described above, and not to a fourth user of another computer system, because the third user is the one to whom the fourth input described above is directed. In some embodiments, when the first computer system (e.g., the first user of the first computer system) shares the respective user interface with the third computer system (e.g., the third user of the third computer system), as described above, the respective user interface is not already shared with the second computer system. In some embodiments, when the first computer system (e.g., the first user of the first computer system) shares the respective user interface with the third computer system (e.g., the third user of the third computer system), the respective user interface is already shared with the second computer system, and in these embodiments the sharing of the respective user interface with the second computer system is either maintained or ceased in response to the sharing of the respective user interface with the third computer system. Further, the first computer system may the respective user interface with additional and/or alternative users of computer systems, performing similar operations as described above with reference to the sharing of the respective user interface with the second user and/or third user. In some embodiments, when the respective user interface is shared between the first, second, and third computer systems, the respective user interface is associated with the first location in the first three-dimensional environment, the location in the second three-dimensional environment, and the respective location in the third three-dimensional environment. As such, the users of the computer system may interact with the respective user interface in their own environment. In some embodiments, the respective user interface is maintained at the same location in the first three-dimensional environment when it goes from not being shared with the third computer system to being shared with the third computer system, independent of whether or not it was already being shared between the first computer system and the second computer system. Additionally or alternatively, in some embodiments, were the respective user interface to already be shared with the second user when the first computer system initiates sharing of the respective user interface with the third computer system, the first computer system optionally moves the respective user interface to an ideal location in the respective environments of the first and second users when the first computer system initiates sharing of the respective user interface to include the third user, such as to a location (e.g., that is associated with a corresponding physical location) in the respective environments of the first and second users that is visible in the viewport (e.g., current field of view) of the first, second, and third computer systems when the sharing of the respective user interface with the third computer system is initiated. Sharing a user interface with the third user of the third computer system in response to detection of different user inputs directed to the third user and to the user interface reduces errors associated with sharing user interfaces with different users since the user interface is shared specifically with the third user to which the user input is directed and since the user interface to which the other user input is directed becomes the shared user interface, thus making sharing with the third user more efficient.

In some embodiments, while a second user interface of a second application is not shared between the first computer system and the second computer system, the first computer system displays, via the one or more first display generation components, the second user interface of the second application at a second location in the first three-dimensional environment, such as the second user interface 1108 in FIG. 13A. In some embodiments, the second location in the first three-dimensional environment is different from the first location in the first three-dimensional environment. In some embodiments, the second user interface of the second application includes one or more features of the respective user interface of the respective application described with reference to method 1200 and/or step(s) 1402 of method 1400, or another user interface of an application, such as a user interface of an application described with reference to method 800 and/or 1000). In some embodiments, while detecting a third input directed to the second user interface of the second application, the first computer system detects, via the one or more first input devices, a fourth input that is different from the third input, such as the first computer system 101a detecting a gaze point of the first user 1101a while the index finger and thumb of the hand 1116 of the first user 1101a is in contact with each other in FIG. 13B as part of an air pinch gesture that was optionally started while the gaze of the first user 1101a was directed to the grabber user interface element 1108b of the second user interface 1108 in FIG. 13B. In some embodiments, the operations of detecting the fourth input while detecting the third input directed to the second user interface includes feature(s) described with reference to the operations of detecting the second input while detecting the first input directed to the respective user interface in step(s) 1402 of method 1400. In some embodiments, the third input includes one or more features of the first input described with reference to step(s) 1402 of method 1400, but is directed to the second user interface. In some embodiments, the fourth input includes one or more features of the second input described with reference to step(s) 1402 of method 1400, but directed to the second user (were the one or more second criteria to be met as described below).

In some embodiments, while detecting the fourth input, in accordance with a determination that one or more second criteria are met, including a respective criterion that is met when the fourth input is directed to the second user of the second computer system, such as the gaze point 1310b in FIG. 13D-13F being directed to the second user 1101b while the grabber user interface element 1108b of the second user interface 1108 is selected instead of the grabber user interface element 1106b of the first user interface 1106, the first computer system shares the second user interface of the second application with the second computer system, including causing the second user interface of the second application to be concurrently associated with the second location in the first three-dimensional environment and associated with a respective location in the second three-dimensional, the respective location in the second three-dimensional environment corresponding to the second location in the first three-dimensional environment. For example, the first computer system would optionally share the second user interface 1108 with the second computer system 101b in FIG. 13G-1 instead of the first user interface 1106 provided that the gaze point 1310b was directed to the second user 1101b while the grabber user interface element 1108b of the second user interface 1108 is selected instead of the grabber user interface element 1106b of the first user interface 1106. As such, the first computer system optionally shares the user interface to which the input is being directed. For example, since the first input is directed to the respective user interface in step(s) 1402 of method 1400, the first computer system shares the respective user interface with the second user (to whom the second input in step(s) 1402 of method 1400 is directed) without sharing the second user interface with the second user (e.g., unless the second user interface was already shared using the step(s) 1402 of method 1400 relative to the second user interface). Continuing with this example, since the third input described above is directed to the second user interface, the first computer system optionally shares the second user interface with the second user (to whom the fourth input described above is directed) without sharing the respective user interface (e.g., unless the respective user interface was already shared using the step(s) 1402 of method 1400). In some embodiments, were the first computer system to start sharing the respective user interface with the second user and then initiate sharing of the second user interface with the second user, the first computer system ceases sharing of the respective user interface with the second user and shares the second user interface or the first computer system concurrently shares the respective user interface and the second user interface with the second user concurrently. In some embodiments, the one or more second criteria include feature(s) of the one or more first criteria described with reference to step(s) 1402 of method 1400, but directed to the second user interface and/or the second user where applicable (e.g., correspondingly). In some embodiments, the respective criterion of the one or more second criteria described above includes one or more features of the criterion described with reference to step(s) 1402 above. In some embodiments, sharing the second user interface of the second application with the second computer system includes one or more features described with reference to sharing the respective user interface of the respective application in step(s) 1402 of method 1400. In some embodiments, the first computer system concurrently displays the respective user interface and the second user interface, provided that their associated locations in the first three-dimensional environment are in the current viewport of the first computer system. In some embodiments, the first computer system shares the respective user interface provided that the process described with reference to step(s) 1402 of method 1400 is performed. In some embodiments, the first computer system shares the second user interface with the second user provided that the process described above with reference to the second user interface is performed. In some embodiments, when the first computer system starts sharing of the second user interface with the second user, the respective user interface described with reference to step(s) 1402 of method 1400 is already being shared with the second user. In some embodiments, when the first computer system starts sharing of the second user interface, the respective user interface described with reference to step(s) 1402 of method 1400 is not already being shared with the second user. In some embodiments, the first computer system moves the second user interface to an ideal location in the first three-dimensional environment when the first computer system initiates sharing of the respective user interface, such as to a location in the first three-dimensional environment that, corresponding to a physical location in the physical environment, is in the current viewports (e.g., field of views) of the first and second computer systems when the sharing of the second user interface is initiated. In some embodiments, the first computer system maintains the second user interface at the same location in the first three-dimensional environment when it goes from not being shared with the second computer system to being shared with the second computer system. Sharing a specific user interface to which a user input is directed reduces errors associated with sharing user interfaces since the user interface to which the user input is directed becomes the shared user interface, thus making sharing with collocated users more efficient.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

FIGS. 15A-15Y generally illustrate examples of a first computer system sharing a user interface with a second computer system in response to detecting movement of the user interface to a user interface element for sharing the user interface with the second computer system, where the first computer system and the second computer system are collocated in a physical environment in accordance with some embodiments.

In some embodiments, the first computer system 101a is collocated in the physical environment 1105 with the second computer system 101b and the first computer system 101a displays a user interface element indicating a sharing zone in a three-dimensional environment for sharing virtual content between the first computer system 101a and the second computer system 101b. In some embodiments, were the first computer system 101a to display a user interface that is outside of the sharing zone, the first computer system 101a would not be sharing the user interface with the second computer system. In some embodiments, were the first computer system 101a to display a user interface inside of the sharing zone, the first computer system 101a would be sharing the user interface with the second computer system. In some embodiments, were the first computer system 101a to detect movement of a user interface to the sharing zone, the first computer system 101a would initiate sharing of the virtual content with the second computer system. In some embodiments, were the first computer system 101a to detect movement of a user interface to from the sharing zone to outside of the sharing zone, the first computer system 101a would cease sharing of the user interface with the second computer system. In some embodiments, the sharing zone is at an ideal location for viewing of content between the first user and the second user. Embodiments described herein with reference to FIGS. 15A-15Y are further described with reference to method 1600.

FIG. 15A shows the first computer system 101a (e.g., an electronic device) worn by the first user 1101a of the first computer system 101a displaying, via the display generation components 120 (e.g., display generation components 1-122a and 1-122b of FIG. 1), the first three-dimensional environment 1103 from a viewpoint of the first user 1101a (e.g., first user 1101a in overhead view 1502a of the first three-dimensional environment 1103) of the first computer system 101a (e.g., facing the back wall of the physical environment 1105 in which the first computer system 101a is located). The first user interface 1106 and the second user interface 1108 are likewise in the first three-dimensional environment 1103, and the second user interface 1108 is at a location in the first three-dimensional environment 1103 that is behind the first user interface 1106 from the viewpoint of the first user 1101a in FIG. 15A. Further, as shown in the overhead view 1502a of FIG. 15A, the first user 1101a of the first computer system 101a is collocated with the second user 1101b of the second computer system 101b. The overhead views 1502a through 1502y in FIGS. 15A through 15y show relative positioning of objects in the three-dimensional environment in a horizontal dimension and a depth dimension in the respective figure.

From FIG. 15A to FIG. 15B, the first user 1101a turns (e.g., rotates the head of the first user 1101a) towards the second user 1101b, as shown with the counterclockwise rotation of the first user 1101a from the overhead view 1502a of FIG. 15A to the overhead view 1502b of FIG. 15B. In response, the first computer system 101a updates the visible portion of the first three-dimensional environment 1103 in accordance with the change in viewpoint of the first user 1101a (e.g., with the change in the direction associated with the viewpoint of the first user 1101a), as shown with the change in the view of the first three-dimensional environment 1103 shown via display generation component 120 from FIG. 15A to FIG. 15B. Note that in some embodiments, from FIG. 15A to FIG. 15B, the first user interface 1106 does not move because no user input requesting movement of the first user interface 1106 has been detected. Further, the grabber user interface element 1106b of the first user interface 1106 is not changed in visual appearance (e.g., not highlighted) from FIG. 15A to FIG. 15B because no user input directed to the grabber user interface element 1106b of the first user interface 1106 has been detected. Additionally, in FIG. 15B, the second user 1101b is visible in the first three-dimensional environment 1103 via the display generation component 120 because the second user 1101b is at a location that corresponds to a location in the first three-dimensional environment 1103 that is now visible via the display generation component 120.

In FIG. 15C, the first computer system 101a is detecting selection of the grabber user interface element 1106b of the first user interface 1106, such as described with the first computer system 101a detecting selection of the grabber user interface element 1106b of the first user interface 1106 in FIG. 13B. For example, in FIG. 15C, the first computer system 101a optionally detects the hand 1116 of the first user 1101a performing an air pinch gesture directed to the grabber user interface element 1106b of the first user interface 1106 while attention (e.g., gaze) of the first user 1101a is directed to the grabber user interface element 1106b, as indicated by gaze point 1510a. In response, the first computer system 101a visually confirms that the grabber user interface element 1106b is in a selected state (e.g., by changing a visual appearance of the grabber user interface element 1106b a shown from FIG. 15B to FIG. 15C), such as shown with the highlighting of the grabber user interface element 1106b of the first user interface 1106 from FIG. 15B to FIG. 15C, and such as described with reference to FIGS. 13B and 13C.

In some embodiments, the first computer system 101a started detecting the selection of the grabber user interface element 1106b of the first user interface 1106 right before the first user 1101a started turning toward the second user 1101b (e.g., the first user 1101a performed the air pinch gesture while attention (e.g., gaze) of the first user 1101a is directed to the grabber user interface element 1106b of the first user interface 1106, such that the index finger and thumb of the first user 1101a have been in contact with each other since right before the first user 1101a started turning toward the second user 1101b). In some embodiments, the first computer system 101a started detecting the selection of the grabber user interface element 1106b of the first user interface 1106 while the first user 1101a was turning toward the second user 1101b (e.g., the first user 1101a performed the air pinch gesture while attention (e.g., gaze) of the first user 1101a is directed to the grabber user interface element 1106b of the first user interface 1106, such that the index finger and thumb of the first user 1101a have been in contact with each other since during the turning of the first user 1101a toward the second user 1101b but not before the turning of the first user 1101a toward the second user 1101b). In some embodiments, the first computer system 101a started detecting the selection of the grabber user interface element 1106b of the first user interface 1106 after the first user 1101a turned toward the second user 1101b (e.g., the first user 1101a performed the air pinch gesture while attention (e.g., gaze) of the first user 1101a is directed to the grabber user interface element 1106b of the first user interface 1106, such that the index finger and thumb of the first user 1101a have been in contact with each other since after the turning of the first user 1101a toward the second user 1101b but not before and not during the turning of the first user 1101a toward the second user 1101b).

Additionally, as shown in FIG. 15C, the user input directed to the grabber user interface element 1106b of the first user interface 1106 is also part of a user input that requests movement of the first user interface 1106. That is, in FIG. 15C, as indicated by the arrow 1504a, the hand 1116 of the first user 1101a is moving while the grabber user interface element 1106b of the first user interface 1106 is in the selected state, and the first computer system 101a interprets such movement as a request for movement of the first user interface 1106 in the first three-dimensional environment 1103. For example, were the hand 1116 of the first user 1101a to move in a first direction, the first computer system 101a would optionally interpret such as a request for movement of the first user interface 1106 in a first corresponding direction in the first three-dimensional environment 1103, and were the hand 1116 of the first user 1101a to move in a second direction that is different from the first direction, the first computer system 101a would optionally interpret such as a request for movement of the first user interface 1106 in a second corresponding direction in the first three-dimensional environment 1103 that is different from the first corresponding direction in the first three-dimensional environment 1103. Further, were the hand 1116 of the first user 1101a to move by a first amount, the first computer system 101a would optionally interpret such as a request for movement of the first user interface 1106 by a first magnitude of movement in the first three-dimensional environment 1103, and were the hand 1116 of the first user 1101a to move by a second amount that is different from the first amount, the first computer system 101a would optionally interpret such as a request for movement of the first user interface 1106 by a second magnitude of movement in the first three-dimensional environment 1103 that is different from the first magnitude of movement in the first three-dimensional environment 1103.

In response to detecting the selection and/or movement input described above with reference to FIG. 15C, the first computer system 101a updates displays of the first three-dimensional environment to include a first user interface element 1506, as shown from FIG. 15C to FIG. 15D (or alternatively, from FIG. 15B to FIG. 15C to FIG. 15D). Note that, were the first computer system 101a to detect the selection input directed to the grabber user interface element 1106b of the first user interface 1106, without detecting the movement component described above, the first computer system 101a would optionally display the first user interface element 1506, as shown in FIG. 15D. The first user interface element 1506 in FIG. 15D optionally indicates a location of a sharing zone of the first three-dimensional environment 1103. In some embodiments, the first computer system 101a displays the first user interface element 1506 provided that certain criteria are met, such as criteria described with reference to method 1600. In some embodiments, the criteria include a criterion that is met when the selection and/or movement input described above with reference to FIG. 15C has been detected. In some embodiments, the criteria include a criterion that is met when the selection and/or movement input described above with reference to FIG. 15C requests a first amount of movement that is less than a second amount of movement, such as described with reference to method 1600. In some embodiments, the criteria include a criterion that is met when a specific zone of the first three-dimensional environment 1103 that is based on a spatial arrangement between the first computer system 101a and the second computer system 101b is in the visible in the display generation component 120 of the first computer system 101a. In some embodiments, the criteria include a criterion that is met were the first computer system 101a to be collocated with the second computer system 101b in the physical environment 1105.

In the illustrated embodiment of FIG. 15D, the first computer system 101a is collocated with the second computer system 101b, and the first user interface element 1506 is specifically for sharing of virtual content between the first computer system 101a and the second computer system 101b (e.g., and is optionally not for sharing between a different set of computer systems). In some embodiments, the first user interface element 1506 is a container user interface element. In some embodiments, the first user interface element 1506 can receive a user interface (e.g., a user interface can be moved into the first user interface element 1506. In some embodiments, in response to receiving the user interface, the first computer system 101a shares the user interface with another computer system. Additionally, the overhead view 1502d in FIG. 15D shows a location of the first user interface element 1506 and a region or zone of a first sharing zone 1520 of the first three-dimensional environment for sharing between the first computer system 101a and the second computer system 101b. In the view of the first three-dimensional environment 1103 shown via display generation component 120 in FIG. 15D, the first computer system 101a displays the first user interface 1106, and the sharing zone 1520 of the first three-dimensional environment 1103 is a volume surrounding and including the first user interface element 1506. Note that were the first computer system 101a not collocated with a computer system in the physical environment 1105, the first computer system 101a would not display the first user interface element 1506.

In some embodiments, a location of the first user interface element 1506 is based on a spatial arrangement between the first computer system 101a and the second computer system 101b in the physical environment 1105. In some embodiments, the first computer system 101a displays the first user interface element 1506 at its illustrated location in FIG. 15D because the first computer system 101a has determined that that location is an ideal location for viewing of virtual content between the first computer system 101a and the second computer system 101b (e.g., the first computer system 101a has determined that, were a corresponding physical location of a user interface to be the same in the first three-dimensional environment 1103 and the second three-dimensional environment 1107, the viewing angle between the user interface and the second user 1101b is an ideal viewing angle and the viewing angle between the user interface and the first user 1101a is an ideal viewing angle). For example, were the second user 1101b of the second computer system 101b to be to the left of the first user 1101a of the first computer system 101a instead of to the right of the first user 1101a of the first computer system 101a as illustrated in overhead view 1502d in FIG. 15D, the first computer system 101a would optionally display the first user interface element 1506 at a location that, in the overhead view 1506d, would instead be in between the first user 1101a of the first computer system 101a and the second user 1101b of the second computer system 101b (who in this example is to the left of the first user 1101a of the first computer system 101a), just like how in the illustrated overhead view 1502d of FIG. 15D, the first user interface element 1506 is in between the first between the first user 1101a of the first computer system 101a and the second user 1101b of the second computer system 101b (who in the illustrated embodiment of FIG. 15D is to the left of the first user 1101a of the first computer system 101a). Further details regarding the first user interface element 1506 and the sharing zone 1520 of the first three-dimensional environment 1103 are provided with reference to method 1600.

In some embodiments, the first computer system 101a displays the first user interface element 1506 having a size that is based on a size of the user interface that is subject to selection. For example, since the first user interface 1106 is associated with the selected grabber user interface element 1106b, the first computer system 101a optionally displays the first user interface element 1506 having the same vertical and horizontal dimensions as the first user interface 1106. In some embodiments, were a size of the first user interface 1106 to be a first size, the first computer system 101a would optionally display the first user interface element 1506 having a first corresponding size, and were the size of the first user interface 1106 to be a second size that is different from the first size, the first computer system 101a would optionally display the first user interface element 1506 having a second corresponding size that is different from the first size.

In FIG. 15D, while displaying the illustrated view of the first three-dimensional environment 1103 via display generation component 120, the first computer system 101a detects the movement component of the user input from the hand 1116, as indicated by the arrow 1504b. From FIG. 15D to FIG. 15E, the first computer system 101a moves the first user interface 1106 in accordance with the user input of FIG. 15D, which includes movement of the hand 1116 of the first user 1101a as indicated by the arrow 1504b in FIG. 15D. As such, in response to the user input of FIG. 15D, the first user interface 1106 is moved from the illustrated location in FIG. 15A to the illustrated location in FIG. 15E. Notice that, in the embodiment illustrated from FIG. 15D to FIG. 15E, as shown from overhead view 1502d to overhead view 1502e, the first user interface 1106 is moved to a location that is not within the sharing zone 1520 of the first three-dimensional environment 1103 because the user input of FIG. 15D is not requesting movement of the first user interface 1106 to a location that is within the sharing zone 1520 of the first three-dimensional environment 1103. Further, note that from FIG. 15D to FIG. 15E, the movement of the first user interface 1106 is movement that is centric to the first user 1101a of the first computer system 101a (e.g., centric to the viewpoint of the first user 1101a. For example, the first computer system 101a optionally maintains the perpendicularity of the first user interface 1106 to the viewpoint of the first user 1101a, such as shown from FIG. 15D to FIG. 15E.

In FIG. 15E, while displaying the illustrated view of the first three-dimensional environment 1103 via display generation component 120, the first computer system 101a detects a movement input requesting movement of the first user interface 1106 toward the first user interface element 1506, as shown with the hand 1116 of the first user 1101a being moved toward a location of the first user interface element 1506, as indicated with the arrow 1504c. In response to the user input of FIG. 15E, the first computer system 101a moves the first user interface 1106 toward the first user interface element 1506 in accordance with the user input, as shown in FIG. 15F. Note, that in FIG. 15F, the first user interface 1106 is not in the sharing zone of the first three-dimensional environment 1103 because the magnitude of movement requested in FIG. 15E was less than to the sharing zone 1520 of the first three-dimensional environment 1103.

In FIG. 15F, while displaying the illustrated view of the first three-dimensional environment 1103 via display generation component 120, the first computer system 101a detects a movement input requesting movement of the first user interface 1106 toward the first user interface element 1506, as shown with the hand 1116 of the first user 1101a being moved toward a location of the first user interface element 1506, as indicated with the arrow 1504d. In response to the user input of FIG. 15F, the first computer system 101a moves the first user interface 1106 toward the first user interface element 1506 in accordance with the user input, as shown in FIG. 15G. Thus, from FIG. 15F to FIG. 15G, the first computer system 101a moves the first user interface 1106 further toward the location of the first user interface element 1506, as shown, in response to the movement input shown in FIG. 15F. In FIG. 15G, though the first user interface 1106 is not in the first user interface element 1506, the first user interface 1106 overlaps a location of the sharing zone 1520 of the first three-dimensional environment 1103, as shown in overhead view 1502g. In some embodiments, when a location of the first user interface 1106 overlaps a location of the sharing zone 1520 of the first three-dimensional environment 1103 but does not overlap location of the first user interface element 1506, the first user interface 1106 is within a threshold distance of the first user interface element 1506. In some embodiments, in response to the first user interface 1106 being within a threshold distance of the first user interface element 1506, but not in the first user interface element 1506, such as shown in FIG. 15G, the first computer system 101a automatically moves the first user interface 1106 to the location of the first user interface element 1506 (e.g., without further user input for doing so), such as shown from FIG. 15G to FIG. 15H. Thus, in some embodiments, were the first user 1101a to drop the first user interface 1106, as shown with the air pinch release gesture in FIG. 15G, at the illustrated location of the first user interface 1106 in FIG. 15G, which is in the sharing zone 1520 but not in the first user interface element 1506, the first computer system 101a automatically moves the first user interface 1106 to the location of the first user interface element 1506 (e.g., without further user input for doing so), such as shown from FIG. 15G to FIG. 15H.

In some embodiments, when the first user interface 1106 is moved to a location that corresponds to the sharing zone 1520 of the first three-dimensional environment 1103, the first computer system 101a no longer maintains the perpendicularity of the first user interface 1106 to the viewpoint of the first user 1101a, such as shown from FIG. 15G to FIG. 15H. For example, the first computer system 101a optionally automatically ceases maintaining of the perpendicularity of the first user interface 1106 to the viewpoint of the first user 1101a in response to detecting that a position of the first user interface 1106 corresponds to a position that is within the sharing zone 1520 of the first three-dimensional environment 1103, such as shown from FIG. 15G to FIG. 15H. For example, when the first user interface 1106 is moved to the sharing zone of the first three-dimensional environment 1103, such as shown from FIG. 15F to FIG. 15G, the first computer system 101a optionally causes the first user interface 1106 to have the angular orientation illustrated by the first user interface element 1506 relative to the viewpoint of the first user 1101a in FIG. 15H, which as illustrated is not perpendicular to the viewpoint of the first user 1101a (e.g., in contrast to the perpendicularity of the first user interface 1106 to the viewpoint of the first user 1101a in FIG. 15D). For example, when the first user interface 1106 is in the sharing zone 1520 of the first three-dimensional environment 1103, the first computer system 101a optionally causes the first user interface 1106 to be perpendicular relative to a position that is in between the viewpoint of the first user 1101a and a position of the second user 1101b in the physical environment 1105 (e.g., optionally so that the first user 1101a and the second user 1101b can view the content at in an ideal viewing angle based on their respective viewpoints in their respective three-dimensional environments.

In some embodiments, the movement input of FIG. 15F that requests movement of the first user interface 1106 toward the first user interface element 1506, as shown with the hand 1116 of the first user 1101a being moved toward a location of the first user interface element 1506, as indicated with the arrow 1504d in FIG. 15F, is a movement requesting that the first user interface 1106 be at the location of the first user interface element 1506. In some embodiments, in response to such movement request, the first computer system 101a moves the first user interface 1106 to a location of the first user interface element 1506, such as shown from FIG. 15F to FIG. 15I in accordance with the movement request were the movement request to request the illustrated movement from FIG. 15F to FIG. 15I or alternatively from FIG. 15F to FIG. 15J in accordance with the movement request were the movement request to request the illustrated movement from FIG. 15F to FIG. 15J. In some embodiments, were a portion of the first user interface 1106 to intersect (e.g., partially and not fully) the first user interface element 1506, such as shown from FIG. 15F to FIG. 15I, when the dragging (e.g., moving input) of the first user interface 1106 has been released, as such with the hand 1116 of the first user 1101a having released the air pinch gesture while the first user interface 1106 is at its illustrated location in FIG. 15I, the first computer system 101a optionally automatically moves the first user interface 1106 to being received at the location of the first user interface element 1506 (and shares the first user interface 1106 at the location to which it is moved), such as shown from FIG. 15F to FIG. 15I to FIG. 15J. Note that in some embodiments, the first computer system 101a shares the first user interface 1106 in response to detecting that the first user interface 1106 is in the sharing zone 1520 of the first three-dimensional environment 1103 (e.g., independent of whether the air pinch gesture directed to the grabber user interface element 1106b of the first user interface 1106 has been released).

FIG. 15K shows the second computer system 101b displaying a second three-dimensional environment 1107 that is visible via the display generation component 120 of the second computer system 101b in response to the first computer system 101a initiating sharing of the first user interface 1106 in the sharing zone 1520 of the first three-dimensional environment 1103 such as in FIG. 15J. As shown in FIG. 15K, the second three-dimensional environment 1107 includes the first user interface 1106 because the first computer system 101a is sharing the first user interface 1106 with the second computer system 101b. Before the first computer system 101a shared the first user interface 1106 in the sharing zone, the first computer system 101a was not sharing a user interface with the second computer system 101b, so the second three-dimensional environment 1107 of the second user 1101b was optionally as described with reference to FIG. 11A-2. Furthermore, though a corresponding location of the second user interface 1108 of the first three-dimensional environment 1103 is in the viewport of the second computer system 101b, the second three-dimensional environment 1107 does not include the second user interface 1108 because the second user interface 1108 is not being shared (e.g., the second user interface 1108 is not in the sharing zone). Further, note that the second three-dimensional environment 1107 includes a sharing zone 1521 of the second three-dimensional environment 1107 in response to the first computer system 101a initiating of sharing of the first user interface 1106 in the sharing zone 1520 of the first three-dimensional environment 1103. The sharing zone 1521 of the second three-dimensional environment 1107 optionally corresponds to the sharing zone 1520 of the first three-dimensional environment 1103. The sharing zone 1521 of the second three-dimensional environment 1107 is for sharing of content between the first computer system 101a and the second computer system 101b, and the second user 1101b may initiate sharing of content with the first user 1101a by moving content into the sharing zone 1521 of the second three-dimensional environment 1107. Further, the sharing zone 1521 of the second three-dimensional environment 1107 for sharing of content between the first computer system 101a and the second computer system 101b is optionally as described with reference to the sharing zone 1520 of the first three-dimensional environment 1103 for sharing of content between the first computer system 101a and the second computer system 101b.

FIGS. 15L and 15M illustrate the first computer system 101a detecting and responding to a request for movement of the first user interface 1106 while the first user interface 1106 is in the sharing zone of the first three-dimensional environment 1103. In FIG. 15L, while displaying the illustrated view of the first three-dimensional environment 1103 via display generation component 120, the first computer system 101a detects a movement input requesting movement of the first user interface 1106, as shown with the movement of the hand 1116 of the first user 1101a, as indicated with the arrow 1504e. In response to the user input of FIG. 15L, the first computer system 101a moves the first user interface 1106 in the sharing zone, as shown from FIG. 15L to FIG. 15M. Note that in some embodiments, the sharing zone 1520 moves as well in accordance with the movement input of FIG. 15L. Also, note that the movement of the first user interface 1106 in the sharing zone would optionally result in corresponding movement of the first user interface 1106 in the second three-dimensional environment 1107 since the first user interface 1106 is being shared with the second computer system 101b. As such, in some embodiments, the first computer system 101a moves the sharing zone and/or the first user interface 1106 in the sharing zone in response to input for doing so. Note that were the user input of FIG. 15L to request movement of the first user interface 1106 by an amount that is greater than a threshold amount, the first computer system would optionally move the first user interface 1106 out of the sharing zone 1520 of the first three-dimensional environment 1103 and would optionally cease the sharing of the first user interface 1106 with the second computer system 101b, such as shown from FIG. 15M to FIG. 15N.

FIGS. 15M and 15N illustrate the first computer system 101a detecting and responding to a request for movement of the first user interface 1106 from the sharing zone of the first three-dimensional environment 1103 to outside of the sharing zone of the first three-dimensional environment while the first user interface 1106 is in the sharing zone of the first three-dimensional environment 1103. In FIG. 15M, while displaying the illustrated view of the first three-dimensional environment 1103 via display generation component 120, the first computer system 101a detects a movement input requesting movement of the first user interface 1106, as shown with the movement of the hand 1116 of the first user 1101a, as indicated with the arrow 1504f. In response to the user input of FIG. 15M, the first computer system 101a moves the first user interface 1106 to beyond the sharing zone of the first three-dimensional environment, as shown from FIG. 15M to FIG. 15N. Further, as shown in FIG. 15N, in response to detecting that the first user interface 1106 is moved to outside of the sharing zone 1520, the first computer system 101a ceases sharing of the first user interface 1106 with the second computer system 101b, as shown in FIG. 15N. Further, note that from FIG. 15M to FIG. 15N, the first computer system 101a changes the angular orientation of the first user interface 1106 to be perpendicular to the viewpoint of the first user 1101a. Thus, the first computer system 101a optionally causes the movement of the first user interface to go from being not centric to the viewpoint of the first user 1101a to centric to the viewpoint of the first user 1101a in response to detecting that the first user interface 1106 is no longer in the sharing zone 1520 of the first three-dimensional environment 1103.

FIG. 150 illustrates the first computer system 101a displaying different sharing zone for sharing virtual content with different sets of computer systems that are collocated with the first computer system 101a in the physical environment 1105 in accordance with some embodiments. In particular, in FIG. 150, the first computer system 101a displays the first user interface element 1506 for sharing between the first computer system 101a and the second computer system 101b, and displays a second interface element 1508 for sharing between the first computer system 101a, the second computer system 101b, and the third computer system 101c. As such, were the first computer system 101a to detect movement of the first user interface 1106 to within the sharing zone 1520, the first computer system would optionally cause the first user interface 1106 to be shared between the first computer system 101a and the second computer system 101b; were the first computer system 101a to detect movement of the first user interface 1106 to within the sharing zone 1522 of the first three-dimensional environment 1103, the first computer system 101a would optionally cause the first user interface 1106 to be shared between the first computer system 101a, the second computer system 101b, and the third computer system 101c. Note that, in some embodiments, were the first computer system 101a collocated with two computer systems, such as shown in FIG. 150, the first computer system 101a would optionally display up to three user interface elements for sharing between the different sets of computer systems-one for sharing between the first computer system 101a and the second computer system 101b, one for sharing between the first computer system 101a and the third computer system 101c (e.g., third user interface element 1534 inside the sharing zone 1532 (for sharing between the first computer system 101a and the third computer system 101c) that is representatively shown just in overhead view 1502o of FIG. 150), and one for sharing between the first computer system 101a, the second computer system 101b, and the third computer system 101c.

As an example, in FIG. 150, while displaying the illustrated view of the first three-dimensional environment 1103 via display generation component 120, the first computer system detects a movement input requesting movement of the first user interface 1106, as shown with the movement of the hand 1116 of the first user 1101a, as indicated with the arrow 1504g, to the sharing zone 1522 of the first three-dimensional environment 1103. In response, the first computer system 101a shares the first user interface 1106 with both the second computer system 101b and the third computer system 101c, as shown in FIGS. 15P through 15R.

FIGS. 15P through 15R illustrate computer systems displaying three-dimensional environments that include the first user interface 1106 which is being shared between the computer systems in response to movement input of the first user interface 1106 to the sharing zone 1520 in accordance with some embodiments. In particular, FIG. 15P shows the first computer system 101a displaying the first user interface 1106 in the first three-dimensional environment 1103 from the viewpoint of the first user 1101a; FIG. 15Q shows the second computer system 101b displaying the first user interface 1106 in the second three-dimensional environment 1107 from the viewpoint of the second user 1101b; FIG. 15R shows the third computer system 101c displaying the first user interface 1106 in a third three-dimensional environment 1509 from a viewpoint of the third user 1101c. In FIG. 15R, the viewing boundaries of the third user 1101c via the first computer system 101a are given by the viewing boundaries 1115, and note that were the third user 1101c to move, the viewing boundaries of the third three-dimensional environment 1509 optionally update (e.g., moves) as well in accordance with the movement of the third user 1101c.

In FIG. 15P, the first computer system 101a is collocated with the second computer system 101b and the third computer system 101c and is sharing the first user interface 1106 with the second computer system 101b and the third computer system 101c. From FIG. 15P to FIG. 15S, the first computer system 101a detects that it is no longer collocated with the third computer system 101c. For example, the first computer system 101a optionally detects that the third user 1101c of the third computer system 101c has left the room (e.g., physical environment 1105 and/or has turned off the third computer system 101c). In response, the first computer system 101a ceases sharing of the first user interface 1106 with the third computer system 101c while maintaining sharing of the first user interface 1106 with the second computer system 101b, as shown in FIG. 15S.

In FIG. 15P, the first computer system 101a is collocated with the second computer system 101b and the third computer system 101c and is sharing the first user interface 1106 with the second computer system 101b and the third computer system 101c. From FIG. 15P to FIG. 15T, the first computer system 101a detects that it is no longer collocated with the second computer system 101b and the third computer system 101c. For example, the first computer system 101a optionally detects that second user 1101b of the second computer system 101b and the third user 1101c of the third computer system 101c have left the room (e.g., physical environment 1105 and/or has turned off the second computer system 101b and third computer system 101c). In response, the first computer system 101a ceases sharing of the first user interface 1106 with second computer system 101b and the third computer system 101c while maintaining display of the first user interface 1106, as shown in FIG. 15T. Further, as shown in the overhead view in FIG. 15T, the first computer system 101a no longer includes a sharing zone in the first three-dimensional environment 1103 (e.g., no longer includes sharing zone 1522) because the first computer system 101a is no longer collocated with another computer system in the physical environment 1105. In some embodiments, in response to the determination that the first computer system 101a is no longer collocated with the second computer system 101b and the third computer system 101c, the first computer system 101a updates the perpendicularity of the first user interface 1106 to be perpendicular to the viewpoint of the first user 1101a.

In FIG. 15P, the first computer system 101a is collocated with the second computer system 101b and the third computer system 101c and is sharing the first user interface 1106 with the second computer system 101b and the third computer system 101c. From FIG. 15P to FIG. 15U, the first computer system 101a detects that it is no longer collocated with the second computer system 101b and the third computer system 101c. For example, the first computer system 101a has optionally left the room (e.g., the physical environment 1105) in which it was present with the second user 1101b and the third user 1101c, and the second user 1101b of the second computer system 101b and the third user 1101c of the third computer system 101c are optionally still in the room. In response, the first computer system 101a ceases sharing of the first user interface 1106 with second computer system 101b and the third computer system 101c, as shown in FIG. 15U with the first user interface 1106 no longer being displayed in the second three-dimensional environment 1107 of the second user 1101b (and the first user interface 1106 would likewise no longer be in the third three-dimensional environment 1109 as well).

FIGS. 15V through 15Y illustrate an example of the first computer system 101a swapping user interfaces in the sharing zone of the first three-dimensional environment 1103 in accordance with some embodiments.

In FIG. 15V, while displaying the illustrated view of the first three-dimensional environment 1103 via display generation component 120, including while sharing the first user interface 1106 in the sharing zone 1520 of the first three-dimensional environment 1103, the first computer system 101a detects an air pinch gesture directed to the second user interface 1108, as shown with hand 1116 of the first user 1101a, while attention (e.g., gaze) of the first user 1101a is directed to the grabber user interface element 1108b of the second user interface 1108, as shown with gaze point 1510h. In FIG. 15V, the first computer system 101a displays the grabber user interface element 1108b highlighted to indicate that the grabber user interface element 1108b is in a selected state. Additionally, in FIG. 15V, the first computer system 101a detects a movement component of the user input requesting movement of the second user interface 1108 in the first three-dimensional environment 1103 to the sharing zone 1520 of the first three-dimensional environment 1103 (e.g., to the location of the first user interface 1106), as indicated by the arrow 1504h. In response, the first computer system 101a moves the second user interface 1108 in the first three-dimensional environment 1103 in accordance with the movement component of the input, as shown from FIG. 15V to FIG. 15W. As shown from FIG. 15V to FIG. 15W, in response to the movement input of FIG. 15V, the first computer system 101a moves the second user interface 1108 into the sharing zone 1520 of the first three-dimensional environment 1103 and initiates an animation for sharing the second user interface 1108, as shown from FIG. 15W to FIG. 15X to FIG. 15Y. In particular, when the first computer system 101a detects that the movement request is movement of the second user interface 1108 to the location of the sharing zone 1520, the first computer system 101a moves the first user interface 1106 to outside of the sharing zone 1520 and moves the second user interface to within the sharing zone 1520. Additionally, as shown from FIG. 15W to FIG. 15X to FIG. 15Y, when the first computer system 101a detects that the movement request is movement of the second user interface 1108, the first computer system 101a ceases sharing of the first user interface 1106 and initiates sharing of the second user interface 1108. Further details regarding the embodiments illustrated and described with reference to FIGS. 15A-15Y are provided with reference to method 1600.

FIG. 16 is a flowchart illustrating an exemplary method 1600 for sharing a user interface with a second computer system in response to detecting movement of the user interface to a user interface element for sharing the user interface with the second computer system in accordance with some embodiments. In some embodiments, the method 1600 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, a method 1600 (e.g., the method 1600 of FIG. 16) is performed at a first computer system in communication with one or more first display generation components and one or more first input devices. In some embodiments, the first computer system has one or more characteristics of the computer systems in methods 800, 1000, 1200 and/or 1400. In some embodiments, the first display generation component(s) have one or more characteristics of the display generation component(s) in methods 800, 1000, 1200 and/or 1400. In some embodiments, the one or more first input devices have one or more characteristics of the one or more input devices in methods 800, 1000, 1200, and/or 1400.

In some embodiments, (1602a) while a respective user interface of a respective application (e.g., the respective user interface of the respective application described with reference to method 1200 and/or 1400, or another user interface of an application, such as a user interface of an application described with reference to method 800 and/or 1000) is not shared between the first computer system and a second computer system that are collocated in a physical environment, such as the first user interface 1106 being private to the first three-dimensional environment 1103 of the first computer system 101a and not shared between the first computer system 101a and the second computer system 101b that are collocated in the physical environment 1105 in FIG. 15A, and optionally such as while no user interface of an application (e.g., no user interface of any application) is being shared between the first and second computer systems and/or while no communication session (e.g., a communication session described with reference to method 800, 1000, 1200 and/or 1400) is active between the first and second computer systems), and while the first user of the first computer system and the second user of the second computer system are collocated in the physical environment, such as a physical environment described with reference to method 800, 1000, 1200, and/or 1400, (1602b) while the respective user interface of the respective application is associated with a first location in a first three-dimensional environment that is visible via the one or more first display generation components (e.g., the first location is optionally as described with reference to the first location in the first three-dimensional environment that is visible via the one or more first display generation components in method 1200 and/or 1400, such as the first location being visible (and the respective user interface being displayed there) when the part of the first three-dimensional environment that includes the first location is in the viewport of the first computer system and the first location not being visible (and the respective user interface not being displayed) when the part of the first three-dimensional environment that includes the first location is not within the viewport of the first computer system, and the respective user interface may be associated with (e.g., located at) the first location even when the first location is not in within the viewport), such as the illustrated location of the first user interface 1106 in the first three-dimensional environment 1103 in FIG. 15A, wherein the first location in the first three-dimensional environment is not a location within a sharing zone of the first three-dimensional environment (e.g., a respective location in the sharing zone has a respective spatial relationship between the first user of the first computer system and the second user of the second computer system, such as described below with reference to the method 1600), such as the illustrated location of the first user interface 1106 in the first three-dimensional environment 1103 in FIG. 15A not being a location that is within the sharing zone 1520 of the first three-dimensional environment 1103 in FIG. 15D, in accordance with a determination that one or more first criteria are satisfied, including a criterion that is satisfied when a current viewport of the first computer system includes the location within the sharing zone, the first computer system displays (1602c), via the one or more first display generation components, a first user interface element, at a location corresponding to the sharing zone, wherein the first user interface element is configured to receive a first user interface of a first application, such as first the user interface element 1506 in FIG. 15D. In some embodiments, the location corresponding to the sharing zone is the location within the sharing zone of the first three-dimensional environment. In some embodiments, the location of the first user interface element (e.g., the location corresponding to the sharing zone) is the location of the sharing zone in the first three-dimensional environment. In some embodiments, the sharing zone comprises the first user interface element. In some embodiments, the sharing zone comprises the first user interface element and an additional zone extending about the location of the first user interface element in the first three-dimensional environment. In some embodiments, the first user interface element is an empty user interface container (e.g., a two-dimensional or three-dimensional user interface) that is configured to accept a user interface. In some embodiments, in response to the first user interface element receiving (e.g., accepting) a user interface, the first user interface element comprises the user interface. In some embodiments, the first user interface element is greater in size than the user interface it receives. In some embodiments, the first user interface element is smaller in size than the user interface it receives. In some embodiments, the first user interface element is the same size as the user interface it receives. In some embodiments, the first user interface of the first application is as described with reference to the respective user interface of the respective application in method 1200 and/or 1400, and/or is as described with reference to a user interface of an application described with reference to method 800 and/or 1000. In some embodiments, the first user interface element is an outline of a two-dimensional or three-dimensional user interface (e.g., an empty container). In some embodiments, the first user interface element is a visually emphasized/distinct region of the first three-dimensional environment. In some embodiments, the boundaries of the sharing zone are the displayed boundaries of the first user interface element. In some embodiments, the boundaries of the sharing zone are further than the displayed boundaries of the first user interface element. In some embodiments, the computer system displays the first user interface element in accordance with a determination that the first user is collocated with at least one user in a physical environment. In some embodiments, the first computer system forgoes displaying the first user interface element (e.g., the sharing zone) in accordance with a determination that the first user is not collocated with another user in the physical environment. In some embodiments, the sharing zone exists (e.g., the first user interface element is associated with the sharing zone) even if the location of the sharing zone is not within the current viewport of the computer system (e.g., even if the first user interface element is not displayed due to its location being outside of the current viewport of the first computer system). In some embodiments, the sharing zone of the first three-dimensional environment is two-dimensional. In some embodiments, the sharing zone is a point in the first three-dimensional environment. In some embodiments, the sharing zone is three-dimensional (e.g., a volume) in the first three-dimensional environment. In some embodiments, the sharing zone is a region of the first three-dimensional environment that includes a set of positions and/or locations that have a predetermined spatial relationship between the (location of) first user of the first computer system and the (location of) second user of the second computer system. In some embodiments, the predetermined spatial relationship is between and/or in front of a location of the (location of) first user of the first computer system and the (location of) second user of the second computer system from the perspective of the (location of) first user of the first computer system and/or from the perspective of the (location of) second user of the second computer system. Other spatial relationships are contemplated as well. In some embodiments, the set of positions and/or locations in the first three-dimensional environment that are outside of the sharing zone do not have the predetermined spatial relationship between the (location of) first user of the first computer system and the (location of) second user of the second computer system. Note that were the current viewport to not include the location corresponding to the sharing zone, the first computer system optionally would not display the first user interface element.

In some embodiments, (1602a) while the respective user interface of the respective application is not shared between the first computer system and the second computer system that are collocated in the physical environment, and (1602b) while the respective user interface of the respective application is associated with the first location in the first three-dimensional environment that is visible via the one or more first display generation components, wherein the first location in the first three-dimensional environment is not the location within the sharing zone of the first three-dimensional environment, the first computer system detects (1602d), via the one or more first input devices, a first input requesting movement of the respective user interface of the respective application away from the first location, such as the movement of the hand 1116 of the first user 1101a while the index finger and thumb of the hand 1116 of the first user 1101a are in contact with each other as part of an air pinch gesture. For example, the first computer system optionally detects attention (e.g., gaze) of the first user and/or an air gesture (e.g., an air pinch) that requests movement of the respective user interface. Additionally or alternatively, in some embodiments, the first computer system detects a voice input, an input via a mouse, touch screen or trackpad, or another type of input described herein that requests movement of the respective user interface. In some embodiments, detecting the input that requests movement of the respective user interface includes one or more characteristics described with reference to detecting inputs (e.g., inputs requesting movement of virtual content) and/or selections in methods 800, 1000, 1200, and/or 1400.

In some embodiments, (1602e) in response to detecting the first input requesting movement of the respective user interface of the respective application away from the first location, the first computer system moves (1602f) the respective user interface away from the first location in accordance with the first input (e.g., displaying the respective user interface moving in the first three-dimensional environment away from the first location in accordance with the first input (e.g., moving in the requested direction by the requested amount of movement (e.g., moving in a direction/magnitude corresponding to the direction/magnitude associated with the first input))), as shown with the movement of the first user interface 1106 from FIG. 15D to FIG. 15G. In some embodiments, (1602e) in response to detecting the first input requesting movement of the respective user interface of the respective application away from the first location, after moving the respective user interface away from the first location in accordance with the first input, in accordance with a determination that one or more second criteria are satisfied, including a criterion that is satisfied when the respective user interface of the respective application is moved to the location within the sharing zone (e.g., at least a part of the respective user interface overlaps any portion or volume of the sharing zone and/or more than a threshold amount (e.g., 10, 20, 30, 50, 75 or 90%) of the respective user interface overlaps or intersects with the sharing zone, and/or the respective user interface is otherwise moved to within the sharing zone), such as the movement of the first user interface 1106 from FIG. 15D to FIG. 15G, resulting in a portion of the first user interface 1106 intersecting a portion of the sharing zone 1520 in FIG. 15G, the first computer system shares (1602g) the respective user interface of the respective application with the second computer system (e.g., such as described with reference to sharing of the respective user interface of the respective application in method 1200 and/or 1400 and/or with reference to sharing of virtual content as described with reference to method 800 and/or 1000), including causing the respective user interface of the respective application to be concurrently associated with the location within the sharing zone of the first three-dimensional environment and associated with a respective location in a second three-dimensional environment that is visible via one or more second display generation components of the second computer system, the respective location in the second three-dimensional environment corresponding to the location within the sharing zone of the first three-dimensional environment, such as shown by the first user interface 1106 being in the first three-dimensional environment 1103 in FIG. 15J and the first user interface 1106 being in the second three-dimensional environment 1107 in FIG. 15K. In some embodiments, were a first portion of the respective user interface to be outside of the sharing zone and a second portion of the respective user interface to be inside of the sharing zone, the first computer system additionally moves (e.g., without user further user input) the respective user interface such that the first and second portions are inside the sharing zone of the first three-dimensional environment. In some embodiments, the location within the sharing zone is the location corresponding to the sharing zone (e.g., the respective user interface is displayed at the location that the first user interface element was displayed). For example, while displaying the respective user interface outside of the sharing zone of the first three-dimensional environment, if a current viewport of the first computer system includes the sharing zone, the first computer system optionally displays a user interface element that is configured to accept a user interface into the sharing zone. Continuing with this example, the first computer system optionally detects movement of the respective user interface away from the location it was associated with when the user interface element was displayed. Continuing with this example, in response to the movement of the respective user interface, if the respective user interface is moved to a location that is within the sharing zone, the first computer system optionally shares the respective user interface with the second computer system, such as described with reference to the sharing of the respective user interface of the respective application in method 1200 and/or 1400 and/or with reference to sharing of virtual content as described with reference to method 800 and/or 1000. In some embodiments, the one or more second criteria include a second criterion that is satisfied when the movement input has ceased (e.g., the user has dropped or released the respective user interface from being moved) while the respective user interface is in the sharing zone and the respective user interface is shared in response to satisfaction of the one or more second criteria. In some embodiments, the respective user interface is shared independent of whether the second criterion of the one or more second criteria is satisfied. A corresponding physical location of the respective user interface (e.g., the location and/or orientation of the respective user interface relative to the same physical environment that is in the first three-dimensional environment and the second three-dimensional environment) is optionally the same between the first three-dimensional environment and the second three-dimensional environment. Note that the sharing of the respective user interface optionally initiates a communication session (e.g., a real-time communication session or another communication session) between the first and second computer systems, such as a communication session described with reference to methods 800, 1000, 1200, and/or 1400. In some embodiments, after moving the respective user interface away from the first location in accordance with the first input, in accordance with a determination that the one or more second criteria are not satisfied (e.g., the respective user interface is moved to a location that is outside of the sharing zone), the computer system forgoes sharing the respective user interface with the second computer system. In some embodiments, the location of the shared respective user interface is the location of the first user interface element that was displayed before the respective user interface was moved to the first user interface element. Sharing a user interface with a collocated user in response to detection of movement of the user interface to a user interface element that is configured to accept a user interface reduces errors associated with sharing user interfaces between users because the shared user interface is the user interface that is moved to the user interface element, thus making sharing with collocated users more efficient.

In some embodiments, moving the respective user interface away from the first location in accordance with the first input also includes moving the respective user interface to a second location that is within a threshold distance of the location corresponding to the sharing zone and that is not the location corresponding to the sharing zone, such as shown with the movement of the first user interface 1106 from FIG. 15D to FIG. 15G resulting in a portion of the first user interface 1106 intersecting a portion of the sharing zone 1520 but not intersecting or being within the first user interface element 1506 in FIG. 15G, and after moving the respective user interface to the second location, the first computer system moves the respective user interface from the second location to the location corresponding to the sharing zone without input for doing so, such as shown with the movement of the first user interface 1106 from FIG. 15G to FIG. 15H. For example, the movement input described in step(s) 1602 of method 1600 optionally results in movement of the respective user interface to within the threshold distance of the location of the first user interface element but not at the location of the first user interface element. Continuing with this example, the first computer system optionally additionally moves the respective user interface in the first three-dimensional environment (e.g., without user input for additionally moving the respective user interface), thus snapping the respective user interface to the location of the first user interface element, and the first computer system optionally initiates sharing of the respective user interface from the location to which the first computer system additionally moved the respective user interface. In some embodiments, were a first portion of the respective user interface to be outside of the sharing zone and a second portion of the respective user interface to be inside of the sharing zone, the first computer system additionally moves (e.g., without user further user input) the respective user interface such that the first and second portions are inside the sharing zone of the first three-dimensional environment. In some embodiments, the location corresponding to the sharing zone is the location corresponding to the sharing zone (e.g., the respective user interface is displayed at the location that the first user interface element was displayed). In some embodiments, were the movement input to finish while the respective user interface is snapped, the first computer system initiates sharing of the respective user interface. In some embodiments, were the movement input (e.g., movement component) to request movement that is to a location that is not within the threshold distance (e.g., not within the snapping distance), the first computer system moves the respective user interface in accordance with the movement input without snapping it the location corresponding to the sharing zone. Additionally moving the respective user interface to inside the sharing zone when it is moved via user input to within a threshold distance of the first user interface element in the sharing zone reduces errors associated with dropping the respective user interface at a location that is outside of the sharing zone when the user intended to drop the respective user interface inside the sharing zone, and maintains the integrity of the first computer system sharing the respective user interface from an ideal location in the first three-dimensional environment since the respective user interface is shared from the location within the sharing zone.

In some embodiments, the one or more first criteria include a second criterion that is satisfied when at least a portion of the first input requesting movement of the respective user interface of the respective application away from the first location has been detected, such as when a portion of the such as the movement of the hand 1116 of the first user 1101a while the index finger and thumb of the hand 1116 of the first user 1101a are initially detected as being in contact with each other as part of =selection of the grabber user interface element 1106b of the first user interface 1106 (e.g., optionally independent of whether the movement of the hand 1116 of the first user 1101a is detected). In some embodiments, the first input is directed to a user interface element for moving the respective user interface, such as the user interface element for moving the respective user interface of the respective application in the first three-dimensional environment described with reference to method 1400. In some embodiments, the user interface element for moving the respective user interface is for moving the respective user interface, without being for moving another user interface. For example, the user interface element is optionally a selection element (e.g., a grabber or handlebar virtual object) associated with the respective user interface (e.g., virtual content) that is selectable to initiate movement of the respective user interface (e.g., virtual content) in the three-dimensional environment (e.g., first three-dimensional environment) such as described with reference to method 800 and/or 1400. The first input is optionally directed to a user interface element for moving the respective user interface in the first three-dimensional environment, such as the selection element described with reference to method 800 and/or 1400 below, and the first user interface element is optionally displayed when a portion of the input directed to the user interface element for moving the respective user interface is displayed. For example, the first input optionally input an air pinch gesture being performed by the hand of the first user and directed to the selection element, and when the contact of the thumb and index finger of the first user is detected (and when the current viewport includes a portion of the sharing zone, such as described in step(s) 1602 of method 1600), the first computer system optionally displays the first user interface element in the first three-dimensional environment. In some embodiments, the first computer system does not display the first user interface element until a movement component of the first input is detected. For example, the first input optionally includes the air pinch gesture described above and a movement of the hand while it is in the pinched pose, and the first computer system optionally does not display the first user interface element until the movement of the hand is detected. The movement component of the first input optionally is a request for movement of the respective user interface in the first three-dimensional environment. In some embodiments, were the current viewport to include the location within the sharing zone, as described in step(s) 1602, without the second criterion described above being satisfied (e.g., without detecting the air pinch gesture being performed by the hand of the first user and directed to the selection element, including the contact of the thumb and index finger of the first user), the first computer system does not display the first user interface element. In some embodiments, the first computer system determines a location to display the first user interface element based on a spatial arrangement between the first user and the second user, such as described below, and independent of where the respective user interface is located. In some embodiments, were the first input to continue being detected after sharing of the respective user interface with the second computer system is initiated, were the first input to include the input that corresponds to the request to move the respective user interface in the first three-dimensional environment, and were the input that corresponds to the request to move the respective user interface in the first three-dimensional environment to include a first amount of requested movement, first computer system moves the respective user interface by the first amount of requested movement and may cause the respective user interface to be moved in the second three-dimensional environment of the second computer system by the first amount of requested movement as well. In some embodiments, though the first input may include the input corresponds to a request to move the respective user interface in the first three-dimensional environment, were the input to not request any movement, the first computer system would not move the respective user interface in the first three-dimensional environment. Displaying the first user interface element for receiving a user interface for sharing in response to detecting that a portion of a movement input for moving the user interface in the three-dimensional environment has been detected notifies the first user that the user interface can be moved to the first user interface element and notifies the first user of the location in the three-dimensional environment to drop the user interface, which reduces errors associated with sharing user interfaces.

In some embodiments, the one or more first criteria include a second criterion that is satisfied when the first input requesting movement of the respective user interface of the respective application away from the first location is a request for movement of the respective user interface of the respective application that is less than a threshold amount of movement (e.g., is less than a threshold distance, speed, velocity, and/or acceleration) in the first three-dimensional environment (e.g., a movement that is less than a threshold amount of movement (e.g., 0.01 m, 0.1 m, 0.5, 0.9 m, 1.1 m, or another amount of movement), that is less than a threshold amount of movement over time, and/or that is less than a threshold amount of movement over time squared), such as the requested movement, as indicated by the movement of the hand 1116 indicated by the arrow 1504b in FIG. 15D being a request for movement of the first user interface 1106 that is less than a threshold amount of requested movement (e.g., is less than a threshold requested distance, speed, velocity, and/or acceleration). As described above, in some embodiments, the first computer system moves the respective user interface in accordance with an amount of requested movement. In some embodiments, the first computer system triggers display of the first user interface element provided that the requested movement is less than the threshold amount of movement (and/or less than the threshold amount of movement over a period of time (or over the square of the period of time). In some embodiments, the first computer system displays the first user interface element described with reference to step(s) 1602 of method 1600 provided that at least the respective user interface is moving less than a threshold amount of movement (e.g., is less than the threshold distance, speed, velocity, and/or acceleration) in the first three-dimensional environment. In some embodiments, the first computer system forgoes displaying the first user interface element when the requested movement of the respective user interface is more than the threshold amount of movement (e.g., is more than the threshold distance, speed, velocity, and/or acceleration). In some embodiments, the first computer system displays the first user interface element when at least the portion of the first input requesting movement of the respective user interface of the respective application away from the first location has been detected, as described above, independent of whether the requested movement of the first input is less or more than the threshold amount of movement (e.g., the threshold distance, speed, velocity, and/or acceleration) in the first three-dimensional environment. Displaying the first user interface element for receiving a user interface for sharing in response to detecting that a requested movement of the user interface in the three-dimensional environment is less than a threshold amount of movement corresponds specific amounts of movement requests as potential movements to the sharing zone, thus reducing consumption of processing resources devoted to displaying the first user interface element and reducing errors associated with sharing user interfaces.

In some embodiments, the one or more first criteria include a third criterion that is satisfied when the first input has been detected for more than a threshold period of time (e.g., 0.5 s, 1 s, 3 s, 5 s, or another period of time), such as the grabber user interface element 1106b of the first user interface 1106 being selected for more than the threshold period of time in FIG. 15C. As such, the first computer system optionally triggers display of the first user interface element for receiving a user interface for sharing provided that the first input requesting movement of the respective user interface has been detected for longer than the threshold period of time. Thus, in some embodiments, the first computer system forgoes displaying the first user interface element described with reference to step(s) 1602 of method 1600 until at least the first input has been detected for more than the threshold period of time (e.g., until the index finger and the thumb of the first user has been in contact with each other for more than the threshold period of time). In some embodiments, the first computer system displays the first user interface element independent of whether first input has been detected for more than the threshold period of time. Displaying the first user interface element for receiving a user interface for sharing in response to detecting that a requested movement of the user interface in the three-dimensional environment has been detected for longer than a threshold period of time corresponds specific amounts of movement requests—even movement requests that are received over more than the threshold period of time—as potential movements to the sharing zone, thus reducing consumption of processing resources devoted to displaying the first user interface element and reducing errors associated with sharing user interfaces.

In some embodiments, a user of the first computer system is a first user in the physical environment, and the one or more first criteria include a second criterion that is satisfied when a second user of the second computer system, different from the first user of the first computer system, is detected in the physical environment (e.g., in response to detecting that the first user of the first computer system is collocated with another user of another computer system in the physical environment), such as the second user 1101b being detected in the physical environment 1105 in FIG. 15C. As such, in some embodiments, the first computer system displays the first user interface element of step(s) 1602 in method 1600 in response to detecting that the first computer system is collocated with another user of a computer system in the physical environment. Note that when the first computer system is collocated with the second computer system, the first and second computer systems may be proximate to each other, as described with reference to method 800, and/or the second user of the second computer system may be in a contact list of the first user, such as described with reference to method 800. Other possibilities of proximities are contemplated and are generally described herein with reference to method 800 and/or to collocation. In some embodiments, the first computer system forgoes displaying the first user interface element provided that the first computer system is not collocated with another user of another computer system in the physical environment. In some embodiments, the second user of the second computer system is as described with reference to the second user of the second computer system in method 800. Displaying the first user interface element for receiving a user interface for sharing in response to detecting that another user of another computer system is in the physical environment reducing consumption of processing resources devoted to displaying the first user interface element since the first user interface element is only displayed when the first user is collocated with another user in the physical environment and reduces errors associated with sharing user interfaces.

In some embodiments, the one or more first criteria include a second criterion that is satisfied when the respective user interface of the respective application is not shared between the first computer system and another computer system (e.g., is not being shared as described with reference to method 1200, 1400, and/or 1600 with any other computer system such as the second computer system and/or another computer system and/or has not initiated in sharing using the operation(s) described with reference to method 1200, 1400, and/or 1600) that are collocated in the physical environment, such as the first user interface 1106 not already being shared between the first user 1101a and the second use 1101b in FIG. 15C. As such, in some embodiments, the first computer system displays the first user interface element of step(s) 1602 in method 1600 in response to detecting that the respective user interface is not already being shared with another user of another computer system in the physical environment. Were the respective user interface to be already shared, the first computer system would optionally not display the first user interface element. In some embodiments, shared user interfaces in the first three-dimensional environment are displayed in the sharing zone of the first three-dimensional environment, such that a shared user interface in the first three-dimensional environment is not displayed outside of the sharing zone of the first three-dimensional environment. In some embodiments, a shared user interface may be displayed inside the sharing zone of the first three-dimensional environment and a second shared user interface may be displayed outside of the sharing zone of the first three-dimensional environment. Displaying the first user interface element for receiving a user interface for sharing in response to detecting that the respective user interface is not already being shared with another user in the physical environment reduces consumption of processing resources devoted to displaying the first user interface element since the first user interface element is only displayed when the respective user interface is not being shared with another user in the physical environment and reduces errors associated with sharing user interfaces.

In some embodiments, displaying the first user interface element includes, in accordance with a determination that a spatial arrangement between a first user of the first computer system and a second user of the second computer system (e.g., a spatial arrangement between the first and second computer systems) in the physical environment is a first spatial arrangement (e.g., a first relative positioning), displaying the first user interface element at a first respective location in the first three-dimensional environment based on the first spatial arrangement, such as the first user interface element 1506 being displayed at the illustrated location in FIG. 15D at least because of how the second user 1101b is positioned in the first three-dimensional environment 1103, and in accordance with a determination that the spatial arrangement between the first user of the first computer system and the second user of the second computer system (e.g., the spatial arrangement between the first and second computer systems) in the physical environment is a second spatial arrangement (e.g., a second relative positioning) that is different from the first spatial arrangement, user of the first computer system, displaying the first user interface element at a second respective location in the first three-dimensional environment based on the second spatial arrangement, the second respective location being different from the first respective location. For example, provided that the second user 1101b were to be at a position that is different from the illustrated position of the second user 1101b in the first three-dimensional environment 1103 in FIG. 15C, the first computer system would optionally display the first user interface element 1506 at a location that is different from the illustrated location in FIG. 15D. As such, in some embodiments, the first computer system displays the first user interface element based on a spatial arrangement of the first and second users in the physical environment. In some embodiments, the location of display of the first user interface element is based on the spatial arrangement of the users with whom the first user interface element is associated. For example, the first user interface element optionally corresponds to a sharing zone for sharing virtual content between the first user and the second user so the location of display of the first user interface element is optionally based on the location of the first user (e.g., the position of the viewpoint of the first user) and the location of the second user in the physical environment optionally because either the first or second user can share user interfaces with each other in that sharing zone in their respective three-dimensional environments. In some embodiments, different sharing zones for sharing between different sets of users have different locations in the first three-dimensional environment. In some embodiments, the location of display of the first user interface element is an ideal location for viewing and/or interacting with content based on the spatial arrangement between the first and second users in the physical environment. In some embodiments, the location of display of the first user interface element intersects a line that extends between (e.g., equidistant between) the locations of the first and second users in the physical environment. In some embodiments, the spatial arrangement between the first and second users is a spatial arrangement (e.g., a location) of the second user relative to the first user in the physical environment (and/or relative to another anchor location in the physical environment that the second computer system uses to determine the spatial arrangement) and/or is a spatial arrangement of the first user (e.g., a location) relative to the second user in the physical environment (and/or relative to another anchor location in the physical environment that the second computer system uses to determine the spatial arrangement). In some embodiments, were the spatial arrangement of the first and second users to change while the first computer system is displaying the first user interface element, the first computer system updates the location of display of the first user interface element to be based on the updated spatial arrangement. In some embodiments, were the spatial arrangement of the first and second users to change while the first computer system is displaying the first user interface element, the first computer system maintains the original location of display of the first user interface element. In some embodiments, the spatial arrangement between the first and second users is a spatial arrangement of the second user relative in the physical environment to the first user and/or is a spatial arrangement of the first user relative to the second user in the physical environment. In some embodiments, were the first computer system to be collocated with the second user of the second computer system and with a third user of a third computer system, such that there is a third spatial arrangement between the first, second, and third users of the first, second, and third computer systems, the first computer system displays the first user interface element, which is devoted to receiving user interfaces for sharing between the first and second computer systems, at a location that is based on the spatial arrangement between the first and second computer systems, without being based on the third spatial arrangement. In some embodiments, were the first computer system to be in a communication session with the third user of the third computer system, and the third user is not in the physical environment as is the first and second computer systems, the first computer system may still display the first user interface element at the location that is based on the spatial arrangement between the first and second computer systems. Displaying the first user interface element for receiving a user interface for sharing at a location in the first three-dimensional environment that is based on a spatial arrangement between the first and second users of the computer systems in the physical environment makes sharing of user interfaces more efficient since the respective user interface is shared with the second user from the sharing zone in which the first user interface element and reduces errors associated with sharing user interfaces.

In some embodiments, displaying the first user interface element includes, in accordance with a determination that an orientation of a second user of the second computer system is a first orientation relative to the first three-dimensional environment (e.g., a first angular orientation relative to an origin of the first three-dimensional environment), such as the illustrated orientation of the second user 1101a in FIG. 15C, displaying the first user interface element at a first respective location in the first three-dimensional environment based on the first orientation, such as the illustrated location of the first user interface element 1506 in FIG. 15D, and in accordance with a determination that the orientation of the second user of the second computer system is a second orientation relative to the first three-dimensional environment (e.g., a second angular orientation relative to the origin of the first three-dimensional environment) that is different from the first orientation relative to the first three-dimensional environment, displaying the first user interface element at a second respective location in the first three-dimensional environment based on the second orientation, the second respective location being different from the first respective location. For example, provided that the orientation of the second user 1101b were to be an orientation that is different from the illustrated orientation of the second user 1101b in the first three-dimensional environment 1103 in FIG. 15C, the first computer system would optionally display the first user interface element 1506 at a location that is different from the illustrated location in FIG. 15D. As such, in some embodiments, the first computer system displays the first user interface element based on how the second user of the second computer system is oriented relative to the first three-dimensional environment. In some embodiments, the orientation of display of the first user interface element is based on the spatial arrangement of the users with whom the first user interface element is associated. For example, the first user interface element optionally corresponds to a sharing zone for sharing virtual content between the first user and the second user so the location of display of the first user interface element in the first three-dimensional environment is optionally based on the orientation of the second user in the first three-dimensional environment. In some embodiments, different sharing zones for sharing between different sets of users have different orientations in the first three-dimensional environment based on the orientations of the users with whom the respective user interface element for sharing is associated. In some embodiments, the location of display of the first user interface element is an ideal location for viewing and/or interacting with content based on the orientation of the second user and of the first user in the first three-dimensional environment. For example, the first computer system optionally displays the first user interface element at a location in the first three-dimensional environment from which a viewing angle of the first and second users would be equal to each other. In some embodiments, the first computer system displays the first user interface element at a location in the first three-dimensional environment that corresponds to a location that is in front of the second user. In some embodiments, the first computer system displays the first user interface element based on how the second user of the second computer system is oriented relative to an orientation of the first user of the first computer system. For example, were the second user to be oriented in a first orientation relative to the first user, the first computer system would optionally display the first user interface element at a first location in the first three-dimensional environment that is based on that first orientation. Continuing with this example, were the second user to be oriented in a second orientation relative to the first user, different from the first orientation relative to the first user, the first computer system would optionally display the first user interface element at a second location in the first three-dimensional environment that is based on that second orientation. In some embodiments, were the orientation of the second user to change (e.g., to change relative to the first three-dimensional environment and/or to an orientation of the first user), the first computer system updates the location of display of the first user interface element to be based on the updated orientation of the second user. In some embodiments, were the orientation of the second user to change (e.g., to change relative to the first three-dimensional environment and/or to an orientation of the first user), the first computer system maintains the original location of display of the first user interface element. Displaying the first user interface element for receiving a user interface for sharing at a location in the first three-dimensional environment that is based on an orientation of the second user of the second computer system relative to the first three-dimensional environment makes sharing of user interfaces more efficient since the respective user interface is shared with the second user from the sharing zone in which the first user interface element and since the orientation of the first user interface element at the location is based on the orientation of the second user, and reduces errors associated with sharing user interfaces.

In some embodiments, the sharing zone of the first three-dimensional environment is a first sharing zone for sharing between a first set of computer systems including the first computer system and the second computer system, and in accordance with the determination that one or more first criteria are satisfied, and in accordance with a determination that a second set of computer systems (e.g., the first computer system, the second computer system, and a third computer system, and optionally one or more additional computer systems), different from the first set of computer systems, is also collocated in the physical environment, and that one or more third criteria are satisfied, including a third criterion that is satisfied when the current viewport of the first computer system includes a respective location in a second sharing zone for sharing between the second set of computer systems, the first computer system concurrently displays, via the one or more first display generation components, the first user interface element at the location corresponding to the sharing zone and a second user interface element that is configured to receive a user interface of an application for sharing between the second set of computer systems, at a location corresponding to the second sharing zone. As such, in some embodiments, the first computer system displays different user interface element for receiving user interfaces for sharing with different sets of users that are collocated with the first user in the physical environment. In some embodiments, the second user interface element includes feature(s) of the first user interface element, such as the feature(s) of the first user interface element described herein with reference to method 1600 (e.g., step(s) 1602 of method 1600). In some embodiments, the first user interface element and the second user interface element do not overlap in location in the first three-dimensional environment. In some embodiments, displaying the first user interface element includes displaying a first indication that the first user interface element is for sharing with the first set of computer systems. For example, the first indication optionally includes name(s) and/or other representations of user(s) in the first set of computer systems. In some embodiments, displaying the second user interface element includes displaying a second indication, different from the first indication, that the second user interface element is for sharing with the second set of computer systems. For example, the second indication optionally includes name(s) and/or other representations of user(s) in the second set of computer systems. In some embodiments, the second set of computer systems includes the same number of computer systems as the first set of computer systems. In some embodiments, the second set of computer systems includes a different number of computer systems than a number of computer systems in the first set of computer systems. In some embodiments, the first set of computer systems includes the first and second computer systems, and the second set of computer systems includes the first computer system and a third computer system. In some embodiments, the second set of computer systems incudes the first and third computer systems, and additionally includes one or more other computer systems, such as the second computer system. In some embodiments, when the first computer system concurrently displays the first and second user interface elements described above, the respective user interface of step(s) 1602 of method 1600 is not yet being shared between the first and second computer systems. In some embodiments, the first computer system displays the first user interface element without displaying the second user interface element provided that the location corresponding to the first sharing zone is in the current viewport of the first computer system and that a location corresponding to the second sharing zone is not in the current viewport of the first computer system. In some embodiments, the first computer system displays the second user interface element without displaying the first user interface element provided that the location corresponding to the second sharing zone is in the current viewport of the first computer system and that the location corresponding to the first sharing zone is not in the current viewport of the first computer system. In some embodiments, the number of sharing zones and user interface elements for receiving user interfaces for sharing with different sets of users is based on a number of sets of computer systems in the physical environment. For example, when two sets of computer systems are in the physical environment, such as one set including the first and second computer systems and the other set including the first, second, and third computer systems, the first computer system optionally displays up to two user interface elements-one for sharing between the first and second computer systems and another for sharing between the first, second, and third computer system. As another example, when two sets of computer systems are in the physical environment, such as one set including the first and second computer systems and the other set including the first, second, and third computer systems, the first computer system optionally displays up to two user interface elements-one for sharing between the first and second computer systems, one for sharing between the first, second, and third computer system, and another for sharing between the first and third computer systems. Displaying different user interface elements for receiving a user interface for sharing with different sets of computer systems allows for sharing user interface with different sets of computer systems and reduces errors associated with mis-sharing user interface with unintended recipients since the different user interface elements are for sharing with different sets of computer systems, thus making sharing more efficient.

In some embodiments, displaying the second user interface element includes, in accordance with a determination that a spatial arrangement between users of computer systems of the second set of computer systems (e.g., the spatial arrangement between the computer systems of the second set of computer systems) in the physical environment is a first spatial arrangement, such as the illustrated spatial arrangement between the first user 1101a and the second user 1101b in FIG. 15C, displaying the second user interface element at a first respective location in the first three-dimensional environment based on the first spatial arrangement, such as the illustrated location of the first user interface element 1506 in FIG. 15D and in accordance with a determination that the spatial arrangement between users of the computer systems of the second set of computer systems (e.g., the spatial arrangement between the computer systems of the second set of computer systems) in the physical environment is a second spatial arrangement that is different from the first spatial arrangement, displaying the second user interface element at a second respective location in the first three-dimensional environment based on the second spatial arrangement, the second respective location being different from the first respective location. For example, provided that the spatial arrangement between the first user 1101a and the second user 1101b in FIG. 15C were to be different from the illustrated spatial arrangement between the first user 1101a and the second user 1101b in FIG. 15C, the first computer system would optionally display the first user interface element 1506 at a location that is different from the illustrated location in FIG. 15D. As such, in some embodiments, the first computer system displays the second user interface element based on the spatial arrangement of the users of the computer systems in the second set of computer systems (e.g., based on the locations and/or orientations of the users of the computer systems in the second set of computer systems relative to the first three-dimensional environment such as described above), such as described above with reference to displaying the first user interface element based on the spatial arrangement of the first and second users in the physical environment. Thus, in some embodiments, different user interface elements of different sharing zones in the first three-dimensional environment have different locations and/or orientations based on the locations and/or orientations of the users with whom the respective user interface element for sharing is associated. For example, were the second set of computer systems to include the first computer system, the second computer system, and the third computer system, were the relative positioning of the these computer systems in the physical environment to be in a first spatial arrangement (e.g., relative to the first computer system), the first computer system would optionally display the second user interface element at a location in the first three-dimensional environment that is based on the first spatial arrangement. Similarly, in some embodiments, the first computer system displays the first user interface element based on how the users of the computer systems of the second set of computer systems are oriented (e.g., relative to the first three-dimensional environment and/or relative to the first user), such as described above with reference to the first computer system displaying the first user interface element based on how the second user of the second computer system is oriented relative to the first three-dimensional environment. Note that display of the second user interface element is optionally in accordance with (e.g., based on) the spatial arrangement of the second set of computer systems, without is in accordance with the spatial arrangement of the first set computer systems. As such, the first computer system displays a respective user interface element for sharing based on the spatial arrangement that exists between the set of computer systems to which the sharing associated with the respective user interface element corresponds. Displaying a respective user interface element for sharing between a set of computer systems at a location that is based on the spatial arrangement that exists between the set of computer systems to which the sharing associated with the respective user interface element corresponds associates a location of display of the respective user interface element with the spatial arrangement that exists between the set of computer systems to which the sharing associated with the respective user interface element corresponds, which reduces errors associated with sharing of user interfaces with different sets of computer systems.

In some embodiments, the one or more second criteria also include a second criterion that is satisfied when the respective user interface of the respective application is at least partially in the first user interface element in the first three-dimensional environment when the first input has ceased being detected, such as the hand 1116 having released the air pinch (e.g., the index finger and thumb of the first user 1101a no longer being in contact with each other) while the first user interface 1106 is in (e.g., at least partially in) the first user interface element 1506 in FIG. 15I. For example, the first computer system optionally shares the respective user interface when the user input that corresponds to the first input is terminated or ended while the respective user interface is at least partially in the first user interface element. For example, as described above, when the first input includes an air pinch gesture, the first input optionally starts when the air pinch gesture is detected, the first input optionally continues while the air pinch hand shape is held, and optionally is terminated or ended when the air pinch gesture is released (e.g., the hand releases the air pinch hand shape). As other examples, when the first input includes a mouse click, touch on a touch screen, or a click or tap on a trackpad, the first input optionally terminates when the mouse click release is detected, when the touch input is no longer being detected, or when the click or tap input on the trackpad is complete, respectively. In some embodiments, the first input further includes movement of the hand while it is in the air pinch hand shape. In some embodiments, were the air pinch gesture to be released while the respective user interface is at least partially in the first user interface element due to movement of the respective user interface in accordance with the first input, the first computer system snaps the respective user interface to the first user interface element, as described above with reference to moving the respective user interface from the second location to the location corresponding to the sharing zone without input for doing so and shares the respective user interface with the second computer system. Sharing a user interface with a collocated user in response to a movement input when the movement input is completed while the user interface is within the first user interface element for sharing maps the dropped location of the user interface to a request for sharing and reduces errors associated with sharing of user interfaces.

In some embodiments, after moving the respective user interface away from the first location in accordance with the first input, in accordance with a determination that the one or more second criteria are not satisfied, the first computer system forgoes sharing the respective user interface of the respective application with the second computer system. For example, in response to the movement input of FIG. 15D, the first user interface 1106 is moved from the illustrated location in FIG. 15E to the illustrated location in FIG. 15E, and, since the first user interface 1106 is not at least partially in the first user interface element 1506 in FIG. 15E (and, optionally, since the first user interface 1106 is not at least partially in the sharing zone 1520 in FIG. 15E), the first computer system optionally does not share first user interface 1106. For example, the first computer system optionally forgoes sharing the respective user interface if the respective user interface is not moved to the location within the sharing zone of the first three-dimensional environment (e.g., is not moved to the location of the first user interface element in the first three-dimensional environment) when the air pinch gesture of the first input described above has been released. In some embodiments, the respective user interface has been moved in the first manner and not in the second manner, such as described with reference to the first and second manners below, when the respective has been moved without sharing of the respective user interface. For example, as described above, when the first input includes an air pinch gesture, the first input optionally starts when the air pinch gesture is detected, the first input optionally continues while the air pinch hand shape is held, and optionally is terminated or ended when the air pinch gesture is released (e.g., the hand releases the air pinch hand shape). In some embodiments, the first input further includes movement of the hand while it is in the air pinch hand shape. In some embodiments, were the air pinch gesture to be released while the respective user interface is not at, in, and/or within the first user interface element (e.g., no portion of the respective user interface is at, in, and/or within the first user interface element), the first computer system optionally forgoes sharing the respective user interface. Forgoing sharing a user interface with a collocated user in response to a movement input when the movement input is completed while the user interface is not within the first user interface element maintains consistency of the operation of sharing the user interface when the user interface is in the first user interface element, confirms to the first user that the user interface is not within the first user interface element for sharing, and reduces errors associated with sharing of user interfaces.

In some embodiments, while the respective user interface is in the sharing zone of the first three-dimensional environment and while the respective user interface is being shared with the second computer system, the first computer system detects an event, such as a leaving of the third user 1101b from the physical environment 1105 while the first user interface 1106 is being shared from the first user 1101a to the third user 1101c in FIG. 15P. In some embodiments, in response to detecting the event, in accordance with a determination that the event corresponds to a request to stop sharing the respective user interface (e.g., an event corresponding to a request to stop sharing the respective user interface with the second computer system), the first computer system ceases sharing of the respective user interface with the second computer system. For example, the event of the leaving of the third user 1101c from the physical environment 1105 while the first user interface 1106 is being shared from the first user 1101a to the third user 1101c optionally further corresponds to a request to stop sharing the first user interface 1106 with the third computer system 101c of the third user 1101c, and in response to the event, the first computer system stops sharing the first user interface 1106 with the third computer system 101c as shown from FIG. 15P to FIG. 15S. Note that, were the second user 1101b to leave the physical environment 1105 while the first user interface 1106 is being shared from the first user 1101a to the second user 1101b, the first computer system would optionally stop sharing the first user interface 1106 with the second computer system 101b. In some embodiments, the event is a second user of the second computer system leaving the physical environment (e.g., the room) with or without the second computer system. In some embodiments, the event is the first computer system no longer being collocated with the second computer system in the physical environment (e.g., in the room). In some embodiments, were a respective computer system with which the first computer system is sharing the respective user interface to leave the room, the respective user interface would cease being shared with that respective computer system. In some embodiments, were the first computer system to leave the room, the respective user interface would cease being shared with the set of computer systems that it was shared with before the first computer system left the room. In some embodiments, were the leaving computer system a computer system that did not initiate the sharing but was a recipient computer system of a sharing operation initiated at another computer system, the respective user interface would cease being shared with that specific computer system, but may still be shared with other computer systems in the room that may still be present (e.g., collocated). As such, in some embodiments, while the respective user interface is being shared, were the first computer system to detect an event that corresponds to a request to stop sharing of the respective user interface with a respective computer system, the first computer system would optionally cease sharing of the respective user interface with that respective computer system. Ceasing sharing of a user interface with a collocated user in response to detecting an event corresponding to a request to cease sharing of the user interface while the user interface was in the sharing zone allows for ceasing of sharing of the user interface and reduces errors associated with stopping sharing of user interfaces.

In some embodiments, in response to detecting the event, in accordance with a determination that the event also corresponds to a request to share a second respective user interface, different from the respective user interface, such as the request to the share the second user interface 1108 shown from FIG. 15V to FIG. 15W, the first computer system ceases sharing of the respective user interface with the second computer system, such as the stopping of sharing of the first user interface 1106 from FIG. 15W to FIG. 15X, and the first computer system shares the second respective user interface with the second computer system including causing the second respective user interface of the respective application to be concurrently associated with the location corresponding to the sharing zone of the first three-dimensional environment and associated with the respective location in the second three-dimensional environment, such as the initiation of sharing of the second user interface 1108 from FIG. 15W to FIG. 15X to FIG. 15Y. In some embodiments, sharing the second respective user interface includes one or more features described with reference to sharing the respective user interface of the respective application in step(s) 1602 of method 1600 above. In some embodiments, the event is movement of the second user interface from a location that is outside of the sharing zone of the first three-dimensional environment to a location that is inside of the sharing zone of the first three-dimensional environment. In some embodiments, in response to detecting the event, and in accordance with the determination that the event also corresponds to the request to share the second respective user interface, the first computer system moves the respective user interface to outside of the sharing zone of the first three-dimensional environment. In some embodiments, the first computer system moves the respective user interface to outside of the sharing zone of the first three-dimensional environment while the second respective user interface is being moved to within the sharing zone of the first three-dimensional environment. In some embodiments, while displaying the respective user interface in the sharing zone, and while the respective user interface is being shared with the second computer system, the first computer system detects a movement input directed to the second respective user interface, where the movement input (e.g., air pinch gesture with corresponding movement of the hand that is performing the air pinch gesture) requests movement of the second user interface to sharing zone (e.g., to the location of the respective user interface which is in the sharing zone). In response to detecting the movement input, the first computer system moves the second user interface to the sharing zone, optionally to the location of the respective user interface in the sharing zone, ceases sharing of the respective user interface with the second computer system, and initiates sharing of the second user interface. In some embodiments, were the first computer system to display the respective user interface while the second respective user interface is being shared with the second computer system, the first computer system would display the respective user interface at a location in the first three-dimensional environment that is outside of the sharing zone of the first three-dimensional environment. Ceasing sharing of a user interface with a collocated user and sharing a second user interface with the collocated user instead in response to detecting an event corresponding to a request to cease sharing of the user interface while the user interface was in the sharing zone and to a request to share the second user interface allows for changing with user interface is shared with the collocated user, reduces a number of inputs involved with sharing different user interfaces, and reduces errors associated with sharing different user interfaces, thus making sharing of different user interfaces more efficient.

In some embodiments, the location corresponding to the sharing zone of the first three-dimensional environment is a first respective location in the first three-dimensional environment, and while the respective user interface is in the sharing zone of the first three-dimensional environment and while the respective user interface is being shared with the second computer system, the first computer system detects, via the one or more first input devices, a second input requesting movement of the respective user interface in the first three-dimensional environment, such as the movement component of the input from the hand 1116 of the first user 1101a, as indicated by the arrow 1504e in FIG. 15L, while the grabber user interface element 1106b of the first user interface 1106 is selected. For example, the first computer system optionally detects attention (e.g., gaze) of the first user and/or an air gesture (e.g., an air pinch) that requests movement of the respective user interface. Additionally or alternatively, in some embodiments, the first computer system detects a voice input, an input via a mouse, touch screen or trackpad, or another type of input described herein that requests movement of the respective user interface. In some embodiments, detecting the input that requests movement of the respective user interface includes one or more characteristics described with reference to detecting inputs (e.g., inputs requesting movement of virtual content) and/or selections in methods 800, 1000, 1200, and/or 1400.

In some embodiments, in response to detecting the second input, the first computer system moves the respective user interface in accordance with the second input from the first respective location to a second respective location in the first three-dimensional environment that is different from the first respective location (e.g., displaying the respective user interface moving in the first three-dimensional environment away from the first location in accordance with the second input (e.g., moving in the requested direction by the requested amount of movement (e.g., moving in a direction/magnitude corresponding to the direction/magnitude associated with the first input))), such as the illustrated movement of the first user interface 1106 from FIG. 15L to FIG. 15M in accordance with the movement component of the input from the hand 1116 of the first user 1101a in FIG. 15L. In some embodiments, after moving the respective user interface to the second respective location, in accordance with a determination that a distance between the first respective location and the second respective location is a first distance that is less than a threshold distance (e.g., 0.1 m, 0.2 m, 0.4 m, 1 m, 2 m or another threshold distance), the first computer system maintains sharing of the respective user interface with the second computer system (e.g., including causing the respective user interface of the respective application to be concurrently associated with the second respective location and associated with a third respective location in the second three-dimensional environment, the third respective location in the second three-dimensional environment corresponding to the second respective location in the first three-dimensional environment), such as the maintaining of the sharing of the first user interface 1106 after the moving of the first user interface 1106 from FIG. 15L to FIG. 15M in accordance with the movement component of the input from the hand 1116 of the first user 1101a in FIG. 15L. As such, in some embodiments, the first computer system repositions the respective user interface while the respective user interface is being shared in response to movement input directed to the respective user interface while it is being shared in the sharing zone. In some embodiments, when the first computer system repositions the respective user interface, the sharing zone of the first three-dimensional environment is being re-positioned as well. For example, were the respective user interface to cease being shared with the second computer system, such as via user input requesting to cease sharing the respective user interface with the second computer system, the first computer system optionally would display the first user interface element at a position in the first three-dimensional environment that corresponds to where the respective user interface was last displayed in the first three-dimensional environment when shared, rather than a position corresponding to where the respective user interface was when the second input described above was detected. In some embodiments, the first computer system detects an input requesting movement of the sharing zone of the first three-dimensional environment while the respective user interface is at a location that is not within the sharing zone of the first three-dimensional environment, such as described with reference to step(s) 1602 of method 1600. For example, while the respective user interface is at a location that is not within the sharing zone of the first three-dimensional environment, such as described with reference to step(s) 1602 of method 1600, the first computer system optionally detects an input directed to the first user interface element, where the input request movement of the first user interface element in the first three-dimensional environment. For example, the input requesting movement of the first user interface element in the first three-dimensional environment optionally includes one or more features of the first input described with reference to step(s) 1602 of method 1600 and/or of the second input described above. Continuing with this example, in response to detecting the input requesting movement of the first user interface element in the first three-dimensional environment from a first location to a second location in the first three-dimensional environment, and in accordance with the determination that a distance between the first location and the second location is a first distance that is less than a threshold distance (e.g., 0.1 m, 0.2 m, 0.4 m, 1 m, 2 m or another threshold distance), the first computer system optionally moves the first user interface element in the first three-dimensional environment in accordance with the input requesting movement of the first user interface element, optionally including moving the sharing zone of the first three-dimensional environment in accordance with the input requesting movement of the first user interface element. Repositioning the shared user interface in response to movement input directed to the shared user interface allows for user customization of the location of the shared user interface in the three-dimensional environments of the users with which the user interface is shared and reduces errors associated with sharing user interfaces.

In some embodiments, after moving the respective user interface to the second respective location, in accordance with a determination that the distance between the first respective location and the second respective location is a second distance greater than the threshold distance, the first computer system ceases sharing of the respective user interface of the respective application with the second computer system. For example, were the movement requested in FIG. 15L, as indicated by the arrow 1504e indicating movement input from the hand 1116 of the first user 1101a, to further include the movement requested in FIG. 15M, as indicated by arrow 1504f indicating movement input from the hand 1116 of the first user 1101a, the first computer system would optionally move the first user interface 1106 in accordance with the requested movement and would optionally stop sharing the first interface 1106 (e.g., optionally because the first user interface 1106 is optionally no longer in a sharing zone of the first three-dimensional environment 1103). As such, in some embodiments, were the respective user interface to be moved further than the threshold distance, the first computer system ceases sharing of the respective user interface. Additionally or alternatively, in some embodiments, when the first computer system ceases sharing of the respective user interface, the respective user interface is at a location in the first three-dimensional environment that is not within the sharing zone of the first three-dimensional environment. Additionally or alternatively, in some embodiments, while moving the respective user interface from the first respective location to the second respective location, the respective user interfaces moves in different manners based on whether the respective user interface is inside the sharing zone of the first three-dimensional environment or not. For example, when moving the respective user interface from the first respective location to the second respective location in accordance with the second input requesting movement of the respective user interface in the first three-dimensional environment described above, the respective user interface passes a third respective location, and were a boundary of the sharing zone of the first three-dimensional environment to be at the third respective location, the respective user interface would optionally move in a first manner while moving from the first respective location to the third respective location and then would optionally move in a second manner, different from the first manner, while moving from the third respective location to the second respective location, such as the first and second manners described below. Ceasing sharing of a user interface in response to the shared user interface being moved more than a threshold distance allows for a user to cease sharing of the user interface via a movement input, and reduces a number of inputs involved with ceasing of sharing of the user interface.

In some embodiments, moving the respective user interface in accordance with a respective input (e.g., the first input that requests movement of the respective user interface away from the first location and/or another user input that requests movement of the respective user interface and optionally that includes one or more features of the first input described with reference to step(s) 1602 of method 1600) includes in accordance with a determination that the respective user interface is being moved while in the sharing zone of the first three-dimensional environment, moving the respective user interface in a first manner, such as the manner of movement of the first user interface 1106 illustrated from FIG. 15L to FIG. 15M. In some embodiments, movement of the respective user interface in of the sharing zone does not maintain a spatial arrangement between the respective user interface and the viewpoint of the first user. For example, the movement of the respective user interface in the sharing zone is optionally as if the respective user interface is rotating about an axis that is offset from a location of the viewpoint of the first user in the first three-dimensional environment and that is in between a location of the first user of the first computer system and a location of the second user of the second computer system. For example, the movement of the respective user interface in the sharing zone is optionally based on a location of the first user (e.g., the viewpoint of the first user) and on a location of the second user of the second computer system in the physical environment, optionally such that the movement of the respective user interface inside the sharing zone attempts to maintain the first and second users being able to view the respective user interface at an ideal viewing angle (e.g., 5, 10, 15, 20, 30 degree, or another viewing angle between a normal of the respective user interface and the viewpoint of the respective user). For example, the first computer system optionally maintains perpendicularity of the respective user interface to a vector extending from the center of the respective user interface to a point in space (e.g., a centroid or some other location) that is based on the locations and/or orientations of the set of users with whom the respective user interface is being shared in the sharing zone. Were the respective user interface shared with different sets of computer systems and/or in different sharing zones of the first three-dimensional environment, the point in space to which the first computer system would maintain the respective user interface as orthogonal to would be different in accordance with the different location and/or orientations of the different sets of users. In some embodiments, moving the respective user interface in accordance with a respective input (e.g., the first input that requests movement of the respective user interface away from the first location and/or another user input that requests movement of the respective user interface and optionally that includes one or more features of the first input described with reference to step(s) 1602 of method 1600) includes in accordance with a determination that the respective user interface is being moved while outside of the sharing zone of the first three-dimensional environment, moving the respective user interface in a second manner that is different from the first manner, such as the manner of movement of the first user interface 1106 illustrated from FIG. 15D to FIG. 15E. In some embodiments, movement of the respective user interface outside of the sharing zone maintains a spatial arrangement between the respective user interface and the viewpoint of the first user. For example, the movement of the respective user interface outside of the sharing zone is optionally as if the respective user interface is rotating about an axis that is centered at a location of the viewpoint of the first user in the first three-dimensional environment. For example, the movement of the respective user interface outside of the sharing zone is optionally based on a location of the first user without being based on a location of the second user of the second computer system in the physical environment. In some embodiments, for a given movement input, were the respective user interface to be in the sharing zone of the first three-dimensional environment, the movement of respective user interface in accordance with the given movement input is of a first speed while the respective user interface is moving in the sharing zone in accordance with the given movement input, and were the respective user interface to be outside the sharing zone, the movement of the respective user interface in accordance with the given movement input is of a second speed, different from the first speed, while the respective user interface is moving outside the sharing zone in accordance with the given movement input. For example, the first computer system optionally maintains perpendicularity of the respective user interface to the viewpoint of the first user (e.g., independent of the locations of any other users in the first three-dimensional environment and/or in the physical environment). Moving a user interface in different manners based on whether the user interface is in the sharing zone of the first three-dimensional environment or not indicates to the first user whether the user interface is being shared or not and reduces errors associated with operating the first computer system.

It should be understood that the particular order in which the operations in method 1600 have been described is merely exemplary and is not intended to indicate that the described order is the only order in which the operations could be performed. One of ordinary skill in the art would recognize various ways to reorder the operations described herein.

FIGS. 17A-1 through 17Z generally illustrate examples of a first computer system displaying a sharing user interface for selecting content to share with a second user of a second computer system in response to selection of a first user interface element that is displayed when the second user is detected in a viewport of the first computer system, where the first computer system and the second computer system are collocated in a physical environment in accordance with some embodiments.

In some embodiments, the sharing user interface includes a plurality of selectable options that corresponds to a plurality of different user interfaces of applications that are currently open on the first computer system. In some embodiments, the plurality of selectable options includes a first option that is selectable to initiate a process to share all user interfaces of applications that are currently open on the first computer system. In some embodiments, the plurality of selectable options includes a first option that is selectable to initiate a process to share less than all user interfaces of applications that are currently open on the first computer system. These and other embodiments of the disclosure are generally shown throughout FIGS. 17A-1 through 17Z, and the embodiments described with reference to FIGS. 17A-1 through 17Z are further described with reference to the method 1800.

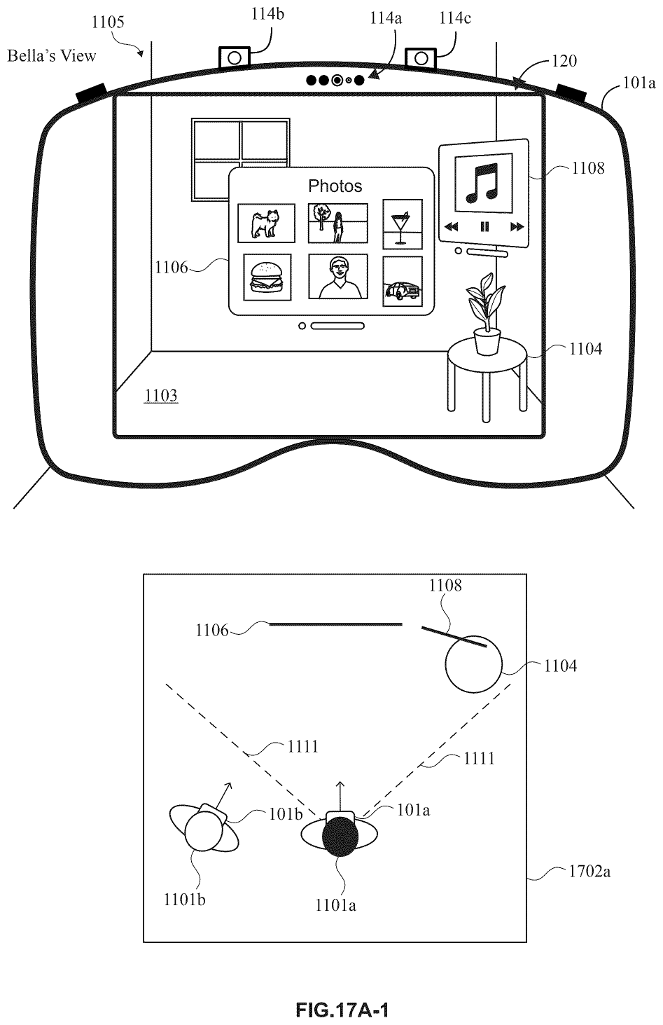

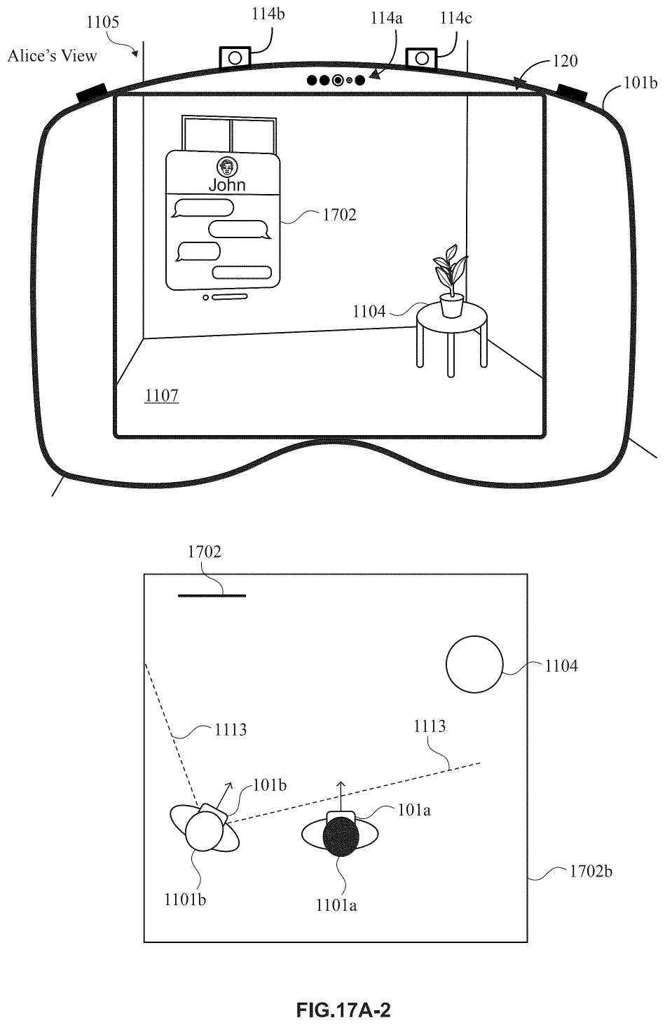

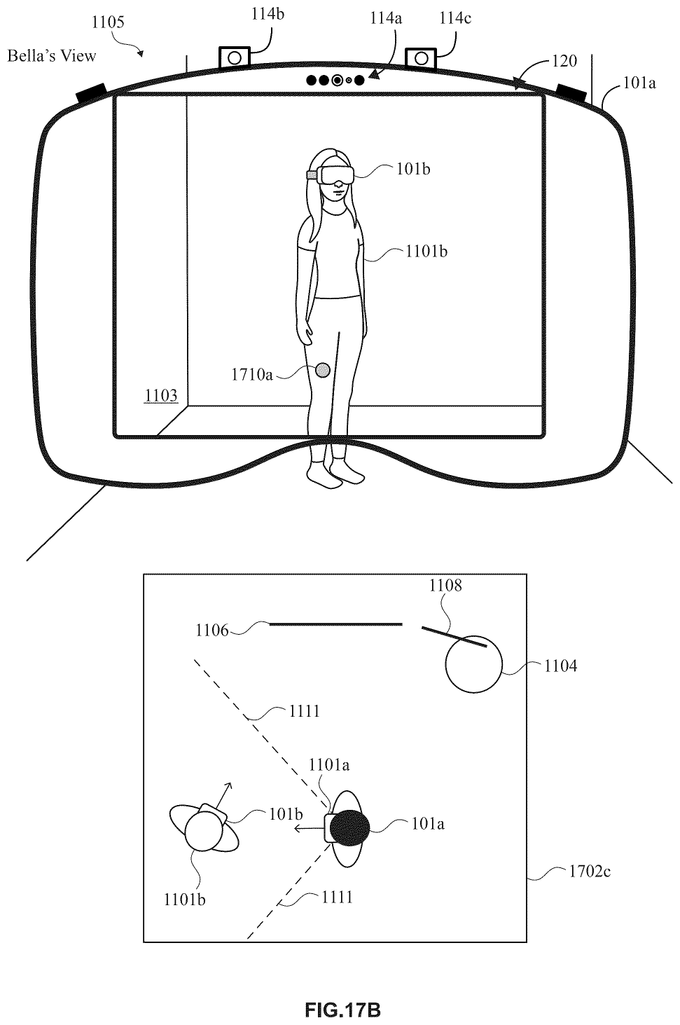

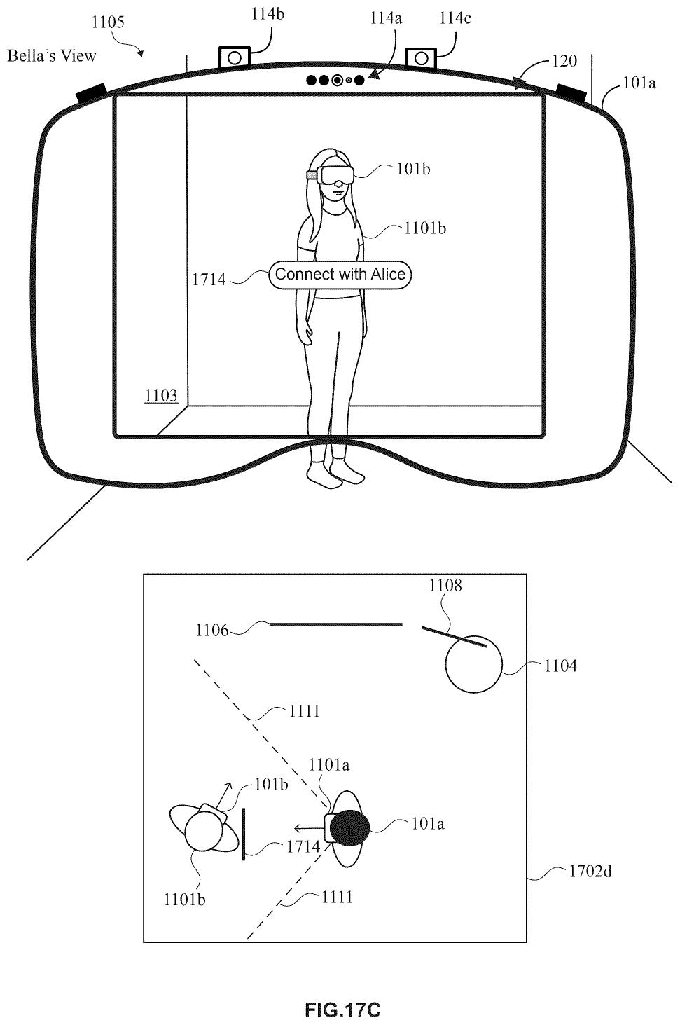

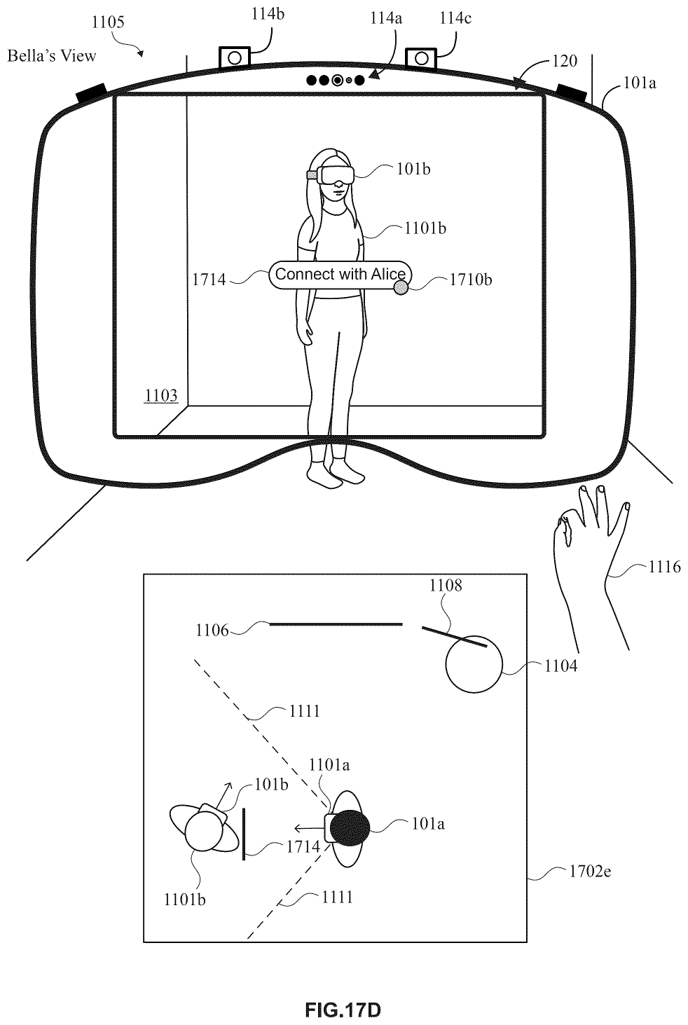

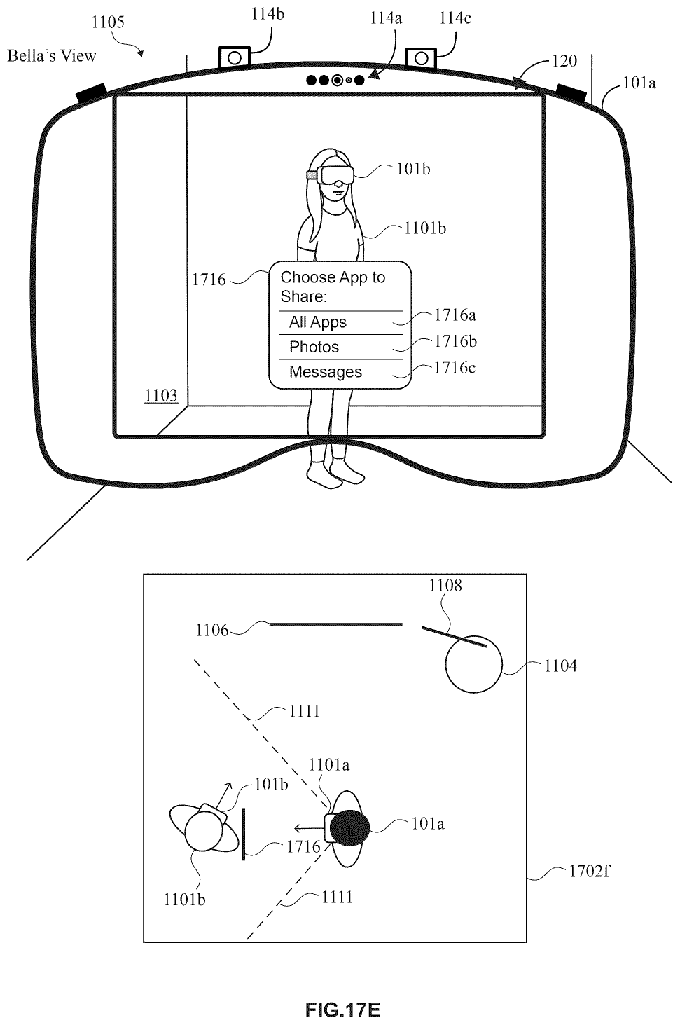

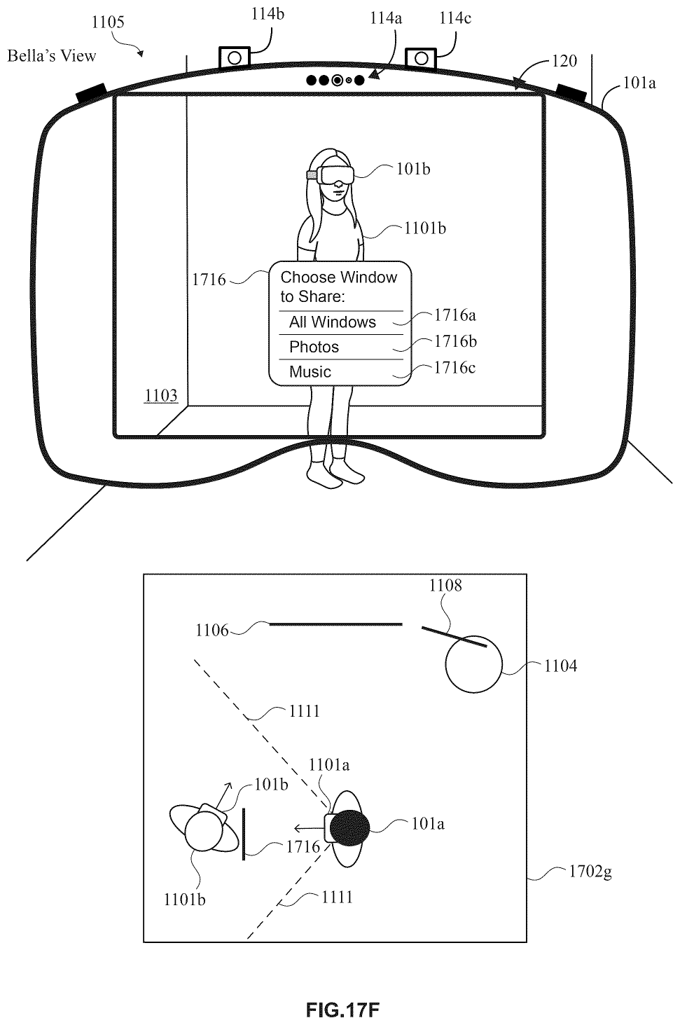

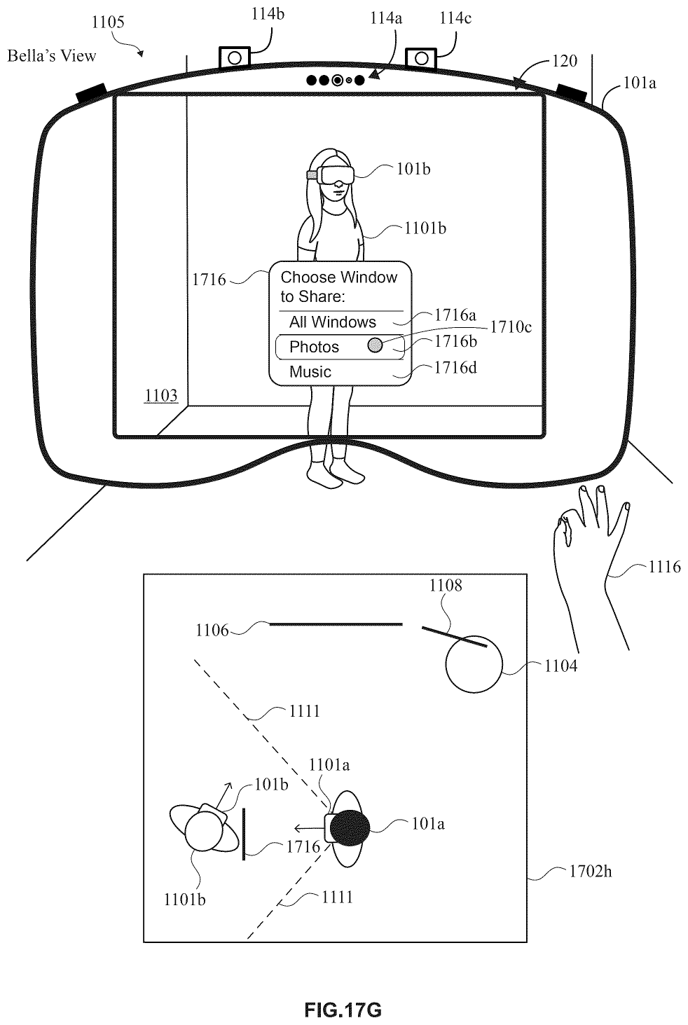

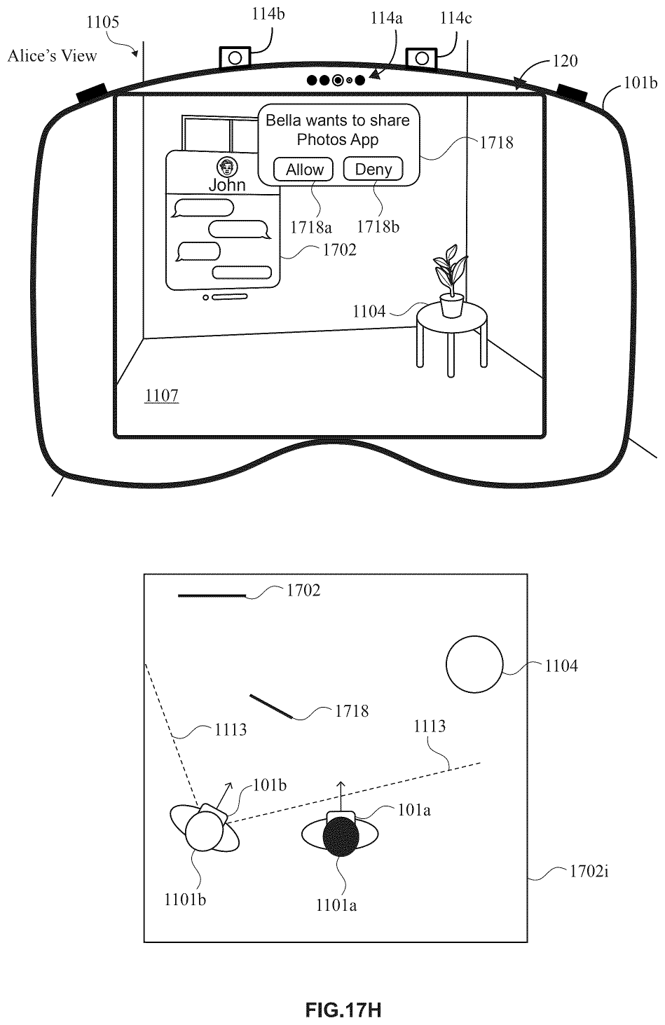

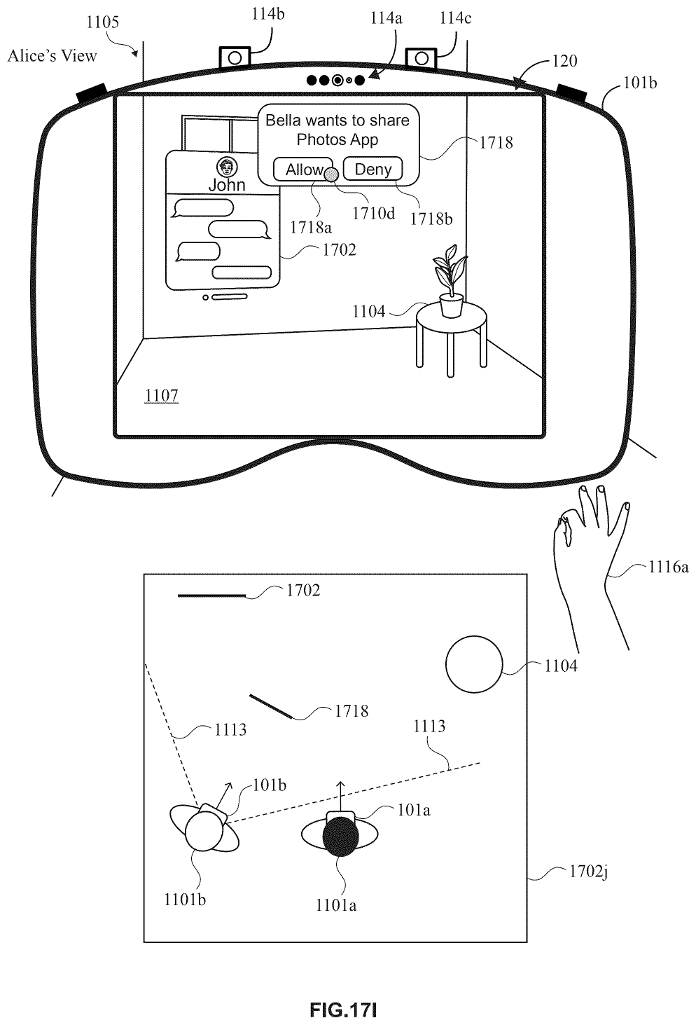

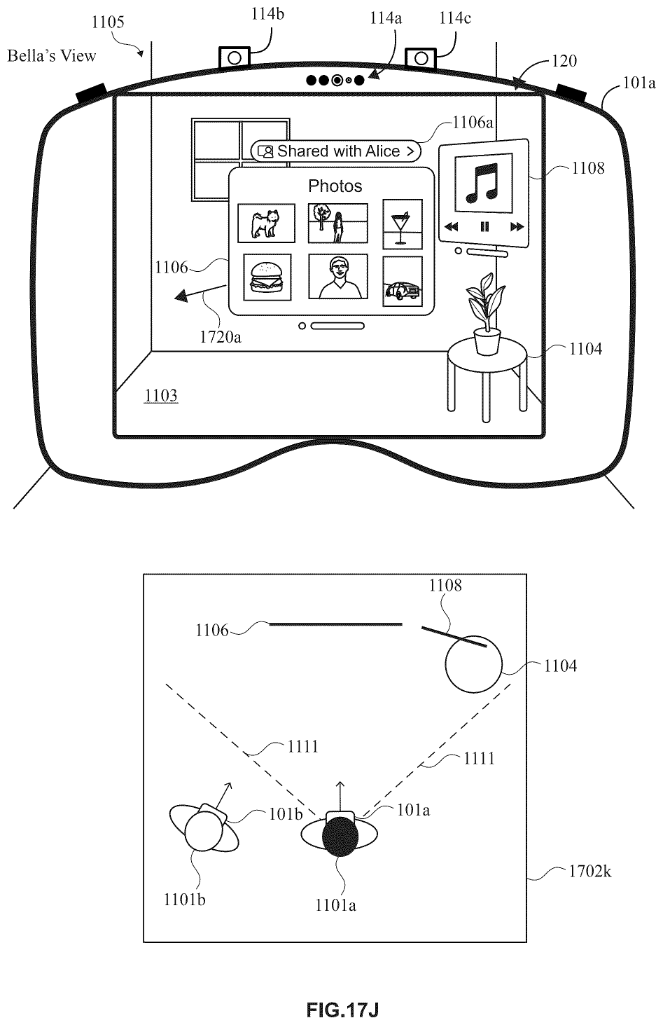

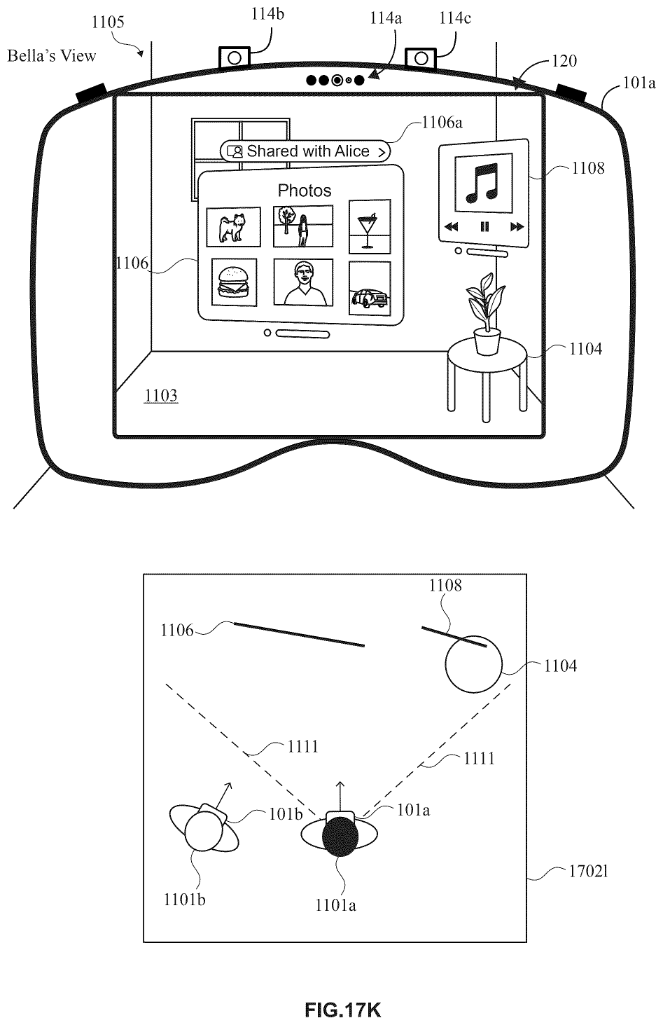

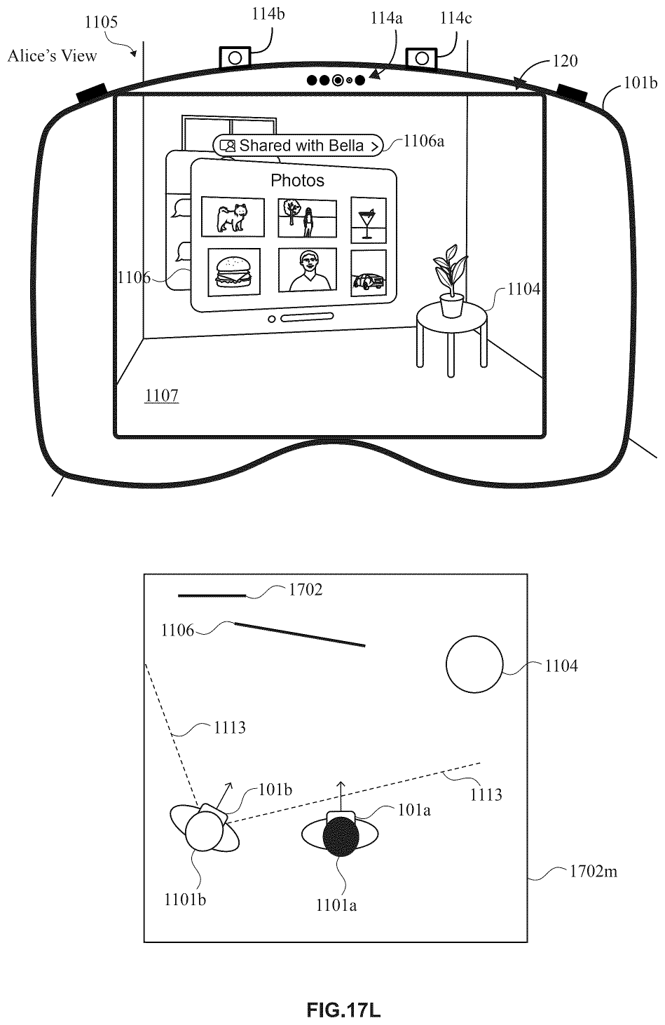

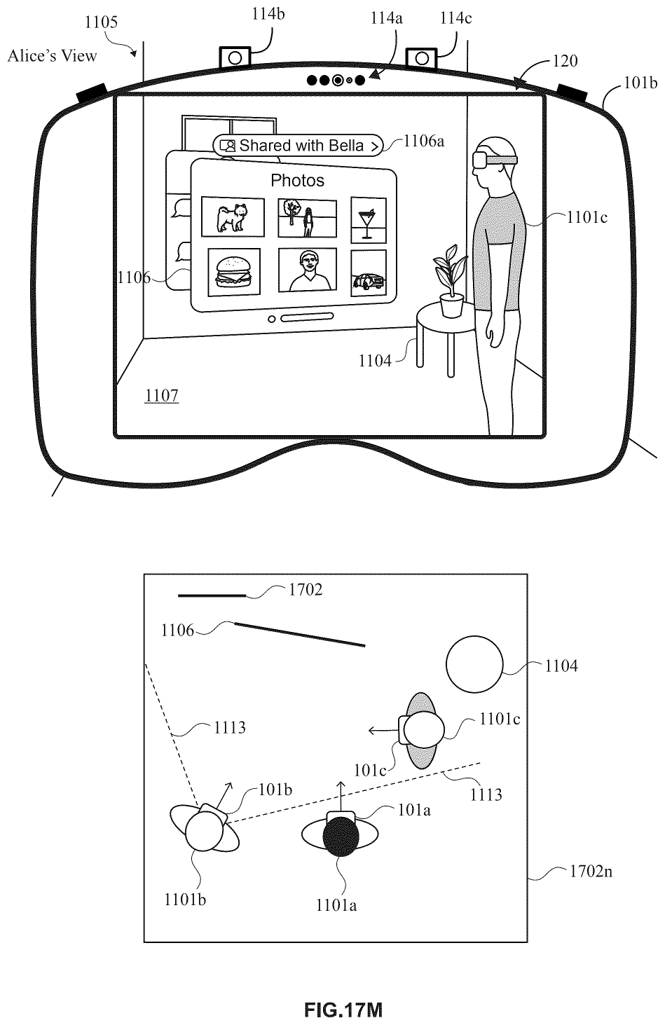

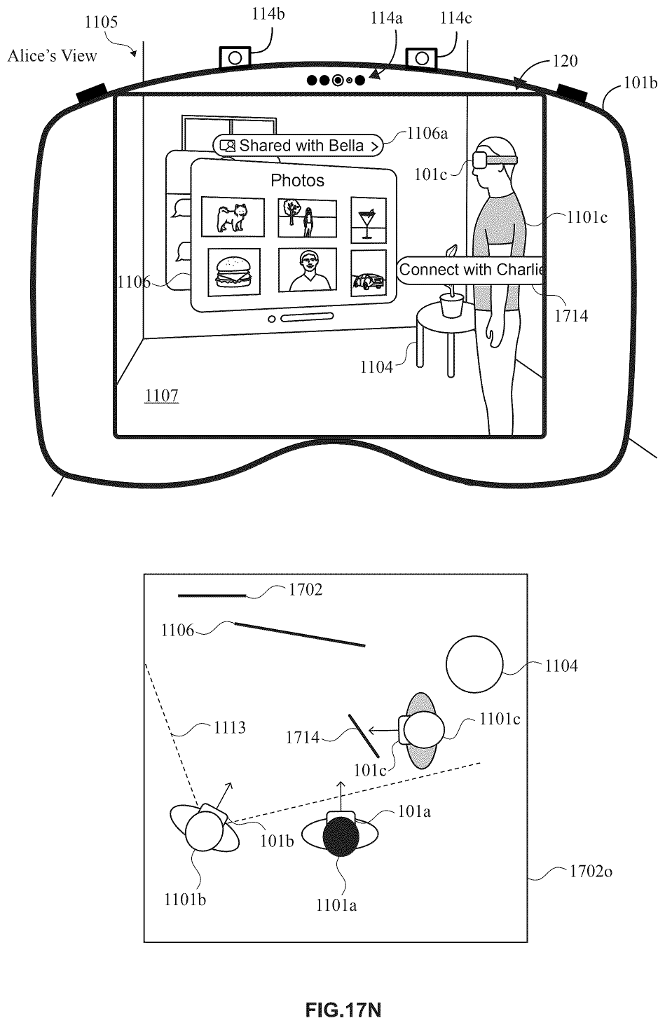

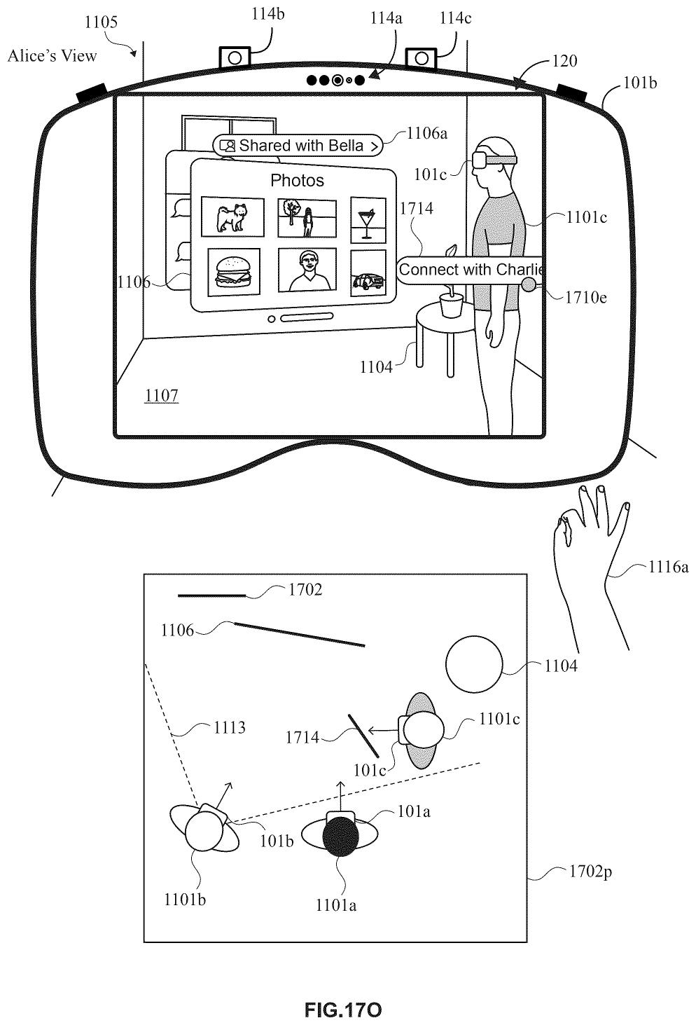

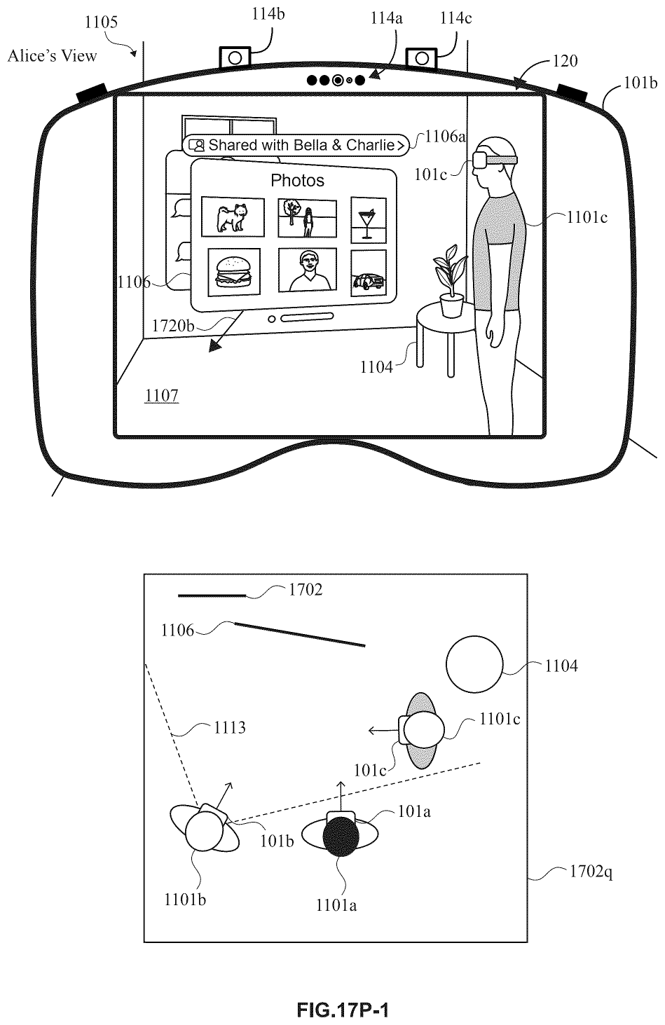

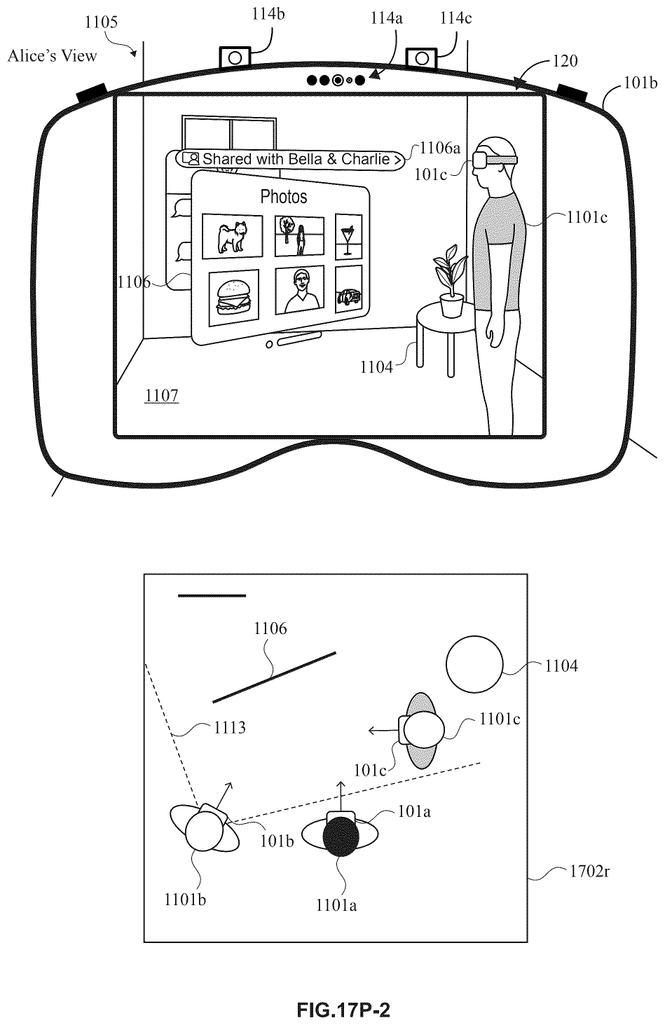

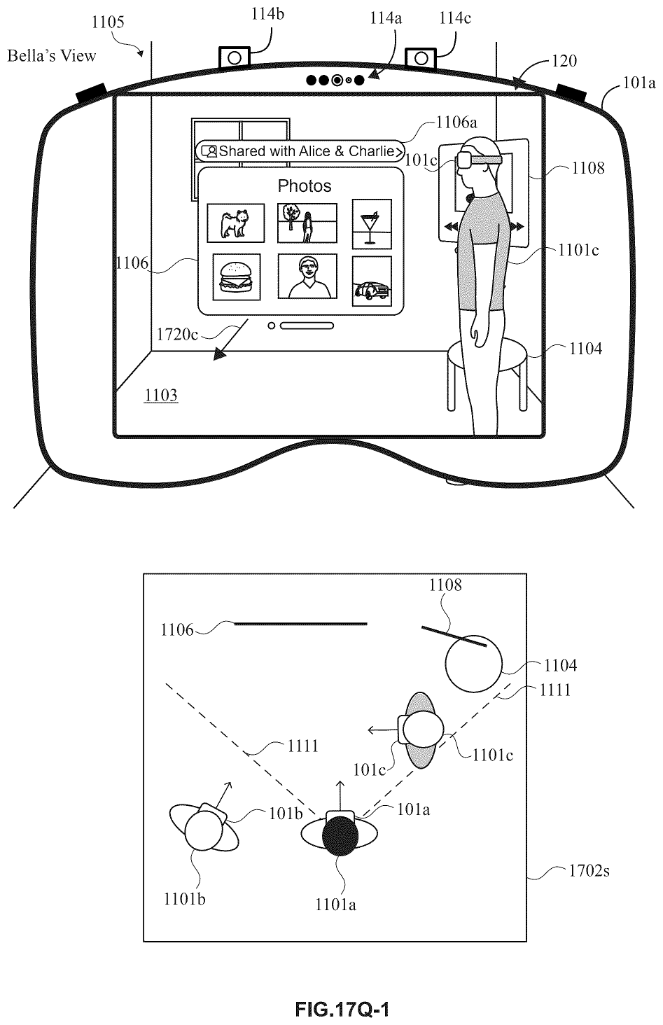

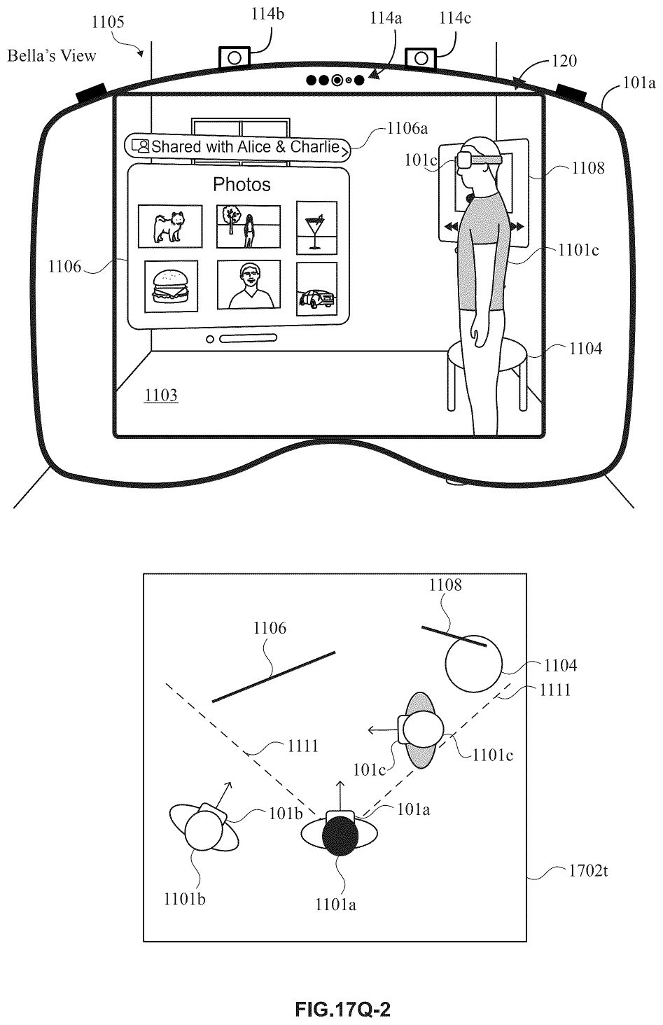

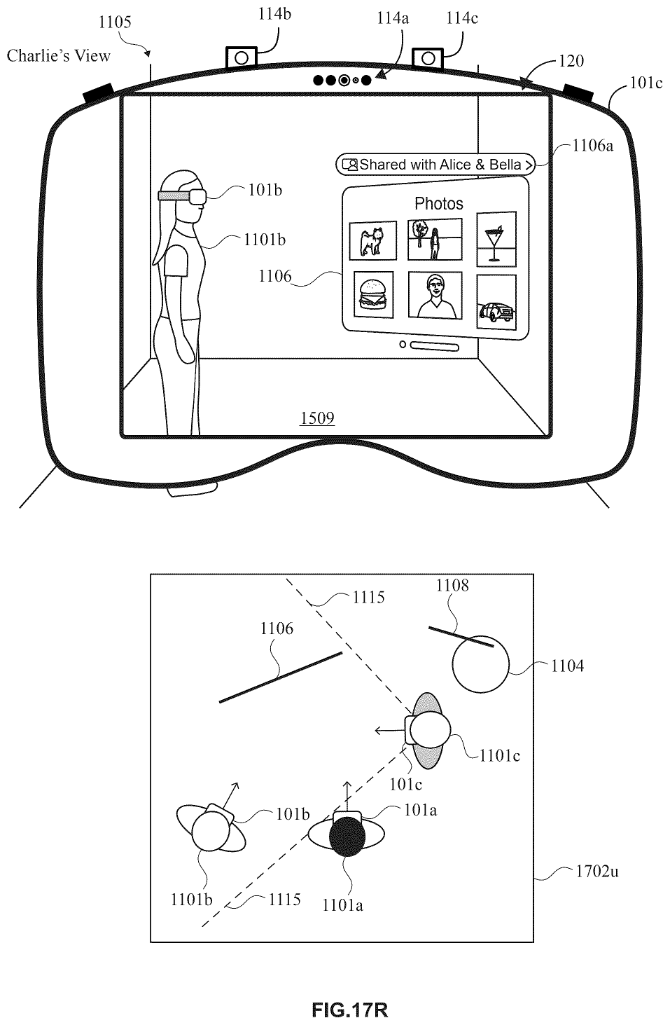

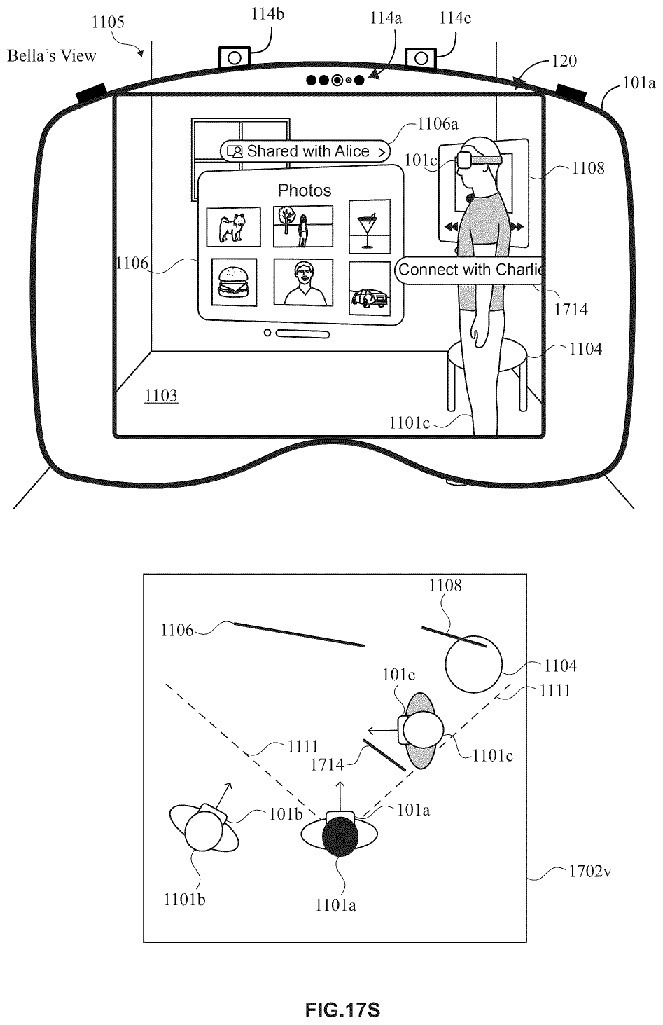

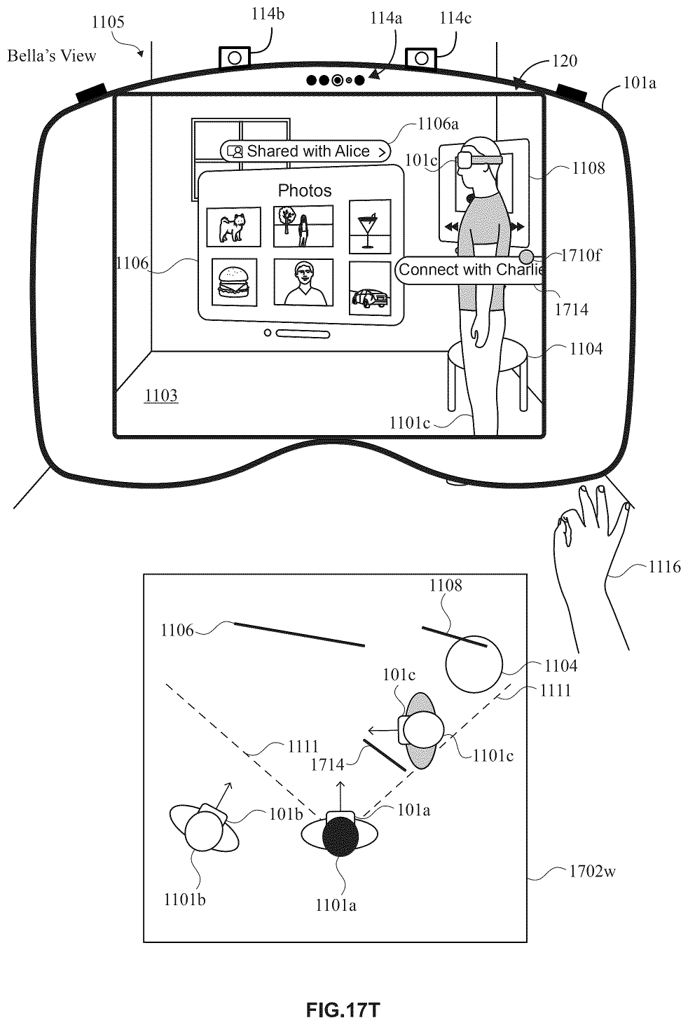

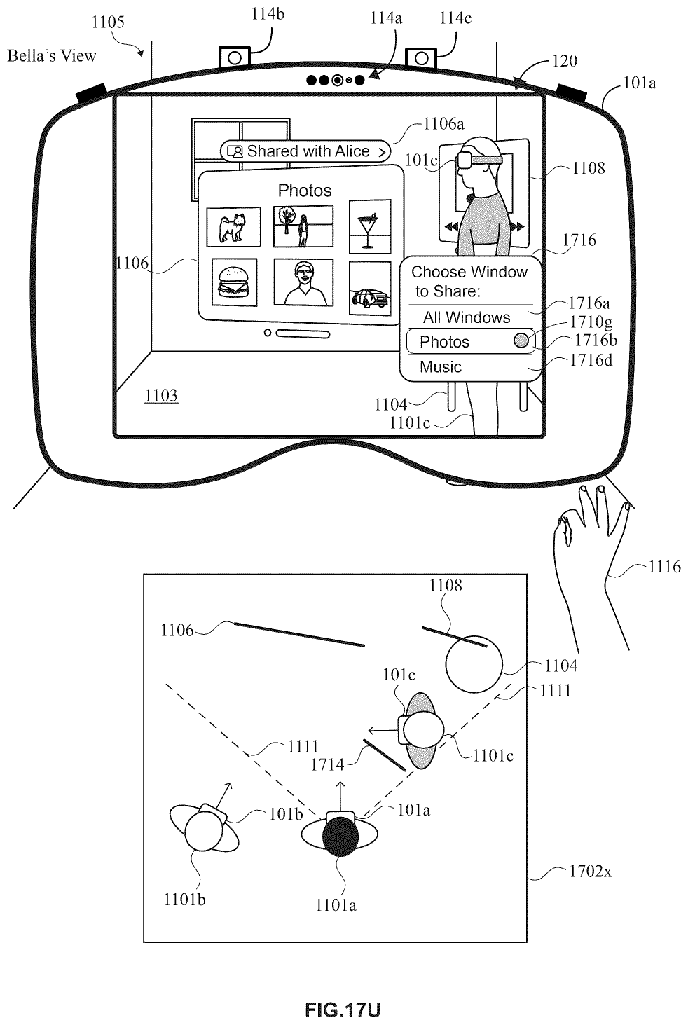

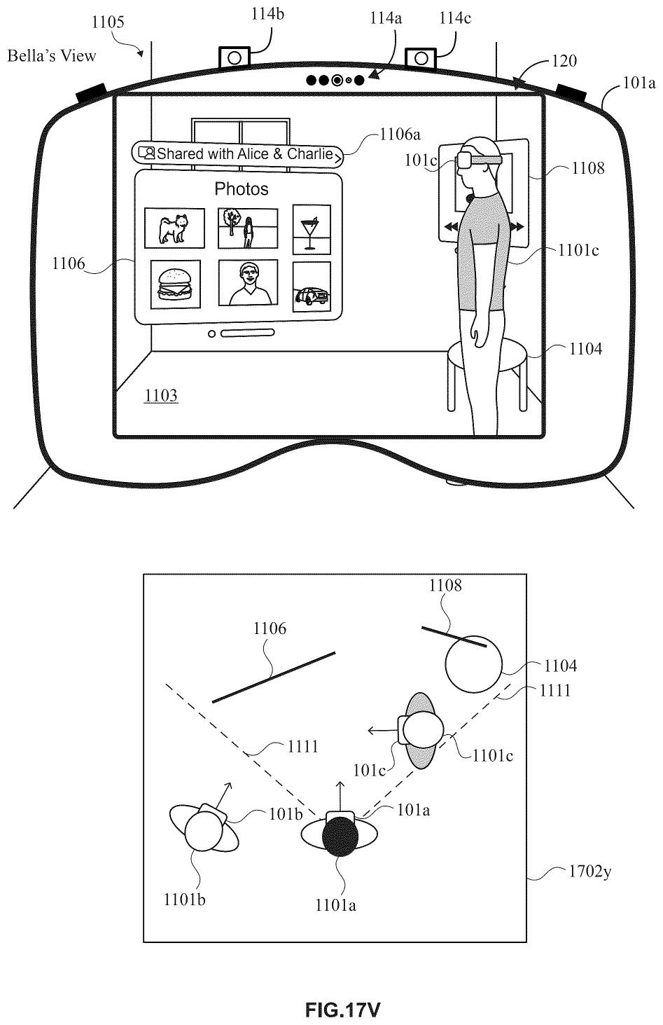

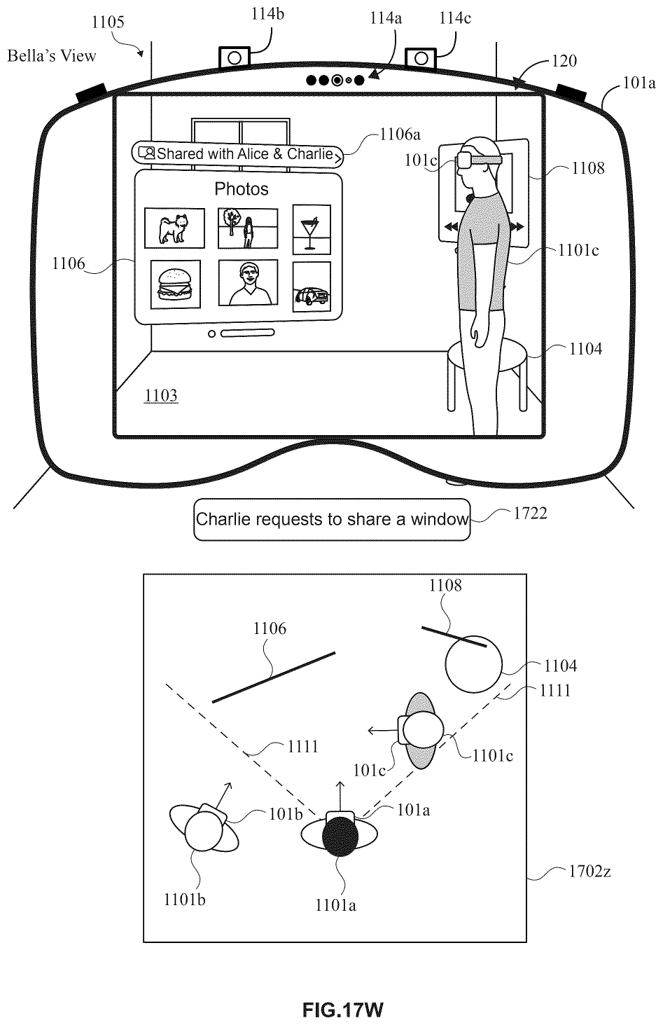

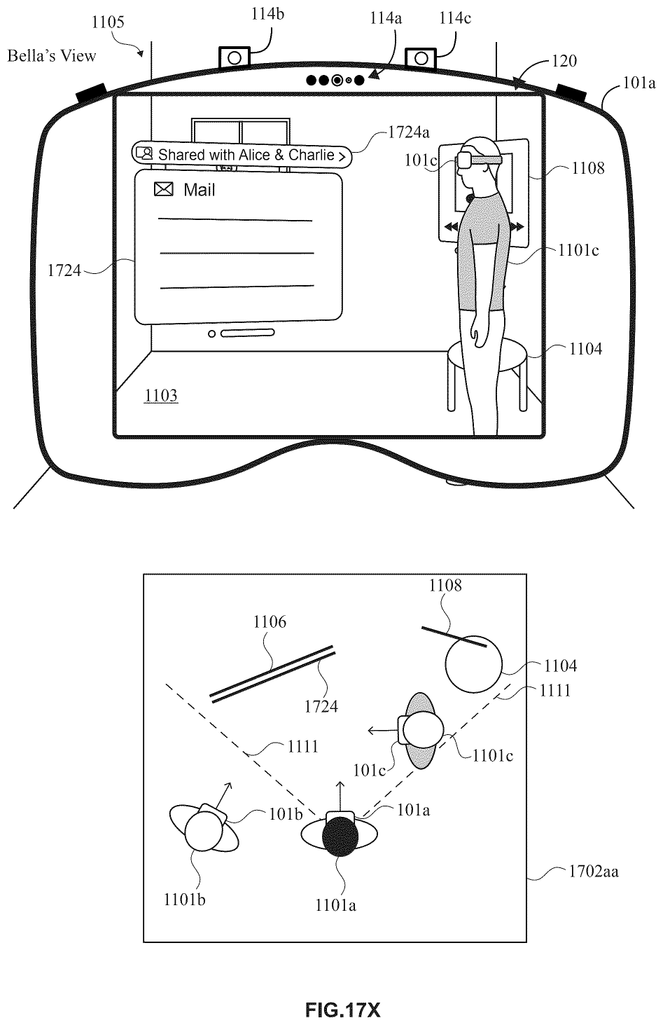

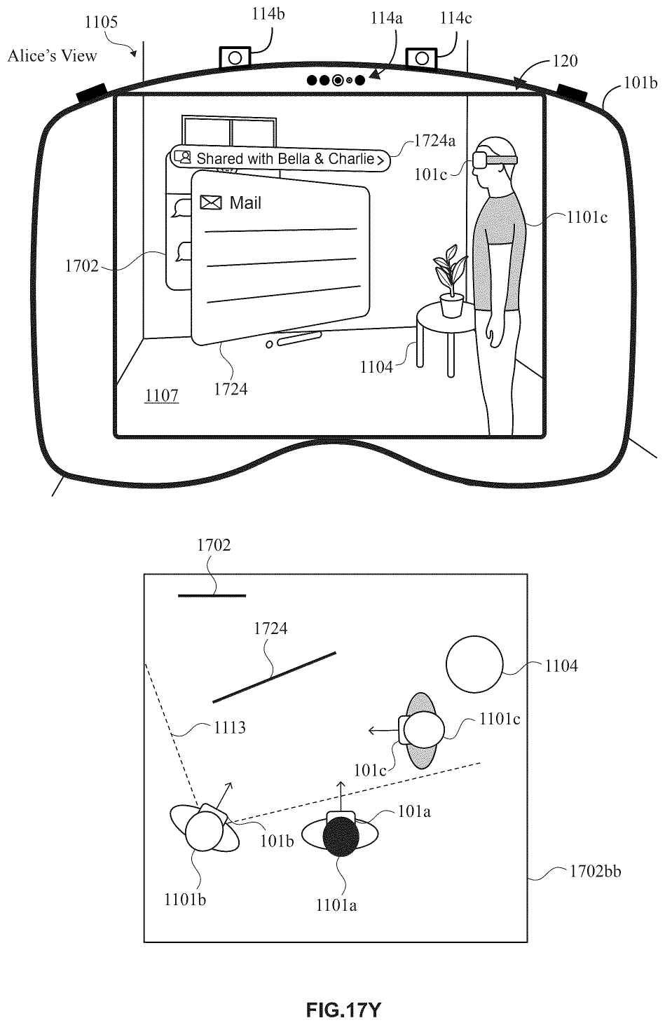

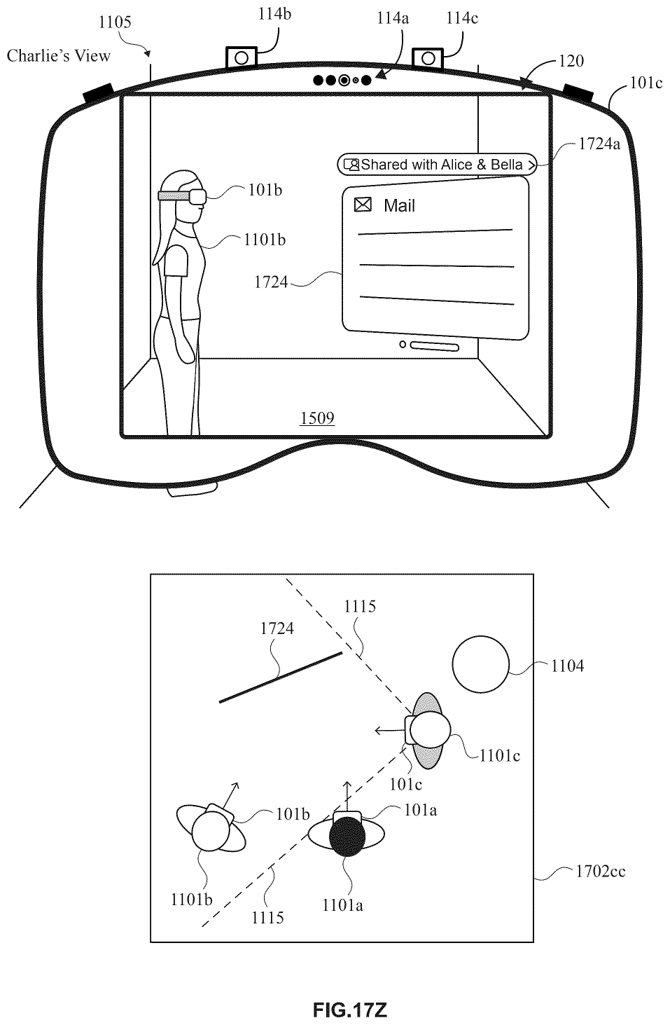

FIG. 17A shows the first computer system 101a (e.g., an electronic device) worn by the first user 1101a of the first computer system 101a displaying, via the display generation components 120 (e.g., display generation components 1-122a and 1-122b of FIG. 1), the first three-dimensional environment 1103 from a viewpoint of the first user 1101a (e.g., first user 1101a in overhead view 1702a of the first three-dimensional environment 1103) of the first computer system 101a (e.g., facing the back wall of the physical environment 1105 in which the first computer system 101a is located). The first user interface 1106 and the second user interface 1108 are likewise in the first three-dimensional environment 1103. Further, as shown in the overhead view 1702a of FIG. 17A, the first user 1101a of the first computer system 101a is collocated with the second user 1101b of the second computer system 101b in the physical environment 1105. Overhead views 1702a through 1702cc in FIGS. 17A-1 through 17Y show relative positioning of objects in the three-dimensional environment in a horizontal dimension and a depth dimension in the respective figure and the view of the three-dimensional environment in the respective figure shows the relative positioning of objects in the three-dimensional environment in a vertical dimension and a horizontal dimension (and, optionally in a depth dimension).

In FIG. 17A-1, the first computer system 101a displays the first user interface 1106 and the second user interface 1108. The first user interface 1106 and the second user interface 1108 are private to the first computer system 101a. That is, the first user interface 1106 and the second user interface 1108 are not being shared with the second computer system 101b in the illustrated figure. Thus, for example, in FIG. 17A-1, the first user interface 1106 and the second user interface 1108 are not displayed in a second three-dimensional environment of the second computer system 101b (e.g., and is therefore not visible to and/or interactive to the second user 1101b); such features are further made clear in view of FIG. 17A-2, which shows the second three-dimensional environment 1107 that is visible via display generation components 120 of the second computer system 101b (e.g., optionally at the same time as the first computer system 101a is displaying the first three-dimensional environment 1103 via the display generation component 120 in FIG. 17A-1). Further, in FIG. 17A-2, the second computer system 101b displays a third user interface 1702 (e.g., a messaging user interface of a messaging application) that is private to the second computer system 101b in the illustrated embodiment (e.g., the third user interface 1702 is not being shared with the first computer system 101a).

FIGS. 17A-1 and 17B through 17E illustrate a process for displaying a sharing user interface for selecting content to share with the second computer system 101b, according to some embodiments.

From FIG. 17A-1 to FIG. 17B, the first user 1101a turns (e.g., rotates the head of the first user 1101a) towards the second user 1101b, as shown with the rotation of the first user 1101a from their illustrated orientation in the overhead view 1702a of FIG. 17A-1 to their illustrated orientation in the overhead view 1702c of FIG. 17B. In response, the first computer system 101a updates the visible portion of the first three-dimensional environment 1103 in accordance with the change in viewpoint of the first user 1101a (e.g., with the change in the direction associated with the viewpoint of the first user 1101a), as shown with the change in the view of the first three-dimensional environment 1103 shown via display generation components 120 from FIG. 17A-1 to FIG. 17B. For example, in FIG. 17B, the second user 1101b is visible in the first three-dimensional environment 1103 via the display generation components 120 (e.g. the second user 1101b is visible in the viewport of the first computer system 101a) because the second user 1101b is at a location that corresponds to a location in the first three-dimensional environment 1103 that is now visible via the display generation components 120 of the first computer system 101a.

Additionally, in FIG. 17B, the first computer system 101a detects that attention (e.g., gaze) of the first user 1101a is directed to the second user 1101b, as shown by gaze point 1710a being on a portion of the second user 1101b. In response to detecting that attention (e.g., gaze) of the first user 1101a is directed to the second user 1101b, the first computer system 101a displays the user interface element 1714, as shown from FIG. 17B to FIG. 17C.

As shown in FIG. 17C, the first computer system 101a displays the user interface element 1714 between a position of the viewpoint of the first user 1101a and a position of the second user 1101b. The user interface element 1714 is optionally selectable to display a sharing user interface for selecting content to share with the second user 1101b (e.g., with the second computer system 101b), such as described below. Further, in some embodiments, display of the user interface element 1714 is in accordance with one or more features described with reference to criteria that may be satisfied in order for the first computer system 101a to display the user interface element 1114 of method 1200.

While displaying the illustrated view of the first three-dimensional environment 1103 of FIG. 17C, the first computer system 101a detects selection of the user interface element 1714, as shown in FIG. 17D. For example, in FIG. 17D, the first computer system 101a optionally detects input from the hand 1116 of the first user 1101a (e.g., detects the hand 1116 of the first user 1101a performing an air pinch gesture) while attention (e.g., gaze) of the first user 1101a is directed to the user interface element 1714, as indicated by gaze point 1710b. In response, the first computer system 101a ceases display of the user interface element 1714 and displays the sharing user interface 1716, as shown from FIG. 17D to FIG. 17E.

In FIG. 17E, the sharing user interface 1716 includes a plurality of selectable options that are selectable to share respective content with the second user 1101b of the second computer system 101b. In FIG. 17E, the selectable options indicate applications that are accessible for sharing content with the second computer system. In FIG. 17E, the selectable options include a first selectable option 1716a that is selectable to share multiple applications (e.g., all applications) that are accessible for sharing content with the second computer system 101b, a second selectable option 1716b that is selectable to share content of a photos application (e.g., a user interface of a photos application), and a third selectable option 1716c that is selectable to share content of a messaging application (e.g., a user interface of messaging application) with the second computer system 101b. In some embodiments, the sharing user interface 1716 indicates applications that are accessible for sharing content with the second computer system 101b independent of whether a respective application is currently active on the first computer system 101a (e.g., independent of whether the respective application is currently in use and/or associated with a user interface that is currently associated with a location in the first three-dimensional environment 1103). For example, the sharing user interface 1716 includes the third selectable option 1716c, which is selectable to cause the first computer system to share a messaging user interface of a messaging application with the second user 1101b, but the messaging application is not currently active on the first computer system 101a (e.g., in the FIG. 17E, the user interfaces of application that are associated with locations in the first three-dimensional environment 1103 includes the first user interface 1106 of the photos application and the second user interface 1108 of the music application as shown in the overhead view 1702f in FIG. 17E, and does not include a messaging user interface of a messaging application).

In FIG. 17E, the first computer system 101a displays the sharing user interface 1716 at a location that is between a position corresponding to the viewpoint of the first user 1101a and a position of the second user 1101b. In some embodiments, the first computer system 101a updates the location of display of the sharing user interface 1716 in the first three-dimensional environment 1103 in accordance with updates to (e.g., changes of) a position of the second user 1101b.

Additionally or alternatively, in some embodiments, the sharing user interface 1716 includes a plurality of selectable options that correspond to user interfaces of applications that are currently active on the first computer system 101a, such as shown in FIG. 17F. For example, while displaying the illustrated view of the first three-dimensional environment 1103 of FIG. 17C, the first computer system 101a optionally detects selection of the user interface element 1714, as shown in FIG. 17D and as described above. In response, the first computer system 101a optionally ceases display of the user interface element 1714 and displays the sharing user interface 1716 of FIG. 17F.

The sharing user interface 1716 of FIG. 17F includes a plurality of selectable options that correspond to user interfaces of applications that are currently active (e.g., open) on the first computer system 101a. In FIG. 17F, the selectable options include a first selectable option 1716a that is selectable to share multiple user interfaces of applications (e.g., all user interfaces of applications) that are accessible for sharing and are currently associated with locations in the first three-dimensional environment 1103 with the second user 1101b of the second computer system 101b, the second selectable option 1716b that is selectable to share content of a photos application (e.g., a user interface of a photos application) with the second user 1101b of the computer system 101b, and a fourth selectable option 1716d that is selectable to share content of a music application (e.g., a user interface of music application) with the second user 1101b of the second computer system 101b. In particular, in FIG. 17F, the first selectable option 1716a is selectable to share the first user interface 1106 and the second user interface 1108 with the second computer system 101b (e.g., since those user interfaces are accessible for sharing and are currently associated with locations in the first three-dimensional environment 1103), the second selectable option 1716b is selectable to share the first user interface 1106 (e.g., without being selectable to share the second user interface 1108), and the third selectable option 1716c is selectable to share the second user interface 1108 (e.g., without being selectable to share the first user interface 1106).

FIGS. 17G through 17M generally illustrates the first computer system 101a performing a process for sharing content, where the process is initiated in response to detecting selection of a selectable option of the sharing user interface 1716 of FIG. 17F, according to some embodiments.

In FIG. 17G, while displaying the illustrated view of the first three-dimensional environment 1103 of FIG. 17F, the first computer system 101a detects selection of the second selectable option 1716b, of the sharing user interface 1716, that is selectable to share content of a photos application (e.g., the first user interface 1106), as shown in FIG. 17G. For example, in FIG. 17G, the first computer system 101a optionally detects input from the hand 1116 of the first user 1101a (e.g., detects the hand 1116 of the first user 1101a performing an air pinch gesture) while attention (e.g., gaze) of the first user 1101a is directed to the second selectable option 1716b of the sharing user interface 1716, as indicated by gaze point 1710c. In response, the first computer system 101a optionally initiates a process for sharing the first user interface 1106, where the process includes notifying the second user 1101b that the first user 1101a requests to share the first user interface 1106, as shown in FIG. 17H.

In particular, in response to detecting selection of the second selectable option 1716b in FIG. 17G, the first computer system 101a optionally transmits an indication to the second computer system 101b that notifies that the first user 1101a requests to share the first user interface 1106. In response to detecting the indication, the second computer system 101b optionally displays a notification user interface element 1718 that indicates to the second user 1101b that the first user 1101a requests to share the first user interface 1106, as shown in FIG. 17H. The notification user interface element 1718 includes a first selectable option 1718a that is selectable to accept the request of the first user 1101a and a second selectable option 1718b that is selectable to deny the request of the first user 1101a.

In FIG. 171, while displaying the illustrated view of the second three-dimensional environment 1107 of the second user 1101b in FIG. 17H, the second computer system 101b detects selection of the first selectable option 1718a that is selectable to accept the request of the first user 1101a, as shown in FIG. 171. For example, in FIG. 171, the first computer system 101a optionally detects input from the hand 1116a of the second user 1101b (e.g., detects the hand 1116a of the second user 1101b performing an air pinch gesture) while attention (e.g., gaze) of the second user 1101b is directed to the first selectable option 1718a, as indicated by gaze point 1710d.

In some embodiments, in response to detecting selection of the first selectable option 1718a, the second computer system 101b transmits an indication to the first computer system that notifies that the second user 1101b accepts the request of the first user 1101a to share the first user interface 1106. In response to detecting the indication, the first computer system optionally initiates a process to share the first user interface 1106 (e.g., the photo user interface of the photos application), where the process includes performing one or more operations for sharing, as shown in FIGS. 17J through 17M.

In some embodiments, as shown from FIG. 17J to FIG. 17K, the process to share the first user interface 1106 includes the first computer system 101a moving the first user interface 1106 in the first three-dimensional environment 1103, as shown with the arrow 1720a in FIG. 17J, to a predetermined location, as shown with the location of the first user interface 1106 in FIG. 17K, in the first three-dimensional environment 1103 that is based on a spatial arrangement between a viewpoint of the first user 1101a and a location of the second user 1101b. In some embodiments, the location to which the first user interface 1106 is moved in the first three-dimensional environment 1103 is an ideal location for viewing the first user interface 1106 and/or interacting with the first user interface 1106 for the first user 1101a and the second user 1101b. Movement of a user interface that is to be shared by the first computer system 101a is described further with reference to the method 1800. Additionally, the process to share the first user interface 1106 optionally includes the first computer system 101a causing the second computer system 101b to display the first user interface 1106 at a location in the second three-dimensional environment 1107 of the second user 1101b that corresponds to the location in the first three-dimensional environment 1103 to which the first user interface 1106 was moved, as shown in FIG. 17L.

Note that the pose (e.g., position and/or orientation) of the first user interface 1106 in the first three-dimensional environment 1103 is optionally the same as the pose (e.g., position and/or orientation) of the first user interface 1106 in the second three-dimensional environment 1107, thus, the first user interface 1106 is optionally spatially the same between the first three-dimensional environment 1103 of the first user 1101a and the second three-dimensional environment 1107 of the second user 1101b. For example, the first user interface 1106 in the view of the first three-dimensional environment 1103 in FIG. 17K appears to be oriented toward a location of the second user 1101b and the first user interface 1106 in the view of the second three-dimensional environment 1107 in FIG. 17L appears to be oriented toward a location of the first user 1101a. Continuing with this example, the first user interface 1106 in FIGS. 17K and 17L is facing a point in space that is between the viewpoint of the first user 1101a and the location of the second user 1101b, which is to say that the first user interface 1106 is facing (e.g., a normal of the first user interface 1106 is facing) a point in space that, relative to the first computer system 101a, is between the viewpoint of the first user 1101a and the location of the second user 1101b, and that, relative to the second computer system 101b, is between the viewpoint of the second user 1101b and a location of the first user 1101a. Thus, in some embodiments, the process for the first computer system 101a to share the first user interface 1106 corresponding to the selectable option of the sharing user interface 1716 includes movement of the first user interface 1106 to a predetermined location that is based on the spatial arrangement between the viewpoint of the first user 1101a and the location of the second user 1101b, and includes the first computer system 101a causing the second computer system 101b to display the first user interface 1106.

Further, as shown in FIGS. 17J and 17K, when the first user interface 1106 is shared with the second user 1101b, the first computer system displays pill 1106a indicating that the first user interface 1106 is being shared with the second user 1101b. Likewise, as shown in FIG. 17L, the second computer system 101b displays pill 1106a indicating that the first user interface 1106 is being shared with the first user 1101a (e.g., is from the first user 1101a). Additionally, note that a communication session between the first user 1101a and the second user 1101b is optionally established when the first user interface 1106 becomes shared between the first user 1101a and the second user 1101b.

In some embodiments, in a communication session, were a user other than a current sharer of content in the communication session to request to add an additional user to the communication session, their computer system would optionally initiate a process to share with the additional user the content that is already being shared in the communication session, such as shown and described with reference to FIGS. 17M through 17R. FIGS. 17M through 17R generally illustrate the second computer system 101b detecting and responding to a request from the second user 1101b, who is in the communication session between the first user 1101a and the second user 1101b, to add the third user 1101c to the communication session while a user interface is already being shared in the communication session from the first user 1101a, according to some embodiments.

In FIG. 17M, while displaying the view of the second three-dimensional environment 1107 illustrated in FIG. 17L and while the first user interface 1106 is being shared between the first user 1101a and the second user 110b of the communication session, the second computer system 101b detects that a third user 1101c is in the viewport of the second computer system 101b, as shown in FIG. 17M. For example, in FIG. 17M, the third user 1101c is visible in the second three-dimensional environment 1107 via the display generation components 120 of the second computer system 101b (e.g. the third user 1101c is visible in the viewport of the second computer system 101b) because the third user 1101c is at a location that corresponds to a location in the second three-dimensional environment 1107 that is now visible via the display generation component 120 of the second computer system 101b. Note that in FIG. 17M, the third user 1101c is not in the communication session that is between the first user 1101a and the second user 1101b. In some embodiments, the third user 1101c is collocated with the first user 1101a and/or the second user 1101b in the physical environment 1105.

Additionally, in FIG. 17M, the second computer system 101b detects that attention (e.g., gaze) of the second user 1101b is directed to the third user 1101c, as shown by gaze point 1710e being on a portion of the third user 1101c. In response to detecting that attention (e.g., gaze) of the second user 1101b is directed to the third user 1101c, the second computer system 101b displays the user interface element 1714, as shown from FIG. 17M to FIG. 17N.

The user interface element 1714 of FIG. 17N optionally includes one or more features of the user interface element 1714 of FIG. 17C, but is relative to the third user 1101c instead of being relative to the second user 1101b. For example, as shown in FIG. 17N, the second computer system 101b displays the user interface element 1714 between a position of the viewpoint of the second user 1101b and a position of the third user 1101c. The user interface element 1714 of FIG. 17N is optionally not selectable to display a sharing user interface for selecting content to share with the third user 1101c (e.g., with the third computer system 101c), but is selectable to display shared content. Further, in some embodiments, display of the user interface element 1714 by the second computer system 101b is in accordance with one or more features described with reference to criteria that may be satisfied for the first computer system 101a to display the user interface element 1114 of method 1200 but is relative to the second user 1101b and the third user 1101c (e.g., the second computer system 101b and the third computer system 101c) instead of being relative to the first user 1101a and the second user 1101b (e.g., the first computer system 101a and the second computer system 101b).

While displaying the illustrated view of the second three-dimensional environment 1107 of FIG. 17N, the second computer system 101b detects selection of the user interface element 1714, as shown in FIG. 170. For example, in FIG. 170, the second computer system 101b optionally detects input from the hand 1116a of the second user 1101b (e.g., detects the hand 1116a of the second user 1101b performing an air pinch gesture) while attention (e.g., gaze) of the second user 1101b is directed to the user interface element 1714, as indicated by gaze point 1710e. In response, the second computer system 101b initiates a process to share the first user interface 1106 with the third computer system 101c (e.g., with the third user 1101c), such as shown in FIGS. 17P-1 through 17R. In some embodiments, the process does not include the second computer system 101b displaying a sharing user interface to which further input from the second user 1101b can be detected for determining which user interface the second user 1101b requests to share. Additionally or alternatively, in some embodiments, the first computer system 101a detects an indication from the second computer system 101b that the second user 1101b has selected selection of the user interface element 1714 and then the first computer system 101a causes the second computer system 101b to initiate the process, such as shown in FIGS. 17P-1 through 17R.

In some embodiments, as shown from FIG. 17P-1 to FIG. 17P-2, since the first user interface 1106 is being shared between solely the first user 1101a and the second user 1101b when the process to share the first user interface 1106 with the third computer system 101c is initiated, the process to share the first user interface 1106 with the third computer system 101c includes the second computer system 101b moving the first user interface 1106 in the second three-dimensional environment 1107 of the second computer system 101b (and/or optionally the first computer system 101a causing the second computer system 101b to move the first user interface 1106 in the second three-dimensional environment 1107 of the second computer system 101b), as shown with the arrow 1720b in FIG. 17P-1, to a predetermined location, as shown with the location of the first user interface 1106 in FIG. 17P-2, in the second three-dimensional environment 1107 that is based on a spatial arrangement between a viewpoint of the second user 1101b, a location of the first user 1101a, and a location of the third user 1101c. In some embodiments, the location to which the first user interface 1106 is moved in the second three-dimensional environment 1107 is an ideal location for viewing the first user interface 1106 and/or interacting with the first user interface 1106 for the first user 1101a, the second user 1101b, and the third user 1101c, optionally based on their relative positioning in the physical environment 1105 in which they are collocated. For example, as described above, when the second computer system 101b displays the first user interface 1106 at its illustrated location in FIG. 17P-1, the first user interface 1106 is at a predetermined location in the second three-dimensional environment 1107 of the second user 1101b that is based on a spatial arrangement between a viewpoint of the second user 1101b and a location of the first user 1101a (e.g., without being based on a location of the third user 1101c), optionally because the communication session solely includes the first user 1101a and the second user 1101b. Continuing with this example, when the first user interface 1106 is further shared with the third user 1101c after being shared between just the first user 1101a and the second user 1101b, the second computer system 101b moves the first user interface 1106 to a predetermined location that is based on a spatial arrangement between a viewpoint of the second user 1101b, a location of the first user 1101a, and a location of the third user 1101c, as shown from FIG. 17P-1 to FIG. 17P-2, optionally because the communication session now includes the first user 1101a, the second user 1101b, and the third user 1101c.

Similarly, in some embodiments, as shown from FIG. 17Q-1 to FIG. 17Q-2, since the first user interface 1106 is being shared between just the first user 1101a and the second user 1101b when the process to share the first user interface 1106 with the third computer system 101c is initiated, the process to share the first user interface 1106 with the third computer system 101c includes the first computer system 101a moving the first user interface 1106 in the first three-dimensional environment 1103 of the first computer system 101a, as shown with the arrow 1720c in FIG. 17Q-1, to a predetermined location, as shown with the location of the first user interface 1106 in FIG. 17Q-2, in the second three-dimensional environment 1107 that is based on a spatial arrangement between a viewpoint of the first user 1101a, a location of the second user 1101b, and a location of the third user 1101c. In some embodiments, the location to which the first user interface 1106 is moved in the first three-dimensional environment 1103 is an ideal location for viewing the first user interface 1106 and/or interacting with the first user interface 1106 for the first user 1101a, the second user 1101b, and the third user 1101c, optionally based on their relative positioning in the physical environment 1105 in which they are collocated. For example, in some embodiments, as described above, when the first computer system 101a displays the first user interface 1106 at its illustrated location in FIG. 17Q-1, the first user interface 1106 is at a predetermined that location in the first three-dimensional environment 1103 of the first user 1101a that is based on a spatial arrangement between a viewpoint of the first user 1101a and a location of the second user 1101b (e.g., without being based on a location of the third user 1101c) optionally because the communication session solely includes the first user 1101a and the second user 1101b. Continuing with this example, when the first user interface 1106 is further shared with the third user 1101c after being shared between just the first user 1101a and the second user 1101b, the first computer system 101a moves the first user interface 1106 to a predetermined location in the first three-dimensional environment 1103 that is based on a spatial arrangement between a viewpoint of the first user 1101a, a location of the second user 1101b, and a location of the third user 1101c, as shown from FIG. 17Q-1 to FIG. 17Q-2, optionally because the communication session now includes the first user 1101a, the second user 1101b, and the third user 1101c.

FIG. 17R illustrates the third computer system 101c displaying the first user interface 1106 in the third three-dimensional environment 1509, according to some embodiments. In some embodiments, the first user interface 1106 is displayed with spatial truth between the first three-dimensional environment 1103, the second three-dimensional environment 1107, and the third three-dimensional environment 1509, as shown with the pose (e.g., position and/or orientation) of the first user interface 1106 in the respective overhead views in FIGS. 17P-2, 17Q-2, and 17R.

In some embodiments, in a communication session, were a current sharer of content in the communication session to request to add an additional user to the communication session, their computer system would optionally initiate a process to provide user input for selecting content to share with the additional user, such as shown and described with reference to FIGS. 17S through 17V. FIGS. 17S through 17V generally illustrate the first computer system 101a detecting and responding to the first user 1101a in a communication session between the first user 1101a and the second user 1101b requesting to add the third user 1101c to the communication session while a user interface is already being shared in the communication session from the first user 1101a, according to some embodiments.

In some embodiments, while the first user interface 1106 is being shared between the first user 1101a and the second user 110b, and while the communication session between the first user 1101a and the second user 1101b is active, the first computer system 101a detects that a third user 1101c is in the viewport of the first computer system 101a and, further, detects that attention (e.g., gaze) of the first user 1101a is directed to the third user 1101c, such as described above with reference to the second computer system 101b detecting that the third user 1101c is in the viewport of the second computer system 101b and that attention (e.g., gaze) of the second user 1101b is directed to the third user 1101c in FIG. 17M. In response, the first computer system 101a displays the user interface element 1714 for initiating a process to share content with the third user 1101c, as shown in FIG. 17S.

The user interface element 1714 of FIG. 17S optionally includes one or more features of the user interface element 1714 of FIG. 17C but is relative to the third user 1101c instead of being relative to the second user 1101b and/or includes one or more features of the user interface element 1714 of FIG. 17N. Further, in some embodiments, display of the user interface element 1714 in FIG. 17S is in accordance with one or more features described with reference to criteria that may be satisfied for the first computer system 101a to display the user interface element 1114 of method 1200, but is relative to the first user 1101a and the third user 1101c (e.g., the first computer system 101a and the third computer system 101c) instead of being relative to the first user 1101a and the second user 1101b (e.g., the first computer system 101a and the second computer system 101b).

The user interface element 1714 of FIG. 17S is optionally selectable to display a sharing user interface for selecting content to share with the third user 1101c (e.g., with the third computer system 101c), such as shown from FIG. 17S to FIG. 17T to FIG. 17U. While displaying the illustrated view of the first three-dimensional environment 1103 of FIG. 17S, the first computer system 101a detects selection of the user interface element 1714, as shown in FIG. 17T. For example, in FIG. 17T, the first computer system 101a optionally detects input from the hand 1116 of the first user 1101a (e.g., detects the hand 1116 of the first user 1101a performing an air pinch gesture) while attention (e.g., gaze) of the first user 1101a is directed to the user interface element 1714, as indicated by gaze point 1710f. In response, the first computer system 101a ceases display of user interface element 1714 and displays the sharing user interface 1716, as shown in FIG. 17U. The sharing user interface 1716 of FIG. 17U optionally includes one or more features described with reference to the sharing user interface 1716 of FIG. 17F.

In FIG. 17U, the first computer system 101a detects selection of the second selectable option 1716b of the sharing user interface 1716, and the second selectable option 1716b corresponds to the first user interface 1106. For example, in FIG. 17U, the first computer system 101a optionally detects input from the hand 1116 of the first user 1101a (e.g., detects the hand 1116 of the first user 1101a performing an air pinch gesture) while attention (e.g., gaze) of the first user 1101a is directed to the second selectable option 1716b, as indicated by gaze point 1710g. In response, the first computer system 101a initiates a process for sharing the content of the photos application (e.g., the first user interface 1106) with the third computer system 101c. FIG. 17V illustrates the first computer system 101a displaying the pill 1106a indicating that the first user interface 1106 is now being shared with the second user 1101b and the third user 1101c.

In some embodiments, while a user is sharing content in a communication session, a different user in the communication session requests to share content in the communication session. FIGS. 17W through 17Z generally illustrate user interfaces and processes performed by one or more computer systems in response to detecting that another user request to share content in a communication session while other content from another user is already being shared in the communication session, according to some embodiments.

In FIG. 17W, the first computer system 101a (e.g., the first user 1101a) is sharing the first user interface 1106 in the communication session that is between the first user 1101a, the second user 1101b, and the third user 1101c. While the first user 1101a is sharing the first user interface 1106 in the communication session in FIG. 17W, the first computer system 101a detects an indication that the third user 1101c request to share a user interface (e.g., an application window) in the communication session, such as shown with indication 1722 in FIG. 17W. In response, the first computer system 101a ceases sharing the first user interface 1106 in the communication session, and displays the user interface that the third user 1101c requested to share, such as shown in FIG. 17X. The user interface (e.g., application window) that the third user 1101c requested to share in the communication session, as shown with the indication 1722 in FIG. 17W, is a user interface of an email application (e.g., an email application window), so the first computer system 101a displays the user interface 1724 of the email application (e.g., the email application window), as shown in FIG. 17X.

In some embodiments, the first computer system 101a ceases displaying the first user interface 1106 in response to ceasing sharing the first user interface 1106 in the communication session. In some embodiments, the first computer system 101a maintains display of the first user interface 1106 in response to ceasing sharing the first user interface 1106 in the communication session, such as shown from FIG. 17W to FIG. 17X, and may move the first user interface 1106 backwards relative to the viewpoint of the first user 1101a. In some embodiments, the location of display of the user interface 1724 of the email application that is being shared from the third user 1101c is the same as or is near (e.g., within 0.1, 0.2, 0.5, 0.9, 1, 1.5 m, or another distance) the location of the first user interface 1106 when the first user interface 1106 was being shared in the communication session between the first user 1101a, the second user 1101b, and the third user 1101c, optionally because the location of the first user interface 1106 when it was being shared in the communication session was the ideal location for viewing and/or interacting with the first user interface 1106 between the first user 1101a, the second user 1101b, and the third user 1101c.

In some embodiments, while the second computer system 101b is displaying the first user interface 1106 that is being shared from the first user 1101a into the communication session between the first user 1101a, the second user 1101b, and the third user 1101c, the second computer system 101b detects the indication 1722 of FIG. 17W, such as described with reference to the first computer system 101a detecting the indication 1722 in FIG. 17W. In response, the second computer system 101b ceases displaying the first user interface 1106 and displays the user interface 1724 of the email application, as shown in FIG. 17W, optionally at the same location in the second three-dimensional environment 1107 that the first user interface 1106 was displayed when the first user interface 1106 was being shared in the communication session.

FIG. 17Z illustrates the third computer system 101c displaying the user interface 1724 of the email application in the third three-dimensional environment 1509. In some embodiments, while the first user interface 1106 was being shared from the first user 1101a into the communication session between the first user 1101a, the second user 1101b, and the third user 1101c, the third computer system 101c was displaying the first user interface 1106 in the third three-dimensional environment 1509. In some embodiments, the third computer system 101c detects user input from the third user 1101c requesting to share the user interface 1724 of the email application into the communication session. In response, the third computer system 101c optionally shares the user interface 1724 of the email application into the communication session and display the indication 1724a that indicates that the user interface 1724 of the email application is being shared with the first user 1101a and the second user 1101b in the communication session, such as shown in FIG. 17Z. Further details regarding the embodiments illustrated and described with reference to FIGS. FIGS. 17A-1 through 17Z are provided with reference to method 1800.

FIG. 18 is a flowchart illustrating an exemplary method 1800 for sharing a user interface with a second computer system in response to detecting movement of the user interface to a user interface element for sharing the user interface with the second computer system in accordance with some embodiments. In some embodiments, the method 1800 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, method 1800 (e.g., the method 1800 of FIG. 18) is performed at a first computer system in communication with one or more first display generation components and one or more first input devices. In some embodiments, the first computer system has one or more characteristics of the computer systems in methods 800, 1000, 1200, 1400, and/or 1600. In some embodiments, the first display generation component(s) have one or more characteristics of the display generation component(s) in methods 800, 1000, 1200, 1400, and/or 1600. In some embodiments, the one or more first input devices have one or more characteristics of the one or more input devices in methods 800, 1000, 1200, 1400, and/or 1600.

In some embodiments, (1802a) while a real-time communication session between a first user of the first computer system and a second user of a second computer system is not established (e.g., while neither a spatial or non-spatial real-time communication session is established between the first and second users of the first and second computer systems, such as the communication sessions described with reference to methods 800, 1000, 1200, 1400, and/or 1600, and while no virtual content is being shared between the first computer system and the second computer system (e.g., from the first computer system to the second computer system or from the second computer system to the first computer system)), such as the first user 1101a and the second user 1101b in FIGS. 17A-1 and 17A-2, while a first three-dimensional environment is visible via the one or more first display generation components, such as the first three-dimensional environment 1103 in FIG. 17A-1, and while a first user interface of a first application is associated with a first user interface location in the first three-dimensional environment (optionally such as described with reference to a respective user interface of a respective application being associated with the first location in the first three-dimensional environment that is visible via the one or more first display generation components in method 1200, 1400, and/or 1600 (e.g., independent of whether the first location is currently visible or not in the viewport of the first computer system)), such as the first user interface 1106 in the first three-dimensional environment 1103 in FIG. 17A-1, the first computer system detects (1802b) that one or more criteria are satisfied, including a criterion that is satisfied when a second user of the second computer system is in (e.g., is visible in) a viewport of the first computer system at a first user location in the first three-dimensional environment (e.g., detecting that the second user and/or the second computer system is visible in physical form (e.g., not an avatar of the second user) in (e.g., through) the viewport of the first computer system at the first user location in the first three-dimensional environment, because the second user is physically located at a location in the physical environment that corresponds to (e.g., is the same as) the first user location in the first three-dimensional environment), such as similarly described with reference to method 1200, such as the first computer system 101a detecting that the second user 1101b is in the viewport of the first computer system 101a in FIG. 17B. In some embodiments, while the real-time communication session between the first and second computer systems is not established, no respective user interface of a respective application (e.g., a messages user interface, maps user interface, media user interface, web browsing user interface, a game user interface, or another user interface of an application, such as a user interface of an application (e.g., a respective user interface of a respective application) described with reference to methods 800, 1000, 1200, 1400, and/or 1600) is being shared between the first computer system and the second computer system. In some embodiments, while the real-time communication session between the first and second computer systems is not established, the first computer system is optionally displaying one or more user interfaces of one or more applications at one or more locations in the first three-dimensional environment, and the user interfaces are not being shared with the second computer system. For example, the first computer system is optionally displaying a first user interface of a first application at a first location in the first three-dimensional environment, a second user interface of a second application (or of the first application) at a second location in the first three-dimensional environment, and/or a third user interface of a third application (or of the first application or of the second application) at a third location in the first three-dimensional environment. In some embodiments, even though no real-time communication session between the first and second computer systems is active, the first and second users of the first and second computer systems are optionally collocated in a physical environment, such as a physical environment described with reference to methods 800, 1000, 1200, 1400, and/or 1600), such as described with reference to the first and second computer systems being collocated in a physical environment in methods 1200, 1400, and/or 1600. In some embodiments, the one or more criteria of method 1800 are satisfied independent of whether attention (e.g., based on gaze) of the first user is directed at the second user or the second computer system.

In some embodiments, (1802a) while the real-time communication session between the first user of the first computer system and the second user of the second computer system is not established, while the first three-dimensional environment is visible via the one or more first display generation components, and while the first user interface of the first application is associated with the first user interface location in the first three-dimensional environment, in response to detecting that the one or more criteria are satisfied, the first computer system displays (1802c), via the one or more first display generation components, a first user interface element (e.g., the user interface element 1714 in FIG. 17C) in the first three-dimensional environment that is selectable to display a sharing user interface for selecting content to share with the second computer system, wherein the first user interface element is not displayed before detecting that the second user is in the viewport of the first computer system (e.g., before detecting that the one or more criteria are satisfied, such that the one or more criteria are optionally satisfied when the first computer system detects that the second user is in the viewport). In some embodiments, the first user interface element of method 1800 includes one or more features of the first user interface element of method 1200. In some embodiments, the first user interface element is specifically associated with the second user of the second computer system. For example, the first computer system may be collocated in the physical environment with the second computer system and a third computer system, but the first user interface element would be selectable to display the sharing user interface for selecting content to share with (the second user of) the second computer system, but not selectable for selecting content to share with (a third user of) the third computer system. In some embodiments, the first user interface element specifically indicates the second user, such as via textual content in the first user interface element that specifically indicates a name or username of the second user, other content such as an icon or photo of the second user, and/or by the location of the first user interface element being proximate to the second user. In some embodiments, a location of display of the first user interface element in the first three-dimensional environment is based on the location of the second user in the first three-dimensional environment (e.g., the first location in the first three-dimensional environment). For example, were the first location to be a first respective location in the first three-dimensional environment, the computer system would optionally display the first user interface element at a location that is based on the first respective location. Continuing with this example, were the first location to be a second respective location in the first three-dimensional environment that is different from the first respective location, the first computer system would optionally display the first user interface element at a location that is based on the second respective location (e.g., without being based on the first respective location). Further, the first computer system optionally displays the first user interface element having a predefined spatial relationship relative to a location of the second computer system and/or second user, such as above, below, left, and/or right of the location of the second computer system, relative to a location of the first computer system. For example, the second computer system is optionally worn on a head of the second user, and the first computer system optionally displays the first user interface element having a vertical location that is below a vertical position of the second computer system. In some embodiments, the location of the first user interface element covers a portion of a torso of the second user. In some embodiments, in response to detecting that the second user is no longer in the viewport of the first computer system, the computer system ceases display of the first user interface element. In some embodiments, were a third user in the viewport of the first computer system instead of the second user, the first computer system would display the first user interface element as selectable to display the sharing user interface with the third user. In some embodiments, were both the second user and the third user in the viewport of the first computer system, and were no communication session established between the first user and the second user and the first user and the third user, the first computer system would display different first user interface elements—one that is selectable to display a sharing user interface for selecting content to share with the second user and another that is selectable to display a sharing user interface for selecting content to share with the third user. The first three-dimensional environment is optionally as described with reference to the first three-dimensional environment of methods 800, 1200, 1400, and/or 1600.

In some embodiments, (1802a) while the real-time communication session between the first user of the first computer system and the second user of the second computer system is not established, while the first three-dimensional environment is visible via the one or more first display generation components, and while the first user interface of the first application is associated with the first user interface location in the first three-dimensional environment, while displaying the first user interface element, the first computer system detects (1802d), via the one or more first input devices, selection of the first user interface element, such as the gaze point 1710b of the first user 1101a being directed to the first user interface element 1714 in FIG. 17D. For example, the first computer system optionally detects a gaze of the first user and/or an air gesture directed to the first user interface element. Additionally or alternatively, the first computer system optionally detects a voice input, an input via a mouse, touch screen or trackpad, or another type of input described herein that is directed to the first user interface element. Additionally or alternatively, in some embodiments, the selection of the first user interface element includes one or more characteristics described with reference to selections in methods 800, 1000, 1200, 1400, and/or 1600.

In some embodiments, (1802a) while the real-time communication session between the first user of the first computer system and the second user of the second computer system is not established, while the first three-dimensional environment is visible via the one or more first display generation components, and while the first user interface of the first application is associated with the first user interface location in the first three-dimensional environment, in response to detecting the selection of the first user interface element, the first computer system displays (1802e), via the one or more first display generation components, the sharing user interface for selecting content to share with the second computer system, the sharing user interface including a plurality of selectable options selectable to share respective content (e.g., different content and/or different sets of content) with the second computer system, such as the sharing user interface 1716 in FIG. 17E or FIG. 17F. In some embodiments, in response to detecting the selection of the first user interface element, the first computer system ceases display of the first user interface element and displays the sharing user interface. In some embodiments, the respective content is content that is currently being displayed by the first computer system, such as content that is currently associated with a location in the first three-dimensional environment. In some embodiments, the plurality of selectable options indicate different content that can be shared with the second user of the second computer system. In some embodiments, the shareable content includes audio and/or visual content, such as user interfaces of applications (e.g., different user interfaces that are optionally of the same application and/or of different applications). In some embodiments, the one or more selectable options indicate the content that they are selectable to share. In some embodiments, the one or more selectable options are displayed as a scrollable list. The one or more selectable options are described in more detail below. In some embodiments, the first computer system detects selection of a respective option of the one or more selectable options that are in the sharing user interface. For example, the first computer system optionally detects a gaze of the first user and/or an air gesture directed to the respective option. Additionally or alternatively, the first computer system optionally detects a voice input, an input via a mouse, touch screen or trackpad, or another type of input described herein that is directed to the respective option. Additionally or alternatively, in some embodiments, the selection of the first user interface element includes one or more characteristics described with reference to selections in methods 800, 1000, 1200, 1400, and/or 1600. In some embodiments, in response to detecting the selection of the respective option, the first computer system initiates a process to share the respective content that the respective option indicated. In some embodiments, in response to detecting selection of a first respective option, the first computer system shares a first user interface with the second computer system, and in response to detecting selection of a second selectable option, different from the first selectable option, the first computer system shares a second user interface, different from the first user interface (e.g., without sharing the first user interface). In some embodiments, the first computer system detects and responds to selection of multiple options of the plurality of selectable options and shares multiple user interfaces accordingly. In some embodiments, in response to detecting selection of a first respective option, the first computer system initiates a communication session and shares the user interface corresponding to the first respective option. In some embodiments, in response to detecting selection of the first respective option, the first computer system shares the user interface corresponding to the first respective option without initiating the communication session. As such, in some embodiments, the first computer system displays a sharing user interface to provide a user the ability to select which content the user wants to share with a specific user before a real-time communication session is initiated. Displaying a sharing user interface that includes user-selectable options for sharing different content specifically with a second user of a second computer system in response to selection of a first user interface element that is displayed in response to detection of the second user reduces errors associated with sharing content with different users since the sharing user interface is specifically for sharing of content with the second user, reduces errors associated with unintentional sharing of content since the sharing user interface is displayed for providing the user opportunity to select which content the user intends to share, and makes sharing with collocated users more efficient since the sharing user interface is specifically for selecting content to share with a collocated user.

In some embodiments, the plurality of selectable options correspond to a plurality of different applications accessible for sharing by the first computer system, such as the second selectable option 1716b and the third selectable option 1716c in the sharing user interface 1716 in FIG. 17E. In some embodiments, the plurality of different applications include applications that are accessible for sharing, independent of whether an application is currently in used on the first computer system. For example, the plurality of different applications optionally include applications that are not currently in use on the first computer system (e.g., applications that are not associated with user interface(s) that are displayed in the first user's three-dimensional environment) and/or applications that are currently in use on the first computer system (e.g., applications that are associated with user interfaces that are displayed in the first user's three-dimensional environment). In some embodiments, were the first computer system to detect a user input selecting one of the options corresponding to one of the applications of the plurality of different applications, the first computer system would initiate a process to share with the second computer system the application that corresponds the selected option (e.g., initiate a process to cause the first and second computer systems to display user interface(s) of the application in their respective environments). In some embodiments, were the first computer system to detect a user input selecting a first option corresponding to a first application of the plurality of different applications, the first computer system would initiate a process to share with the second computer system the first application, and were the first computer system to detect a user input selecting a second option corresponding to a second application of the plurality of different applications, different from the first application, the first computer system would initiate a process to share with the second computer system the second application (e.g., instead of the first application). In some embodiments, were the first computer system to detect a user input selecting one of the options corresponding to one of the applications of the plurality of different applications, and were the application that corresponds to the selected option to not currently be in use on the first computer system (e.g., is an application that is not associated with a user interface that is displayed in the first user's three-dimensional environment), the first computer system would optionally initiate display of a user interface of the application in the first user's environment and share the user interface with the second computer system (e.g., optionally at a location on the first user's three-dimensional environment that is ideal for viewing and/or interacting between a position of the viewpoint of the first computer system and the position of the second user), such as described with reference to sharing of virtual content (e.g., a respective user interface) in methods 800, 1000, 1200, 1400, and/or 1600. In some embodiments, were the first computer system to detect a user input selecting an application of the plurality of different applications that is currently in use on the first computer system (e.g., is an application that is associated with a user interface that is displayed in the first user's three-dimensional environment), the first computer system would share the user interface with the second computer system, such as described with reference to sharing of a virtual content (e.g., a respective user interface) in methods 800, 1000, 1200, 1400, and/or 1600. Displaying in the sharing user interface a plurality of selectable options corresponding to different applications accessible for sharing by the first computer system permits user selection of which application the first user wants to share with the second computer system, reduces errors associated with attempting to share content that might not be shareable since the plurality of different applications that are indicated in the sharing user interface are applications that are accessible for sharing, and makes sharing collocated users more efficient since the sharing user interface is specifically for selecting content to share with a collocated user.

In some embodiments, the plurality of selectable options correspond to a plurality of different user interfaces of one or more applications that are currently open (e.g., that are associated with location(s) in the first three-dimensional environment of the first user) on the first computer system, including the first user interface of the first application, such as the second selectable option 1716b and the fourth selectable option 1716d in the sharing user interface 1716 in FIG. 17F. In some embodiments, were the first computer system to detect a user input selecting a first option corresponding to a first user interface of the plurality of different user interfaces, the first computer system would initiate a process to share with the second computer system the first user interface, and were the first computer system to detect a user input selecting a second option corresponding to a second user interface of the plurality of different user interfaces, different from the first user interface, the first computer system would initiate a process to share with the second computer system the second user interface (e.g., instead of the first user interface). In some embodiments, the plurality of different user interfaces are of the same application or are of different applications. In some embodiments, the plurality of different user interfaces are user interfaces of applications that are currently open on the first computer system and are accessible for sharing from the first computer system. In some embodiments, the plurality of different user interfaces are associated with locations in the first three-dimensional environment. In some embodiments, a number of selectable options of the plurality of user interfaces is based on a number of user interfaces that are currently in the first user's three-dimensional environment (e.g., the first three-dimensional environment). In some embodiments, were the number of user interfaces associated with locations in the first three-dimensional environment to be a first number, the plurality of selectable options would include a first amount of selectable options, and were the number of user interfaces associated with locations in the first three-dimensional environment to be a second number that is different from the first number, the plurality of selectable options would include a second amount of selectable options that is different from the first amount. In some embodiments, an order of the selectable options is based on how recently the first user interacted with the user interface of the respective selectable option, where the most recently used user interface being closer to the top of the list of selectable options and the least recently used user interface being closer to the bottom of the list. Displaying in the sharing user interface a plurality of selectable options corresponding to different user interfaces that are in the first user's three-dimensional environment reduces computer processing involved with determining which content to present to the first user as options for sharing with the second user since the presented options correspond to just the user interfaces that are currently in the first user's three-dimensional environment, and makes sharing collocated users more efficient since the sharing user interface is specifically for selecting content to share with a collocated user.

In some embodiments, the plurality of selectable options includes a first selectable option that is selectable to share all user interfaces of applications that are currently open (e.g., that are associated with location(s) in the first three-dimensional environment of the first user and are accessible for sharing from the first computer system) on the first computer system, such as the first selectable option 1716a in FIG. 17E or FIG. 17F, and a second selectable option that is selectable to share less than all user interfaces of applications that are currently open (e.g., that are associated with location(s) in the first three-dimensional environment and are accessible for sharing from the first computer system) on the first computer system, the second selectable option 1716b in FIG. 17F. In some embodiments, the first selectable option is selectable to share multiple (e.g., more than one or all) user interfaces of application(s) that are currently open on the first computer system. In some embodiments, the second selectable option is selectable to share a single user interface of an application. In some embodiments, the first computer system displays the first selectable option at a top of the listing of the plurality of user interfaces for sharing with the second computer system in the sharing user interface. As such, in some embodiments, the plurality of selectable options includes a respective option that is selectable to share all user interfaces that are currently in the first user's three-dimensional environment, thus reducing an amount of inputs used for sharing all user interfaces. Displaying in the sharing user interface a first option for sharing all user interfaces of applications that are open in the first user's three-dimensional environment and a second option for sharing less than all user interfaces that are open in the first user's three-dimensional environment reduces an amount of inputs involved with sharing multiple user interfaces and makes sharing collocated users more efficient since the sharing user interface is specifically for selecting content to share with a collocated user.

In some embodiments, while displaying the sharing user interface, the first computer system detects, via the one or more first input devices, selection of a first selectable option of the plurality of selectable options in the sharing user interface, such as the gaze point 1710c of the first user 1101a being directed to the second selectable option 1716b in FIG. 17G. For example, the first computer system optionally detects a gaze of the first user and/or an air gesture directed to the first selectable option. Additionally or alternatively, the first computer system optionally detects a voice input, an input via a mouse, touch screen or trackpad, or another type of input described herein that is directed to the first selectable option. Additionally or alternatively, in some embodiments, the selection of the first selectable option includes one or more characteristics described with reference to selections in methods 800, 1000, 1200, 1400, and/or 1600.

In some embodiments, in response to detecting the selection of the first selectable option of the plurality of selectable options of the sharing user interface, the first computer system shares (e.g., initiates a process to share) a respective user interface of a respective application that corresponds to the first selectable option with the second computer system, including causing the respective user interface of the respective application to be concurrently associated with a first respective user interface location in the first three-dimensional environment of the first computer system and associated with a location in a second three-dimensional environment that is visible via one or more second display generation components of the second computer system, the location in the second three-dimensional environment corresponding to the first respective user interface location in the first three-dimensional environment, such as shown by the first user interface 1106 being in the first three-dimensional environment 1103 in FIG. 17K and the first user interface 1106 being in the second three-dimensional environment 1107 in FIG. 17L. In some embodiments, the respective user interface that corresponds to the first selectable option is the first user interface described in step(s) 1802. In some embodiments, the respective user interface is different from the first user interface. In some embodiments, sharing the respective user interface of the respective application includes one or more features described with reference to sharing the respective user interface of the respective application in methods 1200, 1400, and/or 1600 (e.g., causing the respective user interface of the respective application to be concurrently associated with a first respective user interface location in the first three-dimensional environment of the first computer system and associated with a location in a second three-dimensional environment that is visible via one or more second display generation components of the second computer system, the location in the second three-dimensional environment corresponding to the first respective user interface location in the first three-dimensional environment is optionally as described with reference to sharing the respective user interface of the respective application including causing the respective user interface of the respective application to be concurrently associated with the first location in the first three-dimensional environment and associated with a location in a second three-dimensional environment that is visible via one or more second display generation components of the second computer system, the location in the second three-dimensional environment corresponding to the first location in the first three-dimensional environment in methods 1200, 1400, and/or 1600). As such, in some embodiments, the first computer system shares a user interface with the second computer system in response to detecting selection of an option of the plurality of selectable options of the sharing user interface. Sharing a user interface with the second computer system in response to detecting selection of the option of the plurality of selectable options of the sharing user interface that corresponds to the user interface reduces errors associated with improper sharing of user interfaces since the shared user interface is the user interface that corresponds to the selected option.

In some embodiments, while displaying the sharing user interface, the first computer system detects, via the one or more first input devices, selection of a first selectable option of the one or more selectable options of the sharing user interface, and the first selectable option is selectable to share the first user interface of the first application with the second computer system, such as the gaze point 1710c of the first user 1101a being directed to the second selectable option 1716b, which is selectable to share the first user interface 1106 in FIG. 17G. For example, the first computer system optionally detects a gaze of the first user and/or an air gesture directed to the first selectable option. Additionally or alternatively, the first computer system optionally detects a voice input, an input via a mouse, touch screen or trackpad, or another type of input described herein that is directed to the first selectable option. Additionally or alternatively, in some embodiments, the selection of the first selectable option includes one or more characteristics described with reference to selections in methods 800, 1000, 1200, 1400, and/or 1600.

In some embodiments, in response to detecting the selection of the first selectable option of the plurality of selectable options of the sharing user interface (and/or optionally, in response to detecting an indication that the second user accepts the request of the first user to share the first user interface), the first computer system moves (e.g., automatically moving (e.g., without input for moving being detected) and/or optionally visually animating movement of) the first user interface of the first application from the first user interface location in the first three-dimensional environment to a second user interface location in the first three-dimensional environment that is different from the first user interface location in the first three-dimensional environment, wherein the second user interface location is based on a spatial arrangement between a viewpoint of the first user of the first computer system and a location of the second user of the second computer system (e.g., a spatial arrangement such as described with reference to method 1600), such as the moving of the first user interface 1106 from its illustrated location in the first three-dimensional environment 1103 in FIG. 17J to its illustrated location in the first three-dimensional environment 1103 in FIG. 17K, based on the spatial arrangement between the first user 1101a and the second user 1101b in the physical environment 1105. In some embodiments, in response to detecting the selection of the first selectable option of the plurality of selectable options of the sharing user interface, the first computer system shares the first user interface of the first application with the second computer system, including causing the first user interface of the first application to be concurrently associated with the second user interface location in the first three-dimensional environment of the first computer system and associated with a location in a second three-dimensional environment that is visible via one or more second display generation components of the second computer system, the location in the second three-dimensional environment corresponding to the second user interface location in the first three-dimensional environment, such as shown by the first user interface 1106 being in the first three-dimensional environment 1103 in FIG. 17K and the first user interface 1106 being in the second three-dimensional environment 1107 in FIG. 17L. In some embodiments, sharing the first user interface includes one or more features described with reference to sharing the respective user interface of the respective application in methods 1200, 1400, and/or 1600 (e.g., causing the first user interface of the first application to be concurrently associated with the second user interface location in the first three-dimensional environment of the first computer system and associated with a location in a second three-dimensional environment that is visible via one or more second display generation components of the second computer system, the location in the second three-dimensional environment corresponding to the second user interface location in the first three-dimensional environment is optionally as described with reference to sharing the respective user interface of the respective application including causing the respective user interface of the respective application to be concurrently associated with the first location in the first three-dimensional environment and associated with a location in a second three-dimensional environment that is visible via one or more second display generation components of the second computer system, the location in the second three-dimensional environment corresponding to the first location in the first three-dimensional environment in methods 1200, 1400, and/or 1600). In some embodiments, in response to detection the selection, the first computer system moves the first user interface to the second user interface location in the first three-dimensional environment and causes the second computer system to display the first user interface in the second three-dimensional environment at the location (e.g., without showing movement of the first user interface from a different location to the location in the second three-dimensional environment). In some embodiments, the movement of the first user interface is to a location in the first three-dimensional environment that is an ideal location for viewing and/or interacting for the first and second users, based on the spatial arrangement between the first and second users when selection of the first selectable option is detected (e.g., the second user interface location is optionally the ideal location). In some embodiments, the movement is to a location that is in the viewports of the first and second computer systems when selection of the first selectable option is detected (e.g., the second user interface location optionally corresponds to a location that is in the viewports of the first and second computer systems when selection of the first selectable option is detected). As such, in some embodiments, the first computer system moves the user interface that is to be shared with the second computer system in response to detecting selection of the option of the plurality of selectable options that corresponds to the user interface. In some embodiments, were a second user interface selected instead of the first user interface, the first computer system would move the second user interface to the second user interface location (e.g., instead of moving the first user interface to the second user interface location). In some embodiments, the second user interface location in the first three-dimensional environment is different for different user interfaces. For example, in some embodiments, the second user interface location in the first three-dimensional environment is optionally different for different shared user interfaces having different sizes. In some embodiments, for user interfaces having the same size, the first computer system moves the user interface to the same optimal location (e.g., the second user interface location is optionally the same location in the first three-dimensional environment for user interfaces having the same size). Moving a user interface in a first three-dimensional environment based on a spatial arrangement between the first and second users in response to detection selection of an option for sharing the user interface with another computer system bases the ending location of the user interface on the spatial arrangement between the first and second users, indicates that the user interface is being shared between the first and second users, and reduces errors associated with sharing user interfaces.

In some embodiments, in response to detecting the selection of the first selectable option of the plurality of selectable options of the sharing user interface, in accordance with a determination that the spatial arrangement between the viewpoint of the first user of the first computer system and the location of the second user of the second computer system is a first spatial arrangement (e.g., a first relative positioning such as a relative positioning described with reference to method 1600), such the spatial arrangement between the first user 1101a and the second user 1101b in the physical environment 1105 in FIG. 17G the second user interface location is a first respective location in the first three-dimensional environment, such as the illustrated location in the first three-dimensional environment 1103 in FIG. 17K, and the location in the second three-dimensional environment that corresponds to the second user interface location in the first three-dimensional environment is a first particular location in the second three-dimensional environment, such as the illustrated location in the second three-dimensional environment 1107 in FIG. 17L. In some embodiments, in accordance with a determination that the spatial arrangement between the viewpoint of the first user of the first computer system and the location of the second user of the second computer system is a second spatial arrangement (e.g., a second relative positioning such as a relative positioning described with reference to method 1600) that is different from the first spatial arrangement, such the spatial arrangement between the first user 1101a and the second user 1101b being different from the illustrated spatial arrangement between the first user 1101a and the second user 1101b in the physical environment 1105 in FIG. 17G, the second user interface location is a second respective location in the first three-dimensional environment that is different from the first respective location in the first three-dimensional environment, such as being different from the illustrated location of the first user interface 1106 in the first three-dimensional environment 1103 in FIG. 17K, and the location in the second three-dimensional environment that corresponds to the second user interface location in the first three-dimensional environment is a second particular location in the second three-dimensional environment that is different from the first particular location in the second three-dimensional environment, such as being different from the illustrated location of the first user interface 1106 in the second three-dimensional environment 1107 in FIG. 17L. In some embodiments, a placement of the first user interface (e.g., of a respective user interface) when shared is based on the spatial arrangement between the first and second users. As such, the first computer system optionally causes the location of the first user interface in the three-dimensional environments of the users to be different should the spatial arrangements between the first and second users to be different. As such, in some embodiments, different spatial arrangements between the first and second users when the selection of the option of the sharing user interface is detected are associated (e.g., would result in) different placements of user interfaces in the three-dimensional environments. Moving the user interface to different locations should the spatial arrangement between the first and second users be different corresponds the ending location of the first user interface on the spatial arrangement, indicates that the first user interface is being shared between the first and second users, and reduces errors associated with sharing user interfaces between the first and second users.

In some embodiments, while the real-time communication session between the first user of the first computer system and the second user of the second computer system is established, including while first content including a respective user interface of a respective application (e.g., the first user interface in step(s) 1802 and/or another user interface) is being shared between the first computer system and the second computer system (e.g., such as the sharing of a respective user interface described with reference to methods 1200, 1400, and/or 1600, optionally in response to a selection of a first selectable option of the plurality of selectable options of the sharing user interface), such as the first user interface 1106 in FIG. 17N, while a third user of a third computer system is not in a real-time communication session with the first user of the first computer system and is not in a real-time communication session with the second user of the second computer system (e.g., the first content is not being shared between the first computer system, the second computer system, and the third computer system, but is being shared between the first and second computer systems), such as the third user 1101c in FIG. 17N, and the respective user interface of the respective application is associated with a first respective user interface location in the first three-dimensional environment, such as the illustrated location of the first user interface 1106 in FIG. 17N, the first computer system detects an event, such as the first computer system detecting selection the user interface element 1714 in FIG. 170. In some embodiments, detecting the event includes detection that one or more second criteria are satisfied, including a second criterion that is satisfied when the third user of the third computer system is in (e.g., is visible in) the viewport of the first computer system at a second user location in the first three-dimensional environment. In some embodiments, the third user is collocated with the first and/or second users in the physical environment.

In some embodiments, in response to detecting the event, the first computer system updates the real-time communication session between the first user of the first computer system and the second user of the second computer system to be a real-time communication session between the first user of the first computer system, the second user of the second computer system, and the third user of the third computer system, such as shown with the pill 1106a updating from showing that the first user interface 1106 of the communication session is being shared with the first user 1101a in FIG. 170 to showing that the first user interface 1106 of the communication session is being shared with the first user 1101a and the third user 1101c in FIG. 17P-2. In some embodiments, the real-time communication session between the first user of the first computer system, the second user of the second computer system, and the third user of the third computer system has one or more features of the communication sessions described with reference to methods 800, 1000, 1200, 1400, 1600, 2000, 2200. As such, in some embodiments, the first computer system creates a communication session that includes the first, second, and third users in response to detecting an event while a communication session that includes the first and second users, without including the third user, is active. Initiating a communication session that includes the first, second, and third user in response to detecting an event while a communication session that includes just the first and second users is active allows for upgrading of the communication session that includes just the first and second users to further include the third user, and reduces errors associated with including users in communication sessions.

In some embodiments, updating the real-time communication session between the first user of the first computer system and the second user of the second computer system to be the real-time communication session between the first user of the first computer system, the second user of the second computer system, and the third user of the third computer system includes moving (e.g., automatically moving (e.g., without input for moving being detected) and/or optionally visually animating movement of) the respective user interface of the respective application from the first respective user interface location in the first three-dimensional environment to a second respective user interface location in the first three-dimensional environment that is different from the first respective user interface location in the first three-dimensional environment, such as the moving of the first user interface 1106 from its illustrated location in the first three-dimensional environment 1103 in FIG. 17S to its illustrated location in the first three-dimensional environment 1103 in FIG. 17V, based on the spatial arrangement between the first user 1101a and the second user 1101b in the physical environment 1105, and the second respective user interface location is based on a spatial arrangement (e.g., a relative positioning in an environment (e.g., the physical environment in which the first, second, and third users are optionally collocated) between a viewpoint of the first user of the first computer system, a second user location of the second user of the second computer system, and a third user location of the third user of the third computer system, such as the illustrated location in the first three-dimensional environment 1103 in FIG. 17V to which the first user interfaced 1106 is moved being based on the spatial arrangement between the first user 1101a, the second user 1101b, and the third user 1101c in the physical environment 1105. In some embodiments, the first computer system displays the respective user interface at the first respective user interface location in the first three-dimensional environment based on the spatial arrangement between the first and second user (e.g., independent of the third user), optionally because the first and second users are collocated in the physical environment and are in a real-time communication session. In some embodiments, the first computer system changes the location of display of the respective user interface in response to the third user joining the communication session. In some embodiments, the second computer system displays the respective user interface at a location in the second three-dimensional environment that corresponds to a location of display of the respective user interface at a location in the first three-dimensional environment, and the second computer system moves the respective user interface in the second three-dimensional environment to another location in response to the joining of the third user to the communication session. In some embodiments, the location to which the user interface is moved in the three-dimensional environment of the first user and the three-dimensional environment of the second user is a computer-determined ideal location for viewing and/or interacting with the user interface between the first user, the second user, and the third user, such as described above with reference to the second user interface location in the first three-dimensional environment. In some embodiments, were the spatial arrangement between the first user, the second user, and the third user to be a first spatial arrangement, the second respective user interface location in the first three-dimensional environment would be a first location, and were the spatial arrangement between the first user, the second user, and the third user to be a second spatial arrangement that is different from the first spatial arrangement, the second respective user interface location in the first three-dimensional environment would be a second location in the first three-dimensional environment that is different from the first three-dimensional environment. Moving a shared user interface to a location that is based on the spatial arrangement between the first, second, and third users corresponds the ending location of the shared user interface on the spatial arrangement between the first, second, and third users, indicates that the shared user interface is now being shared between the first, second, and third users and not just the first and second users, and reduces errors associated with sharing user interfaces between the first, second, and third users.

In some embodiments, detecting the event includes detecting that the first computer system or the second computer system first detected selection of a third user interface element that is selectable to initiate a process to cause the real-time communication session between the first user of the first computer system and the second user of the second computer system to update to be the real-time communication session between the first user of the first computer system, the second user of the second computer system, and the third user of the third computer system. For example, the first computer system first detecting selection of the third user interface element is shown with the first computer system 101a detecting user input from the first user 1101a directed at the user interface element 1714 in FIG. 17T and the second computer system first detecting selection of the third user interface element is shown with the second computer system 101b detecting user input from the second user 1101b directed at the user interface element 1714 in FIG. 170. In some embodiments, the first computer system displays the third user interface element. In some embodiments, the second computer system displays the third user interface element. In some embodiments, a location of display of the third user interface element is as described with reference to a location of display of the first user interface element of step(s) 1802 and/or the first user interface element of method 1200 in the first three-dimensional environment. In some embodiments, the third user interface element includes one or more features of the first user interface element of method 1200 and/or the first user interface element of method 1800. In some embodiments, detecting the event includes detecting that selection of the third user interface element was made from user input from the first user of the first computer system (e.g., in which case the first computer system first detected selection of the third user interface element). In some embodiments, detecting the event includes detecting that selection of the third user interface element was made from user input from the second user of the second computer system (e.g., in which case the second computer system first detected selection of the third user interface element). Displaying a user interface element that is selectable to initiate a process to add a third user to a communication session that just includes the first and second users provides a way to add users to an active communication session, and reduces errors associated with adding different users to the communication session since the user interface element is selectable to start the process for adding the third user specifically.

In some embodiments, the first content is being shared from the first computer system to the second computer system. In some embodiments, in accordance with a determination that the first computer system first detected selection of the third user interface element (e.g., selection of the third user interface element was made from user input from the first user of the first computer system), the process that the third user interface element is selectable to initiate includes displaying, via the one or more first display generation components, a second sharing user interface for selecting content to share with the third computer system, such as the sharing user interface 1716 in FIG. 17U. In some embodiments, the second sharing user interface includes one or more features described with reference to the sharing user interface of step(s) 1802, but relative to sharing with the third computer system. In some embodiments, in accordance with a determination that the second computer system first detected selection of the third user interface element (e.g., selection of the third user interface element was made from user input from the second user of the second computer system (e.g., and not from user input from the first user)), the process that the third user interface element is selectable to initiate includes sharing the first content with the third computer system, without displaying a sharing user interface at the second computer system for selecting content to share with the third computer system, such as the sharing of the first user interface 1106 without display of a sharing user interface as shown from FIG. 170 to FIG. 17P-1 to FIG. 17P-2. As such, the process that the third user interface element is selectable to initiate is different based on which user in the communication session made the selection from the third user interface element. Were the user that is associated with the computer system that initiates sharing of the first content to have made the selection of the third user interface element, the process that the third user interface element is selectable to initiate includes displaying the second sharing user interface, and were the user that is associated with the computer system that is sharing the first content to have made the selection of the third user interface element, the process that the third user interface element is selectable to initiate includes sharing the first content with the third user without displaying a sharing user interface (e.g., such as described with reference to sharing the respective user interface of the respective application with the second computer system in response to detecting selection of the first user interface element in method 1200). Performing different processes related to adding a third user to a communication session that just includes the first and second user based on which user in the communication session selects a user interface element for adding the third user reduces errors associated with updating the communication session to include the third user.

In some embodiments, while the real-time communication session between the first user of the first computer system and the second user of the second computer system is established, and while the first user interface is being shared between the first user of the first computer system and the second user of the second computer system, wherein the first user interface is displayed at a first respective user interface location in the first three-dimensional environment, such as the first user interface 1106 in FIG. 17W being shared between the first user 1101a and the third user 1101c, and while a second user interface is not being shared between the first user of the first computer system and the second user of the second computer system, such as the user interface 1724 of FIG. 17X not being shared in the embodiment illustrated in FIG. 17W, the first computer system detects a request indicating that the second user of the second computer system requests to share the second user interface with the first user of the first computer system, such as the indication 1722 in FIG. 17W. In some embodiments, the request to share the second user interface includes one or more features of described with reference to sharing user interfaces (e.g., processes or steps involved in sharing of user interfaces) in methods 1200, 1400, 1600, and 1800, 2000, and/or 2200. For example, the request indicating that the second user requests to share the second user interface with the first user is optionally based on the second computer system detecting the selection of the first user interface element of method 1200, detecting the second (and first) input and that the one or more first criteria of method 1400 are met, detecting first input requesting movement of the second user interface into a sharing zone as described with reference to method 1600, detecting selection of an option corresponding to content to share with the first computer system such as described with reference to plurality of selectable options in method 1800, and/or the various manners in which requests to share user interfaces are described with reference to methods 2000 and/or 2200. In some embodiments, the first respective user interface location in the first three-dimensional environment is a location that is a computer-determined ideal location for viewing and/or interacting with the second user interface between the first and second users based on their locations. In some embodiments, the second user interface is private to the second three-dimensional environment of the second user while the second user interface is not being shared between the first and second users. In some embodiments, the second computer system detects the request via one or more second input devices of the second computer system and then transmits the request to the first computer system. As such, in some embodiments, any user in the communication session can request to share content in the communication session independent of whether the user is concurrently sharing content in the communication session.

In some embodiments, in response to detecting the request, the first computer system ceases sharing the first user interface of the first application with the second computer system, such as the ceasing of sharing of the first user interface 1106 in FIG. 17X. In some embodiments, the first computer system maintains display of the first user interface after ceasing the sharing of the first user interface with the second computer system. In some embodiments, in response to detecting the request, the first computer system displays, via the one or more first display generation components, the second user interface at a second user interface location in the first three-dimensional environment, the second user interface location in the first three-dimensional environment corresponding to a location in a second three-dimensional environment that is visible via one or more second display generation components of the second computer system, such as the display of the user interface 1724 in the first three-dimensional environment 1103 in FIG. 17X. For example, the second computer system optionally shares the first user interface, including causing the first user interface to be concurrently associated the location in the second three-dimensional environment of the second computer system and associated with the with the second user interface location in the first three-dimensional environment, the second user interface location in the first three-dimensional environment corresponding to the location, such as described with reference to sharing user interfaces in methods 1200, 1400, 1600, 1800, and/or 2000. In some embodiments, in response to the second computer system detecting the request, the second computer system moves the second user interface to a location (e.g., an ideal location for viewing and/or interacting with the second user interface between the first and second users based on their locations). In some embodiments, the second user interface location in the first three-dimensional environment is the same as or different from the first respective user interface location. For example, in response to the first computer system detecting the request, the first computer system optionally displays the second user interface at the location that the first user interface was displayed when the first user interface was being shared with the second computer system (and optionally moves the first user interface to a different location in the first three-dimensional environment). Displaying content from another user in response to detecting a request from the user to share content in the communication session allows any user in the communication session to share content in the communication session and reduces errors associated with the sharing of content in the communication session since the shared content is content that a user in the communication session specifically requests to share.

In some embodiments, displaying the first user interface element that is selectable to display the sharing user interface for selecting content to share with the second computer system includes in accordance with a determination that a position of the second user is a first user position in the first three-dimensional environment, displaying the first user interface element at a first user interface element location in the first three-dimensional environment, such as the illustrated location of the user interface element 1714 in the first three-dimensional environment 1103 in FIG. 17C, and in accordance with a determination that the position of the second user is a second user position in the first three-dimensional environment that is different from the first user position in the first three-dimensional environment, displaying the first user interface element at a second user interface element location in the first three-dimensional environment that is different from the first user interface element location in the first three-dimensional environment, such as displaying the user interface element 1714 at a location in the first three-dimensional environment 1103 that is different from the illustrated location of the user interface element 1714 in FIG. 17C provided that the position of the second user 1101b is different from the illustrated position of the second user 1101b in the first three-dimensional environment 1103 in FIG. 17C. As such, the first computer system optionally displays the first user interface element at a location that is based on the position of the second use in the first three-dimensional environment, such as described with reference to the first computer system displaying the first user interface element of method 1200. Displaying a user interface element that is selectable to display the sharing user interface for selecting content to share with the second computer system at a location that is based on a position of the second user corresponds the location of the user interface element to a location of the second user, who is the user to which sharing of content is intended and reduces errors associated with sharing content with different users.

In some embodiments, the one or more criteria includes a second criterion that is satisfied based on attention (e.g., gaze) of the first user of the first computer system. For example, the second criterion is optionally satisfied when attention of the first user is detected via the first input devices of the first computer system and/or when the attention of the first user is directed to specific object(s) in the viewport of the first computer system. In some embodiments, the second criterion is satisfied based on one or more characteristics of the attention of the first user (e.g., one or more of direction, location, duration, and/or movement of the attention of the user). Displaying the first user interface element based on attention of the first user corresponds display of the first user interface element to the attention of the first user and reduces errors associated with displaying the first user interface element in the first three-dimensional environment.

In some embodiments, the second criterion is satisfied when the attention of the first user of the first computer system is directed to the second user of the second computer system (e.g., directed to a portion of the physical body or person of the second user, such as described with reference to method 1400), such as the gaze point 1710a of the first user 1101a being directed to the second user 1101b in FIG. 17B. In some embodiments, were the attention of the first user not directed to the second user, the second criterion would not be satisfied, and the first computer system would not display the first user interface element. Displaying the first user interface element when the attention of the first user is directed to the second user indicates that the first user interface element is specifically for performance of operations that are relative to the second user and reduces errors associated with performing operations relative to different users.

In some embodiments, the second criterion is satisfied when the attention of the first user of the first computer system is directed to the second user of the second computer system for longer than a threshold period of time (e.g., 0.3 0.5, 1, 2, 3, or another threshold period of time), such as the gaze point 1710a of the first user 1101a being directed to the second user 1101b for longer than the threshold period of time in FIG. 17B. In some embodiments, were the attention of the first user not directed to the second user for at least the threshold period of time, the second criterion would not be satisfied and the first computer system would not display the first user interface element. Displaying the first user interface element when the attention of the first user is directed to the second user for longer than a threshold period of time provides a confirming period of the first computer system determining that the first user intends to interact with the second user, including intention to initiate sharing of content with the second user specifically, and reduces errors associated with performing operations relative to different users.

In some embodiments, the second criterion is satisfied when the attention of the first user of the first computer system is directed to the second user of the second computer system, such as the gaze point 1710a of the first user 1101a being directed to the second user 1101b in FIG. 17B, and second attention of the second user of the second computer system is directed to the first user of the first computer system (e.g., directed to a portion of the physical body or person of the first user, such as described with reference to attention of the first user being directed to the second user in method 1400), such as a gaze point of the second user 1101b being directed to the first user 1101a in FIG. 17B. In some embodiments, were the attention of the first user not directed to the second user and were the attention of the second user not directed to the first user (e.g., at the same time), the second criterion would not be satisfied and the first computer system would not display the first user interface element. Displaying the first user interface element when both the attention of the first user is directed to the second user and the attention of the second user is directed to the first user allows the first computer system to determine that the first and second users intend to interact with each other, including determining intention to share content, and reduces errors associated with performing operations relative to different users.

In some embodiments, while displaying the first user interface of the first application, the first computer system detects, via the one or more first input devices, a movement input requesting movement of the first user interface. For example, the first computer system optionally detects attention (e.g., gaze) of the first user and/or an air gesture (e.g., an air pinch) that requests movement of the first user interface. Additionally or alternatively, in some embodiments, the first computer system detects a voice input, an input via a mouse, touch screen or trackpad, or another type of input described herein that requests movement of the first user interface. In some embodiments, detecting the movement input includes one or more characteristics described with reference to detecting inputs (e.g., inputs requesting movement of virtual content) and/or selections in methods 800, 1000, 1200, 1400, and/or 1600. For example, while displaying the first user interface 1106 in FIG. 17A-1, the first computer system optionally detects a selection input selecting the first user interface 1106, where the selection input includes a movement component optionally including movement of the hand 1116 of the first user 1101a while the index finger and thumb of the hand 1116 of the first user 1101a are in contact with each other as part of an air pinch gesture.

In some embodiments, in response to detecting the movement input, in accordance with a determination that the movement input is detected while the first user interface is being shared with the second computer system, the first computer system moves the first user interface in a first manner in accordance with the movement input (e.g., moving in the requested direction by the requested amount of movement (e.g., moving in a direction/magnitude corresponding to the direction/magnitude associated with the movement input) in the first manner). For example, provided that the movement input is detected while the first user interface 1106 is being shared, such as being shared with the second user 1101b in FIG. 17K, the first computer system would optionally move the first user interface 1106 in the first manner. Moving the first user interface in the first manner is optionally as described with reference to moving the respective user interface in the first manner in method 1600. For example, movement of the first user interface in the first manner optionally does not maintain a spatial arrangement between the first user interface and the viewpoint of the first user. For example, the movement of the first user interface in the first manner is optionally as if the first user interface is rotating about an axis that is offset from a location of the viewpoint of the first user in the first three-dimensional environment and that is in between a location of the first user of the first computer system (e.g., the viewpoint of the first user (e.g., the viewpoint of the first computer system)) and a location of the second user of the second computer system. For example, how the first user interface moves in the first manner is optionally based on a location of the first user (e.g., the viewpoint of the first user) and on a location of the second user of the second computer system in the physical environment, optionally such that the movement of the first user interface attempts to maintain the first and second users being able to view the first user interface at an ideal viewing angle (e.g., 5, 10, 15, 20, 30 degree, or another viewing angle between a normal of the first user interface and the viewpoint of the respective user (e.g., the first user and/or the second user). For example, the first computer system optionally maintains perpendicularity of the first user interface to a vector extending from the center of the first user interface to a point in space (e.g., a centroid or some other location) that is different from the position of the viewpoint of the first user and that is based on the locations and/or orientations of the set of users with whom the first user interface is being shared (e.g., the first and second users) while the first user interface is moved within the three-dimensional environment of the first user. As such, the first computer system optionally changes the orientation of the first user interface in the first three-dimensional environment as the first user interface is being moved in response to the movement input. Continuing with this example, note that the point in space is optionally different for different spatial arrangements of the different users in the communication session and that the point in space is optionally not based on users that are not in the communication session.

In some embodiments, in response to detecting the movement input, in accordance with a determination that the movement input is detect while the first user interface is not being shared with the second computer system, the first computer system moves the first user interface in a second manner, different from the first manner, in accordance with the movement input (e.g., moving in the requested direction by the requested amount of movement (e.g., moving in a direction/magnitude corresponding to the direction/magnitude associated with the movement input) in the second manner). For example, provided that the movement input is detected while the first user interface 1106 is not being shared, such as the first user interface 1106 not being shared in FIG. 17A-1, the first computer system would optionally move the first user interface 1106 in the second manner. Moving the first user interface in the second manner is optionally as described with reference to moving the respective user interface in the second manner in method 1600. For example, movement of the first user interface in the second manner optionally maintains a spatial arrangement between the first user interface and the viewpoint of the first user. For example, the movement of the first user interface in the second manner is optionally as if the first user interface is rotating about an axis that is centered at a location of the viewpoint of the first user in the first three-dimensional environment. For example, the movement of the first user interface in the second manner is optionally based on a location of the first user without being based on a location of the second user. For example, the first computer system optionally maintains perpendicularity of the first user interface to the viewpoint of the first user and/or to the location of the viewpoint of the first user (e.g., independent of the locations of any other users in the first three-dimensional environment and/or in the physical environment and/or independent of other users in the communication session)) while the first user interface is moved within the three-dimensional environment of the first user. As such, the first computer system optionally changes the orientation of the first user interface in the first three-dimensional environment as the first user interface moves in response to the movement input. Moving a user interface in different manners based on whether the user interface is being shared or not indicates whether the user interface is being shared or not and reduces errors associated with operating the first computer system.

It should be understood that the particular order in which the operations in method 1800 have been described is merely exemplary and is not intended to indicate that the described order is the only order in which the operations could be performed. One of ordinary skill in the art would recognize various ways to reorder the operations described herein.

FIGS. 19A through 19O generally illustrate examples of a first computer system initiating a process to present a visual indication on a portion of a second computer system in response to detecting that certain criteria are satisfied, where the first computer system and the second computer system are collocated in a physical environment in accordance with some embodiments.

In some embodiments, the first computer system initiates the process to present the visual indication on the portion of the second computer system while a real-time communication session between the first and second users of the first and second computer systems has not been established. In some embodiments, the visual indication that is presented on the portion of the second computer system when the real-time communication session between the first and second users has not been established indicates that the first user has performed one or more steps involved in a process for initiating the real-time communication session between the first and second users. In some embodiments, the visual indication is presented with different visual appearances based on whether or not a communication session that includes the first and second users is active and/or based on which step of a process for initiating the communication session is reached. In some embodiments, the first computer system initiates the process to present the visual indication on the portion of the second computer system while the real-time communication session between the first and second users is established, and the visual indication indicates that the second user is in the real-time communication session. These and other embodiments of the disclosure are generally shown throughout FIGS. 19A through 19O, and the embodiments described with reference to FIGS. 19A through 19O are further described with reference to the method 2000.

FIG. 19A shows the first computer system 101a (e.g., an electronic device) worn by the first user 1101a of the first computer system 101a displaying, via the display generation components 120 (e.g., display generation components 1-122a and 1-122b of FIG. 1), the first three-dimensional environment 1103 from a viewpoint of the first user 1101a (e.g., first user 1101a in overhead view 1902a of the first three-dimensional environment 1103) of the first computer system 101a (e.g., facing the back wall of the physical environment 1105 in which the first computer system 101a is located). The first user interface 1106 and the second user interface 1108 are likewise in the first three-dimensional environment 1103. Further, as shown in the overhead view 1902a of FIG. 19A, the first user 1101a of the first computer system 101a is collocated with the third user 1101c of the third computer system 101c in the physical environment 1105. Overhead views 1902a through 1902q in FIGS. 19A through 19O show relative positioning of objects in the three-dimensional environment in a horizontal dimension and a depth dimension in the respective figure and the view of the three-dimensional environment shown in the display generation components 120 in the respective figure shows the relative positioning of objects in the three-dimensional environment in a vertical dimension and a horizontal dimension (and, optionally in a depth dimension).

In FIG. 19A, the first computer system displays the first user interface 1106 and the second user interface 1108. The first user interface 1106 and the second user interface 1108 are private to the first computer system 101a in FIG. 19A. That is, the first user interface 1106 and the second user interface 1108 are not being shared with the third computer system 101c (e.g., with the third user 1101c) in the illustrated figure.

In FIG. 19B, while displaying the view of the first three-dimensional environment 1103 illustrated in FIG. 19A, the first computer system 101a detects that the second user 1101b is in the viewport of the second computer system 101b, as shown in FIG. 19B. For example, in FIG. 19B, the second user 1101b is visible in the first three-dimensional environment 1103 via the display generation components 120 of the first computer system 101a (e.g. the second user 1101b is visible in the viewport of the first computer system 101a) because the second user 1101b is at a location that corresponds to a location in the first three-dimensional environment 1103 that is visible via the display generation components 120 of the first computer system 101a.

From FIG. 19B to FIG. 19C, the second user 1101b turns (e.g., rotates the head of the second user 1101b) towards the first user 1101a, such as shown with the rotation of the second user 1101b from the overhead view 1902b of FIG. 19B to the overhead view 1902c of FIG. 19C. FIG. 19D illustrates the first computer system 101a detecting that the attention (e.g., gaze) of the first user 1101a is directed to a portion of the second user 1101b. For example, in FIG. 19D, the first computer system 101a optionally displays an indication of the gaze point 1910a that indicates where the attention (e.g., gaze) of the first user 1101a is directed, and in FIG. 19D the gaze point 1910a is directed on a portion of the second user 1101b.

FIGS. 19E and 19F illustrate the first computer system 101a detecting and responding to the attention (e.g., gaze) of the first user 1101a being directed to the second computer system 101b. Specifically, in FIG. 19E, the first computer system 101a detects that the attention (e.g., gaze) of the first user 1101a is directed to the second computer system 101b, as indicated with the location of the gaze point 1910b in FIG. 19E. In response to detecting that the attention (e.g., gaze) of the first user 1101a is directed to the second computer system 101b, the first computer system 101a initiates a process to present a visual indication on a respective portion of the second computer system 101b, as shown in FIG. 19F.

FIG. 19F illustrates the first computer system 101a presenting a visual indication 1912 on a respective portion of the second computer system 101b in response to detecting that the attention (e.g., gaze) of the first user 1101a is directed to the second computer system 101b. In some embodiments, the visual indication 1912 visually alerts the first user 1101a that the first computer system 101a has detected that the first user 1101a has performed an action (e.g., directing the first user's attention to the second computer system) that is involved in a process for initiating a communication session between the first and second users. In some embodiments, the respective portion of the second computer system 101b is an attention-providing portion of the second computer system 101b. Further details regarding the respective portion are discussed with reference to method 2000.

The visual characteristics of the visual indication 1912 are described with reference to the method 2000. In some embodiments, the first computer system 101a presenting the visual indication 1912 on the respective portion of the second computer system 101b includes the first computer system 101a displaying the visual indication 1912 at the location of the respective portion of the second computer system 101b in the first three-dimensional environment 1103 of the first user 1101a (e.g., the display generation components 120 actively displays the visual indication 1912). Additionally or alternatively, in some embodiments, the first computer system 101a presenting the visual indication 1912 on the respective portion of the second computer system 101b includes the first computer system 101a causing the second computer system 101b to display the visual indication 1912 at a location on the second computer system 101b that corresponds to the respective portion; in these embodiments, the visibility of visual indication 1912 includes visibility that is via active or passive passthrough via the display generation components 120 of the first computer system 101a. In some embodiments, the first computer system 101a displays the visual indication 1912 on the respective portion of the second computer system 101b and the second computer system 101b displays the visual indication 1912 at a location on the second computer system 101b that causes the visual indication 1912 to be visible at another computer system (e.g., the first computer system 101a) different from the second computer system 101b.

Note that the first computer system optionally initiates the process to present the visual indication 1912 on a portion of the second computer system 101b provided that attention (e.g., gaze) of the first user 1101a is directed to a specific portion or region of the second computer system 101b. For instance, in some embodiments, were the attention of the first user to be directed to part 1916 (e.g., a strap or a non-attention providing portion) of the second computer system 101b in FIG. 19B, the first computer system 101a does not initiate the process to present the visual indication 1912 on a portion of the second computer system 101b (e.g., no visual indication is presented in response). Further details regarding when process to present the visual indication 1912 on a portion of the second computer system 101b is initiated (e.g., characteristics of the portion of the second computer system 101b to which the attention of the first user 1101a is to be directed in order for the first computer system 101a to initiate the process to present the visual indication 1912 on the portion of the second computer system 101b) is provided with reference to the method 2000.

FIGS. 19F through 19H generally illustrate the first computer system 101a detecting and responding to movement of the attention (e.g., gaze) of the first user 1101a on the second computer system 101b, according to some embodiments.

From FIG. 19F to FIG. 19G, the portion of the second computer system 101b to which the attention (e.g., gaze) of the first user 1101a is directed changes, as shown with the movement of the gaze point 1910c from being at its illustrated location on the second computer system 101b in FIG. 19F to being at its illustrated location on the second computer system 101b in FIG. 19G. In response to detecting that the portion of the second computer system 101b to which the attention (e.g., gaze) of the first user 1101a is directed has changed as illustrated from FIG. 19F to FIG. 19G, the first computer system 101a initiates a process move the location of the visual indication 1912 on the second computer system 101b, such as shown from FIG. 19G to FIG. 19H. That is, from FIG. 19G to FIG. 19H, the first computer system 101a initiates a process move the visual indication 1912 leftward in the viewpoint of the first user 1101a on the second computer system 101b to correspond the visual indication 1912 to where the attention (e.g., gaze) of the first user 1101a is directed on the second computer system 101b. Thus, in FIG. 19H, the visual indication 1912 is at a location on the second computer system 101b that is different from the location of the visual indication 1912 on the second computer system 101b in FIG. 19G because the portion of the second computer system 101b to which the attention (e.g., gaze) of the first user 1101a is directed changed as illustrated with the movement of the gaze point 1910c on the second computer system 101b from FIG. 19G to FIG. 19H.

FIGS. 19I through 19K-2 generally illustrate the first computer system 101a initiating (and/or continuing) a process to start a communication session between the first user 1101a and the second user 1101b, according to some embodiments.

In FIG. 19I, while displaying the illustrated view of the first three-dimensional environment 1103 of FIG. 17H, including while the visual indication 1912 is being presented on the second computer system 101b and while the attention (e.g., gaze) of the first user 1101a is directed at the second computer system 101b, the first computer system 101a detects first input from the first user 1101a, as shown in FIG. 19I. The first input from the first user 1101a optionally corresponds to a request from the first user 1101a to initiate a communication session between the first user 1101a and the second user 1101b. In FIG. 19I, the first computer system 101a optionally detects input from the hand 1116 of the first user 1101a (e.g., detects the hand 1116 of the first user 1101a performing an air pinch gesture) while the visual indication 1912 is being presented on the second computer system 101b and while the attention (e.g., gaze) of the first user 1101a is directed at the second computer system 101b, as indicated by the gaze point 1910c. In response, the first computer system 101a optionally transmits an indication to the second computer system 101b that notifies the second user 1101b that the first user 1101a requests to start a communication session between the first user 1101a and the second user 1101b. In response to detecting the indication of the request of the first user 1101a, the second computer system 101b optionally displays notification user interface element 1718, as shown in FIG. 19J. The notification user interface element 1718 in FIG. 19J optionally includes one or more features described with reference to the notification user interface element 1718 in FIG. 17H. Additionally, in response to detecting the input from the hand 1116 of the first user 1101a as described above with reference to FIG. 19I, the first computer system 101a initiates a process to present a visual animation on the second computer system 101b while the first computer system 101a is awaiting a response from the second computer system 101b regarding whether or not the second user 1101b accepts the request of the first user 1101a, as shown in FIGS. 19K-1 and 19K-2 (e.g., while the first computer system 101a is awaiting knowledge of whether the second user 1101b selects the first selectable option 1718a or the second selectable option 718b of the notification user interface element 1718 in FIG. 19J).

As described above, the first computer system 101a optionally initiates a process to present a visual animation on the second computer system 101b while the first computer system 101a is awaiting a response from the second computer system 101b regarding whether or not the second user 1101b accepts the request of the first user 1101a. In some embodiments, the visual animation includes movement of the visual indication 1912 on the second computer system 101b. For example, from FIG. 19K-1 to FIG. 19K-2, the visual indication 1912 moves along the second computer system 101b (e.g., along an attention-providing portion of the second computer system 101b). In some embodiments, the visual indication moves independent of whether attention (e.g., gaze) of the first user 1101a is directed to the visual indication 1912 and/or to the second computer system 101b. For example, from FIG. 19K-1 to FIG. 19K-2, the visual indication 1912 moves along the second computer system 101b, optionally independent of whether or where the attention (e.g., gaze) of the first user 1101a is directed. In some embodiments, the first computer system 101a causes the visual indication 1912 to move as illustrated from FIG. 19K-1 to FIG. 19K-2, and then causes the visual indication 1912 to move as illustrated from FIG. 19K-2 to FIG. 19K-1. In some embodiments, the visual animation including a repeating of the same movements of the visual indication 1912 for a threshold amount of time (e.g., 1 s, 5 s, 10 s, or another amount of time). In some embodiments, the visual indication 1912 in FIGS. 19K-1 and FIG. 19K-2 has a visual appearance that is different from the visual appearance of the visual indication 1912 in any of FIGS. 19F, 19G, and 19H. For example, the visual indication 1912 in FIGS. 19K-1 and FIG. 19K-2 optionally pulses radially, in addition to the translational movement along the second computer system 101b, while the visual indication 1912 in FIGS. 19K-1 and FIG. 19K-2 optionally does not pulse radially.

In some embodiments, the visual indication 1912 in FIGS. 19K-1 and FIG. 19K-2 is visible to the first user 1101a (e.g., via the first computer system 101a) and is not visible to another user who did not request to initiate the communication session with the second user 1101b. For example, as shown in FIGS. 19K-1 and 19K-2, the visual indication 1912 is visible to the first user 1101a, and as shown in FIG. 19K-3, the visual animation is not visible to the third user 1101c (e.g., via the third computer system 101c) even though the second computer system 101b is in the viewport of the third computer system 101c of the third user 1101c at the same time that the second computer system 101b is in the viewport of the first computer system 101a of the first user 1101a. In some embodiments, the visual animation is not visible to the third user 1101c in FIG. 19K-3 because the third user 1101c did not request to initiate a communication session with the second user 1101b. Similarly, in some embodiments, the visual indication 1912 in any of FIGS. 19F, 19G, and 19H is visible to the first user 1101a (e.g., via the first computer system 101a), but is optionally not visible to the third user 1101c optionally provided that the third user 1101c is not directing their attention (e.g., gaze) to the second computer system 101b.

In FIG. 19L, the second computer system 101b detects selection of the first selectable option 1718a that is selectable to accept the request of the first user 1101a to initiate a communication session. For example, in FIG. 19L, the second computer system 101b optionally detects input from the hand 1116a of the second user 1101b (e.g., detects the hand 1116a of the second user 1101b performing an air pinch gesture) while attention (e.g., gaze) of the second user 1101b is directed to the first selectable option 1718a, as indicated by gaze point 1910d.

In some embodiments, in response to detecting selection of the first selectable option 1718a in FIG. 19L, the second computer system 101b transmits an indication to the first computer system that notifies that the second user 1101b accepts the request of the first user 1101a to initiate a communication session. In response to detecting the indication, the first computer system 101a optionally initiates the real-time communication session between the first user 1101a and the second user 1101b.

In some embodiments, when the communication session is initiated, the first computer system 101a initiates a process to present a visual indication on the second computer system 101b that indicates that the second user 1101b is in the communication session. For example, in some embodiments, when the first computer system 101a detects the indication described above, a visual indication 1912 is being presented on the second computer system 101b, such as shown and/or described with reference to FIGS. 19K-1 and 19K-2, and then when the communication session is initiated, the first computer system 101a initiates a present to change or update the visual indication 1912, such as shown in FIG. 19M. The visual indication 1912 of FIG. 19M has an appearance that is different from the appearance of the visual indication 1912 presented of FIG. 19I, and the appearance of the visual indication 1912 in FIG. 19M optionally indicates that the second user 1101b is in the communication session with the first user 1101a.

In some embodiments, the request from the first user 1101a is a request for the second user 1101b to join a communication session that is already active between the first user 1101a and the third user 1101c. In some embodiments, in FIG. 19M, the second user 1101b is in a communication session that includes the first user 1101a and the third user 1101c. In some embodiments, the visual indication 1912 of FIG. 19M that indicates that the second user 1101b is in the communication session is also visible to the third user 1101c, such as shown in FIG. 19N, because the third user 1101c is in the communication session as well.

In some embodiments, the request from the first user 1101a is a request for the second user 1101b to join a communication session that solely includes the first user 1101a and/or is a request for the second user 1101b to start a communication session solely with the first user 1101a. In some embodiments, in FIG. 19M, the first user 1101a and the second user 1101b are in a communication session, and the third user 1101c is not in the communication session. In some embodiments, the visual indication 1912 of FIG. 19M that indicates that the second user 1101b is in the communication session is not visible to the third user 1101c, such as shown in FIG. 19O, because the third user 1101c is not in the communication session that includes the first user 1101a and the second user 1101b in the illustrated embodiment. Further details regarding the embodiments illustrated and described with reference to FIGS. 19A through 19O are provided with reference to method 2000.

FIG. 20 is a flowchart illustrating an exemplary method 2000 for initiating a process to present a visual indication on a portion of a second computer system in response to detecting that certain criteria are satisfied in accordance with some embodiments. In some embodiments, the method 2000 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2000 are, optionally, combined and/or the order of some operations is, optionally, changed.

In some embodiments, a method 2000 (e.g., the method 2000 of FIG. 20) is performed at a first computer system in communication with one or more first display generation components and one or more first input devices. In some embodiments, the first computer system has one or more characteristics of the computer systems in methods 800, 1000, 1200, 1400, 1600, and/or 1800. In some embodiments, the first display generation component(s) have one or more characteristics of the display generation component(s) in methods 800, 1000, 1200, 1400, 1600, and/or 1800. In some embodiments, the one or more first input devices have one or more characteristics of the one or more input devices in methods 800, 1000, 1200, 1400, 1600, and/or 1800.

In some embodiments, (2002a) while a real-time communication session between a first user of the first computer system and a second user of a second computer system is not established (e.g., while neither a spatial or non-spatial real-time communication session is established between the first and second users of the first and second computer systems, such as a communication session described with reference to method 1800, and while no virtual content is being shared between the first computer system and the second computer system (e.g., from the first computer system to the second computer system or from the second computer system to the first computer system, such as described with reference to method 1800), such as the first user 1101a and the second user 1101b in FIG. 19A, and while the second computer system is in (e.g., is visible in) a viewport of the first computer system (e.g., while a view of first three-dimensional environment that is currently visible via the displays of the first computer system currently includes the second computer system in the view of the first three-dimensional environment), such as the second user 1101b in FIG. 19B, the first computer system detects (2002b), via the one or more first input devices, that attention (e.g., based on gaze) of the first user of the first computer system satisfies one or more criteria, wherein the one or more criteria include a criterion that is satisfied when the attention of the first user is directed at the second computer system (optionally directed at a portion of the second computer system), such as the gaze point 1910b of the first user 1101a being directed at the second computer system 101b in FIG. 19E. In some embodiments, when the second computer system is in the viewport of the first computer system, the second user and/or the second computer system is visible in physical form (e.g., not an avatar of the second user) in (e.g., through) the viewport of the first computer system at a location in the first three-dimensional environment, because the second user is physically located at a location in the physical environment that corresponds to (e.g., is the same as) the second location in the first three-dimensional environment). Additionally or alternatively, in some embodiments, the one or more criteria include a criterion that is satisfied when attention (e.g., which is optionally based on gaze) of the first user is directed to an attention-providing portion of the second computer system. In some embodiments, the attention-providing portion of the second computer system is a part of the second computer system via which attention of the second user is directed to objects in a three-dimensional environment of the second user. In some embodiments, the attention-providing portion of the second computer system is a display generation component portion of the second computer system. In some embodiments, the attention-providing portion of the second computer system is a part of the second computer system through which the second user can view their three-dimensional environment. In some embodiments, the one or more criteria are satisfied when attention of the first user is directed to a first portion of the second computer system, but are not satisfied if the attention of the first user is directed to a second portion of the second computer system that is different from the first portion. In some embodiments, if attention of the first user is not directed to the second computer system and/or to a specific portion of the second computer system, the criteria are not satisfied.

In some embodiments, (2002a) while the real-time communication session between the first user of the first computer system and the second user of the second computer system is not established, and while the second computer system is in the viewport of the first computer system, in response to detecting that the one or more criteria are satisfied, the first computer system initiates (2002c) a process to present a visual indication that the one or more criteria are satisfied on a respective portion of the second computer system, such as the first computer system initiating the process to present the visual indication 1912 on the respective portion of the second computer system 101b in FIG. 19F. In some embodiments, initiating the process includes causing the second computer system to display the visual indication on the respective portion of the second computer system, optionally independent of whether the respective portion is visible in the viewport of the first computer system when the second computer system displays the visual indication on the respective portion. In some embodiments, initiating the process includes transmission of data from the first computer system to the second computer system that results in the causing of the second computer system to display the visual indication on the respective portion. In some embodiments, initiating the process includes the first computer system displaying, via the one or more first displays, the visual indication on the respective portion. In some embodiments, the visual indication that is presented on the respective portion is different from a visual indication of attention of the first user that may be displayed elsewhere. For example, were the first computer system to display a first user interface in the first three-dimensional environment and were the attention of the first user to be directed to the first user interface, the first computer system would optionally display an indication of the attention of the first user on the part of the first user interface to which the attention of the first user is directed. Continuing with this example, were the attention of the first user directed to the respective portion of the second computer system, the visual characteristics (e.g., a size, a color, a brightness, and/or another visual characteristic) of the visual indication that would be presented on the respective portion are optionally different from the visual characteristics of the indication of the attention of the first user that are displayed on the part of the first user interface to which the attention of the first user is directed.

In some embodiments, the visual indication is a visual indication of the attention of the first user, and the first computer system may move the visual indication of the attention of the first user along the respective portion provided that the attention of the first user is moving along the respective portion, such as described in detail below.

In some embodiments, the respective portion is a transparent portion, such as partially or fully transparent portion, of the second computer system. For example, the respective portion optionally includes a portion of glass, plastic, and/or another type of material of the second computer system. In some embodiments, the respective portion includes a portion of the second computer system that is in front of and/or in a field of view of the eyes of the second user from the viewpoint of the first user. In some embodiments, the respective portion includes a front housing of the second computer system that covers (or is otherwise at one or more layers in front of) the eyes of the second user provided that the second computer system is worn on a head of the second user.

In some embodiments, when the visual indication is presented on the respective portion, the visual indication is not visible or is less visible to the second user than it is in the viewpoint of the first user. For example, when the first computer system is presenting the visual indication on the respective portion of the second computer system, visual indication is optionally not visible via the displays of the second computer system that are oriented for viewing by the second user of the second computer system or is less visible via the displays of the second computer system that are oriented for viewing by the second user of the second computer system.

In some embodiments, the visual indication is a highlight, a glow, a brightness applied to the respective portion, an increased contrast, or another type of visual indication, such as a type of visual indication that makes more distinct the respective portion of the second computer system (e.g., optionally compared to other portions of the second computer system and/or other portions of the first three-dimensional environment). In some embodiments, the visual indication is of one or more colors. In some embodiments, when the visual indication is not being presented on the respective portion of the second computer system, the respective portion has a first visual appearance (e.g., a first color, a first amount of transparency, an appearance that is optionally just based on the lighting of the physical environment of the respective portion, and/or another kind of visual appearance), and when the visual indication is being presented on the respective portion, the respective portion has a second visual appearance (e.g., an appearance that is optionally based on the visual characteristics of the visual indication, a second color, a second amount of transparency, or another kind of visual appearance) that is different from the first visual appearance.

In some embodiments, a size of the visual indication is based on a size of the respective portion of the second computer system. For example, were the portion to be a first size, the first computer system would optionally present the visual indication on the respective portion having a first respective size. Continuing with this example, were the portion to be a second size that is different from the first size, the first computer system would optionally present the visual indication on the respective portion having a second respective size that is different from (e.g., greater or less than) the first respective size.

In some embodiments, a size (e.g., an apparent size) of the visual indication is based on a distance between the viewpoint of the first user and the second computer system. For example, were the distance between the viewpoint of the first user and the second computer system to be a first distance, the first computer system would optionally present the visual indication on the respective portion having a first apparent size in the viewpoint of the first user. Continuing with this example, were the distance between the viewpoint of the first user and the second computer system to be a second distance that is different from the first distance, the first computer system would optionally present the visual indication on the respective portion having a second apparent size in the viewpoint of the first user that is different from the first apparent size. In some embodiments, the greater the distance between a position of the viewpoint of the first user and a position of the second computer system, the smaller the size (e.g., apparent size) of the visual indication.

In some embodiments, the visual indication is bounded by the respective portion of the second computer system (e.g., is bounded by an area and/or volume of the respective portion). For example, the second computer system optionally includes the respective portion and a second portion that is different from the respective portion, and when the visual indication is being presented on the respective portion, the visual indication is not being presented on the second portion. In some embodiments, the respective portion is greater in size than the visual indication such that when the visual indication is presented on the respective portion, the visual indication is less in size than the respective portion. In some embodiments, the respective portion is equal in size to the attention indication such that when the visual indication is presented on the respective portion, the visual indication is presented on all areas or volumes of the respective portion. In some embodiments, the visual indication is displayed on the respective portion without being displayed on other portions of the second computer system not displayed on other portions of the second computer system. Initiating the process to present a visual indication on a portion of a second computer system in response to detecting that the first user's attention is directed at the second computer system while no real-time communication session between the first and second users of the first and second computer systems is active indicates that the first user has performed an action (e.g., directing the first user's attention to the second computer system) that is involved in a process for initiating a communication session between the first and second users, thus reducing errors in the first computer system determining with whom the first user wants to initiate a communication session, and further, indicates and confirms to the first user that their attention is directed to the second computer system, and makes identifying locations of computer systems more efficient since the computer system to which the attention of the first user is directed is the computer system on which the visual indication is presented.

In some embodiments, the one or more criteria includes a second criterion that is satisfied when the attention (e.g., gaze) of the first user is directed at the respective portion of the second computer system, such as gaze point 1910c being directed at the respective portion of the second computer system 101b in FIG. 19F. In some embodiments, the process to initiate the presentation of the visual indication on the respective portion starts when the attention (e.g., gaze) of the first user is directed at the respective portion of the second computer system. In some embodiments, the process to initiate the presentation of the visual indication on the respective portion does not start until the attention (e.g., gaze) of the first user is directed at the respective portion of the second computer system. In some embodiments, the criteria are not satisfied when the attention of the first user is not directed at the respective portion of the computer system. Initiating the process to present a visual indication on a portion of a second computer system in response to detecting that the first user's attention is directed at the portion of second computer system while no real-time communication session between the first and second users of the first and second computer systems is active indicates that the first user has performed an action (e.g., directing the first user's attention to the portion of the second computer system) that is involved in a process for starting a communication session between the first and second users, thus reducing errors in the first computer system determining with whom the first user wants to initiate a communication session, and further, indicates and confirms to the first user that their attention is directed to the portion of the second computer system.

In some embodiments, when the visual indication is presented on the respective portion of the second computer system in accordance with initiation of the process to present the visual indication (e.g., initiating the process to present the visual indication optionally includes the first computer system displaying the visual indication and/or the first computer system causing the second computer system to display the visual indication), the attention of the first user is directed at a first portion of the second computer system (and the first portion is optionally the same as, different from, and/or a subset of the respective portion of the second computer system), such as the portion of the second computer system 101b to which the gaze point 1910c is directed in FIG. 19F. In some embodiments, while the visual indication is being presented on the respective portion the second computer system in accordance with initiation of the process to present the visual indication (e.g., initiating the process to present the visual indication optionally includes the first computer system displaying the visual indication and/or the first computer system causing the second computer system to display the visual indication), the first computer system detects, via the one or more first input devices, movement of the attention of the first user from being directed at the first portion of the second computer system to being directed at a second portion of the second computer system that is different from the first portion of the second computer system (and the second portion is optionally the same as, different from, and/or a subset of the respective portion of the second computer system), such as the movement of the gaze point 1910c from its illustrated location on the second computer system 101b in FIG. 19F to its illustrated location on the second computer system 101b in FIG. 19G. In some embodiments, in response to detecting the movement of the attention of the first user from being directed at the first portion of the second computer system to being directed at the second portion of the second computer system, the first computer system initiates a process to move presentation of the visual indication from the respective portion to a second respective portion of the second computer system that is different from the respective portion (e.g., initiating the process to move the visual indication optionally includes the first computer system displaying the visual indication moving from the respective portion to the second respective portion and/or the first computer system causing the second computer system to display the visual indication moving from the respective portion to the second respective portion), such as the first computer system 101a initiating the process to move presentation of the visual indication 1912 from its illustrated position on the second computer system 101b in FIG. 19F to its illustrated position on the second computer system 101b in FIG. 19H. Initiating a process to move presentation of the visual indication to different portions of the second computer system in response to movement of the attention of the first user indicates to the first user that the visual indication is responsive to attention and corresponds movement of the visual indication to movement of the attention of the first user.

In some embodiments, initiating the process to present the visual indication includes displaying, via the one or more first display generation components, the visual indication at a location in a first three-dimensional environment of the first computer system that corresponds to a location of the respective portion of the second computer system in the first three-dimensional environment. For example, the first computer system 101a optionally displays the visual indication 1912 at the illustrated location in the first three-dimensional environment 1103 on the second computer system 101b in FIG. 19F. As such, in some embodiments, the first computer system displays the visual indication on the respective portion of the second computer system, optionally with or without the second computer system displaying the visual indication on the respective portion. Displaying the visual indication on the respective portion of the second computer system indicates that the attention of the first user is directed to the second computer system and confirms that the first computer system has detected that the first user has performed an action (e.g., directing the first user's attention to the second computer system) that is involved in a process for initiating a communication session between the first and second users.

In some embodiments, initiating the process to present the visual indication on the respective portion of the second computer system includes causing the second computer system to display the visual indication at a location on the second computer system that corresponds to the respective portion. For example, the first computer system 101a optionally causes the second computer system 101b to display the visual indication 1912 at the corresponding illustrated location in the first three-dimensional environment 1103 on the second computer system 101b in FIG. 19F. As such, in some embodiments, the second computer system displays the visual indication on the respective portion of the second computer system, optionally with or without the first computer system displaying the visual indication on the respective portion of the second computer system. In some embodiments, when the second computer system displays the visual indication on the respective portion of the second computer system without the first computer system displaying the visual indication on the respective portion of the second computer system, at the first computer system, the visibility of visual indication that is displayed by the second computer system is optionally via active or passive passthrough via the displays of the first computer system. Causing the second computer system to display the visual indication on the respective portion of the second computer system provides confirmation to the second computer system that the attention of the first user is directed to the second computer system and that the first user has performed an action (e.g., directing the first user's attention to the second computer system) that is involved in a process for initiating a communication session between the first and second users.

In some embodiments, the first computer system detects, via the one or more first input devices, a first user input directed at the second user of the second computer system, wherein the first user input requests initiation of a real-time communication session between the first user and the second user, such as the first computer system 101a detecting input from the hand 1116 of the first user 1101a (e.g., detects the hand 1116 of the first user 1101a performing an air pinch gesture) while the attention (e.g., gaze) of the first user 1101a is directed at the second computer system 101b, as indicated by the gaze point 1910c, in FIG. 19I. For example, the first computer system optionally detects a gaze of the first user directed at the second user and/or an air gesture (e.g., an air pinch gesture) performed by a hand of the first user. Additionally or alternatively, the first computer system optionally detects a voice input, an input via a mouse, touch screen or trackpad, or another type of input described herein that is directed to the second user (e.g., the voice input indicates a name or username of the second user). In some embodiments, in response to detecting the first user input, and in accordance with a determination that the first user input is detected while the visual indication is being presented in accordance with initiation of the process to present the visual indication (e.g., initiating the process to present the visual indication optionally includes the first computer system displaying the visual indication and/or the first computer system causing the second computer system to display the visual indication), such as the first computer system 101a detecting input from the hand 1116 of the first user 1101a (e.g., detects the hand 1116 of the first user 1101a performing an air pinch gesture) while the visual indication 1912 is being presented on the second computer system 101b and while the attention (e.g., gaze) of the first user 1101a is directed at the second computer system 101b, as indicated by the gaze point 1910c, in FIG. 19I, and that second user input from the second user is detected after detecting the first user input, such as the input from the hand 1116a of the second user 1101b being detected in FIG. 19L after input from the hand 1116a of the first user 1101a is detected in FIG. 19I, the first computer system initiates the real-time communication session between the first user and the second user, such as initiating the communication session between the first user 1101a of the first computer system 101a and the second user 1101b of the second computer system 101b described with reference to FIG. 19M. In some embodiments, the second computer system presents an indication to the second user (e.g., presents an alert such as an audio alert, a visual alert, a text message, or another type of alert) that notifies the second user that the first user has requested to start a communication session with the second user and that provides the second user with opportunity (e.g., a period of time (e.g., 3, 5, 10, 30 s, 1 min, or another period of time) to accept or deny the communication session request. As such, were input from the first user directed at the second user and requesting starting of a communication session between the first and second users detected while the visual indication is being presented in accordance with initiation of the process to present the visual indication, and were input from the second user detected after the input from the first user detected, the first computer system optionally initiates the communication session between the first and second users, and the communication session is optionally as described with reference to methods 800, 1000, 1200, 1400, 1600, and/or 1800. In some embodiments, the communication session initiates without sharing of content between the first and second users. In some embodiments, in response to detecting the first user input, in accordance with a determination that the first user input is detected while the visual indication is being presented in accordance with initiation of the process to present the visual indication, and that second user input from the second user is not detected after detecting the first user input, the first computer system does not initiate a communication session. In some embodiments, if the second user input from the second user is detected before the first user input is detected, the first computer system does not initiate a communication session. Starting a communication session between the first and second users when input from the second user is detected after detecting input from the first user requesting initiation of the communication session indicate that both users have performed actions involved in a process for starting the communication session between the first and second users and completes the process for starting the communication session between the first and second users.

In some embodiments, in response to detecting the first user input, in accordance with a determination that the first user input (and optionally the second user input from the second user) is detected while the visual indication is not being presented in accordance with initiation of the process to present the visual indication (e.g., initiating the process to present the visual indication optionally includes the first computer system displaying the visual indication and/or the second computer system displaying the visual indication), such as the first computer system 101a detecting input from the hand 1116 of the first user 1101a (e.g., detects the hand 1116 of the first user 1101a performing an air pinch gesture) while the visual indication 1912 is not being presented on the second computer system 101b and optionally while the attention (e.g., gaze) of the first user 1101a is directed at the second computer system 101b, as indicated by the gaze point 1910c, in FIG. 19I, the first computer system forgoes initiating the real-time communication session between the first user and the second user, such as forgoing initiating the communication session between the first user 1101a of the first computer system 101a and the second user 1101b of the second computer system 101b described with reference to FIG. 19M. Thus, in some embodiments, the first computer system does not start the communication session between the first and second users provided that the first and/or second user input from the first and/or second user are not detected while the visual indication is being presented. Forgoing starting a communication session between the first and second users when input from either or both users is not detected while the visual indication is not being presented correlates the presentation of the visual indication, and further, input detection during the presentation of the visual indication, to criteria that should be met for the first computer system to start the communication session between the first and second users, and reduces errors associated with mis-starting communication sessions.

In some embodiments, the first user input includes first input that is other than input from one or more eyes of the first user, such as the input from the hand 1116 of the first user 1101a (e.g., the hand 1116 of the first user 1101a performing an air pinch gesture) in FIG. 19I, and the second user input includes second input that is other than input from the one or more eyes of the second user, such as the input from the hand 1116a of the second user 1101b (e.g., the hand 1116a of the second user 1101b performing an air pinch gesture) in FIG. 19L. For example, the first user input optionally includes input that is not from and/or not based on one or more eyes of the first user (e.g., is not based on a gaze of the first user) and second user input optionally includes input that is not from and/or not based on one or more eyes of the second user (e.g., is not based on a gaze of the second user). As such, in some embodiments, the first and second user inputs are non-gaze inputs (e.g., are not based on the eyes of the first and second users). In some embodiments, the first and second user inputs are from portions of the first and second users that are different from the eyes of the first and second users. In some embodiments, the first and second user inputs include input from non-attention-providing portion(s) of the first user and the second user, respectively. Detecting non-gaze inputs from the first and second users in the process for starting a communication session between the first and second users corresponds non-gaze inputs from them to actions involved in the process for starting the communication session between them and reduces errors associated with starting communication sessions using different inputs.

In some embodiments, the first user input includes first input from a hand of the first user, such as the input from the hand 1116 of the first user 1101a (e.g., the hand 1116 of the first user 1101a performing an air pinch gesture) in FIG. 19I, and wherein the second user input includes second input from a hand of the second user, such as the input from the hand 1116a of the second user 1101b (e.g., the hand 1116a of the second user 1101b performing an air pinch gesture) in FIG. 19L. In some embodiments, the first user input includes the first user performing an air gesture with their hand (e.g., an air pinch gesture, such as a contact of the index finger and thumb of the first user and the release thereof). In some embodiments, the second user input includes the second user performing an air gesture with their hand (e.g., an air pinch gesture, such as a contact of the index finger and thumb of the second user and the release thereof). Detecting hand inputs from the first and second users in the process for starting a communication session between the first and second users corresponds hand inputs from them to actions involved in the process for starting the communication session between them and reduces errors associated with starting communication sessions using different inputs.

In some embodiments, when the first user input is detected, the visual indication is being presented in accordance with initiation of the process to present the visual indication (e.g., initiating the process to present the visual indication optionally includes the first computer system displaying the visual indication and/or the second computer system displaying the visual indication) with a first visual appearance (e.g., a first color, shape, contrast, brightness, size, animation, and/or another visual appearance), such as the visual indication 1912 in FIG. 19F, and in response to detecting the first user input, the first computer system initiates a process to update presentation of the visual indication from having the first visual appearance to having a second visual appearance (e.g., a second color, shape, contrast, brightness, size, animation, and/or another visual appearance) that is different from the first visual appearance, such as the second visual appearance including the visual animation including the movement of the visual indication 1912 on the second computer system 101b from FIG. 19K-1 to FIG. 19K-2, wherein the second visual appearance indicates that a first part of a set of one or more inputs for initiating the real-time communication session between the first user and the second user has been detected, such as the visual animation including the movement of the visual indication 1912 on the second computer system 101b from FIG. 19K-1 to FIG. 19K-2 indicating that the first part of inputs for initiating the communication session between the first user 1101a of the first computer system 101a and the second user 1101b of the second computer system 101b has been detected. As such, in some embodiments, when the first user input is detected, the visual indication is presented with a first visual appearance, and in response to the first user input, the first computer system initiates a process to change the visual appearance of the visual indication to indicate that a first part of a set of actions for starting a communication session between the first and second users has been detected. In some embodiments, when the first user input is detected, the visual indication follows movement of the attention of the first user, and in response to the first user input, the first computer system initiates a process to cease movement of the visual indication that is based on movement of the attention of the first user. In some embodiments, in response to the first user input, the first computer system initiates a process to present the visual indication on the second computer system in a manner where the visual indication does not follow movement of the attention of the first user. For example, when the first input is detected, the visual indication optionally is not pulsing on the second computer system, and in response to the first input, the visual indication is optionally presented as pulsing (e.g., moving along the portion of the second computer system without the movement of it being based on changes to where the attention of the user is directed on the second computer system). In some embodiments, the visual indication is presented with the second appearance for a threshold period of time (e.g., 1, 3, 5, 10, 15 seconds, or another period of time), and once the threshold period of time is past, the first computer system initiates a process to cease presenting the visual indication with the second appearance. In some embodiments, the second user input must be detected during the threshold period of time. In some embodiments, were the second user input not detected during the threshold period of time, the first computer system would not initiate a communication session between the first and second users. Initiating a process to update the appearance of the visual indication when the first user input is detected so that the visual indication indicates that a part of a set of inputs for starting a communication session between the first and second users has been detected notifies the first user that the part of the set of inputs for starting the communication session between the first and second users has been detected and reduces errors associated with starting communication sessions.

In some embodiments, initiating the process to update presentation of the visual indication from having the first visual appearance to having the second visual appearance includes displaying, via the one or more first display generation components, the visual indication having the second visual appearance, such as the second visual appearance including the visual animation including the movement of the visual indication 1912 on the second computer system 101b from FIG. 19K-1 to FIG. 19K-2, without including causing the visual indication having the second visual appearance to be visible (or optionally without causing it to be displayed) at a respective computer system that is different from the first computer system, such as the second visual appearance including the visual animation including the movement of the visual indication 1912 on the second computer system 101b from FIG. 19K-1 to FIG. 19K-2 not being visible at the third computer system 101c of the third user 1101c in FIG. 19K-3. In some embodiments, the visual indication having the second appearance is not displayed (or is not visible) at other computer systems that are different from the first computer system because only the first user has provided the input (e.g., the first user input) while a visual indication was being presented on the second computer system. As such, in some embodiments, the visual indication having the second appearance is visible only at computer systems where the users of the computer systems have provided input when the visual indication having the first visual appearance was presented (e.g., was visible at their computer systems). In some embodiments, the visual indication having the second visual appearance is not visible at any computer system that has not detected input from its respective user requesting to initiate a communication session with the second user. In some embodiments, a visual indication presented on the second computer system (e.g., the visual indication having the first visual appearance or the visual indication having the second visual appearance) is not visible at any computer system that has not detected attention of its respective user directed to the second computer system and/or input from its respective user requesting to initiate a communications session with the second user. Displaying the visual indication with the second appearance only at the first computer system indicates that the first user (e.g., and not another user) has performed an action for initiating the communication session with the second user reduces errors associated with which user has performed the action for initiating the communication session with the second user.

In some embodiments, before (optionally when) the real-time communication session between the first user and second user is initiated (e.g., in response to detecting the first user input and in accordance with a determination that the first user input is detected while the visual indication is being presented in accordance with initiation of the process to present the visual indication (e.g., initiating the process to present the visual indication optionally includes the first computer system displaying the visual indication and/or the second computer system displaying the visual indication) and that second user input from the second user is detected after detecting the first user input), the visual indication that is being presented in accordance with initiation of the process to present the visual indication (e.g., initiating the process to present the visual indication optionally includes the first computer system displaying the visual indication and/or the second computer system displaying the visual indication) has a first visual appearance (e.g., a first color, shape, contrast, brightness, size, animation, and/or another visual appearance), such as the visual animation including the movement of the visual indication 1912 on the second computer system 101b from FIG. 19K-1 to FIG. 19K-2, and in response to initiating the real-time communication session between the first user and the second user, the first computer system initiates a process to update presentation of the visual indication from having the first visual appearance to having a second visual appearance (e.g., a second color, shape, contrast, brightness, size, animation, and/or another visual appearance) that is different from the first visual appearance, wherein the second visual appearance indicates that the real-time communication session between the first user and the second user is established, such as the appearance of the visual indication 1912 in FIG. 19M, which is different from the appearance of the visual indication 1912 in FIG. 19K-1 is different from the appearance of the visual indication 1912 in FIG. 19F. In some embodiments, when the visual indication is being presented with the first appearance, the visual appearance indicates that a first part of a set of one or more inputs for initiating the real-time communication session between the first user and the second user has been detected as described above and/or that the criteria described above with reference to step(s) 2002 are satisfied, and when the visual indication is being presented with the second appearance, the visual appearance indicates that the communication session between the first and second users is now active. In some embodiments, the second visual appearance that the visual indication is updated to have in response to initiation of the communication session is the same as or different from the second visual appearance that the visual indication is updated to have in response to detecting the first user input described above. In some embodiments, the visual indication that is updated to have the second visual appearance in response to initiation of the communication session is also in response to detecting the second user input from the second user described above. Initiating a process to change the visual appearance of the visual indication on the second computer system corresponds differences in appearance of the visual indication on the second computer system to differences in progression along the process for initiating the communication session between the first and second users, and reduces errors associated with mis-interpreting whether the communication session between the first and second users is established.

In some embodiments, initiating the process to update presentation of the visual indication from having the first visual appearance to having the second visual appearance that indicates that the real-time communication session between the first user and the second user is established, includes displaying, via the one or more first display generation components, the visual indication having the second visual appearance, without including causing the visual indication having the second visual appearance to be visible (or optionally without causing it to be displayed) at a respective computer system that is not in the real-time communication session (e.g., that is not in a communication session with the first and/or second user), such as the visual indication 1912 in FIG. 19M being visible to the third user 1101c provided that the third user 1101c is in the communication session with the first user 1101a and the second user 1101b, as shown in FIG. 19N, and the visual indication 1912 in FIG. 19M not being visible to the third user 1101c provided that the third user 1101c is not in the communication session with the first user 1101a and the second user 1101b, as shown in FIG. 19O. In some embodiments, initiating the process to update presentation of the visual indication from having the first visual appearance to having the second visual appearance that indicates that the real-time communication session between the first user and the second user is established includes forgoing causing the visual indication having the second visual appearance to be displayed (or to be visible) at a respective computer system that is not in the real-time communication session (e.g., that is not in a communication session with the first and/or second user). In some embodiments, were the first and/or second users in a communication session with other users that are collocated in the physical environment with the first and/or second user when the communication session between the first and second user is established, the process includes presentation of the visual indication having the second appearance such that it is visible to other users that are in the communication session without it being visible to users that are not in the communication session. In some embodiments, were other users (that are collocated in the physical environment with the first and/or second user) to initiate a communication session with the first and/or second user while the communication session between the first and second users is established, a process would be initiated to present the visual indication having the second appearance to those other users that are now in a communication session with the first and/or second user. In some embodiments, were a third user to initiate a communication session with the second user while the communication session between the first and second users is already established, the communication session between the first and second users would update to be a communication session between the first, second, and third users. In some embodiments, when the communication session between the first and second users is established, a visual indication having the second appearance may be presented on a portion of the first and second computer systems to indicate that the first and second users are in the communication session. In some embodiments, were the communication session to update to include the first, second, and third users, a visual indication having the second appearance may be presented on a portion of the first, second, and third computer systems to indicate that the users of these computer systems are in the communication session. In some embodiments, the visual indication having the second visual appearance is not visible at any computer system associated with a respective user who is not in the communication session with the first and second users. Causing the visual indication having the second appearance to be presented relative to only computer systems that are in the communication session indicates to users in the communication session who is with them in the communication session and reduces errors associated with mis-interpreting whether or not a user is in a communication session with the first and/or second user.

It should be understood that the particular order in which the operations in method 2000 have been described is merely exemplary and is not intended to indicate that the described order is the only order in which the operations could be performed. One of ordinary skill in the art would recognize various ways to reorder the operations described herein.

FIGS. 21A through 21U generally illustrate examples of a first computer system adding a user to an existing communication session that is between a first user of the first computer system and a second user of a second computer system in response to user input from the first user being directed at a communication session user interface for adding the user, where the first computer system and second computer systems are collocated in a physical environment, in accordance with some embodiments.

In some embodiments, the user that the first computer system adds is collocated in the physical environment with the first user. In some embodiments, user that the first computer system adds is not collocated in the physical environment with the first user, but is in a different environment (e.g., a different room or place). In some embodiments, the first computer system displays a communication session user interface that indicates different users differently based on whether or not the users are collocated in the physical environment with the first user. In some embodiments, the communication session user interface updates the indications of the users in the communication session user interface in response to detecting changes to the collocation status of the users relative to the first user. These and other embodiments of the disclosure are generally shown throughout FIGS. 21A through 21U, and the embodiments described with reference to FIGS. 21A through 21U are further described with reference to the method 2200.

FIG. 21A shows the first computer system 101a (e.g., an electronic device) worn by the first user 1101a of the first computer system 101a displaying, via the display generation components 120 (e.g., display generation components 1-122a and 1-122b of FIG. 1), the first three-dimensional environment 1103 from a viewpoint of the first user 1101a (e.g., first user 1101a in overhead view 2102a of the first three-dimensional environment 1103) of the first computer system 101a (e.g., facing the back wall of the physical environment 1105 in which the first computer system 101a is located). The first user interface 1106 and the second user interface 1108 are likewise in the first three-dimensional environment 1103. Further, as shown in the overhead view 2102a of FIG. 21A, the first user 1101a of the first computer system 101a is collocated with the second user 1101b of the second computer system 101b and the third user 1101c of the third computer system 101c in the physical environment 1105. Overhead views 2102a through 2102u in FIGS. 21A through 21U show relative positioning of objects in the three-dimensional environment in a horizontal dimension and a depth dimension in the respective figure and the view of the three-dimensional environment shown in the display generation components 120 in the respective figure shows the relative positioning of objects in the three-dimensional environment in a vertical dimension and a horizontal dimension (and, optionally in a depth dimension).

In FIG. 21A, the first computer system displays the first user interface 1106 and the second user interface 1108. In FIG. 21A, the first computer system 101a is sharing the first user interface 1106 with the second user 1101b. In FIG. 21A, the second user interface 1108 is private to the first computer system 101a. That is, the second user interface 1108 is not being shared with the second computer system 101b or the third computer system 101c in FIG. 21A.

Additionally, in FIG. 21A, the first user 1101a and the second user 1101b are in a communication session (e.g., a communication session such as described with reference to methods 800, 1000, 1200, 1400, 1600, 1800, 2000, and/or 2200) via the first computer system 101a and the second computer system 101b, respectively. In some embodiments, the communication session in which the first user 1101a and the second user 1101b participate in FIG. 21A includes shared content, namely the sharing of the first user interface 1106 between the first user 1101a and the second user 1101b (e.g., which in the illustrated embodiment is sharing of the first user interface 1106 initiated by the first user 1101a). In some embodiments, the communication session in which the first user 1101a and the second user 1101b participate in FIG. 21A solely includes the first user 1101a and the second user 1101b. For example, in FIG. 21A, though the third user 1101c is collocated in the physical environment 1105 with the first user 1101a and the second user 1101b, the third user 1101c is not in the communication session in which the first user 1101a and the second user 1101b participate. For example, in FIG. 21A, though the first computer system 101a is sharing the first user interface 1106 with the second user 1101b as described above, the first computer system 101a is not sharing the first user interface 1106 with the third user 1101c.

From FIG. 21A to FIG. 21B, the first user 1101a turns (e.g., rotates the head of the first user 1101a) towards the second user 1101b, as shown with the rotation of the first user 1101a from their orientation in the overhead view 2102a in FIG. 21A to their orientation in the overhead view 2102b in FIG. 21B. In response, the first computer system 101a updates the visible portion of the first three-dimensional environment 1103 in accordance with the change in viewpoint of the first user 1101a (e.g., with the change in the direction associated with the viewpoint of the first user 1101a), as shown with the change in the view of the first three-dimensional environment 1103 shown via the display generation components 120 from FIG. 21A to FIG. 21B. In FIG. 21B, the second user 1101b is visible in the first three-dimensional environment 1103 via the display generation components 120 (e.g. the second user 1101b is visible in the viewport of the first computer system 101a) because the second user 1101b is at a location that corresponds to a location in the first three-dimensional environment 1103 that is now visible via the display generation components 120.

In FIG. 21C, while displaying the view of the first three-dimensional environment 1103 illustrated in FIG. 21B, the first computer system 101a detects input from the first user 1101a directed to the second user 1101b (e.g., directed to the location in the first three-dimensional environment 1103 that the body or person of the second user 1101b occupies), as shown in FIG. 21C. For example, in FIG. 21C, the first computer system 101a optionally detects input from the hand 1116 of the first user 1101a (e.g., detects the hand 1116 of the first user 1101a performing an air pinch gesture) while attention (e.g., gaze) of the first user 1101a is directed to the second user 1101b, as indicated by gaze point 2110a. In response, the first computer system 101a displays the communication session user interface 2114, as shown in FIG. 21D.

In FIG. 21D, the communication session user interface 2114 includes a first element 2114a, a second element 2114b, a third element 2114c, a fourth element 2114d, and a fifth element 2114e. The first element 2114a shows pictorial and/or iconic representations of the users in the communication session associated with the communication session user interface 2114. In the illustrated embodiment of FIG. 21D, the communication session associated with the communication session user interface 2114 solely includes the first user 1101a and the second user 1101b, so the first element 2114a shows a first pictorial and/or iconic representation of the first user 1101a and shows a second pictorial and/or iconic representation of the second user 1101b. In FIG. 21D, the second element 2114b, “Bella & Alice”, shows textual representations of the users in the communication session associated with the communication session user interface 2114. In the illustrated embodiment of FIG. 21D, the communication session associated with the communication session user interface 2114 solely includes the first user 1101a and the second user 1101b, so the second element 2114b shows a name of the first user 1101a (e.g., Bella) and a name of the second user 1101b (e.g., Alice). In FIG. 21D, the third element 2114c, “Sharing ‘Photos’”, indicates the content that is being shared in the communication session. As described with reference to FIG. 21A, the first user interface 1106 (e.g., a photos user interface of a photos application) is being shared from the first user 1101a to the second user 1101b in the communication session, so the third element 2114c indicates that the first user interface 1106 is being shared (e.g., without indicating that other content is being shared because solely the first user interface 1106 is being shared between the first user 1101a and the second user 1101b in FIG. 21D). In some embodiments, the third element 2114c is selectable to modify sharing of the first user interface 1106, such as to cease sharing of the first user interface 1106 and/or to perform other operations related to sharing. In FIG. 21D, the fourth element 2114d is selectable to display a user interface including one or more indications of users that the first computer system 101a (e.g., in response to input from the first user 1101a) can request to add to the communication session. In FIG. 21D, the fifth element 2114e indicates a suggested user to add to the communication session. In FIG. 21D, the suggested user indicated by the fifth element 2114e is the third user 1101c, who is not in the communication session that is associated with the communication session user interface 2114. In some embodiments, the fifth element 2114e indicates one or more users that are collocated with the first user 1101a and could be added to the communication session. In some embodiments, the communication session user interface 2114 includes one or more (or all) features described with reference to the communication session user interface 940 referenced with reference to the method 1000.

In FIG. 21E, while displaying the view of the first three-dimensional environment 1103 illustrated in FIG. 21D, the first computer system 101a detects selection of the fourth element 2114d, as shown in FIG. 17E. For example, in FIG. 17E, the first computer system 101a optionally detects input from the hand 1116 of the first user 1101a (e.g., detects the hand 1116 of the first user 1101a performing an air pinch gesture) while attention (e.g., gaze) of the first user 1101a is directed to the fourth element 2114d of the communication session user interface 2114, as indicated by gaze point 2110b. In response, the first computer system 101a displays the communication session user interface 2114 of FIG. 21F.

As described above, the fourth element 2114d of the communication session user interface 2114 is selectable to display a user interface including one or more indications of users that the first user 1101a of the first computer system 101a can request to add to the communication session. In FIG. 21F, the communication session user interface 2114 includes a sixth element 2115a indicating that the current page of the communication session user interface 2114 includes options for adding users to the communication session. Additionally, in FIG. 21F, the communication session user interface 2114 includes options 2114f through 2114i. Options 2114f through 2114i indicate the person that the respective option is selectable to request to add and indicate whether the respective person is collocated in the physical environment 1105 with the first user 1101a (e.g., in which case the person is indicated as “local” in the illustrated embodiment) or is not collocated in the physical environment 1105 with the first user 1101a (e.g., in which case the person is indicated as “remote” in the illustrated embodiment) In FIG. 21F, option 2114f is selectable to request to add “Charlie”, who is the third user 1101c and is collocated in the physical environment 1105 with the first user 1101a (e.g., Charlie is indicated as “local” in the illustrated embodiment); option 2114g is selectable to request to add “Sarah”, who is the user 1101d in the illustrated embodiment and who is collocated in the physical environment 1105 with the first user 1101a (e.g., Sarah is indicated as “local” in the illustrated embodiment); option 2114h is selectable to request to add “Brooke”, who is a user that is not collocated in the physical environment 1105 with the first user 1101a (e.g., Brooke is indicated as “remote” in the illustrated embodiment); option 2114i is selectable to request to add “Avery”, who is another user that is not collocated in the physical environment 1105 with the first user 1101a (e.g., Avery is indicated as “remote” in the illustrated embodiment). Additionally, in some embodiments, an order in which persons are listed in the communication session user interface 2114 is optionally based on whether or not the person is collocated in the physical environment 1105 with the first user 1101a. For example, as shown in FIG. 21F, the two users that are collocated in the physical environment 1105 with the first user 1101a (e.g. the third user 1101c and the user 1101d, namely “Charlie” and “Sarah” respectively) have higher positions in the listing than the two users of computer systems that are not collocated in the physical environment 1105 with the first user 1101a (e.g., Brooke and Avery).

In some embodiments, the communication session user interface 2114 is navigable to display a listing that solely includes persons to add to the communication session that are collocated with the first user 1101a in the physical environment 1105, such as shown in FIG. 21G. In FIG. 21G, the communication session user interface 2114 includes a seventh element 2115b indicating that the current page of the communication session user interface 2114 includes options for adding to the communication session users who are collocated with the first user 1101a in the physical environment 1105. In FIG. 21G, the users who are collocated with the first user 1101a in the physical environment 1105 and who are not in the communication session include the third user 1101c and the user 1101d, namely “Charlie” and “Sarah” respectively, so the first computer system 101a display in the communication session user interface 2114 the option 2114f corresponding to the third user 1101c, namely “Charlie”, and the option 2114g corresponding to the user 1101d, namely “Sarah”. In some embodiments, the communication session user interface 2114 of FIG. 21G is displayed in response to input directed to the fourth element 2114d.

In some embodiments, the communication session user interface 2114 is navigable to display a listing that solely includes persons to add to the communication session that are not collocated with the first user 1101a in the physical environment 1105, such as shown in FIG. 21H. In FIG. 21H, the communication session user interface 2114 includes an eight element 2115c indicating that the current page of the communication session user interface 2114 includes options for adding to the communication session users who are not collocated with the first user 1101a in the physical environment 1105. In FIG. 21H, the users who are not collocated with the first user 1101a in the physical environment 1105 and who are not in the communication session include Brooke and Avery, so the first computer system 101a display in the communication session user interface 2114 the option 2114h corresponding to Brooke (e.g., the user Brooke) and the option 2114i corresponding to Avery (e.g., the user Avery). In some embodiments, the communication session user interface 2114 of FIG. 21H is displayed in response to input directed to the fourth element 2114d.

In some embodiments, the first computer system 101a updates the communication session user interface 2114 in response to detecting that a collocation status of a user has changed, such as shown in FIGS. 211 and 21J. For example, in FIG. 21G, Sarah (e.g., the user 1101d) was collocated with the first user 1101a in the physical environment 1105 and not in the communication session (e.g., the first computer system 101a detected that Sarah was collocated with the first user 1101a and not in the communication session), so the communication session user interface 2114 included the option 2114g corresponding to Sarah (e.g., which was selectable to initiate a process to add Sarah (e.g., the user 1101d) to the communication session). Continuing with this example, in FIG. 21I, though the first computer system 101a is displaying the communication session user interface 2114 including the seventh element 2115b indicating that the current page of the communication session user interface 2114 includes options for adding to the communication session users who are collocated with the first user 1101a in the physical environment 1105, the communication session user interface 2114 in FIG. 21I does not include the option 2114g corresponding to Sarah (e.g., the user 1101d) because Sarah (e.g., the user 1101d) is no longer collocated with the first user 1101a in the physical environment 1105 (e.g., the first computer system 101a detected that Sarah (e.g., the user 1101d) is no longer collocated with the first user 1101a in the physical environment 1105). In particular, Sarah's collocation status (e.g., the collocation status of the user 1101d) has changed from being collocated with the first user 1101a in the physical environment 1105 to not being collocated with the first user 1101a in the physical environment 1105, such as shown in the respective overhead views from FIG. 21G, where Sarah (e.g., the user 1101d) is in the physical environment 1105 with the first user 1101a in FIG. 21G, to FIG. 21I and FIG. 21J, where Sarah (e.g., the user 1101d) is not in the overhead view in FIG. 21I and FIG. 21J. Continuing with this example, in FIG. 21J, the first computer system 101a is displaying the communication session user interface 2114 including the eight element 2115c indicating that the current page of the communication session user interface 2114 includes options for adding to the communication session users who are not collocated with the first user 1101a in the physical environment 1105, and the options now include the option 2114g corresponding to Sarah (e.g., the user 1101d) because Sarah (e.g., the user 1101d) is no longer collocated with the first user 1101a in the physical environment 1105 (e.g., the first computer system 101a detected that Sarah (e.g., the user 1101d) is no longer collocated with the first user 1101a in the physical environment 1105).

FIGS. 21K through 21M generally illustrate the first computer system 101a detecting and responding to input directed at the communication session user interface 2114 for adding the user Brooke to the communication session, according to some embodiments.

In FIG. 21K, while displaying the view of the first three-dimensional environment 1103 illustrated in FIG. 21J, the first computer system 101a detects input from the first user 1101a directed to the option 2114h corresponding to the user Brooke, as shown in FIG. 21K. For example, in FIG. 21K, the first computer system 101a optionally detects input from the hand 1116 of the first user 1101a (e.g., detects the hand 1116 of the first user 1101a performing an air pinch gesture) while attention (e.g., gaze) of the first user 1101a is directed to the option 2114h corresponding to the user Brooke, as indicated by gaze point 2110c. In response, the first computer system 101a initiates a process to add the user Brooke, as shown in FIG. 21L. In FIG. 21L, the first computer system 101a displays the contact user interface 926. In some embodiments, the contact user interface 926 in FIG. 21L indicates to the first user 1101a that the first computer system 101a is notifying the computer system of the user Brooke that the first user 1101a is calling the user Brooke. Note that the user Brooke is different from the second user 1101b in FIG. 21L. For example, the second user 1101b is collocated with the first user 1101a in the physical environment 1105 while the user Brooke is not even in the physical environment 1105 in FIG. 21L.

In some embodiments, provided that the user Brooke accepts the call of the first user 1101a, the first computer system 101a adds the user Brooke to the communication session, thus updating the communication session to be between the first user 1101a, the second user 1101b, and the user Brooke, and displays a representation of the added user, Brooke, in the first three-dimensional environment 1103, such as shown in FIG. 21M and FIG. 21N. In some embodiments, the first computer system 101a display a three-dimensional representation 2120a of the added user, Brooke, such as shown in FIG. 21M. These features are described further with reference to method 2200. In some embodiments, the first computer system 101a display a two-dimensional representation 2120b of the added user, Brooke, such as shown in FIG. 21N. These features are described further with reference to method 2200.

In some embodiments, the location at which the first computer system 101a displays a representation (e.g., the three-dimensional representation 2120a in FIG. 21M or the two-dimensional representation 2120b in FIG. 21N) of the adder user, Brooke, in the first three-dimensional environment 1103 is based on a spatial arrangement between the users in the communication session that are collocated in the physical environment 1105. For example, the first computer system 101a optionally displays the representation of the adder user, Brooke, in the first three-dimensional environment 1103, at the illustrated location in FIG. 21M or FIG. 21N because of the spatial arrangement between viewpoint of the first user 1101a and the position of the second user 1101b in the illustrated figure (e.g., in any of FIGS. 21K through 21N). Continuing with this example, were the spatial arrangement between the users of the communication session that are in the same physical environment 1105 (e.g., between the users in the communication session that are collocated with each other) different from the spatial arrangement between viewpoint of the first user 1101a and the position of the second user 1101b in FIG. 21M, such as shown with the spatial arrangement between viewpoint of the first user 1101a and the position of the second user 1101b in FIG. 210 or FIG. 21P, the first computer system 101a would optionally display the representation of the added user, Brooke, in the first three-dimensional environment 1103, at a location that is different from the illustrated location in FIG. 21M or FIG. 21N, such as shown from FIG. 210 to FIG. 21P. These features are described further with reference to method 2200.

In some embodiments, when the first computer system 101a adds the user Brooke to the communication session such that the communication session transitions from being a communication session between the first user 1101a and the second user 1101b to being a communication session between the first user 1101a, the second user 1101b, and the user Brooke, a user interface of an application (e.g., content) is being shared in the communication session. For example, in FIG. 21K, the first computer system 101a is optionally sharing the first user interface 1106 with the second computer system 101b, such that when the first computer system 101a adds the user Brooke to the communication session such that the communication session transitions from being a communication session between the first user 1101a and the second user 1101b to being a communication session between the first user 1101a, the second user 1101b, and the user Brooke, as described with reference to FIGS. 21K through 21N, the first user interface 1106 is still being shared in the communication session, including being now shared between the first user 1101a, the second user 1101b, and the user Brooke.

In some embodiments, when the first computer system 101a adds the user Brooke to the communication session such that the communication session transitions from being a communication session between the first user 1101a and the second user 1101b to being a communication session between the first user 1101a, the second user 1101b, and the user Brooke, a user interface of an application (e.g., the first user interface 1106, the second user interface 1108, or another user interface of an application) is not being shared in the communication session. For example, the first user 1101a is optionally not sharing a user interface of an application with the second user 1101b in the communication session and the second user 1101b is optionally not sharing a user interface of an application with the first user 1101a in the communication session when the first computer system 101a adds the user Brooke to the communication session, such as shown in FIG. 21Q, which includes the notification 2123a that indicates that no window (e.g., user interface of an application) is being shared between the first user 1101a and the second user 1101b. For example, in FIG. 21Q, the first user interface 1106 and the second user interface 1108, which are in the first three-dimensional environment 1103, are private to the first user 1101a (e.g., they are not being displayed by the second computer system 101b of the second user 1101b), and the second computer system 101b not sharing a user interface with the first computer system 101a. As such, in some embodiments, when the first computer system 101a adds the user Brooke to the communication session such that the communication session transitions from being a communication session between the first user 1101a and the second user 1101b to being a communication session between the first user 1101a, the second user 1101b, and the user Brooke, a user interface of an application is not being shared in the communication session.

FIGS. 21R through 21U illustrate computer systems in a communication session detecting and responding to an indication that the user Brooke, who is in the communication session but not collocated in the physical environment 1105 with the first user 1101a or the second user 1101b in the communication session, requests to share a user interface in the communication session, according to some embodiments. The communication session described with reference to FIGS. 21R through 21U is a communication session between the first user 1101a, the second user 1101b, and the user Brooke, where the first user 1101a and the second user 1101b are collocated in the physical environment 1105 and where the user Brooke is not collocated in the physical environment 1105 with the first user 1101a or the second user 1101b (e.g., the user Brooke is in a room, building, city, state, and/or country, that is different from the location of the first user 1101a and the second user 1101b).

In FIG. 21R, while displaying, in the second three-dimensional environment 1107, a first shared user interface of the communication session, which is the first user interface 1106 that is being shared from the first user 1101a, and while displaying, in the second three-dimensional environment 1107, the three-dimensional representation 2120a of the user Brooke, which indicates to the second user 1101b that the user Brooke is in the communication session, the second computer system 101b detects the indication 2122a that the user Brooke requests to share a user interface (e.g., an application window), namely a user interface of a maps application, in the communication session. In response, the second computer system 101b ceases display of the first user interface 1106 and displays the maps user interface 2124 (e.g., of maps application), which is the user interface that the computer system of the user Brooke is sharing in the communication session, as shown in FIG. 21S. In addition, the pill 2124a of the maps user interface 2124 indicates to the second user 1101b that the maps user interface 2124 is being shared with the first user 1101a (e.g., “Bella”) and the user Brooke, as shown in FIG. 21S.

Similarly, in FIG. 21T, while displaying, in the first three-dimensional environment 1103, a first shared user interface of the communication session, which is the first user interface 1106 that is being shared from the first user 1101a, and while displaying, in the first three-dimensional environment 1103, the three-dimensional representation 2120a of the user Brooke, which indicates to the first user 1101a that the user Brooke is in the communication session, the first computer system 101a detects the indication 2122a that the user Brooke requests to share a user interface (e.g., an application window), namely a user interface of a maps application, in the communication session. In response, the first computer system 101a optionally moves the location of display of the first user interface 1106 in the first three-dimensional environment 1103, which optionally was previously located at an ideal viewing location between the first user 1101a and the second user 1101b since it was being shared in the communication session, and displays the maps user interface 2124 (e.g., of maps application), which is the user interface that the computer system of the user Brooke is sharing in the communication session, as shown in FIG. 21U. In some embodiments, the maps user interface 2124 is displayed near or at the same location that the first user interface 1106 was displayed in the first three-dimensional environment 1103 when it was being shared in the communication session. In addition, the pill 2124a of the maps user interface 2124 indicates to the first user 1101a that the maps user interface 2124 is being shared with the second user 1101b and the user Brooke, as shown in FIG. 21U. Further details regarding the embodiments illustrated and described with reference to FIGS. 21A through 21U are provided with reference to method 2200.

FIG. 22 is a flowchart illustrating an exemplary method for adding a user to an existing communication session that is between a first user of the first computer system and a second user of a second computer system in response to user input from the first user being directed at a communication session user interface for adding the user in accordance with some embodiments. In some embodiments, the method 2200 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2200 are, optionally, combined and/or the order of some operations is, optionally, changed.

In some embodiments, a method 2200 (e.g., the method 2200 of FIG. 22) is performed at a first computer system in communication with one or more first display generation components and one or more first input devices. In some embodiments, the first computer system has one or more characteristics of the computer systems in methods 800, 1000, 1200, 1400, 1600, 1800, and/or 2000. In some embodiments, the first display generation component(s) have one or more characteristics of the display generation component(s) in methods 800, 1000, 1200, 1400, 1600, 1800, and/or 2000. In some embodiments, the one or more first input devices have one or more characteristics of the one or more input devices in methods 800, 1000, 1200, 1400, 1600, 1800, and/or 2000.

In some embodiments, (2202a) while a real-time communication session between a first user of the first computer system and a second user of a second computer system that are collocated in a physical environment is established (e.g., while a spatial or non-spatial real-time communication session is established between the first and second users of the first and second computer systems (e.g., between just the first and second users of the first and second computer systems), such as a communication session described with reference to 800, 1000, 1200, 1400, 1600, 1800, and/or 2000, and optionally while the real-time communication session includes shared virtual content or does not include shared virtual content between the first and second users of the first and second computer systems (e.g., from the first computer system to the second computer system or from the second computer system to the first computer system), such as described with reference to method 1800 and/or 2000)), such as the communication session between the first user 1101a and the second user 1101b described with reference to FIG. 21A, the first computer system detects (2202b) an event corresponding to a request to display a communication session user interface, such as the input from the hand 1116 of the first user 1101a (e.g., the hand 1116 of the first user 1101a performing an air pinch gesture) while attention (e.g., gaze) of the first user 1101a is directed to the second user 1101b, as indicated by gaze point 2110a, in FIG. 21C. In some embodiments, the event is a selection input directed to the second user. For example, the first computer system optionally detects an air gesture (e.g., an air pinch gesture, an air tap gesture, or other gesture) performed by a hand of the first user, optionally while the gaze of the first user is directed to the second user (e.g., the actual physical body of the second user and not to an avatar of the second user, such as described with reference to method 1200, 1400 and/or 1800) or to a spatial representation of the second user, such as described with reference to method 1000. Additionally or alternatively, in some embodiments, the event includes the second user and/or the second computer system being in the viewport of the first user (e.g., visible in physical form (e.g., not an avatar of the second user) in (e.g., through) the viewport of the first computer system at a location in a first three-dimensional environment of the first user, such as the first three-dimensional environment described with reference to methods 1200, 1400, 1600, 1800, and/or 2000), because the second user is physically located at a location in the physical environment that corresponds to (e.g., is the same as) the location in the first three-dimensional environment). Additionally or alternatively, in some embodiments, the event includes a voice input from the first user requesting to display the communication session user interface and/or another type of input that corresponds to a request to display the communication session user interface.

In some embodiments, (2202a) while the real-time communication session between the first user of the first computer system and the second user of the second computer system that are collocated in the physical environment is established, in response to detecting the event, the first computer system displays (2202c), via the one or more first display generation components, the communication session user interface, such as the communication session user interface 2114 in FIG. 21D. In some embodiments, the communication session user interface includes user interface elements indicative of who is currently in the communication session. For example, the communication session user interface optionally includes an indication of the first user and/or an indication of the second user because the first user and the second user are currently in the real-time communication session between the first user and the second user. In some embodiments, were the real-time communication session to include shared content between the first and second users, the communication session user interface indicates the shared content. In some embodiments, the communication session user interface includes a user interface element that is selectable to display indications of one or more users to add to the communication session (e.g., one or more suggested users to add to the communication session). In some embodiments, the communication session user interface is navigable (e.g., via one or more inputs) to display indications of the one or more users to add the communication session. In some embodiments, the communication session user interface includes indications of users to add to the communications session (e.g., without having to navigate or to select the user interface element described above with reference to method 2200).

In some embodiments, the first computer system displays the communication session user interface in between a position of the viewpoint of the first user and a position of the second user (e.g., the actual physical body of the second user and not to an avatar of the second user, such as described with reference to method 1200, 1400, 1800 and/or step(s) 2202 of method 2200). In some embodiments, the first computer system displays the communication session user interface closer to a position of the second user, closer to a position of the viewpoint of the first user, or equidistance from the position of the viewpoint of the first user and a position of the second user. In some embodiments, the first computer system displays the communication session user interface maintaining a spatial arrangement (e.g., position and/or orientation) relative to the position of the viewpoint of the first user and the position of the second user, such that, were the position of the viewpoint of the first user to change while displaying the communication user interface, the first computer system would optionally update the position of display of the communication session user interface to maintain the spatial arrangement.

Additionally or alternatively, in some embodiments, the communication session user interface is as described with reference to method 1000. In some embodiments, the communication session user interface includes one or more virtual buttons for controlling one or more aspects of the communication session. In some embodiments, the one or more virtual buttons are not displayed in the three-dimensional environment before detecting the event. In some embodiments, the one or more buttons include a video conferencing button, a mute button configured to mute the first user, an exit button, and a screenshare button configured to share media content from the first computer system to the second computer system (e.g., in the communication session).

In some embodiments, (2202a) while the real-time communication session between the first user of the first computer system and the second user of the second computer system that are collocated in the physical environment is established, and while displaying the communication session user interface, the first computer system detects (2202d), via the one or more first input devices, a set of one or more inputs directed at the communication session user interface, the set of one or more inputs for adding a respective user of a respective computer system to the real-time communication session, such as the input from the hand 1116 of the first user 1101a (e.g., the hand 1116 of the first user 1101a performing an air pinch gesture) while attention (e.g., gaze) of the first user 1101a is directed to the option 2114h of the communication session user interface 2114, as indicated by gaze point 2110c, in FIG. 21K. In some embodiments, the respective user is a respective user of a respective computer system that is collocated in the physical environment with the first and second users. In some embodiments, the respective user is in a contact list of an application on the first computer system. In some embodiments, the respective user is a respective user of a respective computer system that is not collocated in the physical environment with the first and second users. For example, the respective user is optionally located in a physical environment that is different from (e.g., remote to) to the physical environment in which the first and second users are collocated. In some embodiments, the set of inputs is a sequence of inputs resulting in selection of a user interface element in the communication session user interface that corresponds to a request to add the respective user to the real-time communication session. In some embodiments, the set of inputs is a single selection input that corresponds to the request to add the respective user. In some embodiments, the set of input includes multiple inputs. For example, the first computer system optionally detects an air gesture (e.g., an air pinch gesture, an air tap gesture, or other gesture) performed by a hand of the first user, optionally while the gaze of the first user is directed to the communication session user interface (e.g., the actual physical body of the second user) or to a spatial representation of the second user, such as described with reference to method 1000. In some embodiments, were the set of inputs to include multiple inputs, the first computer system updates the communication session user interface in response to each input (or to a subset or the set of inputs) to confirm to the first user that the communication session user interface is responding to the input. In some embodiments, the first computer system displays the communication session user interface while the real-time communication session between the first and second users is active.

In some embodiments, in response to detecting the set of one or more inputs directed at the communication session user interface, and in accordance with a determination that one or more criteria are satisfied, the first computer system updates (2202e) the real-time communication session that is between the first user of the first computer system and the second user of the second computer system to be a real-time communication session between the first user of the first computer system, the second user of the second computer system, and the respective user of the respective computer system, such as shown with display of the representation 2120a of the added user, Brooke, in the first three-dimensional environment 1103 in FIG. 21M. In some embodiments, in response to detecting the set of inputs, the first computer system transmits a request to the respective computer system of the respective user that indicates that the first user requests the respective user to join the real-time communication session. In some embodiments, the criteria include a criterion that is satisfied when the respective user accepts the first user's request for the respective user to join the communication session (e.g., when the first computer system and/or the second computer system detects a notification that the respective user has accepted the first's request for the respective user to join the communication session). In some embodiments, the criteria includes a criterion that is satisfied were the real-time communication session between the first and second users to be active when the set of inputs directed at the communication session user interface were detected. In some embodiments, in response to the criteria being satisfied, the first computer system initiates a process to update the real-time communication session to be between the first, second, and respective users (e.g., instead of just between the first and second users). In some embodiments, content is being shared between the first and second users (e.g., such as the sharing of content described with reference to methods 800, 1000, 1200, 1400, 1600, 1800, and/or 2000), and updating the real-time communication session to be between the first, second, and respective users includes sharing the content with the respective user's computer system as well. In some embodiments, content is not being shared between the first and second users when the criteria are satisfied, and updating the real-time communication session to be between the first, second, and respective users does not include sharing content with the respective user's computer system since no content is being shared when the criteria are satisfied. In some embodiments, the first computer system adds the respective user to the communication session as described above without adding other users (e.g., independent of whether or not the other users are collocated in the physical environment with the first and/or second user, are remote to the physical environment of the first and second users and are in a contact list of an application on the first computer system, are collocated in a physical environment with the respective user). In some embodiments, the first computer system transmits a notification to the second computer system indicating that the respective user is now in the real-time communication session. In some embodiments, the respective computer system of the respective user transmits the notification to the second computer system indicating that the respective user in now in the real-time communication session. As such, in some embodiments, the first computer system adds the respective user to the real-time communication session between the first and second users, thus updating the real-time communication session to be a real-time communication session between the first, second, and respective users, in response to input directed at the communication session user interface for adding the respective user to the real-time communication session user interface and in accordance with the determination that the criteria is satisfied. Adding a third user to a communication session that is between the first and second user in response to input directed to a communication session user interface streamlines adding users to a communication session independent of whether or not the added user is collocated in the physical environment with the first and second users, and improves user experience during the real-time communication session.

In some embodiments, the event corresponding to the request to display the communication session user interface includes an input directed to the second user of the second computer system (e.g., such as described above with reference to step(s) 2202 and/or with reference to methods 1400 and/or 1600 where the attention of the first user is directed to another user (e.g., directed to a portion of the physical body or person of the second user)), such as shown with the communication session user interface 2114 being displayed in response to input that includes attention (e.g., gaze) of the first user 1101a in the communication session directed to the second user 1101b in the communication session, as indicated by gaze point 2110a, in FIG. 21C. Displaying the communication session user interface in response to input directed to the second user corresponds inputs directed to the second user specifically to requests to display the communication session user interface and reduces errors associated with the computer system mis-interpreting whether to display the communication session user interface.

In some embodiments, the respective user of the respective computer system is not collocated in the physical environment with the first user of the first computer system and the second user of the second computer system, such as the user Brooke who corresponding to the option 2114h of the communication session user interface 2114 in FIG. 21K. As such, the first computer system can add a remote user (e.g., a user that is not collocated in the physical environment with the first user) to the communication session between the first and second user using the communication session user interface. In some embodiments, the communication session user interface indicates the remote user (e.g., via indicating a name or username of the remote user). In some embodiments, the first user (and/or the second user) has previously interacted with the remote user, such as having been in a communication session with each other previously. Adding a non-collocated user to the communication session in response to input directed to the communication session user interface streamlines adding non-collocated users to the communication session and reduces errors associated with adding non-collocated users to the communication session.

In some embodiments, the respective user of the respective computer system is collocated in the physical environment with the first user of the first computer system and the second user of the second computer system. For example, were the option 2114f of the communication session user interface 2114 to be selected by the first user 1101a in FIG. 21G, the first computer system would optionally initiate a process to update the real-time communication session that is between the first user of the first computer system and the second user of the second computer system to be a real-time communication session between the first user of the first computer system, the second user of the second computer system, and the third user 1101c of the third computer system 101c. As such, the first computer system can add a local user (e.g., a user that is collocated in the physical environment with the first user) to the communication session between the first and second user using the communication session user interface. In some embodiments, the communication session user interface indicates the local user (e.g., via indicating a name or username of the local user). In some embodiments, the first user (and/or the second user) has previously interacted with the local user, such as having been in a communication session with each other previously. Adding a collocated user to the communication session in response to input directed to the communication session user interface streamlines adding collocated users to the communication session and reduces errors associated with adding collocated users to the communication session.

In some embodiments, while the real-time communication session between the first user of the first computer system, the second user of the second computer system, and the respective user of the respective computer system is established, the first computer system detects an event corresponding to an indication that a user in the real-time communication session (e.g., the first user, the second user, or the respective user) requests to add a second respective user of a second respective computer system to the real-time communication session. For example, were the second computer system to detect user input from the second user 1101b that requests to add an additional user to the communication session that is between the first user 1101a, the second user 1101b, and the user Brooke in FIG. 21M, the first computer system 101a would optionally detect an indication that the second user 1101b has requested to add the additional user to the communication session. In some embodiments, a communication session user interface is displayed in a three-dimensional environment of the user and the user provides input to the communication session user interface for adding the second respective user to the communication session, such as described above with reference to the first computer system detecting the set of one or more inputs for adding the respective user of the respective computer system to the real-time communication session. In some embodiments, the user's request to add the second respective user includes user input from the user and directed to a communication session user interface for adding the second respective user to the communication session, such as described above with reference to the first computer system detecting the set of one or more inputs for adding the respective user of the respective computer system to the real-time communication session. In some embodiments, the second respective user is collocated with the first, second, and/or respective user in the physical environment when the event is detected. In some embodiments, the second respective user is not collocated with the first, second, and/or respective user in the physical environment when the event is detected.

In some embodiments, in response to detecting the event corresponding to the indication that the user in the real-time communication session requests to add the second respective user of the second respective computer system to the real-time communication session, the first computer system updates the real-time communication session that is between the first user of the first computer system, the second user of the second computer system, and the respective user of the respective computer system to be a real-time communication session between the first user of the first computer system, the second user of the second computer system, the respective user of the respective computer system, and the second respective user of the second respective computer system. For example, in response to detecting the indication that the second user 1101b in FIG. 21M has requested to add the additional user to the communication session in FIG. 21M, and optionally in response to detecting another indication that the additional user has accept the request from the second user 1101b to be added to the communication session, the first computer system 101a would optionally update the communication session that is between the first user 1101a, the second user 1101b, and the user Brooke to be a communication session that is between the first user 1101a, the second user 1101b, the user Brooke, and the additional user that the second user requested to add. As such, in some embodiments, any user in the communication session (e.g., a user who shared content in the communication session or a user other than a user who shared content in the communication session) can add additional users to the communication session (e.g., can initiate a process to add one or more additional users to the communication session). In some embodiments, the user that adds an additional user to the communication session is sharing virtual content in the communication session. In some embodiments, the user that adds an additional user to the communication session is not sharing virtual content in the communication session. For example, the user that adds the additional user to the communication session is optionally a recipient of a sharing of virtual content that was initiated by another user in the communication session. Updating the communication session to include an additional user in response to detecting that a user in the communication session requests to add the additional user maintains consistency of the communication session between computer systems in the communication session.

In some embodiments, displaying the communication session user interface includes displaying a first set of one or more indications of users (e.g., a first set of one or more indications of one or more users) that are collocated with the first user in the physical environment and are not in the real-time communication session between the first user and the second user, such as the option 2114f and the option 2114g in the communication session user interface 2114 in FIG. 21F, and a second set of one or more indications of users (e.g., a second set of one or more indications of one or more users), different from the first set of users, that are not collocated with the first user in the physical environment and are not in the real-time communication session between the first user and the second user, such as the option 2114h and the option 2114i in the communication session user interface 2114 in FIG. 21F. In some embodiments, the first set of indications of users includes icons and/or textual representations of the users (e.g., names or usernames of the users). In some embodiments, the first set of indications of users indicates that the users included in the first set are collocated with the first user in the physical environment and are not in the real-time communication session between the first user and the second user. In some embodiments, were the first computer system to detect one or more users that are collocated with the first user in the physical environment and that are not in the communication session, the first computer system displays indication(s) of those user(s) in the communication session user interface. In some embodiments, the second set of indications of users includes icons and/or textual representations of the users (e.g., names or usernames of the users). In some embodiments, the second set of indications of users indicates that the users included in the second set are not collocated with the first user in the physical environment and are not in the real-time communication session between the first user and the second user. In some embodiments, were the first computer system to detect one or more users that are not collocated with the first user in the physical environment and that are not in the communication session, the first computer system displays indication(s) of those user(s) in the communication session user interface. In some embodiments, were the first computer system to detect one or more inputs selecting a first indication, the first computer system would initiate a process to add the user indicated by the first indication, and were the first computer system to detect one or more inputs selecting a second indication that is different from the first indication, the first computer system would initiate a process to add the user indication by the second indication (e.g., without initiating the process to add the user indicated by the first indication). Displaying in the communication session user interface different sets of indications of users that indicate whether or not the users are collocated with the first user in the physical environment allows the first user to add users to the communication session independent of whether or not the user is collocated with the first user in the physical environment.

In some embodiments, the first set of one or more indications of users is displayed with a first visual appearance (e.g., a first color, textual indication, or another kind of visual appearance) indicating that users included in the first set of one or more indications of users are collocated with the first user in the physical environment and are not in the real-time communication session between the first user and the second user, such as shown with the option 2114h that is selectable to request to add “Charlie” indicating “local” and the option 2114i that is selectable to request to add “Sarah” indicating “local” in FIG. 21F. For example, the first visual appearance optionally indicates that the users are collocated with the first user in the physical environment and are not in the real-time communication session between the first user and the second user. In some embodiments, the second set of one or more indications of users is displayed with a second visual appearance (e.g., a second color, textual indication, or another kind of visual appearance), different from the first visual appearance, indicating that users included in the second set of one or more indications of users are not collocated with the first user in the physical environment and are not in the real-time communication session between the first user and the second user, such as shown with the option 2114h that is selectable to request to add “Brooke” indicating “remote” and the option 2114i that is selectable to request to add “Avery” indicating “remote” in FIG. 21F. For example, the second visual appearance optionally indicates that the users are not collocated with the first user in the physical environment and are not in the real-time communication session between the first user and the second user. In some embodiments, were a user included in the first set (and thus be collocated with the first user in the physical environment and not be in the communication session between the first and second users), the indication of that user would have the first visual appearance, and were the user included in the second set (and thus not be collocated with the first user in the physical environment and not be in the communication session between the first and second users), the indication of that user would have the second visual appearance. In some embodiments, the first set of indications of users are displayed in a first list in the communication session user interface, and the first visual appearance includes the first set of indications of users being listed in the first list. In some embodiments, the second set of indications of users are displayed in a second list in the communication session user interface that is different from the first list, and the second visual appearance includes the second set of indications of users being listed in the second list. In some embodiments, the communication session user interface includes a bifurcated list that includes the first list and the second list. In some embodiments, for each user that is collocated with the first user in the physical environment and is not in the real-time communication session between the first user and the second user, the communication session user interface includes a respective indication that the user is collocated with the first user in the physical environment and is not in the real-time communication session between the first user and the second user, such as an icon, a symbol or another respective indication. In some embodiments, for each user that is not collocated with the first user in the physical environment and is not in the real-time communication session between the first user and the second user, the communication session user interface includes a respective indication that the user is not collocated with the first user in the physical environment and is not in the real-time communication session between the first user and the second user, such as an icon, a symbol or another respective indication. Displaying in the communication session user interface different sets of indications of users with different visual appearances based on whether or not the users are collocated with the first user in the physical environment indicates whether a specific user is collocated with the first user, and reduces errors associated with adding users to the communication session.

In some embodiments, while displaying the communication session user interface, the first computer system detects a change in number of users that are collocated with the first user in the physical environment and are not in the real-time communication session between the first user and the second user, such as the first computer system 101a detecting that the user 1101d is no longer in the physical environment 1105 with the first user 1101a as shown from the overhead view 2102g in FIG. 21G to the overhead view 2102i in FIG. 21I, where the user 1101d is not in the overhead view in FIG. 21I. In some embodiments, the first computer system detects the change while not displaying the communication session user interface. In some embodiments, the first computer system displays the communication session user interface, then ceases display of the communication session user interface, and while the communication session user interface is not being displayed, the first computer system detects the change. In some embodiments, in response to detecting the change, the first computer system updates display, via the one or more first display generation components, of the communication session user interface in accordance with the change, such as shown with the communication session user interface 2114 not including the option 2114g as it did in FIG. 21G since the user 1101d is no longer (collocated) in the physical environment 1105 with the first user 1101a as shown with the overhead view 2102i not including the user 1101d in FIG. 21I. For example, were a first respective user included in the first set of indications of users to leave the room in which the first user is located (e.g., to cease being collocated in the physical environment with the first user), the first computer system optionally updates the communication session user interface to reflect that the first respective user is no longer included in the first set of indications of users. For example, were the first set of indications of users to include a first indication of the first respective user, in response to detecting that the first respective user has left the room in which the first user is located (e.g., detecting that the first respective user and the first user are no longer collocated in the physical environment of the first user), the first computer system optionally ceases display of the first indication of the first respective user in the first set of indications of users and optionally displays an indication of the first respective user in the second set of indications of users. As another example, were a first respective user included in the second set of indications of users to enter the room in which the first user is located (e.g., to become collocated in the physical environment with the first user), the first computer system optionally updates the communication session user interface to reflect that the first respective user is no longer included in the second set of indications of users. For example, were the second set of indications of users to include a first indication of the first respective user, in response to detecting that the first respective user has entered the room in which the first user is located (e.g., detecting that the first respective user and the first user are collocated in the physical environment of the first user), the first computer system optionally ceases display of the first indication of the first respective user in the second set of indications of users and optionally displays an indication of the first respective user in the first set of indications of users (e.g., optionally initiates a process to display the indication of the first respective user in the first set of indications of users). Updating the communication session user interface in response to detecting a change in a number of users that are collocated with the first user in the physical environment and are not in the communication session between the first user and the second user maintains consistency of how users are indicated in the communication session user interface with their current status of being collocated or not with the first user, and reduces errors associated with adding users to the communication session.

In some embodiments, in accordance with a determination that the change in number of users that are collocated with the first user in the physical environment and are not in the real-time communication session between the first user and the second user is a decrease in number, updating display of the communication session user interface in accordance with the change includes reducing a number of indications of users in the first set of one or more indications of users, such as shown with the communication session user interface 2114 in FIG. 211 including less options of users to add than the communication session user interface 2114 in FIG. 21G since the user 1101d is no longer collocated in the physical environment 1105 with the first user 1101a in FIG. 21G. As such, in some embodiments, the first computer system reduces the number of indications of users in the first set of indications of users in the communication session user interface should the number of users that are collocated with the first user in the physical environment and are not in the communication session between the first user and the second user decrease. Reducing the number of users in the first set of indication of users in the communication session user interface in response to detecting a reduction in the number of users that are collocated with the first user in the physical environment and are not in the communication session between the first user and the second user maintains consistency of the first set of indications of users just including users that are currently collocated with the first user, and reduces errors associated with adding users to the communication session.

In some embodiments, in accordance with a determination that the change in number of users that are collocated with the first user in the physical environment and are not in the real-time communication session between the first user and the second user is an increase in number, updating display of the communication session user interface in accordance with the change includes increasing a number of indications of users in the first set of one or more indications of users. For example, were the user Brooke who corresponds to the option 2114h of the communication session user interface 2114 in FIG. 21F to become collocated in the physical environment 1105 with the first user 1101a, should the first computer system 101a display the communication session user interface 2114 of FIG. 21G, the communication session user interface 2114 of FIG. 21G would further include the option 2114h that corresponds to the user Brooke. As such, in some embodiments, the first computer system increases the number of indications of users in the first set of indications of users in the communication session user interface should the number of users that are collocated with the first user in the physical environment and are not in the real-time communication session between the first user and the second user increase. Increasing the number of users in the first set of indications of users in the communication session user interface in response to detecting an increase in the number of users that are collocated with the first user in the physical environment and are not in the communication session between the first user and the second user maintains consistency of the first set of indications of users just including users that are currently collocated with the first user, and reduces errors associated with adding users to the communication session.

In some embodiments, updating display, via the one or more first display generation components, of the communication session user interface in accordance with the change includes changing, in a first direction of change (e.g., an increase or a decrease), a number of indications of users in the first set of one or more indications of users by a first amount, such as shown with the removal of the option 2114g corresponding to the user 1101d from the communication session user interface 2114 from FIG. 21G to FIG. 21I and changing, in a second direction of change (e.g., an increase or a decrease), different from the first direction of change, a number of indications of users in the second set of one or more indications of users by the first amount, such as shown with the addition of the option 2114g corresponding to the user 1101d from the communication session user interface 2114 from FIG. 21H to FIG. 21J. For example, were the number of users that are collocated with the first user and not in the communication session between the first user and the second user to change by a first amount (e.g., to increase or to decrease by the first amount (e.g., 1, 2, 3, 4, or another amount)), the first computer system would optionally update the first set of indications of users by the first amount and also update the second set of indications of users by the first amount. For example, while displaying the communication session user interface, were a user to not be collocated with the first user and thus included in the second set of indications of users, and then to later become collocated with the first user in the physical environment (e.g., were the first computer system to detect that the user has become collocated with the first user while displaying the communication session user interface), the first computer system optionally moves that user from being indicated in the second set of indications of users, which indicates users that are not collocated with the first user and are not in the communications session between the first user and the second user, to being indicated in the first set of indications of users, which indicates users that are collocated with the first user and are not in the communications session between the first user and the second user. As another example, while displaying the communication session user interface, were a user to be collocated with the first user and thus included in the first set of indications of users, and then to later cease being collocated with the first user in the physical environment (e.g., were the first computer system to detect that the user is no longer collocated with the first user while displaying the communication session user interface), the first computer system optionally moves that user from being indicated in the first set of indications of users, which indicates users that are collocated with the first user and are not in the communications session between the first user and the second user, to being indicated in the second set of indications of users, which indicates users that are not collocated with the first user and are not in the communications session between the first user and the second user. As such, in some embodiments, the first computer system updates the communication session user interface so that a respective user is indicated in the proper place in the communication session user interface—as collocated with the first user in the physical environment and not in the real-time communication session between the first user and the second user or as not collocated with the first user in the physical environment and not in the real-time communication session between the first user and the second user. In some embodiments, were a user to be indicated in the communication session user interface (e.g., in the first set of indications of users or in the second set of indications of users), and then the first computer system detects that the computer system of the user is no longer currently in use by the user, the first computer system optionally removes that user from being indicated in the communication session user interface. Changing the number of users in the first set of indications of users and in the second set of indications of users in the communication session user interface by the same amount in different directions of change in response to detecting a change in the number of users that are collocated with the first user in the physical environment and are not in the communication session between the first user and the second user maintains consistency of the first set of indications of users just including users that are currently collocated with the first user, maintains consistency of the second set of indications of users just including users that are not currently collocated with the first user, and reduces errors associated with adding users to the communication session.

In some embodiments, the respective user is not collocated with the first user in the physical environment, and wherein updating the real-time communication session that is between the first user of the first computer system and the second user of the second computer system to be the real-time communication session between the first user of the first computer system, the second user of the second computer system, and the respective user of the respective computer system includes displaying, via the one or more first display generation components, a three-dimensional representation of the respective user in a three-dimensional environment that is visible via the one or more first display generation components, such as the three-dimensional representation 2120a of the user Brooke in FIG. 21M. The three-dimensional environment that is visible via the first displays optionally includes one or more features of the first three-dimensional environment described with reference to methods 1200, 1400, 1600, 1800, and/or 2000. In some embodiments, the three-dimensional representation of the respective user includes one or more features of the first spatial visual representation of the second user described with reference to method 1000 and/or of the visual representations in method 800 and is also a representation of a user that is not collocated in the physical environment with the first user. For example, the three-dimensional representation is optionally a virtual avatar corresponding to the respective user (e.g., corresponding to the person of the respective user). In some embodiments, the three-dimensional representation of the respective user is an avatar of the respective user that includes a representation of a head, neck, torso, and/or arms of the respective user. In some embodiments, the avatars are user-personalized, user-selected, and/or user-created representations. In some embodiments, the three-dimensional representation of the respective user does not include live camera feed of the respective user from the respective computer system of the respective user, but the three-dimensional representation of the respective user optionally animates based on movement and/or talking of the respective user. In some embodiments, the three-dimensional representation of the respective user includes a live camera feed of the respective user. As such, in some embodiments, should the respective user be remote to the physical environment of the first user (e.g., not collocated in the physical environment with the first user, such as not in the same room as the first user) the first computer system displays a three-dimensional representation of the respective user indicating that the respective user is in now in the communication session. Displaying a three-dimensional representation of a user that is not in the physical environment of the first user when the user joins the communication session provides the first user with a visual representation of the user and reduces errors associated with determining whether the user has joined the communication session.

In some embodiments, the respective user is not collocated with the first user in the physical environment, and updating the real-time communication session that is between the first user of the first computer system and the second user of the second computer system to be the real-time communication session between the first user of the first computer system, the second user of the second computer system, and the respective user of the respective computer system includes displaying, via the one or more first display generation components, a two-dimensional representation of the respective user in a three-dimensional environment that is visible via the one or more first display generation components (e.g., an approximately two-dimensional representation of the respective user), such as the two-dimensional representation 2120b of the user Brooke in FIG. 21N. The three-dimensional environment that is visible via the first displays optionally includes one or more features of the first three-dimensional environment described with reference to methods 1200, 1400, 1600, 1800, and/or 2000. In some embodiments, the two-dimensional representation of the respective user includes one or more features of the first object corresponding to the non-spatial representation of the second user described with reference to method 1000 and is also a representation of a user that is not collocated in the physical environment with the first user. In some embodiments, the two-dimensional representation of the respective user is a displayed in a two-dimensional user interface. In some embodiments, the two-dimensional representation of the respective user includes live camera feed of the respective user from the respective computer system of the respective user. In some embodiments, the two-dimensional representation of the respective user does not include live camera feed of the respective user from the respective computer system of the respective user. Displaying a two-dimensional representation of a user that is in not in the physical environment of the first user when the user joins the communication session provides the first user with a visual representation of the user and reduces errors associated with determining whether the user has joined the communication session.

In some embodiments, the respective user is not collocated with the first user in the physical environment, and updating the real-time communication session that is between the first user of the first computer system and the second user of the second computer system to be the real-time communication session between the first user of the first computer system, the second user of the second computer system, and the respective user of the respective computer system includes displaying, via the one or more first display generation components, a representation of the respective user. In some embodiments, displaying the representation of the respective user includes in accordance with a determination that a spatial arrangement (e.g., a spatial arrangement such as described with reference to method 1600) between the first user and the second user (e.g., a relative positioning and/or orientation between the first user and the second user in the physical environment, such as a relative positioning and/or orientation between a viewpoint of the first user of the first computer system and a location of the second user of the second computer system) is a first spatial arrangement, displaying the representation of the respective user includes displaying the representation of the respective user at a first location in a first three-dimensional environment of the first user, such as the three-dimensional representation 2120a being displayed in the first three-dimensional environment 1103 at its illustrated location due the spatial arrangement between the first user 1101a and the second user 1101b in FIG. 21M, and in accordance with a determination that the spatial arrangement between the first user and the second user is a second spatial arrangement that is different from the first spatial arrangement, displaying the representation of the respective user includes displaying the representation of the respective user at a second location, different from the first location, in the first three-dimensional environment of the first user, such as the three-dimensional representation 2120a being displayed in the first three-dimensional environment 1103 at its illustrated location due the spatial arrangement between the first user 1101a and the second user 1101b in FIG. 21P. As such, in some embodiments, the first computer system displays the representation of the respective user at a location that is based on the locations of the users with which the first user is collocated in the physical environment and in the communication session when the respective user is added, such as described with reference to displaying a user interface at different locations based on the spatial arrangement between a viewpoint of the first user of the first computer system and a location of the second user of the second computer system in method 1600. Displaying a representation of a user at different locations based on a spatial arrangement of the first and second users in the communication session when the user is added to the communication session maintain consistency of display of the representation of the user at an optimal location based on the spatial arrangement between the first and second users, and reduces errors associated with determining whether or not the user is in the communication session.

In some embodiments, the respective user is not collocated with the first user in the physical environment, and while the real-time communication session between the first user of the first computer system and the second user of the second computer system is established, a user interface of an application is being shared between the first computer system and the second computer system (e.g., a messages user interface, maps user interface, media user interface, web browsing user interface, a game user interface, or another user interface of an application, such as a user interface of an application described with reference to methods 800, 1000, 1200, 1400, 1600, 1800, and/or 2000, being shared as described with reference to methods 1200, 1400, 1600, and/or 1800), and when the real-time communication session that is between the first user of the first computer system and the second user of the second computer system is updated to be the real-time communication session between the first user of the first computer system, the second user of the second computer system, and the respective user of the respective computer system, the user interface of the application is being shared between the first computer system, the second computer system, and the respective computer system. For example, in FIG. 21K, the first computer system 101a is optionally sharing the first user interface 1106 with the second computer system 101b, such that when the first computer system 101a adds the user Brooke to the communication session such that the communication session transitions from being a communication session between the first user 1101a and the second user 1101b to being a communication session between the first user 1101a, the second user 1101b, and the user Brooke, as described with reference to FIGS. 21K through 21N, the first user interface 1106 is still being shared in the communication session, including being now shared between the first user 1101a, the second user 1101b, and the user Brooke. In some embodiments, sharing the user interface of the application between the first computer system and the second computer system includes one or more features described with reference to sharing the respective user interface of the respective application in methods 1200, 1400, 1600, 1800. In some embodiments, sharing the user interface of the application between the first computer system, the second computer system, and the respective computer system includes one or more features described with reference to sharing the respective user interface of the respective application in methods 1200, 1400, 1600, 1800. As such, in some embodiments, content is being shared between users that are in the communication session when a user (e.g., a user that is not located in the physical environment) is added to the communication session, and in response to the adding of the user to the communication session, the content becomes shared with the user as well. Sharing content with an added user that was being shared between users of a communication session right before the added user joined the communication session maintain consistency of the communication session since the shared content is shared with the users that are in the communication session.

In some embodiments, the respective user is not collocated with the first user in the physical environment (e.g., the respective user is not in the physical environment of the first user, but is remote to the first user (e.g., does not share a visual and/or audio space in a physical environment with the first user)), and while the real-time communication session between the first user of the first computer system and the second user of the second computer system is established, a user interface of an application is not being shared between the first computer system and the second computer system (e.g., such as described with reference to method 1200, 1400, and/or 1600), and when the real-time communication session that is between the first user of the first computer system and the second user of the second computer system is updated to be the real-time communication session between the first user of the first computer system, the second user of the second computer system, and the respective user of the respective computer system, the user interface of the application is not being shared between the first computer system, the second computer system, and the respective computer system. For example, the first user 1101a is optionally not sharing a user interface of an application with the second user 1101b in the communication session and the second user 1101b is optionally not sharing a user interface of an application with the first user 1101a in the communication session when the first computer system 101a adds the user Brooke to the communication session, such as shown in FIG. 21Q, which includes the notification 2123a that indicates that no user interface is being shared between the first user 1101a and the second user 1101b. As such, in some embodiments, content is not being shared between users that are in the communication session when a user (e.g., a user that is not located in the physical environment) is added to the communication session. Maintaining no sharing of content in a communication session when another user joins should no content be shared in the communication session right before the user joins maintains consistency of the communication session when the user joins the communication session.

In some embodiments, while the real-time communication session between the first user of the first computer system, the second user of the second computer system, and the respective user of the respective computer system is active, the first computer system detects an indication that the respective user requests to share a respective user interface of a respective application (e.g., a messages user interface, maps user interface, media user interface, web browsing user interface, a game user interface, or another user interface of an application, such as a user interface of an application described with reference to methods 800, 1000, 1200, 1400, 1600, 1800, and/or 2000) in the real-time communication session, such as the indication 2122a that the user Brooke requests to share a user interface in FIG. 21T. For example, the first computer system optionally detects data including the indication transmitted from the respective computer system of the respective user. In some embodiments, the request to share the respective user interface includes one or more features of described with reference to sharing user interfaces (e.g., processes or steps involved in sharing of user interfaces) in methods 1200, 1400, 1600, and 1800, 2000, and/or 2200. For example, the indication that the respective user requests to share the respective user interface is optionally based on the respective computer system of the respective user detecting the selection of the first user interface element of method 1200, detecting the second (and first) input and that the one or more first criteria of method 1400 are met, detecting first input requesting movement of the respective user interface into a sharing zone as described with reference to method 1600, detecting selection of an option corresponding to content to share with the first computer system such as described with reference to plurality of selectable options in method 1800, and/or the various manners in which requests to share user interfaces are described with reference to methods 2000 and/or 2200.

In some embodiments, in response to detecting the indication, the first computer system displays, via the one or more first display generation components, the respective user interface of the respective application in a first three-dimensional environment of the first user, such as the maps user interface 2124 in FIG. 21S. In some embodiments, respective user interface of the respective application between the first computer system, the second computer system, and the respective computer system includes one or more features described with reference to sharing the respective user interface of the respective application in methods 1200, 1400, 1600, and/or 1800. In some embodiments, the first three-dimensional environment of the first user includes one or more features of the first three-dimensional environment described with reference to methods 1200, 1400, and/or 1600). In some embodiments, the respective user can initiate sharing of content (e.g., audio and/or visual content such as one or more user interfaces of one or more applications) into the communication session so that others (e.g., the first and second users) in the communication session can interact with the content even though they are not in the same physical environment as the respective user. In some embodiments, the first computer system displays the respective user interface in the three-dimensional environment of the first user at a first location and the second computer system displays the respective user interface in the three-dimensional environment of the second user at a location that is based on the first location. In some embodiments, the first location and the location correspond to a same corresponding physical location in the physical environment of the first and second users, such that the respective user interface is being displayed with spatial truth in the first and second three-dimensional environments. As such, in some embodiments, users who are remote to the first user (e.g., users that are not collocated with the first user in the physical environment of the first user, such as users that are not in the same room as the first user) and are in the communication session with the first user can initiate sharing of content into the communication session. Displaying content shared from the respective computer system of the respective user who is not collocated with the first user in a physical environment in response detecting that the respective user requests to share the content allows the respective user to share content to the communication session with other users that are in the communication session—even users that are not collocated in a physical environment with the respective user.

In some embodiments, while the real-time communication session between the first user of the first computer system, the second user of the second computer system, and the respective user of the respective computer system is active, the first computer system detects an indication that the second user requests to share a respective user interface of a respective application (e.g., a messages user interface, maps user interface, media user interface, web browsing user interface, a game user interface, or another user interface of an application, such as a user interface of an application described with reference to methods 800, 1000, 1200, 1400, 1600, 1800, and/or 2000) in the real-time communication session, such as the indication 2122a but it corresponding to a request from the second user 1101b instead of the user Brooke to share a user interface in the communication session. In some embodiments, the request to share the respective user interface includes one or more features of described with reference to sharing user interfaces (e.g., processes or steps involved in sharing of user interfaces) in methods 1200, 1400, 1600, and 1800, 2000, and/or 2200. For example, the indication that the second user requests to share the respective user interface is optionally based on the second computer system of the second user detecting the selection of the first user interface element of method 1200, detecting the second (and first) input and that the one or more first criteria of method 1400 are met, detecting first input requesting movement of the respective user interface into a sharing zone as described with reference to method 1600, detecting selection of an option corresponding to content to share with the first computer system such as described with reference to plurality of selectable options in method 1800, and/or the various manners in which requests to share user interfaces are described with reference to methods 2000 and/or 2200.

In some embodiments, in response to detecting the indication, the first computer system displays, via the one or more first display generation components, the respective user interface of the respective application in a first three-dimensional environment of the first user, such as the maps user interface 2124 in FIG. 21S being displayed in response to the first computer system 101a detecting the indication 2122a but it corresponding to a request from the second user 1101b instead of the user Brooke to share the maps user interface in the communication session. In some embodiments, the first three-dimensional environment of the first user includes one or more features of the first three-dimensional environment described with reference to methods 1200, 1400, and/or 1600). In some embodiments, the first computer system detects an indication that the first user requests to share the respective user interface of the respective application, and in response, the first computer system displays the respective user interface in the three-dimensional environment of the first user. In some embodiments, the second user can initiate sharing of content (e.g., audio and/or visual content such as one or more user interfaces of one or more applications) into the communication session so that others (e.g., the first and respective users) in the communication session can interact with the content independent of whether or not the others are collocated in the physical environment with the second user. As such, in some embodiments, users who are collocated with the first user in the physical environment of the first user, such as users who are in the same room as the first user) and are in the communication session with the first user can initiate sharing of content into the communication session. Displaying content shared from the second computer system of the second user who is collocated with the first user in a physical environment in response detecting that the second user requests to share the content allows the second user to share content to the communication session with other users that are in the communication session, independent of whether or not the other users are collocated in a physical environment with the second user.

It should be understood that the particular order in which the operations in method 2000 have been described is merely exemplary and is not intended to indicate that the described order is the only order in which the operations could be performed. One of ordinary skill in the art would recognize various ways to reorder the operations described herein.

FIGS. 23A through 23AU generally illustrate examples of a first computer system displaying a user interface and detecting and responding to input directed to a first control element that is concurrently displayed with the user interface, where the first control element is selectable to display a sharing user interface for the user interface, and/or displaying a user interface and detecting and responding to input corresponding to a request to initiate sharing of the user interface, in accordance with some embodiments.

In some embodiments, the first computer system concurrently displays the user interface and a plurality of control elements for the user interface. In some embodiments, the plurality of control elements includes a first control element that is selectable to display a sharing user interface for the user interface. In some embodiments, the first computer system detects and responds to input directed to the first control element by concurrently displaying the user interface and a sharing user interface for the user interface. In some embodiments, the sharing user interface includes options for initiating processes to sharing the user interface in different types of communication sessions. In some embodiments, the sharing user interface includes different options for initiating sharing of the user interface with different users that are collocated in a physical environment with the first user of the first computer system based on whether those users satisfy one or more criteria, such as whether those users are in contact list of an application on the first compute system. These and other embodiments of the disclosure are generally shown throughout FIGS. 23A through 23AU, and the embodiments described with reference to FIGS. 23A through 23AU are further described with reference to method 2400 and method 2500.

FIG. 23A shows the first computer system 101a (e.g., an electronic device) worn by the first user 1101a of the first computer system 101a displaying, via the display generation components 120 (e.g., display generation components 1-122a and 1-122b of FIG. 1), the first three-dimensional environment 1103 from a viewpoint of the first user 1101a (e.g., first user 1101a in overhead view 2102a of the first three-dimensional environment 1103) of the first computer system 101a (e.g., facing the back wall of the physical environment 1105 in which the first computer system 101a is located). The first user interface 1106 and the second user interface 1108 are likewise in the first three-dimensional environment 1103. Further, in FIG. 23A, the first user 1101a of the first computer system 101a is in a room (e.g., a physical environment 1105) that includes the second user 1101b of the second computer system 101b, the third user 1101c of the third computer system 101c, and a fourth user 1101d of a fourth computer system 101d, as shown in overhead view 2302a. Overhead views 2302a through 2302au in FIGS. 23A through 23AU show relative positioning of objects in the illustrated three-dimensional environment in a horizontal dimension and a depth dimension in the respective figure and the view of the three-dimensional environment shown in the display generation component 120 in the respective figure shows the relative positioning of objects in the three-dimensional environment in a vertical dimension and a horizontal dimension (and, optionally in a depth dimension).

In FIG. 23A, the first computer system 101a displays the first user interface 1106 and the second user interface 1108 in the first three-dimensional environment 1103. The first user interface 1106 and the second user interface 1108 are private to the first computer system 101a in FIG. 23A, such as described with reference to FIGS. 17A-1 and FIGS. 17A-2. That is, the first user interface 1106 and the second user interface 1108 are not being shared with the second computer system 101b, the third computer system, 101c, or the fourth computer system 101d in FIG. 23A. For example, FIG. 23B shows a view of a second three-dimensional environment 1107 that is being presented via the second computer system 101b while the first computer system 101a is presenting the view of the first three-dimensional environment 1103 in FIG. 23A. As shown in FIG. 23B, the second three-dimensional environment 1107 does not include the first user interface 1106 or the second user interface 1108 because those user interfaces are private to the first computer system 101a in FIG. 23A and are not being shared. Additionally, a view of the third three-dimensional environment displayed by the third computer system 101c and a view of the fourth three-dimensional environment displayed by the fourth computer system 101d in FIG. 23A would likewise not include the first user interface 1106 or the second user interface 1108 because those user interfaces are private to the first computer system 101a in FIG. 23A and are not being shared.

In FIG. 23A, the first user interface 1106 includes a plurality of control elements for the first user interface 1106. The plurality of control elements for the first user interface 1106 includes control element 2306a, which is optionally selectable to close or ceasing displaying the first user interface 1106, grabber user interface element 1106b, which is selectable to move the first user interface 1106 in the first three-dimensional environment 1103, and a control element 2306c, which is selectable to display a sharing user interface for the first user interface 1106. The plurality of control elements for the first user interface 1106 are described further with reference to methods 2400 and/or 2500.

The second user interface 1108 includes a plurality of control elements for the second user interface 1108. The plurality of control elements for the second user interface 1108 includes control element 2308a, which is optionally selectable to close or ceasing displaying the second user interface 1108, grabber user interface element 1108b which is selectable to move the second user interface 1108 in the first three-dimensional environment 1103, and a control element 2308c, which is selectable to display a sharing user interface for the second user interface 1108. The plurality of control elements for the second user interface 1108 are described further with reference to methods 2400 and/or 2500.

In FIG. 23C, the first computer system 101a detects an input directed at the control element 2306c that is selectable to display the sharing user interface for the first user interface 1106. For example, while displaying the view of the first three-dimensional environment 1103 in FIG. 23A, the first computer system 101a optionally detects an input directed at the control element 2306c, as shown in FIG. 23C. In some embodiments, the input includes attention 2310a (e.g., based on gaze) of the first user 1101a directed at the control element 2306c while the hand 1116 of the first user 1101a performs an air pinch gesture (e.g., the thumb and index finger of the hand of the user coming into contact with each other and then the release thereof). In some embodiments, in response to detecting the input directed at the control element 2306c, the first computer system 101a displays the sharing user interface 2312 for the first user interface 1106, as shown in FIG. 23D.

In FIG. 23D, the sharing user interface 2312 for the first user interface 1106 includes options for initiating processes to share the first user interface 1106 in different types of communication sessions. For example, the sharing user interface 2312 includes a selectable option 2312a for initiating a process to share the first user interface 1106 in one type of communication session (e.g., a second type of communication session, such as the second type of communication session described with reference to methods 2400/2500) and includes selectable option 2312b and selectable option 2312b for initiating a process to share the first user interface 1106 in another type of communication (e.g., (e.g., a first type of communication session, such as the first type of communication session described with reference to methods 2600/2700). In some embodiments, the selectable option 2312b is selectable to invite (e.g., include) the second user 1101b of the second computer system 101b (“Alice”) to the sharing of the first user interface 1106 in the first type of communication session. In some embodiments, the selectable option 2312b is selectable to invite (e.g., include) the third user 1101c of the third computer system 101c (“Charlie”) to the sharing of the first user interface 106 in the first type of communication session.

In some embodiments, the first computer system 101a displays the selectable option 2312b corresponding to the second user 1101b (“Alice”) and the selectable option 2312c corresponding to the third user 1101c (“Charlie) because the first user 1101a of the first computer system 101a (“Bella”) is collocated in the physical environment 1105 with the second user 1101b (“Alice”) and the third user 1101c (“Charlie) and because the second user 1101b and the third user 1101c meet one or more criteria, such as the one or more criteria described with reference to method 2500. For example, the second user 1101b and the third user 1101c optionally satisfy the one or more criteria because they are optionally in a contact list of an application on the first computer system 101a in FIG. 23D, such as the contact list of the application described with reference to methods 2400 and/or 2500. In some embodiments, in FIG. 23D, the first computer system 101a does not display a selectable option corresponding to the fourth user 1101d (e.g., a selectable option corresponding to the fourth user 1101d (e.g., that indicates an identifier such as a name or username of the fourth user 1101d) that is selectable to invite (e.g., include) the fourth user 1101d to the sharing of the first user interface 1106 in the first type of communication session in FIG. 23D because the fourth user 1101d does not satisfy the one or more criteria described above.

In FIG. 23D, the sharing user interface 2312 for the first user interface 1106 also includes a selectable option 2312d for initiating a process for enabling sharing of the first user interface 1106 in the first type of communication session with users who are collocated in the physical environment and do not meet the one or more criteria (e.g., the one or more criteria described with reference to method 2500), such as users who are not in a contact list of an application on the first computer system 101a. Further details of the selectable option 2312d are described below.

Additionally, in some embodiments, in response to detecting the input directed at the control element 2306c, the first computer system 101a updates display of the control element 2306c, such as shown from FIG. 23C to FIG. 23D. For example, in FIG. 23D, the control element 2306c includes an icon (e.g., a sharing icon, art, or graphic) while in FIG. 23C the control element 2306c does not include the icon. Further details regarding changes in visual appearances of the control element 2306c are described with reference to methods 2400/2500.

In FIG. 23D, the sharing user interface 2312 for the first user interface 1106 also includes a selectable option 2312e. In some embodiments, the selectable option 2312e is selectable to update the sharing user interface 2312 for the first user interface 1106 to include options for configuring the sharing of the first user interface 1106 in the first type of communication session with the user(s) that the first user 1101a selects, such as described below. Further details regarding the selectable option 2312e are described with reference to methods 2400/2500.

In FIG. 23E, the first computer system 101a detects an input directed to the selectable option 2312b of the sharing user interface 2312 for the first user interface 1106, which is selectable to invite (e.g., include) the second user 1101b of the second computer system 101b (“Alice”) to the sharing of the first user interface 1106 in the first type of communication session. In some embodiments, the input includes attention 2310b (e.g., based on gaze) of the first user 1101a directed at the selectable option 2312b while the hand 1116 of the first user 1101a performs an air pinch gesture (e.g., the thumb and index finger of the hand of the user coming into contact with each other and then the release thereof), as shown in FIG. 23E. In some embodiments, in response to detecting the input directed at the selectable option 2312b, the first computer system 101a updates display of the selectable option 2312b to include an indication 2312b-1 (e.g., a highlight, check mark, or another type of visual indication) that notifies the first user 1101a that the second user 1101b (“Alice”) will be invited to the sharing of the first user interface 1106 in the first type of communication session when the first type of communication session is established, as shown in FIG. 23F.

From FIG. 23F to FIG. 23G, the first computer system 101a detects an input directed at the selectable option 2312c of the sharing user interface 2312 for the first user interface 1106, which is selectable to invite (e.g., include) the third user 1101c of the third computer system 101c (“Charlie”) to the sharing of the first user interface 1106 in the first type of communication session. In some embodiments, the input includes attention 2310c (e.g., based on gaze) of the first user 1101a directed at the selectable option 2312c while the hand 1116 of the first user 1101a performs an air pinch gesture (e.g., the thumb and index finger of the hand of the user coming into contact with each other and then the release thereof). In some embodiments, in response to detecting the input directed at the selectable option 2312c, the first computer system 101a updates display of the selectable option 2312c to include an indication 2312c-1 (e.g., a highlight, check mark, or another type of visual indication) that notifies the first user 1101a that the third user 1101c (“Charlie”) will be invited to the sharing of the first user interface 1106 in the first type of communication session when the first type of communication session is established, as shown in FIG. 23G. Thus, in FIG. 23G, the selection option 2312b and the selectable option 2312c include an indication that that notifies the first user 1101a that the indicated users will be included the sharing of the first user interface 1106 in first type of communication session when the first type of communication session is established, in accordance with the respective inputs directed to the respective selectable options described with reference to FIGS. 23E and 23F.

In FIG. 23G, the first computer system 101a detects an input directed at the selectable option 2312e described above. In some embodiments, the selectable option 2312e is selectable to updating display of the sharing user interface 2312 to include options for configuring the sharing of the first user interface 1106 with the users with which the first user 1101a has selected to include in the first type of communication session. In FIG. 23G, the users with which the first user 1101a has selected to include in the first type of communication session include the second user 1101b and the third user 1101c, as indicated by the indication 2312b-1 and the indication 2312c-1, respectively. In some embodiments, the input directed at the selectable option 2312e includes attention 2310d (e.g., based on gaze) of the first user 1101a directed at the selectable option 2312e while the hand 1116 of the first user 1101a performs an air pinch gesture (e.g., the thumb and index finger of the hand of the user coming into contact with each other and then the release thereof). In some embodiments, in response to detecting the input directed at the selectable option 2312e, the first computer system 101a updates display of the sharing user interface 2312 to include options for configuring the sharing of the first user interface 1106 with the selected users (e.g., the second user 1101b and the third user 1101c), as shown in FIG. 23H.

In FIG. 23H, the sharing user interface 2312 indicates the application (e.g., the Photos application) that is being configured to be shared in the first type of communication. In addition, in FIG. 23H, the sharing user interface 2312 includes selectable options 2312f through 2312h. Selectable option 2312f is selectable to cause the first user interface 1106 to be shared in a view only mode. In some embodiments, in the view-only mode, users party to the first type of communication session other than the sharer (e.g., the first user 1101a of the first computer system 101a) can view the first user interface 1106 and cannot edit (or otherwise modify) the content of the first user interface 1106. For example, in the view-only mode, the second user 1101b and the third user 1101c can view the first user interface 1106 and cannot edit (or otherwise modify) the content of the first user interface 1106. Selectable option 2312g is selectable to cause the first user interface 1106 to be shared in an editing mode. In some embodiments, in the editing mode, users party to the first type of communication session other than the sharer (e.g., the first user 1101a of the first computer system 101a) can view and edit the first user interface 1106. For example, in the editing mode, the second user 1101b and the third user 1101c can view and edit the first user interface 1106. The selectable option 2312f and the selectable option 2312g are described further with reference to method 2400. Selectable option 2312h in FIG. 23H is selectable to cancel the process of sharing the first user interface 1106.

In FIG. 23H, the first computer system 101a detects an input directed the selectable option 2312g, which is selectable to cause the first user interface 1106 to be shared in the first type of communication session in the editing mode as described above. In some embodiments, the input directed the selectable option 2312g includes attention 2310e (e.g., based on gaze) of the first user 1101a directed at the selectable option 2312g while the hand 1116 of the first user 1101a performs an air pinch gesture (e.g., the thumb and index finger of the hand of the user coming into contact with each other and then the release thereof). In some embodiments, in response to detecting the input directed at the selectable option 2312g, the computer system 101a ceases displaying the sharing user interface 2312, as shown in FIG. 23I, initiates sharing of the first user interface 1106 with the computer systems that correspond to the selected users (e.g., the second computer system 101b and the third computer system 101c), and updates the visual appearance of the control element 2306c to indicate that a process for sharing the first user interface 1106 is in progress and is not yet complete. For example, in FIG. 23I, the control element 2306c includes a buffer animation while in FIG. 23H the control element 2306c includes an icon without including the buffer animation. Further details regarding changes in visual appearances of the control element 2306c are described with reference to methods 2400/2500.

In some embodiments, in response to detecting the input directed at the selectable option 2312g in FIG. 23I, the first computer system 101a transmits to the second computer system 101b and the third computer system 101c respective indications requesting that their users join the first type of communication session for sharing of the first user interface 1106. In some embodiments, in response to detecting an indication requesting that the second user 1101b (“Alice”) join the first type of communication session with the first user 1101a (“Bella”) for sharing of the first user interface 1106, the second computer system 101b displays a user interface element 2314 including options for the second user 1101b (“Alice”) to accept or deny the request, as shown in FIG. 23J. In FIG. 23J, the user interface element 2314 includes a first option 2314a that is selectable to accept the request and a second option 2314b that is selectable to deny the request. In some embodiments, the user interface element 2314 visually indicates the specific application that the first user 1101a is requesting to share in the first type of communication. For example, in some embodiments, the user interface element 2314 includes a visual indication that the first user 1101a is requesting to share a user interface of a photos application. Additionally, in FIG. 23J, the second computer system 101b detects an input directed at the first option 2314a that is selectable to accept the request. For example, the second computer system 101b optionally detect attention 2310f (e.g., based on gaze) of the second user 1101b (“Alice”) directed at the first option 2314a while the hand 1116a performs an air pinch gesture (e.g., the thumb and index finger of the hand of the user coming into contact with each other and then the release thereof). In some embodiments, in response to detecting the input directed at the first option 2314a, the second computer system 101b transmits an indication to the first computer system 101a that indicates that the second user 1101b (“Alice”) has accepted the request to join the first type of communication session with the first user 1101a for sharing of the first user interface 1106.

Likewise, in some embodiments, in response to detecting an indication requesting that the third user 1101c (“Charlie”) join the first type of communication session with the first user 1101a for sharing of the first user interface 1106, the third computer system 101c displays the user interface element 2314 including options for the third user 1101c to accept or deny the request, as shown in FIG. 23K. Additionally, in FIG. 23K, the third computer system 101c detects an input directed at the first option 2314a that is selectable to accept the request. For example, the third computer system 101c optionally detect attention 2310g (e.g., based on gaze) of the third user 1101c directed at the first option 2314a while the hand 1116b of the third user 1101c performs an air pinch gesture (e.g., the thumb and index finger of the hand of the user coming into contact with each other and then the release thereof). In some embodiments, in response to detecting the input directed at the first option 2314a, the third computer system 101c transmits an indication to the first computer system 101a that indicates that the third user 1101c has accepted the request to join the first type of communication session with the first user 1101a for sharing of the first user interface 1106.

In some embodiments, the first computer system 101a detects and responds to input directed at the control element 2306c while the process for sharing the first user interface 1106 is in progress and is not yet complete (e.g., while the control element 2306c has the illustrated visual appearance in FIG. 23I), such as shown from FIG. 23L to FIG. 23M. In FIG. 23L, the first computer system 101a detects an input directed at the control element 2306c while the process for sharing the first user interface 1106 is in progress and is not yet complete. In some embodiments, the input directed at the control element 2306c in FIG. 23L includes attention 2310h (e.g., based on gaze) of the first user 1101a directed at the control element 2306c while the hand 1116 of the first user 1101a performs an air pinch gesture (e.g., the thumb and index finger of the hand of the user coming into contact with each other and then the release thereof). In some embodiments, in response to detecting the input directed at the control element 2306c in FIG. 23L, the first computer system 101a displays the sharing user interface 2312 for the first user interface 1106, as shown in FIG. 23M. In FIG. 23M, the sharing user interface 2312 for the first user interface 1106 includes status indications of the sharing of the first user interface 1106 with the selected users. For example, in FIG. 23M the sharing user interface 2312 includes a first status indication 2312i that notifies the first user 1101a that the second user 1101b (“Alice”) has accepted the request to join the first type of communication session with the first user 1101a, but additional steps are being performed between the first computer system 101a and the second computer system 101b for the second computer system 101b to display the first user interface 1106, and includes a second status indication 2312j that notifies the first user 1101a that the third user 1101c has not yet accepted or denied the request to join the first type of communication session with the first user 1101a. In FIG. 23M, the sharing user interface 2312 for the first user interface 1106 also includes a respective option that is selectable to invite additional users to the first type of communication session that the first computer system 101a is attempting to establish with the second user 1101b of the second computer system 101b and the third user 1101c of the third computer system 101c.

FIGS. 23N through 23P illustrate the first computer system 101a sharing the first user interface 1106 with the second computer system 101b and the third computer system 101c, in accordance with some embodiments. In some embodiments, in response to the second user 1101b successfully joining the first type of communication session with the first user 1101a for sharing of the first user interface 1106, the second computer system 101b displays the first user interface 1106 at a location in the second three-dimensional environment 1107 that corresponds to a location of display of the first user interface 1106 in the first three-dimensional environment 1103 of the first user 1101a, as shown in FIGS. 23N and 23O. In some embodiments, in response to the third user 1101c successfully joining the first type of communication session with the first user 1101a for sharing of the first user interface 1106, the third computer system 101c displays the first user interface 1106 at a location in the third three-dimensional environment 1509 that corresponds to a location of display of the first user interface 1106 in the first three-dimensional environment 1103 of the first user 1101a, as shown in FIGS. 23N and 23P. In some embodiments, in response to the second user 1101b and the third user 1101c successfully joining the first type of communication session with the first user 1101a for sharing of the first user interface 1106, the second computer system 101b displays the first user interface 1106 at a location in the second three-dimensional environment 1107 that corresponds to a location of display of the first user interface 1106 in the first three-dimensional environment 1103 of the first user 1101a and the third computer system 101c displays the first user interface 1106 at a location in the third three-dimensional environment 1509 that corresponds to a location of display of the first user interface 1106 in the first three-dimensional environment 1103 of the first user 1101a, as shown in FIGS. 23N through 23P.

Additionally, as shown in FIG. 23N, when the first computer system 101a shares the first user interface 1106 with a respective computer system, the first computer system 101a changes the visual appearance of the control plurality of control elements for the first user interface 1106. For example, in FIG. 23A, in which the first computer system 101a is not sharing the first user interface 1106, the first computer system 101a optionally displays the plurality of control elements for the first user interface 1106 with a first visual appearance (e.g., a first color, a first brightness, a first amount of contrast, a first size, and/or another visual appearance). Continuing with this example, in FIG. 23N, in which the first computer system 101a is sharing the first user interface 1106, the first computer system 101a displays the plurality of control elements for the first user interface 1106 with a second visual appearance (e.g., a second color, a second brightness, a second amount of contrast, a second size, and/or another visual appearance) that is different from the first visual appearance, optionally to indicate that the first user interface 1106 is currently being shared. Additionally, as shown in FIG. 23N, the plurality of control elements for the first user interface 1106 have the second visual appearance even though input directed to the plurality of control elements for the first user interface 1106 is not being detected in FIG. 23N. In some embodiments, the plurality of control elements for the first user interface 1106 that are displayed in the second three-dimensional environment 1107 of the second user 1101b, as shown in FIG. 23O, and the third three-dimensional environment 1509 of the third user 1101c, as shown in FIG. 23P, have the second visual appearance as well, optionally to visually indicate that the first user interface 1106 is a shared user interface. In some embodiments, the control element 2306c in FIG. 23N has a visual appearance that is different from the visual appearance of the other control elements for the first user interface 1106 in FIG. 23N. Displaying the first control element with different visual appearances based on whether or not the user interface corresponding to the first control element is currently being shared is described with reference to methods 2400 and/or 2500. Additionally, note that in FIG. 23N, the plurality of control elements for the first user interface 1106 (e.g., control element 2306a, control element 1106b, and control element 2306c) have the second visual appearance while the plurality of control elements 2308 for the second user interface 1108 1106 (e.g., control element 2308a, control element 1108b, and control element 2308c) have an appearance that is different from the second visual appearance (e.g., the plurality of control elements for the second user interface 1108 in the illustrated figure optionally have the first visual appearance described above) optionally because the first user interface 1106 is being shared while the second user interface 1108 is not being shared in the illustrated figure. Further, note that in FIG. 23N, the first computer system 101a does not display the pill 1106a of FIG. 11E-1 that indicates that the first user interface 1106 is being shared with the second user 1101b of the second computer system 101b in FIG. 11E-1; in FIG. 23N, the visual appearance of the plurality of control elements for the first user interface 1106 (e.g., control element 2306a, control element 1106b, and control element 2306c), and optionally, more specifically, the visual appearance of the control element 2306c indicates the first user interface 1106 is being shared in the illustrated figure. Further, note that in FIG. 23N, the visual appearance of the of the plurality of control elements for the first user interface 1106 (e.g., control element 2306a, control element 1106b, and control element 2306c), and optionally, more specifically, the visual appearance of the control element 2306c, does not indicate the users who are party to the sharing of the first user interface 1106. For example, unlike the pill 1106a in FIG. 11E-1, the visual appearance of the of the plurality of control elements for the first user interface 1106 (e.g., control element 2306a, control element 1106b, and control element 2306c), and optionally, more specifically, the visual appearance of the control element 2306c, does not include an indication or identification that the first user interface 1106 is being shared with the second user 1101b and the third user 1101c even though the first user interface 1106 is being shared with the second user 1101b and the third user 1101c in the illustrated figure.

FIGS. 23Q and 25R illustrate an example of the first computer system 101a detecting and responding to input directed at the control element 2308c of the second user interface 1108 while the first computer system 101a is sharing the first user interface 1106 with the second computer system 101b and the third computer system 101c as described with reference to FIGS. 23N through 23P. In FIG. 23Q, the first computer system 101a detects an input directed at the control element 2308c of the second user interface 1108 while the first computer system 101a is sharing the first user interface 1106 with the second computer system 101b and the third computer system 101c. In FIG. 23Q, the input directed at the control element 2308c of the second user interface 1108 includes attention 2310i (e.g., based on gaze) of the first user 1101a directed at the control element 2308c of the second user interface 1108 while the hand 1116 of the first user 1101a performs an air pinch gesture (e.g., the thumb and index finger of the hand of the user coming into contact with each other and then the release thereof). In response to detecting the input directed at the control element 2308c of the second user interface 1108 in FIG. 23Q, the first computer system 101a displays the sharing user interface 2312 for the second user interface 1108, as shown in FIG. 23R. In FIG. 23R, the sharing user interface 2312 for the second user interface 1108 includes selectable option 2312b including the indication 2312b-1 and includes the selectable option 2312c including the indication 2312c-1, even though the second user interface 1108 is not currently being shared, in addition to the other options described with reference to the sharing user interface 2312 for the first user interface 1106 in FIG. 23D. Additionally, note that the sharing user interface 2312 for the second user interface 1108 in FIG. 23R includes the indication 2312b-1 in the selectable option 2312b and the indication 2312c-1 in the selectable option 2312c in response to detecting the input directed at the control element 2308c of the second user interface 1108 in FIG. 23Q and not in response to input directed at the selectable option 2312b and/or input directed at the selectable option 2312c of the sharing user interface 2312 for the second user interface 1108. In some embodiments, the sharing user interface 2312 for the second user interface 1108 in FIG. 23R includes the indication 2312b-1 in the selectable option 2312b and the indication 2312c-1 in the selectable option 2312c because the first user interface 1106 is being shared in the first type of communication session with the second user 1101b of the second computer system 101b (e.g., “Alice”) and the third user 1101c of the third computer system 101c (e.g., “Charlie”) when the input directed at the control element 2308c of the second user interface 1108 in FIG. 23Q is detected.

FIGS. 23S and 23T illustrate an example of the first computer system 101a detecting and responding to input directed at the selectable option 2312e of the sharing user interface 2312 for the second user interface 1108, in accordance with some embodiments. In FIG. 23S, the first computer system 101a detects an input directed at the selectable option 2312e of the sharing user interface 2312 for the second user interface 1108 while the first computer system 101a is sharing the first user interface 1106 with the second computer system 101b and the third computer system 101c. In FIG. 23S, the input directed at the selectable option 2312e includes attention 2310j (e.g., based on gaze) of the first user 1101a directed at the selectable option 2312e of sharing user interface 2312 for the second user interface 1108 while the hand 1116 of the first user 1101a performs an air pinch gesture (e.g., the thumb and index finger of the hand of the user coming into contact with each other and then the release thereof). In some embodiments, in response to the input directed at the selectable option 2312e in FIG. 23S, the first computer system 101a updates display of the sharing user interface 2312 for the second user interface 1108 to be a confirmation use interface for confirming that the first user 1101a is requesting to replace sharing of the first user interface 1106 with sharing of the second user interface 1108 in the first type of communication session between the first user 1101a, the second user 1101b, and the third user 1101c, as shown in FIG. 23T.

For example, in FIG. 23T, the sharing user interface 2312 for the second user interface 1108 includes a selectable option 2312l that is selectable to replace sharing of the first user interface 1106 with sharing of the second user interface 1108 in the first type of communication session that is already established between the first user 1101a, the second user 1101b, and the third user 1101c, and a selectable option 2312m that is selectable to cancel sharing of the second user interface 1108. In some embodiments, were the selectable option 2312m selected, the first computer system 101a would optionally maintain the sharing of the first user interface 1106 as described with reference to FIGS. 23N through 23P.

In FIG. 23U, the first computer system 101a detects an input directed at the selectable option 2312l. In some embodiments, the input directed at the selectable option 2312l includes attention 2310k (e.g., based on gaze) of the first user 1101a directed at the selectable option 2312l while the hand 1116 of the first user 1101a performs an air pinch gesture (e.g., the thumb and index finger of the hand of the user coming into contact with each other and then the release thereof). In response to detecting the input of FIG. 23U, the first computer system 101a shares the second user interface 1108 in the first type of communication session that is already established between the first user 1101a, the second user 1101b, and the third user 1101c, including replacing sharing of the first user interface 1106 with sharing of the second user interface 1108, and which likewise causes the second computer system 101b and the third computer system 101c to replace display of the first user interface 1106 with display of the second user interface 1108 in the second three-dimensional environment 1107 and the third three-dimensional environment 1509, such as shown from FIG. 23O to FIG. 23W and from FIG. 23P to FIG. 23X, respectively. In some embodiments, in response to detecting the input directed at the selectable option 2312e in the sharing user interface 2312 for the second user interface 1108 in FIG. 23S and/or in response to the input directed at the selectable option 2312l in FIG. 23U, the first computer system 101a updates display of the sharing user interface 2312 for the second user interface 1108 to include options for configuring the sharing of the second user interface 1108 with the second user 1101b and the third user 1101c, such as described with reference to the first computer system 101a updating display of the sharing user interface 2312 for the first user interface 1106 to include options for configuring the sharing of the first user interface 1106 with the second user 1101b and the third user 1101c shown in FIG. 23H. Further, as shown from FIG. 27U to FIG. 27V, since the first user 1101a is sharing the second user interface 1108 with the same set of users in the physical environment 1105 with whom the first user interface 1106 was being shared, the first computer system 101a optionally moves display of the second user interface 1108 to a location that the first user interface 1106 had when it was being shared. For example, the location of the first user interface 1106 in FIG. 23U is optionally an ideal location for sharing of content between the users, such as described with reference to a location within a sharing zone in method 1600, and the first computer system 101a optionally moves the second user interface 1108 in the first three-dimensional environment 1103 to the ideal location in response to detecting the input directed at the selectable option 2312l in FIG. 23U. Additionally, as shown from FIG. 23U to FIG. 23V, the first computer system 101a changes the visual appearances of the plurality of control elements for the first user interface 1106 (e.g., the control element 2306a, control element 1106b, and control element 2306c) and the plurality of control elements for the second user interface 1108 (e.g., the control element 2308a, control element 1108b, and control element 2308c). For example, the first computer system 101a changes the visual appearance of the plurality of control elements for the first user interface 1106 (e.g., the control element 2306a, control element 1106b, and control element 2306c) from FIG. 23U to FIG. 23V optionally because the first user interface 1106 has ceased being shared in FIG. 23V. Continuing with this example, the first computer system 101a changes the visual appearance of the plurality of control elements for the second user interface 1108 (e.g., the control element 2308a, control element 1108b, and control element 2308c) optionally because the second user interface 1108 has started to be shared in FIG. 23U.

FIG. 23Y illustrates an example of the first computer system 101a displaying a user interface 2320 that indicates that the process for sharing the first user interface 1106 with the second user 1101b of the second computer system 101b failed to be completed within a threshold period of time (e.g., 15 s, 30 s, 1 min, 2 min, or another threshold period of time); such features are described further with reference to method 2400. Note that, in some embodiments, were the first user 1101a to invite the second user 1101b and the third user 1101c to the first type of communication session for the sharing of the first user interface 1106, such as shown in FIG. 23M, and were the process for sharing the first user interface 1106 with the third user 1101c to be completed within the threshold period of time, but the process for sharing the first user interface 1106 with the second user 1101b to not be complete within the threshold period of time, the first computer system 101a optionally shares the first user interface 1106 in the first type of communication session with the third user 1101c, such as shown in FIGS. 23N and 23P, and displays the user interface 2320 of FIG. 23Y. Additionally, were the process for sharing the first user interface 1106 with the third user 1101c to be completed within the threshold period of time, but the process for sharing the first user interface 1106 with the second user 1101b to not be complete within the threshold period of time, the first computer system 101a optionally displays the plurality of control elements for the first user interface 1106 (e.g., control element 2306a, control element 1106b, and control element 2306c) having a visual appearance that indicates that it is being shared. Further details regarding the user interface 2320 are described with reference to method 2400.

FIGS. 23Z and 23AA illustrate an example of the first computer system 101a detecting and responding to input directed at the selectable option 2312d for initiating a process for enabling sharing of the first user interface 1106 in the first type of communication session with users who are collocated in the physical environment 1105 with the first user 1101a and do not satisfy the one or more criteria (e.g., the one or more criteria described with reference to method 2500), such as users who are not in a contact list of an application on the first computer system 101a, while the first computer system 101a is sharing the first user interface 1106 in the first type of communication session, according to some embodiments.

In FIG. 23Z, the first computer system 101a detects an input directed at the selectable option 2312d. In some embodiments, the input includes attention 2310l (e.g., based on gaze) of the first user 1101a directed at the selectable option 2312d while the hand 1116 of the first user 1101a performs an air pinch gesture (e.g., the thumb and index finger of the hand of the user coming into contact with each other and then the release thereof). In some embodiments, in response to detecting the input directed at the selectable option 2312d, the first computer system 101a updates display of the sharing user interface 2312 for the first user interface 1106, as shown in FIG. 23AA.

In FIG. 23AA, the sharing user interface 2312 for the first user interface 1106 includes the selectable option 2312a, the selectable option 2312d, and instructions 2312n. The instructions 2312n include instructions for initiating a process to enable sharing of the first user interface 1106 in the first type of communication session with the one or more users of computer systems who are collocated in the physical environment with the first user of the first computer system and do not satisfy the one or more criteria (e.g., the one or more criteria described with reference to method 2500). For example, the instructions optionally include an instruction that a respective input is to be provided (e.g., detected) at the computer systems of the users who are collocated in the physical environment with the first user of the first computer system and do not satisfy the one or more criteria (e.g., the one or more criteria described with reference to method 2500) in order for those users to satisfy the one or more criteria. In FIG. 23AA, the instructions 2312n include an instruction that a code (“4352”) is to be provided to the computer systems of the users who are collocated in the physical environment with the first user of the first computer system and do not satisfy the one or more criteria to enable sharing of content between the first computer system 101a and the computer systems of those users. The instructions 2312n (e.g. the respective input) are further described with reference to method 2500.

The fourth user 1101d of the fourth computer system 101d is a user who is collocated in the physical environment with the first user 1101a of the first computer system 101a and does not satisfy the one or more criteria (e.g., the one or more criteria described with reference to method 2500). For example, the fourth user 1101d optionally is not in a contact list of an application on the first computer system 101a. In some embodiments, the first user 1101a shares the code (“4352”) given in the instructions 2312n with the fourth user 1101d. For example, the first user 1101a optionally verbally tells the code (“4352”) given in the instructions 2312n to the fourth user 1101d. In some embodiments, the fourth user 1101d provides the code (“4352”) to the fourth computer system 101d so that the one or more criteria (e.g., the one or more criteria described with reference to method 2500) can be satisfied.

FIGS. 23AB through 23AG generally illustrate an example of the fourth computer system 101d detecting and responding to respective input that enables sharing of content (e.g., a user interface) from the first user 1101a of the first computer system 101a to the fourth user 1101d of the fourth computer system 101d (e.g., between the first user 1101a and the fourth user 1101d), in accordance with some embodiments.

In some embodiments, the code (“4352”) given in the instructions 2312n is to be entered in a control user interface (e.g., a system control user interface) of the fourth computer system 101d. FIGS. 23AB and 23AC illustrate the fourth computer system 101d detecting and responding to input that corresponds to a request to display the control user interface of the fourth computer system 101d.

In some embodiments, the fourth computer system 101d detects an input corresponding to a request to display a control user interface of the fourth computer system 101d. In some embodiments, the input includes a first part and a second part. In some embodiments, the first part includes attention (e.g., based on gaze) of the fourth user 1101d being directed at a hand of the fourth user 1101d, such as directed to the palm of the hand, and then the fourth user 1101d performing a hand flip gesture while the attention of the fourth user 1101d is directed at their hand. In some embodiments, in response to detecting the first part of the input, the fourth computer system 101d displays the control widget user interface 2322 of FIG. 23AC. For example, while displaying the fourth three-dimensional environment 2321 of FIG. 23AB, the fourth computer system 101d optionally detects the first part of the input described above, and in response, the fourth computer system 101d displays the control widget user interface 2322, such as shown in FIG. 23AC. As shown in FIG. 23AC, the control widget user interface 2322 indicates the current time at the fourth computer system 101d, a battery level of the fourth computer system 101d, the connectivity (e.g., a Wi-Fi strength) at the fourth computer system 101d, and a current volume level (e.g., a current system volume level) of the fourth computer system 101d. In some embodiments, the control widget user interface 2322 of FIG. 23AC is selectable to display the control user interface of the fourth computer system 101d, such as shown from FIG. 23AC to FIG. 23AD. In some embodiments, the second part of the input described above includes a selection input including input from the hand 1116c of the fourth user 1101d (e.g., an air pinch gesture) while attention 2310m of the fourth user 1101d is directed to the control widget user interface 2322, such as shown in FIG. 23AC. In some embodiments, in response to detecting the second part of the input, the fourth computer system 101d displays a control user interface of the fourth computer system 101d, such as the control user interface 2324 of FIG. 23AD.

As shown in FIG. 23AD, the control user interface 2324 indicates the current time at the fourth computer system 101d, a battery level of the fourth computer system 101d, and the connectivity (e.g., a Wi-Fi strength) at the fourth computer system 101d. The control user interface 2324 in FIG. 23AD also includes options 2324a through 2324e for controlling different aspects of the fourth computer system 101d. Option 2324a is optionally selectable to edit controls that are in the control user interface 2324 and/or is selectable to view a second control user interface of the fourth computer system 101d. Option 2324b is optionally selectable to control aspects (e.g., level of immersion, volume level of an immersive environment, and/or selection) of an immersive environment of the fourth computer system 101d. Option 2324c is optionally selectable to control (e.g., modify) a current volume level (e.g., a current system volume level) of the fourth computer system 101d. Option 2324d is optionally selectable for controlling establishment of a connection between the fourth computer system 101d and a computer system that is different from the fourth computer system 101d to use the display generation component 120 of the fourth computer system 101d to display user interfaces of (e.g., content from) the computer system. Option 2324e is optionally selectable to view and/or control notification settings of the fourth computer system 101d, such as for viewing notifications and/or for configuring how notifications from application on the fourth computer system 101d are to be presented at the fourth computer system 101d.

In some embodiments, the fourth computer system 101d detects an indication that someone in the physical environment 1105 wishes to share content. In some embodiments, the indication is transmitted from the first computer system 101a to the fourth computer system 101d (e.g., the first computer system 101a optionally broadcasts (e.g., via BLUETOOTH and/or another wireless protocol) the indication in response to detecting selection of the selectable option 2312d in FIG. 23Z (and/or otherwise while displaying a sharing user interface (e.g., the sharing user interface 2312 for the first user interface 1106 or the sharing user interface 2312 for the second user interface 1108)). In some embodiments, the indication does not identify the specific user who wishes to share content. In some embodiments, in response to detection the indication described above, and while the fourth computer system 101d displays the control user interface 2324 of the fourth computer system 101d, the fourth computer system 101d display a notification 2326 that indicates that someone in the physical environment 1105 wishes to share content, as shown in FIG. 23AD.

In FIG. 23AD, the fourth computer system 101d detects input directed to the notification 2326. In some embodiments, the input directed to the notification 2326 includes attention (e.g., based on gaze) of the fourth user 1101d directed to the notification 2326 while the hand 1116c of the fourth user 1101d performs an air pinch gesture (e.g., the thumb and index finger of the hand of the user coming into contact with each other and then the release thereof). In some embodiments, in response to detecting the input directed to the notification 2326, the fourth computer system 101d updates display of the control user interface 2324, as shown in FIG. 23AE.

In FIG. 23AE, the fourth computer system 101d displays the control user interface 2324 including settings for configuring sharing functionalities at the fourth computer system 101d. In FIG. 23AE, the control center includes an option 2324f (e.g., a toggle) for enabling/disabling discovery for sharing of content in the first type of communication session users who are collocated in the physical environment 1105 with the fourth user 1101d and meet one or more criteria (e.g., the one or more criteria described with reference to method 2500) relative to the fourth user 1101d, such as users who are in a contact list of an application on the fourth computer system 101d. For example, were the option 2324f enabled, were the fourth user 1101d collocated in the physical environment 1105 with a respective user of a respective computer system who meets the one or more criteria, and were the respective computer system to display a sharing user interface for a respective user interface, such as the sharing user interface 2312 for the first user interface 1106 in FIG. 23D, the sharing user interface for the respective user interface would optionally include a selectable option that is selectable to invite (e.g., include) the fourth user 1101d of the fourth computer system 101d (“Brooke”) to the sharing of the respective user interface 1106 in the first type of communication session, such as described with reference to the sharing user interface 2312 for the first user interface 1106 in FIG. 23D including the selectable option 2312c. Continuing with this example, were the option 2324f disabled, were the fourth user 1101d collocated in the physical environment 1105 with the respective user of the respective computer system who meets the one or more criteria, and were the respective computer system to display the sharing user interface for the respective user interface, such as the sharing user interface 2312 for the first user interface 1106 in FIG. 23D, the sharing user interface for the respective user interface would optionally exclude the selectable option that is selectable to invite (e.g., include) the fourth user 1101d of the fourth computer system 101d (“Brooke”) to the sharing of the respective user interface 1106 in the first type of communication session. Additionally, in FIG. 23AE, the control user interface 2324 includes an option 2324g (e.g., a text entry field, a passcode entry field, and/or a number entry field) for entering a code to enable sharing of content in the first type of communication session from other users in the physical environment 1105 who currently do not meet the one or more criteria (e.g., the one or more criteria described with reference to method 2500) relative to the fourth user 1101d (e.g., relative to the fourth computer system 101d).

FIGS. 23AE and 23AF illustrate an example of the fourth computer system 101d detecting and responding to input directed to the option 2324g. In some embodiments, the input directed to the option 2324g includes attention (e.g., based on gaze) of the fourth user 1101d directed to the option 2324g and one or more air pinch gestures that corresponds to entry of the code (“4352”) illustrated in the option 2324g in FIG. 23AF, which is the code (“4352”) given in the instructions 2312n in FIG. 23AA. Thus, from FIG. 23AE to FIG. 23AF, the fourth computer system 101d detects the respective input described above (e.g., entry of the code (“4352”)).

In response to detecting the respective input of FIG. 23AF, the fourth computer system 101d updates display of the control user interface 2324 to indicate that the first user 1101a (“Bella”) is allowed to specifically request to share content in the first type of communication session with the fourth user 1101d (“Brooke”), as shown in FIG. 23AG. Additionally, as shown in FIG. 23AG, the fourth computer system 101d updates the control user interface 2324 to include an option 2324h that is selectable to initiate a process to add the first user 1101a (“Bella”) to a contact list of an application on the fourth computer system 101d.

FIGS. 23Z and 23AH illustrates an example of the first computer system 101a detecting and responding to an indication that the fourth user 1101a has enabling sharing in the first type of communication session with the first user 1101a. For example, in response to detecting the respective input of FIG. 23AF (e.g., entry of the code (“4352”)), the fourth computer system 101d optionally transmits the indication to the first computer system 101a, and in response, the first computer system 101a optionally updates the sharing user interface for the first user interface 1106 of FIG. 23Z to include a selectable option 2312k, which is selectable to invite (e.g., include) the fourth user 1100d (“Brooke”) of the fourth computer system 101d (“Charlie”) to the sharing of the first user interface 1106 in the first type of communication that is already active between the first user 1101a, the second user 1101b, and the third user 1101c, as shown in FIG. 23AH. Additionally, as shown in FIG. 23AH, the first computer system 101a displays a user interface element 2312k-1 that is selectable to initiate a process to add the fourth user 1101d (“Brooke”) to a contact list of an application on the first computer system 101a. For example, were the first computer system 101a to detect input directed to the user interface element 2312k-1, such as attention 2310o-3 of the first user 1101a directed to the user interface element 2312k-1 while the hand 1116 performs an air pinch gesture (e.g., the thumb and index finger of the hand of the user coming into contact with each other and then the release thereof), the first computer system 101a would optionally initiate the process to add the fourth user 1101d (“Brooke”) to the contact list of the application on the first computer system 101a in response.

FIGS. 23AH and 23AI illustrate an example of the first computer system 101a detecting and responding to input for adding the fourth user 1101d to the sharing of the first user interface 1106 in the first type of communication session that includes the first user 1101a, the second user 1101b, and the third user 1101c. In FIG. 23AH, while sharing the first user interface 1106 in the first type of communication session that includes the first user 1101a, the second user 1101b, and the third user 1101c, and while displaying the sharing user interface 2312 for the first user interface 1106, the first computer system 101a detects input directed to the selectable option 2312k and then input directed to the selectable option 2312e. For example, the first computer system 101a optionally detects attention 2310o-1 of the first user 1101a directed to the selectable option 2312k while the hand 1116 performs an air pinch gesture (e.g., the thumb and index finger of the hand of the user coming into contact with each other and then the release thereof) and then detects attention 2310o-2 directed to the selectable option 2312e while the hand performs an air pinch gesture. In response to detecting the input directed to the selectable option 2312k and then the input directed to the selectable option 2312e, the first computer system 101a optionally adds (e.g., invites) the fourth user 1101d to the sharing of the first user interface 1106 in the first type of communication session that includes the first user 1101a, the second user 1101b, and the third user 1101c (e.g., optionally without displaying the options for configuring the sharing of the first user interface 1106 shown in FIG. 23H).

In some embodiments, in response to detecting the input directed to the selectable option 2312k and then the input directed to the selectable option 2312e in FIG. AH, the first computer system 101a transmits to the fourth computer system 101d a respective indication requesting that the fourth user 1101d join the first type of communication session for sharing of the first user interface 1106 that includes the first user 1101a, the second user 1101b, and the third user 1101c. In some embodiments, in response to detecting the respective indication, the fourth computer system 101d displays a user interface element 2314 including options for the fourth user 1101d (“Brooke”) to accept or deny the request, such as described with reference to the second computer system 101b displaying the user interface element 2314 as shown in FIG. 23J. In some embodiments, in response to detecting input corresponding to acceptance of the request, the fourth computer system 101d displays the first user interface 1106 in the fourth three-dimensional environment 2321, such as shown in FIG. 23AI. Thus, since the fourth user 1101d is added to the sharing of the first user interface 1106 in the first type of communication session that includes the first user 1101a, the second user 1101b, and the third user 1101c in FIG. 23AI, in FIG. 23AI, while the fourth computer system 101d displays the first user interface 1106, the first computer system 101a is optionally displaying the first user interface 1106 in the first three-dimensional environment 1103 (e.g., as shown in FIG. 23N), the second computer system 101b is optionally displaying the first user interface 1106 in the second three-dimensional environment 1107 (e.g., as shown in FIG. 23O), and the third computer system 101c is optionally displaying the first user interface 1106 in the third three-dimensional environment 1509 (e.g., as shown in FIG. 23P).

FIGS. 23AJ and 23AA illustrate an example of the first computer system 101a detecting and responding to input directed at the selectable option 2312a of the sharing user interface 2312 for the first user interface 1106 for initiating the process for enabling sharing of the first user interface 1106 in the first type of communication session with users who are collocated in the physical environment and do not meet certain criteria, such as users who are not in a contact list of an application on the first computer system 101a, while the first computer system 101a is not sharing the first user interface 1106, according to some embodiments. In FIG. 23AJ, the first computer system 101a detects an input directed at the selectable option 2312a while the first computer system 101a is not sharing the first user interface 1106. The first computer system 101a provides a visual indication that the first user interface 1106 is not being shared in FIG. 23AJ through the visual appearance of the plurality of control elements for the first user interface 1106 in FIG. 23AJ, which is different from the visual appearance of the plurality of control elements for the first user interface 1106 in FIGS. 23N, 23Q through 23U, 23Y, and 23Z, in which figures the first computer system 101a is sharing the first user interface 1106. In some embodiments, the input includes attention 2310p (e.g., based on gaze) of the first user 1101a directed at the selectable option 2312a while the hand 1116 performs an air pinch gesture (e.g., the thumb and index finger of the hand of the user coming into contact with each other and then the release thereof). In some embodiments, in response to detecting the input directed at the selectable option 2312a in FIG. 23AJ, the first computer system 101a updates display of the sharing user interface 2312 for the first user interface 1106, as shown in FIG. 23AA, but note that, in these embodiments, the visual appearance of the plurality of control elements for the first user interface 1106 (e.g., the control element 2306a, control element 1106b, and control element 2306c) would be different from the visual appearance of the plurality of control elements for the first user interface 1106 illustrated in FIG. 23AA because the first user interface 1106 is not being shared in the described example of FIGS. 23AJ and 23AA (e.g., described above). In the described example of FIGS. 23AJ and 23AA (e.g., described above), the plurality of control elements for the first user interface 1106 (e.g., the control element 2306a, control element 1106b, and control element 2306c) would have a visual appearance that indicates that the first user interface 1106 is not being shared when the input directed at the selectable option 2312a in FIG. 23AJ is detected and in response to detecting the input directed at the selectable option 2312a in FIG. 23AJ.

Thus, in some embodiments, in response to detecting the input directed at the selectable option 2312a in FIG. 23AJ, the first computer system 101a updates display of the sharing user interface 2312 for the first user interface 1106 to include the instructions 2312n of FIG. 23AA, which indicates the respective input that is to be provided (e.g., detected) at the computer systems of the users who are collocated in the physical environment with the first user of the first computer system and do not satisfy the one or more criteria (e.g., the one or more criteria described with reference to method 2500) in order for those users to satisfy the one or more criteria. In some embodiments, in response to detecting an indication that the fourth computer system 101d has detected the respective input (e.g., one or more of the inputs described with reference to FIGS. 23AB through 23AF, including the input corresponding to entry of the code illustrated in the option 2324g in FIG. 23AF), the first computer system 101a updates display of the sharing user interface 2312 for the first user interface 1106 to include the selectable option 2312k as shown in FIG. 23AK, such as described with reference to FIGS. 23AG and 23AH. Additionally, in FIG. 23AK, the first computer system 101a can detect and respond to input for initiating sharing of the first user interface 1106 in a first type of communication session with the fourth user 1101d of the fourth computer system 101d, such as shown in FIG. 23AK. For example, in FIG. 23AK, while not sharing the first user interface 1106, the first computer system 101a optionally detects input directed to the selectable option 2312k and then input directed to the selectable option 2312e, such as described with reference to FIG. 23AH. For example, in FIG. 23AK, the first computer system 101a optionally detects attention 2312o-3 of the first user 1101a directed to the selectable option 2312k while the hand 1116 performs an air pinch gesture (e.g., the thumb and index finger of the hand of the user coming into contact with each other and then the release thereof) and then detects attention 2312o-5 directed to the selectable option 2312e while the hand performs an air pinch gesture. In response to detecting the input directed to the selectable option 2312k and then the input directed to the selectable option 2312e in FIG. 23AK, the first computer system 101a optionally transmits a request to the fourth computer system 101d for the fourth user 1101d join a first type of communication session with the first user 1101a for sharing of the first user interface 1106. In some embodiments, in response to detecting the request, the fourth computer system 101d displays the user interface element 2314 including options for the fourth user 1101d to accept or deny the request, such as described with reference to the second computer system 101b displays the user interface element 2314 in FIG. 23J. In some embodiments, in response to detecting an indication that the fourth user 1101d has accepted the request, the first computer system 101a establishes the first type of communication session just between the first user 1101a and the fourth user 1101d and causes the fourth computer system 101d to display the first user interface 1106 at a location in the fourth three-dimensional environment 2321 that corresponds to a location of display of the first user interface 1106 in the first three-dimensional environment 1103, such as shown in FIGS. 23AI and 23N.

FIGS. 23AL through 23AO illustrate an example of the first computer system 101a detecting and responding to input corresponding to a request to share the first user interface 1106 in a second type of communication session (e.g., the second type of communication session described with reference to methods 2400/2500), where the input is detected while the first user interface 1106 is currently being shared in the first type of communication session, according to some embodiments.

In FIG. 23AL, the first computer system 101a detects an input directed to the selectable option 2312a in the sharing user interface 2312 for the first user interface 1106 while the first user interface 1106 is currently being shared in the first type of communication session between the first user 1101a, the second user 1101b, and the third user 1101c, as indicated with the indication 2312b-1 in the selectable option 2312b and the indication 2312c-1 in the selectable option 2312c. For example, the input directed to the selectable option 2312a optionally includes attention 2310q of the first user 1101a directed to the selectable option 2312a while the hand 1116 performs an air pinch gesture (e.g., the thumb and index finger of the hand of the user coming into contact with each other and then the release thereof). In response, the first computer system 101a updates display of the sharing user interface 2312 for the first user interface 1106, as shown in FIG. 23AM.

In FIG. 23AM, while the first user interface 1106 is currently being shared in the first type of communication session as described with reference to FIG. 23AL, the first computer system 101a displays the sharing user interface 2312 for the first user interface 1106 including options for including different users in the sharing of the first user interface 1106 in the second type of communication session. In FIG. 23AM, the options include an option 2328a (e.g., a text entry field) that is selectable to search for users to invite to join the second type of communication session, and include options 2328b through 2328e, which are respectively selectable to include the indicated suggested user. In FIG. 23AM, the sharing user interface 2312 for the first user interface 1106 also includes the option 2328f, which is optionally selectable to invite the users the first user 1101a selects in the sharing user interface 2312 to the sharing of the first user interface 1106 in the second type of communication session. For example, the option 2328f is optionally similar to (e.g., the same as) the functionality of the selectable option 2312e.

In FIG. 23AM, while the first user interface 1106 is currently being shared in the first type of communication session as described with reference to FIG. 23AL, the first computer system 101a detects an input directed to the option 2328b, which is selectable to invite (e.g., include) the user “Jill”, who is a user of a computer system who is not collocated in the physical environment 1105 with the first user 1101a, to the second type of communication session for the sharing of the first user interface 1106, and then detects an input directed to the option 2328f. For example, in FIG. 23AM, the first computer system 101a optionally detects attention 2310r of the first user 1101a directed to the option 2328b while the hand 1116 performs an air pinch gesture (e.g., the thumb and index finger of the hand of the user coming into contact with each other and then the release thereof) and then detects attention 2310s directed to the option 2328f while the hand performs an air pinch gesture. In response to detecting the inputs of FIG. 23AM, the first computer system 101a updates display of the sharing user interface 2312 for the first user interface 1106, as shown in FIG. 23AN.

In FIG. 23AN, the sharing user interface 2312 for the first user interface 1106 includes options for inviting (e.g., including) different sets of users in the second type of communication session. In FIG. 23AN, the options include an option 2330a that is selectable to invite (e.g., include) the user “Jill”, to whom the option 2328d in FIG. 23AM corresponded, and the users with whom the first user 1101a is currently sharing the first user interface 1106, which include the second user 1101b and the third user 1101c. In FIG. 23AN, the options include an option 2330b that is selectable to invite (e.g., include) just the user “Jill”, to whom the option 2328d in FIG. 23AM corresponded (e.g., without being selectable to invite the users with whom the first user 1101a is currently sharing the first user interface 1106). In FIG. 23AN, the options include an option 2330c that is selectable to cancel initiation of sharing of the first user interface 1106 in the second type of communication session.

FIGS. 23AN and 23AO illustrate an example of the first computer system detecting and responding to input directed at the option 2330a, which is selectable to invite (e.g., include) the user “Jill”, to whom the option 2328d in FIG. 23AM corresponded, and the users with whom the first user 1101a is currently sharing the first user interface 1106, which include the second user 1101b and the third user 1101c, according to some embodiments. In FIG. 23AN, the first computer system 101a detects an input directed to the option 2330a in the sharing user interface 2312 for the first user interface 1106 while the first user interface 1106 is currently being shared in the first type of communication session between the first user 1101a, the second user 1101b, and the third user 1101c. For example, the input directed to the option 2330a optionally includes attention 2310t of the first user 1101a directed to the option 2330a while the hand 1116 performs an air pinch gesture (e.g., the thumb and index finger of the hand of the user coming into contact with each other and then the release thereof). In response, the first computer system 101a initiates sharing the first user interface 1106 in the second type of communication session and updates display of the sharing user interface 2312 for the first user interface 1106, as shown in FIG. 23AO.

In some embodiments, in response to detecting the input directed to the option 2330a in FIG. 23AN, the first computer system 101a changes the communication session that is currently active between the first user 1101a, the second user 1101b, and the third user 1101c, from the first type of communication session to the second type of communication session (e.g., without ceasing sharing of the first user interface 1106. In some embodiments, in response to detecting the input directed to the option 2330a in FIG. 23AN, the first computer system 101a transmits a request to the computer system of the user “Jill” for the user “Jill” to join the second type of communication session with the first user 1101a. In some embodiments, in response to detecting (e.g., from the computer system of the user “Jill”) an indication that the user “Jill” has accepted the request, the first computer system 101a updates the second type of communication session to be between the first user 1101a, the second user 1101b, the third user 1101c, and the user “Jill”, who is not in the physical environment 1105, and displays a spatial representation 2332 of the user “Jill”, such as described with reference to methods 1000, 2400, and/or 2500. In addition, in some embodiments, in response to detecting (e.g., from the computer system of the user “Jill”) an indication that the user “Jill” has accepted the request, the second computer system 101b displays a notification 2331 that indicates that the user “Jill” has accepted the request and thus is now in the second type of communication session, such as shown in FIG. 23AP. Further, in some embodiments, in response to detecting (e.g., from the computer system of the user “Jill”) an indication that the user “Jill” has accepted the request, the third computer system 101c and the first computer system 101a display a notification (e.g., the notification 2331) that indicates that the user “Jill” has accepted the request and thus is now in the second type of communication session.

FIGS. 23AN and 23AQ illustrate an example of the first computer system detecting and responding to input directed at the option 2330b, which is selectable to invite (e.g., include) just the user “Jill” to whom the option 2328d in FIG. 23AM corresponded (e.g., without being selectable to invite the users with whom the first user 1101a is currently sharing the first user interface 1106), according to some embodiments. In FIG. 23AN, the first computer system 101a detects an input directed to the option 2330b in the sharing user interface 2312 for the first user interface 1106 while the first user interface 1106 is currently being shared in the first type of communication session between the first user 1101a, the second user 1101b, and the third user 1101c. For example, the input directed to the option 2330b optionally includes attention 2310u of the first user 1101a directed to the option 2330a while the hand 1116 performs an air pinch gesture (e.g., the thumb and index finger of the hand of the user coming into contact with each other and then the release thereof). In response to detecting the input directed to the option 2330b, the first computer system 101a ceases the sharing of the first user interface 1106 with the second user 1101b and the third user 1101c, including ending the first type of communication session that includes the first user 1101a, the second user 1101b, and the third user 1101c. In addition, in response to detecting the input directed to the option 2330b, the first computer system 101a transmits a request to the computer system of the user “Jill” for the user “Jill” to join the second type of communication session with the first user 1101a. In some embodiments, in response to detecting (e.g., from the computer system of the user “Jill”) an indication that the user “Jill” has accepted the request, the first computer system 101a displays a spatial representation 2332 of the user “Jill”, such as described with reference to methods 1000, 2400, and/or 2500, such as shown in FIG. 23AQ. In addition, in some embodiments, in response to detecting (e.g., from the computer system of the user “Jill”) an indication that the user “Jill” has accepted the request, the first computer system 101a displays a notification (e.g., the notification 2331 in FIG. 23AP) that indicates that the user “Jill” has accepted the request and thus is now in the second type of communication session.

In some embodiments, a location of initial display of the spatial representation 2332 of the user “Jill” in the first three-dimensional environment 1103 is based on the locations of users in the physical environment 1105 who are party to the second type of communication session. For example, in FIG. 23AO, the first computer system 101a optionally displays the spatial representation 2332 of the user “Jill” in the first three-dimensional environment 1103 at the illustrated location because at that location, the spatial representation 2332 of the user “Jill” is not blocking a view of the first user interface 1106 from the locations of the first user 1101a, the second user 1101b, and the third user 1101c, who are party to the second type of communication session, such as shown in FIGS. 23AO and 23AP. Continuing with this example, in FIG. 23AQ, the first computer system 101a optionally displays the spatial representation 2332 of the user “Jill” in the first three-dimensional environment 1103 at the illustrated location, independent of the whether a view of the first user interface 1106 from locations of the second user 1101b and the third user 1101c is being blocked by the spatial representation 2332 of the user “Jill” because the second user 1101b and the third user 1101c are not party the second type of communication session (e.g., the first computer system 101a is not sharing the first user interface 1106 with the second computer system 101b and the third computer system 101c, so those computer systems computer systems are not displaying the first user interface 1106) in FIG. 23AQ.

FIGS. 23AR through 23AT illustrate an example of the first computer system 101a detecting and responding to input corresponding to a request to share the first user interface 1106 in a second type of communication session (e.g., the second type of communication session described with reference to methods 2400/2500), where the input is detected while the first user interface 1106 is not currently being shared, according to some embodiments.

In FIG. 23AR, the first computer system 101a detects an input directed to the selectable option 2312a in the sharing user interface 2312 for the first user interface 1106. For example, the input directed to the selectable option 2312a optionally includes attention 2310v of the first user 1101a directed to the selectable option 2312a while the hand 1116 performs an air pinch gesture (e.g., the thumb and index finger of the hand of the user coming into contact with each other and then the release thereof). In response, the first computer system 101a updates display of the sharing user interface 2312 for the first user interface 1106, as shown in FIG. 23AS. The option 2328a and 2328b through 2328e illustrated in the sharing user interface 2312 for the first user interface 1106 in FIG. 23AS are generally as described with reference to the option 2328a and 2328b through 2328e illustrated in the sharing user interface 2312 for the first user interface 1106 in FIG. 23AM.

In FIG. 23AS, the first computer system 101a detects an input directed to the option 2328b, which is selectable to invite (e.g., include) the user “Jill”, who is a user of a computer system who is not collocated in the physical environment 1105 with the first user 1101a, to the second type of communication session for the sharing of the first user interface 1106, and then detects an input directed to the option 2328f. For example, in FIG. 23AS, the first computer system 101a optionally detects attention 2310w of the first user 1101a directed to the option 2328b while the hand 1116 performs an air pinch gesture (e.g., the thumb and index finger of the hand of the user coming into contact with each other and then the release thereof) and then detects attention 2310x directed to the option 2328f while the hand performs an air pinch gesture. In response to detecting the inputs of FIG. 23AS, the first computer system 101a optionally ceases display of the sharing user interface 2312 for the first user interface 1106 and transmits a request to the computer system of the user “Jill” for the user “Jill” to join the second type of communication session with the first user 1101a. In some embodiments, in response to detecting (e.g., from the computer system of the user “Jill”) an indication that the user “Jill” has accepted the request, the first computer system 101a displays a spatial representation 2332 of the user “Jill”, such as described with reference to methods 1000, 2400, and/or 2500, such as shown in FIG. 23AT. In addition, in some embodiments, in response to detecting (e.g., from the computer system of the user “Jill”) an indication that the user “Jill” has accepted the request, the first computer system 101a displays a notification (e.g., the notification 2331 in FIG. 23AP) that indicates that the user “Jill” has accepted the request and thus is now in the second type of communication session.

FIG. 23AU illustrates an example of the first computer system 101a concurrently displaying immersive content 2336 of an application (e.g., a gaming application, a movie playback application, or another type of application) and a user interface element 2336a that is selectable to display a sharing user interface for the immersive content, according to some embodiments. In some embodiments, the user interface element 2336a is selectable to display the sharing user interface 2312 of FIG. 23D, but corresponding to the immersive content 2336 of the application. Further details regarding ways to share immersive content are described with reference to method 2400. Additionally, further details regarding the embodiments illustrated and described with reference to FIGS. 23A through 23AU are provided with reference to methods 2400/2500.

FIG. 24 is a flowchart illustrating an exemplary method for displaying a sharing user interface for a user interface in response to detecting an input directed to a first control element for the user interface, in accordance with some embodiments.

In some embodiments, the method 2400 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2400 are, optionally, combined and/or the order of some operations is, optionally, changed.

The devices, methods, and/or computer-readable storage mediums described with reference to method 2400 enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Displaying options for sharing a sharing user interface in different types of communication sessions in response to input directed to a control element for sharing the user interface makes the computer system responsive to input for controlling sharing of the user interface and reduces errors associated with improper sharing of user interfaces Further, displaying indications of users with whom the user interface can be shared with reduces a number of inputs involved with sharing the user interface with those specific indicated users. Displaying the sharing element concurrently with the user interface independent of whether a collocated user is present indicates to the first user that sharing of the user interface is possible even with users who are remote to the environment of the first user.

In some embodiments, a method 2400 (e.g., the method 2400 of FIG. 24) is performed at a first computer system (e.g., the first computer system 101a of FIG. 23A) that is in communication with one or more first display generation components and one or more first input devices. In some embodiments, a first user of the first computer system (e.g., the first user 1101a in FIG. 23A) is collocated in a physical environment (e.g., physical environment 1105 in FIG. 23A) with a second user of a second computer system (e.g., the second user 1101b of the second computer system 101b in FIG. 23A). In some embodiments, the first computer system has one or more characteristics of the computer systems in methods 800, 1000, 1200, 1400, 1600, 1800, 2000, and/or 2200. In some embodiments, the first display generation component(s) have one or more characteristics of the display generation component(s) in methods 800, 1000, 1200, 1400, 1600, 1800, 2000, and/or 2200. In some embodiments, the one or more first input devices have one or more characteristics of the one or more input devices in methods 800, 1000, 1200, 1400, 1600, 1800, 2000, and/or 2200. In some embodiments, the first user is collocated in a physical environment with the second user (e.g., the first computer system and the second computer system are collocated in the physical environment) as described with reference to methods 800, 1000, 1200, 1400, 1600, 1800, 2000, and/or 2200.

In some embodiments, the first computer system concurrently displays (2402a), via the one or more first display generation components (optionally in a first three-dimensional environment, such as in the first three-dimensional environment described with reference to methods 1200, 1400, 1600, 1800, 2000, and/or 2200), a user interface (e.g., a messages user interface, maps user interface, media user interface, web browsing user interface, a game user interface, or another user interface of an application, such as a user interface of an application described with reference to methods 800, 1000, 1200, 1400, 1600, 1800, 2000, and/or 2200), such as the first user interface 1106 in FIG. 23A, and a plurality of control elements for the user interface, including a first control element selectable to display a sharing user interface, such as the control element 2306c in FIG. 23A, and a second control element selectable to modify display of the user interface, such as the control element 1106b or the control element 2306a in FIG. 23A, wherein the plurality of control elements for the user interface are displayed at a predetermined spatial arrangement (e.g., predetermined position and/or orientation) relative to the user interface (e.g., below, above, in front of, behind, to the left, to the right, or at another predetermined spatial arrangement relative to the user interface), such as the spatial arrangement of the control element 2306c and the control element 1106b relative to the first user interface 1106 in FIG. 23A. In some embodiments, the control elements control one or more aspects of the user interface. The first control element is selectable to display a sharing user interface for controlling sharing of the user interface. In some embodiments, the second control element is selectable to move, cease display, and/or resize the user interface (e.g., in a three-dimensional environment of the first user). In some embodiments, the computer system detects and responds to input directed to the second control element by moving the second control element in accordance with the input (e.g., by a magnitude and in a direction that corresponds to the input). The first computer system optionally displays the first and second control elements adjacent to and/or in line with each other (e.g., on/along the same line/axis, such as the control elements being aligned vertically or horizontal on along the same line/axis (that is optionally not displayed), the control elements being parallel to an edge (e.g., a top edge, bottom edge, left edge, right edge) of the user interface, and/or on a same side of the user interface as each other. In some embodiments, while input is being directed to the first control element, the first computer system ceases display of the second control element. In some embodiments, while input is being directed to the second control element, the first computer system ceases display of the first control element. In some embodiments, while input is being directed to the first control element, the first computer system maintains display of the second control element. In some embodiments, while input is being directed to the second control element, the first computer system maintains display of the first control element. In some embodiments, the control elements for the user interface include the first control element, the second control element, and a third control element that is selectable to close the user interface.

In some embodiments, while concurrently displaying the user interface and the plurality of control elements for the user interface, the first computer system detects (2402b), via the one or more first input devices, an input directed to the first control element, such as attention 2310a in directed to the control element 2306c in FIG. 23C. In some embodiments, the input includes attention (e.g., gaze) of the user directed to the first control element while a hand of the user is performing an air pinch gesture (e.g., the thumb and index finger of the hand of the user coming into contact and then the release thereof). In some embodiments, the input directed to the first control element includes touch inputs detected on a touch-sensitive surface (e.g., a touch screen), the first user pressing down on a control element on a mouse (e.g., a left-click), and/or is a gaze input without including other inputs such as an air gesture. In some embodiments, the user interface is not being shared when the input directed to the first control element is detected. In some embodiments, the user interface is being shared when the input directed to the first control element is detected. In some embodiments, the input includes a first part (e.g., attention (e.g., gaze) of the first user for a threshold period of time) and a second part (e.g., the attention of the first user while an air pinch gesture is being performed), in response to detecting the first part, the first computer system updates display of the first control element to include an icon indicative of sharing, and in response to detecting the second part, the first computer system initiates a process to display the sharing user interface described below.

In some embodiments, in response to detecting the input directed to the first control element, the first computer system concurrently displays (2402c), via the one or more first display generation components, the user interface (2402d), such as the first user interface in FIG. 23D, and the sharing user interface (2402e), such as the sharing user interface 2312 for the first user interface 1106 in FIG. 23D. In some embodiments, the sharing user interface includes a first option that is selectable to initiate a process for sharing the user interface in a first type of communication session between a first user of the first computer system and the second user of the second computer system (2402f), such as the selectable option 2312b in FIG. 23D. In some embodiments, the first option is part of a set of one or more options that are selectable to initiate a process for sharing the user interface in the first type of communication session with one or more users, such as the first option being an option in the first set of one or more options described with reference to method 2500.

In some embodiments, the sharing user interface includes a second option that is selectable to initiate a process for sharing the user interface in a second type of communication session that is different from the first type of communication session (2402g), such as the selectable option 2312a in FIG. 23D. In some embodiments, in response to detecting the input directed to the first control element, the computer system concurrently displays the user interface, the plurality of control elements for the user interface, and the sharing user interface. In some embodiments, the sharing user interface includes a third option that is selectable to configure sharing of the user interface in the first type of communication session with users that the first user selects such as described below. The first type of communication session is optionally a non-spatial real-time communication session, such as described with reference to methods 800, 1000, 1200, 1400, 1600, 1800, 2000, and/or 2200. For example, in the first type of communication session, the first computer system optionally does not display a spatial representation of the second user (e.g., in the three-dimensional environment visible via the first computer system). In some embodiments, in the first type of communication session, were the user interface to be shared between the first user and the second user, the user interface would be displayed with spatial truth between the first and second computer systems, such as described with reference to sharing a user interface of an application in methods 1200, 1400, 1600, 1800, 2000, 2200 (e.g., the user interface would optionally be concurrently associated with a first location in a first three-dimensional environment of the first user and associated with a location in a second three-dimensional environment that is visible via one or more second display generation components of the second computer system of the second user, where the location in the second three-dimensional environment corresponds to the first location in the first three-dimensional environment). In some embodiments, in the first type of communication session, the first computer system does not generate audio corresponding to audio that is detected at the second computer system (e.g., the first computer system does not recreate/output audio detected by a microphone, of the second user, at the second computer system). The second type of communication session is optionally a spatial real-time communication session, such as described with reference to methods 800, 1000, 1200, 1400, 1600, 1800, 2000, and/or 2200. For example, in the second type of communication session, the first computer system optionally displays a spatial representation of the second user (e.g., an avatar) in a three-dimensional environment visible via the first computer system. In some embodiments, in the second type of communication, were the user interface to be shared between the first user and the second user, the user interface would not be displayed with spatial truth. For example, location of display of the user interface in the first three-dimensional environment of the first user would not be aligned with (e.g., would not be the same as or corresponding to) a location of display of the user interface in the second three-dimensional environment of the second user. In some embodiments, in the second type of communication session, the first computer system generates audio corresponding to detected audio that is detected at the second computer system (e.g., the first computer system does recreate/output audio detected by a microphone, of the second user, at the second computer system).

In some embodiments, the first option includes a visual representation of the second user of the second computer system, such as the selectable option 2312b in FIG. 23D, and the second option does not include a visual representation of a respective user of a respective computer system, such as the selectable option 2312a in FIG. 23D. In some embodiments, provided that the second user and users other than the second user are collocated in the physical environment with the first user and satisfy one or more criteria (e.g., the one or more criteria described with reference to method 2500), visual representations of those users would be displayed in the sharing user interface as well. In some embodiments, the visual representation of the second user includes a picture, photo, icon, name or username, and/or another identifier of the second user. In some embodiments, the second option does not include any representation of a respective user. In some embodiments, the second option is selectable to display a set of one or more suggested users with whom the first user can share the user interface in the second type of communication session. As such, in some embodiments, the first computer system visually notifies the first user that the first option is associated with the second user.

In some embodiments, while concurrently displaying the user interface and the sharing user interface, the first computer system detects, via the one or more first input devices, one or more inputs, including an input directed to the first option, wherein the input directed to the first option corresponds to selection of the first option, such as attention 2310b directed to the selectable option 2312b in FIG. 23E and attention 2310d directed to the selectable option 2312e in FIG. 23G. In some embodiments, the input directed to the first option includes attention (e.g., gaze) of the first user directed to the first option while a hand of the first user performs an air pinch gesture (e.g., the thumb and index finger of the hand of the user coming into contact and then the release thereof) and/or includes other type(s) of input(s) described herein. In some embodiments, in response to detecting the input directed to the first control element described above with reference to step(s) 2402, the first computer system concurrently displays the user interface, the plurality of control elements for the user interface, and the sharing user interface, where the sharing user interface includes the first option, the second option, and a third option that is selectable to display options for configuring the sharing of the user interface with the users that the first user has selected, such as described below. For example, after detecting selection of the first option of the sharing user interface, the first computer system optionally detects input directed to the third option. In some embodiments, the input directed to the third option includes attention (e.g., gaze) of the first user directed to the third option while the hand of the first user performs an air pinch gesture (e.g., the thumb and index finger of the hand of the user coming into contact and then the release thereof). In some embodiments, the one or more inputs described above include the input directed to the first option and the input directed to the third option described above.

In some embodiments, in response to detecting the one or more inputs, the first computer system concurrently displays, via the one or more first display generation components, the user interface and the sharing user interface, including updating display, via the one or more first display generation components, of the sharing user interface to include one or more options for configuring sharing of the user interface with the second user of the second computer system, such as the selectable option 2312f and the selectable option 2312g in FIG. 23H. In some embodiments, in response to detecting the one or more inputs, the first computer system concurrently displays the user interface and sharing user interface including the one or more options for configuring sharing of the user interface. In some embodiments, the options include a first option that is selectable to share the user interface in a view-only mode. In some embodiments, in the view-only mode, the sharer of the user interface (e.g., the first user of the first computer system) can view and edit the user interface while it is being shared while users other than the sharer of the user interface (e.g., the first user of the first computer system) can view the user interface and cannot edit the user interface. In some embodiments, the options include an option that is selectable to share the user interface in an editing mode. In some embodiments, in the editing mode, the sharer of the user interface and the users other than the sharer of the user interface (e.g., the first user of the first computer system) can view and edit the user interface. In some embodiments, the options include an option to cancel the process to share the user interface. In some embodiments, the one or more inputs include the input directed to the first option and an input directed to another option for sharing the user interface with another user as well in the first type of communication session. In some embodiments, when the one or more inputs include the input directed to the first option and an input directed to another option for sharing the user interface with another user as well in the first type of communication session, and the input directed to the third option described above, the one or more options for configuring sharing of the user interface are for configuring sharing of the user interface with the second user and with the other user as well. In some embodiments, a number of users that can join the first type of communication session for the sharing of the user interface is no greater than a threshold number (e.g., three, four, seven, eight, or another number).

In some embodiments, the one or more options for configuring sharing of the user interface with the second user of the second computer system are based on an application that is associated with the user interface. For example, the selectable option 2312f and the selectable option 2312g in FIG. 23H are optionally based on the application that is associated with the first user interface 1106. For example, the user interface is optionally a messages user interface, maps user interface, media user interface, web browsing user interface, a game user interface, or another user interface of an application, such as a user interface of an application described with reference to methods 800, 1000, 1200, 1400, 1600, 1800, 2000, 2200, and/or 2400. In some embodiments, the options for configuring sharing of the user interface that the first computer system displays are based on input from an application developer of the application that is associated with the user interface, such as described below. In some embodiments, the options are based on a type of application associated with the user interface. For example, were the user interface a user interface of a music application, the options for configuring the sharing of the user interface optionally include a listen-only mode option and a playback control mode option. In some embodiments, in the listen-only mode users other than the sharer of the user interface (e.g., the first user of the first computer system) can view the user interface and listen to music associated with the user interface, but cannot change playback of the currently playing song. In some embodiments, in the listen-only mode users other than the sharer (e.g., the first user of the first computer system) can control a volume level of the song in their own environment, but cannot change the song. In some embodiments, in the playback control mode, users other than the sharer (e.g., the first user of the first computer system) can control the volume level of the song in their own environment and can change playback of the song (e.g., fast-forward, rewind, pause) in their environment, which optionally would cause playback of the song to correspondingly change in environments of the other users in the communication session (e.g., including the environment of the sharer).

In some embodiments, in accordance with a determination that the user interface is a user interface of a first application (e.g., a photos application, a music application, a maps application, and/or another type of application described herein), such as the first user interface 1106 being a photos application in FIG. 23H, the one or more options for configuring sharing of the user interface include (e.g., visually indicate) a first set of one or more options (optionally without including the second set of options described below), such as the selectable option 2312f and the selectable option 2312g in FIG. 23H. In some embodiments, in accordance with a determination that the user interface is a user interface of a second application (e.g., a photos application, a music application, a maps application, and/or another type of application described herein) that is different from the first application, the one or more options for configuring sharing of the user interface include (e.g., visually indicate) a second set of one or more options that is different from the first set of one or more options (optionally without including the first set of options). For example, the second user interface 1108 is a user interface of a music application, and the sharing user interface 2312 that is displayed in response to detection of selection of the selectable option 2312e in the sharing user interface 2312 for the second user interface 1108 in FIG. 23S would optionally include a set of options that is different from the selectable option 2312f and the selectable option 2312g in FIG. 23H. In some embodiments, options in the first set are determined by an application developer of the first application and options in the second set are determined by an application developer of the second application. In some embodiments, the options in the first set are different from the options in the second set. For example, the first application is optionally a photos application and options in the first set optionally include the first option that is selectable to share the user interface in the view-only mode (e.g., the option visually indicates “View-only” and the option that is selectable to share the user interface in the editing mode described above (e.g., the option visually indicates “Allow Editing”). Continuing with this example, the second application is optionally a music application and options in the second set optionally include the listen-only mode (e.g., the option visually indicates “Listen Together”) described above and the playback control mode option (e.g., the option visually indicates “Allow Audio Control”) described above, without including the view-only mode option (e.g., the option that visually indicates “View-only”) and the editing mode option (e.g., the option visually indicates “Allow Editing”). For example, the application developer of the first application optionally configures the text in the first set of options and the application developer of the second application optionally configures the text in the second set of options.

In some embodiments, in accordance with a determination that the user interface is a user interface of a first application (e.g., a photos application, a music application, a maps application, and/or another type of application described herein), such as the first user interface 1106 being a photos application in FIG. 23H, the one or more options for configuring sharing of the user interface include a first set of one or more options, such as the selectable option 2312f and the selectable option 2312g in FIG. 23H, and in accordance with a determination that the user interface is a user interface of a second application (e.g., a photos application, a music application, a maps application, and/or another type of application described herein) that is different from the first application, the one or more options for configuring sharing of the user interface include the first set of one or more options. For example, the second user interface 1108 is a user interface of a music application, and the sharing user interface 2312 that is displayed in response to detection of selection of the selectable option 2312e in the sharing user interface 2312 for the second user interface 1108 in FIG. 23S would optionally include the selectable option 2312f and the selectable option 2312g in FIG. 23H. For example, were the user interface a user interface of a presentation application, an option in the first set would optionally include an editing mode option that visually indicates “Collaborate Together”, which notifies the first user that selection of said option provides the other users with ability to edit content presented in the user interface. Continuing with this example, were the user interface a user interface of a word processing application, an option in the first set would optionally include the editing mode option that visual indicates “Collaborate Together” as well. In some embodiments, the first set of options are default options for sharing a user interface. In some embodiments, multiple applications can include the same options provided that the application developer opts to present those options to the first user in the sharing user interface.

In some embodiments, while concurrently displaying the user interface and the sharing user interface with the one or more options for configuring sharing of the user interface in the sharing user interface, the first computer system detects, via the one or more first input devices, an input directed to an option of the one or more options for configuring sharing of the user interface, such as attention 2310d directed to the selectable option 2312g in FIG. 23H. In some embodiments, the input directed to the option includes attention (e.g., gaze) of the first user directed to the option while a hand of the first user performs an air pinch gesture (e.g., the thumb and index finger of the hand of the user coming into contact and then the release thereof), and/or includes other type(s) of input(s) described herein.

In some embodiments, in response to detecting the input directed to the option of the one or more options for configuring sharing of the user interface, the first computer system ceases displaying the sharing user interface, such as the ceasing of display of the sharing user interface 2312 for the first user interface from FIG. 23H to FIG. 23I, and initiates sharing of the user interface with the second user of the second computer system in the first type of communication session in accordance with the option, including while displaying the user interface at a first user interface location in a first three-dimensional environment of the first user, initiating a process to cause display of the user interface at a second user interface location in a second three-dimensional environment of the second user, and the second user interface location in the second three-dimensional environment of the second user corresponds to the first user interface location in the first three-dimensional environment of the first user (e.g., initiating a process to cause the user interface to be displayed with spatial truth between the first and second computer systems, such as described with reference to sharing a user interface of an application in methods 1200, 1400, 1600, 1800, 2000, 2200, and/or 2400), such as shown with the sharing of the first user interface 1106 between the first computer system 101a and the second computer system 101b in FIG. 23N and FIG. 23O. In some embodiments, were the option a first respective option (e.g., the editing mode option described above), the first computer system would initiate sharing of the user interface with the second user in accordance with the editing mode option described above (e.g., the second user can edit content of the user interface). In some embodiments, were the option a second respective option (e.g., the view-only mode option described above), different from the first respective option, the first computer system would initiate sharing of the user interface with the second user in accordance with the second respective option (e.g., the second user can view the user interface but cannot edit the content of the user interface). In some embodiments, in response to detecting the one or more inputs, the first computer system ceases display of the sharing user interface and maintains display of the user interface (and optionally the control elements for the user interface in the environment of the first user). In some embodiments, the process includes a process to obtain a shared spatial coordinate system of the physical environment, between the first computer system and the second computer system so that the user interface can be displayed with spatial truth between the first and second computer systems. For example, the first and second computer systems optionally share map data of the physical environment in which they are collocated, until their map data is aligned, at which the second computer system would optionally display the user interface at a location that corresponds to a location of display of the user interface in the environment of the first user.

In some embodiments, in response to detecting the input directed to the option of the one or more options for configuring sharing of the user interface, and while the process to cause display of the user interface at the second user interface location in the second three-dimensional environment of the second user is not yet complete, the first computer system updates display, via the one or more first display generation components, of the first control element to indicate that the process to cause display of the user interface at the second user interface location in the second three-dimensional environment of the second user is progress and is not yet complete, such as the buffer animation illustrated in the control element 2306c in FIG. 23I. For example, in response to detecting the input directed to the option of the one or more options for configuring sharing of the user interface, the first computer system optionally changes the visual appearance of the first control element, such as displaying a buffer animation in the first control element, changing a size of the first control element, changing a color of the first control element, or otherwise displaying the first control element with a visual appearance that is different from the visual appearance of the first control element when the input directed to the option of the one or more options is detected. As such, in some embodiments, the computer system changes the visual appearance of the first control element in response detecting the input directed to the option of the one or more options for configuring sharing of the user interface.

In some embodiments, while initiating sharing of the user interface with the second user of the second computer system in the first type of communication session in accordance with the option (e.g., in accordance with the option of the one or more options for configuring sharing of the user interface), in accordance with a determination that the process to cause display of the user interface at the second user interface location in the second three-dimensional environment of the second user is not completed within a threshold period of time (e.g., 15 s, 30 s, 1 min, 2 min, or another threshold period of time), the first computer system concurrently displays, via the one or more first display generation components, the user interface, such as the first user interface 1106 in FIG. 23Y, and a user interface element that indicates that the user interface failed to be shared with the second computer system, such as the user interface element 2320 in FIG. 23Y. As such, in some embodiments, were the process to start sharing of the user interface to take longer than the threshold amount of time, the first computer system would cease the operation to share the user interface with second computer system (e.g., the second user). In some embodiments, the user interface element that indicates that the user interface failed to be shared with the second computer system includes a respective option that is selectable to restart the process for sharing the user interface with the second computer system again. In some embodiments, were the first computer system to detect input directed to the respective option, the first computer system would initiate the process to share the user interface with the second user in the first type of communication session again in accordance with the option of the one or more options for configuring sharing of the user interface described above. In some embodiments, the first computer system displays the user interface element even if the sharing user interface for the user interface is not displayed when the first computer system detects that the process to cause display of the user interface at the second user interface location in the second three-dimensional environment of the second user is not completed within the threshold period of time.

In some embodiments, after concurrently displaying the user interface and the sharing user interface in response to detecting the input directed to the first control element, while sharing the user interface in the first type of communication session with the second user of the second computer system, while concurrently displaying the user interface and the plurality of control elements for the user interface, and while the sharing user interface is not displayed, the first computer system detects, via the one or more first input devices, a second input directed to the first control element, such as attention of the first user 1101a directed to the control element 2303c in FIG. 23Q. In some embodiments, the second input directed to the first control element includes one or more characteristics of the input directed to the first control element described with reference to method 2400. In some embodiments, the input includes attention (e.g., gaze) of the first user directed to the first control element while the hand of the first user is performing an air pinch gesture (e.g., the thumb and index finger of the hand of the first user coming into contact and then the release thereof).

In some embodiments, in response to detecting the second input directed to the first control element, the first computer system concurrently displays, via the one or more display generation components, the user interface (e.g., the first user interface 1106 in FIG. 23Q) and the sharing user interface, wherein the sharing user interface includes at least an indication that the user interface is currently being shared with the second user in the first type of communication session. For example, were input directed to the control element 2303c in FIG. 23Q, the first computer system 101a would optionally display the sharing user interface 2312 for the first user interface including an indication, such as the indication 2312b-1 in FIG. 23AH, which indicates that the first user interface 1106 is currently being shared with the second user 1101b. In some embodiments, the indication is displayed in the first option described with reference to method 2400. For example, the indication is optionally a user interface element, such as a checkmark, a highlight, or another type of indication displayed in the first option that visually notifies the first user that the user interface is being shared with the second user in the first type of communication session. As such, the sharing user interface optionally includes indications of the users with whom the user interface is currently being shared in the first type of communication session.

In some embodiments, the sharing user interface that is displayed in response to detecting the input directed to the first control element described with reference to step(s) 2402 does not include the indication that the user interface is currently being shared with the second user in the first type of communication (e.g., since the user interface is optionally not being shared at all when the input directed to first control element described with reference to step(s) 2402 is detected).

In some embodiments, when the second input directed to the first control element is detected as described above, the first computer system does not display an indication that the user interface is being specifically shared with the second user even though the user interface is being specifically shared with the second user in the first type of communication session when the second input directed to the first control element is detected. In some embodiments, when the second input directed to the first control element is detected as described above, the first computer system displays the first control element with a visual appearance that indicates that the user interface is currently being shared with a respective user, without identifying the second user (e.g., without displaying an indication that the user interface is being specifically shared with the second user).

In some embodiments, were the first computer system to detect selection of the second option (e.g., described above with reference to method 2400) in the sharing user interface for the user interface while the user interface is being shared in the first type of communication session, the first computer system updates the sharing user interface to include options for initiating the second type of communication session for sharing of the user interface in the second type of communication session with one or more users, such as described with reference to method 2500.

Additionally or alternatively, in some embodiments, while sharing the user interface in the second type of communication session with a respective user of a respective computer system (e.g., the second user or another user), while concurrently displaying the user interface and the plurality of control elements for the user interface, and while the sharing user interface is not displayed, the first computer system detects, via the one or more first input devices, a respective input directed to the first control element. For example, the respective input optionally includes attention of the first user directed to the first control while the hand of the first user performs an air pinch gesture. In some embodiments, in response to detecting the respective input directed to the first control element, the first computer system concurrently displays, via the one or more first display generation components the user interface and the sharing user interface, where the sharing user interface includes at least an indication that the user interface is currently being shared with the respective user in the second type of communication session. As such, the sharing user interface optionally includes indications of the users with whom the user interface is currently being shared in the second type of communication session.

In some embodiments, the first user of the first computer system is also collocated in the physical environment with a third user of a third computer system, such as the fourth user 1101d in FIG. 23AH, and the sharing user interface that is concurrently displayed with the user interface in response to detecting the second input directed to the first control element includes the indication that the user interface is currently being shared with the second user in the first type of communication session, such as the indication 2312b-1 in FIG. 23AH, and a respective option that is selectable to initiate a process for adding the third user to the first type of communication session that is between the first user of the first computer system and the second user of the second computer system, and wherein adding the third user to the first type of communication session that is between the first user of the first computer system and the second user of the second computer system includes sharing the user interface in the first type of communication session with the third user of the third computer system, such as the selectable option 2312k in FIG. 23AH. As such, in some embodiments, the sharing user interface that is concurrently displayed with the user interface in response to detecting the second input directed to the first control element described above optionally includes the first option with the indication displayed in the first option and the respective option. Additionally, in some embodiments, the sharing user interface that is displayed in response to the second input directed to the first control element described above includes the second option that is that is selectable to initiate the process for sharing the user interface in the second type of communication session as described with reference to method 2400. In some embodiments, the first computer system detects one or more inputs including an input directed to the respective option. For example, the first computer system optionally detects attention (e.g., based on gaze) directed to the respective option while the hand of the first user performs an air pinch gesture. In some embodiments, in response to detecting the input directed to the respective option, the first computer system adds the third user to the first type of communication session that is between the first and second users and that includes the sharing of the user interface. In some embodiments, the sharing user interface includes the second option described above, and were the first user to request that a fourth user of a fourth computer system who is not collocated in the physical environment with the first user to join the sharing of the user interface (e.g., via the second option), and were the fourth user to accept the request of the first user, the first computer system would optionally add the fourth user to the sharing of the user interface including, sharing the user interface with the fourth computer system (e.g., causing the fourth computer system to display the user interface in a fourth three-dimensional environment of the fourth user), displaying a representation of the fourth user (e.g., a spatial representation (e.g., a spatial representation described with reference to method 2400) of the fourth user) in the first three-dimensional environment of the first user, and causing the fourth computer system to display a representation of the first user (e.g., a spatial representation (e.g., a spatial representation described with reference to method 2400) of the first user) in the fourth three-dimensional environment of the fourth user. Additionally, in some embodiments, were the fourth user added to the sharing of the user interface, the first computer system would cause the second computer system to display the representation of the fourth user in the second three-dimensional environment of the second user and would cause the fourth computer system to display a representation of the second user (e.g., a spatial representation (e.g., a spatial representation described with reference to method 2400) of the second user) in the fourth three-dimensional environment of the fourth user. Additionally, in some embodiments, were the fourth user added to the sharing of the user interface, a location of display of the representation of the fourth user in the second three-dimensional environment of the second user correspond to (e.g., be the same as) a location of display of the representation of the fourth user in the first three-dimensional environment of the first user.

In some embodiments, while concurrently displaying the user interface and the sharing user interface, the first computer system detects, via the one or more first input devices, one or more inputs, including an input directed to the second option in the sharing user interface, such as attention 2310v directed to the selectable option 2312c in FIG. 23AR. In some embodiments, the input directed to the second option in the sharing user interface includes attention (e.g., gaze) of the first user directed to the second option while the hand of the first user performs an air pinch gesture (e.g., the thumb and index finger of the hand of the user coming into contact and then the release thereof), and/or includes other type(s) of input(s) described herein.

In some embodiments, in response to detecting the one or more inputs, the first computer system 101a initiates the process for sharing the user interface in the second type of communication session with a set of one or more users of computer systems, such the first computer system 101a displaying the sharing user interface 2312 for the first user interface 1106 in FIG. 23AS including options corresponding to potential users to invite to join the second type of communication session. In some embodiments, initiating the process for sharing the user interface in the second type of communication session includes updating display of the sharing user interface to include selectable options corresponding to users with whom the first user can request to establish the second type of communication session. In some embodiments, the selectable options include suggested users. In some embodiments, the set one or more users of computer systems are the user(s) that the first user selects in the updated sharing user interface. In some embodiments, the set of one or more users of computer systems includes one or more users that are not collocated in the physical environment with the first user, without including user(s) that are collocated in the physical environment with the first user. In some embodiments, the set of one or more users of computer systems includes one or more users that are collocated in the physical environment with the first user, without including user(s) that are not collocated in the physical environment with the first user.

In some embodiments, the set of one or more users includes a respective user of a respective computer system. In some embodiments, the first computer system transmits a request to the respective computer system for the respective user to join the second type of communication session for the sharing of the user interface. In some embodiments, in response to detecting the request, the respective computer system displays a user interface element including options for the respective user to join or deny the request of the first user for the respective user to join the second type of communication session for the sharing of the user interface. In some embodiments, were the respective computer system to detect input directed to the option that corresponds to acceptance the request, the respective computer system would display the user interface in the three-dimensional environment of the respective computer system. In addition, in some embodiments, in response to detecting an indication that the respective computer system has detected input corresponding to acceptance of the request for the respective user to join the second type of communication session with the first user, the first computer system displays a representation of the respective user of the respective computer system (e.g., a spatial representation of the respective user, such as a spatial representation described with reference to the spatial representation in method 2400) in the first three-dimensional environment that is presented via the first computer system, in addition to displaying the user interface and the plurality of control element for the user interface.

Additionally, in some embodiments, after concurrently displaying the user interface and the sharing user interface in response to detecting the input directed to the first control element, while sharing the user interface in the second type of communication session with the set of one or more users, including the respective user of the respective computer system, while concurrently displaying the user interface and the plurality of control elements for the user interface, and while the sharing user interface is not displayed, the first computer system detects, via the one or more first input devices, a respective input directed to the first control element. In some embodiments, the respective input directed to the first control element includes one or more characteristics of the input directed to the first control element described with reference to method 2400. In some embodiments, the respective input includes attention (e.g., gaze) of the user directed to the first control element while a hand of the first user performs an air pinch gesture (e.g., the thumb and index finger of the hand of the user coming into contact and then the release thereof). In some embodiments, in response to detecting the respective input directed to the first control element, the first computer system concurrently displays the user interface and the sharing user interface, where the sharing user interface includes at least an indication (e.g., a name or username of the respective user and/or a user interface element such as a checkmark, a highlight or another type of indication)) that indicates that the user interface is currently being shared specifically with the respective user in the second type of communication session.

In some embodiments, the first control element of the plurality of control elements for the user interface is concurrently displayed with the user interface independent of whether the first user of the first computer system is collocated with a respective user of a respective computer system in the physical environment. For example, in FIG. 23A, the first computer system 101a displays the control element 2306c while the first user 1101a is collocated with the second user 1101b in the physical environment 1105. Continuing with this example, were the first user 1101a not collocated in the physical environment 1105 with any user of another computer system in FIG. 23A, the first computer system 101a would optionally still display the control element 2306c (e.g., the first control element that is selectable to display the sharing user interface) as described above. Additionally, in some embodiments, the first computer system 101a displays concurrently displays the user interface and the first control element independent of whether the user interface is currently being shared.

In some embodiments, in accordance with a determination that the user interface is being shared with a respective user of a respective computer system when the input directed to the first control element is detected, such as the first user interface 1106 being shared with the second user 1101b in FIG. 23N, the first control element has a first visual appearance (e.g., a first color, a first size, a first amount of contrast, a first amount of transparency, and/or a first amount of translucency), such as the illustrated visual appearance of the control element 2306c in FIG. 23N. In some embodiments, the first computer system displays the first control element having the first visual appearance without input directed at the first control element. In some embodiments, were the user interface being shared with the respective user in the first type of communication session, the first computer system displays the first control element with the first visual appearance. In some embodiments, were the user interface being shared with the respective user in the second type of communication session, the first computer system displays the first control element with the first visual appearance.

In some embodiments, in accordance with a determination that the user interface is not being shared with the respective user of the respective computer system when the input directed to the first control element is detected, such as the first user interface not being shared in FIG. 23A, the first control element has a second visual appearance (e.g., a second color, a second size, a second amount of contrast, a second amount of transparency, and/or a second amount of translucency) that is different from the first visual appearance, such as the illustrated visual appearance of the control element 2306c in FIG. 23A. In some embodiments, the first computer system displays the first control element having the second visual appearance without input directed at the first control element. As such, in some embodiments, the first computer system displays the first control element with different appearances based on whether or not the user interface is currently being shared.

In some embodiments, in accordance with a determination that the user interface is being shared with a respective user of a respective computer system when the input directed to the first control element is detected, the second control element has a first visual appearance (e.g., a first color, a first size, a first amount of contrast, a first amount of transparency, and/or a first amount of translucency), such as the illustrated visual appearance of the control element 2306a in FIG. 23N. In some embodiments, the first computer system displays the first control element having the first visual appearance without input directed at the first control element. In some embodiments, in accordance with a determination that the user interface is not being shared with the respective user of the respective computer system when the input directed to the first control element is detected, the second control element has a second visual appearance (e.g., a second color, a second size, a second amount of contrast, a second amount of transparency, and/or a second amount of translucency) that is different from the first visual appearance, such as the illustrated visual appearance of the control element 2306a in FIG. 23A. In some embodiments, the first computer system displays the first control element having the first visual appearance without input directed at the first control element. As such, in some embodiments, the first computer system displays the second control element with different appearances based on whether or not the user interface is currently being shared. In some embodiments, the first computer system displays the first and second control elements with similar visual appearances. For example, were the user interface being shared with the respective user in a respective type of communication session (e.g., the first or second type of communication session) when the input directed to the first control element is detected, the first computer system would optionally display the first and second control elements having the first visual appearance (e.g., same first color), separate from any differences in visual appearance due to differences in shape of the first and second control elements. Continuing with this example, were the user interface not being shared with a respective user in a respective type of communication session (e.g., the first or second type of communication session) when the input directed to the first control element is detected, the first computer system would optionally display the first and second control elements having the second visual appearance (e.g., the same second color). In some embodiments, were the user interface being shared with the respective user in a respective type of communication session (e.g., the first or second type of communication session) when the input directed to the first control element is detected, the first computer system would optionally display the first control element and second control elements with visual appearances that are different from each other and that are different from their respective visual appearance when the input directed to the first control element was detected.

In some embodiments, the user interface is a first user interface, and the plurality of control elements for the user interface is a plurality of control elements for first the user interface, such as the first user interface 1106 and the control element 2306a, control element 1106b, and control element 2306c for the first user interface 1106 in FIG. 23A. In some embodiments, the first computer system concurrently displays, via the one or more first display generation components, the first user interface, the plurality of control elements for the first user interface, a second user interface that is different from the first user interface (e.g., a messages user interface, maps user interface, media user interface, web browsing user interface, a game user interface, or another user interface of an application, such as a user interface of an application described with reference to methods 800, 1000, 1200, 1400, 1600, 1800, 2000, 2200, and/or 2400), such as the second user interface 1108 in FIG. 23A, and a plurality of control elements for the second user interface, including a third control element selectable to display a sharing user interface for the second user interface, such as the control element 2308c in FIG. 23A, and a fourth control element selectable to modify display of the second user interface, such as the control element 2308a or the control element 2308b in FIG. 23A, wherein the plurality of control elements for the second user interface are displayed at a predetermined spatial arrangement (e.g., predetermined position and/or orientation) relative to the second user interface (e.g., below, above, in front of, behind, to the left, to the right, or at another predetermined spatial arrangement relative to the second user interface), such as the spatial arrangement of the control element 2308a and the control element 1108b relative to the second user interface 1108 in FIG. 23A. In some embodiments, plurality of control elements for the second user interface includes one or more characteristics of the plurality of control elements for the user interface described with reference to step(s) 2402. In some embodiments, the third control element includes one or more characteristics of the first control element, but relative to the second user interface. In some embodiments, the fourth control element includes one or more characteristics of the second control element, but relative to the second user interface. As such, in some embodiments, the first computer system displays a plurality of control elements for each user interface of applications that are currently open (e.g., that are displayed) on the first computer system.

In some embodiments, while concurrently displaying the first user interface, the plurality of control elements for the first user interface, the second user interface, and the plurality of control elements for the second user interface, and while sharing the first user interface in the first type of communication session with the second user of the second computer system, the first computer system detects, via the one or more first input devices, an input directed to the third control element that is selectable to display the sharing user interface for second user interface, such as attention 2310i directed to the control element 2308c in FIG. 23Q. In some embodiments, the input directed to the third control element includes one or more features of the input directed to the first control element described with reference to step(s) 2402. In some embodiments, the input directed to the third control element includes attention (e.g., based on gaze) of the first user directed to the third control element while the hand of the first user performs an air pinch gesture (e.g., the thumb and index finger of the hand of the user coming into contact and then the release thereof) and/or includes other type(s) of input(s) described herein.

In some embodiments, in response to detecting the input directed to the third control element, the first computer system concurrently displays, via the one or more first display generation components, the first user interface, such as the first user interface 1106 in FIG. 23R, the second user interface, such as the second user interface 1108 in FIG. 23R, and the sharing user interface for the second user interface including a first respective option corresponding to the second user of the second computer system, wherein the first respective option is selectable to initiate a process for sharing the user interface in the first type of communication session between the first user of the first computer system and the second user of the second computer system, and wherein the first respective option has a visual appearance indicative of the first respective option being selected for sharing of the second user interface in the first type of communication session (e.g., without user input for selecting the first respective option), such as the sharing user interface 2312 for the second user interface 1108 including the indication 2312b-1 in FIG. 23R. For example, when the first respective option is displayed in the sharing user interface for the second user interface, the first computer system displays the first respective option having the visual appearance indicative of the first respective option being selected for sharing of the second user interface in the first type of communication session without the first computer system detecting user input selecting the first respective option. Additionally or alternatively, in some embodiments, were the user interface being shared with other user(s), in addition to the second user, when the input directed to the third control element is detected, the sharing user interface for the second user interface would optionally include option(s) corresponding to those user(s) as well, just like the first respective option corresponding to the second user, where those option(s) would likewise have the visual appearance indicative of them being selected for sharing of the second user interface in the first type of communication session. Additionally or alternatively, in some embodiments, were the user interface being shared with other user(s), without being shared with the second user who is collocated in the physical environment with the first user, when the input directed to the third control element is detected, the sharing user interface for the second user interface would optionally include option(s) corresponding to those user(s) as well, just like described above with reference to the first respective option corresponding to the second user, where those option(s) would have the visual appearance indicative of them being selected for sharing of the second user interface in the first type of communication session; in such embodiments, the first respective option would optionally have a visual appearance of the first respective option not being selected for sharing of the second user interface in the first type of communication session (e.g., the user input directed to the first respective option would have to be detected to initiate a process to include the second user in the sharing of the second user interface in the first type of communication session). Additionally, in some embodiments, the sharing user interface for the second user interface further includes a second respective option that is selectable to continue the process for sharing the second user interface in the first type of communication session between the first user of the first computer system and the second user of the second computer system in response to detecting the input directed to the third control element. In some embodiments, the second respective option is selectable to display one or more options for configuring the sharing of the second user interface, such as described with reference to the third option that is selectable to display options for configuring the sharing of the user interface with the users that the first user has selected described above with reference to method 2400. In some embodiments, the first computer system detects an input directed to the second respective option (e.g., without detecting an input directed to the first respective option). In some embodiments, the input directed to the second respective option includes attention (e.g., based on gaze) of the first user directed to the second respective option while the hand of the first user performs an air pinch gesture. In some embodiments, in response to detecting the input directed to the second respective option, the first computer system continues the process for sharing the second user interface in the first type of communication session between the first user of the first computer system and the second user of the second computer system. For example, in some embodiments, in response to detecting the input directed to the second respective option, the first computer system updates display of the sharing user interface for the second user interface to include a confirmation user interface element that includes a first selectable option for confirming that the first user requests to replace sharing of the first user interface with the second user interface and a second selectable option for canceling the request to share the second user interface. In some embodiments, were the first computer system to detect a selection input directed to the first selectable option (e.g., an input that optionally includes attention of the first user directed to the first selectable option while the hand of the first user performs an air pinch gesture), the first computer system would cease the sharing of the first user interface in the first type of communication session and would initiating sharing of the second user interface in the first type of communication session. In some embodiments, were the first computer system to detect a selection input directed to the second selectable option (e.g., an input that optionally includes attention of the first user directed to the second selectable option while the hand of the first user performs an air pinch gesture), the first computer system would maintain the sharing of the first user interface in the first type of communication session (e.g., without replacing it with the second user interface).

In some embodiments, the user interface is a non-immersive user interface of immersive content (e.g., content of an application (e.g., a content playback application, such as movie application, or a gaming application, or another type of application), where the content is configured to surround (at least partially) the viewpoint of the first user of the first computer system (e.g., the content is 180-degree media content or 360-degree media content). For example, the first user interface 1106 of FIG. 23A is optionally a windowed version of immersive content, such as of the immersive content illustrated in FIG. 23AU. Continuing with this example, were input directed to the control element 2306c in FIG. 23A, the sharing user interface that would be displayed in response would optionally be for sharing the immersive content in FIG. 23A. In some embodiments, the first computer system can detect and respond to input for sharing the immersive content. In some embodiments, the first computer system displays the user interface with the plurality of control elements to provide an efficient way to share the immersive content. For example, the first user can make selections via the sharing user interface to share the immersive content in the first or second type of communication session as described herein with reference to method 2400. In some embodiments, the first computer system displays a user interface element that indicates a status of the immersive content as shared or not shared. In some embodiments, while displaying the immersive content, the first computer system displays the user interface element. In some embodiments, the user interface element is selectable to control sharing of the immersive content in a respective communication session (e.g., the first or second type of communication session). For example, the user interface element is optionally selectable to display the sharing user interface described with reference to method 2400.

FIG. 25 is a flowchart illustrating an exemplary method for displaying a sharing user interface for a user interface in response to detecting an input corresponding to a request to initiate sharing of the user interface in a communication session, in accordance with some embodiments.

In some embodiments, the method 2500 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2500 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2500 are, optionally, combined and/or the order of some operations is, optionally, changed.

The devices, methods, and/or computer-readable storage mediums described with reference to method 2500 enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Restricting access to potentially sensitive information and/or compartmentalizing the information to specific devices and processes (such as by displaying information for enabling sharing of the user interface with users who do not meet the criteria and by not displaying indications of those users who do not meet the criteria until those users have enabled sharing from the specific user who wishes to share content]) improves privacy and security by limiting the manner in which that potentially sensitive information can be accessed. For example, the second user's privacy is maintained since the second user has to authorize the first user's ability to share in the second user's environment. For example, a visual indication of the second user is optionally not displayed in the sharing user interface until the second user authorizes the first user's ability to share in the second user's environment, which protects the privacy of the second user. Displaying options that are selectable to initiate a process to start a first type of communication session with users who satisfy criteria and a second option that is selectable to initiate a process to start the first type of communication session with users who do not satisfy criteria in response to input for sharing a user interface allows the first user to initiate processes to share the user interface in the first type of communication session with users who may or may not satisfy the criteria and reduces errors associated with operating the computer system.

In some embodiments, a method 2500 (e.g., the method 2500 of FIG. 25) is performed at a first computer system (e.g., the first computer system 101a of FIG. 23A) that is in communication with one or more first display generation components and one or more first input devices. In some embodiments, the first computer system has one or more characteristics of the computer systems in methods 800, 1000, 1200, 1400, 1600, 1800, 2000, 2200, and/or 2400. In some embodiments, the first display generation component(s) have one or more characteristics of the display generation component(s) in methods 800, 1000, 1200, 1400, 1600, 1800, 2000, 2200, and/or 2400. In some embodiments, the one or more first input devices have one or more characteristics of the one or more input devices in methods 800, 1000, 1200, 1400, 1600, 1800, 2000, 2200, and/or 2400.

In some embodiments, the first computer system displays (2502a), via the one or more first display generation components, a user interface (e.g., a messages user interface, maps user interface, media user interface, web browsing user interface, a game user interface, or another user interface of an application, such as a user interface of an application described with reference to methods 800, 1000, 1200, 1400, 1600, 1800, 2000, 2200, and/or 2400, and the user interface is optionally displayed in a first three-dimensional environment such as such as in the first three-dimensional environment described with reference to methods 1200, 1400, 1600, 1800, 2200, and/or 2400), such as the first user interface 1106 in FIG. 23A.

In some embodiments, while displaying the user interface, the first computer system detects (2502b), via the one or more first input devices, an input corresponding to a request to initiate sharing of the user interface in a communication session, such as attention 2310a in directed to the control element 2306c in FIG. 23C. In some embodiments, the input includes attention (e.g., gaze) of a first user of the first computer system directed to a control element while a hand of the first user is performing an air pinch gesture (e.g., the thumb and index finger of the hand of the first user coming into contact and then the release thereof). In some embodiments, the input includes touch inputs detected on a touch-sensitive surface (e.g., a touch screen), a user pressing down on a control element on a mouse (e.g., a left-click), and/or is a gaze input without including other inputs such as an air gesture. In some embodiments, the input corresponding to the request to initiate sharing of the user interface in a communication session is the input directed to the first control element described with reference to method 2400. For example, the user interface is optionally displayed concurrently with the first control element (e.g., with the control elements for the user interface described with reference to method 2400), and the input directed to the first control element is optionally the input corresponding to the request to initiate sharing of the user interface in a communication session). In some embodiments, the input corresponds to a request to initiate sharing of the user interface in any of the manners of sharing user interfaces described in methods 800, 1000, 1200, 1400, 1600, 1800, 2000, 2200, and/or 2400.

In some embodiments, in response to detecting the input corresponding to the request to initiate sharing of the user interface in the communication session, the first computer system concurrently displays (2502c), via the one or more first display generation components, the user interface (2502d), such as the first user interface in FIG. 23D and a sharing user interface (2502e), such as the sharing user interface 2312 for the first user interface 1106 in FIG. 23D. In some embodiments, the sharing user interface includes a first set of one or more options corresponding to one or more users of computer systems who are collocated in a physical environment with the first user of the first computer system and satisfy one or more criteria, such as the selectable option 2312b in FIG. 23D and/or the selectable option 2312c, wherein the first set of one or more options are selectable to initiate a process for sharing the user interface in a first type of communication session between the first user of the first computer system and the one or more users of computer systems who are collocated in the physical environment with the first user of the first computer system and satisfy the one or more criteria (2502f). In some embodiments, the sharing user interface of the method 2500 includes one or more features of the sharing user interface of the method 2400. The first type of communication session is the first type of communication session described with reference to method 2400. In some embodiments, the one or more users being collocated in the physical environment is as described with reference to the first user being collocated in a physical environment with the second user (e.g., the first and second computer systems are collocated in the physical environment) in methods 800, 1000, 1200, 1400, 1600, 1800, 2000, 2200, and/or 2400. In some embodiments, each user of a computer system that is collocated in the physical environment with the first user and satisfy the one or more criteria is associated with an option in the first set of options. The one or more criteria optionally include a criterion that is satisfied when the other user(s) (e.g., second user described with reference to method 2400) is in a contact list of an application on the first computer system and/or when the first user is in a contact list of an application on the second computer system, such as described below. In some embodiments, the one or more criteria include a criterion that is satisfied when the first and second users have previously interacted in the physical environment, such as described below. In some embodiments, options in the first set of options are as described with reference to the first option that is selectable to initiate a process for sharing the user interface in the first type of communication session between the first user of the first computer system and the second user of the second computer system in method 2400. In some embodiments, should there be no user(s) who is collocated in the physical environment with the first user and satisfies the one or more criteria, the first computer system forgoes display of the first set of options and only displays the second option described below.

In some embodiments, the sharing user interface includes a second option that is selectable to initiate a process for sharing the user interface in the first type of communication session between the first user of the first computer system and one or more users of computer systems who are collocated in the physical environment with the first user of the first computer system and do not satisfy the one or more criteria, such as the selectable option 2312d in FIG. 23D, wherein the process for sharing the user interface in the first type of communication session with the one or more users of the computer systems who are collocated in the physical environment with the first user of the first computer system and do not satisfy the one or more criteria is different from the process for sharing the user interface in the first type of communication session between the first user of the first computer system and the one or more users of computer systems who are collocated in the physical environment with the first user of the first computer system and satisfy the one or more criteria (2502g). In some embodiments, the second option is selectable to initiate the process for sharing the user interface in the first type of communication session with unspecified computer systems. For example, the second option optionally does not visually indicate specific identities of users (e.g., names or usernames) with whom the second option is selectable initiate the process to share. In some embodiments, the second option is selectable to display instructions for enabling sharing between the first computer system and the users of the computer systems who are collocated with the first user in the physical environment and do not satisfy the one or more criteria. In some embodiments, the users with whom the second option is selectable to initiate the process to share is defined by the users associated with the computers systems that detect the respective input displayed in response to selection of second option. In some embodiments, the first option does visually indicate the specific identity of the second user (e.g., name, icon, or username) with whom the first option is selectable to initiate the process to share. In some embodiments, the second option is selectable to initiate a process to enable sharing of the user interface in any of the manners of sharing user interfaces described in methods 800, 1000, 1200, 1400, 1600, 1800, 2000, 2200, and/or 2400. As described above, in some embodiments, options in the first set of options are as described with reference to the first option that is selectable to initiate a process for sharing the user interface in a first type of communication session between the first user of the first computer system and the second user of the second computer system in method 2400. In some embodiments, the second option of method 2500 is different from the second option of method 2400. For example, when the first type of communication session of method 2400 is the same as the first type of communication session of method 2500, the second option of method 2400 is selectable for sharing of a user interface in a second type of communication session while the second option of method 2500 is optionally selectable for sharing of a user interface in the same type of communication session in which the first option of method 2500 is selectable to share. Thus, the first and second options of method 2500 are optionally selectable to initiate processes for sharing of the user interface in the same type of communication session while the first and second options of method 2400 are optionally selectable to initiate processes for sharing of the user interface in different types of communication sessions. As such, in some embodiments, the first computer system displays one or more first options that are selectable to initiate a process for sharing the user interface in a first type of communication session with users who satisfy criteria, and a second option that is selectable to initiate a process for sharing the user interface in the first type of communication session with users who do not satisfy the one or more criteria.

In some embodiments, the one or more criteria that are satisfied by the one or more users of computer systems to which the first set of one or more options corresponds include a criterion that is satisfied when the one or more users who are collocated in the physical environment are in a contact list of an application (e.g., a contact list application, video conferencing application, a text messaging application, or another application) on the first computer system. For example, the first computer system 101a displays the selectable option 2312b corresponding to the second user 1101b in FIG. 23D optionally because the second user 1101b is in the contact list of the application on the first computer system 101a. In some embodiments, when a respective user is collocated with the first user, if the respective user is in the contact list of the application on the first computer system when the input corresponding to the request to initiate sharing of the user interface in the communication session is detected, the first set of one or more options described above includes a respective option that corresponds to the respective user (e.g., for sharing of the user interface in the first type of communication session with the respective user). In some embodiments, when the respective user is collocated with the first user in the physical environment, if the respective user is not in the contact list of the application on the first computer system when the input corresponding to the request to initiate sharing of the user interface in the communication session is detected, the first computer system does not include a respective option that corresponds to the respective user in the first set of one or more options.

In some embodiments, while concurrently displaying the user interface and sharing user interface, the first computer system detects, via the one or more first input devices, one or more inputs directed to the sharing user interface, such as attention of the first user 1101a directed to the sharing user interface 2312 in FIG. 23E. In some embodiments, the one or more inputs directed to the sharing user interface includes attention (e.g., based on gaze) of the first user directed to the sharing user interface while a hand of the first user performs an air pinch gesture (e.g., the thumb and index finger of the hand of the user coming into contact and then the release thereof), and/or includes other type(s) of input(s) described herein.

In some embodiments, in accordance with a determination that the one or more inputs directed to the sharing user interface include an input directed to a first option of the first set of one or more options (e.g., the input directed to the first option optionally includes attention (e.g., based on gaze) of the first user directed to the first option while the hand of the first user performs an air pinch gesture (e.g., the thumb and index finger of the hand of the user coming into contact and then the release thereof), and/or other types of input(s) described herein), wherein the first option of the first set of one or more options corresponds to a second user of a second computer system who is collocated in the physical environment with the first user of the first computer system and satisfies the one or more criteria, such as attention 2310b directed to the selectable option 2312b in FIG. 23E, in response to detecting the one or more inputs, the first computer system initiates the process to sharing the user interface in the first type of communication session between the first user and the second user. For example, the first computer system 101a optionally detects the attention 2310b directed to the selectable option 2312b (and then, optionally, detects attention 2310d directed to the selectable option 2312e) and in response initiates the process. The first option of the first set of one or more options is optionally as described with reference to the first option in the sharing user interface described with reference to method 2400. The input directed to the first option of the first set of one or more options is optionally as described with reference to the input directed to the first option of the sharing user interface described with reference to method 2400. For example, the input directed to the first option of the first set of one or more options optionally includes attention of the first user directed to the first option while the hand of the first user performs an air pinch gesture (e.g., the thumb and index finger of the hand of the user coming into contact and then the release thereof). In some embodiments, in response to detecting the input directed to the first option of the first set of one or more options, and optionally in response to detecting an input requesting to initiate sharing of the user interface in first type of communication session, the first computer system optionally updates display of the sharing user interface to include the one or more options for configuring sharing of the user interface with the user that corresponds to the first option, such as described with reference to the first computer system updating display of the sharing user interface to include one or more option for configuring sharing of the user interface with the second user in method 2400. In some embodiments, the one or more inputs directed to the sharing interface are detected while the first computer system is not sharing the user interface in a communication session. In some embodiments, initiating the process to sharing the user interface in the first type of communication session between the first user and the second user includes initiating sharing of the user interface in any of the manners of sharing user interfaces described in methods 800, 1000, 1200, 1400, 1600, 1800, 2000, 2200, and/or 2400.

In some embodiments, in accordance with a determination that the one or more inputs directed to the sharing user interface include an input directed to the second option, such as attention 2310l directed to the selectable option 2312d in FIG. 23Z, in response to detecting the one or more inputs, the first computer system initiates the process for sharing the user interface in the first type of communication session between the first user of the first computer system and one or more users of computer systems who are collocated in the physical environment with the first user of the first computer system and do not satisfy the one or more criteria, such as the first computer system 101a displaying the sharing user interface 2312 for the first user interface 1106 in FIG. 23AA in response to the attention 2310l directed to the selectable option 2312d in FIG. 23Z. In some embodiments, the users that do not satisfy the one or more criteria include users who are not in the contact list of the application on the first computer system described above. In some embodiments, initiating the process includes displaying instructions for enabling sharing of content (e.g., the user interface) between the first user and the one or more users of computer systems who are collocated in the physical environment with the first user of the first computer system and do not satisfy the one or more criteria, such as described below. In some embodiments, the instructions are for enabling sharing of content (e.g., the user interface) between the first user and the one or more users of computer systems who are collocated in the physical environment with the first user of the first computer system and do not satisfy the one or more criteria in any of the manners of sharing user interfaces described in methods 800, 1000, 1200, 1400, 1600, 1800, 2000, 2200, and/or 2400.

In some embodiments, while concurrently displaying the user interface and sharing user interface, the first computer system detects, via the one or more first input devices, one or more inputs including an input directed to the second option, such as attention 2310l directed to the selectable option 2312d in FIG. 23Z. In some embodiments, the one or more inputs directed to the second option in the sharing user interface includes attention (e.g., based on gaze) of the first user directed to the second option while the hand of the first user performs an air pinch gesture (e.g., the thumb and index finger of the hand of the user coming into contact and then the release thereof), and/or other input(s) described herein.

In some embodiments, in response to detecting the one or more inputs, the first computer system updates display of the sharing user interface to include instructions for initiating a process to enable sharing of the user interface in the first type of communication session with the one or more users of computer systems who are collocated in the physical environment with the first user of the first computer system and do not satisfy the one or more criteria, such as the first computer system 101a displaying the sharing user interface 2312 for the first user interface 1106 in FIG. 23AA. In some embodiments, the instruction indicate respective input that should be detected at the first computer system and/or respective input that should be detected at the computer systems of the one or more users who are collocated in the physical environment with the first user and do not satisfy the one or more criteria in order for the one or more users who are collocated in the physical environment with the first user and do not satisfy the one or more criteria to satisfy the one or more criteria. Further, as described above, in some embodiments, the instructions are for enabling sharing of content (e.g., the user interface) between the first user and the one or more users of computer systems who are collocated in the physical environment with the first user of the first computer system and do not satisfy the one or more criteria in any of the manners of sharing user interfaces described in methods 800, 1000, 1200, 1400, 1600, 1800, 2000, 2200, and/or 2400. The instructions are described in more detail below.

In some embodiments, the instructions include information, such the instructions 2312n in FIG. 23AA. In some embodiments, a respective input corresponding to entry of the information at the one or more computer systems of the one or more users of computer systems who are collocated in the physical environment with the first user of the first computer system and do not satisfy the one or more criteria completes the process to enable sharing of the user interface in the first type of communication session with the one or more users of computer systems who are collocated in the physical environment with the first user of the first computer system and do not satisfy the one or more criteria, such the instructions 2312n in FIG. 23AA. For example, the first computer system displays the information. In some embodiments, the information is a passcode, a password, a key, an authentication key, an authorization key, and/or another type of code that is to be entered (e.g., detected) at the one or more computer systems of the user(s) who do not satisfy the one or more criteria in order for sharing between the first user and those user(s) to be enabled. In some embodiments, the instructions include instructions indicating that the first user should communicate the information to the one or more users who do not satisfy the criteria so that the one or more users who do not satisfy the one or more criteria can enter or otherwise provide the information to their respective computer system(s). In some embodiments, the instructions indicate instructions for navigating a computer system for providing the information to the computer system. For example, were the information to correspond to information that should be directed or entered in a settings or control user interface of the computer system, the instructions that the first computer system displays optionally indicates that the user(s) who do not satisfy the criteria should navigate to the settings or control user interface of their computer systems to provide the information to their computer systems.

In some embodiments, the one or more users of computer systems who are collocated in the physical environment and do not satisfy the one or more criteria include a respective user of a respective computer, such as the fourth user 1101d of the fourth computer system 101d in FIG. 23AA. In some embodiments, after updating display of the sharing user interface to the information, and while displaying the sharing user interface including the first set of one or more options, the first computer system detects an indication that the respective input has been detected at the respective computer system. For example, after the fourth computer system 101d detects the respective input in FIG. 23AF, the fourth computer system optionally transmits to the first computer system 101a the indication that the respective input has been detected at the fourth computer system 101d. In some embodiments, the respective computer system transmits the indication to the first computer system in response to the respective computer system detecting that the respective input has been detected at the respective computer system. In some embodiments, the first computer system detects the indication from the respective computer system.

In some embodiments, in response to detecting the indication, the first computer system updates the first set of one or more options to include an additional option corresponding to the respective user of the respective computer system, wherein the additional option is selectable initiate a process for sharing the user interface in the first type of communication session between the first user and the respective user, such as the sharing user interface 2312 including the selectable option 2312k in FIG. 23AH. The functionality of the additional option is similar to (e.g., the same as) the functionality of the other option(s) of the first set of one or more options, but is relative to the first computer system and the respective computer system. As such, in some embodiments, the first computer system adds additional options to the first set of one or more options, where the additional options correspond to user(s) of computer system(s) that are collocated in the physical environment with the first user and have provided the respective input to their respective computer systems. In some embodiments, the additional option indicates a name or username of the respective user (e.g., without input from the first user that provides a name or username of the respective user). In some embodiments, the respective computer system transmitted to the first computer system the name or username of the respective user when the respective computer system detected the respective input. Additionally or alternatively, in some embodiments, the first computer system can update the first set of one or more options to include another option corresponding to a user who becomes collocated with the first user in the physical environment if the user is already in the contact list of the application on the first computer system described above when they become collocated with the first user in the physical environment. Additionally or alternatively, in some embodiments, the first computer system can update the first set of one or more options to exclude an option that corresponds to a user provided that the user is no longer collocated in the physical environment with the first user.

In some embodiments, while displaying the sharing user interface and the first set of one or more options including the additional option, the first computer system detects, via the one or more input devices, one or more inputs including an input directed to the additional option, such as attention 2310o-1 directed to the selectable option 2312k in FIG. 23AH. In some embodiments, the input directed to the additional option in the sharing user interface includes attention (e.g., based on gaze) of the first user directed to the additional option while the hand of the first user performs an air pinch gesture (e.g., the thumb and index finger of the hand of the user coming into contact and then the release thereof), and/or other input(s) described herein. In some embodiments, the input directed to the additional option includes one or more characteristics of the input directed to the first option of the sharing user interface described in method 2400. In some embodiments, the sharing user interface includes the first set of one or more options, the additional option, the second option, and the third option described with reference to method 2400. For example, the third option is optionally selectable to configure sharing of the user interface with the user(s) that the first user selects. For example, since the first computer system has detected an input directed to the additional option, which corresponds to selection of the respective user for sharing the user interface with the respective user in the first type of communication session, were the first computer system to detect selection of the third option, the third option would be selectable to configure sharing of the user interface with the third user. In some embodiments, while the additional option is indicated as selected in the sharing user interface, and in response to detecting selection of the third option, the first computer system transmits a request to the respective computer system for the respective user to join the first type of communication session with the first user for the sharing of the user interface. In some embodiments, in response to detecting the one or more inputs, the first computer system initiates the process for sharing the user interface in the first type of communication session between the first user of the first computer system and the respective user of the respective computer system, such as the first computer system 101a causing the fourth computer system 101d to display the first user interface 1106 as shown in FIG. 23AI. In some embodiments, initiating the process for sharing the user interface in the first type of communication session between the first user of the first computer system and the respective user of the respective computer system is as described with reference to initiating the process for sharing the user interface in the first type of communication session between the first user of the first computer system and the second user of the second computer system in method 2400. Additionally or alternatively, in some embodiments, initiating the process for sharing the user interface in the first type of communication session between the first user of the first computer system and the respective user of the respective computer system includes initiating sharing of the user interface in any of the manners of sharing user interfaces described in methods 800, 1000, 1200, 1400, 1600, 1800, 2000, 2200, and/or 2400.

In some embodiments, the additional option that is added to the first set of one or more options includes a user interface element that is selectable to initiate a process to add the respective user of the respective computer system to a contact list of an application (e.g., a contact list application, video conferencing application, a text messaging application, or another application) on the first computer system, such as the user interface element 2312k-1 in FIG. 23AH. In some embodiments, options in the first set of one or more option other than the additional option of the first set of one or more options do not include a user interface element for adding their corresponding users to the contact list of the application, optionally because those users are already in the contact list of the application. For example, as described above, the one or more criteria that are satisfied by the one or more users of computer systems to which the first set of one or more options corresponds (e.g., excluding the additional option) include a criterion that is satisfied when the one or more users who are collocated in the physical environment are in the contact list of the application, so options in the first set of one or more option other than the additional option of the first set of one or more options optionally do not include a user interface element for adding their corresponding users to the contact list of the application, optionally because those users are already in the contact list of the application.

In some embodiments, while displaying the sharing user interface and the first set of one or more options including the additional option with the user interface element displayed in the additional option, the first computer system detects, via the one or more first input devices, one or more inputs including an input directed at the user interface element, such as attention 2310o-3 directed to the user interface element 2312k-1 in FIG. 23AH. In some embodiments, the input directed to the user interface element includes attention (e.g., based on gaze) of the first user directed to the user interface element while the hand of the first user performs an air pinch gesture (e.g., the thumb and index finger of the hand of the user coming into contact and then the release thereof), and/or other input(s) described herein.

In some embodiments, in response to detecting the one or more inputs, the first computer system initiates a process to add the respective user of the respective computer system to a contact list of an application on the first computer system. For example, the first computer system 101a optionally adds the fourth user 1101d to the contact list of the application on the first computer system 101a in response to detecting the attention 2310o-3 directed to the user interface element 2312k-1 in FIG. 23AH. In some embodiments, in response to detecting the one or more inputs, the first computer system adds the respective user to the contact list of the application on the first computer system. For example, in response to detecting the one or more inputs, the first computer system optionally updates display of the sharing user interface to include options for creating a contact of the respective user in the contact list of the application. In some embodiments, the one or more of the options for creating the contact of the respective user in the contact list of the application is pre-populated with information, such as with the name or username of the respective user, which was optionally detected at the first computer system from the respective computer system in response to the respective computer system detecting the respective input described above.

In some embodiments, after concurrently displaying the user interface and the sharing user interface with the first set of one or more options including the additional option that corresponds to the respective user of the respective computer system and the second option, and while displaying the user interface without displaying the sharing user interface, the first computer system detects, via the one or more first input devices, a second input corresponding to a request to initiate sharing of the user interface in a communication session. For example, after concurrently displaying the first user interface 1106 and the sharing user interface 2306 for the first user interface 1106 of FIG. 23AH, and while displaying the first user interface 1106 (including the plurality of control elements for the first user interface 1106 (e.g., the control elements 2306a, 1106b, and 2306c in FIG. 23A) without displaying the sharing user interface 2306 for the first user interface 1106 of FIG. 23AH, the first computer system 101a optionally detects attention of the first user 1101a directed to the control element 2306c for the first user interface 1106. In some embodiments, the second input corresponding to the request to initiate sharing of the user interface in the communication session includes one or more characteristics of the input corresponding to the request to initiate sharing of the user interface in the communication session described with reference to method 2500. For example, the second input optionally includes attention (e.g., gaze) of the first user directed to a control element while the hand of the first user is performing an air pinch gesture (e.g., the thumb and index finger of the hand of the first user coming into contact and then the release thereof). In some embodiments, in response to detecting the second input, in accordance with a determination that one or more second criteria are satisfied when the second input is detected, the first computer system concurrently displays, via one or more first display generation components, the user interface, and the sharing user interface including the first set of one or more options, the additional option that corresponds to the respective user of the respective computer system, and the second option. For example, were the one or more second criteria satisfied when the second input is detected, the first computer system 101a would optionally display the first user interface 1106 and the sharing user interface 2312 of FIG. 23AH, which includes the selectable option 2312k that corresponds to the fourth user 1101d, in response to the second input. As such, in some embodiments, provided that the one or more second criteria are satisfied when the second input described above is detected, the first computer system concurrently displays the user interface and the sharing user interface, with the sharing user interface including the first set of one or more options, the additional option that corresponds to the respective user of the respective computer system, and the second option. The one or more second criteria are described below.

In some embodiments, in accordance with a determination that one or more second criteria are not satisfied when the second input is detected, the first computer system concurrently displays, via one or more first display generation components, the user interface, and the sharing user interface including the first set of one or more options and the second option, without including the additional option that corresponds to the respective user of the respective computer system. For example, were the one or more second criteria not satisfied when the second input is detected, the first computer system 101a would optionally display the first user interface 1106 and the sharing user interface 2312 of FIG. 23AL, which does not include the selectable option 2312k that corresponds to the fourth user 1101d, in response to the second input. As such, in some embodiments, provided that the one or more second criteria are not satisfied when the second input described above is detected, the first computer system concurrently displays the user interface and the sharing user interface, with the sharing user interface including the first set of one or more options and the second option and excluding the additional option that corresponds to the respective user of the respective computer system. The one or more second criteria are described below.

In some embodiments, when the user interface and the sharing user interface with the first set of one or more options including the additional option, and the second option were concurrently displayed, the first computer system and the respective computer system were collocated in the physical environment, such as the first user 1101a and the fourth user 1101d being collocated in the physical environment 1105 in FIG. 25AK, wherein the physical environment is a first physical environment, such as the physical environment 1105 in FIG. 25AK, and wherein the second criteria includes a criterion that is satisfied when the first computer system and the respective computer system are in the first physical environment when the second input is detected. For example, when the second input is detected, were the first user 1101a and the fourth user 1101d to be collocated in the same physical environment as they were when the fourth computer system 101d detected the respective input in FIG. 23AF (e.g., when the fourth computer system 101d transmitted an indication that the respective input of FIG. 23AF has been detected and/or when the first computer system 101a detected the indication), the one or more second criteria would optionally be satisfied, and in response to the second input described above, the first computer system 101a would optionally display the first user interface 1106 and the sharing user interface 2312 of FIG. 23AH, which includes the selectable option 2312k that corresponds to the fourth user 1101d. Thus, in some embodiments, when the second input is detected, were the first and second computer systems in the same location (e.g., in the same physical room, office, or building) as the location of the first and second computer systems when the user interface and the sharing user interface with the first set of one or more options including the additional option and the second option were previously concurrently displayed, the second criteria are satisfied and the first computer system optionally concurrently displays the user interface and the sharing user interface including the first set of one or more options, the additional option, and the second option in response to detecting the second input. Further, in some embodiments, when the second input is detected, were the first and second computer systems in a location that is different from the location of the first and second computer systems when the user interface and the sharing user interface with the first set of one or more options including the additional option and the second option were previously concurrently displayed, the second criteria are not satisfied and the first computer system optionally concurrently displays the user interface and the sharing user interface including the first set of one or more options and the second option and excluding the additional option in response to detecting the second input.

In some embodiments, the user interface and the sharing user interface with the first set of one or more options including the additional option, and the second option were concurrently displayed at a first time, wherein the second input is detected at a second time after the first time, and wherein the second criteria includes a criterion that is satisfied when a difference in time between the first time and the second time is less than a threshold period of time (e.g., 1 hr, 5 hr, 10 hr, 24 hr, 2 days, 5 days, or another threshold period of time). For example, were the difference in time between when the fourth computer system 101d detected the respective input in FIG. 23AF (e.g., when the fourth computer system 101d transmitted an indication that the respective input of FIG. 23AF has been detected and/or when the first computer system 101a detected the indication) and detection of the second input described above, the one or more second criteria would optionally be satisfied and the first computer system 101a would optionally display the first user interface 1106 and the sharing user interface 2312 of FIG. 23AH, which includes the selectable option 2312k that corresponds to the fourth user 1101d, in response to detecting the second input described above is detected Thus, in some embodiments, when the second input is detected, were the difference in time between the first time and the second time described above less than the threshold period of time, the second criteria are satisfied and the first computer system optionally concurrently displays the user interface and the sharing user interface including the first set of one or more options, the additional option, and the second option in response to detecting the second input. Further, in some embodiments, when the second input is detected, were the difference in time between the first time and the second time described above greater than the threshold period of time, the second criteria are not satisfied and the first computer system optionally concurrently displays the user interface and the sharing user interface including the first set of one or more options and the second option and excluding the additional option in response to detecting the second input.

In some embodiments, the second criteria include a criterion that is satisfied when the respective user of the respective computer system is in a contact list of an application on the first computer system when the second input is detected. For example, were the first computer system 101a to add the fourth user 1101d to the contact list of the application on the first computer system 101a, the one or more second criteria would optionally be satisfied (and optionally the fourth user 1101d would now satisfy the one or more criteria described above since the fourth user 1101d is in the contact list of the application on the first computer system 101 in this example) and the first computer system 101a would optionally display the first user interface 1106 and the sharing user interface 2312 of FIG. 23AH, which includes the selectable option 2312k that corresponds to the fourth user 1101d, in response to detecting the second input described above is detected. Thus, in some embodiments, were the respective user to be in the contact list of the application on the first computer system when the second input is detected, the second criteria are satisfied and the first computer system optionally concurrently displays the user interface and the sharing user interface including the first set of one or more options, the additional option, and the second option in response to detecting the second input. For example, the first user optionally added the respective user to the contact list of the application before the second input is detected, such as described above with reference to the additional option including the user interface element that is selectable to initiate the process to add the respective user of the respective computer system to the contact list of the application. Further, in some embodiments, were the respective user to not be in the contact list of the application on the first computer system when the second input described above is detected, the second criteria are not satisfied and the first computer system optionally concurrently displays the user interface and the sharing user interface including the first set of one or more options and the second option and excluding the additional option in response to detecting the second input. Additionally or alternatively, in some embodiments, were the respective user to be in the contact list of the application on the first computer system when the second input described above is detected, and were the difference in time between the first time and the second time less than the threshold period of time described above, the second criteria are satisfied and the first computer system optionally concurrently displays the user interface and the sharing user interface including the first set of one or more options, the additional option, and the second option in response to detecting the second input. Additionally or alternatively, in some embodiments, were the respective user to be in the contact list of the application on the first computer system when the second input is detected, and were the difference in time between the first time and the second time greater than the threshold period of time described above, the second criteria are satisfied and the first computer system optionally concurrently displays the user interface and the sharing user interface including the first set of one or more options, the additional option, and the second option in response to detecting the second input.

In some embodiments, while sharing the user interface in the first type of communication session with a set of one or more users, the first computer system detects, via the one or more first input devices, a second input corresponding to a request to control sharing of the user interface. For example, while sharing the first user interface 1106 in the first type of communication session with the second user 1101b and the third user 1101c as shown in FIG. 23N, the first computer system 101a optionally detects attention of the first user 1101a directed to the control element 2306c in FIG. 23N. In some embodiments, the second input corresponding to the request to control sharing of the user interface includes one or more characteristics of the input corresponding to the request to initiate sharing of the user interface in the communication session described with reference to step(s) 2502 and/or of the second input directed to the first control element (e.g., of the user interface) described with reference to method 2400, which, as described with reference to method 2400, is detected after concurrently displaying the user interface and the sharing user interface in response to detecting the input directed to the first control element, while sharing the user interface in the first type of communication session with the second user of the second computer system, while concurrently displaying the user interface and the plurality of control elements for the user interface, and while the sharing user interface is not displayed. In some embodiments, the second input includes attention (e.g., gaze) of a first user directed to a control element while a hand of the first user is performing an air pinch gesture (e.g., the thumb and index finger of the hand of the first user coming into contact and then the release thereof), and/or other type(s) of input(s) described herein. In some embodiments, in response to detecting the second input, the first computer system concurrently displays, via the one or more first display generation components, the user interface, such as the first user interface 1106 in FIG. 23AL, and the sharing user interface (e.g., the sharing user interface 2312 for the first user interface 1106 in FIG. 23AL) including the first set of one or more options, such as the selectable option 2312b and the selectable option 2312c in FIG. 23AL, the second option, such as the selectable option 2312d in FIG. 23AL, and a third option for initiating a process to establish a second type of communication session, different from the first type of communication session with a respective user of a respective computer system who is not collocated in the physical environment with the first user of the first computer system and who is not a user in the set of one or more users, such as the selectable option 2312a in FIG. 23AL. In some embodiments, the third option is as described with reference to the second option of the sharing user interface described with reference to method 2400. In some embodiments, the second type of communication session is as described with reference to the second type of communication session described with reference to method 2400. In some embodiments, while concurrently displaying the user interface and the sharing user interface including the first set of one or more options, the second option, and the third option, the first computer system detects via the one or more first input devices, one or more inputs including an input directed at the third option, such as attention 2310q directed to the selectable option 2312a in FIG. 23AL. In some embodiments, the input directed at the third option is as described with reference to the input directed to the second option in the sharing user interface that is described with reference to method 2400. In some embodiments, the input directed to the third option includes attention (e.g., gaze) of the first user directed to the third option while the hand of the first user performs an air pinch gesture (e.g., the thumb and index finger of the hand of the user coming into contact and then the release thereof), and/or includes other type(s) of input(s) described herein. In some embodiments, in response to detecting the one or more inputs, and based on user input detected at a respective option that is different from the first set of one or more options and the second option, such as based on user input directed at the option 2330a or the option 2330b in FIG. 23AN, the first computer system initiates a process to share the user interface in the second type of communication session with the set of one or more users and the respective user or initiates a process to share the user interface in the second type of communication session with the respective user and not with the set of one or more users, including ceasing sharing of the user interface with the set of one or more users. For example, in response to detecting attention 2310q directed to the selectable option 2312a in FIG. 23AL, the first computer system 101a optionally displays the sharing user interface 2312 of FIG. 23AN, and were the first computer system 101a to detect input directed to the option 2330a in the sharing user interface 2312 of FIG. 23AN, such as attention 2310t directed to the option 2330a in FIG. 23AN, the first computer system 101a would optionally initiate the process to sharing the user interface in the second type of communication session with the set of one or more users and the respective user, such as with “Jill” and the second user 1101b and the third user 1101c with whom the first user interface 1106 is being shared in the first type of communication session in FIG. 23AN. Continuing with this example, were the first computer system 101a to detect input directed to the option 2330b in the sharing user interface 2312 of FIG. 23AN, such as attention 2310u directed to the option 2330b in FIG. 23AN, the first computer system 101a would optionally initiate the process to share the user interface in the second type of communication session with the respective user and not with the set of one or more users, including ceasing sharing of the user interface with the set of one or more users, such as with “Jill” and not with the second user 1101b and the third user 1101c with whom the first user interface 1106 is being shared in the first type of communication session in FIG. 23AN, and would optionally cease the sharing of the first user interface 1106 with the second user 1101b and the third user 1101c.

In some embodiments, in response to detecting the one or more inputs, the first computer system updates display of the sharing user interface to include options for sharing of the user interface in the second type of communication session with one or more users. In some embodiments, the options for sharing of the user interface in the second type of communication session with the one or more users do not include option(s) for sharing of the user interface in the second type of communication session with the user(s) that are party to the first type of communication session with whom the user interface is currently being shared. In some embodiments, the options for sharing of the user interface in the second type of communication session with the one or more users include option(s) for sharing of the user interface in the second type of communication session with the user(s) that are party to the first type of communication session with whom the user interface is currently being shared. In some embodiments, the options for sharing of the user interface in the second type of communication session with the one or more users include suggested users to add the second type of communication session. In some embodiments, the options for sharing of the user interface in the second type of communication session with the one or more users include a text entry field for providing the first user ability to search for one or more users to invite to the sharing of the user interface in the second type of communication session. In some embodiments, the first computer system detects selection of one or more options corresponding to one or more users that the first user requests to join the second type of communication session for sharing of the user interface in the second type of communication session. In some embodiments, the selected one or more options does not include option(s) that corresponds user(s) with whom the first user is currently sharing the user interface in the first type of communication session.

In some embodiments, in response to detecting the selection described above, where the selection is detected while the user interface is currently being shared in the first type of communication session, the first computer system updates display of the sharing user interface for the first user interface to include a first respective option for inviting both the user(s) the first user selected in the selection described above (e.g., which optionally does not include the user(s) with whom the first user is currently sharing the user interface in the first type of communication session) and the user(s) with whom the first user is currently sharing the user interface in the first type of communication session to the second type of communication session and a second respective option for inviting just the user(s) that the first user selected in the selection described above. For example, even if the users that are party to the first type of communication session with whom the user interface is currently being shared are not users that the first user selected to join the second type of communication session (e.g., even if they were not part of the selection described above), the first computer system optionally still displays the first respective option. In some embodiments, the first computer system detects input directed to the first respective option. For example, the first computer system optionally detects attention of the first user directed at the first respective option while the hand of the first user performs an air pinch gesture (e.g., the thumb and index finger of the hand of the user coming into contact and then the release thereof). In some embodiments, in response to detecting the input directed to first respective option, the first computer system changes (e.g., updates) the currently active first type of communication session to be the second type of communication session, without causing ceasing of display of the user interface that is currently being shared. Additionally, in response to detecting input directed to the first respective option, the first computer system optionally transmits a request to the computer system(s) of the user(s) that were selected in the selection process described above to join the second type of communication session. In some embodiments, were those user(s) to accept the request to join the second type of communication session and those user(s) to not be collocated in the physical environment with the first user, the first computer system would optionally display representation(s) of those users(s) (e.g., spatial representation(s) (e.g., avatar(s)) of those user(s) such as described above with reference to method 2400)). Further, in response to detecting the input directed to the first respective option, the first computer system optionally transmits an indication to computer system(s) associated with the user(s) with whom the first user is currently sharing the user interface in the first type of communication session that the first type of communication session is being changed (e.g., updated) to be the second type of communication session. Additionally, in some embodiments, the computer system(s) associated with the user(s) with whom the first user is currently sharing the user interface in the first type of communication session does not display a request to join the second type of communication session in response to detecting the indication described above (e.g., those computer system join the second type of communication session without user input from their respective users for doing so). In some embodiments, the computer system(s) of the user(s) that were selected in the selection process described above display a user interface element that allows those user(s) to accept or deny the request to join the second type of communication session. In some embodiments, the first computer system detects input directed to the second respective option for inviting just the user(s) that the first user selected in the selection described above, which optionally does not include any of the user(s) with whom the first user is currently sharing the user interface in the first type of communication session. In some embodiments, the input directed to the second respective option includes attention of the first user directed at the second respective option while the hand of the first user performs an air pinch gesture (e.g., the thumb and index finger of the hand of the user coming into contact and then the release thereof). In some embodiments, in response to detecting the input directed at the second respective option, the first computer system ceases the first type of communication session that is established with the user(s) with whom the first user is currently sharing the user interface in the first type of communication session, including ceasing sharing of the user interface in the first type of communication session. Additionally, in some embodiments, the first computer system transmits a request to the computer system(s) of the user(s) that were selected in the selection process described above to join the second type of communication session, such as described above. In some embodiments, were those user(s) to accept the request to join the second type of communication session, the first computer system would share the user interface in the second type of communication session with those user(s).

In some embodiments, while sharing the user interface in a communication session (e.g., in the first type of communication session or the second type of communication session described with reference to methods 2400 and/or 2500) that includes a set of one or more users, the first computer system detects an indication that a respective user of a respective computer system is added to the communication session (e.g., the first type of communication session or the second type of communication session described with reference to methods 2400 and/or 2500, such as a non-spatial real-time communication session, such as described with reference to methods 800, 1000, 1200, 1400, 1600, 1800, 2000, 2200, and/or 2400 or a spatial real-time communication session, such as described with reference to methods 800, 1000, 1200, 1400, 1600, 1800, 2000, 2200 and/or 2400) that includes the set of one or more users. For example, were the user “Jill” added to the communication session, such as the second type of communication session described with reference to input being directed at the option 2330a in FIG. 23AN, the first computer system 101a (and the other computer systems who are currently in a communication session with the first user 1101a would optionally detect an indication that the user “Jill” has been added to the communication session. In some embodiments, the indication is transmitted to the first computer system from the respective computer system. In some embodiments, the first user is collocated with the respective user in the physical environment. In some embodiments, the first user is not collocated with the respective user in the physical environment. In some embodiments, the first computer system adds the respective user to the communication session in response to input detected at the first computer system. In some embodiments, a computer system in the communication session that is different from the first computer system adds the respective user to the communication session in response to input detected at the other computer system. In some embodiments, in response to detecting the indication, the first computer system displays, via the one or more first display generation components, a user interface element that indicates that the respective user is added to the communication session that includes the set of one or more users, such as the notification 2331 in FIG. 23AP. In some embodiments, when the indication is detected, the communication session includes a first user of the first computer system and a second user of a second computer system. In some embodiments, in response to detecting the indication, the first computer system displays the user interface element and the second computer system displays the user interface element, thus notifying their respective users that the respective user has been added to the communication session.

It should be understood that the particular order in which the operations in methods 800, 1000, 1200, 1400, 1600, 1800, 2000, 2200, 2400, and/or 2500 have been described is merely exemplary and is not intended to indicate that the described order is the only order in which the operations could be performed. One of ordinary skill in the art would recognize various ways to reorder the operations described herein. In some embodiments, aspects/operations of methods 800, 1000, 1200, 1400, 1600, 1800, 2000, 2200, 2400, and/or 2500 may be interchanged, substituted, and/or added between these methods. For example, various object manipulation techniques and/or object movement techniques of methods 800, 1000, 1600, 1800, and/or 2500, the three-dimensional environments in methods 800, 1000, 1200, 1400, 1600, 1800, 2000, 2200, 2400, and/or 2500, the communication sessions in methods 800, 1000, 1200, 1400, 1600, 1800, 2000, 2200, 2400, and/or 2500, the virtual content and/or virtual objects in methods 800, 1000, 1200, 1400, 1600, 1800, 2000, 2200, 2400, and/or 2500, the interactions with users and/or virtual content and/or the user interfaces in methods 800, 1000, 1200, 1400, 1600, 1800, 2000, 2200, 2400, and/or 2500 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, TWITTER IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-53. (canceled)

54. A method comprising:
at a first computer system in communication with one or more first display generation components and one or more first input devices:
while a respective user interface of a respective application is not shared between the first computer system and a second computer system, and while the respective user interface of the respective application is associated with a first location in a first three-dimensional environment that is visible via the one or more first display generation components:
detecting that one or more criteria are satisfied, including a criterion that is satisfied when a second user of the second computer system is in a viewport of the first computer system at a second location in the first three-dimensional environment;
in response to detecting that the one or more criteria are satisfied, displaying, via the one or more first display generation components, a first user interface element in the first three-dimensional environment that is selectable to share the respective user interface of the respective application with the second computer system, wherein the first user interface element is not displayed before detecting that the second user is in the viewport of the first computer system; and
while displaying the first user interface element, detecting, via the one or more first input devices, selection of the first user interface element; and
in response to detecting the selection of the first user interface element, sharing the respective user interface of the respective application with the second computer system, including causing the respective user interface of the respective application to be concurrently:
associated with the first location in the first three-dimensional environment; and
associated with a location in a second three-dimensional environment that is visible via one or more second display generation components of the second computer system, the location in the second three-dimensional environment corresponding to the first location in the first three-dimensional environment.

55. The method of claim 54, comprising while the respective user interface of the respective application is not shared between the first computer system and the second computer system, and while the respective user interface of the respective application is associated with the first location in the first three-dimensional environment, in accordance with a determination that the second user of the second computer system and the first location are in a current viewport of the first computer system, concurrently displaying, via the one or more first display generation components:
the respective user interface of the respective application at the first location; and
the first user interface element.

56. The method of claim 54, comprising while the respective user interface of the respective application is not shared between the first computer system and the second computer system, and while the respective user interface of the respective application is associated with the first location in the first three-dimensional environment, in accordance with a determination that the second user of the second computer system is in a current viewport of the first computer system and the first location is not in the current viewport of the first computer system, displaying, via the one or more first display generation components, the first user interface element, without displaying the respective user interface of the respective application.

57. The method of claim 54, wherein:
in accordance with a determination that a first user of the first computer system interacted with a first user interface of a first application last before the first user interface element was selected, the respective user interface of the respective application that the first user interface element is selectable to share is the first user interface of the first application; and
in accordance with a determination that the first user interacted with a second user interface that is different from the first user interface last before the first user interface element was selected, the respective user interface of the respective application that the first user interface element is selectable to share is the second user interface.

58. The method of claim 54, comprising:
before detecting the selection of the first user interface element, concurrently displaying, via the one or more first display generation components, the respective user interface at the first location in the first three-dimensional environment and an indication that the respective user interface is not being shared with another user of a computer system; and
in response to detecting the selection of the first user interface element, concurrently displaying, via the one or more first display generation components, the respective user interface at the first location in the first three-dimensional environment and an indication that the respective user interface is being shared with another user of the computer system.

59. The method of claim 54, wherein the one or more criteria include an additional criterion that is satisfied when a gaze of a first user of the first computer system is directed to the second user.

60. The method of claim 59, wherein the one or more criteria include another criterion that is satisfied when the gaze of the first user is directed to the second user for more than a threshold period of time.

61. The method of claim 54, wherein displaying the first user interface element includes:
in accordance with a determination that the second location of the second user in the first three-dimensional environment is a first user position in the first three-dimensional environment, displaying the first user interface element at a first user interface element position in the first three-dimensional environment; and
in accordance with a determination that the second location of the second user in the first three-dimensional environment is a second user position, different from the first user position, in the first three-dimensional environment, displaying the first user interface element at a second user interface element position, different from the first user position, in the first three-dimensional environment.

62. The method of claim 54, comprising:
while the respective user interface of the respective application is not shared between the first computer system and a third computer system, and while the respective user interface of the respective application is associated with the first location in the first three-dimensional environment that is visible via the one or more first display generation components:
detecting that one or more second criteria are satisfied, including a criterion that is satisfied when a third user of the third computer system is in the viewport of the first computer system at a third location in the first three-dimensional environment;
in response to detecting that the one or more second criteria are satisfied, displaying, via the one or more first display generation components, a second user interface element, different from the first user interface element, in the first three-dimensional environment that is selectable to share the respective user interface of the respective application with the third computer system, wherein the second user interface element is not displayed before detecting that the third user is in the viewport of the first computer system; and
while displaying the second user interface element, detecting, via the one or more first input devices, selection of the second user interface element; and
in response to detecting the selection of the second user interface element, sharing the respective user interface of the respective application with the third computer system, including causing the respective user interface of the respective application to be concurrently:
associated with the first location in the first three-dimensional environment; and
associated with a respective location in a third three-dimensional environment that is visible via one or more third display generation components of the third computer system, the respective location in the third three-dimensional environment corresponding to the first location in the first three-dimensional environment.

63. The method of claim 62, comprising in accordance with a determination that the one or more criteria are satisfied and that the one or more second criteria are satisfied, concurrently displaying, via the one or more first display generation components:
the first user interface element; and
the second user interface element.

64. A first computer system that is in communication with one or more first input devices and one or more first display generation components, the first computer system comprising:
one or more processors;
memory; and
one or more programs, wherein the one or more programs are stored in the memory and configured to be executed by the one or more processors, the one or more programs including instructions for:
while a respective user interface of a respective application is not shared between the first computer system and a second computer system, and while the respective user interface of the respective application is associated with a first location in a first three-dimensional environment that is visible via the one or more first display generation components:
detecting that one or more criteria are satisfied, including a criterion that is satisfied when a second user of the second computer system is in a viewport of the first computer system at a second location in the first three-dimensional environment;
in response to detecting that the one or more criteria are satisfied, displaying, via the one or more first display generation components, a first user interface element in the first three-dimensional environment that is selectable to share the respective user interface of the respective application with the second computer system, wherein the first user interface element is not displayed before detecting that the second user is in the viewport of the first computer system; and
while displaying the first user interface element, detecting, via the one or more first input devices, selection of the first user interface element; and
in response to detecting the selection of the first user interface element, sharing the respective user interface of the respective application with the second computer system, including causing the respective user interface of the respective application to be concurrently:
associated with the first location in the first three-dimensional environment; and
associated with a location in a second three-dimensional environment that is visible via one or more second display generation components of the second computer system, the location in the second three-dimensional environment corresponding to the first location in the first three-dimensional environment.

65. A non-transitory computer readable storage medium storing one or more programs, the one or more programs comprising instructions, which when executed by one or more processors of a first computer system that is in communication with one or more first input devices and one or more first display generation components, cause the first computer system to perform operations comprising:
while a respective user interface of a respective application is not shared between the first computer system and a second computer system, and while the respective user interface of the respective application is associated with a first location in a first three-dimensional environment that is visible via the one or more first display generation components:
detecting that one or more criteria are satisfied, including a criterion that is satisfied when a second user of the second computer system is in a viewport of the first computer system at a second location in the first three-dimensional environment;
in response to detecting that the one or more criteria are satisfied, displaying, via the one or more first display generation components, a first user interface element in the first three-dimensional environment that is selectable to share the respective user interface of the respective application with the second computer system, wherein the first user interface element is not displayed before detecting that the second user is in the viewport of the first computer system; and
while displaying the first user interface element, detecting, via the one or more first input devices, selection of the first user interface element; and
in response to detecting the selection of the first user interface element, sharing the respective user interface of the respective application with the second computer system, including causing the respective user interface of the respective application to be concurrently:
associated with the first location in the first three-dimensional environment; and
associated with a location in a second three-dimensional environment that is visible via one or more second display generation components of the second computer system, the location in the second three-dimensional environment corresponding to the first location in the first three-dimensional environment.

66-222. (canceled)
